(19) United States
(12) Patent Application Publication
(10) Pub. No.: US 2026/0369696 A1
(43) Pub. Date: Nov. 19, 2026

(54) CERAMIC MATERIALS AND SEALS FOR HIGH TEMPERATURE REACTIVE MATERIAL DEVICES

(71) Applicant: Ambri, LLC, Marlborough, MA (US)

(72) Inventors: David J. Bradwell, Sudbury, MA (US); Hari Nayar, Woburn, MA (US); Zachary T. Modest, Jamaica Plain, MA (US); Stephanie L. Golmon, Arlington, MA (US)

(21) Appl. No.: 19/215,218

(22) Filed: May 21, 2025

Related U.S. Application Data
(63) Continuation-in-part of application No. 18/912,364, filed on Oct. 10, 2024, now abandoned.
Application No. 18/912,364 is a continuation of application No. 18/417,936, filed on Jan. 19, 2024.
Application No. 18/417,936 is a continuation of application No. 18/203,822, filed on May 31, 2023, now abandoned.
Application No. 18/203,822 is a continuation of application No. 17/510,056, filed on Oct. 25, 2021, now Pat. No. 11,721,841.
Application No. 17/510,056 is a continuation of application No. 16/718,020, filed on Dec. 17, 2019, now Pat. No. 11,196,091.
Application No. 16/718,020 is a continuation of application No. 15/647,468, filed on Jul. 12, 2017, now Pat. No. 10,541,451.
Application No. 15/647,468 is a continuation-in-part of application No. 14/688,179, filed on Apr. 16, 2015, now Pat. No. 9,735,450.
Application No. 14/688,179 is a continuation of application No. PCT/US2013/065092, filed on Oct. 15, 2013.
(60) Provisional application No. 61/715,821, filed on Oct. 18, 2012.

(51) Int. Cl. H01M 10/39; B60L 50/64; B60L 53/00; B60L 53/53; H01M 4/134; H01M 4/38; H01M 10/42; H01M 50/138; H01M 50/463

(52) U.S. Cl. CPC H01M 10/399; B60L 50/64; B60L 53/00; B60L 53/53; H01M 4/134; H01M 4/38; H01M 4/381; H01M 4/382; H01M 10/4207; H01M 10/425; H01M 50/463; H01M 4/387; H01M 50/138; H01M 2220/20; Y02T 10/70; Y02T 10/7072; Y02T 90/14

(57) ABSTRACT

The disclosure provides seals for devices that operate at elevated temperatures and have reactive metal vapors, such as lithium, sodium or magnesium. In some examples, such devices include energy storage devices that may be used within an electrical power grid or as part of a standalone system. The energy storage devices may be charged from an electricity production source for later discharge, such as when there is a demand for electrical energy consumption.

### CROSS-REFERENCE

This application is a continuation-in-part of U.S. application Ser. No. 18/912,364, filed Oct. 10, 2024, which is a continuation of U.S. application Ser. No. 18/417,936, filed Jan. 19, 2024, which is a continuation of U.S. application Ser. No. 18/203,822, filed May 31, 2023, which is a continuation of U.S. application Ser. No. 17/510,056, filed on Oct. 25, 2021, now U.S. Pat. No. 11,721,841, which is a continuation of U.S. application Ser. No. 16/718,020, filed on Dec. 17, 2019, now U.S. Pat. No. 11,196,091, which is a continuation of U.S. patent application Ser. No. 15/647,468, filed Jul. 12, 2017, now U.S. Pat. No. 10,541,451, which is a continuation-in-part of U.S. patent application Ser. No. 14/688,179, filed Apr. 16, 2015, now U.S. Pat. No. 9,735,450, which is a continuation of PCT Application No. PCT/US2013/065092, filed Oct. 15, 2013, which claims the benefit of U.S. Provisional Application No. 61/715,821, filed Oct. 18, 2012, and which is a continuation-in-part of U.S. patent application Ser. No. 13/801,333, filed Mar. 13, 2013, now U.S. Pat. No. 9,312,522, which claims the benefit of U.S. Provisional Application No. 61/763,925, filed Feb. 12, 2013, and U.S. Provisional Application No. 61/715,821, filed Oct. 18, 2012, and which is a continuation-in-part of U.S. patent application Ser. No. 14/536,563, filed Nov. 7, 2014, now U.S. Pat. No. 9,728,814, which is a continuation of U.S. patent application Ser. No. 14/178,806, filed Feb. 12, 2014, now U.S. Pat. No. 9,520,618, which claims the benefit of U.S. Provisional Application No. 61/763,925, filed Feb. 12, 2013; and is a continuation-in-part of U.S. patent application Ser. No. 17/399,724, filed Aug. 11, 2021, which is a continuation of U.S. application Ser. No. 17/136,432, filed Dec. 29, 2020, which is a continuation of U.S. application Ser. No. 15/130,129, filed Apr. 15, 2016, which is a continuation of PCT Application No. PCT/US2014/061266, filed Oct. 17, 2014, which claims the benefit of U.S. Provisional Application No. 61/892,326, filed Oct. 17, 2013; and is a continuation-in-part of U.S. application Ser. No. 18/218,412, filed Jul. 5, 2023, which is a continuation of U.S. patent application Ser. No. 17/404,341, filed Aug. 17, 2021, which is a continuation-in-part of U.S. patent application Ser. No. 15/063,842, filed Mar. 8, 2016, which is a continuation of PCT Application No. PCT/US2014/056367, filed Sep. 18, 2014, which claims the benefit of U.S. Provisional Patent Application No. 61/879,349, filed Sep. 18, 2013; and is a continuation-in-part of U.S. patent application Ser. No. 19/197,869, filed May 2, 2025, which is a continuation of U.S. patent application Ser. No. 18/895,092, filed Sep. 24, 2024, which is a continuation of U.S. patent application Ser. No. 18/141,041, filed Apr. 28, 2023, now U.S. Pat. No. 12,142,735, which is a continuation of U.S. patent application Ser. No. 17/747,333, filed May 18, 2022, now U.S. Pat. No. 11,677,100, which is a continuation of U.S. patent application Ser. No. 16/592,621, filed Oct. 3, 2019, now U.S. Pat. No. 11,387,497, which is a continuation-in-part of U.S. patent application Ser. No. 15/140,434, filed Apr. 27, 2016, which is a continuation of PCT Application No. PCT/US2014/063222, filed Oct. 30, 2014, which claims the benefit of U.S. Provisional Application No. 61/898,642, filed Nov. 1, 2013; and is a continuation-in-part of U.S. patent application Ser. No. 19/177,409, filed Apr. 11, 2025, which is a continuation of U.S. application Ser. No. 18/821,820, filed Aug. 30, 2024, which is a continuation of U.S. application Ser. No. 18/410,790, filed Jan. 11, 2024, which is a continuation of U.S. application Ser. No. 18/166,814, filed Feb. 9, 2023, now U.S. Pat. No. 11,909,004, which is a continuation of U.S. patent application Ser. No. 17/529,171, filed Nov. 17, 2021, now U.S. Pat. No. 11,611,112, which is a continuation of U.S. patent application Ser. No. 16/858,189, filed Apr. 24, 2020, now U.S. Pat. No. 11,211,641, which is a continuation-in-part of U.S. patent application Ser. No. 15/130,292, filed Apr. 15, 2016, which is a continuation of PCT Application No. PCT/US2014/060979, filed Oct. 16, 2014, which claims the benefit of U.S. Provisional Application No. 61/930,298, filed Jan. 22, 2014, U.S. Provisional Application No. 61/891,784, filed Oct. 16, 2013, and U.S. Provisional Application No. 61/891,789, filed Oct. 16, 2013; and is a continuation-in-part of U.S. patent application Ser. No. 19/033,134, filed Jan. 21, 2025, which is a continuation of U.S. application Ser. No. 18/680,139, filed May 31, 2024, which is a continuation of U.S. application Ser. No. 18/381,512, filed Oct. 18, 2023, which is a continuation of U.S. application Ser. No. 17/670,168, filed Feb. 11, 2022, now U.S. Pat. No. 11,840,487, which is a continuation of U.S. application Ser. No. 16/829,965, filed Mar. 25, 2020, now U.S. Pat. No. 11,289,759, which is a continuation of U.S. application Ser. No. 15/690,863, filed Aug. 30, 2017, now U.S. Pat. No. 10,637,015, which is a continuation of PCT Application No. PCT/US2016/021048, filed Mar. 4, 2016, which claims priority to U.S. Provisional Application No. 62/128,838, filed Mar. 5, 2015, and U.S. Provisional Application No. 62/208,518, filed Aug. 21, 2015; and is a continuation-in-part of U.S. patent application Ser. No. 18/943,432, filed Nov. 11, 2024, which is a continuation of U.S. application Ser. No. 18/436,940, filed Feb. 8, 2024, which is a continuation of U.S. application Ser. No. 18/196,225, filed May 11, 2023, now U.S. Pat. No. 11,929,466, which is a continuation-in-part of U.S. application Ser. No. 16/293,288, filed Mar. 5, 2019, which is a continuation of PCT Application No. PCT/US2017/050544, filed Sep. 7, 2017, which claims the benefit of U.S. Provisional Application No. 62/384,662, filed Sep. 7, 2016; and is a continuation-in-part of U.S. patent application Ser. No. 17/840,395, filed Jun. 14, 2022, which is continuation of U.S. application Ser. No. 16/593,278, filed Oct. 4, 2019, now U.S. Pat. No. 11,411,254, which is a continuation of PCT Application No. PCT/US2018/026601, filed Apr. 6, 2018, which claims the benefit of U.S. Provisional Patent Application No. 62/483,208, filed Apr. 7, 2017, each of which are entirely incorporated herein by reference.

### BACKGROUND

Various devices are configured for use at elevated (or high) temperatures. Examples of such devices include elevated temperature batteries, which are devices capable of converting stored chemical energy into electrical energy. Batteries may be used in many household and industrial applications. Another example of a high temperature device is a chemical vapor deposition chamber such as those used in the fabrication of semiconductor devices. Another example of a high temperature device is a chemical process vessel, a transfer pipe, or storage vessel designed to process, transport, contain and/or store reactive metals. These devices typically may operate at a temperature at or in excess of 300 °C.

### SUMMARY

Recognized herein are various limitations associated with elevated (or high) temperature devices. For instance, some batteries operate at high temperatures (e.g., at least about 100 °C or 300 °C) and have reactive material vapors (e.g., reactive metal vapors such as, for example, vapors of lithium, sodium, potassium, magnesium or calcium) that may need to be sufficiently contained within the devices. Other examples of high temperature reactive material devices include nuclear (e.g., fusion and/or fission) reactors that use a molten salt or metal (e.g., molten sodium or lithium or molten sodium- or lithium-containing alloys) as a coolant, devices for manufacturing semiconductors, heterogeneous reactors, and devices for producing (e.g., processing) and/or handling (e.g., transporting or storing) reactive materials (e.g., reactive chemicals such as, for examples, a chemical with a strong chemical reducing capability, or reactive metals such as, for example, lithium or sodium). Such devices may need to be sufficiently sealed from an external environment during use (e.g., to prevent device failure, prolong device use, or avoid adverse health effects on users or operators of such devices), and/or may need a protective lining in the device to avoid corrosion of the container.

The present disclosure provides ceramic materials that may be used in high temperature devices and/or in other devices, including, for example, strengthened ceramics used in ballistic protection systems and devices (e.g., ballistic penetration resistant armor).

The present disclosure provides seals and/or reactor vessel linings for energy storage devices and other devices having (e.g., containing or comprising) reactive materials (e.g., reactive metals) and operating at high temperatures (e.g., at least about 100 °C or 300 °C). The energy storage devices (e.g., batteries) may be used within an electrical power grid or as part of a standalone system. The batteries may be charged from an electricity production source for later discharge when there is a demand for electrical energy consumption.

An aspect of the present disclosure provides an electrochemical cell comprising (a) a container comprising a reactive material maintained at a temperature of at least about 200 °C; and (b) a double seal that seals the container from an environment external to the container. The double seal comprises a first seal that is stable when in contact with the reactive material and a second seal that is stable when in contact with the external environment, such that (i) the first seal comprises a solid material that is not stable when in contact with the external environment or (ii) the second seal comprises a solid material that is not stable when in contact with the reactive material. In some cases, (i) the first seal comprises a solid material that is not stable when in contact with the external environment and (ii) the second seal comprises a solid material that is not stable when in contact with the reactive material. The reactive material can comprise a reactive metal or vapor thereof. The reactive metal can be molten or liquid. The reactive material can comprise molten salt or a vapor thereof. The first seal can resist corrosion by molten lithium or a molten lithium salt. The second seal can resist oxidation by air resulting in an increase in a leakage rate of the second seal. The first seal and the second seal can each be hermetic. The first seal and the second seal can each provide a seal between the container and a conductor that protrudes through the container through an aperture in the container. The first seal and the second seal can each comprise a ceramic component and a metal collar adjacent to the ceramic component. The double seal can comprise a seal arranged in a circumferential configuration, a seal arranged in a stacked configuration, or a combination thereof. In some cases, the electrochemical cell further comprises a pocket filled with inert gas between the first seal and the second seal. The double seal can surround a conductor, a thermocouple or a voltage sensor coupled to the container. The double seal can electrically isolate the conductor from the container.

Another aspect of the present disclosure provides a method to seal an electrochemical cell comprising (a) providing a container comprising a reactive material maintained at a temperature of at least about 200 °C; and (b) sealing the container with a double seal that seals the container from an environment external to the container. The double seal comprises a first seal that is stable when in contact with the reactive material and a second seal that is stable when in contact with the external environment, such that (i) the first seal comprises a solid material that is not stable when in contact with the external environment or (ii) the second seal comprises a solid material that is not stable when in contact with the reactive material. The sealing can comprise (i) sealing the first seal in an environment comprising a first inert gas, thereby capturing the first inert gas inside the container; (ii) sealing the second seal, thereby forming a pocket between the first seal and the second seal; (iii) filling the pocket with a second inert gas via a port; and (iv) sealing the port, thereby sealing the pocket and capturing the second inert gas in the pocket. The first or second inert gas can comprise helium (He), or a mixture of argon (Ar) and helium. The first or second inert gas can comprise between about 1% and 5% He with balance Ar. The port can comprise a hole through a conductor that protrudes through the container through an aperture in the container, or a hole through a bushing between the first seal and the second seal. The sealing in (iv) can comprise closing the port via a weld.

Another aspect of the present disclosure provides an electrochemical cell comprising (a) a container comprising a reactive material maintained at a temperature of at least about 200 °C; and (b) a seal in the container that seals the container from an environment external to the container. The seal comprises a ceramic component exposed to the reactive material and at least two metal sleeves joined to the ceramic component. The seal is arranged in a stacked configuration with face-sealing interfaces that are substantially perpendicular to a direction parallel to a conductor that passes through the seal. At least one of the face-sealing interfaces is configured as a concentric accordion joint. The at least two metal sleeves are flexible, thereby allowing the seal to absorb at least a portion of internal thermal stresses during operation of the electrochemical cell. The seal can be hermetic. The ceramic component can comprise aluminum nitride (AlN). The at least two metal sleeves can comprise zirconium (Zr) or stainless steel. The temperature can be at least about 300 °C. The seal can be maintained at a temperature of least about 300 °C. The seal can be stable when in contact with the reactive material and not stable when in contact with the external environment. In some cases, the electrochemical cell further comprises additional ceramic components distributed in a vertically symmetric configuration around the ceramic component. In some cases, the electrochemical cell further comprises a first coupler between the container and a first of the at least two metal sleeves. The first coupler can be flexible, thereby allowing the seal to absorb at least a portion of internal thermal stresses. In some cases, the electrochemical cell further comprises a second coupler between the conductor and a second of the at least two metal sleeves. The at least two metal sleeves, the first coupler and the second coupler can be configured with 30° slopes to allow for (i) self-fixturing of the seal during assembly at room temperature and/or (ii) when the seal is at its brazing temperature. The face-sealing interfaces can comprise 0.060″ wide braze joints. The ceramic component can be chamfered. The at least two metal sleeves and the first coupler can comprise angled self-fixturing features. The conductor can self-fixture with the second coupler.

Another aspect of the present disclosure provides an electrochemical cell comprising (a) a container comprising a reactive material maintained at a temperature of at least about 200 °C; and (b) a seal in the container that seals the container from an environment external to the container. The seal comprises a ceramic component and at least two metal sleeves joined to the ceramic component. The seal is stable when in contact with the external environment. The seal is not stable when in contact with the reactive material. The seal can be hermetic. The temperature can be at least about 300 °C. The seal can be maintained at a temperature of least about 300 °C. In some cases, the ceramic component is not exposed to the reactive material. In some cases, the electrochemical cell further comprises an additional seal that is stable when in contact with the reactive material nested within the seal. The seal can be configured to bear a vertical load of at least about 10 Newtons, thereby allowing at least a portion of the load to be transferred to the container as opposed to the additional seal. The ceramic component can comprise alumina. The at least two metal sleeves can comprise alloy 42. A coefficient of thermal expansion (CTE) of at least one of the at least two metal sleeves can substantially match a CTE of the ceramic component, thereby reducing internal stresses within the ceramic component. The seal can have a height above a top plate of the container of less than about 2 inches, thereby reducing spacing between vertically stacked electrochemical cells. A conductor can protrude through the container through an aperture in the container. The seal can have an outer diameter of at least about 1 inch, or the aperture can be at least about 0.5 inches in diameter. A first of the at least two metal sleeves can be joined to the ceramic component and the conductor via a braze joint with a braze length of less than about 0.080 inches, thereby reducing thermal stresses at the braze joint.

Another aspect of the present disclosure provides an electrochemical cell comprising (a) a container comprising a reactive material maintained at a temperature of at least about 200 °C; and (b) a seal in the container that seals the container from an environment external to the container. The seal comprises a ceramic component exposed to the reactive material and a metal sleeve joined to the ceramic component. The seal is arranged in a stacked configuration with one or more sealing interfaces that are perpendicular to a direction parallel to a conductor that passes through the seal. The ceramic component comprises a protruding portion that substantially protrudes beyond at least one of the one or more sealing interfaces. The seal can be hermetic. The ceramic component can comprise aluminum nitride (AlN). The metal sleeve can comprise zirconium (Zr). The metal sleeve can be joined to the container. The protruding portion can be adjacent to the conductor. The protruding portion can substantially protrude beyond a sealing interface on the ceramic component. The sealing interface on the ceramic component can comprise a braze joint. The protruding portion can have a thickness that substantially exceeds a thickness of the braze joint, thereby allowing the protruding portion to substantially protrude beyond the braze joint. The ceramic component can increase or physically block an electrical shorting path between the conductor and the metal sleeve. The protruding portion can further protrude downward from the seal in a direction parallel to the conductor to allow fixturing of the seal and/or the conductor. In some cases, the electrochemical cell further comprises an additional metal sleeve joined to the conductor. The metal sleeve can be joined to the container at a bottom surface of the ceramic component and the additional metal sleeve can be joined to the conductor at a top surface of the ceramic component. The metal sleeves can be joined to the ceramic component via braze joints with substantially the same braze lengths, thereby reducing asymmetric forces on the seal. The ceramic component can comprise an inner diameter chamfer. Each of the braze joints can be 0.080 inches wide and 0.002 inches thick. Adjacent solid materials can have substantially matching coefficients of thermal expansion, thus reducing potential for cracks forming within the ceramic upon brazing or cell operation. In some cases, the electrochemical cell further comprises additional ceramic components adjacent to the ceramic component. The ceramic component can be positioned in the center of a vertical stack of ceramic components. The seal can be stable when in contact with the reactive material. In some cases, the electrochemical cell further comprises an additional seal that is stable when in contact with the external environment and within which the seal is nested. The ceramic component can be compressed upon thermal expansion of the conductor, the container, the additional seal, or a combination thereof.

Another aspect of the present disclosure provides an electrochemical cell comprising (a) a container comprising a reactive material maintained at a temperature of at least about 200 °C; and (b) a seal in the container that seals the container from an environment external to the container. The seal comprises a ceramic component exposed to the reactive material and a metal sleeve joined to the ceramic component. The seal is arranged in a stacked configuration with one or more sealing interfaces that are perpendicular to a direction parallel to a conductor that passes through the seal. An axially symmetric cross-section of the ceramic component comprises at least two portions that are not parallel or perpendicular to each other. The ceramic component can be substantially L-shaped. The ceramic component can comprise an inner diameter chamfer. The reactive material can comprise an alkali metal or an alkaline earth metal. The reactive material can comprise magnesium (Mg), calcium (Ca), sodium (Na), potassium (K), lithium (Li), or any combination thereof. The reactive material can further comprise one or more of tin, lead, bismuth, antimony, tellurium, and selenium. The reactive material further can comprise a Group 12 element. The ceramic material can (i) be stable when in contact with lithium, (ii) be stable when in contact with air, (iii) have a coefficient of thermal expansion (CTE) substantially similar to a CTE of stainless steel, and (iv) be electrically insulating. The ceramic material can comprise aluminum nitride (AlN), silicon nitride (Si₃N₄), magnesium oxide (MgO) or neodymium oxide (Nd₂O₃). The container and/or the conductor can comprise 400-series steel, 300-series steel, nickel, titanium, zirconium, or any combination thereof. In some cases, the electrochemical cell further comprises a sheath or liner between at least a portion of the reactive material and the container. The sheath or liner can comprise graphite. In some cases, the electrochemical cell further comprises a lining or coating that covers an interior portion of the container. The lining or coating can comprise an oxide material with a coefficient of thermal expansion (CTE) substantially similar to a CTE of the container. The CTE of the oxide material can differ from the CTE of the container by less than about 20%. The oxide material can be stable when in contact with the reactive material. The oxide material can comprise one or more of neodymium oxide (Nd₂O₃), cerium oxide (CeO₂) and lanthanum oxide (La₂O₃), the container can comprise stainless steel, and the reactive material can comprise lithium.

Another aspect of the present disclosure provides an electrochemical cell comprising (a) a container comprising a reactive material maintained at a temperature of at least about 200 °C; and (b) a seal in the container that seals the container from an environment external to the container. The seal comprises a ceramic component exposed to the reactive material and a metal sleeve joined to the ceramic component. The ceramic component comprises a lanthanide oxide. The ceramic component comprises grains with a size of less than about 50 microns (μm). The lanthanide oxide can comprise neodymium oxide (Nd₂O₃). The seal can further comprise a metallization layer bonded to the ceramic component, wherein the ceramic component and the metallization layer form a pre-metallized ceramic component, wherein the metallization layer comprises greater than 50 at % niobium (Nb). In some cases, the ceramic component further comprises less than or equal to about 10 weight percent yttrium oxide (Y₂O₃). The ceramic component can further comprise greater than or equal to about 5 weight percent silicon carbide (SiC). The metal sleeve can comprise alloy 52 or 18CrCb ferritic stainless steel. In some cases, the ceramic component further comprises greater than or equal to about 3 weight percent of a different oxide material. In some cases, the seal further comprises a first layer coated onto the ceramic component, the first layer comprising yttrium (Y). The seal can further comprise a second layer coated onto the first layer, the second layer comprising chromium (Cr) or rhenium (Re). The ceramic component, the first layer and the second layer can form a pre-metallized ceramic component. The seal can further comprise a third layer joining the pre-metallized ceramic component to the metal sleeve, the third layer comprising a nickel (Ni)-based material. The materials of the first, second and third layers can form at most one intermetallic compound with each other. The first, second and third layers can form a layered braze between the ceramic component and the metal sleeve. In some cases, the seal further comprises a metallization powder bonded to the ceramic component to form a first layer and a second layer on the ceramic component. The ceramic component, the first layer and the second layer can form a pre-metallized ceramic component. At least one of the first layer and second layer can comprise a mutual reaction compound of the metallization powder and the ceramic component. The metallization powder can comprise a metal powder mixed with a ceramic or glass material. The metallization powder can comprise a metal selected from at least one of manganese (Mn) and molybdenum (Mo). The metallization powder can comprise at least about 10% Mn, at least about 10%, 20%, 50%, or 70% Mo and at least about 2% aluminum nitride (AlN). The first layer can comprise a mutual reaction compound of the ceramic or glass material and the ceramic component. The second layer can comprise the metal. The ceramic or glass material can comprise aluminum nitride (AlN), and the mutual reaction compound can comprise Nd₂AlO₃N. The metallization powder can be applied to the ceramic component as a slurry or paint. The metallization powder can be melted at a temperature of greater than or equal to about 1330 °C. The seal can further comprise a third layer joining the pre-metallized ceramic component to the metal sleeve, the third layer comprising nickel (Ni), copper (Cu) or a combination thereof. The first, second and third layers can form a layered braze between the ceramic component and the metal sleeve. The container can further comprise a lining or coating comprising an oxide material that covers an interior portion of the container. The oxide material can be stable when in contact with the reactive material. The oxide material can comprise a lanthanide oxide. The container can further comprise a molten metal negative electrode that comprises at least a portion of the reactive material. At the temperature of the electrochemical cell, the ceramic component can be stable (i) when in contact with the reactive material or (ii) when in contact with the external environment. At the temperature of the electrochemical cell, the ceramic component can be stable (i) when in contact with the reactive material and (ii) when in contact with the external environment. The reactive material can be lithium. The ceramic component can comprise grains with a size of less than about 10 μm. The metal sleeve can comprise stainless steel, and the ceramic component can have a coefficient of thermal expansion that is less than about 10% different than a coefficient of thermal expansion of the metal sleeve. The metal sleeve can comprise a nickel alloy, and the ceramic component can have a coefficient of thermal expansion that is less than about 10% different than a coefficient of thermal expansion of the metal sleeve. The metal sleeve can comprise at least about 40% nickel. The metal sleeve can comprise at least about 50% nickel. The metal sleeve can comprise at least about 95% or 99% nickel. The seal can surround a conductor that protrudes through the container through an aperture in the container.

Another aspect of the present disclosure provides an electrochemical cell comprising (a) a container comprising a reactive material maintained at a temperature of at least about 200 °C; and (b) a seal in the container that isolates the container from an environment external to the container. The seal comprises a ceramic component exposed to the reactive material and a metal sleeve joined to the ceramic component. The ceramic component comprises a primary ceramic material and a secondary ceramic material. The primary ceramic material comprises aluminum nitride (AlN). The secondary ceramic material increases a strength of the primary ceramic material by at least about 1%. The secondary ceramic material can comprise yttrium oxide (Y₂O₃), silicon carbide (SiC), or a combination thereof. The secondary ceramic material can be included in the ceramic component in an amount that is greater than or equal to about 3 weight percent Y₂O₃, greater than or equal to about 25 volume percent SiC, or a combination thereof. The secondary ceramic material can be included in the ceramic component in an amount that is less than or equal to about 3 weight percent Y₂O₃, less than or equal to about 25 volume percent SiC, or a combination thereof. The secondary ceramic material can be included in the ceramic component in an amount that is less than about 5 or 3 weight percent Y₂O₃, greater than or equal to about 15 or 25 volume percent SiC, or a combination thereof. The secondary ceramic material can be included in the ceramic component in an amount that is greater than or equal to about 3 weight percent Y₂O₃, less than about 25 volume percent SiC, or a combination thereof. The seal can be stable when in contact with the reactive material. The metal sleeve can have a coefficient of thermal expansion that is greater than or equal to about 10 microns per meter per degree Celsius (μm/m/°C). The ceramic component can comprise grains with a size of less than about 50 microns (μm). The primary ceramic material and the secondary ceramic material can comprise grains with different sizes. The seal can further comprise a metallization powder bonded to the ceramic component to form a first layer and a second layer on the ceramic component. The metallization powder can comprise a metal powder and a ceramic or glass material. The ceramic component, the first layer and the second layer can form a pre-metallized ceramic component. The metallization powder can comprise a metal selected from at least one of manganese (Mn) and molybdenum (Mo). The metallization powder can comprise at least about 10% Mn, at least about 10% Mo and at least about 2% neodymium oxide (Nd₂O₃). The metallization powder can comprise at least about 10% Mn, at least about 10% Mo and at least about 10% neodymium oxide (Nd₂O₃). The metallization powder can comprise at least about 10% Mn, at least about 10% Mo and at least about 20% neodymium oxide (Nd₂O₃). The first layer can comprise a mutual reaction compound of the ceramic or glass material and the ceramic component. The second layer can comprise the metal. The mutual reaction compound can comprise Nd₂AlO₃N. The seal can further comprise a third layer joining the pre-metallized ceramic component to the metal sleeve, the third layer comprising nickel (Ni), copper (Cu) or a combination thereof. At least a portion of the third layer can comprise at least about 82% Ni. The first, second and third layers can form a layered braze between the ceramic component and the metal sleeve.

In another aspect, the present disclosure provides a ceramic material comprising at least about 30 weight percent (wt %) neodymium oxide (Nd₂O₃), wherein the ceramic material has a strength of greater than or equal to about 150 MPa.

In some embodiments, the ceramic material comprises at least about 40 wt % Nd₂O₃. In some embodiments, the ceramic material comprises at least about 50 wt % Nd₂O₃. In some embodiments, the ceramic material comprises at least one of Nd₂O₃, ZrO₂ and Nd₂Zr₂O₇ crystal structures, and wherein the ceramic material comprises less than or equal to about 38.7 atomic percent (at %) Nd and 60.2 at % O, and greater than or equal to about 1.1 at % Zr as measured on an atomic percentage basis.

In some embodiments, the ceramic material further comprises at least one of SiC, TiC and Y₂O₃. In some embodiments, the ceramic material further comprises at least one of tetragonal zirconia polycrystal (TZP), ZrO₂, SiC, TiC and Y₂O₃. In some embodiments, at least a portion of the ceramic material comprises grains with a size of less than about 50 microns (μm). In some embodiments, a grain size of the SiC in the ceramic material is less than about 1 μm. In some embodiments, the ceramic material has a coefficient of thermal expansion (CTE) of between about 8 ppm/K and 11 ppm/K for a temperature range of between about 20 °C and 500 °C. In some embodiments, the ceramic material retains mechanical strength after exposure to air at a temperature of at least about 400 °C for at least about 100 hours. In some embodiments, the ceramic material retains mechanical strength after being submerged in a reactive material at a temperature of at least about 400 °C for at least about 8 hours. In some embodiments, the reactive material comprises lithium metal-saturated molten LiCl—LiBr—LiF salts. In some embodiments, the ceramic material retains mechanical strength after being submerged in water at a temperature of at least about 25 °C for at least about 100 hours. In some embodiments, the ceramic material further comprises greater than or equal to about 15 at % Nd, 1.5 at % Zr, 5.2 at % Ti and 5.2 at % C, and less than or equal to about 54.1 at % O. In some embodiments, the ceramic material further comprises greater than or equal to about 15 at % Nd, 2.5 at % Y, 2.3 at % Zr, 7.1 at % Si and 7.1 at % C, and less than or equal to about 51.9 at % O.

In some embodiments, the ceramic material has a strength greater than or equal to about 200 MPa. In some embodiments, the ceramic material has a strength greater than or equal to about 300 MPa. In some embodiments, the ceramic material functions as a dielectric insulator in a device that contains one or more reactive materials. In some embodiments, the device operates at a temperature of at least about 300 °C. In some embodiments, the device is associated with a nuclear fission or fusion reactor. In some embodiments, the ceramic material functions as a protective lining in a reactor chamber that contains reactive material. In some embodiments, the reactor chamber contains reactive material at an operating temperature of greater than about 300 °C. In some embodiments, the reactive material is a reactive liquid metal. In some embodiments, the dielectric insulator is part of a gas-tight seal. In some embodiments, the device is a liquid metal battery cell. In some embodiments, the liquid metal battery cell comprises molten lithium metal and molten salts. In some embodiments, the liquid metal battery cell is operated at a temperature of at least about 300 °C. In some embodiments, the seal comprises a ceramic-to-metal joint. In some embodiments, the ceramic-to-metal joint comprises a layered assembly that includes the ceramic material, and a braze layer bonded to a metal sleeve. In some embodiments, the ceramic-to-metal joint further comprises a metallization layer bonded between the ceramic material and the braze layer. In some embodiments, the metallization layer comprises a primary metallization metal that includes niobium (Nb). In some embodiments, the metallization layer further comprises a secondary metallization metal that includes Ti, Cr, Al, Mo or any combination thereof. In some embodiments, the metallization layer comprises a ceramic powder material comprising Nd₂O₃, AlN, Y₂O₃, TiO₂, Al₂O₃, CaO, SrO or any combination thereof. In some embodiments, the braze layer comprises a Ni-based braze alloy. In some embodiments, the braze layer comprises BNi-2, BNi-7 or BNi-5b braze alloy.

In some embodiments, the metal sleeve comprises 18CrCb ferritic stainless steel, 441 stainless steel, Inconel 600, ATI alloy 600 or Hastelloy S. In some embodiments, the metal sleeve material has a thickness of greater than or equal to about 75 μm.

Another aspect of the present disclosure provides a ceramic material comprising aluminum nitride (AlN); and at least one of silicon carbide (SiC) and titanium carbide (TiC), wherein at least a portion of the at least one of SiC and TiC is in particle form other than whiskers. The ceramic material can have a grain size of less than about 50 microns (μm) and a porosity of less than about 1%.

In some embodiments, the ceramic material further comprises yttria (Y₂O₃), and wherein the ceramic material comprises about 3 weight percent (wt %) Y₂O₃ and at least about 25 volume percent (vol %) SiC. In some embodiments, the ceramic material has a tensile strength greater than about 400 MPa.

In some embodiments, a device for protecting against ballistic penetration comprises the ceramic material. In some embodiments, the device is ballistic armor.

In some embodiments, a high temperature device containing reactive material(s) comprises a seal comprising the ceramic material.

In some embodiments, the ceramic material further comprises at least about 3 wt % Nd₂O₃. In some embodiments, the ceramic material further comprises at least about 5 wt % Nd₂AlNO₃. In some embodiments, the ceramic material further comprises at least about 5 vol % SiC. In some embodiments, the ceramic material further comprises at least about 20 vol % SiC. In some embodiments, the ceramic material has a tensile strength of at least about 400 MPa.

In some embodiments, a device for holding reactive material(s) at an operating temperature greater than about 300 °C comprises a seal comprising the ceramic material.

In some embodiments, ballistic armor comprises the ceramic material.

In some embodiments, a grain size of the SiC in the ceramic material is less than or equal to about 1 μm. In some embodiments, the grain size of the SiC in the ceramic material is less than or equal to about 0.7 μm. In some embodiments, the grain size of the SiC in the ceramic material is less than or equal to about 0.45 μm.

In some embodiments, the ceramic material comprises at least about 30 weight percent (wt %) AlN. In some embodiments, the SiC is in particle form other than whiskers.

In some embodiments, the ceramic material further comprises greater than or equal to about 20 at % Al, 20 at % N, 0.6 at % Y, 0.8 at % O, 5.2 at % Si, and 5.2 at % C. In some embodiments, the ceramic material further comprises greater than or equal to about 20 at % Al, 20 at % N, 0.4 at % Nd, 0.6 at % O, 5.2 at % Si, and 5.2 at % C. In some embodiments, the ceramic material further comprises greater than or equal to about 20 at % Al, 20 at % N, 0.4 at % Nd, 0.6 at % O, 1.8 at % Ti, and 1.8 at % C. In some embodiments, the ceramic material further comprises at least about 5 wt % TiC.

In another aspect, the present disclosure provides an electrochemical cell comprising (a) a container comprising a reactive material maintained at a temperature of at least about 200 °C; (b) a seal in the container that isolates the container from an environment external to the container, the seal comprising a ceramic component exposed to the reactive material and a metal sleeve joined to the ceramic component; and (c) a coating on an external surface of the seal to protect the metal sleeve and/or the ceramic component from excessive oxidation, the coating comprising phosphorus (P) and oxygen (O).

In some embodiments, the electrochemical cell further comprises aluminum (Al). In some embodiments, the coating comprises aluminophosphate glass. In some embodiments, the coating comprises Al—O—Al bonds. In some embodiments, the coating comprises nanometer scale carbon particles. In some embodiments, the nanometer scale carbon particles are encapsulated within the aluminophosphate glass. In some embodiments, the coating comprises phosphate glass. In some embodiments, the coating comprises amorphous glass.

The present disclosure recognizes a need for energy storage devices (e.g., batteries) that are capable of storing a large amount of energy and are transportable on a vehicle (e.g., truck). Several aspects of the energy storage devices are described.

An aspect of the present disclosure provides an energy storage device comprising at least one liquid metal electrode, wherein the energy storage device has an energy storage capacity of at least about 1 kWh and a response time less than or equal to about 100 milliseconds (ms).

Another aspect of the present disclosure provides an energy storage device comprising at least one liquid metal electrode stored in a container at a temperature greater than or equal to about 250 °C, wherein the energy storage device has an energy storage capacity of at least about 1 kWh, and wherein the container has a surface area-to-volume ratio that is less than or equal to about 100 m⁻¹.

Another aspect of the present disclosure provides an energy storage device comprising at least one liquid metal electrode, wherein the energy storage device maintains at least 90% of its energy storage capacity after 100 charge/discharge cycles, and wherein the energy storage device has an energy storage capacity of at least about 1 kWh.

Another aspect of the present disclosure provides an energy storage device comprising at least one liquid metal electrode, wherein the device is transportable on a vehicle and has an energy storage capacity of at least about 1 kWh, and wherein the energy storage device is transportable with at least any two of an anode, cathode and electrolyte of the energy storage device in solid state.

Another aspect of the present disclosure provides an energy storage device comprising a container containing one or more cells, an individual cell of the one or more cells containing at least one liquid metal electrode, wherein a rate of heat generation in the cell during charge/discharge is about equal to a rate of heat loss from the cell.

Another aspect of the present disclosure provides a separator-less energy storage device comprising a container with at least one liquid metal electrode, wherein the container has a surface area-to-volume ratio that is less than or equal to about 100 m⁻¹, and the separator-less energy storage device has (i) a response time less than or equal to about 100 milliseconds (ms), and/or (ii) an energy storage capacity of at least about 1 kWh.

Another aspect of the present disclosure provides a method for forming an energy storage device, comprising shipping a container comprising an energy storage material in solid state to a destination location, and at the destination location supplying energy to the energy storage material to form at least one of a liquid metal anode, liquid metal cathode, and liquid electrolyte, thereby forming the energy storage device.

Another aspect of the present disclosure provides an energy storage system, comprising: (a) a container comprising one or more energy storage cells, wherein an individual energy storage cell of the one or more energy storage cells comprises an energy storage material comprising at least one liquid metal electrode; and (b) a control system comprising a processor with machine-executable code for monitoring at least one temperature of the one or more energy storage cells and/or the container, wherein the processor regulates the flow of electrical energy into at least a subset of the one or more energy storage cells such that the energy storage material undergoes sustained self heating during charge/discharge.

Another aspect of the present disclosure provides an energy storage device comprising at least one electrochemical cell having an operating temperature, the at least one electrochemical cell comprising: (a) a liquid negative electrode comprising a first metal; (b) a liquid electrolyte adjacent to the liquid negative electrode; and (c) a liquid positive electrode adjacent to the liquid electrolyte, the liquid positive electrode comprising a second elemental metal that is different than the first metal, wherein the liquid electrolyte comprises a charged species of the first metal and an oppositely charged species of the second metal, and wherein the energy storage device is capable of being transported on a vehicle.

Another aspect of the present disclosure provides an energy storage device comprising a molten salt, wherein a liquid electronic conductor is extracted from the molten salt by oxidation and metal is extracted from the molten salt by reduction, and wherein the energy storage device is capable of being transported on a vehicle.

Another aspect of the present disclosure provides an electrometallurgical cell comprising a positive electrode and a negative electrode, wherein the electrodes are liquid, the reactants of reactions that occur at the electrodes are liquid, and the products of reactions that occur at the electrodes are liquid, and wherein the electrometallurgical cell is capable of being transported on a vehicle.

Another aspect of the present disclosure provides an energy storage device capable of being transported on a vehicle and having a power capacity of greater than 1 MW and: (a) a physical footprint smaller than about 100 m²/MW; (b) a cycle life greater than 3000 deep discharge cycles; (c) a lifespan of at least 10 years; (d) a DC-to-DC efficiency of at least 65%; (e) a discharge capacity of at most 10 hours; and (f) a response time of less than 100 milliseconds.

Another aspect of the present disclosure provides an energy storage device comprising a liquid electrode, the electrode comprising an additive, wherein the electrode is consumed and the additive is concentrated by operation of the device, and wherein a property of the device is determined by of the concentration of the additive, and wherein the energy storage device is capable of being transported on a vehicle.

Another aspect of the present disclosure provides an energy storage device comprising a liquid antimony electrode, a steel container and a layer of iron antimonide disposed therebetween, wherein the device is operated at less than 738 °C, and wherein the energy storage device is capable of being transported on a vehicle.

Another aspect of the present disclosure provides an energy storage device comprising a liquid electrode and a current collector in contact with the electrode, wherein the liquid electrode is consumed in a reaction during operation of the device, and wherein the amount of liquid electrode is in stoichiometric excess relative to other reactants of the reaction such that the current collector is in contact with the liquid electrode when the reaction has proceeded to completion, and wherein the energy storage device is capable of being transported on a vehicle.

Another aspect of the present disclosure provides an energy storage device comprising an alkaline earth metal present in each of a positive electrode, a negative electrode and a liquid electrolyte, wherein the energy storage device is capable of being transported on a vehicle.

Another aspect of the present disclosure provides an energy storage device comprising an alkaline earth metal present in each of an elemental form, an alloy form and a halide form, wherein the energy storage device is capable of being transported on a vehicle.

Another aspect of the present disclosure provides an energy storage device comprising a liquid anode, a liquid cathode and a liquid electrolyte disposed therebetween, wherein the thickness of the electrolyte is substantially constant through a charge-discharge cycle of the device, and wherein the energy storage device is capable of being transported on a vehicle.

Another aspect of the present disclosure provides an energy storage device comprising a liquid anode, a liquid cathode and a liquid electrolyte disposed therebetween, wherein the thickness of the electrolyte is less than 50% of the thickness of the cathode or the anode, and wherein the energy storage device is capable of being transported on a vehicle.

Another aspect of the present disclosure provides an energy storage device comprising a liquid electrode comprising an elemental alkaline earth metal and an electrolyte comprising a halide of the alkaline earth metal, wherein the electrolyte further comprises complexing ligands, and wherein the energy storage device is capable of being transported on a vehicle.

Another aspect of the present disclosure provides an energy storage device comprising a conductive housing comprising a conductive liquid anode, a conductive liquid cathode and an electrolyte disposed therebetween, wherein the interior surface of the container is not electrically insulated, and wherein the energy storage device is capable of being transported on a vehicle.

Another aspect of the present disclosure provides an energy storage device comprising an anode comprising a first electronically conductive liquid and a cathode comprising a second electronically conductive liquid, wherein the device is configured to impede mixing of the electronically conductive liquids, and wherein the energy storage device is capable of being transported on a vehicle.

Another aspect of the present disclosure provides an energy storage device comprising a negative electrode comprising an alkali metal, a positive electrode comprising the alkali metal and one or more additional elements and a liquid electrolyte disposed between the electrodes, wherein the electrolyte is not depleted upon charging or discharging of the device, and wherein the energy storage device is capable of being transported on a vehicle.

Another aspect of the present disclosure provides an energy storage device comprising a liquid metal electrode, a second metal electrode that is a liquid and an electrolyte disposed between the electrodes, wherein the electrolyte is a paste, and wherein the energy storage device is capable of being transported on a vehicle.

Another aspect of the present disclosure provides an energy storage device comprising a liquid negative electrode comprising an alkali metal, a liquid positive electrode comprising an alloy of the alkali metal and an electrolyte disposed between the electrodes, wherein the electrolyte comprises a salt of the alkali metal and particles, and wherein the energy storage device is capable of being transported on a vehicle.

Another aspect of the present disclosure provides an energy storage device comprising a metal anode, a metal cathode and an electrolyte disposed between the electrodes, wherein the anode, cathode and electrolyte are liquids at an operating temperature of the device and the operating temperature of the device is less than 500 °C, and wherein the energy storage device is capable of being transported on a vehicle.

Another aspect of the present disclosure provides a method for charging an energy storage device comprising connecting an external charging circuit to terminals of the energy storage device that is capable of being transported on a vehicle such that an active alkali metal moves from a positive electrode, through an electrolyte, to a negative electrode comprising a metal having a higher chemical potential than the positive electrode.

Another aspect of the present disclosure provides a method for discharging an energy storage device comprising connecting an external load to terminals of the energy storage device that is capable of being transported on a vehicle such that an active alkali metal moves from a negative electrode, through an electrolyte as cations, to a positive electrode where the active alkali metal forms a neutral metal having a lower chemical potential than the negative electrode.

Another aspect of the present disclosure provides an energy storage device comprising a liquid metal electrode, an electrolyte and a current collector in contact with the electrode, wherein the current collector comprises a material that has a greater wetability with the liquid metal than with the electrolyte.

Another aspect of the present disclosure provides an electrochemical energy storage device comprising an anode, a cathode and an electrolyte between said anode and said cathode, wherein the device is not capable of conducting ions through said electrolyte at a first temperature, and wherein the device is capable of conducting ions through said electrolyte at a second temperature that is greater than said first temperature, and wherein said device is configured to be transported at the first temperature at a potential difference between said anode and said cathode that is less than 1 volt.

Another aspect of the present disclosure provides an electrochemical energy storage device comprising a negative electrode and a positive electrode and an electrolyte disposed between said negative and positive electrodes, wherein the electrochemical energy storage device has a first potential difference between the negative and positive electrodes at a first temperature that is less than about 50 °C and a second potential difference between the negative and positive electrodes at a second temperature of at least about 250 °C, wherein the second potential difference is greater than the first potential difference.

Another aspect of the present disclosure provides a method for forming an energy storage system, comprising: (a) forming, at a first location, an energy storage device comprising a negative electrode and a positive electrode, and an electrolyte between the negative electrode and the positive electrode, wherein the negative electrode, positive electrode and electrolyte are in the liquid at an operating temperature of the energy storage device; and (b) placing the energy storage device on a vehicle that is configured to transport the energy storage device from the first location to a second location.

While batteries are presently available, recognized herein are various limitations associated with such batteries. For example, rechargeable batteries may not be able to retain a given energy density after a certain number of charge/discharge cycles, making the long term use of these devices practically infeasible. While some batteries may have longer operating lifetimes than others, such batteries may not have an energy density that is suited for commercial use.

Recognized herein is the need for improved batteries and systems for operating such batteries. Also recognized herein is a need for methods for detecting a failure or fault condition in an electrochemical energy storage device, such as a liquid metal battery. The failure condition can be a breach. The breach can include a fault in the seal of the electrochemical cell which allows a gas from an atmosphere to contact the materials inside the housing of the electrochemical cell.

Provided herein are methods for detecting a failure or fault condition in an electrochemical energy storage device, such as a seal breach, using an electrical signature. In some cases, a breached cell is inactivated, cooled, discharged and/or replaced.

The present disclosure also provides energy storage systems comprising energy storage devices (e.g., electrochemical systems and/or high temperature energy storage devices such as, for example, liquid metal batteries) and battery management systems for monitoring and/or regulating the energy storage devices (e.g., liquid metal batteries). A liquid metal battery can include one or more electrochemical cells (“cells”) in a parallel and/or serial configuration. A battery management system can be programmed or otherwise configured to regulate the operation (e.g., charging, discharging, cell balancing, routing current) of the energy storage device (e.g., liquid metal battery). The battery management system can regulate the charging and discharging of the cells in tandem (or substantially in tandem) when the cells are connected together in series or parallel. The battery management system can monitor the operation of the energy storage device. The battery management system can be programmed or otherwise configured to use dynamic impedance control.

For serial operation, the battery management system can include voltage sensing of cells and ballasting provisions that are connected to the battery management system through ballasting lines. In some examples, the ballasting lines are electrical wires. The impedance of the ballasting lines, however, can impact the amount of voltage drop across the lines. The impedance of these lines can vary with temperature and in accordance with the material used in the lines. Because the impedance of the ballasting lines can vary with temperature, and because the temperature of an electrochemical system (e.g., a liquid metal battery) can vary during use, the impedance of the ballasting lines can vary during operation of the liquid metal battery. In some situations, algorithms of the battery management system that regulate the operation of the liquid metal battery using an assumed impedance of the ballasting lines (e.g., an impedance at room temperature) may arrive at erroneous results at higher operating temperatures. A battery management system can include hardware and software to dynamically compensate for variations in impedance. The software can be fixed in a non-volatile storage medium, such as a memory location. This can advantageously enable algorithms of the battery management system that regulate cell balancing to have a reliable metric of impedance on the sensing lines, and to thereby control balancing current appropriately.

An aspect of the disclosure relates to a method for regulating an energy storage device comprising at least one electrochemical cell comprising a negative electrode, positive electrode and an electrolyte between the negative and positive electrodes, the method comprising: (a) measuring, with the aid of a temperature sensor in thermal communication with the electrochemical cell, an operating temperature of the electrochemical cell, wherein at least one of the negative electrode, positive electrode and electrolyte are in a liquid state at the operating temperature; (b) calculating, with the aid of a battery management system, an impedance of a current flow path leading through the electrochemical cell using a correspondence between impedance and temperature stored in a memory location of the battery management system; and (c) calculating, with the aid of the battery management system, a state of charge of the electrochemical cell using the impedance calculated in (b) and a current measured through the electrochemical cell.

Another aspect of the disclosure relates to a method for detecting a breach of an electrochemical cell, the method comprising: (a) providing an electrochemical cell comprising a negative electrode, an electrolyte and a positive electrode, wherein at least one of the negative electrode, the electrolyte and the positive electrode is in a liquid state at an operating temperature of the electrochemical cell that is at least about 250 °C, and wherein a seal isolates the negative electrode, the electrolyte and the positive electrode from an environment external to the electrochemical cell; (b) monitoring the electrochemical cell for an electrical signature that is indicative of a breach of the seal and exposure of at least one of the positive electrode, the electrolyte, and the negative electrode to the environment; and (c) in response to the electrical signature, inactivating the electrochemical cell, cooling the electrochemical cell, discharging the electrochemical cell and/or notifying a system operator.

Another aspect of the disclosure relates to a computer readable medium comprising machine-executable code that, upon execution by one or more computer processors implements a method for detecting a breach of an electrochemical cell, the method comprising: (a) providing an electrochemical cell comprising a negative electrode, an electrolyte and a positive electrode, wherein at least one of the negative electrode, the electrolyte and the positive electrode is in a liquid state at an operating temperature of the electrochemical cell, wherein a seal isolates the negative electrode, the electrolyte and the positive electrode from an environment external to the electrochemical cell, and wherein the operating temperature of the electrochemical cell is at least about 250 °C; (b) monitoring the electrochemical cell for an electrical signature that is indicative of a breach of the seal and exposure of at least one of the positive electrode, the electrolyte, and the negative electrode to the environment; and (c) in response to the electrical signature, inactivating the electrochemical cell, cooling the electrochemical cell, discharging the electrochemical cell and/or notifying a system operator.

Another aspect of the disclosure provides an energy storage system, comprising: (a) an electrochemical cell comprising a negative electrode, an electrolyte and a positive electrode, wherein at least one of the negative electrode, the electrolyte and the positive electrode is in a liquid state at an operating temperature of the electrochemical cell that is at least about 250 °C, and wherein a seal isolates the negative electrode, the electrolyte and the positive electrode from an environment external to the electrochemical cell; and (b) a controller that (i) monitors the electrochemical cell for an electrical signature that is indicative of a breach of the seal and exposure of at least one of the positive electrode, the electrolyte and the negative electrode to the environment, and (ii) in response to the electrical signature, inactivates the electrochemical cell, cools the electrochemical cell, discharges the electrochemical cell and/or notifies a system operator.

Another aspect of the disclosure is directed to a system for regulating an energy storage device comprising at least one electrochemical cell having a negative electrode, a positive electrode and an electrolyte between the negative and positive electrodes, wherein at least one of the negative electrode, the electrolyte and the positive electrode of the electrochemical cell is in a liquid state at an operating temperature of the electrochemical cell that is at least about 250 °C. The system comprises at least one controller in electrical communication with the energy storage device, wherein the at least one controller is programmed to (i) monitor a first parameter that is indicative of an operating state of the electrochemical cell, (ii) determine a second parameter of the electrochemical cell based on the first parameter, and (iii) in response to the second parameter, control the operating state of the electrochemical cell.

Another aspect of the disclosure relates to a system that comprises an energy storage device comprising at least one electrochemical cell having a negative electrode, a positive electrode and an electrolyte between the negative and positive electrodes, wherein at least one of the negative electrode, the electrolyte and the positive electrode of the electrochemical cell is in a liquid state at an operating temperature of the electrochemical cell that is at least about 250 °C, wherein the energy storage device is in electrical communication with a power grid, and wherein during use the energy storage device charges and/or discharges to the power grid. The system further comprises at least one controller in electrical communication with the energy storage device and programmed to monitor and/or regulate the energy storage device, wherein the at least one controller is predominantly powered from the power grid and/or a back-up power system.

A further aspect of the disclosure relates to a system that comprises an energy storage device comprising at least one electrochemical cell having a negative electrode, a positive electrode and an electrolyte between the negative and positive electrodes, wherein at least one of the negative electrode, the electrolyte and the positive electrode of the electrochemical cell is in a liquid state at an operating temperature of the electrochemical cell that is at least about 250 °C. The system further comprises at least one controller in electrical communication with the energy storage device and programmed to (i) monitor an operating state of the energy storage device, which operating state includes the operating temperature and a voltage of the electrochemical cell, and (ii) regulate the energy storage device in response to monitoring the operating state. The at least one controller is programmed such that if the operating temperature is at least 50 °C less than a predetermined operating temperature of the energy storage device, the controller does not use the voltage to regulate the energy storage device.

An aspect of the present disclosure provides a method for detecting a breach of an electrochemical cell, comprising providing an electrochemical cell comprising a negative electrode, an electrolyte and a positive electrode, wherein at least one, any two or all of the negative electrode, the electrolyte and the positive electrode is in a liquid state at an operating temperature of the electrochemical cell, where a seal isolates the negative electrode, the electrolyte and the positive electrode from an environment external to the electrochemical cell, and where the operating temperature of the electrochemical cell is at least about 250 °C. In some cases, the electrochemical cell can be monitored for an electrical signature that is indicative of a breach of the seal and exposure of at least one of the positive electrode, the electrolyte, and the negative electrode to the environment. In response to the electrical signature, the electrochemical cell can be inactivated, cooled and/or discharged.

In another aspect of the present disclosure, a method for regulating an energy storage device comprising at least one electrochemical cell comprising a negative electrode, positive electrode and an electrolyte between the negative and positive electrodes is provided. At least one, any two or all of the negative electrode, positive electrode and electrolyte are in a liquid state at the operating temperature. The method comprises measuring, with the aid of a temperature sensor in thermal communication with the electrochemical cell, an operating temperature of the electrochemical cell. Next, with the aid of a battery management system, an impedance of a current flow path leading through the electrochemical cell can be calculated using a correspondence between impedance and temperature stored in a memory location of the battery management system. Next, with the aid of the battery management system, a state of charge of the electrochemical cell can be calculated using the calculated impedance and a current measured through the electrochemical cell.

Another aspect of the present disclosure provides machine executable code that, upon execution by one or more computer processors, implements any of the methods above or elsewhere herein. For example, the machine executable code can implement a method for regulating an energy storage device comprising at least one electrochemical cell that has a negative electrode, positive electrode and an electrolyte between the negative and positive electrodes. At least one, any two or all of the negative electrode, positive electrode and electrolyte can be in a liquid state at the operating temperature. The method can include measuring, with the aid of a temperature sensor in thermal communication with the electrochemical cell, an operating temperature of the electrochemical cell. Next, with the aid of a battery management system, an impedance of a current flow path leading through the electrochemical cell can be calculated using a correspondence between impedance and temperature stored in a memory location of the battery management system. Next, with the aid of the battery management system, a state of charge of the electrochemical cell can be calculated using the calculated impedance and a current measured through the electrochemical cell.

Another aspect of the present disclosure provides a computer system (e.g., battery management system) comprising one or more computer processors and memory coupled to the one or more computer processors. The memory comprises machine executable code that, upon execution by the one or more computer processors, implements any of the methods herein. For example, the machine executable code can implement a method for regulating an energy storage device comprising at least one electrochemical cell comprising a negative electrode, positive electrode and an electrolyte between the negative and positive electrodes. At least one, any two or all of the negative electrode, positive electrode and electrolyte can be in a liquid state at the operating temperature. The method comprises measuring, with the aid of a temperature sensor in thermal communication with the electrochemical cell, an operating temperature of the electrochemical cell. Next, with the aid of a battery management system, an impedance of a current flow path leading through the electrochemical cell can be calculated using a correspondence between impedance and temperature stored in a memory location of the battery management system. Next, with the aid of the battery management system, a state of charge of the electrochemical cell can be calculated using the calculated impedance and a current measured through the electrochemical cell.

A liquid metal energy storage device (or battery) can include a negative electrode, electrolyte and positive electrode, at least some of which may be in the liquid state during operation of the energy storage device. The battery is generally made up of a number of (electrochemical) cells. Most batteries use the cell housing as electrically insulating material.

The disclosure provides cell housings and cell packs that are designed to serve both electrical and structural functions. Cell housing side walls can be directly joined together to create parallel connections within a module of cells. The series connections can be formed by stacking one cell on top of another cell, thus connecting the opposing polarity terminals of the two cells. The cells can be designed to support the weight of the cells above without the use of significant additional framework. This approach can reduce tertiary interconnection mechanisms and/or the number of components required to electrically connect and structurally support cells, thus providing increased system efficiency and/or a reduced system cost.

An aspect of the disclosure relates to a liquid metal battery, comprising: (a) a plurality of electrochemical cells each comprising an electrically conductive housing and a conductor in electrical communication with a current collector, the electrically conductive housing comprising a negative electrode, electrolyte and positive electrode, wherein at least one of the negative electrode, electrolyte and positive electrode are in a liquid state at an operating temperature of the cell, wherein the conductor protrudes through the electrically conductive housing through an aperture in the electrically conductive housing and is electrically isolated from the electrically conductive housing with a seal, and wherein the plurality of electrochemical cells are stacked in series with the conductor of a first cell in electrical contact with the electrically conductive housing of a second cell; and (b) a plurality of non-gaseous spacers disposed between the electrochemical cells. At least 3 electrochemical cells can be stacked in series. The electrochemical cells can be stacked vertically. A thickness of each spacer can be approximately equal to a distance that the conductor protrudes through the electrically conductive housing. A displacement between the negative electrode and the positive electrode can be determined by the non-gaseous spacers. A force applied to the seal can be less than about 45 Newtons. At least 90% of a force applied to the first cell can be applied to the non-gaseous spacers and/or the electrically conductive housing of the first cell. The spacers can be electrically insulating. The the spacers can comprise a ceramic material. The conductor of the first cell can be brazed to the electrically conductive housing of the second cell. The conductor of the first cell can sit in a recessed portion of the electrically conductive housing of the second cell, wherein a coefficient of thermal expansion (CTE) of the conductor can be greater than a CTE of the electrically conductive housing. In some cases, the electrochemical cells that are connected in series are not connected by wires. The electrically conductive housings can be part of a current conducting pathway. The resistance of each cell-to-cell series connection can be less than about 100 mOhm. The resistance can be measured by a direct electrical connection between the conductor of the first electrochemical cell and the electrically conducting housing of the second cell. In some cases, the battery further comprises at least one additional electrochemical cell connected in parallel to each of the plurality of electrochemical cells that are stacked in series. The parallel connections can be made by creating the electrically conductive housing for multiple cells from one manufactured part. The parallel connections can be formed by interconnects that allow at least some of the electrochemical cells comprising the battery to be replaced without breaking a direct metal-to-metal joint. The parallel connections can be formed by welding together features in cell bodies of adjacent cells. In some cases, the battery comprises one interconnect for at least every four electrochemical cells. The battery can be capable of storing at least about 10 kWh of energy. The operating temperature can be at least about 250 °C. In some cases, the negative electrode comprises an alkali or alkaline earth metal. The alkali or alkaline earth metal can be lithium, sodium, potassium, magnesium, calcium, or any combination thereof. In some cases, the positive electrodes comprises a Group 12 element. The Group 12 element can be zinc, cadmium or mercury. In some cases, the positive electrode further comprises one or more of tin, lead, bismuth, antimony, tellurium and selenium. In some cases, the electrolyte comprises a salt of an alkali or alkaline earth metal. In some cases, each cell operates at a charge cutoff voltage of at least about 1.0 V after at least about 300 charge/discharge cycles. In some cases, each cell operates at a charge cutoff voltage of at least about 1.7 V after at least about 100 charge/discharge cycles. In some cases, the battery further comprises a current transfer plate welded to the conductor of the first cell and the electrically conductive housing of the second cell.

Another aspect of the disclosure is directed to an electrochemical energy storage system, comprising at least a first electrochemical cell adjacent to a second electrochemical cell, each of the first and second electrochemical cells comprising a negative current collector, negative electrode, electrolyte, positive electrode and a positive currently collector, wherein at least one of the negative electrode, electrolyte and positive electrode is in a liquid state at an operating temperature of the first or second electrochemical cell, and wherein the positive current collector of the first electrochemical cell is direct metal-to-metal joined to the negative current collector of the second electrochemical second cell. The positive current collector of the first electrochemical cell can be direct metal-to-metal joined to the negative current collector of the second electrochemical second cell by a braze or a weld. In some cases, the first and second electrochemical cells are not connected by wires. The electrochemical energy storage system can be capable of storing at least about 10 kWh of energy. The electrochemical energy storage system can operate at a temperature of at least about 250 °C. In some cases, the negative electrode comprises an alkali or alkaline earth metal. The alkali or alkaline earth metal can be lithium, sodium, potassium, magnesium, calcium, or any combination thereof. In some cases, the positive electrode comprises a Group 12 element. The Group 12 element can be zinc, cadmium or mercury. In some cases, the positive electrode further comprises one or more of tin, lead, bismuth, antimony, tellurium and selenium. In some cases, the electrolyte comprises a salt of an alkali or alkaline earth metal. In some cases, each cell operates at a charge cutoff voltage of at least about 1.0 V after at least about 300 charge/discharge cycles. In some cases, each cell operates at a charge cutoff voltage of at least about 1.7 V after at least about 100 charge/discharge cycles.

Another aspect of the disclosure relates to a battery comprising electrochemical cells connected in series, the battery comprising a plurality of modules each comprising electrochemical cells in a parallel configuration, wherein the battery is capable of storing at least about 10 kWh of energy, the battery has an operating temperature of at least about 250 °C and each of the electrochemical cells has at least one liquid metal electrode, wherein an internal resistance of the battery at the operating temperature is less than about 1.50*n*R, where ‘n’ is the number of modules in the battery and ‘R’ is the resistance of each of the modules. n can be at least 3. In some cases, the internal resistance of the battery at the operating temperature is less than about 1.25*n*R. In some cases, the internal resistance of the battery at the operating temperature is less than about 1.05*n*R. In some cases, the battery comprises electrochemical cells connected in series and in parallel. In some cases, the liquid metal electrode comprises one or more Group 12 elements. The Group 12 elements can be zinc, cadmium or mercury. In some cases, the liquid metal electrode further comprises one or more of tin, lead, bismuth, antimony, tellurium and selenium. In some cases, the liquid metal electrode comprises one or more alkali metals. In some cases, the liquid metal electrode comprises one or more alkaline earth metals. In some cases, the liquid metal electrode comprises lithium, sodium, potassium, magnesium, calcium, or any combination thereof. In some cases, the electrochemical cells are not connected with wires. In some cases, the battery is capable of storing at least about 10 kWh of energy. In some cases, the battery is capable of storing at least about 100 kWh of energy.

A further aspect of the disclosure relates to a liquid metal battery comprising: (a) a plurality of electrochemical cells connected in series and parallel, wherein each of the electrochemical cells comprises a negative electrode, electrolyte and positive electrode, wherein at least one of the negative electrode, electrolyte and positive electrode is in a liquid state at an operating temperature of the electrochemical cell; (b) a plurality of wires each having a first end and a second end; and (c) a common single point connector in electrical communication with at least one of the electrochemical cells, wherein each of the first ends of the wires is connected to the common single point connector. The single point connector can be connected to a busbar that is in electrical communication with the at least one of the electrochemical cells, a cell body that is in electrical communication with the at least one of the electrochemical cells or a feature in the cell body that is in electrical communication with the at least one of the electrochemical cells. The feature in the cell body can be a tab protruding from the cell body. At least one of the second ends of the wires can be connected to control circuitry. The at least one of the second ends of the wires can be connected to a battery management system. At least one of the second ends of the wires can be connected to another common single point connector. The common single point connector can form an electrical connection with another plurality of electrochemical cells. At least 3 wires can be connected to the single point connector. In some cases, the single point connector comprises a bent nickel piece. The first ends of the wires can be passed through holes in the bent nickel piece and/or welded to the bent nickel piece.

A further aspect of the disclosure is directed to a liquid metal battery comprising: (a) a first plurality of electrochemical cells connected in parallel, wherein each of the electrochemical cells comprises a negative electrode, electrolyte and positive electrode, wherein at least one of the negative electrode, electrolyte and positive electrode is in a liquid state at an operating temperature of the electrochemical cell; and (b) a busbar in electrical communication with the first plurality of electrochemical cells, wherein the busbar comprises a conductive material. The conductive material can comprise copper, and the liquid metal battery can operate at a temperature of less than about 450 °C. In some cases, the conductive material comprises an aluminum-copper alloy. The aluminum-copper alloy can have an electrical conductivity at an operating temperature of the liquid metal battery of at least about 2×10⁶ S/m. The aluminum-copper alloy can be coated with an oxidation-resistant material. The oxidation-resistant material can be aluminum, aluminum-bronze, aluminum-brass, chromium, nickel, stainless steel, or any combination thereof. In some cases, the conductive material comprises an alloy of at least about 1 weight-percent aluminum with copper, bronze or brass. The conductive material can have an electrical conductivity greater than about 2×10⁶ S/m at 20 °C or greater than about 1×10⁶ S/m at 500 °C. In some cases, the conductive material comprises stainless steel. In some cases, the conductive material comprises nickel. In some cases, the conductive material is a non-ferrous alloy. The busbar can be joined to a stainless steel end-cap. The busbar can be brazed, press-fit or welded to a stainless steel end-cap. Compared to the conductive material, the end-cap can be more easily welded to another busbar, an interconnect or an electrochemical cell. In some cases, the first plurality of electrochemical cells further comprises electrochemical cells connected in series. In some cases, the first plurality of electrochemical cells comprises a parallel string of packs. The busbar can be an interconnect. In some cases, the liquid metal battery further comprises an interconnect that electrically connects the busbar of the first plurality of electrochemical cells with a second plurality of electrochemical cells, thereby placing the first plurality and the second plurality in parallel or in series. In some cases, the interconnect comprises the same conductive material as the busbar. The operating temperature can be at least about 250 °C. An internal resistance between the first plurality of electrochemical cells and a second plurality of electrochemical cells connected to the busbar of the first plurality of electrochemical cells can be less than about 10 milliohm.

Recognized herein are various limitations associated with elevated or high temperature devices, such as, for example, battery systems (also “batteries” herein). For instance, some battery systems operate at high temperatures (e.g., at least about 100 °C or 300 °C) and comprise reactive materials (e.g., reactive metal vapors of lithium, sodium, potassium, magnesium, or calcium). Operation of such batteries can generate heat that may need to be removed from the system to maintain a stable operating temperature. In some cases, such as, for example, when the battery is idle, heat is not generated and needs to be added to the system to maintain the battery at a given operating state (e.g., to maintain electrodes and/or electrolyte in a molten state).

The present disclosure provides energy storage systems, and systems and methods for operating energy storage systems. Operation (e.g., heat management or temperature control) of an energy storage system may include providing a thermal management fluid to or from the energy storage system. In some cases, the thermal management fluid may be provided to (e.g., contacted with) the energy storage system as well as with other portions of the system (e.g., a storage reservoir, condenser or other component in the system). The thermal management fluid may contact one or more portions of the energy storage system. For example, the systems and methods herein can flow the thermal management fluid through a frame of the energy storage system to maintain the system at an operating temperature, operate the system in an energy-efficient manner, extend an operating lifetime of the system and/or enable the system to operate during periods (e.g., time periods, or periods with a given supply and/or demand level) when it can supply most value (e.g., maximum profit (value) can be derived from operation of the system) to the customer (e.g., discharge during hours of peak energy demand).

In an aspect of the present disclosure, an energy storage system comprises a plurality of electrochemical cells each comprising a negative electrode, electrolyte and positive electrode, wherein at least one, two, or all of the negative electrode, the electrolyte and the positive electrode is in a liquid state at an operating temperature of the electrochemical cell, wherein the plurality of electrochemical cells are connected in series and/or parallel; and a frame supporting the plurality of electrochemical cells, wherein the frame comprises one or more fluid flow paths for bringing a thermal management fluid in thermal communication with at least a subset of the plurality of electrochemical cells.

In an embodiment, the frame comprises tubes, pipes, or enclosed trusses. In another embodiment, the thermal management fluid is air, a gas, oil, molten salt, water, or steam. In another embodiment, the gas is argon or nitrogen. In another embodiment, the operating temperature is between about 150 °C and 750 °C. In another embodiment, the system further comprises thermal insulation surrounding the frame elements. In another embodiment, the thermal insulation enables the system to operate continuously in a self-heated configuration when charged and/or discharged at least once every two days. In another embodiment, in a self-heated configuration, the thermal insulation enables the system to increase its internal temperature above the operating temperature during regular operation, and wherein the system maintains its internal temperature at about the operating temperature by activating an actuator to allow the thermal management fluid to flow through the one or more fluid flow paths driven by natural convection.

In an embodiment, the system further comprises insulation along at least a portion of the fluid flow path to aid in removal of heat from a predetermined location within the system. In another embodiment, the insulation is thinner in a portion of the fluid flow path adjacent a heated zone of the system.

In an embodiment, the thermal management fluid does not contact the electrochemical cells. In another embodiment, the frame mechanically/structurally supports the electrochemical cells in a series and/or parallel configuration. In another embodiment, the frame is resistant to corrosion. In another embodiment, the frame comprises stainless steel. In another embodiment, the frame is chemically resistant to the thermal management fluid. In another embodiment, the frame is chemically resistant to reactive metals. In another embodiment, the system further comprises a fluid flow system that is configured and arranged to direct the thermal management fluid through the one or more fluid flow paths of the frame. In another embodiment, the fluid flow system is configured or programmed to provide the thermal management fluid at an adjustable flow rate that is selected to maintain the temperature of the system at the operating temperature. In another embodiment, the system comprises at least 10 electrochemical cells. In another embodiment, the frame comprises a chamber that contains at least a subset of the plurality of electrochemical cells. In another embodiment, at least a subset of the plurality of electrochemical cells is connected in series.

In an embodiment, the frame comprises a plurality of parallel fluid flow paths. In another embodiment, fluid flow rates through at least two of the parallel fluid flow paths are separately controllable. In another embodiment, the frame comprises a plurality of orthogonal fluid flow paths. In another embodiment, the frame is rectangular box. In another embodiment, a dimension of the frame is configured to selectively accelerate heat transfer.

In an embodiment, the system further comprises a circulatory fluid flow system that is configured to store thermal energy, wherein the one or more fluid flow paths are in fluid communication with a fluid flow path of the circulatory fluid flow system. In another embodiment, the circulatory fluid flow system comprises a thermal energy storage medium. In another embodiment, the thermal energy storage medium comprises molten salt, gravel, sand, steam or water.

In an embodiment, the negative electrode comprises an alkali or alkaline earth metal. In another embodiment, the alkali or alkaline earth metal is lithium, sodium, potassium, magnesium, calcium or a combination thereof.

In an embodiment, the positive electrode comprises a Group 12 element. In another embodiment, the Group 12 element is selected from the group consisting are zinc, cadmium, and mercury. In another embodiment, the positive electrode further comprises one or more of tin, lead, bismuth, antimony, tellurium, and selenium. In another embodiment, the positive electrode comprises one or more of tin, lead, bismuth, antimony, tellurium, and selenium.

In an embodiment, the electrolyte comprises a salt of an alkali or alkaline earth metal. In another embodiment, the system further comprises a thermal insulation package that comprises one or more layers of insulating material. In another embodiment, the system further comprises a pass-through configured and adapted to facilitate a connection between hot and cold zones of the energy storage system. In another embodiment, the system further comprises at least one wire that passes through the pass-through in a circuitous path, wherein a length of the wire is at least two times a length of the pass-through. In another embodiment, connection comprises a wire, a sensor, a cell current connection, or a cell voltage connection.

In another aspect of the present disclosure, a method for operating an energy storage system comprises (a) providing an energy storage system comprising a plurality of electrochemical cells supported by a frame structure, an individual cell of the plurality of electrochemical cells comprising a negative electrode, electrolyte and positive electrode, wherein at least one, two, or all of the negative electrode, the electrolyte and the positive electrode is in a liquid state at an operating temperature of the individual electrochemical cell, wherein the frame structure comprises one or more fluid flow paths for bringing a thermal management fluid in thermal communication with at least a subset of the plurality of electrochemical cells; and (b) directing the thermal management fluid through the one or more fluid flow paths.

In an embodiment, the thermal management fluid is directed through the one or more fluid flow paths to maintain a temperature of the individual cell, or cell parts, at the operating temperature. In another embodiment, upon directing the thermal management fluid through the one or more fluid flow paths, the temperature of the individual cell is maintained to within about +/−60 °C. In another embodiment, upon directing the thermal management fluid through the one or more fluid flow paths, the temperature of the individual cell fluctuates by at most about +/−60 °C in a time period of 10 hours, 9 hours, 8 hours, 7 hours, 6 hours, 5 hours, 4 hours, 3 hours, 2 hours, 1 hour or less.

In an embodiment, the directing of the thermal management fluid is performed to maximize the efficiency and/or operating lifetime of the energy storage system. In another embodiment, the thermal management fluid is directed at a rate that is varied over time. In another embodiment, the thermal management fluid is directed at a rate that depends on at least one of (i) a temperature of the energy storage system or electrochemical cell thereof; (ii) a rate of change of the temperature of the energy storage system or electrochemical cell thereof; (iii) whether the energy storage system is charging, discharging or idle; (iv) an anticipated future operation of the energy storage system; and (v) a current or anticipated market condition. In another embodiment, the thermal management fluid is directed at a rate that depends on at least one, two, three, four, or at least all of (i)-(v). In another embodiment, an anticipated future operation of the energy storage system comprises the time and extent of future charging, discharging and/or idle operation of the energy storage system. In another embodiment, a current or anticipated market conditions comprise the price of energy.

In an embodiment, the thermal management fluid is directed through the one or more fluid flow paths with the aid of a fluid flow system in fluid communication with the one or more fluid flow paths. In another embodiment, the fluid flow system comprises a fan, pump or convection-assisted flow.

In an embodiment, directing the thermal management fluid through the one or more fluid flow paths dissipates or adds thermal energy from the plurality of electrochemical cells at a rate of at least about 1 Watt (W). In another embodiment, directing the thermal management fluid through the one or more fluid flow paths dissipates thermal energy from or adds thermal energy to the plurality of electrochemical cells at a rate of at most about 100 kilo-Watts (kW).

In an embodiment, the method further comprises rapidly cooling at least a portion of the energy storage system in response to a potentially hazardous event. In another embodiment, the potentially hazardous event is an earthquake or a cell breach. In another embodiment, upon rapidly cooling, a temperature of a hottest of the plurality of electrochemical cells decreases from its operating temperature to a temperature below a freezing point of the electrolyte in less than about 4 hours.

In an embodiment, directing the thermal management fluid through the one or more fluid flow paths comprises directing the thermal management fluid through a plurality of fluid flow paths. In another embodiment, the thermal management fluid is directed using forced and/or natural convection. In another embodiment, flow of the thermal management fluid is directed using natural convection and is controlled by an actuator that opens a given fluid flow path of the one or more fluid flow paths.

Another aspect of the present disclosure provides a system comprising one or more computer processors and memory coupled thereto. The memory comprises a computer-readable medium with machine executable code that, upon execution by the one or more computer processors, implements any of the methods above or elsewhere herein.

In some embodiments, a control system for regulating an energy storage system comprises (a) at least one computer processor; and (b) memory operatively coupled to the computer processor, the memory comprising machine executable code that upon execution by the computer processor implements a method, the method comprising directing thermal management fluid through one or more fluid flow paths in a frame structure that supports an energy storage system, wherein the fluid flow paths bring the thermal management fluid in thermal communication with at least a subset of a plurality of electrochemical cells of the energy storage system, wherein an individual cell of the plurality of electrochemical cells comprises a negative electrode, electrolyte and positive electrode, and wherein at least two of the negative electrode, the electrolyte and the positive electrode is in a liquid state at an operating temperature of the individual electrochemical cell.

In an embodiment, the computer processor and the memory are located outside of a hot zone of the energy storage system. In another embodiment, the energy storage system further comprises a temperature sensor in the hot zone or in thermal communication with the hot zone. In another embodiment, the temperature sensor is in electronic communication with the computer processor.

In some embodiments, a computer system programmed to direct a thermal management fluid through one or more fluid flow paths of an energy storage system is provided. The energy storage system comprises a plurality of electrochemical cells supported by a frame structure, an individual cell of the plurality of electrochemical cells comprising a negative electrode, electrolyte and positive electrode, wherein at least one, two, or all of the negative electrode, the electrolyte and the positive electrode is in a liquid state at an operating temperature of the individual electrochemical cell, wherein the frame structure comprises the one or more fluid flow paths for bringing the thermal management fluid in thermal communication with at least a subset of the plurality of electrochemical cells.

In an embodiment, the directing of the thermal management fluid is performed to maintain a temperature of the individual cell, or cell parts, at the operating temperature. In another embodiment, the directing of the thermal management fluid is performed to maximize the efficiency and/or operating lifetime of the energy storage system. In another embodiment, the thermal management fluid is directed at a rate that is varied over time.

In an embodiment, the thermal management fluid is directed at a rate that depends on at least one of (i) a temperature of the energy storage system or electrochemical cell thereof; (ii) a rate of change of the temperature of the energy storage system or electrochemical cell thereof; (iii) whether the energy storage system is charging, discharging or idle; (iv) an expected (or anticipated) future operation of the energy storage system; and (v) a current or anticipated market condition. In another embodiment, the thermal management fluid is directed at a rate that depends on at least one, two, three, four, or at least all of (i)-(v). In another embodiment, the anticipated future operation of the energy storage system comprises the time and extent of future charging, discharging and/or idle operation of the energy storage system. In another embodiment, the current or anticipated market conditions comprise the price of energy.

Another aspect of the present disclosure provides a computer-readable medium comprising machine executable code that, upon execution by one or more computer processors, implements any of the methods above or elsewhere herein.

In some embodiments, a computer readable medium is provided that comprises machine-executable code that upon execution by one or more computer processors implements a method, the method comprising directing thermal management fluid through one or more fluid flow paths in a frame structure that supports an energy storage system, wherein the fluid flow paths bring the thermal management fluid in thermal communication with at least a subset of a plurality of electrochemical cells of the energy storage system, wherein an individual cell of the plurality of electrochemical cells comprises a negative electrode, electrolyte and positive electrode, and wherein at least two of the negative electrode, the electrolyte and the positive electrode is in a liquid state at an operating temperature of the individual electrochemical cell.

In an embodiment, the thermal management fluid is directed through the one or more fluid flow paths to maintain a temperature of the individual cell, or cell parts, at the operating temperature. In another embodiment, the thermal management fluid is directed through the one or more fluid flow paths to maximize the efficiency and/or operating lifetime of the energy storage system. In another embodiment, the thermal management fluid is directed through the one or more fluid flow paths at a rate that is varied over time. In another embodiment, the thermal management fluid is directed through the one or more fluid flow paths at a rate that depends on at least one, two, three, four, or at least all of (i) a temperature of the energy storage system or electrochemical cell thereof; (ii) a rate of change of the temperature of the energy storage system or electrochemical cell thereof; (iii) whether the energy storage system is charging, discharging or idle; (iv) an anticipated future operation of the energy storage system; and (v) a current or anticipated market condition. In another embodiment, the anticipated future operation of the energy storage system comprises the time and extent of future charging, discharging and/or idle operation of the energy storage system. In another embodiment, the current or anticipated market conditions comprise the price of energy.

Recognized herein are various limitations associated with elevated (or high) temperature devices. For instance, some batteries operate at high temperatures (e.g., at least about 100 °C or 300 °C) and have reactive material vapors (e.g., reactive metal vapors such as, for example, vapors of lithium, sodium, potassium, magnesium or calcium) that may need to be sufficiently contained within the devices. Other examples of high temperature reactive material devices include nuclear (e.g., fusion) reactors that use a molten salt or metal (e.g., molten sodium or lithium or molten sodium- or lithium-containing alloys) as a coolant, devices for manufacturing semiconductors, heterogeneous reactors, and devices for producing (e.g., processing) and/or handling (e.g., transporting or storing) reactive materials (e.g., reactive chemicals such as, for examples, a chemical with a strong chemical reducing capability, or reactive metals such as, for example, lithium or sodium). Such devices may need to be sufficiently sealed from an external environment during use, such as, for example, to prevent device failure, prolong device use, or avoid adverse health effects on users or operators of such devices.

The disclosure provides seals for energy storage devices and other devices having (e.g., containing or comprising) reactive materials (e.g., reactive metals) and operating at high temperatures (e.g., at least about 100 °C or 300 °C). The energy storage devices (e.g., batteries) may be used within an electrical power grid or as part of a standalone system. The batteries may be charged from an electricity production source, for later discharge when there is a demand for electrical energy consumption.

An aspect of the disclosure is directed to a high-temperature device, comprising: (a) a container comprising a reactive metal and/or molten salt; and (b) a seal that seals the container from an environment external to the container. The seal comprises (i) a ceramic material exposed to the reactive metal and/or molten salt, wherein the ceramic material is chemically resistant to the reactive metal and/or molten salt at a temperature of at least 100 °C; (ii) a metal collar adjacent to the ceramic material; and an active metal braze disposed between the ceramic material and at least one of the metal collar and the container, wherein the active metal braze comprises at least one metal that chemically reduces the ceramic material.

Another aspect of the disclosure relates to an electrochemical cell, comprising: (a) an electrically conductive housing comprising a liquid metal that is liquid at an operating temperature of at least about 200 °C, wherein the liquid metal is configured to store/release charge during charge/discharge of the electrochemical cell; (b) a conductor in electrical contact with the liquid metal, wherein the conductor protrudes through the electrically conductive housing through an aperture in the electrically conductive housing; and (c) a seal that electrically isolates the conductor from the electrically conductive housing, wherein the seal comprises a ceramic material, a braze material, and a sleeve.

Another aspect of the disclosure relates to an electrochemical cell, comprising: (a) an electrically conductive housing comprising a liquid metal that is liquid at an operating temperature of at least about 200 °C, wherein the liquid metal composition is configured to store/release charge during charge/discharge of the electrochemical cell; (b) a conductor in electrical contact with the liquid metal, wherein the conductor protrudes through the electrically conductive housing through an aperture in the electrically conductive housing; and (c) a seal that seals the conductor to the electrically conductive housing, wherein the seal provides a helium leak rate of no more than about 1×10⁻⁶ atmosphere-cubic centimeters per second (atm-cc/s) at a temperature of at least about 25 °C.

Another aspect of the disclosure is directed to an electrochemical cell, comprising: (a) an electrically conductive housing comprising a liquid metal that is liquid at an operating temperature of at least about 200 °C, wherein the liquid metal composition is configured to store/release charge during charge/discharge of the electrochemical cell; (b) a conductor in electrical contact with the liquid metal, wherein the conductor protrudes through the electrically conductive housing through an aperture in the electrically conductive housing; and (c) a seal that electrically isolates the conductor from the electrically conductive housing, wherein the impedance across the seal is at least about 1 kilo-Ohm at the operating temperature.

Another aspect of the disclosure is directed to an electrochemical cell, comprising: (a) an electrically conductive housing comprising a liquid metal that is liquid at an operating temperature of at least about 200 °C, wherein the liquid metal is configured to store/release charge during charge/discharge of the electrochemical cell; (b) a conductor in electrical contact with the liquid metal, wherein the conductor protrudes through the electrically conductive housing through an aperture in the electrically conductive housing; and (c) a seal comprising an electrically insulating ceramic bonded to a metal collar and connected to both the conductor and the electrically conductive housing, wherein the seal electrically isolates the conductor from the electrically conductive housing, wherein the electrically insulating ceramic has a coefficient of thermal expansion (CTE) of less than 6 μm/m/°C, and wherein the CTE of the metal collar is less than 60% different than the CTE of the electrically insulating ceramic.

Another aspect of the disclosure provides an electrochemical cell, comprising: (a) an electrically conductive housing comprising a liquid metal that is liquid at an operating temperature of at least about 200 °C, wherein the liquid metal is configured to store/release charge during charge/discharge of the electrochemical cell; (b) a conductor in electrical contact with the liquid metal, wherein the conductor protrudes through the electrically conductive housing through an aperture in the electrically conductive housing; and (c) a seal that electrically isolates the conductor from the electrically conductive housing, wherein the seal comprises a material with a coefficient of thermal expansion (CTE) that is at least 10% different than the CTE of the electrically conductive housing and/or the conductor, and wherein the seal has a geometry such that the electrochemical cell is hermetically sealed.

In another aspect of the disclosure, a high-temperature device is provided. The device comprises (a) a container comprising a reactive metal and/or molten salt; and (b) a seal that seals the container from an environment external to the container. The seal comprises (i) a ceramic material exposed to the reactive metal and/or molten salt, wherein the ceramic material is chemically resistant to the reactive metal and/or molten salt at a temperature of at least 100 °C; and (ii) a first metal collar joined to the ceramic material, wherein the first metal collar has a coefficient of thermal expansion (CTE) of less than 8 ppm/°C.

Another aspect of the disclosure provides a method for selecting materials to form a seal for a high-temperature device containing a reactive material. The method comprises rank-ordering a set of materials based on increasing or decreasing Gibbs free energy of formation (ΔGᵣ) of each of the materials; selecting a subset of the rank-ordered materials, wherein the selected materials remain rank-ordered; and selecting a set of seal materials based on the selected rank-ordered materials, thereby eliminating a driving force for the selected rank-ordered materials to degrade when provided in the seal.

Another aspect of the disclosure provides an electrochemical cell that comprises a container comprising a reactive material maintained at a temperature of at least about 200 °C. The electrochemical cell further comprises a seal that passes through the container and seals the container from an environment external to the container. The seal comprises a ceramic component exposed to the reactive material and a metal collar joined to the ceramic component. The seal is arranged in a circumferential configuration that results in a radially compressive force of the metal collar onto the ceramic conductor, and configured with a conical angle of about 20 degrees relative to a vertical orientation.

Another aspect of the disclosure provides an electrochemical cell, comprising: (a) a container comprising a reactive material maintained at a temperature of at least about 200 °C; and (b) a seal in the container that seals the container from an environment external to the container. The seal comprises a ceramic component exposed to the reactive material and a metal collar joined to the ceramic component, wherein the seal is arranged in a stacked configuration with one or more sealing interfaces that are perpendicular to a direction parallel to a conductor that passes through the seal.

Another aspect of the disclosure provides an electrochemical cell, comprising: (a) a container comprising one or more materials comprising liquid components and gaseous components maintained at a temperature of at least about 100 °C, wherein at least one of the materials is a reactive material; and (b) a seal in the container that seals the container from an environment external to the container. The seal is configured as a pressure relief component above a critical pressure or above a critical temperature. The seal is provided adjacent a head space inside the container, wherein the head space comprises the gaseous components, and wherein the head space is above the liquid components.

A further aspect of the disclosure is directed to an electrochemical cell, comprising: (a) a container comprising a reactive material maintained at a temperature of at least about 200 °C; and (b) a seal that seals the container from an environment external to the container. The seal comprises a ceramic material exposed to the reactive material and a metal collar joined to the ceramic material, wherein a coefficient of thermal expansion (CTE) of the metal collar is less than 30% different than the CTE of the ceramic material, and wherein the metal collar is a ferrous alloy.

A further another aspect of the disclosure relates to a seal for containing a reactive material in a high-temperature device. The seal comprises a ceramic material that is electrically isolating and has a normalized Gibbs free energy of formation (ΔGᵣ,n) that is more negative than a ΔGᵣ,n of a first compound associated with the reactive material and a common element; and an active braze material that is chemically stable with the reactive material, wherein a ΔGᵣ,n of a second compound associated with the active braze material and the common element is more negative than the ΔGᵣ,n of the ceramic material.

Recognized herein are various limitations associated with elevated (or high) temperature devices. For instance, some batteries operate at high temperatures (e.g., at least about 100 °C or 300 °C) and have reactive material vapors (e.g., reactive metal vapors such as, for example, vapors of lithium, sodium, potassium, magnesium or calcium) that may be sufficiently contained within the devices. Other examples of high temperature reactive material devices include nuclear (e.g., fusion and/or fission) reactors that use a molten salt or metal (e.g., molten sodium or lithium or molten sodium- or lithium-containing alloys) as a coolant, devices for manufacturing semiconductors, heterogeneous reactors, and devices for producing (e.g., processing) and/or handling (e.g., transporting or storing) reactive materials (e.g., reactive chemicals such as, for examples, a chemical with a strong chemical reducing capability, or reactive metals such as, for example, lithium or sodium). Such devices may be sufficiently sealed from an external environment during use to prevent reactive material vapors from leaving the device (e.g., to prevent device failure, prolong device use, or avoid adverse health effects on users or operators of such devices), and/or may have a protective lining in the device to avoid corrosion of the container. Moreover, the seals of these devices themselves may be protected from effects of use in the presence of high-temperature, reactive materials.

The present disclosure provides ceramic materials that may be used in high temperature devices and/or in other devices, including, for example, strengthened ceramics used in ballistic protection systems and devices (e.g., ballistic penetration resistant armor).

The present disclosure provides seals and/or reactor vessel linings for energy storage devices and other devices having (e.g., containing or comprising) reactive materials (e.g., reactive metals) and operating at high temperatures (e.g., at least about 100 °C or 300 °C). The energy storage devices (e.g., batteries) may be used within an electrical power grid or as part of a standalone system. The batteries may be charged from an electricity production source for later discharge when there is a demand for electrical energy consumption.

In an aspect, the present disclosure provides a high-temperature device, comprising: a container comprising an internal cavity, wherein the internal cavity comprises a reactive material, and wherein the reactive material is maintained at a temperature of at least about 200 °C; a seal that seals the internal cavity of the container from an environment external to the container, wherein the seal comprises a ceramic component, and wherein the seal is exposed to both the reactive material and the environment external to the container; a conductor that extends from the environment external to the container through the seal to the internal cavity of the container; and a first metal sleeve coupled to the conductor and to the ceramic component, wherein the first metal sleeve is coupled to the ceramic component by a first braze joint comprising a first braze, and wherein the first braze comprises an alloy of silver and aluminum.

In some embodiments, the conductor is a negative current lead. In some embodiments, the device further comprises a negative current collector within the container, wherein the negative current collector is in contact with the reactive material and is attached to the negative current lead.

In some embodiments, the device further comprises a second metal sleeve coupled to the ceramic component, wherein the second metal sleeve is coupled to the container or to a collar joined to the container, wherein the second metal sleeve is coupled to the ceramic component by a second braze joint comprising a second braze, and wherein the second braze comprises the alloy of silver and aluminum. In some embodiments, the alloy of silver and aluminum comprises a ratio of silver to aluminum of less than or equal to about 19 to 1. In some embodiments, one or both of the first braze and the second braze further comprises a titanium braze alloy. In some embodiments, the titanium braze alloy comprises about 19-21 weight percent zirconium, 19-21 weight percent nickel, 19-21 weight percent copper, and a remaining weight percent comprises at least titanium.

In some embodiments, the device further comprises an internal braze disposed adjacent to the first braze joint, the second braze joint, or both the first and second braze joint, wherein the internal braze is exposed to the internal cavity of the container. In some embodiments, the internal braze comprises a titanium braze alloy.

In some embodiments, the second metal sleeve is coupled to the container or the collar by a third braze. In some embodiments, the third braze comprises a nickel-based or titanium based braze and the nickel-based braze comprises greater than or equal to about 70 weight percent nickel. In some embodiments, the nickel-based braze comprises a BNi-2 braze, a BNi-5b braze, or a BNi-9 braze.

In some embodiments, the first metal sleeve is coupled to the conductor by a fourth braze. In some embodiments, the fourth braze is a nickel-based braze, titanium-based braze, or the alloy of silver and aluminum.

In some embodiments, the alloy of silver and aluminum further comprises a wetting agent. In some embodiments, the wetting agent comprises titanium. In some embodiments, the ceramic component comprises aluminum nitride. In some embodiments, the ceramic component further comprises greater than or equal to about 3 weight percent yttrium oxide. In some embodiments, the ceramic component further comprises from about 1 percent to about 4 percent yttrium oxide by weight.

In some embodiments, the first and second metal sleeves comprise alloy 42 and the conductor and the collar comprise a stainless steel. In some embodiments, the stainless steel comprises 304L stainless steel. In some embodiments, the first and the second metal sleeves have a thickness of less than or equal to about 0.020 inches.

In an aspect, the present disclosure provides an electrochemical cell, comprising: a container comprising an internal cavity, wherein the internal cavity comprises a reactive material, and wherein the reactive material is maintained at a temperature of at least about 200 °C; a seal that seals the internal cavity of the container from an environment external to the container, wherein the seal comprises a ceramic component exposed to both the reactive material and the environment external to the container; a current lead that extends from the internal cavity of the container through the seal to the environment external to the container; a first metal sleeve coupled to the current lead and to the ceramic component; and a second metal sleeve coupled to the ceramic component and to the container or to a collar joined to the container, wherein the ceramic component comprises a physical ion blocker on a surface of the ceramic component.

In some embodiments, the physical ion blocker is shaped to inhibit electromigration along the surface of the ceramic component. In some embodiments, the physical ion blocker is shaped to inhibit the formation of metal dendrites across the surface of the ceramic component. In some embodiments, the first metal sleeve and the second metal sleeve are respectively coupled to the ceramic component by a first braze and a second braze. In some embodiments, the surface of the ceramic component is an exposed surface of the ceramic component between the first braze and the second braze and the physical ion blocker is shaped such that a shortest path along the exposed surface of the ceramic component from the first braze to the second braze includes a path segment directed at least partially away from both the first braze and the second braze.

In some embodiments, the first and second brazes each comprise an alloy of silver and aluminum. In some embodiments, the current lead is a negative current lead. In some embodiments, the physical ion blocker is attached to the surface of the ceramic component. In some embodiments, the physical ion blocker is disposed on an exposed surface of the ceramic component. In some embodiments, the physical ion blocker is an integral part of the ceramic component, the physical ion blocker comprises one or more protrusions as part of the exposed surface of the ceramic component, and the one or more protrusions extend out from a reference surface of the ceramic component.

In some embodiments, the one or more protrusions comprise a plurality of protrusions defining a groove. In some embodiments, the one or more protrusions extend a distance greater than or equal to about 2 mm from the reference surface of the ceramic component. In some embodiments, the one or more protrusions comprise a long dimension and a short dimension, and wherein the long dimension defines a slope disposed at an angle substantially orthogonal to the reference surface of the ceramic component. In some embodiments, the one or more protrusions define a slope disposed at an acute angle relative to the reference surface of the ceramic component and facing toward a source of positive electric field. In some embodiments, the one or more protrusions comprise a first portion extending out from the reference surface of the ceramic component and a second part defining a slope parallel to the reference surface of the ceramic component and extending toward a source of positive electric field. In some embodiments, the source of positive electric field is a body of the container in electrical communication with a positive electrode.

In an aspect, the present disclosure provides a high-temperature device, comprising: a container comprising an internal cavity, wherein the internal cavity comprises a reactive material, and wherein the reactive material is maintained at a temperature of at least about 200 °C; a seal that seals the internal cavity of the container from an environment external to the container, wherein the seal comprises a ceramic component, and wherein the seal is exposed to both the reactive material and the environment external to the container; a conductor that extends from the environment external to the container through the seal to the internal cavity of the container; and a metal sleeve coupled to the conductor and to the ceramic component, wherein the metal sleeve is coupled to the ceramic component by a braze joint comprising a braze, and wherein the braze is formed of a material that is substantially unreactive to air and prevents diffusion of air into the container when the reactive material is maintained at the temperature of at least about 200 °C for a time period of at least about 1 day.

In some embodiments, the braze is ductile. In some embodiments, the device further comprises an internal braze and wherein the internal braze is in contact with and protects the braze from the reactive material. In some embodiments, the internal braze is an active metal braze. In some embodiments, the diffusion of air into the container is of at most about 1×10⁻⁸ atmosphere-cubic centimeters per second. In some embodiments, the braze is an alloy of at least two different metals.

In an aspect, the present disclosure provides a high-temperature device, comprising: a container having a chamber containing a reactive material comprising a gas portion and a liquid portion, the reactive material maintained at a temperature of at least about 200 °C; a seal that seals the chamber of the container from an environment external to the container, wherein the seal comprises a ceramic component exposed to the gas portion; a conductor extending through the seal from the external environment of the container to the chamber of the container, wherein the conductor is in electrical communication with the liquid portion; and a first shield connected to the conductor and disposed within the gas portion between the seal and the liquid portion.

In some embodiments, the first shield at least partially blocks the seal and the liquid portion from each other. In some embodiments, the first shield fully blocks the seal and the liquid portion from each other. In some embodiments, wherein the first shield extends a distance from the conductor, the distance being greater than or equal to about 1.5 times a width of the conductor. In some embodiments, the first shield is shaped to increase an effective gas diffusion path from the liquid portion to the seal by greater than or equal to about 10 percent relative to the same high-temperature device without the shield. In some embodiments, the first shield is shaped to provide an effective gas diffusion path from the liquid portion to the seal of about 7 cm⁻¹ or more.

In some embodiments, the first shield is shaped to increase an effective ion path length from the liquid portion to the seal by about 30 percent or more relative to an otherwise identical high-temperature device without a shield. In some embodiments, the increase in effective ion diffusion path length is about 75 percent or more. In some embodiments, the first shield is shaped to provide an effective ion diffusion path length of greater than or equal to about 1.5. In some embodiments, the first shield is shaped to provide an effective ion diffusion path length of greater than or equal to about 2.

In some embodiments, the conductor is a negative current lead. In some embodiments, the device further comprises a second shield disposed between the first shield and the seal. In some embodiments, the first shield and second shield comprise alternating convex and concave portions shaped to produce a diffusion path from the liquid portion to the seal at least 1.5 times as long as a width of the container. In some embodiments, the second shield is coupled to a wall of the chamber. In some embodiments, the first shield is in electrical contact with the negative current lead and wherein the second shield is in electrical contact with a positive current lead.

In some embodiments, the device further comprises a second shield in electrical contact with a positive current lead and disposed between the first shield and the liquid portion. In some embodiments, the liquid portion produces a vapor and the second shield converts the vapor to a salt upon contact. In some embodiments, an internal surface of the container exposed to the gas portion comprises an ionically conductive film in electrical communication with a positive current source and the first shield is shaped to cause vapor flowing between the liquid portion and the seal to flow along the internal surface. In some embodiments, the first shield comprises an edge at its perimeter wherein the edge is shaped and positioned in the chamber to inhibit capillary flow of liquid from the liquid portion along a path from the liquid portion to the seal.

In an aspect, the present disclosure provides an electrochemical cell, comprising: a container having a chamber containing a reactive material maintained at a temperature of at least about 200 °C; a seal that seals the chamber of the container from an environment external to the container, wherein the seal comprises a ceramic component exposed to the reactive material and a metal sleeve coupled to the ceramic component by a braze; and a current lead extending through the seal from the external environment of the container to the chamber of the container, wherein current lead is in electrical contact with the reactive material, and wherein the current lead comprises a shoulder comprising the same material as the current lead and wherein the shoulder couples the sleeve to the current lead.

In some embodiments, the current lead is a negative current lead. In some embodiments, the electrochemical cell further comprises a negative current collector within the chamber and attached to an end of the negative current lead. In some embodiments, the negative current lead comprises a cylindrical body extending through the seal and a threaded portion attaching the negative current lead to the negative current collector and the negative current lead further comprises two parallel, substantially flat surfaces located on opposite sides of an end of the negative current lead outside the container. In some embodiments, the negative current collector comprises a foam.

In some embodiments, the high-temperature device is a battery and the battery comprises a negative electrode, a positive electrode, and a liquid electrolyte. In some embodiments, at least one of the negative electrode and the positive electrode is a liquid metal electrode. In some embodiments, the liquid electrolyte is a molten halide electrolyte.

This disclosure provides energy storage devices and systems. An energy storage device can include a negative electrode, an electrolyte, and a positive electrode, at least some of which may be in a liquid state during operation of the energy storage device. In some situations, during discharge of the energy storage device, an intermetallic compound forms at the positive electrode.

In an aspect, the present disclosure provides an electrochemical energy storage device, comprising: a first electrode comprising a first material, where the first electrode is in electrical communication with a negative current collector, where the first material comprises calcium; a second electrode comprising a second material, where the second electrode is in electrical communication with a positive current collector, where the second material comprises antimony, and wherein the positive current collector comprises a surface treatment that resists corrosion; and liquid electrolyte between the first electrode and the second electrode, where at an operating temperature of the electrochemical energy storage device the second material is solid, and where the liquid electrolyte is capable of conducting ions of the first material.

In some embodiments, the second electrode comprises a plurality of solid particles comprising the second material. In some embodiments, the plurality of solid particles comprises granules, flakes, needles, or any combination thereof. In some embodiments, an individual particle of the plurality of solid particles has a dimension of at least about 0.0001 millimeters. In some embodiments, an individual particle of the plurality of solid particles has a dimension of less than or equal to about 10 millimeters. In some embodiments, the electrochemical energy storage device further comprises an intermetallic material disposed at one or more interfaces between the plurality of solid particles and the liquid electrolyte upon discharge of the electrochemical energy storage device. In some embodiments, the intermetallic material comprises the first material and the second material. In some embodiments, the intermetallic material is included in an intermetallic layer at a given interface of the one or more interfaces. In some embodiments, the intermetallic material is included in a shell at least partially circumscribing a given solid particle of the plurality of solid particles.

In some embodiments, the operating temperature is at least about 500 °C. In some embodiments, the operating temperature is from about 400 °C to 500 °C. In some embodiments, the operating temperature is less than about 500 °C or 400 °C. In some embodiments, the operating temperature is from about 300 °C to 650 °C. In some embodiments, the first material and the second material comprise one or more metals.

In some embodiments, the first material comprises a calcium alloy. In some embodiments, the first material comprises lithium, magnesium, potassium, barium, strontium, copper, zinc, or any combination thereof. In some embodiments, the first material comprises lithium, sodium, magnesium, copper, zinc, or any combination thereof.

In some embodiments, the first electrode is solid at the operating temperature. In some embodiments, the first electrode is semi-solid at the operating temperature. In some embodiments, the first electrode is liquid at the operating temperature. In some embodiments, the first electrode comprises a semi-solid or a liquid at the operating temperature.

In some embodiments, the liquid electrolyte comprises a calcium salt. In some embodiments, the liquid electrolyte further comprises a salt additive. In some embodiments, the calcium salt is calcium chloride. In some embodiments, the salt additive comprises lithium chloride, sodium chloride, potassium chloride, strontium chloride, lithium bromide, sodium bromide, calcium bromide, potassium bromide, strontium bromide, barium chloride, barium bromide, or any composition thereof.

In some embodiments, the negative current collector comprises a porous basket. In some embodiments, the negative current collector comprises a porous metallic structure. In some embodiments, the negative current collector comprises a knitted metal mesh or a mesh wire cloth. In some embodiments, the electrochemical energy storage device further comprises a separator disposed between the first electrode and the second electrode, and wherein the separator prevents the second material from contacting the first electrode. In some embodiments, the separator comprises a mechanical layer and a metal mesh, and wherein the metal mesh comprises pores of an average diameter of less than or equal to about 0.8 millimeters. In some embodiments, the separator comprises steel or stainless steel, and wherein the separator comprises a metal mesh or expanded mesh. In some embodiments, the separator comprises the surface treatment. In some embodiments, the surface treatment comprises boronizing, nitriding, nitrocarburizing, or any combination thereof.

In another aspect, the present disclosure provides an electrochemical energy storage device, comprising: a first electrode comprising a first material, where the first electrode is in electrical communication with a negative current collector; a second electrode comprising a plurality of solid particles comprising a second material, where the second electrode is in electrical communication with a positive current collector, wherein the second material is reactive with the first material, wherein the second material of the plurality of solid particles has an electronic conductivity of greater than or equal to 1×10⁴ Siemens per meter, and where at an operating temperature of the electrochemical energy storage device the second material is solid; and a liquid electrolyte between the first electrode and the second electrode, where the liquid electrolyte is capable of conducting ions of the first material.

In some embodiments, the first material and the second material comprise one or more metals. In some embodiments, the operating temperature is at least about 500 °C. In some embodiments, the operating temperature is from about 400 °C to 500 °C. In some embodiments, the operating temperature is less than about 500 °C or 400 °C. In some embodiments, the operating temperature is from about 300 °C to 650 °C.

In some embodiments, the first material comprises calcium. In some embodiments, the first material comprises a calcium alloy. In some embodiments, the first material comprises calcium or a calcium alloy. In some embodiments, the first material comprises lithium, sodium, magnesium, potassium, barium, strontium, copper, zinc, or any combination thereof. In some embodiments, the first material comprises lithium, sodium, magnesium, copper, zinc, or any combination thereof.

In some embodiments, the first electrode is solid at the operating temperature. In some embodiments, the first electrode is semi-solid at the operating temperature. In some embodiments, the first electrode is liquid at the operating temperature. In some embodiments, the first electrode comprises a semi-solid or a liquid at the operating temperature.

In some embodiments, the second material comprises antimony. In some embodiments, the plurality of solid particles comprises granules, flakes, needles, or any combination thereof. In some embodiments, an individual particle of the plurality of solid particles has a dimension of at least about 0.0001 millimeters. In an embodiment, an individual particle of the plurality of solid particles has a dimension of less than or equal to about 10 millimeters.

In some embodiments, the liquid electrolyte comprises a calcium salt. In some embodiments, the liquid electrolyte further comprises a salt additive. In some embodiments, the calcium salt is calcium chloride. In some embodiments, the salt additive comprises lithium chloride, potassium chloride, sodium chloride, potassium chloride, strontium chloride, lithium bromide, sodium bromide, calcium bromide, potassium bromide, strontium bromide, barium chloride, barium bromide, or any composition thereof.

In some embodiments, the electrochemical energy storage device further comprises an intermetallic material disposed at one or more interfaces between the plurality of solid particles of the second electrode and the liquid electrolyte upon discharge of the electrochemical energy storage device, where the intermetallic material comprises the first material and the second material. In some embodiments, the intermetallic material is included in an intermetallic layer at a given interface of the one or more interfaces. In some embodiments, the intermetallic material is included in a shell at least partially circumscribing a given solid particle of the plurality of solid particles.

In some embodiments, the negative current collector comprises a porous basket. In some embodiments, the negative current collector comprises an electrically conductive current lead and/or a porous metallic structure. In some embodiments, the negative current collector comprises a knitted metal mesh or a mesh wire cloth. In some embodiments, the electrochemical energy storage device further comprises a separator disposed between the first electrode and the second electrode, and wherein the separator prevents the second material from contacting the first electrode. In some embodiments, the separator comprises pores of an average diameter of less than or equal to about 0.8 millimeters. In some embodiments, the separator comprises a mechanical layer and a metal mesh, and wherein the metal mesh comprises pores of an average diameter of less than or equal to about 0.8 millimeters.

In another aspect, the present disclosure provides an electrochemical energy storage device, comprising: a container including a cavity comprising sidewalls and a lid assembly comprising a conductor aperture, where at an operating temperature of the electrochemical energy storage device, the lid assembly seals the container; an electrical conductor extending through the conductor aperture into the cavity of the container, where the electrical conductor is electrically isolated from the lid assembly by an electrically insulating seal; a negative current collector suspended within the cavity by the electrical conductor; and an electrochemical energy storage cell arranged within the cavity, where the electrochemical energy storage cell comprises a first electrode comprising a first material, a second electrode comprising a second material, a liquid electrolyte between the first electrode and the second electrode, where the liquid electrolyte is capable of conducting ions of the first material, where the first electrode is in electrical communication with the negative current collector, and where the second electrode is positioned along the sidewalls of the cavity such that ions of the first material are conducted through the liquid electrolyte along a general direction that is not parallel to a direction of a gravitational acceleration vector.

In some embodiments, the general direction is substantially orthogonal to the gravitational acceleration vector. In some embodiments, the first material and the second material comprise one or more metals. In some embodiments, the electrochemical energy storage device further comprises troughs mounted substantially perpendicular to the sidewalls of the cavity and where the second electrode is disposed in the troughs. In some embodiments, the troughs comprise at least two layers of troughs. In some embodiments, the electrochemical energy storage device further comprises a porous retaining wall mounted to an inner edge of the troughs and where the ions from the first material are free to pass through the porous retaining wall. In some embodiments, the electrochemical energy storage device further comprises a separator mounted to an inner edge of the troughs, and wherein the ions from the first material pass through the separator. In some embodiment, the separator comprises pores of an average diameter of less than or equal to about 0.8 millimeters. In some embodiments, the separator comprises a mechanical layer and a metal mesh, and wherein the metal mesh comprises pores of an average diameter of less than or equal to about 0.8 millimeters. In some embodiments, the separator comprises a surface treatment that is resistant to corrosion. In some embodiments, the positive current collector, container, an interior of the container, and/or the lid assembly comprises a surface treatment or coating that is resistant to corrosion. In some embodiments, the container, interior of the container, and/or the lid assembly comprises steel or stainless steel. In some embodiments, the surface treatment comprises boronizing, nitriding, nitrocarburizing, or any combination thereof. In some embodiments, the coating comprises silicon, nickel, chromium, or any combination thereof. In some embodiments, the surface treatment is boronizing, and the separator, positive current collector, container, interior of the container, and/or lid assembly comprise a surface layer of Fe₂B.

In some embodiments, the second electrode comprises a plurality of solid particles. In some embodiments, the plurality of solid particles comprises granules, flakes, needles, or any combination thereof. In some embodiments, an individual particle of the plurality of solid particles has a dimension of at least about 0.0001 millimeters. In some embodiments, an individual particle of the plurality of particles has a dimension of less than or equal to about 10 millimeters.

In some embodiments, the electrochemical energy storage device further comprises an intermetallic material disposed at one or more interfaces between the plurality of solid particles of the second electrode and the liquid electrolyte upon discharge of the electrochemical energy storage device. In some embodiments, the intermetallic material comprises the first material and the second material. In some embodiments, the intermetallic material is included in an intermetallic layer at a given interface of the one or more interfaces. In some embodiments, the intermetallic material is included in a shell at least partially circumscribing a given solid particle of the plurality of solid particles.

In some embodiments, at the operating temperature, the ions of the first material are conducted through the liquid electrolyte along an average flow path that is parallel to a plane of the lid assembly.

In some embodiments, the operating temperature is at least about 500 °C. In some embodiments, the operating temperature is from about 400 °C to 500 °C. In some embodiments, the operating temperature is less than about 500 °C or 400 °C. In some embodiments, the operating temperature is from about 300 °C to 650 °C.

In some embodiments, the first material comprises calcium. In some embodiments, the first material comprises a calcium alloy. In some embodiments, the first material comprises calcium or a calcium alloy. In some embodiments, the first material comprises lithium, sodium, magnesium, potassium, barium, strontium, copper, zinc, or any combination thereof. In some embodiments, the first material comprises lithium, sodium, magnesium, copper, zinc, or any combination thereof.

In some embodiments, the first electrode is solid at the operating temperature. In some embodiments, the first electrode is semi-solid at the operating temperature. In some embodiments, the first electrode is liquid at the operating temperature. In some embodiments, the second electrode is solid at the operating temperature. In some embodiments, the first electrode comprises a semi-solid or a liquid at the operating temperature. In some embodiments, the second electrode comprises antimony.

In some embodiments, the liquid electrolyte comprises a calcium salt. In some embodiments, the liquid electrolyte further comprises a salt additive. In some embodiments, the calcium salt is calcium chloride. In some embodiments, the salt additive comprises lithium chloride, potassium chloride, lithium bromide, calcium bromide, barium chloride, barium bromide, or any composition thereof.

In some embodiments, the negative current collector is porous. In some embodiments, the negative current collector comprises a porous basket. In some embodiments, the negative current collector comprises a knitted metal mesh or a mesh wire cloth. In some embodiments, the electrically insulating seal comprises ceramic. In some embodiments, the cavity of the container further comprises a gaseous headspace. In some embodiments, the gaseous headspace comprises an inert gas.

In another aspect, the present disclosure provides methods for operating an electrochemical energy storage device, comprising: (a) activating the electrochemical energy storage device coupled to an electrical load, wherein the comprising: a. a first electrode comprising a first material, wherein the first electrode is in electrical communication with a negative current collector, wherein at an operating temperature of the electrochemical energy storage device the first material is liquid; b. a second electrode comprising a plurality of solid particles comprising a second material, wherein the second electrode is in electrical communication with a positive current collector, wherein the second material is reactive with the first material, wherein the second material of the plurality of solid particles has an electronic conductivity of greater than or equal to 1×10⁴ Siemens per meter, and wherein at the operating temperature of the electrochemical energy storage device the second material is solid; and c. a liquid electrolyte between the first electrode and the second electrode, wherein the liquid electrolyte is capable of conducting ions of the first material; and (b) charging or discharging the electrochemical energy storage device through the electrical load, wherein (i) during charging, the liquid electrolyte conducts ions of the first material to the first electrode, and (ii) during discharging, the liquid electrolyte conducts ions of the first material away from the first electrode.

In some embodiments, the operating temperature is between about 300 °C and 650 °C. In some embodiments, the method further comprises operating the electrochemical cell at a voltage from about 0.6 volts to 1.2 volts.

In another aspect, the present disclosure provides methods for operating an electrochemical energy storage device, comprising: (a) activating the electrochemical energy storage device coupled to an electrical load, wherein the comprising: a. a container including a cavity comprising sidewalls and a lid assembly comprising a conductor aperture, wherein at an operating temperature of the electrochemical energy storage device, the lid assembly seals the container; b. an electrical conductor extending through the conductor aperture into the cavity of the container, wherein the electrical conductor is electrically isolated from the lid assembly by an electrically insulating seal; c. a negative current collector suspended within the cavity by the electrical conductor; and d. an electrochemical energy storage cell arranged within the cavity, wherein the electrochemical energy storage cell comprises a first electrode comprising a first material, a second electrode comprising a second material, a liquid electrolyte between the first electrode and the second electrode, wherein the liquid electrolyte is capable of conducting ions of the first material, wherein the first electrode is in electrical communication with the negative current collector, and wherein the second electrode is positioned along the sidewalls of the cavity such that ions of the first material are conducted through the liquid electrolyte along a general direction that is not parallel to a direction of a gravitational acceleration vector; and (b) charging or discharging the electrochemical energy storage device through the electrical load, wherein (i) during charging, the liquid electrolyte conducts ions of the first material to the first electrode, and (ii) during discharging, the liquid electrolyte conducts ions of the first material away from the first electrode.

In some embodiments, the operating temperature is between about 300 °C and 650 °C. In some embodiments, the method further comprises operating the electrochemical cell at a voltage from about 0.6 volts to 1.2 volts.

In another aspect, the present disclosure provides methods for operating an electrochemical energy storage device, comprising: (a) activating the electrochemical energy storage device coupled to an electrical load, wherein the comprising: a. a first electrode comprising a first material, wherein the first electrode is in electrical communication with a negative current collector, wherein the first material comprises calcium; b. a second electrode comprising a second material, wherein the second electrode is in electrical communication with a positive current collector, wherein the second material comprises antimony, and wherein the positive current collector comprises a surface treatment that resists corrosion; and c. a liquid electrolyte between the first electrode and the second electrode, wherein at an operating temperature of the electrochemical energy storage device the second material is solid, and wherein the liquid electrolyte is capable of conducting ions of the first material; and (b) charging or discharging the electrochemical energy storage device through the electrical load, wherein (i) during charging, the liquid electrolyte conducts ions of the first material to the first electrode, and (ii) during discharging, the liquid electrolyte conducts ions of the first material away from the first electrode.

In some embodiments, the operating temperature is between about 300 °C and 650 °C. In some embodiments, the method further comprises operating the electrochemical cell at a voltage from about 0.6 volts to 1.2 volts.

In another aspect, the present disclosure provides an electrochemical energy storage device comprising a container including a negative electrode, a positive electrode and an electrolyte disposed between the negative electrode and positive electrode, wherein the electrochemical energy storage device has a first potential difference between the negative electrode and positive electrode at a first temperature that is less than about 50 °C and a second potential difference between the negative electrode and positive electrode at a second temperature of at least about 250 °C, wherein the second potential difference is greater than the first potential difference, wherein at least two of the positive electrode, electrolyte and negative electrode are liquid at the second temperature, wherein the container has a surface area-to-volume ratio of less than or equal to about 100 m⁻¹, and wherein the electrochemical energy storage device maintains at least about 90% of its energy storage capacity after 500 charge/discharge cycles.

In another aspect, the present disclosure provides an energy storage device comprising a negative electrode, a positive electrode and an electrolyte disposed between the negative electrode and positive electrode, wherein at least one of the positive electrode and negative electrode is liquid at an operating temperature of the energy storage device that is greater than a non-operating temperature of the energy storage device, wherein the energy storage device maintains at least about 90% of its energy storage capacity after 500 charge/discharge cycles, and wherein the energy storage device has an efficiency of at least about 80% at a current density of at least about 100 mA/cm².

In another aspect, the present disclosure provides a method for regulating an energy storage device comprising at least one electrochemical cell comprising a negative electrode, positive electrode and an electrolyte between said negative and positive electrodes, the method comprising: (a) measuring, with the aid of a temperature sensor in thermal communication with said electrochemical cell, an operating temperature of the electrochemical cell, wherein at least one of said negative electrode, positive electrode and electrolyte are in a liquid state at said operating temperature; (b) calculating, with the aid of a battery management system, an impedance of a current flow path leading through said electrochemical cell using a correspondence between impedance and temperature stored in a memory location of said battery management system; and (c) calculating, with the aid of said battery management system, a state of charge of said electrochemical cell using said impedance calculated in (b) and a current measured through said electrochemical cell.

In another aspect, the present disclosure provides a method for detecting a breach of an electrochemical cell, the method comprising: (a) providing an electrochemical cell comprising a negative electrode, an electrolyte and a positive electrode, wherein at least one of the negative electrode, the electrolyte and the positive electrode is in a liquid state at an operating temperature of the electrochemical cell that is at least about 250 °C, and wherein a seal isolates the negative electrode, the electrolyte and the positive electrode from an environment external to the electrochemical cell; (b) monitoring the electrochemical cell for an electrical signature that is indicative of a breach of the seal and exposure of at least one of the positive electrode, the electrolyte, and the negative electrode to the environment; and (c) in response to the electrical signature, inactivating the electrochemical cell, cooling the electrochemical cell, discharging the electrochemical cell and/or notifying a system operator.

In another aspect, the present disclosure provides a liquid metal battery, comprising: a plurality of electrochemical cells each comprising an electrically conductive housing and a conductor in electrical communication with a current collector, the electrically conductive housing comprising a negative electrode, electrolyte and positive electrode, wherein at least one of the negative electrode, electrolyte and positive electrode are in a liquid state at an operating temperature of the cell, wherein the conductor protrudes through the electrically conductive housing through an aperture in the electrically conductive housing and is electrically isolated from the electrically conductive housing with a seal, and wherein the plurality of electrochemical cells are stacked in series with the conductor of a first cell in electrical contact with the electrically conductive housing of a second cell; and a plurality of non-gaseous spacers disposed between the electrochemical cells.

In another aspect, the present disclosure provides an electrochemical energy storage system, comprising at least a first electrochemical cell adjacent to a second electrochemical cell, each of the first and second electrochemical cells comprising a negative current collector, negative electrode, electrolyte, positive electrode and a positive currently collector, wherein at least one of the negative electrode, electrolyte and positive electrode is in a liquid state at an operating temperature of the first or second electrochemical cell, and wherein the positive current collector of the first electrochemical cell is direct metal-to-metal joined to the negative current collector of the second electrochemical second cell.

In another aspect, the present disclosure provides an energy storage system, comprising: a plurality of electrochemical cells each comprising a negative electrode, electrolyte and positive electrode, wherein at least two of the negative electrode, the electrolyte and the positive electrode is in a liquid state at an operating temperature of the electrochemical cell, wherein the plurality of electrochemical cells are connected in series and/or parallel; and a frame supporting the plurality of electrochemical cells, wherein the frame comprises one or more fluid flow paths for bringing a thermal management fluid in thermal communication with at least a subset of the plurality of electrochemical cells.

In another aspect, the present disclosure provides a control system for regulating an energy storage system, comprising: a computer processor; and memory operatively coupled to the computer processor, the memory comprising machine executable code that upon execution by the computer processor implements a method, the method comprising directing thermal management fluid through one or more fluid flow paths in a frame structure that supports an energy storage system, wherein the fluid flow paths bring the thermal management fluid in thermal communication with at least a subset of a plurality of electrochemical cells of the energy storage system, wherein an individual cell of the plurality of electrochemical cells comprises a negative electrode, electrolyte and positive electrode, and wherein at least two of the negative electrode, the electrolyte and the positive electrode is in a liquid state at an operating temperature of the individual electrochemical cell.

In another aspect, the present disclosure provides a high-temperature device, comprising: a container comprising a reactive metal and/or molten salt; and a seal that seals said container from an environment external to said container, said seal comprising: (i) a ceramic material exposed to said reactive metal and/or molten salt, wherein the ceramic material is chemically resistant to the reactive metal and/or molten salt at a temperature of at least 100 °C; (ii) a metal collar adjacent to said ceramic material; and (iii) an active metal braze disposed between the ceramic material and at least one of the metal collar and the container, wherein the active metal braze comprises at least one metal that chemically reduces the ceramic material.

In another aspect, the present disclosure provides an electrochemical cell, comprising: an electrically conductive housing comprising a liquid metal that is liquid at an operating temperature of at least about 200 °C, wherein said liquid metal is configured to store/release charge during charge/discharge of the electrochemical cell; a conductor in electrical contact with the liquid metal, wherein the conductor protrudes through the electrically conductive housing through an aperture in the electrically conductive housing; and a seal that electrically isolates the conductor from the electrically conductive housing, wherein the seal comprises a ceramic material, a braze material, and a sleeve.

In another aspect, the present disclosure provides a high-temperature device, comprising: a container comprising an internal cavity, wherein the internal cavity comprises a reactive material, and wherein the reactive material is maintained at a temperature of at least about 200 °C; a seal that seals the internal cavity of the container from an environment external to the container, wherein the seal comprises a ceramic component, and wherein the seal is exposed to both the reactive material and the environment external to the container; a conductor that extends from the environment external to the container through the seal to the internal cavity of the container; and a first metal sleeve coupled to the conductor and to the ceramic component, wherein the first metal sleeve is coupled to the ceramic component by a first braze joint comprising a first braze, and wherein the first braze comprises an alloy of silver and aluminum.

In another aspect, the present disclosure provides an electrochemical cell, comprising: a container comprising an internal cavity, wherein the internal cavity comprises a reactive material, and wherein the reactive material is maintained at a temperature of at least about 200 °C; a seal that seals the internal cavity of the container from an environment external to the container, wherein the seal comprises a ceramic component exposed to both the reactive material and the environment external to the container; a current lead that extends from the internal cavity of the container through the seal to the environment external to the container; a first metal sleeve coupled to the current lead and to the ceramic component; and a second metal sleeve coupled to the ceramic component and to the container or to a collar joined to the container, wherein the ceramic component comprises a physical ion blocker on a surface of the ceramic component.

In another aspect, the present disclosure provides an electrochemical energy storage device, comprising: a first electrode comprising a first material, wherein said first electrode is in electrical communication with a negative current collector; a second electrode comprising a plurality of solid particles comprising a second material, wherein said second electrode is in electrical communication with a positive current collector, wherein said second material is reactive with said first material, wherein said second material of said plurality of solid particles has an electronic conductivity of greater than or equal to 1×10⁴ Siemens per meter, and wherein at an operating temperature of said electrochemical energy storage device said second material is solid; and a liquid electrolyte between said first electrode and said second electrode, wherein said liquid electrolyte is capable of conducting ions of said first material.

In another aspect, the present disclosure provides an electrochemical energy storage device, comprising: a container including a cavity comprising sidewalls and a lid assembly comprising a conductor aperture, wherein at an operating temperature of said electrochemical energy storage device, said lid assembly seals said container; an electrical conductor extending through said conductor aperture into said cavity of said container, wherein said electrical conductor is electrically isolated from said lid assembly by an electrically insulating seal; a negative current collector suspended within said cavity by said electrical conductor; and an electrochemical energy storage cell arranged within said cavity, wherein said electrochemical energy storage cell comprises a first electrode comprising a first material, a second electrode comprising a second material, a liquid electrolyte between said first electrode and said second electrode, wherein said liquid electrolyte is capable of conducting ions of said first material, wherein said first electrode is in electrical communication with said negative current collector, and wherein said second electrode is positioned along said sidewalls of said cavity such that ions of said first material are conducted through said liquid electrolyte along a general direction that is not parallel to a direction of a gravitational acceleration vector.

In another aspect, the present disclosure provides an electrochemical cell, comprising: a container comprising a reactive material maintained at a temperature of at least about 200 °C; and a seal in the container that seals the container from an environment external to the container, the seal comprising a ceramic component exposed to the reactive material and a metal sleeve joined to the ceramic component, wherein the ceramic component comprises a lanthanide oxide, and wherein the ceramic component comprises grains with a size of less than about 50 microns (μm).

In another aspect, the present disclosure provides an electrochemical cell, comprising: a container comprising a reactive material maintained at a temperature of at least about 200 °C; and a seal in the container that isolates the container from an environment external to the container, the seal comprising a ceramic component exposed to the reactive material and a metal sleeve joined to the ceramic component, wherein the ceramic component comprises a primary ceramic material and a secondary ceramic material, wherein the primary ceramic material comprises aluminum nitride (AlN), and wherein the secondary ceramic material increases a strength of the primary ceramic material by at least about 1%.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” or “FIG.” herein), of which:

FIG. 1 is an illustration of an electrochemical cell and a compilation (e.g., battery) of electrochemical cells;

FIG. 2 is a schematic cross-sectional illustration of a housing having a conductor in electrical communication with a current collector pass through an aperture in the housing;

FIG. 3 is a cross-sectional side view of an electrochemical cell or battery;

FIG. 4 is a cross-sectional side view of an electrochemical cell or battery with an intermetallic layer;

FIG. 5 is a schematic cross-sectional illustration of an electrochemical cell having feed-throughs that are electrically insulated from a housing with dielectric seal components;

FIG. 6 shows examples of current collectors combined into a shared lid assembly (A and B);

FIG. 7 shows coefficients of thermal expansion in units of parts per million (ppm) per °C for various types of steel and an insulating ceramic;

FIG. 8 shows the coefficient of thermal expansion in units of parts (p) per °C for various types of sleeve or collar materials, braze materials and insulating ceramics;

FIG. 9 shows the Gibbs free energy of formation (ΔGᵣ) for various materials at a range of temperatures with negative numbers being more thermodynamically stable;

FIG. 10 shows examples of features that can compensate for a coefficient of thermal expansion mismatch;

FIG. 11 shows an electrochemical cell having a brazed ceramic seal;

FIG. 12 shows a schematic drawing of a brazed ceramic seal where the materials are thermodynamically stable with respect to the internal and external environments of the cell;

FIG. 13 shows a seal where the ceramic and/or braze materials are not thermodynamically stable with respect to the internal and external environments;

FIG. 14 shows an example of a brazed ceramic seal;

FIG. 15 shows an example of a brazed ceramic seal;

FIG. 16 shows an example of a brazed ceramic seal;

FIG. 17 shows an example of a brazed ceramic seal;

FIG. 18 shows an example of a seal having an alumina or zirconia seal with yttrium oxide (Y₂O₃) coating and iron-based braze;

FIG. 19 shows an example of a sub-assembly;

FIG. 20 shows how the shape of a sub-assembly can accommodate coefficient of thermal expansion mismatch;

FIG. 21 shows a seal design having multiple ceramic insulators disposed between one or more metal sleeves;

FIG. 22 shows an example of the forces on a seal;

FIG. 23 shows a seal design having a single ceramic insulator disposed between one or more metal sleeves;

FIG. 24 shows a cell cap assembly;

FIG. 25 shows examples and features of seals;

FIG. 26 shows examples and features of seals;

FIG. 27 shows examples and features of seals;

FIG. 28 shows an example of a cell pack;

FIG. 29 shows an example of braze connection between the top of a conductive feed-through and the bottom of a cell;

FIG. 30 shows an example of joining two cells using a compression connection between parts that forms at the operating temperature of the battery based on differences in the coefficient of thermal expansion;

FIG. 31 shows an example of a stack of cell packs, also referred to as a core;

FIG. 32 in an example of a method for selecting materials to form a seal based on a rank-ordered free energy of formation selection process;

FIG. 33 is a cross-sectional view of an example of a double seal;

FIG. 34 is another example of a double seal;

FIG. 35 is a cross-section of a seal with a concentric accordion joint;

FIG. 36 is a cut-away view of another example of a seal with a concentric accordion joint;

FIG. 37 is a cross-sectional view of an example of an air stable seal;

FIG. 38 is a sectioned side view of the seal in FIG. 37;

FIG. 39 shows cross-sectional views of a portion or component of a seal that comprises a simple ceramic component and a portion or component of a seal that comprises a shaped ceramic component.

FIG. 40 shows a cross-sectional view of an example of a seal with a shaped ceramic component;

FIG. 41 is another example of the seal in FIG. 40;

FIG. 42 is a cross-sectional side view of an electrochemical cell or battery with a pressure relief structure.

FIGS. 43A and 43B are cross-sectional side and bottom views of electrochemical cells or batteries with alternative pressure relief structures;

FIG. 44A is a cross-sectional side view of an electrochemical cell or battery with a bowing or bulging solid intermetallic layer;

FIG. 44B is a cross-sectional side view of the electrochemical cell or battery with a post;

FIG. 44C is a cross-sectional side view of the electrochemical cell or battery with ridges;

FIG. 45 is an illustration of an electrochemical energy storage device being transported on a truck;

FIG. 46 illustrates a method for forming an energy storage system.

FIG. 47 shows an energy storage system comprising an energy storage device and a battery management system;

FIG. 48 is a circuit diagram that shows an energy storage system comprising an energy storage device and a battery management system;

FIG. 49 is a circuit diagram that shows an energy storage system comprising an energy storage device and a drive circuit;

FIG. 50 is a circuit diagram that shows an energy storage system comprising an energy storage device, a processor and a drive circuit;

FIG. 51 shows an example of a battery management system (BMS);

FIG. 52 in an example of battery management system (BMS) and supervisory control and data acquisition (SCADA) system architecture and communication wiring;

FIG. 53 is an example of a system for implementing a charge balancing scheme;

FIG. 54 shows an example of an electrochemical cell that is breached;

FIG. 55 shows an example of a cell that is operated with a constant current charge followed by a constant voltage float;

FIG. 56 shows an example of chemical reactions that can lead to an electrical signature of cell breach;

FIG. 57 is an example of a busbar configuration;

FIG. 58 shows an example of a cell module with busbars and wires;

FIG. 59 shows an example of a single point connector;

FIG. 60 is a perspective view of an electrochemical cell with a current transfer plate attached to a negative current lead;

FIG. 61 is an example of a pack with a first interpack busbar and a second interpack busbar.

FIG. 62 shows an example of thermal management fluid flowing through a frame;

FIG. 63 shows an example of an insulation insert for central box tubing;

FIG. 64 shows an example of a core of electrochemical cells with ducts for thermal management fluid;

FIG. 65 is an example of a thermal insulation structure portion comprising multiple insulation layers and a pass-through;

FIG. 66A is an example of a pass-through with an end cap;

FIG. 66B shows the pass-through in FIG. 66A with a wire;

FIG. 67 shows a seal design having a ceramic component disposed between one or more metal sleeves;

FIG. 68 illustrates an electrochemical cell containing a reactive material and comprising a seal including additional components to inhibit seal corrosion;

FIG. 69 shows an electrochemical cell having a shield configured to increase an effective gas diffusion path;

FIG. 70 shows an electrochemical cell having a plurality of shields configured to further increase a diffusion path length;

FIG. 71 illustrates an electrochemical cell with a shield having a lip to inhibit flow and splashing of liquid towards a seal;

FIG. 72 shows an electrochemical cell having a shield configured to increase an effective ion diffusion path;

FIG. 73 is an image of a cell having a positively-polarized shield disposed between a liquid portion and a negatively polarized shield;

FIG. 74A, FIG. 74B, and FIG. 74C illustrate different configurations of a physical ion blocker;

FIG. 75A illustrates negative current leads comprising negative current lead (NCL) couplers;

FIG. 75B shows front and side views of a current lead comprising a pair of substantially flat, parallel surfaces at one end;

FIG. 76 shows a cross-sectional side view of an example electrochemical cell or battery;

FIGS. 77A and 77B show example electrochemical cells or batteries with an electrode positioned along the sidewall of the cell; FIG. 77A shows a cross-sectional side view of an example electrochemical cell or battery with one or more troughs; FIG. 77B shows a cross-sectional side view of an example electrochemical cell or batter without troughs;

FIG. 78 shows an example of reactivity between electrode material and various housing materials;

FIGS. 79A and 79B show example negative current collector baskets; FIG. 79A shows an example negative current collector with a perforated basket; FIG. 79B shows an example negative current collector with a perforated basket and mesh liner;

FIG. 80 shows a cross-sectional side view of an example electrochemical cell or battery with an electrode positioned along the sidewall and bottom of the cell;

FIG. 81 shows a cross-sectional side view of an example electrochemical cell or battery with a separator positioned between the electrodes;

FIGS. 82A and 82B show example separator materials; FIG. 82A shows a top view of an example separator; FIG. 82B shows a side view of an example separator; and

FIG. 83 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The term “direct metal-to-metal joining” or “direct metal-to-metal joint,” as used herein, generally refers to an electrical connection where two metal surfaces are brought into contact (e.g., by forming a braze or a weld). In some examples, direct metal-to-metal joints do not include wires.

The term “electronically,” as used herein, generally refers to a situation in which electrons can readily flow between two or more components with little resistance. Components that are in electronic communication with one another can be in electrical communication with one another.

The term “vertical,” as used herein, generally refers to a direction that is parallel to the gravitational acceleration vector (g).

The term “stable,” as used herein to describe a material, generally refers to a material that is thermodynamically stable, chemically stable, thermochemically stable, electrochemically stable, kinetically stable, or any combination thereof. A stable material may be substantially thermodynamically, chemically, thermochemically, electrochemically and/or kinetically stable. A stable material may not be substantially chemically or electrochemically reduced, attacked or corroded. Any aspects of the disclosure described in relation to stable, thermodynamically stable or chemically stable materials may equally apply to thermodynamically stable, chemically stable, thermochemically stable and/or electrochemically stable materials at least in some configurations.

The term “surface area,” as used herein, generally refers to the geometric surface area of an object.

The term “vehicle,” as used herein, generally refers to a car, truck, train, motorcycle, helicopter, plane, ship, boat, or robot. A vehicle can be manned or unmanned. A vehicle can be configured to travel alone a road or other pathway, such as a waterway. A vehicle can be coupled to a trailer or other container that is configured to house an energy storage device or a container having the energy storage device.

The term “cell,” as used herein, generally refers to an electrochemical cell. A cell can include a negative electrode of material ‘A’ and a positive electrode of material ‘B’, denoted as A∥B. The positive and negative electrodes can be separated by an electrolyte. A cell can also include a housing, one or more current collectors, and a high temperature electrically isolating seal. In some cases, a cell can be about 4 inches wide, about 4 inches deep and about 2.5 inches tall. In some cases, a cell can be about 8 inches wide, about 8 inches deep and about 2.5 inches tall. In some examples, any given dimension (e.g., height, width or depth) of an electrochemical cell can be at least about 1, 2, 2.5, 3, 3.5, 4, 4.5, 5, 5.5, 6, 6.5, 7, 7.5, 8, 8.5, 9, 9.5, 10, 12, 14, 16, 18 or 20 inches. In an example, a cell (e.g., each cell) can have dimensions of about 4 inches×4 inches×2.5 inches. In another example, a cell (e.g., each cell) can have dimensions of about 8 inches×8 inches×2.5 inches. In some cases, a cell may have about at least about 70 Watt-hours of energy storage capacity. In some cases, a cell may have at least about 300 Watt-hours of energy storage capacity.

The term “module,” as used herein, generally refers to cells that are attached together in parallel by, for example, mechanically connecting the cell housing of one cell with the cell housing of an adjacent cell (e.g., cells that are connected together in an approximately horizontal packing plane). In some cases, the cells are connected to each other by joining features that are part of and/or connected to the cell body (e.g., tabs protruding from the main portion of the cell body). A module can include a plurality of cells in parallel. A module can comprise any number of cells, e.g., at least about 2, 3, 4, 5, 6, 7, 8, 9, 10, 11, 12, 13, 14, 15, 16, 17, 18, 19, 20, or more cells. In some cases, a module comprises at least about 4, 9, 12, or 16 cells. In some cases, a module is capable of storing about 700 Watt-hours of energy and/or delivering at least about 175 Watts of power. In some cases, a module is capable of storing at least about 1080 Watt-hours of energy and/or delivering at least about 500 Watts of power. In some cases, a module is capable of storing at least about 1080 Watt-hours of energy and/or delivering at least about 200 Watts (e.g., about 500 Watts) of power. In some cases, a module can include a single cell.

The term “pack” or “tray,” as used herein, generally refers to modules that are attached through different electrical connections (e.g., vertically). A pack can comprise any number of modules, e.g., at least about 1, 2, 3, 4, 5, 6, 7, 8, 9, 10, 11, 12, 13, 14, 15, 16, 17, 18, 19, 20, or more modules. In some cases, a pack comprises at least about 3 modules. In some cases, a pack is capable of storing at least about 2 kilo-Watt-hours of energy and/or delivering at least about 0.4 kilo-Watts (e.g., at least about 0.5 kilo-Watts or 1.0 kilo-Watts) of power. In some cases, a pack is capable of storing at least about 3 kilo-Watt-hours of energy and/or delivering at least about 0.75 kilo-Watts (e.g., at least about 1.5 kilo-Watts) of power. In some cases, a pack comprises at least about 6 modules. In some cases, a pack is capable of storing about 6 kilo-Watt-hours of energy and/or delivering at least about 1.5 kilo-Watts (e.g., about 3 kilo-Watts) of power. A pack or tray can comprise any number of cells (e.g., 1, 2, 3, 4, 5, 6, 7, 8, 9, 10, 11, 12, 13, 14, 15, 16, 17, 18, 19, 20, 25, 30, 40, 50, 60, 80, 100, 120, 140, 160, 200, 250, 300 or more). In some cases, a pack or tray comprises 160 cells. In some cases, a pack is capable of storing at least about 64 kilowatt-hours of energy and/or delivering at least about 12 kilowatts of power.

The term “core,” as used herein generally refers to a plurality of modules or packs that are attached through different electrical connections (e.g., in series and/or parallel). A core can comprise any number of modules or packs (e.g., 1, 2, 3, 4, 5, 6, 7, 8, 9, 10, 11, 12, 13, 14, 15, 16, 17, 18, 19, 20, or more). In some cases, the core also comprises mechanical, electrical, and thermal systems that allow the core to efficiently store and return electrical energy in a controlled manner. In some cases, a core comprises 12 packs. In some cases, a core is capable of storing about 25 kilo-Watt-hours of energy and/or delivering about 6.25 kilo-Watts of power. In some cases, a core comprises at least about 36 packs. In some cases, a core is capable of storing at least about 200 kilo-Watt-hours of energy and/or delivering at least about 40, 50, 60, 70, 80, 90 or 100 kilo-Watts or more of power.

The term “pod,” “core enclosure,” or “CE” as used herein, generally refers to a plurality of cores that are attached through different electrical connections (e.g., in series and/or parallel). A pod or CE can comprise any number of cores (e.g., 1, 2, 3, 4, 5, 6, 7, 8, 9, 10, 11, 12, 13, 14, 15, 16, 17, 18, 19, 20, or more). In some cases, the pod or CE contains cores that are connected in parallel with appropriate by-pass electronic circuitry, thus enabling a core to be disconnected while continuing to allow the other cores to store and return energy. In some cases, a pod or CE comprises at least 4 cores. In some cases, a pod or CE is capable of storing at least about 100 kilo-Watt-hours of energy and/or delivering about 25 kilo-Watts of power. In some cases, a pod or CE comprises 4 cores. In some cases, a pod or CE is capable of storing about 100 kilo-Watt-hours of energy and/or delivering about 25 kilo-Watts of power. In some cases, a pod or CE is capable of storing about 400 kilo-Watt-hours of energy and/or delivering at least about 80 kilo-Watts, e.g., at least or about 80, 100, 120, 140, 160, 180 or 200 kilo-Watts or more of power.

The term “system,” as used herein, generally refers to a plurality of cores or CEs that are attached through different electrical connections (e.g., in series and/or parallel). A system can comprise any number of cores or CEs, e.g., at least about 2, 3, 4, 5, 6, 7, 8, 9, 10, 11, 12, 13, 14, 15, 16, 17, 18, 19, 20, or more cores. In some cases, a system comprises 20 CEs. In some cases, a system is capable of storing about 2 mega-Watt-hours of energy and/or delivering at least about 400 kilo-Watts (e.g., about 500 kilo-Watts or about 1000 kilo-Watts) of power. In some cases, a system comprises 5 CEs. In some cases, a system is capable of storing about 2 mega-Watt-hours of energy and/or delivering at least about 400 kilo-Watts, e.g., at least about 400, 500, 600, 700, 800, 900, 1000 kilo-Watts or more of power.

The term “battery,” as used herein, generally refers to one or more electrochemical cells connected in series and/or parallel. A battery can comprise any number of electrochemical cells, modules, packs, cores, CEs or systems. A battery may undergo at least one charge/discharge or discharge/charge cycle (“cycle”).

The term “cycle,” as used herein, generally refers to a charge/discharge or discharge/charge cycle.

The term “charge cut-off voltage” or “CCV,” as used herein, generally refers to the voltage at which a cell is fully or substantially fully charged, such as a voltage cut-off limit used in a battery when cycled in a constant current mode.

The term “discharge cut-off voltage,” as used herein, generally refers to the voltage at which a cell is fully or substantially fully discharged, such as a minimum voltage cut-off limit used in a battery when discharged in a constant current cycling mode.

The term “open circuit voltage” or “OCV,” as used herein, generally refers to the voltage of a cell (e.g., fully or partially charged) when it is disconnected from any circuit or external load (i.e., when no current is flowing through the cell).

The term “voltage” or “cell voltage,” as used herein, generally refers to the voltage of a cell (e.g., at any state of charge or charging/discharging condition). In some cases, voltage or cell voltage may be the open circuit voltage. In some cases, the voltage or cell voltage can be the voltage during charging or during discharging.

Voltages of the present disclosure may be taken or represented with respect to reference voltages, such as ground (0 volt (V)), or the voltage of the opposite electrode in an electrochemical cell.

The term “state of charge or discharge,” “state of charge” or “SOC,” as used herein, is generally directly related to the voltage of a cell. In some cases, the state of charge or discharge, state of charge or SOC may refer to the voltage of the cell with respect to another voltage, such as, for example, cell voltage after charging or cell voltage upon commencement of discharging.

The term “interconnect,” as used herein, generally refers to any electrical connection other than a direct metal-to-metal joint. Interconnects can include wires or bent sheet metal components designed to pass current. Interconnects may be compliant (e.g., flexible).

The term “wire,” as used herein, generally refers to any cord, strip, or elongated electrical conduit. Wires can be flexible. As used herein, a braided metal strip is a wire. In some cases, a busbar is a wire. The term “oxidation state,” as used herein, generally refers to a possible charged ionic state of a species when dissolved into an ionic solution or electrolyte, such as, for example, a molten halide salt (e.g., zinc²⁺ (Zn²⁺) has an oxidation state of 2+).

The term “coating,” as used herein, generally refers to an organic or inorganic layer that is applied to a surface. For example, a coating may be applied to a surface of the housing, container lid, or other components of the electrochemical cell. The coating may increase resistance of a surface to corrosion from the components of the electrochemical cell (e.g., electrode or electrolyte materials). The coating may comprise one or more layers.

The term “surface treatment,” as used herein, generally refers to a surface that comprises a top layer (e.g., outermost layer) that is metallurgically modified. For example, surface treatments may be applied to a surface of the housing, container lid, or other metallic components of the electrochemical cell. Surface treatments may increase the resistance of the surface to corrosion and/or may decrease thermal expansion.

### Ceramic Materials and Seals for High-Temperature Devices

The Present Disclosure Provides a Seal or a Corrosion Resistant Lining for a High-temperature device. The device can be a high temperature reactive material device that contains/comprises one or more reactive materials. For example, the high-temperature device can contain a reactive material. In some cases, the device can be a high-temperature reactive metal device. The device can be, without limitation, for the production and/or handling of a reactive material, such as, for example, a reactive metal (e.g., lithium, sodium, magnesium, aluminum, titanium and/or other reactive metals) and/or a chemical with a strong chemical reducing capability (e.g., reactive chemical), for semiconductor manufacturing, for a nuclear reactor (e.g., nuclear fusion/fission reactor, nuclear reactor that uses a molten salt or metal, such as, for example, molten sodium or lithium or molten sodium- or lithium-containing alloys, as a coolant), for a heterogeneous reactor, for a chemical processing device, for a chemical transportation device, for a chemical storage device, or for a battery (e.g., a liquid metal battery). For instance, some batteries operate at high temperatures (e.g., at least about 100 °C or 300 °C) and have reactive metal vapors (e.g., lithium, sodium, potassium, magnesium, or calcium) that may need to be sufficiently contained within the battery. In some examples, such high-temperature devices operate, are heated to and/or maintained at a temperature of at least about 100 °C, 150 °C, 200 °C, 250 °C, 300 °C, 350 °C, 400 °C, 450 °C, 500 °C, 550 °C, 600 °C, 650 °C, 700 °C, 750 °C, 800 °C, 850 °C, 900 °C or more. At such temperatures, one or more components of the device can be in a liquid (or molten) or vaporized state.

The corrosion resistant lining may comprise a ceramic material. The ceramic material may function as a protective lining in a reactor chamber that contains reactive material. For example, the reactor chamber may contain reactive material at an operating temperature of, for example, greater than about 300 °C or 400 °C. The reactive material May comprise or be a reactive liquid metal and/or molten salt(s). In some cases (e.g., in some nuclear reactors), molten salt may be used instead of liquid metal. The molten salt may contain dissolved liquid reactive metal.

The ceramic material may function as a dielectric insulator in a device that contains one or more reactive materials. The device may operate at a temperature of, for example, at least about 300 °C or 400 °C. The device may be associated with a nuclear fission or fusion reactor. The dielectric insulator may be part of a seal (e.g., a gas-tight seal). The ceramic material may be used in a seal of a device that contains reactive materials and operates at a temperature of greater than about 300 °C.

The seal can comprise a ceramic material (e.g., aluminum nitride (AlN)) that is in contact with the reactive material (e.g., a reactive metal or molten salt) contained in the device. The ceramic material can be capable of being chemically resistant to a reactive material (e.g., a reactive material contained in the device, such as, for example, reactive metal or molten salt). The ceramic material can be capable of being chemically resistant to the reactive material when the device operates at a high temperature (e.g., at least about 100 °C, 150 °C, 200 °C, 250 °C, 300 °C, 350 °C, 400 °C, 500 °C, 600 °C, 700 °C, 800 °C or 900 °C).

The seal can comprise a metal collar or sleeve (e.g., made from stainless steel (SS), zirconium, nickel, a nickel-based alloy or a chromium-based alloy). A sleeve and/or the collar design can be coefficient of thermal expansion (CTE)-accommodating (e.g., can accommodate differences in CTE (also “CTE mismatch” herein)). In some cases, a sleeve can be a collar. A collar can be conical. For example, a collar can be a conical metal (e.g., stainless steel) collar. Any aspects of the disclosure described in relation to collars may equally apply to sleeves at least in some configurations, and vice versa.

The seal can comprise an active metal braze disposed between the ceramic material and at least one of the metal collar/sleeve and the device. The active metal braze can comprise a metal species that chemically reduces the ceramic material (e.g., titanium (Ti) or zirconium (Zr)).

The seal can surround an electrically conductive feed-through (and can electrically isolate the feed-through from a housing of the device), a thermocouple or a voltage sensor. For example, the ceramic material can be an insulator.

In some examples, the seal may be capable of being chemically resistant to reactive materials in the device at a temperature of at least about 100 °C, 150 °C, 200 °C, 250 °C, 300 °C, 350 °C, 400 °C, 500 °C, 600 °C, 700 °C, 800 °C or 900 °C. In some examples the seal may be capable of being chemically resistant to reactive materials at such temperatures for at least about 6 months, 1 year, 2 years, 5 years, 10 years, 20 years or more. In some examples, the device can be a high-temperature reactive metal device, and the seal can be capable of being chemically resistant to materials in the device that comprise the reactive metal. In an example, the seal is capable of being resistant to lithium vapor at a temperature of at least about 300 °C for at least about one year. The seal can retain the reactive material (e.g., vapors of the reactive material) in the device. For example, the seal can retain reactive metal vapors and/or molten salt vapors in the device. In some cases, the seal surrounds an electrically conductive feed-through (and can electrically isolate the feed-through from the housing of the device), a thermocouple or a voltage sensor.

### Electrochemical Cells, Devices and Systems

The present disclosure provides electrochemical energy storage devices (e.g., batteries) and systems. An energy storage device may form or be provided within an energy storage system. The electrochemical energy storage device generally includes at least one electrochemical cell, also “cell” and “battery cell” herein, sealed (e.g., hermetically sealed) within a housing. A cell can be configured to deliver electrical energy (e.g., electrons under potential) to a load, such as, for example, an electronic device, another energy storage device or a power grid.

An electrochemical cell of the disclosure can include a negative electrode, an electrolyte adjacent to the negative electrode, and a positive electrode adjacent to the electrolyte. The negative electrode can be separated from the positive electrode by the electrolyte. The negative electrode can be an anode during discharge. The positive electrode can be a cathode during discharge. A cell can include a negative electrode of material ‘A’ and a positive electrode of material ‘B’, denoted as A∥B. The positive and negative electrodes can be separated by an electrolyte. A cell can also include a housing, one or more current collectors, and a seal (e.g., a high temperature electrically isolating seal).

In some examples, an electrochemical cell is a liquid metal battery cell. In some examples, a liquid metal battery cell can include a liquid electrolyte arranged between a negative liquid (e.g., molten) metal electrode and a positive liquid (e.g., molten) metal, metalloid and/or non-metal electrode. In some cases, a liquid metal battery cell has a molten alkaline earth metal (e.g., magnesium, calcium) or alkali metal (e.g., lithium, sodium, potassium) negative electrode, an electrolyte, and a molten metal positive electrode. The molten metal positive electrode can include, for example, one or more of tin, lead, bismuth, antimony, tellurium and selenium. For example, the positive electrode can include Pb, a Pb—Sb alloy or Bi. The positive electrode can also include one or more transition metals or d-block elements (e.g., Zn, Cd, Hg) alone or in combination with other metals, metalloids or non-metals, such as, for example, a Zn—Sn alloy or Cd—Sn alloy. In some examples, the positive electrode can comprise a metal or metalloid that has only one stable oxidation state (e.g., a metal with a single or singular oxidation state). Any description of a metal or molten metal positive electrode, or a positive electrode, herein may refer to an electrode including one or more of a metal, a metalloid and a non-metal. The positive electrode may contain one or more of the listed examples of materials. In an example, the molten metal positive electrode can include lead and antimony. In some examples, the molten metal positive electrode may include an alkali or alkaline earth metal alloyed in the positive electrode.

In some examples, an electrochemical energy storage device includes a liquid metal negative electrode, a liquid metal positive electrode, and a liquid salt electrolyte separating the liquid metal negative electrode and the liquid metal positive electrode. The negative electrode can include an alkali or alkaline earth metal, such as lithium, sodium, potassium, rubidium, cesium, magnesium, barium, calcium, sodium, or combinations thereof. The positive electrode can include elements selected from transition metals, d-block elements (e.g., Group 12) or Group IIIA, IVA, VA and VIA of the periodic table of the elements (e.g., zinc, cadmium, mercury, aluminum, gallium, indium, silicon, germanium, tin and lead), pnicogens (e.g., arsenic, bismuth and antimony), chalcogens (e.g., sulfur, tellurium and selenium), or any combination thereof. In some examples, the positive electrode comprises a Group 12 element of the periodic table of the elements, such as one or more of zinc (Zn), cadmium (Cd) and mercury (Hg). In some cases, the positive electrode may form a eutectic or off-eutectic mixture (e.g., enabling lower operating temperature of the cell in some cases). In some examples, the positive electrode comprises a first positive electrode species and a second positive electrode species at a ratio (mol-%) of about 20:80, 40:60, 50:50, 60:40, or 80:20 of the first positive electrode species to the second electrode species. In some examples, the positive electrode comprises Sb and Pb at a ratio (mol-%) of about 20:80, 40:60, 50:50, 60:40, or 80:20 Sb to Pb. In some examples, the positive electrode comprises between about 20 mol-% and 80 mol-% of a first positive electrode species mixed with a second positive electrode species. In some cases, the positive electrode comprises between about 20 mol-% and 80 mol-% Sb (e.g., mixed with Pb). In some cases, the positive electrode comprises between about 20 mol-% and 80 mol-% Pb (e.g., mixed with Sb). In some examples, the positive electrode comprises one or more of Zn, Cd, Hg, or such material(s) in combination with other metals, metalloids or non-metals, such as, for example, a Zn—Sn alloy, Zn—Sn alloy, Cd—Sn alloy, Zn—Pb alloy, Zn—Sb alloy, or Bi. In an example, the positive electrode can comprise about 15:85, 50:50, 75:25 or 85:15 mol-% Zn:Sn.

The electrolyte can include a salt (e.g., molten salt), such as an alkali or alkaline earth metal salt. The alkali or alkaline earth metal salt can be a halide, such as a fluoride, chloride, bromide, or iodide of the active alkali or alkaline earth metal, or combinations thereof. In an example, the electrolyte (e.g., in Type 1 or Type 2 chemistries) includes lithium chloride. In some examples, the electrolyte can comprise sodium fluoride (NaF), sodium chloride (NaCl), sodium bromide (NaBr), sodium iodide (Nal), lithium fluoride (LiF), lithium chloride (LiCl), lithium bromide (LiBr), lithium iodide (LiI), potassium fluoride (KF), potassium chloride (KCl), potassium bromide (KBr), potassium iodide (KI), calcium fluoride (CaF₂), calcium chloride (CaCl₂)), calcium bromide (CaBr₂), calcium iodide (Cal₂), or any combination thereof. In another example, the electrolyte includes magnesium chloride (MgCl₂). As an alternative, the salt of the active alkali metal can be, for example, a non-chloride halide, bistriflimide, fluorosulfano-amine, perchlorate, hexaflourophosphate, tetrafluoroborate, carbonate, hydroxide, nitrate, nitrite, sulfate, sulfite, or combinations thereof. In some cases, the electrolyte can comprise a mixture of salts (e.g., 25:55:20 mol-% LiF:LiCl:LiBr, 50:37:14 mol-% LiCl:LiF:LiBr, 34:32.5:33.5 mol-% LiCl—LiBr—KBr, etc.). The electrolyte may exhibit low (e.g., minimal) electronic conductance. For example, the electrolyte can have an electronic transference number (i.e., percentage of electrical (electronic and ionic) charge that is due to the transfer of electrons) of less than or equal to about 0.03% or 0.3%.

In some cases, the negative electrode and the positive electrode of an electrochemical energy storage device are in the liquid state at an operating temperature of the energy storage device. To maintain the electrodes in the liquid states, the battery cell may be heated to any suitable temperature. In some examples, the battery cell is heated to and/or maintained at a temperature of about 100 °C, 150 °C, 200 °C, 250 °C, 300 °C, 350 °C, 400 °C, 450 °C, 475 °C, 500 °C, 550 °C, 600 °C, 650 °C or about 700 °C. The battery cell may be heated to and/or maintained at a temperature of at least about 100 °C, 150 °C, 200 °C, 250 °C, 300 °C, 350 °C, 400 °C, 450 °C, 475 °C, 500 °C, 550 °C, 600 °C, 650 °C, 700 °C, 800 °C or 900 °C. In such a case, the negative electrode, electrolyte and positive electrode can be in a liquid (or molten) state. In some situations, the battery cell is heated to between about 200 °C and 600 °C, 500 °C and 550 °C or 450 °C and 575 °C.

In some implementations, the electrochemical cell or energy storage device may be at least partially or fully self-heated. For example, a battery may be sufficiently insulated, charged, discharged and/or conditioned at sufficient rates, and/or cycled a sufficient percentage of the time to allow the system to generate sufficient heat through inefficiencies of the cycling operation that cells are maintained at a given operating temperature (e.g., a cell operating temperature above the freezing point of at least one of the liquid components) without the need for additional energy to be supplied to the system to maintain the operating temperature.

Electrochemical cells of the disclosure may be adapted to cycle between charged (or energy storage) modes and discharged modes. In some examples, an electrochemical cell can be fully charged, partially charged or partially discharged, or fully discharged.

In some implementations, during a charging mode of an electrochemical energy storage device, electrical current received from an external power source (e.g., a generator or an electrical grid) may cause metal atoms in the metal positive electrode to release one or more electrons, dissolving into the electrolyte as a positively charged ion (i.e., cation). Simultaneously, cations of the same species can migrate through the electrolyte and may accept electrons at the negative electrode, causing the cations to transition to a neutral metal species, thereby adding to the mass of the negative electrode. The removal of the active metal species from the positive electrode and the addition of the active metal to the negative electrode stores electrochemical energy. In some cases, the removal of a metal from the positive electrode and the addition of its cation to the electrolyte can store electrochemical energy. In some cases, electrochemical energy can be stored through a combination of removal of the active metal species from the positive electrode and its addition to the negative electrode, and the removal of one or more metals (e.g., different metals) from the positive electrode and their addition to the electrolyte (e.g., as cations). During an energy discharge mode, an electrical load is coupled to the electrodes and the previously added metal species in the negative electrode can be released from the metal negative electrode, pass through the electrolyte as ions, and deposit as a neutral species in the positive electrode (and in some cases alloy with the positive electrode material), with the flow of ions accompanied by the external and matching flow of electrons through the external circuit/load. In some cases, one or more cations of positive electrode material previously released into the electrolyte can deposit as neutral species in the positive electrode (and in some cases alloy with the positive electrode material), with the flow of ions accompanied by the external and matching flow of electrons through the external circuit/load. This electrochemically facilitated metal alloying reaction discharges the previously stored electrochemical energy to the electrical load.

In a charged state, the negative electrode can include negative electrode material and the positive electrode can include positive electrode material. During discharging (e.g., when the battery is coupled to a load), the negative electrode material yields one or more electrons, and cations of the negative electrode material. In some implementations, the cations migrate through the electrolyte to the positive electrode material and react with the positive electrode material (e.g., to form an alloy). In some implementations, ions of the positive metal species (e.g., cations of the positive electrode material) accept electrons at the positive electrode and deposit as a metal on the positive electrode. During charging, in some implementations, the alloy at the positive electrode disassociates to yield cations of the negative electrode material, which migrate through the electrolyte to the negative electrode. In some implementations, one or more metal species at the positive electrode disassociates to yield cations of the negative electrode material in the electrolyte. In some examples, ions can migrate through an electrolyte from an anode to a cathode, or vice versa. In some cases, ions can migrate through an electrolyte in a push-pop fashion in which an entering ion of one type ejects an ion of the same type from the electrolyte. For example, during discharge, an alkali metal anode and an alkali metal chloride electrolyte can contribute an alkali metal cation to a cathode by a process in which an alkali metal cation formed at the anode interacts with the electrolyte to eject an alkali metal cation from the electrolyte into the cathode. The alkali metal cation formed at the anode in such a case may not necessarily migrate through the electrolyte to the cathode. The cation can be formed at an interface between the anode and the electrolyte, and accepted at an interface of the cathode and the electrolyte.

Cells may have voltages. Charge cutoff voltage (CCV) may refer to the voltage at which a cell is fully or substantially fully charged, such as a voltage cutoff limit used in a battery when cycled in a constant current mode. Open circuit voltage (OCV) may refer to the voltage of a cell (e.g., fully or partially charged) when it is disconnected from any circuit or external load (i.e., when no current is flowing through the cell). Voltage or cell voltage, as used herein, may refer to the voltage of a cell (e.g., at any state of charge or charging/discharging condition). In some cases, voltage or cell voltage may be the open circuit voltage. In some cases, the voltage or cell voltage can be the voltage during charging or during discharging. Voltages of the present disclosure may be taken or represented with respect to reference voltages, such as ground (0 volt (V)), or the voltage of the opposite electrode in an electrochemical cell.

The present disclosure provides Type 1 and Type 2 cells, which can vary based on, and be defined by, the composition of the active components (e.g., negative electrode, electrolyte and positive electrode), and based on the mode of operation of the cells (e.g., low voltage mode versus high voltage mode). A cell can comprise materials that are configured for use in Type 2 mode of operation. A cell can comprise materials that are configured for use in Type 1 mode of operation. In some cases, a cell can be operated in both a high voltage (Type 2) operating mode and the low voltage (Type 1) operating mode. For example, a cell with positive and negative electrode materials that are ordinarily configured for use in a Type 1 mode can be operated in a Type 2 mode of operation. A cell can be cycled between Type 1 and Type 2 modes of operation. A cell can be initially charged (or discharged) under Type 1 mode to a given voltage (e.g., 0.5 V to 1 V), and subsequently charged (then discharged) under Type 2 mode to a higher voltage (e.g., 1.5 V to 2.5 V, or 1.5 V to 3 V). In some cases, cells operated under Type 2 mode can operate at a voltage between electrodes that can exceed those of cells operated under Type 1 mode. In some cases, Type 2 cell chemistries can operate at a voltage between electrodes that can exceed those of Type 1 cell chemistries operated under Type 1 mode. Type 2 cells can be operated in Type 2 mode.

In some examples, a Type 1 cell includes a negative electrode comprising an alkali or alkaline earth metal (e.g., lithium, sodium, potassium, magnesium, calcium), and a positive electrode comprising a poor metal, or alloys of such metals, such as one or more of tin, lead, bismuth, antimony, tellurium and selenium. The negative electrode and positive electrode can be in a liquid (or molten) state at an operating temperature of the cell. The negative and positive electrodes can be separated by a salt electrolyte (e.g., alkali or alkaline earth metal halide salts).

In an example Type 1 cell, upon discharging, cations formed at the negative electrode can migrate into the electrolyte. Concurrently, the electrolyte can provide a cation of the same species (e.g., the cation of the negative electrode material) to the positive electrode (e.g., Sb, Pb, Bi, Sn, or any combination thereof), which can reduce from a cation to a neutrally charged metallic species, and alloy with the positive electrode. In some examples, different cation species in the electrolyte can co-deposit onto the positive electrode (e.g., calcium²⁺ (Ca²⁺) and lithium⁺ (Li⁺) deposit onto Sb and form Ca—Li—Sb alloy(s)). In a discharged state, the negative electrode can be depleted (e.g., partially or fully) of the negative electrode material (e.g., lithium (Li), sodium (Na), potassium (K), Mg, Ca). During charging, the alloy at the positive electrode can disassociate to yield one or more different species of cations of the negative electrode material (e.g., Li⁺, Na⁺, K⁺, Mg²⁺, Ca²⁺), which migrates into the electrolyte. The electrolyte can then provide cations (e.g., a cation of the negative electrode material) to the negative electrode, where the cations accept one or more electrons from an external circuit and are converted back to a neutral metal species, which replenishes the negative electrode to provide a cell in a charged state. In some examples, different cation species in the electrolyte can co-deposit onto the negative electrode during charging. A Type 1 cell can operate in a push-pop fashion, in which the entry of one or a set of cations into the electrolyte results in the discharge of the same cation or same set of cation species from the electrolyte.

In Type 2 mode (also “high voltage operation” mode herein), operation of a liquid metal battery cell involves a non-symmetric or substantially non-symmetric reaction where one metal species is electrochemically active at one electrode and a second metal species is electrochemically active at the other electrode, resulting in a net change in the composition of the electrolyte at different states of charge. This mode of operation can initiate new chemical reactions compared to the Type 1 mode of operation, in some cases resulting in, or otherwise utilizing, a relatively higher cell voltage (e.g., 1 V to 3 V). Type 2 mode of operation can offer the possibility of using a wider variety of active materials, and combination of such materials, as the electrochemistry of the cell.

In an example Type 2 cell, in a discharged state the electrolyte comprises cations of the negative electrode material (e.g., Li⁺, Na⁺, K⁺, Mg²⁺, Ca²⁺), and the positive electrode comprises positive electrode material (e.g., Sb, Pb, Sn, Bi, Zn, Hg). During charging, a cation of the negative electrode material from the electrolyte accepts one or more electrons (e.g., from a negative current collector) to form the negative electrode comprising the negative electrode material. In some examples, the negative electrode material is liquid and wets into a foam (or porous) structure of the negative current collector. In some examples, negative current collector may not comprise foam (or porous) structure. In some examples, the negative current collector may comprise a metal, such as, for example, tungsten (e.g., to avoid corrosion from Zn), tungsten carbide or molybdenum negative collector not comprising Fe—Ni foam. Concurrently, positive electrode material from the positive electrode sheds electrons (e.g., to a positive current collector) and dissolves into the electrolyte as cations of the positive electrode material (e.g., Sb³⁺, Pb²⁺, Sn²⁺, Bi³⁺, Zn²⁺, Hg²⁺). The concentration of the cations of the positive electrode material can vary in vertical proximity within the electrolyte (e.g., as a function of distance above the positive electrode material) based on the atomic weight and diffusion dynamics of the cation material in the electrolyte. In some examples, the cations of the positive electrode material are concentrated in the electrolyte near the positive electrode.

In some implementations, negative electrode material may not need to be provided at the time of assembly of a cell that can be operated in a Type 2 mode. For example, a Li∥Pb cell or an energy storage device comprising such cell(s) can be assembled in a discharged state having only a Li salt electrolyte and a Pb or Pb alloy (e.g., Pb—Sb) positive electrode (i.e., Li metal may not be required during assembly).

Although electrochemical cells of the present disclosure have been described, in some examples, as operating in a Type 1 mode or Type 2 mode, other modes of operation are possible. Type 1 mode and Type 2 mode are provided as examples and are not intended to limit the various modes of operation of electrochemical cells disclosed herein.

In some cases, an electrochemical cell comprises a liquid metal negative electrode (e.g., sodium (Na) or lithium (Li)), a liquid (e.g., LiF—LiCl—LiBr, LiCl—KCl or LiCl—LiBr—KBr) or solid ion-conducting electrolyte (e.g., β″-alumina ceramic), and a liquid or semi-solid positive electrode (e.g., a solid matrix or particle bed impregnated with a liquid or molten electrolyte). Such a cell can be a high temperature battery. One or more such cells can be provided in an electrochemical energy storage device. The negative electrode may comprise an alkali or alkaline earth metal, such as, for example, lithium, sodium, potassium, magnesium, calcium, or any combination thereof. The positive electrode and/or electrolyte may comprise a liquid chalcogen or a molten chalcogen-halogen compound (e.g., elemental, ionic or other form of sulfur(S), selenium (Se) or tellurium (Te)), a molten salt comprising a transition metal halide (e.g., halides comprising Ni, Fe, Cr, Mn, Co or V, such as, for example, NiCl₃ or FeCl₃), a solid transition metal (e.g., particles of Ni, Fe, Cr, Mn, Co or V), sulfur, one or more metal sulfides (e.g., FeS₂, FeS, NiS₂, CoS₂, or any combination thereof), a liquid or molten alkali halometallate (e.g., comprising Al, Zn or Sn) and/or other (e.g., supporting) compounds (e.g., NaCl, NaF, NaBr, Nal, KCl, LiCl or other alkali halides, bromide salts, elemental zinc, zinc-chalcogen or zinc-halogen compounds, or metallic main-group metals or oxygen scavengers such as, for example, aluminum or transition metal-aluminum alloys), or any combination thereof. The solid ion-conducting electrolyte may comprise a beta alumina (e.g., β″-alumina) ceramic capable of conducting sodium ions at elevated or high temperature. In some instances, the solid ion-conducting electrolyte operates above about 100 °C, 150 °C, 200 °C, 250 °C, 300 °C or 350 °C.

Any aspects of the disclosure described in relation to cathodes can equally apply to anodes at least in some configurations. Similarly, one or more battery electrodes and/or the electrolyte may not be liquid in alternative configurations. In an example, the electrolyte can be a polymer, a gel or a paste. In a further example, at least one battery electrode can be a solid, a gel or a paste. Furthermore, in some examples, the electrodes and/or electrolyte may not include metal. Aspects of the disclosure are applicable to a variety of energy storage/transformation devices without being limited to liquid metal batteries.

### Batteries and Housings

Electrochemical cells of the disclosure can include housings that may be suited for various uses and operations. A housing can include one cell or a plurality of cells. A housing can be configured to electrically couple the electrodes to a switch, which can be connected to the external power source and the electrical load. The cell housing may include, for example, an electrically conductive container that is electrically coupled to a first pole of the switch and/or another cell housing, and an electrically conductive container lid that is electrically coupled to a second pole of the switch and/or another cell housing. The cell can be arranged within a cavity of the container. A first one of the electrodes of the cell (e.g., positive electrode) can contact and be electrically coupled with an endwall of the container. A second one of the electrodes of the cell (e.g., negative electrode) can contact and be electrically coupled with a conductive feed-through or conductor (e.g., negative current lead) on the container lid (collectively referred to herein as “cell lid assembly,” “lid assembly” or “cap assembly” herein). An electrically insulating seal (e.g., bonded ceramic ring) may electrically isolate negative potential portions of the cell from positive portions of the container (e.g., electrically insulate the negative current lead from the positive current lead). In an example, the negative current lead and the container lid (e.g., cell cap) can be electrically isolated from each other, where a dielectric sealant material can be placed between the negative current lead and the cell cap. As an alternative, a housing includes an electrically insulating sheath (e.g., alumina sheath) or corrosion resistant and electrically conductive sheath or crucible (e.g., graphite sheath or crucible). In some cases, a housing and/or container may be a battery housing and/or container.

A cell can have any cell and seal configuration disclosed herein. For instance, the active cell materials can be held within a sealed steel/stainless steel container with a high temperature seal on the cell lid. A negative current lead can pass through the cell lid (and be sealed to the cell lid by the dielectric high temperature seal), and connect with a porous negative current collector (e.g., metal foam) suspended in an electrolyte. In some cases, the cell can use a graphite sheath, coating, crucible, surface treatment or lining (or any combination thereof) on the inner wall of the cell crucible (e.g., container). In other cases, the cell may not use a graphite sheath, coating, crucible, surface treatment or lining on an inner wall of the cell crucible (e.g., container).

During cell operation, material (e.g., Fe) from a wall of the cell can react under the higher voltage potential (e.g., Type 2 mode), and ionize as a soluble species in the electrolyte. Hence, the wall material can dissolve into the electrolyte and subsequently interfere with the cell's electrochemistry. For example, the dissolved material can deposit on the negative electrode, which, in some cases, can grow as dendrites and stretch across the electrolyte to one or more walls of the cell, or toward the positive electrode, which can result in a short failure. The present disclosure provides various approaches for suppressing or otherwise helping minimize the dissolution of solid (passive) cell material such as Fe and its potentially negative effects on cell performance by, for example, formation of dendrites and cell shorting. In some cases, a cell can be designed such that increased spacing between the negative electrode and a wall of the cell suppresses or otherwise helps minimize the ability of dendrites from forming and shorting the wall to the inner wall. A cell can include an electrically insulating, and chemically stable sheath or coating between one or more walls of the cell and the negative electrode, electrolyte and/or positive electrode to minimize or prevent shorting to the one or more walls of the cell. In some cases, the cell can be formed of a non-ferrous container or container lining, such as a carbon-containing material (e.g., graphite), or a carbide (e.g., SiC, TiC), or a nitride (e.g., TiN, BN), or a chemically stable metal (e.g., Ti, Ni, B). The container or container lining material may be electrically conductive. Such non-limiting approaches can be used separately or in combination, for suppressing or otherwise helping minimize chemical interactions with Fe or other cell wall materials, and any subsequent negative effects on cell performance.

A cell may have a set of dimensions. In some cases, a cell can be greater than or equal to about 4 inches wide, 4 inches deep and 2.5 inches tall. In some cases, a cell can be greater than or equal to about 8 inches wide, 8 inches deep and 2.5 inches tall. In some examples, any given dimension (e.g., height, width or depth) of an electrochemical cell can be at least about 1, 2, 2.5, 3, 3.5, 4, 4.5, 5, 5.5, 6, 6.5, 7, 7.5, 8, 8.5, 9, 9.5, 10, 12, 14, 16, 18 or 20 inches. In an example, a cell (e.g., each cell) can have dimensions of greater than or equal to about 4 inches×4 inches×2.5 inches. In another example, a cell (e.g., each cell) can have dimensions of greater than or equal to about 8 inches×8 inches×2.5 inches. In some cases, a cell may have greater than or equal to about 50 Watt-hours of energy storage capacity. In some cases, a cell may have at least about 200 Watt-hours of energy storage capacity.

One or more electrochemical cells (“cells”) may be arranged in groups. Examples of groups of electrochemical cells include modules, packs, cores, CEs and systems.

A module can comprise cells that are attached together in parallel by, for example, mechanically connecting the cell housing of one cell with the cell housing of an adjacent cell (e.g., cells that are connected together in an approximately horizontal packing plane). In some cases, the cells are connected to each other by joining features that are part of and/or connected to the cell body (e.g., tabs protruding from the main portion of the cell body). A module can include a plurality of cells in parallel. A module can comprise any number of cells, e.g., at least about 2, 3, 4, 5, 6, 7, 8, 9, 10, 11, 12, 13, 14, 15, 16, 17, 18, 19, 20 or more cells. In some cases, a module comprises at least about 4, 9, 12 or 16 cells. In some cases, a module is capable of storing greater than or equal to about 700 Watt-hours of energy and/or delivering at least about 175 Watts of power. In some cases, a module is capable of storing at least about 1080 Watt-hours of energy and/or delivering at least about 500 Watts of power. In some cases, a module is capable of storing at least about 1080 Watt-hours of energy and/or delivering at least about 200 Watts (e.g., greater than or equal to about 500 Watts) of power. In some cases, a module can include a single cell.

A pack can comprise modules that are attached through different electrical connections (e.g., vertically). A pack can comprise any number of modules, e.g., at least about 1, 2, 3, 4, 5, 6, 7, 8, 9, 10, 11, 12, 13, 14, 15, 16, 17, 18, 19, 20 or more modules. In some cases, a pack comprises at least about 3 modules. In some cases, a pack is capable of storing at least about 2 kilo-Watt-hours of energy and/or delivering at least about 0.4 kilo-Watts (e.g., at least about 0.5 kilo-Watts or 1.0 kilo-Watts) of power. In some cases, a pack is capable of storing at least about 3 kilo-Watt-hours of energy and/or delivering at least about 0.75 kilo-Watts (e.g., at least about 1.5 kilo-Watts) of power. In some cases, a pack comprises at least about 6 modules. In some cases, a pack is capable of storing greater than or equal to about 6 kilo-Watt-hours of energy and/or delivering at least about 1.5 kilo-Watts (e.g., greater than or equal to about 3 kilo-Watts) of power.

A core can comprise a plurality of modules or packs that are attached through different electrical connections (e.g., in series and/or parallel). A core can comprise any number of modules or packs, e.g., at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50 or more packs. In some cases, the core also comprises mechanical, electrical, and thermal systems that allow the core to efficiently store and return electrical energy in a controlled manner. In some cases, a core comprises at least about 12 packs. In some cases, a core is capable of storing at least about 25 kilo-Watt-hours of energy and/or delivering at least about 6.25 kilo-Watts of power. In some cases, a core comprises at least about 36 packs. In some cases, a core is capable of storing at least about 200 kilo-Watt-hours of energy and/or delivering at least about 40, 50, 60, 70, 80, 90 or 100 kilo-Watts or more of power.

A core enclosure (CE) can comprise a plurality of cores that are attached through different electrical connections (e.g., in series and/or parallel). A CE can comprise any number of cores, e.g., at least about 1, 2, 3, 4, 5, 6, 7, 8, 9, 10, 11, 12, 13, 14, 15, 16, 17, 18, 19, 20 or more cores. In some cases, the CE contains cores that are connected in parallel with appropriate by-pass electronic circuitry, thus enabling a core to be disconnected while continuing to allow the other cores to store and return energy. In some cases, a CE comprises at least 4 cores. In some cases, a CE is capable of storing at least about 100 kilo-Watt-hours of energy and/or delivering greater than or equal to about 25 kilo-Watts of power. In some cases, a CE comprises 4 cores. In some cases, a CE is capable of storing greater than or equal to about 100 kilo-Watt-hours of energy and/or delivering greater than or equal to about 25 kilo-Watts of power. In some cases, a CE is capable of storing greater than or equal to about 400 kilo-Watt-hours of energy and/or delivering at least about 80 kilo-Watts, e.g., greater than or equal to about 80, 100, 120, 140, 160, 180, 200, 250 or 300 kilo-Watts or more of power.

A system can comprise a plurality of cores or CEs that are attached through different electrical connections (e.g., in series and/or parallel). A system can comprise any number of cores or CEs, e.g., at least about 2, 3, 4, 5, 6, 7, 8, 9, 10, 11, 12, 13, 14, 15, 16, 17, 18, 19, 20 or more cores. In some cases, a system comprises 20 CEs. In some cases, a system is capable of storing greater than or equal to about 2 mega-Watt-hours of energy and/or delivering at least about 400 kilo-Watts (e.g., about or at least about 500 kilo-Watts or 1000 kilo-Watts) of power. In some cases, a system comprises 5 CEs. In some cases, a system is capable of storing greater than or equal to about 2 mega-Watt-hours of energy and/or delivering at least about 400 kilo-Watts, e.g., at least about 400, 500, 600, 700, 800, 900, 1,000, 1,200, 1,500, 2,000, 2,500, 3,000 or 5,000 kilo-Watts or more of power.

A group of cells (e.g., a core, a CE, a system, etc.) with a given energy capacity and power capacity (e.g., a CE or a system capable of storing a given amount of energy) may be configured to deliver at least about 10%, 20%, 30%, 40%, 50%, 60%, 70%, 80%, 90% or 95%, or about 100% of a given (e.g., rated) power level. For example, a 1000 kW system may be capable of also operating at 500 kW, but a 500 kW system may not be able to operate at 1000 kW. In some cases, a system with a given energy capacity and power capacity (e.g., a CE or a system capable of storing a given amount of energy) may be configured to deliver less than about 100%, 110%, 125%, 150%, 175% or 200% of a given (e.g., rated) power level, and the like. For example, the system may be configured to provide more than its rated power capacity for a period of time that is less than the time it may take to consume its energy capacity at the power level that is being provided (e.g., provide power that is greater than the rated power of the system for a period of time corresponding to less than about 1%, 10% or 50% of its rated energy capacity).

A battery can comprise one or more electrochemical cells connected in series and/or parallel. A battery can comprise any number of electrochemical cells, modules, packs, cores, CEs or systems. A battery may undergo at least one charge/discharge or discharge/charge cycle (“cycle”).

A battery can comprise one or more (e.g., a plurality of) electrochemical cells. The cell(s) can include housings. Individual cells can be electrically coupled to one another in series and/or in parallel. In series connectivity, the positive terminal of a first cell is connected to a negative terminal of a second cell. In parallel connectivity, the positive terminal of a first cell can be connected to a positive terminal of a second, and/or additional, cell(s). Similarly, cell modules, packs, cores, CEs and systems can be connected in series and/or in parallel in the same manner as described for cells.

Reference will now be made to the figures, wherein like numerals refer to like parts throughout. It will be appreciated that the figures and features therein are not necessarily drawn to scale.

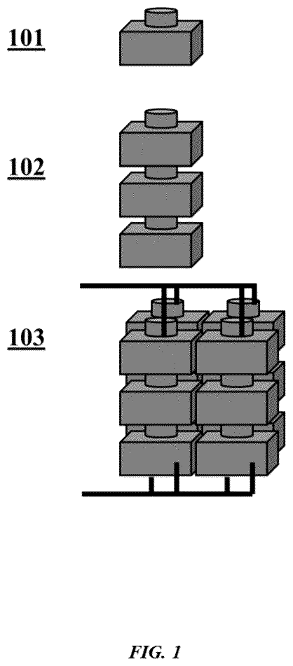

With reference to FIG. 1, an electrochemical cell 101 is a unit comprising an anode and a cathode. The cell may comprise an electrolyte and be sealed in a housing as described herein. In some cases, the electrochemical cells can be stacked 102 to form a battery (i.e., a compilation of one or more electrochemical cells). The cells can be arranged in parallel, in series, or both in parallel and in series 103. Further, as described in greater detail elsewhere herein, the cells can be arranged in groups (e.g., modules, packs, cores, CEs, systems, or any other group comprising one or more electrochemical cells). In some cases, such groups of electrochemical cells may allow a given number of cells to be controlled or regulated together at the group level (e.g., in concert with or instead of regulation/control of individual cells). Interconnections may connect individual cells and/or groups of cells.

The battery may be assembled through repeated addition of individual cells or groups of cells. In one example, cells can be assembled into modules, which can be stacked to form packs, which can then be interconnected to form cores. In some cases, the packs may be assembled (e.g., vertically and/or horizontally) on trays, which is another example of a group of electrochemical cells; the trays can be assembled (e.g., vertically and/or horizontally) to form cores. Further, the cores can then be interconnected to form CEs and systems. In another example, cells can be assembled into modules, which can be interconnected (e.g., vertically and horizontally) to form cores. In yet another example, cells can be stacked to form a single cell tower (see, for example, 102), which is yet another example of a group of electrochemical cells. Multiple cell towers, each comprising multiple cells stacked vertically on top one another, can then be added together to form, for example, a pack. Thus, in an example, a pack comprising a stack of 4 modules, each module comprising a 2 by 2 array of cells, can also be assembled by interconnecting 4 towers with 4 cells each (arranged in a 2 by 2 array of towers). Groups of cells utilized for assembly purposes may or may not be the same as groups of cells utilized for regulation/control purposes. Groups of cells may be supported by (e.g., packs or cores) or comprise (e.g., trays or towers) various frames. The frames of different groups of cells may be connected during assembly.

Electrochemical cells of the disclosure (e.g., Type 1 cell operated in Type 2 mode, Type 1 cell operated in Type 1 mode, or Type 2 cell) may be capable of storing, receiving input of (“taking in”) and/or discharging a suitably large amount of energy (e.g., substantially large amounts of energy). In some instances, a cell is capable of storing, taking in and/or discharging greater than or equal to about 1 watt-hour (Wh), 5 Wh, 25 Wh, 50 Wh, 100 Wh, 250 Wh, 500 Wh, 1 kilo-Watt-hour (kWh), 1.5 kWh, 2 kWh, 3 kWh, 5 kWh, 10 kWh, 15 kWh, 20 kWh, 30 kWh, 40 kWh, 50 kWh, 100 kWh, 500 kWh, 1 mega-watt-hour (MWh), 5 MWh, 10 MWh, 50 MWh, or 100 MWh. It is recognized that the amount of energy stored in an electrochemical cell and/or battery may be less than the amount of energy taken into the electrochemical cell and/or battery (e.g., due to inefficiencies and losses). A cell can have such energy storage capacities upon operating at any of the current densities herein.

The cell can have a suitable energy storage capacity. In an example, a cell comprises an anode and a cathode. The cell can be capable of storing at least about 10 Wh of energy. At least one of the anode and the cathode can be a liquid metal. In another example, an electrochemical cell comprises an electrically conductive housing comprising a liquid metal (including liquid metal alloys) that is liquid at an operating temperature of, for example, at least about 200 °C. The electrochemical cell may be capable of storing at least about 50 Wh or 270 Wh of energy. The liquid metal can be configured (e.g., as part of an electrochemical cell) to store/release charge during charge/discharge of the electrochemical cell. The electrochemical cell can comprise a conductor in electrical contact with the liquid metal. The conductor can protrude through the electrically conductive housing through an aperture in the electrically conductive housing. The electrochemical cell can comprise a seal that seals the conductor to the electrically conductive housing. In some cases, the seal electrically isolates the conductor from the electrically conductive housing.

A cell can be capable of providing a current at a current density of at least about 10 milli-amperes per square centimeter (mA/cm²), 20 mA/cm², 30 mA/cm², 40 mA/cm², 50 mA/cm², 60 mA/cm², 70 mA/cm², 80 mA/cm², 90 mA/cm²,100 mA/cm², 200 mA/cm², 300 mA/cm², 400 mA/cm², 500 mA/cm², 600 mA/cm², 700 mA/cm², 800 mA/cm², 900 mA/cm², 1 A/cm², 2 A/cm², 3 A/cm², 4 A/cm², 5 A/cm² or 10 A/cm², where the current density is determined based on the effective cross-sectional area of the electrolyte and where the cross-sectional area is the area that is orthogonal to the net flow direction of ions through the electrolyte during charge or discharging processes. In some instances, a cell can be capable of operating at a direct current (DC) efficiency of at least about 10%, 20%, 30%, 35%, 40%, 45%, 50%, 55%, 60%, 65%, 70%, 75%, 80%, 90%, 95%, and the like. In some instances, a cell can be capable of operating at a charge efficiency (e.g., Coulombic charge efficiency) of at least about 10%, 20%, 30%, 40%, 50%, 60%, 70%, 80%, 85%, 90%, 95%, 98%, 99%, 99.5%, 99.9%, 99.95%, 99.99%, and the like.

In a charged state, electrochemical cells of the disclosure (e.g., Type 1 cell operated in Type 2 mode, Type 1 cell operated in Type 1 mode, or Type 2 cell) can have (or can operate at) a voltage of at least about 0 V, 0.1 V, 0.2 V, 0.3 V, 0.4 V, 0.5 V, 0.6 V, 0.7 V, 0.8 V, 0.9 V, 1.0 V, 1.1 V, 1.2 V, 1.3 V, 1.4V, 1.5 V, 1.6 V, 1.7V, 1.8 V, 1.9 V, 2.0 V, 2.1 V, 2.2 V, 2.3 V, 2.4 V, 2.5 V, 2.6 V, 2.7 V, 2.8 V, 2.9 V or 3.0 V. In some cases, a cell can have an open circuit voltage (OCV) of at least about 0.2 V, 0.3 V, 0.4 V, 0.5 V, 0.6 V, 0.7 V, 0.8 V, 0.9 V, 1.0 V, 1.1 V, 1.2 V, 1.3 V, 1.4 V, 1.5 V, 1.6 V, 1.7 V, 1.8 V, 1.9 V, 2.0 V, 2.1 V, 2.2 V, 2.3 V, 2.4 V, 2.5 V, 2.6 V, 2.7 V, 2.8 V, 2.9 V or 3.0 V. In an example, a cell has an open circuit voltage greater than about 0.5 V, 1 V, 2 V or 3 V. In some cases, a charge cutoff voltage (CCV) of a cell is from greater than or equal to about 0.5 V to 1.5 V, 1 V to 3 V, 1.5 V to 2.5 V, 1.5 V to 3 V or 2 V to 3 V in a charged state. In some cases, a charge cutoff voltage (CCV) of a cell is at least about 0.5 V, 0.6 V, 0.7 V, 0.8 V, 0.9 V, 1.0 V, 1.1 V, 1.2 V, 1.3 V, 1.4 V, 1.5 V, 1.6 V, 1.7 V, 1.8 V, 1.9 V, 2.0 V, 2.1 V, 2.2 V, 2.3 V, 2.4 V, 2.5 V, 2.6 V, 2.7 V, 2.8 V, 2.9 V or 3.0 V. In some cases, a voltage of a cell (e.g., operating voltage) is between about 0.5 V and 1.5 V, 1 V and 2 V, 1 V and 2.5 V, 1.5 V and 2.0 V, 1 V and 3 V, 1.5 V and 2.5 V, 1.5 V and 3 V or 2 V and 3 V in a charged state. A cell can provide such voltage(s) (e.g., voltage, OCV and/or CCV) upon operating at up to and exceeding about 10 cycles, 20 cycles, 30 cycles, 40 cycles, 50 cycles, 100 cycles, 200 cycles, 300 cycles, 400 cycles, 500 cycles, 600 cycles, 700 cycles, 800 cycles, 900 cycles, 1,000 cycles, 2,000 cycles, 3,000 cycles, 4,000 cycles, 5,000 cycles, 10,000 cycles, 20,000 cycles, 50,000 cycles, 100,000 cycles or 1,000,000 or more cycles (also “charge/discharge cycles” herein).

In some cases, the limiting factor on the number of cycles may be dependent on, for example, the housing and/or the seal as opposed to the chemistry of the negative electrode, electrolyte and/or the positive electrode. The limit in cycles may be dictated not by the electrochemistry, but by the degradation of non-active components of the cell, such as the container or seal. A cell can be operated without a substantial decrease in capacity. The operating lifetime of a cell can be limited, in some cases, by the life of the container, seal and/or cap of the cell. During operation at an operating temperature of the cell, the cell can have a negative electrode, electrolyte and positive electrode in a liquid (or molten) state.

An electrochemical cell may operate in a voltage-limited mode, capacity-limited mode, constant current mode, constant power mode, constant voltage mode, or any combination thereof. An electrochemical cell can be operated at a voltage of greater than or equal to about 0.1 V, 0.2 V, 0.3 V, 0.4 V, 0.5 V, 0.6 V, 0.8 V, 1 V, 1.2 V, 1.4 V, 1.6 V, or more. In an example, an electrochemical cell may be operated from about 0.2 V to 1.5 V or from about 0.6 V to 1.2 V.

An electrochemical cell of the present disclosure can have a response time of any suitable value (e.g., suitable for responding to disturbances in the power grid). In some instances, the response time is less than or equal to about 100 milliseconds (ms), 50 ms, 10 ms, 1 ms, and the like. In some cases, the response time is at most about 100 ms, 50 ms, 10 ms, 1 ms, and the like.

A compilation or array of cells (e.g., battery) can include any suitable number of cells, such as at least about 2, 5, 10, 50, 100, 500, 1000, 5000, 10000, and the like. In some examples, a battery includes at least about 1, 2, 3, 4, 5, 6, 7, 8, 9, 10, 15, 20, 30, 40, 50, 60, 70, 80, 90, 100, 200, 300, 400, 500, 600, 700, 800, 900, 1000, 2000, 5000, 10,000, 20,000, 50,000, 100,000, 500,000 or 1,000,000 cells.

In some implementations, one or more types of cells can be included in energy storage systems of the present disclosure. For example, an energy storage device can comprise Type 2 cells or a combination of Type 1 cells and Type 2 cells (e.g., 50% Type 1 cells and 50% Type 2 cells). Such cells can be operated under Type 2 mode. In some cases, a first portion of the cells may be operated in Type 1 mode, and a second portion of the cells may be operated in Type 2 mode.

Batteries of the disclosure may be capable of storing and/or taking in a suitably large amount of energy (e.g., a substantially large amount of energy) for use with a power grid (i.e., a grid-scale battery) or other loads or uses. In some instances, a battery is capable of storing, taking in and/or discharging greater than or equal to about 1 watt-hour (Wh), 5 Wh, 25 Wh, 50 Wh, 100 Wh, 250 Wh, 500 Wh, 1 kilo-Watt-hour (kWh), 1.5 kWh, 2 kWh, 3 kWh, 5 kWh, 10 kWh, 15 kWh, 20 kWh, 25 kWh, 30 kWh, 40 kWh, 50 kWh, 100 kWh, 500 kWh, 1 mega-Watt-hour (MWh), 1.5 MWh, 2 MWh, 3 MWh, 4 MWh, 5 MWh, 10 MWh, 25 MWh, 50 MWh or 100 MWh.

The battery can be any suitable size (e.g., have a suitable energy storage capacity). In an example, a battery comprises a plurality of electrochemical cells connected in series. The battery can be capable of storing at least about 10 kWh of energy and can have an operating temperature of, for example, at least about 250 °C. Each of the electrochemical cells can have at least one liquid metal electrode. In some cases, the battery is capable of storing at least about 30 kWh or 100 kWh of energy. In another example, a group of cells is capable of storing at least about 10 kWh of energy.

In some instances, the cells and cell housings are stackable. Any suitable number of cells can be stacked. Cells can be stacked side-by-side, on top of each other, or both. In some instances, at least about 3, 6, 10, 50, 100 or 500 cells are stacked. In some cases, a stack of 10⁰ cells is capable of storing and/or taking in at least 50 kWh of energy. A first stack of cells (e.g., 10 cells) can be electrically connected to a second stack of cells (e.g., another 10 cells) to increase the number of cells in electrical communication (e.g., 20 in this instance). In some instances, the energy storage device comprises a stack of 1 to 10, 11 to 50, 51 to 100 or more electrochemical cells.

An electrochemical energy storage device can include one or more individual electrochemical cells. An electrochemical cell can be housed in a container, which can include a container lid (e.g., cell cap) and seal component. The device can include at least 1, 2, 3, 4, 5, 6, 7, 8, 9, 10, 20, 30, 40, 50, 100, 200, 300, 400, 500, 1000, 10,000, 100,000 or 1,000,000 cells. The container lid may utilize, for example, a seal (e.g., annular dielectric gasket) to electrically isolate the container from the container lid. Such a component may be constructed from an electrically insulating material, such as, for example, glass, oxide ceramics, nitride ceramics, chalcogenides, or a combination thereof (e.g., ceramic, silicon oxide, aluminum oxide, nitrides comprising boron nitride, aluminum nitride, zirconium nitride, titanium nitride, carbides comprising silicon carbide, titanium carbide, or other oxides comprising of lithium oxide, calcium oxide, barium oxide, yttrium oxide, silicon oxide, aluminum oxide, or lithium nitride, lanthanum oxide, or any combinations thereof). A seal may be fabricated using a high temperature ‘brazing’ process, whereby a braze material may be used to bond an electrically insulating ceramic material (e.g., aluminum nitride) component to one or more thin metal components (e.g., stainless steel, steel, iron or nickel alloy metal sleeve with a thickness less than about 0.1 mm), and the thin metal components may be joined to other metal components via a joining process (e.g., brazing or welding). Suitable braze materials may include silver, aluminum, titanium, or alloys thereof. Braze alloys may include a silver-aluminum braze alloy (e.g., the alloy may comprise about 95% silver and about 5% aluminum) or a titanium-based braze alloy (e.g., a titanium braze comprising about 40% titanium, about 20% zirconium, about 20% copper and about 20% nickel). The seal may be made hermetic by one or more methods. For example, the seal may be subject to relatively high compressive forces (e.g., greater than 10,000 psi) between the container lid and the container in order to provide a seal in addition to electrical isolation. Alternatively, the seal may be bonded through a weld or other chemically adhesive material that joins relevant cell components to the insulating sealant material.

A cell can be hermetically or non-hermetically sealed. Further, in a group of cells (e.g., a battery), each of the cells can be hermetically or non-hermetically sealed. If the cells are not hermetically sealed, the group of cells or battery (e.g., several cells in series or parallel) can be hermetically sealed.

The seal may be made hermetic by one or more methods. For example, the seal may be subject to relatively high compressive forces (e.g., greater than about 1,000 psi or 10,000 psi) between the container lid and the container in order to provide a seal in addition to electrical isolation. Alternatively, the seal may be bonded through a weld, a braze, or other chemically adhesive material that joins relevant cell components to the insulating sealant material.

In an example, a cell housing comprises an electrically conductive container, a container aperture and a conductor in electrical communication with a current collector. The conductor may pass through the container aperture and can be electrically isolated from the electrically conductive container. The housing may be capable of hermetically sealing a cell which is capable of storing at least about 10 Wh of energy.

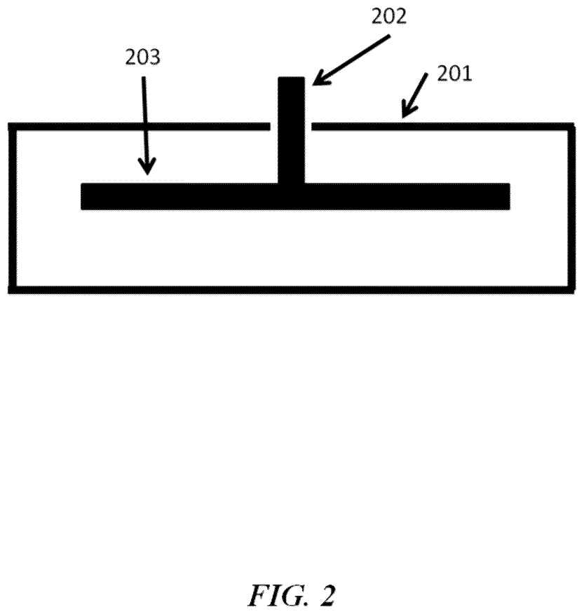

FIG. 2 schematically illustrates a battery that comprises an electrically conductive housing 201 and a conductor 202 in electrical communication with a current collector 203. The battery of FIG. 2 can be a cell of an energy storage device. The conductor can be electrically isolated from the housing and can protrude through the housing through an aperture in the housing such that the conductor of a first cell is in electrical communication with the housing of a second cell when the first and second cells are stacked.

In some cases, a cell comprises a negative current collector, a negative electrode, an electrolyte, a positive electrode and a positive current collector. The negative electrode can be part of the negative current collector. As an alternative, the negative electrode is separate from, but otherwise kept in electrical communication with, the negative current collector. The positive electrode can be part of the positive current collector. As an alternative, the positive electrode can be separate from, but otherwise kept in electrical communication with, the positive current collector.

A cell can comprise an electrically conductive housing and a conductor in electrical communication with a current collector. The conductor protrudes through the housing through an aperture in the housing and may be electrically isolated from the housing. A cell housing can comprise an electrically conductive container and a conductor in electrical communication with a current collector. The conductor may protrude through the housing through an aperture in the container and may be electrically isolated from the container. The conductor of a first housing may contact the container of a second housing when the first and second housings are stacked.

A cell housing may comprise an electrically conductive container and a conductor in electrical communication with a current collector. The conductor may protrude through the housing and/or container through an aperture in the container and may be electrically isolated from the container. The conductor of a first housing may contact the container of a second housing when the first and second housings are stacked.

In some instances, the area of the aperture through which the conductor protrudes from the housing and/or container is small relative to the area of the housing and/or container. The ratio of the area of the aperture to the area of the container and/or housing may be less than or equal to about 0.5, 0.4, 0.3, 0.2, 0.15, 0.1, 0.05, 0.01, 0.005 or 0.001 (e.g., less than about 0.1). In some cases, the ratio of the area of the aperture to the area of the housing is less than or equal to 0.001, less than or equal to 0.005, less than or equal to 0.01, less than or equal to 0.05, less than or equal to 0.1, less than or equal to 0.15, or less than or equal to 0.2. A cell can comprise an electrically conductive housing and a conductor in electrical communication with a current collector. The conductor protrudes through the housing through an aperture in the housing and may be electrically isolated from the housing. The ratio of the area of the aperture to the area of the housing may be less than about 0.3, 0.2, 0.15, 0.1, 0.05, 0.01, 0.005, or 0.001 (e.g., less than about 0.1).

The housing can be capable of enclosing a cell that is capable of storing, taking in and/or discharging any suitable amount of energy, as described in greater detail elsewhere herein. For example, the housing can be capable of enclosing a cell that is capable of storing, taking in and/or discharging less than about 100 Wh, equal to about 100 Wh, more than about 100 Wh or at least about 10 Wh or 25 Wh of energy.

A cell can comprise an electrically conductive housing and a conductor in electrical communication with a current collector. The conductor protrudes through the housing through an aperture in the housing and may be electrically isolated from the housing. The ratio of the area of the aperture to the area of the container may be less than about 0.3, 0.2, 0.15, 0.1, 0.05, 0.01, 0.005, or 0.001 (e.g., less than about 0.1). The housing can be capable of enclosing a cell that is capable of storing, taking in, discharging, and/or returning less than about 100 Wh of energy, about 100 Wh of energy, or more than about 100 Wh of energy. The housing can be capable of enclosing a cell that is capable of storing, taking in, discharging, and/or returning at least about 25 Wh of energy. The cell can be capable of storing, taking in, discharging, and/or returning at least about 1 Wh, 5 Wh, 25 Wh, 50 Wh, 100 Wh, 500 Wh, 1 kWh, 1.5 kWh, 2 kWh, 3 kWh, 5 kWh, 10 kWh, 15 kWh, 20 kWh, 30 kWh, 40 kWh, or 50 kWh of energy.

A cell housing can comprise an electrically conductive container and a conductor in electrical communication with a current collector. The conductor protrudes through the container through an aperture in the container and is electrically isolated from the container. The ratio of the area of the aperture to the area of the container may be less than 0.1. The housing can be capable of enclosing a cell that is capable of storing and/or taking in less than 100 Wh of energy, about 100 Wh of energy, or more than 100 Wh of energy or at leat about 10 Wh or 25 Wh of energy.

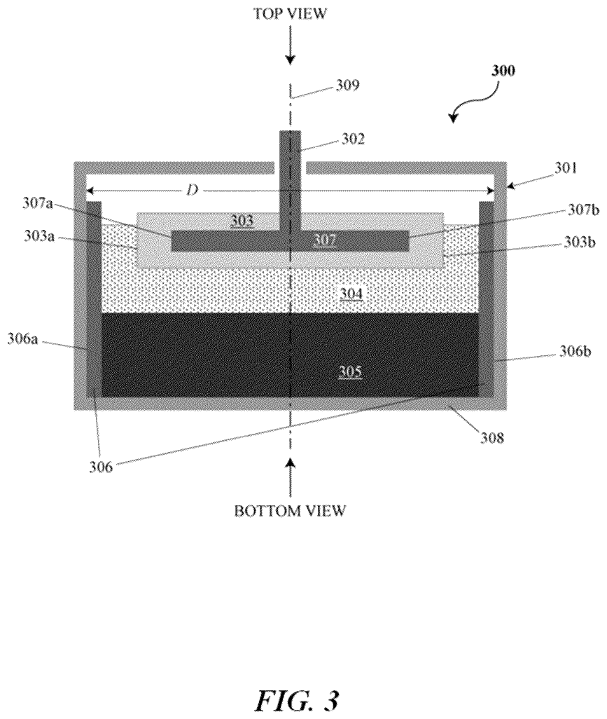

FIG. 3 is a cross-sectional side view of an electrochemical cell or battery 300 comprising a housing 301, an electrically conductive feed-through (i.e., conductor, such as a conductor rod) 302 that passes through an aperture in the housing and is in electrical communication with a liquid metal negative electrode 303, a liquid metal positive electrode 305, and a liquid salt electrolyte 304 between the liquid metal electrodes 303, 305. The cell or battery 300 can be configured for use with cell chemistries operated under a low voltage mode (“Type 1 mode”) or high voltage mode (“Type 2 mode”), as disclosed elsewhere herein. The conductor 302 may be electrically isolated from the housing 301 (e.g., using electrically insulating seals). The negative current collector 307 may comprise foam material 303 that behaves like a sponge, and the negative electrode liquid metal soaks into the foam. The negative electrode 303 may be a foam that behaves like a sponge, and is “soaked” in liquid metal. The liquid metal negative electrode 303 is in contact with the liquid salt electrolyte 304. The liquid salt electrolyte is also in contact with the positive liquid metal electrode 305. The positive liquid metal electrode 305 can be in electrical communication with the housing 301 along the side walls and/or along the bottom end wall of the housing. In some examples, the electrochemical cell or battery 300 may comprise two or more conductors passing through one or more apertures and in electrical communication with the liquid metal negative electrode 303. In some instances, a separator structure (not shown) may be arranged within the electrolyte 304 between the liquid negative electrode 303 and the (liquid) positive electrode 305. The foam can be porous. The foam can include pores that are sized to permit ions to flow through the pores. The foam can be sized to permit the liquid metal to flow through the foam.

The housing may include a container and a container lid (e.g., cell cap). The container and container lid may be connected mechanically (e.g., welded). In some cases, the mechanical connection may comprise a chemical connection. In some instances, the container lid is electrically isolated from the container. The cell lid may or may not be electrically isolated from the negative current lead in such instances. In some instances, the container lid is electrically connected to the container (e.g., cell body). The cell lid may then be electrically isolated from the negative current lead. During operation (e.g., when in a molten state), the container lid and the container can be connected electronically (e.g., through a direct electrical connection, such as, for example, via a welded lid-to-cell body joint, or ionically through the electrolyte and the electrodes). The negative current lead may be electrically isolated from the container and/or container lid (e.g., cell cap), via, for example, the use of an electrically insulating hermetic seal. In some examples, an electrically insulating barrier (e.g., seal) may be provided between the negative current lead and the container lid. The seal can be in the form of a gasket, for example, and placed between the container lid, and the container. The housing 301 can be constructed from an electrically conductive material such as, for example, steel, iron, stainless steel, low carbon steel, graphite, nickel, nickel based alloys, titanium, aluminum, molybdenum, tungsten, or conductive compounds such as nitrides (e.g., silicon carbide or titanium carbide), or a combination thereof (e.g., alloy). In some examples, the electrochemical cell or battery 300 may comprise two or more conductors passing through one or more apertures and in electrical communication with the liquid metal negative electrode 303. In some instances, a separator structure (not shown) may be arranged within the electrolyte 304 between the liquid negative electrode 303 and the (liquid) positive electrode 305.

The housing 301 can be constructed from an electrically conductive material such as, for example, steel, iron, stainless steel, low carbon steel, graphite, nickel, nickel based alloys, titanium, aluminum, molybdenum, tungsten, or conductive compounds such as nitrides (e.g., silicon carbide or titanium carbide), or a combination thereof (e.g., alloy).

The housing 301 can comprise a housing (or container) interior 306. The housing interior 306 may include, but is not limited to, a sheath (e.g., a graphite sheath), a coating, a crucible (e.g., a graphite crucible), a surface treatment, a lining, or any combination thereof. In one example, the housing interior 306 is a sheath. In another example, the housing interior 306 is a crucible. In yet another example, the housing interior 306 is a coating or surface treatment. The housing interior 306 may be thermally conductive, thermally insulating, electrically conductive, electrically insulating, or any combination thereof. For example, the housing interior (e.g., sheath, crucible and/or coating) 306 can be constructed from a material such as, for example, graphite, carbide (e.g., SiC, TiC, etc.), nitride (e.g., BN, TiN, etc.), alumina, titania (TiO₂), silica (SiO₂), magnesia, boron nitride, rare-earth oxides (e.g., a lanthanide oxide or a mixture of lanthanide oxides, such as, for example, neodymium oxide (Nd₂O₃), cerium oxide (CeO₂), lanthanum oxide (La₂O₃), samarium oxide (Sm₂O₃), or any combination thereof), a mixed oxide (e.g., any combination of calcium oxide, aluminum oxide, silicon oxide, lithium oxide, magnesium oxide, lanthanide oxide, neodymium oxide, etc.), or any combination thereof. In some cases, the housing interior 306 may be provided for protection of the housing (e.g., for protecting the stainless steel material of the housing from corrosion). In some cases, the housing interior can be anti-wetting to the liquid metal positive electrode. In some cases, the housing interior can be anti-wetting to the liquid electrolyte. For example, the housing interior 306 can be used to limit or prevent corrosion of the container and/or to limit or prevent wetting of the cathode material up the side wall, and may be constructed from an electrically conductive material, such as steel, stainless steel, tungsten, molybdenum, nickel, nickel-based alloys, graphite, titanium, or titanium nitride.

The housing may comprise a lining component or lining (e.g., an electrically insulating or electrically conductive lining component that is thinner than the cell body) of a separate metal or compound, or a coating (e.g., an electrically insulating or electrically conductive coating), such as, for example, a steel housing with a graphite lining or with a nitride coating or lining (e.g., boron nitride, aluminum nitride, titanium nitride), a carbide coating or lining (e.g., silicon carbide, titanium carbide), a rare-earth oxide coating or lining (e.g., Nd₂O₃, CeO₂, La₂O₃), or a coating or lining of titanium or other stable (e.g., chemically stable) metal (e.g., Ni, B). The lining and/or coating can exhibit favorable properties and functions, including surfaces that are anti-wetting to the positive electrode liquid metal. For example, the housing interior may be anti-wetting (e.g., substantially non-wetting) to the liquid cathode metal, thereby limiting or preventing it from wetting up the side-wall of the container. In some cases, the lining and/or coating may include an oxide material (e.g., yttrium oxide, zirconium oxide, samarium oxide, neodymium oxide, cerium oxide, calcium oxide or magnesium oxide) that is stable (e.g., chemically stable) with one or more portions of the cell (e.g., molten salt, reactive metal such as lithium, etc.) that are in liquid or solid contact with the oxide material. In some cases, the lining and/or coating (e.g., lining and/or coating comprising magnesium oxide, yttrium oxide, neodymium oxide, lanthanum oxide or cerium oxide) may have a coefficient of thermal expansion (CTE) that is similar or about equal to the CTE of the housing material (e.g., stainless steel). For example, some rare-earth oxides (e.g., Nd₂O₃) have a CTE that closely matches the CTE of stainless steel while also being stable (e.g., thermodynamically stable) with reactive materials (e.g., lithium) and/or the molten salts herein. The lining and/or coating may be a separate cell component that is physically placed within the housing, or the lining may be directly formed onto the housing surface to form a coating (e.g., via plasma spray coating, sputtering, precipitation-based coating process, thermally grown oxidation layer, or any other coating processes). The CTE of the lining and/or coating may differ from the CTE of the housing by less than about 1%, 5%, 10%, 20% or 50%. The lining and/or coating may comprise a mixture of different materials that has a CTE that more closely matches that of the housing compared to the CTE of one or more (e.g., any) individual constituent materials (e.g., positive electrode material, negative electrode material, electrolyte material). For example, the lining and/or coating may comprise a mixture that has a CTE that matches the CTE of the housing at least about 5%, 10%, 15%, 25%, 50% or 75% closer than the CTE of one or more (e.g., any) individual constituent materials. The lining and/or coating may protect the container from higher voltages (e.g., voltages greater than about 1 V, 1.5 V, 2 V or 2.5 V). The lining and/or coating may be used instead of a crucible (e.g., a graphite crucible), which may, for example, reduce cell cost and increase cell capacity. In some cases, additives to the lining and/or coating (e.g., Ni or other ductile metals) may be included. The additives may provide increased ductility and/or lower elastic modulus of the housing interior material. In some cases, the lining (e.g., graphite lining) and/or coating can be dried by heating above room temperature in air or dried in a vacuum oven before or after being placed inside the cell housing. Drying or heating the lining and/or coating can remove moisture from the lining and/or coating prior to adding the electrolyte, positive electrode, or negative electrode to the cell housing. Any aspects of the disclosure described in relation to a coating may equally apply to a lining or a surface treatment at least in some configurations, and vice versa.

The housing interior (e.g., sheath, crucible and/or coating) 306 can be constructed from a thermally insulating and/or electrically insulating material such as, for example, alumina, titania, silica, magnesia, boron nitride, or a mixed oxide including calcium oxide, aluminum oxide, silicon oxide, lithium oxide, magnesium oxide, etc. As shown in FIG. 3, the sheath 306 has an annular, square, or rectangular cross-sectional geometry that can extend laterally between a first sheath end 306a and a second sheath end 306b. The sheath may be dimensioned (illustrated in FIG. 3 as the distance from 306a to 306b) such that the sheath is in contact and pressed up against the side walls of the cavity defined by the housing cavity 301. As an alternative, the sheath can be used to prevent corrosion of the container and/or prevent wetting of the cathode material up the side wall, and may be constructed out of an electronically conductive material, such as steel, stainless steel, tungsten, molybdenum, nickel, nickel based alloys, graphite, or titanium. The sheath may be very thin and could be a coating. The coating can cover just the inside of the walls, and/or, can also cover the bottom of the inside of the container. In some cases, the sheath (e.g., graphite sheath) may be dried by heating above room temperature in air or dried in a vacuum oven before or after being placed inside the cell housing. Drying or heating the lining may remove moisture from the lining prior to adding the electrolyte, positive electrode, or negative electrode to the cell housing.

Instead of a sheath, the cell may comprise an electrically conductive crucible or coating that lines the side walls and bottom inner surface of the cell housing, referred to as a cell housing liner, preventing direct contact of the positive electrode with the cell housing. The cell housing liner may prevent wetting of the positive electrode between the cell housing and the cell housing liner or sheath and may prevent direct contact of the positive electrode on the bottom surface of the cell housing. The sheath may be very thin and can be a coating. The coating can cover just the inside of the walls, and/or, can also cover the bottom of the inside of the container. The sheath may not fit perfectly with the housing 301 which may hinder the flow of current between the cell lining and the cell housing. To ensure adequate electronic conduction between the cell housing and the cell lining, a liquid of metal that has a low melting point (i.e. Pb, Sn, Bi) can be used to provide a strong electrical connection between the sheath/coating and the cell housing. This layer can allow for easier fabrication and assembly of the cell.

The housing 301 may include a thermally and/or electrically insulating sheath or crucible 306. In this configuration, the negative electrode 303 may extend laterally between the side walls of the housing 301 defined by the sheath or crucible without being electrically connected (i.e., shorted) to the positive electrode 305. Alternatively, the negative electrode 303 may extend laterally between a first negative electrode end 303a and a second negative electrode end 303b. In this configuration, the sheath or crucible may or may not be thermally and/or electrically insulating. For example, the sheath or crucible may be electrically conductive. When an electrically insulating sheath or crucible 306 is not provided, the negative electrode 303 may have a diameter (or other characteristic dimension, illustrated in FIG. 3 as the distance from 303a to 303b) that is less than the diameter (or other characteristic dimension such as width for a cuboid container, illustrated in FIG. 3 as the distance D) of the cavity defined by the housing 301. The crucible can be made to be in electronic contact with the cell housing by means of a thin layer of a conductive liquid metal or semi-solid metal alloy located between the crucible and the cell housing, such as the elements Pb, Sn, Sb, Bi, Ga, In, Te, or a combination thereof.

As shown in the example in FIG. 3, the sheath or other housing interior (e.g., crucible, coating) 306 can have an annular cross-sectional geometry that can extend laterally between a first sheath end 306a and a second sheath end 306b. The sheath may be dimensioned (illustrated in FIG. 3 as the distance from 306a to 306b) such that the sheath is in contact and pressed up against the side walls of the cavity defined by the housing cavity 301. In some cases, the sheath (e.g., graphite sheath) can be dried by heating above room temperature in air or dried in a vacuum oven before or after being placed inside the cell housing. Drying or heating the sheath may remove moisture from the sheath prior to adding the electrolyte, positive electrode, or negative electrode to the cell housing.

The cell may comprise an electrically conductive crucible or coating that lines the side walls and bottom inner surface of the cell housing, referred to as a cell housing liner, preventing direct contact of the positive electrode with the cell housing. In an example, the cell can comprise a cell housing liner instead of a sheath. In another example, the sheath may be very thin and can be a coating. The cell housing liner may limit or prevent wetting of the positive electrode between the cell housing and the cell housing liner or sheath and May prevent direct contact of the positive electrode on the bottom surface of the cell housing. The cell housing liner or sheath (e.g., coating) can cover just the inside of the walls, and/or, can also cover the bottom of the inside of the container. The cell housing liner or sheath may not fit perfectly with the housing 301 which may hinder the flow of current between the cell housing liner or sheath and the cell housing. To ensure adequate electronic conduction between the cell housing liner or sheath and the cell housing, a liquid of metal that has a low melting point (e.g., Pb, Sn, Bi), can be used to provide a strong electrical connection between the cell housing liner or sheath (e.g., sheath/coating) and the cell housing. This layer can allow for easier fabrication and assembly of the cell. For example, the crucible can be made to be in electronic contact with the cell housing using a thin layer of a conductive liquid metal or semi-solid metal alloy located between the crucible and the cell housing, such as the elements Pb, Sn, Sb, Bi, Ga, In, Te, or a combination thereof.

A cell can include an electrically insulating or electrically conductive, and chemically stable sheath or coating between one or more walls of the cell and the negative electrode, electrolyte and/or positive electrode to minimize or prevent shorting to the one or more walls of the cell. In some cases, the cell can be formed of a non-ferrous container or container lining, such as a carbon-containing material (e.g., graphite), or a carbide (e.g., SiC, TiC), or a nitride (e.g., TiN, BN), or a chemically stable metal (e.g., Ti, Ni, B). The container or container lining material may be electrically conductive.

Instead of a sheath, the cell may comprise an electrically conductive crucible or coating that lines the side walls and bottom inner surface of the cell housing, referred to as a cell housing liner, preventing direct contact of the positive electrode with the cell housing. The cell housing liner may prevent wetting of the positive electrode between the cell housing and the cell housing liner or sheath and may prevent direct contact of the positive electrode on the bottom surface of the cell housing. The sheath may be very thin and can be a coating. The coating can cover just the inside of the walls, and/or, can also cover the bottom of the inside of the container. The sheath may not fit perfectly with the housing 301 which may hinder the flow of current between the cell lining and the cell housing. To ensure adequate electronic conduction between the cell housing and the cell lining, a liquid of metal that has a low melting point (e.g., Pb, Sn, Bi), can be used to provide a strong electrical connection between the sheath/coating and the cell housing. This layer can allow for easier fabrication and assembly of the cell.

The housing 301 can also include a first (e.g., negative) current collector or lead 307 and a second (e.g., positive) current collector 308. The negative current collector 307 may be constructed from an electrically conductive material such as, for example, nickel-iron (Ni—Fe) foam, stainless steel foam, Ni-plated iron foam, foam of another metal alloy, perforated steel disk, sheets of corrugated steel, sheets of expanded metal mesh, etc. The negative current collector 307 may be configured as a plate or foam that can extend laterally between a first collector end 307a and a second collector end 307b. The negative current collector 307 may have a collector diameter that is less than or similar to the diameter of the cavity defined by the housing 301. In some cases, the negative current collector 307 may have a collector diameter (or other characteristic dimension, illustrated in FIG. 3 as the distance from 307a to 307b) that is less than or similar to the diameter (or other characteristic dimension, illustrated in FIG. 3 as the distance from 303a to 303b) of the negative electrode 303. The positive current collector 308 may be configured as part of the housing 301; for example, the bottom end wall of the housing may be configured as the positive current collector 308, as illustrated in FIG. 3. Alternatively, the current collector may be discrete from the housing and may be electrically connected to the housing. In some cases, the positive current collector may not be electrically connected to the housing. The present disclosure is not limited to any particular configurations of the negative and/or positive current collector configurations.

The negative electrode 303 can be contained within the negative current collector (e.g., foam) 307. In this configuration, the electrolyte layer comes up in contact with the bottom, sides, and/or the top of the foam 307. The metal contained in the foam (i.e., the negative electrode material) can be held away from the sidewalls of the housing 301, such as, for example, by the absorption and retention of the liquid metal negative electrode into the foam, thus allowing the cell to run without the insulating sheath 306. In some cases, a graphite sheath or graphite cell housing liner (e.g., graphite crucible) may be used to prevent the positive electrode from wetting up along the side walls, which can prevent shorting of the cell.

Current may be distributed substantially evenly across a positive and/or negative liquid metal electrode in contact with an electrolyte along a surface (i.e., the current flowing across the surface may be uniform such that the current flowing through any portion of the surface does not substantially deviate from an average current density). In some examples, the maximum density of current flowing across an area of the surface is less than or equal to about 105%, 115%, 125%, 150%, 175%, 200%, 250% or 300% of the average density of current flowing across the surface. In some examples, the minimum density of current flowing across an area of the surface is greater than or equal to about 50%, 60%, 70%, 80%, 90% or 95% of the average density of current flowing across the surface.

Viewed from a top or bottom direction, as indicated respectively by “TOP VIEW” and “BOTTOM VIEW” in FIG. 3, the cross-sectional geometry of the cell or battery 300 can be circular, elliptical, square, rectangular, polygonal, curved, symmetric, asymmetric or any other compound shape based on design requirements for the battery. In an example, the cell or battery 300 is axially symmetric with a circular or square cross-section. Components of cell or battery 300 (e.g., component in FIG. 3) may be arranged within the cell or battery in an axially symmetric fashion. In some cases, one or more components may be arranged asymmetrically, such as, for example, off the center of the axis 309.

The combined volume of positive and negative electrode material (the combined volume of anode and cathode material) may be greater than or equal to about 5%, 10%, 20%, 30%, 40%, 50%, 60%, 70%, 80%, 90% or 95% of the volume of the battery (e.g., as defined by the outer-most housing of the battery, such as a shipping container). The combined volume of anode and cathode material may be at least about 5%, 10%, 20%, 30%, 40%, 60% or 75% of the volume of the cell. The combined volume of the positive and negative electrodes material may increase or decrease (e.g., in height) during operation due to growth or expansion, or shrinkage or contraction, respectively, of the positive or negative electrode. In an example, during discharge, the volume of the negative electrode (anode during discharge) may be reduced due to transfer of the negative electrode material to the positive electrode (cathode during discharge), wherein the volume of the positive electrode is increased (e.g., as a result of an alloying reaction). The volume reduction of the negative electrode may or may not equal the volume increase of the positive electrode. The positive and negative electrode materials may react with each other to form a solid or semi-solid mutual reaction compound (also “mutual reaction product” herein), which may have a density that is the same, lower, or higher than the densities of the positive and/or negative electrode materials. Although the mass of material in the electrochemical cell or battery 300 may be constant, one, two or more phases (e.g., liquid or solid) may be present, and each such phase may comprise a certain material composition (e.g., an alkali metal may be present in the materials and phases of the cell at varying concentrations: a liquid metal negative electrode may contain a high concentration of an alkali metal, a liquid metal positive electrode may contain an alloy of the alkali metal and the concentration of the alkali metal may vary during operation, and a mutual reaction product of the positive and negative liquid metal electrodes may contain the alkali metal at a fixed or variable stoichiometry). The phases and/or materials may have different densities. As material is transferred between the phases and/or materials of the electrodes, a change in combined electrode volume may result.

In some cases, a cell can include one or more alloyed products that are liquid, semi-liquid (or semi-solid), or solid. The alloyed products can be immiscible (or, in some cases, soluble) with the negative electrode, positive electrode and/or electrolyte. The alloyed products can form from electrochemical processes during charging or discharging of a cell.

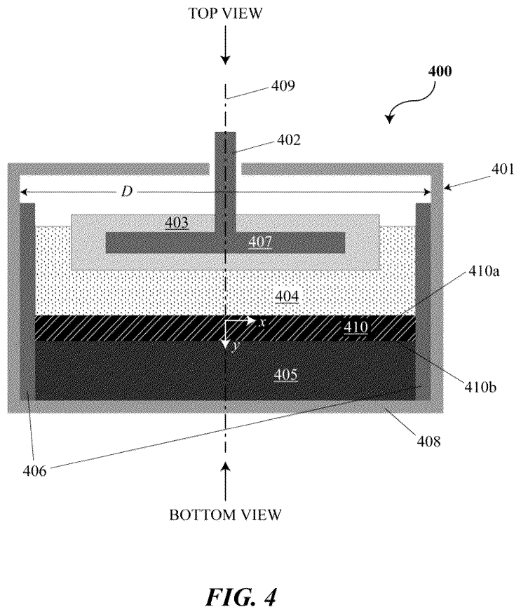

An alloyed product can include an element constituent of a negative electrode, positive electrode and/or electrolyte. An alloyed product can have a different density than the negative electrode, positive electrode or electrolyte, or a density that is similar or substantially the same. The location of the alloyed product can be a function of the density of the alloyed product compared to the densities of the negative electrode, electrolyte and positive electrode. The alloyed product can be situated in the negative electrode, positive electrode or electrolyte, or at a location (e.g., interface) between the negative electrode and the electrolyte or between the positive electrode and the electrolyte, or any combination thereof. In an example, an alloyed product is an intermetallic between the positive electrode and the electrolyte (see, for example, FIG. 4). In some cases, some electrolyte can seep in between the intermetallic and the positive electrode. In other examples, the alloyed product can be at other locations within the cell and be formed of a material of different stoichiometries/compositions, depending on the chemistry, temperature, and/or charge state of the cell.

The negative electrode 303 can be contained within the negative current collector (e.g., foam) 307. In this configuration, the electrolyte layer comes up in contact with the bottom and sides of the foam 307, and the metal contained in the foam (i.e., the negative electrode material) can be held away from the sidewalls of the housing 301, thus allowing the cell to run without the insulating sheath 306. In some cases, a graphite sheath may be used to prevent the positive electrode from wetting up along the side walls, which can prevent shorting of the cell.

Current may be distributed substantially evenly across a positive and/or negative liquid metal electrode in contact with an electrolyte along a surface (i.e., the current flowing across the surface may be uniform such that the current flowing through any portion of the surface does not substantially deviate from an average current density). In some examples, the maximum density of current flowing across an area of the surface is less than about 105%, less than about 115%, less than about 125%, less than about 150%, less than about 175%, less than about 200%, less than about 250%, or less than about 300% of the average density of current flowing across the surface. In some examples, the minimum density of current flowing across an area of the surface is greater than about 50%, greater than about 60%, greater than about 70%, greater than about 80%, greater than about 90%, or greater than about 95% of the average density of current flowing across the surface.

The housing may include a container and a container lid as described elsewhere herein. The container and container lid may be connected mechanically and isolated electrically (e.g., using electrically insulating gaskets, fasteners with electrically insulating sleeves and/or electrically insulating washers constructed from a dielectric such as, for example, mica or vermiculite). In some examples, the electrochemical cell or battery 300 may comprise two or more conductors passing through one or more apertures and in electrical communication with the liquid metal negative electrode 303. In some instances, a separator structure (not shown) may be arranged within the electrolyte 304 between the liquid negative electrode 303 and the (liquid) positive electrode 305.

Viewed from a top or bottom direction, as indicated respectively by “TOP VIEW” and “BOTTOM VIEW” in FIG. 3, the cross-sectional geometry of the cell or battery 300 can be circular, elliptical, square, rectangular, polygonal, curved, symmetric, asymmetric or any other compound shape based on design requirements for the battery. In one example, the cell or battery 300 is axially symmetric with a circular cross-section. Components of cell or battery 300 (e.g., component in FIG. 3) may be arranged within the cell or battery in an axially symmetric fashion. In some cases, one or more components may be arranged asymmetrically, such as, for example, off the center of the axis 309.

The combined volume of positive and negative electrode material may be about 20%, about 30%, about 40%, about 50%, about 60%, about 70%, about 80%, about 90%, or about 95% of the volume of the battery (e.g., as defined by the outer-most housing of the battery, such as a shipping container). In some cases, the combined volume of anode and cathode material is at least 20%, at least 30%, at least 40%, at least about 50%, at least about 60%, at least about 70%, at least about 80%, at least about 90%, or at least about 95% of the volume of the battery. The combined volume of the positive and negative electrodes material may expand or contract during operation due to the expansion or contraction of the positive or negative electrode. In an example, during discharge, the volume of the negative electrode (anode during discharge) may be reduced due to transfer of the negative electrode material to the positive electrode (cathode during discharge), wherein the volume of the positive electrode is increased (e.g., as a result of an alloying reaction). The volume reduction of the negative electrode may or may not equal the volume increase of the positive electrode. The positive and negative electrode materials may react with each other to form a solid or semi-solid mutual reaction compound (also “mutual reaction product” herein), which may have a density that is the same, lower, or higher than the densities of the positive and/or negative electrode materials. Although the mass of material in the electrochemical cell or battery 300 may be constant, one, two or more phases (e.g., liquid or solid) may be present, and each such phase may comprise a certain material composition (e.g., an alkali metal may be present in the materials and phases of the cell at varying concentrations: a liquid metal negative electrode may contain a high concentration of an alkali metal, a liquid metal positive electrode may contain an alloy of the alkali metal and the concentration of the alkali metal may vary during operation, and a mutual reaction product of the positive and negative liquid metal electrodes may contain the alkali metal at a fixed or variable stoichiometry). The phases and/or materials may have different densities. As material is transferred between the phases and/or materials of the electrodes, a change in combined electrode volume may result.

FIG. 4 is a cross-sectional side view of an electrochemical cell or battery 400 with an intermetallic layer 410. The intermetallic layer 410 can include a mutual reaction compound of a material originating from the negative electrode 403 and positive electrode material 405. For example, a negative liquid metal electrode 403 can comprise an alkali or alkaline earth metal (e.g., Na, Li, K, Mg, or Ca), the positive liquid metal electrode 405 can comprise one or more of transition metal, d-block (e.g., Group 12), Group IIIA, IVA, VA or VIA elements (e.g., lead and/or antimony and/or bismuth), and the intermetallic layer 410 can comprise a mutual reaction compound or product thereof (e.g., alkali plumbide, antimonide or bismuthide, e.g., Na₃Pb, Li₃Sb, K₃Sb, Mg₃Sb₂, Ca₃Sb₂, or Ca₃Bi₂). An upper interface 410a of the intermetallic layer 410 is in contact with the electrolyte 404, and a lower interface 410b of the intermetallic layer 410 is in contact with the positive electrode 405. The mutual reaction compound may be formed during discharging at an interface between a positive liquid metal electrode (liquid metal cathode in this configuration) 405 and a liquid salt electrolyte 404. The mutual reaction compound (or product) can be solid or semi-solid. In an example, the intermetallic layer 410 can form at the interface between the liquid metal cathode 405 and the liquid salt electrolyte 404. In some cases, the intermetallic layer 410 may exhibit liquid properties (e.g., the intermetallic may be semi-solid, or it may be of a higher viscosity or density than one or more adjacent phases/materials).

The cell 400 comprises a first current collector 407 and a second current collector 408. The first current collector 407 is in contact with the negative electrode 403, and the second current collector 408 is in contact with the positive electrode 405. The first current collector 407 is in contact with an electrically conductive feed-through 402. A housing 401 of the cell 400 can include a thermally and/or electrically insulating sheath 406. In some cases, a negative liquid metal electrode 403 includes lithium, sodium, potassium, magnesium, and/or calcium, the positive liquid metal electrode 405 includes lead, antimony, tin, tellurium and/or bismuth. The intermetallic layer 410 can include any suitable compound such as magnesium antimonide (Mg₃Sb₂), calcium antimonide (Ca₃Sb₂), lithium antimonide (Li₃Sb), lithium bismuthide (Li₃Bi), sodium antimonide (Na₃Sb) or compounds that contain two or more of K, Li, Na, Pb, Bi, Sb, Te, Sn and the like. In an example, the negative liquid metal electrode 403 includes magnesium (Mg), the positive liquid metal electrode 405 includes antimony (Sb), and the intermetallic layer 410 includes Mg and Sb (MgₓSb, where ‘x’ is a number greater than zero), such as, for example, magnesium antimonide (Mg₃Sb₂). Cells with a Mg∥Sb chemistry may contain magnesium ions within the electrolyte as well as other salts (e.g., MgCl₂, NaCl, KCl, or a combination thereof). In some cases, in a discharged state, the cell is deficient in Mg in the negative electrode and the positive electrode comprises and alloy of Mg—Sb. In such cases, during charging, Mg is supplied from the positive electrode, passes through the electrolyte as a positive ion, and deposits onto the negative current collector as Mg. In some examples, the cell has an operating temperature of at least about 300 °C, 350 °C, 400 °C, 450 °C, 475 °C, 500 °C, 550 °C, 600 °C, 650 °C, 700 °C or 750 °C, and in some cases between about 650 °C and 750 °C. In a charged state, all or substantially all the components of the cell can be in a liquid state. Alternative chemistries exist, including Ca—Mg∥Bi comprising a calcium halide constituent in the electrolyte (e.g., CaF₂, KF, LiF, CaCl₂), KCl, LiCl, CaBr₂, KBr, LiBr, or combinations thereof) and operating, for example, above about 500 °C, Ca—Mg∥Sb—Pb comprising a calcium halide constituent in the electrolyte (e.g., CaF₂, KF, LiF, CaCl₂, KCl, LiCl, CaBr₂, KBr, LiBr, or combinations thereof) and operating, for example, above about 500 °C, Li∥Pb—Sb cells comprising a lithium-ion containing halide electrolyte (e.g., LiF, LiCl, LiBr, or combinations thereof) and operating, for example, between about 350 °C and about 550 °C, and Na∥Pb cells comprising a sodium halide as part of the electrolyte (e.g., NaCl, NaBr, Nal, NaF, LiCl, LiF, LiBr, LiI, KCl, KBr, KF, KI, CaCl₂, CaF₂, CaBr₂, Cal₂, or combinations thereof) and operating, for example, above about 300 °C. In some cases, the product of the discharge reaction may be an intermetallic compound (e.g., Mg₃Sb₂ for the Mg∥Sb cell chemistry, Li₃Sb for the Li∥Pb—Sb chemistry, Ca₃Bi₂ for the Ca—Mg∥Bi chemistry, or Ca₃Sb₂ for the Ca—Mg∥Pb—Sb chemistry), where the intermetallic layer may develop as a distinct solid phase by, for example, growing and expanding horizontally along a direction x and/or growing or expanding vertically along a direction y at the interface between the positive electrode and the electrolyte. The growth may be axially symmetrical or asymmetrical with respect to an axis of symmetry 409 located at the center of the cell or battery 400. In some cases, the intermetallic layer is observed under Type 1 mode of operation but not Type 2 mode of operation. For example, the intermetallic layer (e.g., the intermetallic layer in FIG. 4) may not form during operation of a Type 2 cell. In some cases, the solid intermetallic layer may develop and expand starting from one or more locations (also “nucleation sites” herein) along a surface parallel to the direction x (i.e., the interface between the liquid metal cathode and the liquid metal electrolyte). The nucleation sites may be located in a predetermined pattern along the surface; alternatively, the location of the nucleation sites may be stochastic (random), or determined by natural or induced defects at the interface between the liquid metal cathode and the liquid metal electrolyte, or elsewhere within the cell or battery 400. In some examples, the solid intermetallic layer may not grow and expand horizontally. For example, the solid intermetallic layer may form evenly across the interface.

Wired or wire-less interconnections may be formed between individual electrochemical cells and/or between groups of electrochemical cells (e.g., modules, towers, packs, trays, cores, CEs, systems, or any other group comprising one or more electrochemical cells). In some cases, groups of cells may be joined via one or more cell-to-cell interconnections. In some cases, groups of cells may be joined via a group-level interconnection. The group-level interconnection may further comprise one or more interconnections with one or more individual cells of the group. The interconnections may be structural and/or electrical. Cells and/or groups of cells may be assembled (or stacked) horizontally or vertically. Such assembled cells and/or groups of cells may be arranged in series or parallel configurations. Further, groups of cells may be supported by various frames. The frames may provide structural support, participate or aid in forming the interconnections (e.g., frames on groups of cells may mate or be connected), and/or be part of a thermal management system (e.g., in concert with a thermal management frame). For example, an interconnection may be structural, electrical and/or thermal.

The electrochemical cells can be arranged in series and/or parallel to form an electrochemical energy storage system (e.g., battery). The energy storage system can comprise modules, packs, cores, CEs and/or systems of electrochemical cells surrounded by a frame (e.g., a frame that can be used for both structural support and thermal management of the system).

The solid intermetallic layer may begin developing at or near a vertical location corresponding to the location of the upper surface of the liquid metal cathode at the commencement of discharging (i.e., the interface between the liquid metal cathode and the liquid metal electrolyte at the commencement of discharging), and may then grow in a downward direction y. Thus, the solid intermetallic layer may have an upper interface or surface 410a and a lower interface or surface 410b. The upper interface 410a may remain in an approximately fixed location along the axis 409, while the lower interface 410b moves in a downward direction during discharge. In some cases, the solid intermetallic layer may grow and/or deform in the downward direction (i.e., intermetallic material is added to the layer from the downward direction opposite to vector y). Material buildup along the interface 410b may cause pressure to build up from below. The pressure may exert a force on the intermetallic layer. The pressure may be hydraulic pressure from the liquid metal cathode 405. In some cases, the pressure may be due to material stresses in the intermetallic layer 410. This may, for example, cause the intermetallic layer 410 to bulge or bow upward. In some cases, the liquid metal cathode may break through the intermetallic layer and some liquid metal cathode material may eject into the liquid metal electrolyte past the upper surface of the intermetallic layer, forming fingers or dendritic outgrowths. The intermetallic layer may be partially distorted, and may be ruptured or cracked in one or more locations along the interface 410a.

In some cases, a combination of horizontal and downward growth may occur. For example, a layer having a thickness t may develop in a downward direction along the central axis, and expand horizontally during discharge at a thickness of less than t, about t, or larger than t. The thickness t may also change as a function of discharge or discharge time. The morphology of the interfaces 410a, 410b may not be as uniform as shown in FIG. 4. For example, the interfaces may be lumpy, jagged, uneven, spongy or have offshoots, fingers or dendritic characteristics. For example, the interface 410a can be undulating. Depending on the lateral extent of the intermetallic layer 410 with respect to the dimension of the cavity defined by the side walls of sheath 406 or housing 401 and/or the morphology of the intermetallic layer 410, one or more interfaces between the liquid metal electrolyte 404 and the liquid metal cathode 405 may exist. The interfaces may provide a means for reduction reactions to proceed at the liquid metal cathode. The solid intermetallic layer may grow by the addition of material formed at or near the interfaces.

During discharge, the cathode may comprise the liquid metal cathode 405, and the solid intermetallic layer 410 is formed adjacent to the cathode. As previously described, material can be transferred to the cathode during discharge such that the mass of the cathode grows. The cathode volume may expand as a result of the material addition. The volume expansion may be affected by the alloying reaction. For example, the cathode volume increase after alloying may be about 30% less than expected from adding together the volume of material added to the cathode and the material originally present in the cathode. In some cases, the densities of the intermetallic layer 410 and the liquid metal cathode 405 may be about the same. Alternatively, the density of the intermetallic layer may be higher or lower than the density of the liquid metal cathode 405. For example, the density of the intermetallic layer may be a function of the phase structure of the solid formed. As the cathode volume increases during discharging, individually, the intermetallic layer 410 may grow, but the liquid metal cathode 405 may be consumed. The intermetallic layer 410 may grow at the expense of the liquid metal cathode 405. Alternatively, the volumes of both the intermetallic layer 410 and the liquid metal cathode 405 may increase, but the increase in volume of the liquid metal cathode 405 is less than it would otherwise be in the absence of an intermetallic layer. In some examples, the alloy in the liquid metal cathode 405, and the alloy in the intermetallic layer 410 may be formed independently at the interfaces between the liquid metal electrolyte and the liquid metal cathode. Alternatively, the formation of the intermetallic layer 410 may consume alloy first formed in the liquid metal cathode 405. The expansion of the liquid metal cathode 405 confined by an intermetallic layer 410, and the sheath 406 or housing 401 may lead to hydraulic pressure buildup in the liquid metal cathode 405.

With continued reference to FIG. 4, the intermetallic 410 can be located between the liquid metal electrolyte 404 and the liquid metal cathode 405. During normal operation, the cell or battery 400 can be oriented in the direction shown in FIG. 4, such that any gravitational pull affecting the cell is oriented downward in the direction of the vector y. A hydrostatic pressure from the liquid metal electrolyte 404 may exert a downward force (in the direction of y) on the intermetallic layer 410. This force may remain constant during discharge, as the mass of the liquid metal electrolyte may not change. The upper interface 410a of the intermetallic layer may be stationary. As the intermetallic layer 410 grows, a hydraulic pressure may build up in the liquid metal cathode 405, and may exert an upward force (in the opposite direction from y) on the intermetallic layer 410.

A person of skill in the art will recognize that the battery housing components may be constructed from materials other than the examples provided above. One or more of the electrically conductive battery housing components, for example, may be constructed from metals other than steel and/or from one or more electrically conductive composites. In another example, one or more of the electrically insulating components may be constructed from dielectrics other than the aforementioned glass, mica and vermiculite. The present invention therefore is not limited to any particular battery housing materials.

### Cell Lid Assemblies and Adhesive Seals

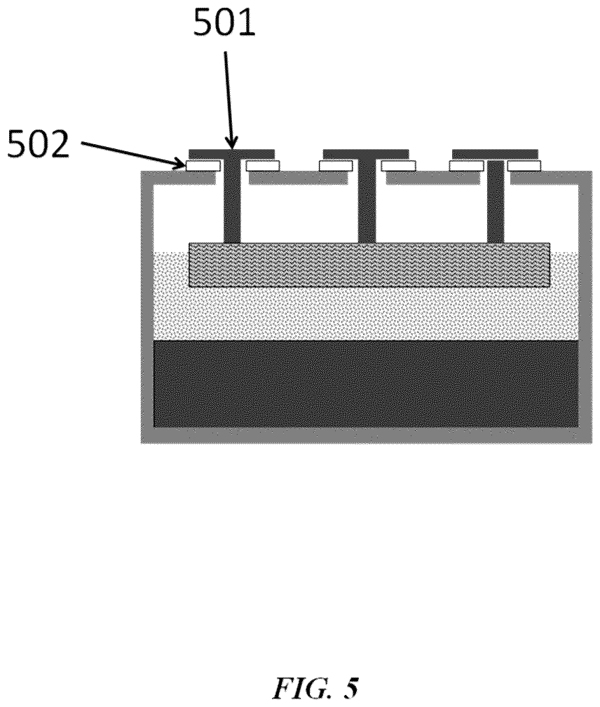

Cell lid assemblies can use adhesive seals to achieve a gas tight and electrically insulating seal. As seen in FIG. 5, a conductive feed-through 501 can be electrically isolated from the housing and the housing can be sealed by an adhesive sealing material 502 disposed between the feed-through and the housing. The adhesive sealing material can include any sealant material capable of adhering to the components of the cell lid assembly that are to be sealed.

In some cases, for cells that are sealed with adhesive dielectric seals, a pressure of less than 1 psi may be sufficient to maintain a gas tight seal. In some cases, at least a portion of the pressure can be supplied by the weight of one or more electrochemical cells stacked upon each other in a battery. The adhesive seal material can comprise a glass seal or a brazed ceramic, such as, for example, alumina with Cu—Ag braze alloy, or other ceramic-braze combination.

In a stacked battery configuration, it may be desirable to reduce head space (e.g., inside a cell chamber or cavity) so that relatively more of the volume of the cell can comprise anode and cathode material (e.g., such that the cell can have a higher energy storage capacity per unit volume). In some instances, the height of the head space (e.g., as measured from the top of the feed-through to the top surface of the anode) is a small fraction of the height of the battery (e.g., as measured from the top of the feed-through to the bottom surface of the housing). In some examples, the head space is at most or equal to about 5%, 10%, 15%, 20% or 25% of the height of the battery.

In some examples, the combined volume of anode and cathode material is about 20%, about 30%, about 40%, about 50%, about 60%, or about 70% of the volume of the battery (e.g., as defined by the outer-most housing of the battery, such as a shipping container). In some examples, the combined volume of anode and cathode material is at least about 50%, at least about 60%, at least about 70%, at least about 80%, at least about 90%, or at least about 95% of the volume of the battery.

In some examples, the electrolyte can have a thickness (measured as the distance between negative electrode/electrolyte and positive electrode/electrolyte interfaces) of at least about 0.01 cm, 0.05 cm, 0.1 cm, 0.5 cm, 0.8 cm, 1.0 cm, 1.3 cm, 1.5 cm, 2 cm, 3 cm, 4 cm, 5 cm, 6 cm, 7 cm, 8 cm, 9 cm or 10 cm for a cell having a thickness of at least about 1 cm, 2 cm, 3 cm, 4 cm, 5 cm, 6 cm, 7 cm, 8 cm, 9 cm, 10 cm or more. In some examples, a cell has a thickness of at most about 3 cm or 4 cm, and an electrolyte with a thickness of at most about 1 cm or 2 cm.

In some situations, the use of a few or only a single conductive feed-through can result in uneven current distribution in an electrode (e.g., in the negative electrode). A plurality of conductive feed-throughs (also “conductors” herein) can more evenly distribute the current in the electrode. In some implementations, an electrochemical energy storage device comprises a housing, a liquid metal electrode, a current collector in contact with the liquid metal electrode, and a plurality of conductors that are in electrical communication with the current collector and protrude through the housing through apertures in the housing. In some examples, current is distributed substantially evenly across the liquid metal electrode.

In some examples, the liquid metal electrode is in contact with an electrolyte along a surface (and/or interface) and the current flowing across the surface (and/or interface) is uniform. The current flowing through any portion of the surface (and/or interface) may not deviate substantially from the average current through the surface. In some examples, the maximum density of current flowing across an area of the surface (and/or interface) is less than about 105%, 115%, 125%, 150%, 175%, 200%, 250% or 300% of the average density of current flowing across the surface (and/or interface). In some examples, the minimum density of current flowing across an area of the surface (and/or interface) is greater than about 50%, 60%, 70%, 80%, 90% or 95% of the average density of current flowing across the surface (and/or interface).

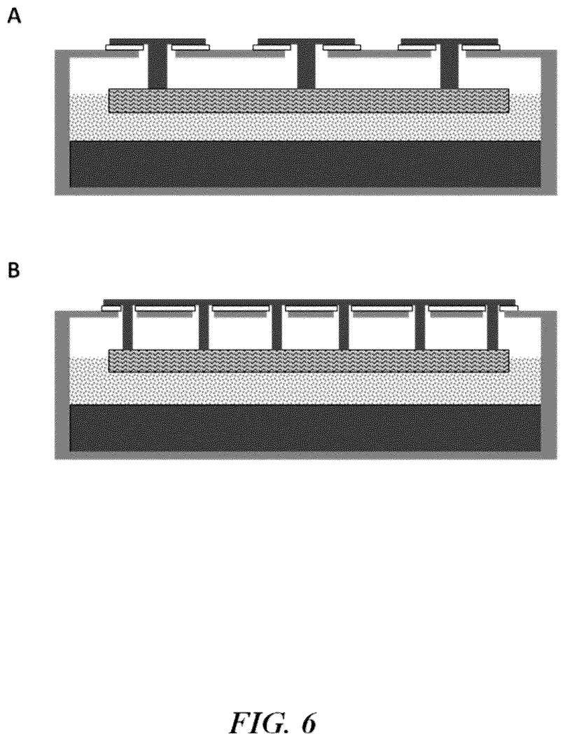

FIG. 6 shows examples of cells with multiple conductive feed-throughs. In these configurations, current collectors can be combined into a shared lid assembly for each cell. Such cell lid assemblies may be used with cells of any size. The electrochemical storage device and/or housings can comprise any number of conductive feed-throughs (e.g., 1, 2, 3, 4, 5, 6, 7, 8, 9, 10, 11, 12, 13, 14, 15, 16, 17, 18, 19, 20 or more). In some cases, the conductive feed-throughs are separate (A). In some cases, the conductive feed-throughs share a common upper portion (B).

### Features and Properties of Seals

The seal can be an important part of a high temperature system containing reactive metals (e.g., a liquid metal battery). Provided herein is a method for choosing materials suitable for forming a seal and methods for designing a suitable seal for a system containing reactive liquid metals or liquid metal vapors and/or reactive molten salt(s) or reactive molten salt vapors such as, for example, a liquid metal battery (e.g., based on the selection of these materials, and considerations of thermal, mechanical and electrical properties). The seal can also be used as part of an electrically isolated feed-through connected to a vessel comprising reactive liquid metals or reactive metal vapors for applications other than energy storage, such as fusion reactors comprising molten or high pressure Li vapor, or other applications that involve liquid sodium, potassium, and/or lithium. The use of stable ceramic and electronically conductive materials can also be appropriate for applications with reactive gases such as those used in semiconductor material processing or device fabrication.

The seal can be electrically insulating and gas-tight (e.g., hermetic). The seals can be made of materials that are not attacked by the liquid and vapor phases of system/vessel components (e.g., cell components), such as, for example, molten sodium (Na), molten potassium (K), molten magnesium (Mg), molten calcium (Ca), molten lithium (Li), Na vapor, K vapor, Mg vapor, Ca vapor, Li vapor, or any combination thereof. The method identifies a seal comprising an aluminum nitride (AlN) or silicon nitride (Si₃N₄) ceramic and an active alloy braze (e.g., Ti, Fe, Ni, B, Si or Zr alloy-based) as being thermodynamically stable with most reactive metal vapors, thus allowing for the design of a seal that is not appreciably attacked by metal or metal vapors.

In some implementations, the seal can physically separate the negative current lead (e.g., a metal rod that extends into the cell cavity) from the positively charged cell body (e.g., the cell can (also “container” herein) and lid). The seal can act as an electrical insulator between these cell components, and hermetically isolate the active cell components (e.g., the liquid metal electrodes, the liquid electrolyte, and vapors of these liquids). In some cases, the seal prevents external elements from entering the cell (e.g., moisture, oxygen, nitrogen, and other contaminants that may negatively affect the performance of the cell). Some examples of general seal specifications are listed in TABLE 1. Such specifications (e.g., properties and/or metrics) can include, but are not limited to, hermeticity, electrical insulation, durability, Coulombic efficiency (e.g., charge efficiency or round-trip efficiency), DC-DC efficiency, discharge time, and capacity fade rate.

TABLE 1
EXAMPLES OF GENERAL SEAL SPECIFICATIONS

| | |
|---|---|
| Specification | Example Value |

The seal can have these properties under operating conditions:

| | |
|---|---|
| Hermetic | <1 × 10⁻⁸ atm cc/s He total |
| | leak rate |
| Electrically insulating | >1 kOhm impedance across seal |
| Durable | maintain integrity for >20 years |

Battery metrics:

| | |
|---|---|
| Coulombic efficiency | >98% (@ ~200 mA/cm²) |
| DC-DC efficiency | >70% (@ ~200 mA/cm²) |
| Discharge time | 4-6 hours (@ ~200 mA/cm²) |
| Capacity fade rate | <0.02%/cycle |

The seal can be hermetic, for example, to a degree quantified by a leak rate of helium (He) (e.g., leak rate from a device at operating conditions (e.g., at operating temperature, operating pressure, etc.) filled with He). In some examples, the leak rate of helium (He) can be less than about 1×10⁻⁶ atmospheric cubic centimeters per second (atm cc/s), 5×10⁻⁷ atm cc/s, 1×10⁻⁷ atm cc/s, 5×10⁻⁸ atm cc/s or 1×10⁻⁸ atm cc/s. In some cases, the leak rate of He is equivalent to the total leak rate of He leaving the system (e.g., cell, seal). In other cases, the leak rate of He is the equivalent total He leak rate if one atmosphere of He pressure was placed across the sealed interface, as determined from the actual pressure/concentration differential of He across the sealed interface and the measured He leak rate.

The seal can provide any suitably low helium leak rate. In some cases, the seal provides a helium leak rate of no more than or equal to about 1×10⁻¹⁰, 1×10⁻⁹, 1×10⁻⁸, 1×10⁻⁷, 5×10⁻⁷, 1×10⁻⁶, 5×10⁻⁶, 1×10⁻⁵ or 5×10⁻⁵ atmosphere-cubic centimeters per second (atm-cc/s) at a temperature (e.g., a storage temperature of the cell, an operating temperature of the cell, and/or a temperature of the seal) of greater than or equal to about −25 °C, 0 °C, 25 °C, 50 °C, 200 °C, 350 °C, 450 °C, 550 °C or 750 °C. The seal can provide such helium leak rates when the electrochemical cell has been operated (e.g., at rated capacity) for a period of, for example, at least about 1 month, 6 months, 1 year, 5 years, 10 years, 20 years or more. In some cases, the seal provides such helium leak rates when the electrochemical cell has been operated for at least about 350 charge/discharge cycles (or cycles), 500 cycles, 1,000 cycles, 3,000 cycles, 10,000 cycles, 50,000 cycles, 75,000 cycles or 150,000 cycles.

The seal can electrically isolate the conductor from the electrically conductive housing. The degree of electrical isolation can be quantified by measuring the impedance across the seal. In some cases, the impedance across the seal is greater than or equal to about 0.05 kilo-Ohms (kOhm), 0.1 kOhm, 0.5 kOhm, 1 kOhm, 1.5 kOhm, 2 kOhm, 3 kOhm, 5 kOhm, 10 kOhm, 50 kOhm, 100 kOhm, 500 kOhm, 1,000 kOhm, 5,000 kOhm, 10,000 kOhm, 50,000 kOhm, 100,000 kOhm or 1,000,000 kOhm at any operating, resting, or storing temperature. In some cases, the impedance across the seal is less than about 0.1 kOhm, 1 kOhm, 5 kOhm, 10 kOhm, 50 kOhm, 100 kOhm, 500 kOhm, 1,000 kOhm, 5,000 kOhm, 10,000 kOhm, 50,000 kOhm, 100,000 kOhm or 1,000,000 kOhm at any operating, resting, or storing temperature. The seal can provide electrical isolation when the electrochemical cell has been operated (e.g., at rated capacity) for a period of, for example, at least about 1 month, 6 months, 1 year or more. In some cases, the seal provides the electrical isolation when the electrochemical cell has been operated for at least about 350 charge/discharge cycles (or cycles), 500 cycles, 1,000 cycles, 3,000 cycles, 10,000 cycles, 50,000 cycles, 75,000 cycles or 150,000 cycles. The seal can provide electrical isolation when the electrochemical cell has been operated for a period of at least about 1 year, 5 years, 10 years, 20 years, 50 years or 100 years. In some cases, the seal provides the electrical isolation when the electrochemical cell has been operated for greater than or equal to about 350 charge/discharge cycles.

The seal can be durable. In some examples, the seal can maintain integrity for at least about 1 month, 2 months, 6 months, 1 year, 2 years, 5 years, 10 years, 15 years, 20 years or more. The seal can have such properties and/or metrics under operating conditions.

In some examples, a battery or device comprising the seal can have a Coulombic efficiency (e.g., measured at a current density of about 20 mA/cm², 200 mA/cm² or 2,000 mA/cm²) of at least about 50%, 55%, 60%, 65%, 70%, 75%, 80%, 85%, 90%, 95%, 96%, 97%, 98%, 99%, 99.5%, 99.8%, 99.9% or more. In some examples, a battery or device comprising the seal can have a DC-DC efficiency (e.g., measured at a current density of about 200 mA/cm² or 220 mA/cm²) of at least about 50%, 55%, 60%, 65%, 70%, 75%, 80%, 85%, 90%, 95% or more. In some examples, a battery or device comprising the seal can have a discharge time (e.g., measured at a current density of about 200 mA/cm² or 220 mA/cm²) of at least about 1 hour, 2 hours, 3 hours, 4 hours, 5 hours, 6 hours, 7 hours, 8 hours, 9 hours, 10 hours or more. In some examples, a battery or device comprising the seal can have a discharge time (e.g., measured at a current density of about 200 mA/cm² or 220 mA/cm²) between about 4 hours and 6 hours, 2 hours and 6 hours, 4 hours and 8 hours or 1 hour and 10 hours. In some examples, a battery or device comprising the seal can have a capacity fade rate (e.g., discharge capacity fade rate) of less than about 10%/cycle, 5%/cycle, 1%/cycle, 0.5%/cycle, 0.1%/cycle, 0.08%/cycle, 0.06%/cycle, 0.04%/cycle, 0.02%/cycle, 0.01%/4914-9495-8917 cycle, 0.005%/cycle, 0.001%/cycle, 0.0005%/cycle, 0.0002%/cycle, 0.0001%/cycle, 0.00001%/cycle or less. The capacity fade rate can provide a measure of the change (decrease) in discharge capacity in ‘% per cycle’ (e.g., in % per charge/discharge cycle).

In some cases, the seal allows the electrochemical cell to achieve on one or more given operating conditions (e.g., operating temperature, temperature cycling, voltage, current, internal atmosphere, internal pressure, vibration, etc.). Some examples of operating conditions are described in TABLE 2. Such operating conditions can include, but are not limited to, metrics such as, for example, operating temperature, idle temperature, temperature cycling, voltage, current, internal atmosphere, external atmosphere, internal pressure, vibration, and lifetime.

TABLE 2
EXAMPLES OF OPERATING CONDITIONS FOR CELLS

| Item | Example description | Example metrics |
|---|---|---|
| Operating | The normal temperature | 440° C. to 550° C. |
| temperature | experienced by the seal | |
| | during operation. | |
| Idle | The temperature experienced | −25° C. to |
| temperature | by the seal while battery | 50° C. |
| | is idle | |
| | (e.g., in manufacturing, | |
| | during transport, battery in | |
| | off-mode). | |
| Temperature | The seal can experience | −25° C. to |
| cycling | infrequent but large amplitude | 700° C. with at |
| | thermal cycles over the course | least about 10 |
| | of battery operating lifetime. | thermal cycles |
| Voltage | The voltage drop across the | 0 V to 3 V |
| | seal. | |
| Current | The electric current flowing | 0 A to 500 A |
| | through materials that | |
| | interface with the seal. | |
| Internal | The seal is exposed to vapors | 0.133 Pa or 0.001 |
| atmosphere | of reactive alkali metals or | torr vapor pressure |
| | reactive alkaline earth | of alkali metals or |
| | metals and halide salts from | alkaline earth |
| | within the battery. | metals and halide |
| | | salts |
| External | The atmosphere that the seal | Air at 0° C. to |
| atmosphere | is exposed to from the | 550° C. accompanied |
| | externals of the battery, | by 100% relative |
| | e.g., ambient air, high | humidity |
| | moisture. | |
| Internal | Vacuum gradient or positive | 0.5 atm to 4.0 atm |
| pressure | pressure across the seal. | |
| Vibration | The seal can be exposed to | Capable of handling |
| | vibrations caused during | vibrational loading |
| | manufacturing, transportation, | analogous to |
| | installation, operation, and | transportation when |
| | rare events (e.g., drops, | used in cell or |
| | shock impact). | system application. |
| Lifetime | The expected lifetime of a | 20 year life |
| | seal in full operation. | with <1% failure |

In some examples, an operating temperature (e.g., temperature experienced by the seal during operation) is at least about 100 °C, 200 °C, 300 °C, 400 °C, 500 °C, 600 °C, 700 °C, 800 °C, 900 °C or more. In some examples, the temperature experienced by the seal during operation is between about 440 °C and 550 °C, 475 °C and 550 °C, 350 °C and 600 °C or 250 °C and 650 °C. In an example, an operating temperature of about 400 °C to about 500 °C, about 450 °C to about 550 °C, about 450 °C to about 500 °C or about 500 °C to about 600 °C, or an operating temperature of at least about 200 °C. (e.g., suitable for cell chemistries that can operate as low as 200 °C) can be achieved. In some cases, the temperature experienced by the seal may be about equal to the operating temperature of the electrochemical cell or high temperature device (e.g., energy storage device). In some cases, the temperature experienced by the seal may differ from the operating temperature of the electrochemical cell or high temperature device (e.g., by at least, less than or equal to about 1 °C, 5 °C, 10 °C, 20 °C, 50 °C, 100 °C, 150 °C, 200 °C, and the like). In an example, an electrochemical cell comprises a reactive material maintained at a temperature (e.g., operating temperature of the cell) of at least about 200 °C, and the temperature of the seal is at least about 200 °C. (e.g., the same as the operating temperature of the cell, or different than the operating temperature of the cell).

In some cases, the operating temperature of the seal can be lower or higher than the operating temperature of the electrochemical cell or high temperature device.

In some examples, an idle temperature (e.g., temperature experienced by the seal while device (e.g., battery) is idle, such as, for example, in manufacturing, during transport, device (e.g., battery) in off-mode, etc.) is greater than about −25 °C, −10 °C, 0 °C, 15 °C, 20 °C or 30 °C. In some examples, the idle temperature is less than about 30 °C, 20 °C, 15 °C, 0 °C, −10 °C, −25 °C or less. In some examples, the temperature experienced by the seal while the device is idle is between about −25 °C and 50 °C.

In some examples, temperature cycling (e.g., infrequent but large amplitude thermal cycles over the course of device (e.g., battery) operating lifetime that the seal can experience) is over a range of at least about 100 °C, 200 °C, 300 °C, 400 °C, 500 °C, 600 °C, 700 °C, 800 °C or 900 °C. In some examples, the temperature cycling is over a range of less than about 100 °C, 200 °C, 300 °C, 400 °C, 500 °C, 600 °C, 700 °C, 800 °C or 900 °C. In an example, the temperature cycling is between about −25 °C and 700 °C. The seal may withstand (e.g., continue to meet all required specifications) such temperature cycling after at least about 1 thermal cycle, 5 thermal cycles, 10 thermal cycles, 20 thermal cycles, 40 thermal cycles, 80 thermal cycles, 100 thermal cycles or 1000 thermal cycles. In some cases, the cell and seal can be thermally cycled at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100 or more times per year (e.g., going from room temperature up to operating temperature). The seal may be capable of withstanding brief temperature excursions above or below typical operating temperature range limits. For example, the seal may be capable of withstanding temperature excursions for greater than or equal to about 1 hour, 2 hours, 3 hours, 4 hours, 5 hours, 6 hours, 7 hours, 8 hours, 9 hours, 10 hours, 12 hours, 14 hours, 16 hours, 18 hours, 20 hours, 22 hours, 24 hours or more. In some cases, such temperature excursions may not exceed 700 °C.

In some examples, voltage (e.g., voltage drop across the seal) is at least about 0.1 V, 0.5 volt (V), 1 V, 1.5 V, 2 V, 2.5 V, 3 V, 4 V, 5 V, 6 V, 7 V, 8 V, 9 V or 10 V. In some examples, the voltage is less than about 0.1 V, 0.5 V, 1 V, 1.5 V, 2 V, 2.5 V, 3 V, 4 V, 5 V, 6 V, 7 V, 8 V, 9 V or 10 V. In some examples, the voltage drop across the seal is between about 0 V and 3 V or 0 V and 10 V.

In some examples, current (e.g., electric current flowing through materials that interface with the seal) is at least about 0 ampere (A), 5 A, 10 A, 25 A, 50 A, 100 A, 150 A, 200 A, 250 A, 300 A, 350 A, 400 A, 450 A or 500 A. In some examples, the current is less than about 0 A, 5 A, 10 A, 25 A, 50 A, 100 A, 150 A, 200 A, 250 A, 300 A, 350 A, 400 A, 450 A or 500 A. In some examples, the electric current flowing through materials that interface with the seal is between about 0 A and 500 A.

In some examples, internal atmosphere (e.g., vapors of reactive materials, such as, for example, alkali metals or reactive alkaline earth metals and halide salts from within the device (e.g., battery) that the seal is exposed to), comprises at least about 1×10⁻⁵ torr, 5×10⁻⁵ torr, 1×10⁻⁴ torr, 5×10⁻⁴ torr, 1×10⁻³ torr, 5×10⁻³ torr, 1×10⁻² torr, 5×10⁻² torr, 1×10⁻¹ torr, 5×10⁻¹ torr or 1 torr vapor pressure of alkali metals or alkaline earth metals and halide salts. In some examples, the internal atmosphere comprises less than about 1×10⁻⁵ torr, 5×10⁻⁵ torr, 1×10⁻⁴ torr, 5×10⁻⁴ torr, 1×10⁻³ torr, 5×10⁻³ torr, 1×10⁻² torr, 5×10⁻² torr, 1×10⁻¹ torr, 5×10⁻¹ torr or 1 torr vapor pressure of alkali metals or alkaline earth metals and halide salts. In some examples, the internal atmosphere that the seal is exposed to comprises at least about 0.001 torr (about 0.133 Pa) or 0.01 torr (about 1.33 Pa) vapor pressure of alkali metals or alkaline earth metals and halide salts. In some examples, the internal atmosphere that the seal is exposed to comprises less than about 0.001 torr (about 0.133 Pa) or 0.01 torr (about 1.33 Pa) vapor pressure of alkali metals or alkaline earth metals and halide salts.

The external surface of the cell and seal can be exposed to the atmosphere (e.g., ambient environment comprising O₂, N₂, Ar, CO₂, H₂O). In some examples, external atmosphere (e.g., atmosphere that the seal is exposed to from the externals of the device (e.g., battery) such as, for example, ambient air, high moisture, etc.) is at a temperature of at least about 0 °C, 50 °C, 100 °C, 150 °C, 200 °C, 250 °C, 300 °C, 350 °C, 400 °C, 450 °C, 500 °C, 550 °C, 600 °C, 700 °C, 750 °C, 800 °C, 850 °C or 900 °C. In some examples, the external atmosphere is at a temperature of less than about 0 °C, 50 °C, 100 °C, 150 °C, 200 °C, 250 °C, 300 °C, 350 °C, 400 °C, 450 °C, 500 °C, 550 °C, 600 °C, 700 °C, 750 °C, 800 °C, 850 °C or 900 °C. In some examples, the atmosphere that the seal is exposed to from the externals of the device is at a temperature of between about 0 °C and 550 °C, 350 °C and 600 °C or 250 °C and 650 °C (e.g., accompanied by 100% relative humidity). Such temperatures can be accompanied by greater than or equal to about 10%, 20%, 30%, 40%, 50%, 60%, 70%, 80%, 90% or 100% relative humidity. For example, such temperatures are accompanied by 100% relative humidity.

In some examples, internal pressure (e.g., vacuum gradient or positive pressure across the seal) can be at least about 0 atm, 0.1 atm, 0.2 atm, 0.4 atm, 0.6 atm, 0.8 atm, 1 atm, 1.5 atm, 2 atm, 2.5 atm, 3 atm, 3.5 atm, 4 atm or 5 atm. In some examples, the internal pressure can be less than about 0 atm, 0.1 atm, 0.2 atm, 0.4 atm, 0.6 atm, 0.8 atm, 1 atm, 1.5 atm, 2 atm, 2.5 atm, 3 atm, 3.5 atm, 4 atm or 5 atm. In some examples, the vacuum gradient or positive pressure across the seal is between about 0.5 atm and 4.0 atm.

The seal may be capable of handling vibration (e.g., vibrations caused during manufacturing, transportation, installation, operation, and rare events such as, for example, drops or shock impact that the seal can be exposed to). In an example, the seal is capable of handling vibrational loading analogous to transportation (e.g., when used in a cell or system application).

The seal may have a given lifetime (e.g., expected lifetime of the seal in full operation). In some examples, the lifetime of seal is at least about 1 month, 2 months, 6 months, 1 year, 2 years, 5 years, 10 years, 15 years, 20 years or more. The seal can have such lifetimes at operation (e.g., utilization) of at least about 20%, 40%, 60%, 80%, 90%, or full operation. The seal can have such lifetimes at a failure rate of less than about 75%, 50%, 40%, 40%, 30%, 20%, 15%, 10%, 5%, 1%, 0.1%, 0.01% or 0.001%. In an example, the seal has a 20 year life with less than about 1% failure, or a 20 year life with less than about 10% failure.

The seal may have a cycle life (e.g., number of complete charge/discharge cycles of the cell that the seal is able to support before its performance degrades and/or before the capacity of the electrochemical cell/battery/energy storage device falls below, for example, 80% of its original capacity) of at least about 10, 50, 100, 150, 200, 250, 300, 350, 400, 450, 500, 600, 700, 800, 900, 1,000, 1,500, 2,000, 3000, 5000, 10,000, 20,000, 50,000, 100,000 cycles.

External cell dimensions may impact system design and performance. For example, a seal height may be limited to a given distance above a cell top plate (e.g., top surface of the cell container lid). In some cases, seal height can be less than about 2 inches, 1 inch, ½ inch (e.g., since spacing between cells can change the thermal environment within a stack cell chamber), ¼ inch or ⅛ inch above the cell top plate. In some cases, the resistance of the conductor (e.g., negative current lead) that conducts electric current from outside the cell through the aperture in the cell lid is sufficiently low. For example, the resistance of the conductor is sufficiently low to achieve a given system efficiency (e.g., greater than or equal to about 40%, 50%, 60%, 75%, 80%, 90%, 95% or 99% energy efficiency). In some instances, a decreasing diameter or radial circumference of the conductor may allow for a more robust seal to be formed around the conductor, but lead to an increase in resistance of the conductor. In such instances, the resistance of the conductor can be decreased or minimized to a value sufficient for a robust seal to be formed (e.g., the resistance of the conductor in the seal can be as low as possible as long as a robust seal can be made, and the conductor can be large enough to achieve low resistance but small enough to achieve a robust seal around it). The resistance may be less than about 200 milliohms (mOhm), 100 mOhm, 80 mOhm, 50 mOhm, 30 mOhm, 10 mOhm, 3 mOhm, 1 mOhm, 0.75 mOhm, 0.5 mOhm, 0.3 mOhm, 0.1 mOhm, 0.075 mOhm, 0.05 mOhm, 0.03 mOhm or 0.01 mOhm.

The chemical stability of the materials (e.g., cell lid assembly materials, adhesive seal material(s), etc.) can be considered (e.g., to ensure the durability of the seal during all possible temperatures that the system may reach). The seal may be exposed to one or more different atmospheres, including the cell internals (internal atmosphere) and open air (external atmosphere). For example, the seal can be exposed to typical air constituents including moisture, as well as to potentially corrosive active materials in the cell. In some implementations, a hermetic seal is provided. A hermetically sealed battery or battery housing can prevent an unsuitable amount of air, oxygen, nitrogen, and/or water from leaking or otherwise entering into the battery. A hermetically sealed battery or battery housing can prevent an unsuitable amount of one or more gases surrounding the battery (e.g., air or any component(s) thereof, or another type of surrounding atmosphere or any component(s) thereof) from leaking or otherwise entering into the battery. In some cases, a hermetically sealed cell or cell housing can prevent gas or metal/salt vapors (e.g., helium, argon, negative electrode vapors, electrolyte vapors) from leaking from the cell.

In some implementations, an electrochemical cell comprises an electrically conductive housing comprising a liquid metal (including liquid metal alloys) that is liquid at an operating temperature of at least about 200 °C. In some cases, the operating temperature is at least about 350 °C. In some instances, the electrochemical cell is capable of storing at least about 50 watt-hours (Wh) of energy. In other instances, the electrochemical cell is capable of storing at least about 270 watt-hours (Wh) of energy. The liquid metal can be configured as part of an electrochemical cell that can store/release charge during charge and/or discharge of the electrochemical cell. The electrochemical cell can comprise a conductor in electrical contact with the liquid metal, where the conductor protrudes through the electrically conductive housing through an aperture in the electrically conductive housing. The electrochemical cell can comprise a seal that seals the conductor to the electrically conductive housing.

The seal can provide any suitably low helium leak rate. In some cases, the seal provides a helium leak rate of about 1×10⁻¹⁰, about 1×10⁻⁹, about 1×10⁻⁸, about 1×10⁻⁷, about 5×10⁻⁷, about 1×10⁻⁶, about 5×10⁻⁶, about 1×10⁻⁵, or about 5×10⁻⁵ atmosphere-cubic centimeters per second (atm-cc/s) at about 25 °C. In some instances, the seal provides a helium leak rate of no more than about 1×10⁻¹⁰, no more than about 1×10⁻⁹, no more than about 1×10⁻⁸, no more than about 1×10⁻⁷, no more than about 5×10⁻⁷, no more than about 1×10⁻⁶, no more than about 5×10⁻⁶, no more than about 1×10⁻⁵, or no more than about 5×10⁻⁵ atmosphere-cubic centimeters per second (atm-cc/s) at a temperature (e.g., an operating temperature of the cell or a temperature of the seal) of at least about −25 °C, at least about 0 °C, at least about 25 °C, at least about 50 °C, at least about 200 °C, at least about 350 °C, at least about 450 °C, at least about 550 °C or at least about 750 °C. The seal can provide such helium leak rates when the electrochemical cell has been operated (e.g., at rated capacity) for a period of, for example, at least about 1 month, at least about 6 months, at least about 1 year, at least about 5 years, at least about 10 years, at least about 20 years, or more. In some cases, the seal can provides such helium leak rates when the electrochemical cell has been operated for at least about 350 charge/discharge cycles, at least about 500 cycles, at least about 1,000 cycles, at least about 3,000 cycles, at least about 10,000 cycles, at least about 50,000 cycles, at least about 75,000 cycles, or at least about 150,000 cycles.

The seal can electrically isolate the conductor from the electrically conductive housing. The degree of electrical isolation can be quantified by measuring the impedance across the seal. In some cases, the impedance across the seal is about 0.1 kilo-Ohms (kOhm), about 1 kOhm, about 5 kOhm, about 10 kOhm, about 50 kOhm, about 100 kOhm, about 500 kOhm, about 1,000 kOhm, about 5,000 kOhm, about 10,000 kOhm, about 50,000 kOhm, about 100,000 kOhm, or about 1,000,000 kOhm at any operating, resting, or storing temperature. In some cases, the impedance across the seal is at least about 0.1 kOhm, at least about 1 kOhm, at least about 5 kOhm, at least about 10 kOhm, at least about 50 kOhm, at least about 100 kOhm, at least about 500 kOhm, at least about 1,000 kOhm, at least about 5,000 kOhm, at least about 10,000 kOhm, at least about 50,000 kOhm, at least about 100,000 kOhm, or at least about 1,000,000 kOhm at any operating, resting, or storing temperature. In some cases, the impedance across the seal is less than about 0.1 kOhm, less than about 1 kOhm, less than about 5 kOhm, less than about 10 kOhm, less than about 50 kOhm, less than about 100 kOhm, less than about 500 kOhm, less than about 1,000 kOhm, less than about 5,000 kOhm, less than about 10,000 kOhm, less than about 50,000 kOhm, less than about 100,000 kOhm, or less than about 1,000,000 kOhm at any operating, resting, or storing temperature. The seal can provide electrical isolation when the electrochemical cell has been operated (e.g., at rated capacity) for a period of, for example, at least about 1 month, at least about 6 months, at least about 1 year, or more. In some cases, the seal provides the electrical isolation when the electrochemical cell has been operated for at least about 350 charge/discharge cycles, at least about 500 cycles, at least about 1,000 cycles, at least about 3,000 cycles, at least about 10,000 cycles, at least about 50,000 cycles, at least about 75,000 cycles, at least about 150,000 cycles.

The seal can provide electrical isolation when the electrochemical cell has been operated for a period of at least about 1 year, at least about 5 years, at least about 10 years, at least about 20 years, at least about 50 years, or at least about 100 years. In some cases, the seal provides the electrical isolation when the electrochemical cell has been operated for about 350 charge/discharge cycles.

A hermetically sealed battery or battery housing may prevent an unsuitable amount of air, oxygen, nitrogen, and/or water into the battery (e.g., an amount such that the battery maintains at least about 80% of its energy storage capacity and/or maintains a round-trip Coulombic efficiency of at least about 90% per cycle when charged and discharged at least about 100 mA/cm² for at least about one year, 2 years, 5 years, 10 years or 20 years). In some instances, the rate of oxygen, nitrogen, and/or water vapor transfer into the battery is less than about 0.25 milli-liter (mL) per hour, 0.02 mL per hour, 0.002 mL per hour or 0.0002 mL per hour when the battery is contacted with air at a pressure that is at least about (or less than about) 0 atmospheres (atm), 0.1 atm, 0.2 atm, 0.3 atm, 0.4 atm, 0.5 atm, 0.6 atm, 0.7 atm, 0.8 atm, 0.9 atm or 0.99 atm higher than, or at least about (or less than about) 0.1 atm, 0.2 atm, 0.5 atm or 1 atm lower than the pressure inside the battery and a temperature of between about 400 °C and 700 °C. In some instances, the rate of metal vapor, molten salt vapor, or inert gas transfer out of the battery is less than about 0.25 mL per hour, 0.02 mL per hour, 0.002 mL per hour or 0.0002 mL per hour when the battery is contacted with air at a pressure of greater than or equal to about 0.5 atm, 1 atm, 1.5 atm, 2 atm, 2.5 atm, 3 atm, 3.5 atm or 4 atm less than the pressure inside the battery and a temperature between about 400 °C and 700 °C. In some examples, the number of moles of oxygen, nitrogen, or water vapor that leaks into the cell over a given period (e.g., at least about a 1 month period, 6 month period, 1 year period, 2 year period, 5 year period, 10 year period or more) is less than about 10%, 5%, 3%, 1%, 0.5%, 0.1%, 0.05% or 0.5% of the number of moles of active material (e.g., active metal material) in the cell.

The seal can meet one or more specifications, including, but not limited to: electrically insulating and hermetic, ability to function at operating temperature for duration of lifespan, thermal cycle-ability, sufficiently high electrical conductivity of the conductor (e.g., negative current lead), configuration that does not excessively protrude from cell body, inner surface chemically stable with liquids and vapors of active components, outer surface stable in air, ability to avoid arcing under high potentials, etc.

### Pressure Relief

A sealed high temperature device containing reactive materials may in some cases experience an increase in internal pressure (e.g., if the temperature of the device is increased above the boiling point of one or more of the materials within the device). The device may comprise a metal housing (e.g., stainless steel cell body) and a metal housing lid (e.g., stainless steel cell lid) that are joined (e.g., brazed or welded) together. The cell lid may comprise a high temperature seal. In the event of a pressure build-up inside the device, the device may rupture. In some cases, the device may rupture, eject material, and result in a hazardous event. It may be desirable for the device to comprise a component that relieves pressure before it reaches a hazardous level. It may also be desirable that the pressure relief component is in a gaseous head space of the device such that the pressure is released via the escape of gaseous components rather than liquid components.

In some implementations, the seal may be designed to serve as the pressure relief component (e.g., to be the weakest portion of the device that will allow the pressure that may build inside the device to be released through the seal) above a critical pressure and/or above a critical temperature. One or more seals may be provided on the device (e.g., a seal around a conductor, a dedicated pressure relief seal, a seal around a conductor that also provides pressure relief, etc.). In some cases, the seal releases pressure when the device and/or seal is heated above the melting point of the braze material that is used to create the metal-to-ceramic sealed interfaces. In some cases, the strength and/or geometry of the ceramic-to-metal joints in the seal are designed to fail (e.g., leak) before the metal-to-metal joints of the device housing and/or lid (and/or before the metal-to-metal joints of the seal). For example, one or more of the ceramic-to-metal brazes in the seal may be weaker than the metal-to-metal welds of the device housing and/or lid. In some examples, the critical pressure inside the device can be greater than about 1 atm, 2 atm, 3 atm, 4 atm, 5 atm, 10 atm, 20 atm, 50 atm, or 100 atm. In some examples, the critical temperature (e.g., of the device and/or of the seal) can be greater than about 300 °C, 400 °C, 500 °C, 600 °C, 700 °C, 800 °C, 900 °C, 1000 °C, 1100 °C, 1200 °C, 1300 °C, or 1400 °C.

In some implementations, a cell comprises an anode and a cathode. The cell can be capable of storing at least about 10 Wh of energy and can be hermetically or non-hermetically sealed. At least one of the anode and the cathode can be a liquid metal.

In some implementations, a group of cells is capable of storing at least about 10 kWh of energy and each of the cells is hermetically or non-hermetically sealed. If the cells are not hermetically sealed, the battery (e.g., several cells in series or parallel) can be hermetically sealed.

In some implementations, a cell housing comprises an electrically conductive container, a container aperture and a conductor in electrical communication with a current collector. The conductor may pass through the container aperture and can be electrically isolated from the electrically conductive container. The housing may be capable of hermetically sealing a cell which is capable of storing at least 10 Wh of energy.

### Materials, Chemical Compatibility and Coefficients of Thermal Expansion

Materials and features of seals herein may be configured to achieve suitable materials (e.g., chemical, mechanical, thermal) compatibility. Materials compatibility may include, for example, suitable matching of coefficients of thermal expansion (CTEs), suitable Young's modulus characteristics (e.g., low Young's modulus metal materials) and/or suitable ductility characteristics (e.g., one or more components with high ductility). Seals may incorporate structural features that can compensate for CTE mismatch.

Materials may be selected to achieve low CTE mismatch between various (e.g., pairs of) seal materials and/or housing (e.g., cell lid and/or body) materials. Materials may be selected to achieve low stress (e.g., stress due to CTE mismatch) at joint(s) between various (e.g., pairs of) seal materials and/or housing materials. A joint between various seal materials and/or housing materials may be of a given type (e.g., ceramic-to-metal or metal-to-metal). In an example, a ceramic material has a CTE that suitably (e.g., substantially) matches a CTE of a cell lid or body, thereby decreasing or minimizing stress(es) (e.g., stress(es) at one or more ceramic-to-metal joint(s) between the ceramic material and the cell lid or body). In another example, a ceramic material has a CTE that is suitably (e.g., substantially) different than the CTE of the cell lid or body. In this instance, a metal collar or sleeve that is a better CTE match or has one or more other properties that reduce the ceramic-to-metal joint stress may be used. The metal collar or sleeve may move the CTE stress from the ceramic joint (e.g., from the ceramic-to-metal joint between the ceramic and the metal collar or sleeve) to the cell lid or body joint (e.g., to the metal-to-metal joint between the metal collar or sleeve and the cell lid or body). The ceramic material may have a CTE that suitably (e.g., substantially) matches a CTE of the metal collar or sleeve. The ceramic material may have a CTE that is suitably (e.g., substantially) different than the CTE of the metal collar or sleeve. The ceramic-to-metal seal joint stress(es) can be reduced, for example, by using a ductile metal collar or sleeve (e.g., comprising at least about 95% or 99% Ni) and/or by using a ductile braze material (e.g., comprising at least about 95% or 99% Ag, Cu or Ni). The ductile braze material may be used to reduce stress(es) at the ceramic-to-metal joint between the ceramic and the cell lid or body or to reduce stress(es) at the ceramic-to-metal joint between the ceramic and metal collar or sleeve.

The seal can be made of any suitable material (e.g., such that the seal forms a hermetic seal and an electrical isolation). In some cases, the seal comprises a ceramic material and a braze material. The ceramic material can have a CTE that is matched to the housing material such that the electrochemical cell maintains suitable gas-tight and/or electrically insulating properties during operation and/or start-up of the battery. The ceramic material may have a CTE that matches a CTE of the braze material and/or the cell top (e.g., lid or cap, or any component of a cell lid assembly) or body. In some cases, the CTEs of the ceramic material, braze material and cell top or body may not be identically matched, but may be sufficiently close to minimize stresses during the braze operation and subsequent thermal cycles in operation. In some cases, the CTE of the ceramic material may not be sufficiently close to the CTE of the cell top or body (e.g., in some cases resulting in an unstable and/or unreliable ceramic-to-metal joint which may lose its leak-tight property). The seal can comprise a collar (e.g., a thin metal collar) or sleeve (e.g., to overcome the CTE mismatch between a ceramic material and the cell lid or cell body). The collar or sleeve can be a metal collar or sleeve. The collar or sleeve can be brazed to the ceramic (e.g., via a braze material) and joined to the cell lid and/or the negative current lead that protrudes through the cell lid and into the cell cavity. A suitable collar or sleeve material may be selected in order to reduce the resulting stresses at the ceramic-to-metal joint (e.g., by reducing the CTE mismatch), increase the resulting stress at the collar or sleeve-to-cell lid or body joint (e.g., by increasing the CTE mismatch), or a combination thereof. The seal can comprise features that alleviate CTE mismatches between the ceramic and the cell lid and/or the negative current lead. Any aspects of the disclosure described in relation to the cell top or body (e.g., CTE, joint stress, configuration and/or formation, etc.) may equally apply to the cell top and body at least in some configurations. Any aspects of the disclosure described in relation to the cell top may equally apply to the cell body at least in some configurations, and vice versa.

Materials herein may have temperature-dependent properties. Such properties may include, for example, CTE and/or yield strength. For example, the CTE of a material may be measured across a given (e.g., specified) temperature range. Thus, a material may have one CTE value over the range of, for example, 20 °C to 200 °C (e.g., 10 ppm/K), and another CTE value over the range of, for example, 20 °C to 400 °C (e.g., 12 ppm/K). Such properties may or may not change continuously with temperature (e.g., the CTE may be a continuous function with temperature). In another example, yield strength may be a function of temperature. Values of the yield strength of materials herein (e.g., of a metal collar or sleeve material) may be provided at one or more temperatures at or below braze temperature (e.g., at about 1100 °C or lower for some metal collar or sleeve materials). Values of temperature-dependent properties herein may be taken to be at any relevant temperature or range. Features and characteristics such as, for example, CTE mismatch may in some cases vary with temperature. Values of CTE mismatch herein may apply at any temperature, or at a given temperature or range of temperatures (e.g., the values may be maximum values, values at a steady-state operating temperature, average values from room temperature up to operating temperature, etc.).

The CTE of the ceramic material may be at least about 3 microns per meter per degree Celsius (μm/m/°C, same as parts per million per degree Kelvin (ppm/K)), 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C or 14 μm/m/°C. The CTE of the ceramic material may be less than or equal to about 3 μm/m/°C, 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C or 14 μm/m/°C. The CTE of the ceramic material may be between about 4 μm/m/°C and 14 μm/m/°C, 6 μm/m/°C and 13 μm/m/°C, or 8 μm/m/°C and 11 μm/m/°C. In some cases, the ceramic material comprises at least about 50% AlN and has a CTE of less than about 5 μm/m/°C. In some cases, the ceramic material comprises at least about 50% neodymium oxide (Nd₂O₃), lanthanum oxide (La₂O₃) or cerium oxide (CeO₂) and has a CTE of greater than about 8 μm/m/°C, 9 μm/m/°C, 10 μm/m/°C, 11 μm/m/°C or 12 μm/m/°C. The ceramic material may have such CTE values for a temperature range of, for example, between about 25 °C and 400 °C, 20 °C and 500 °C, 25 °C and 500 °C, 25 °C and 600 °C, 25 °C and 900 °C, or 25 °C and 1000 °C.

The CTE of the metal collar or sleeve may be at least about 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/C or 20 μm/m/°C. The CTE of the metal collar or sleeve may be less than or equal to about 20 μm/m/°C, 19 μm/m/°C, 18 μm/m/°C, 17 μm/m/°C, 16 μm/m/°C, 15 μm/m/°C, 14 μm/m/°C, 13 μm/m/° °C, 12 μm/m/°C, 11 μm/m/°C, 10 μm/m/°C, 9 μm/m/° °C, 8 μm/m/°C, 7 μm/m/°C, 6 μm/m/°C or 5 μm/m/°C. In some cases, the metal collar or sleeve comprises Zr and has a CTE of less than or equal to about 7 μm/m/°C. In some cases, the metal collar or sleeve comprises Ni (e.g., at least about 95% or 99% Ni, or at least about 40% Ni and at least about 40% Fe by weight) and has a CTE of greater than or equal to about 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The metal collar or sleeve may comprise greater than or equal to about 5%, 10%, 15%, 20%, 25%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 65%, 70%, 75%, 80%, 85%, 90%, 95% or 99% Ni (e.g., by weight). The metal collar or sleeve may comprise such Ni compositions in combination with greater than or equal to about 5%, 10%, 15%, 20%, 25%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 65%, 70%, 75%, 80%, 85%, 90%, 95% or 99% Fe (e.g., by weight). Such Ni or Ni—Fe compositions (e.g., alloys) may comprise one or more other elements (e.g., C, Co, Mn, P, S, Si, Cr and/or Al) with individual concentrations or a total concentration of less than or equal to about 1%, 0.9%, 0.8%, 0.7%, 0.6%, 0.5%, 0.4%, 0.3%, 0.15%, 0.1%, 0.09%, 0.08%, 0.07%, 0.06%, 0.05%, 0.04%, 0.03%, 0.025%, 0.01% or 0.005%. In some cases, the metal collar or sleeve comprises greater than or equal to about 50.5% Ni, greater than or equal to about 48% Fe, and less than or equal to about 0.60% Mn, 0.30% Si, 0.005% C, 0.25% Cr, 0.10% Co, 0.025% P and/or 0.025% S (e.g., alloy 52). In some cases, the metal collar or sleeve comprises greater than or equal to about 41% Ni, greater than or equal to about 58% Fe, and less than or equal to about 0.05% C, 0.80% Mn, 0.40% P, 0.025% S, 0.30% Si, 0.250% Cr and/or 0.10% Al (e.g., alloy 42). In some cases, the metal collar or sleeve comprises an Fe alloy with between about 17.5% and 19.5% Cr, between about 0.10% and 0.50% Ti, between about 0.5% and 0.90% niobium, less than or equal to about 1% Ni, 1% Si, 1% Mn, 0.04% phosphorus, 0.03% nitrogen, 0.03% sulfur and/or 0.03% carbon, and a balance of Fe (e.g., 18CrCb ferritic stainless steel). Such Fe alloy (e.g., 18CrCb ferritic stainless steel) may have a CTE of about 8 ppm/K, 9 ppm/K, 10 ppm/K, 11 ppm/K or 12 ppm/K. In some cases, the metal collar or sleeve comprises an Fe alloy with between about 17.5% and 18.5% Cr, between about 0.10% and 0.60% Ti, between about 0.3% and 0.90% niobium, less than about 1% Si, 1% Mn, 0.04% phosphorus, 0.015% sulfur and/or 0.03% carbon, and a balance of Fe (e.g., grade 441 stainless steel). Such Fe alloy (e.g., 441 stainless steel) may have a CTE of about 9 ppm/K, 10 ppm/K, 11 ppm/K, 12 ppm/K, 13 ppm/K or 14 ppm/K. In some cases, the metal collar or sleeve comprises a Ni alloy with at least about 72% Ni, between about 14% and 17% Cr, between about 6% and 10% Fe, and less than about 0.15% C, 1% Mn, 0.015% S, 0.50% Si and/or 0.5% Cu (e.g., Inconel 600). Such Ni alloy (e.g., Inconel 600) may have a CTE of about 12 ppm/K, 13 ppm/K, 14 ppm/K, 15 ppm/K, 16 ppm/K or 17 ppm/K. In some cases, the metal collar or sleeve comprises a Ni alloy with less than about 0.05% C, 0.25% Mn and/or 0.002% S, less than or equal to about 0.20% Si, 15.5% Cr, 8% Fe and/or 0.1% Cu, and a balance of Ni and Co (e.g., ATI alloy 600). Such Ni alloy (e.g., ATI alloy 600) may have a CTE of about 12 ppm/K, 13 ppm/K, 14 ppm/K, 15 ppm/K, 16 ppm/K or 17 ppm/K. In some cases, the metal collar or sleeve comprises greater than or equal to about 67% Ni, less than about 2% Co, 0.02% C, 0.015% B, 0.35% Cu, 1.0% W, 0.020% P and/or 0.015% S, between about 14.5% and 17% Cr, between about 14% and 16.5% Mo, between about 0.2% and 0.75% Si, between about 0.30% and 1.0% Mn, between about 0.10% and 0.50% Al, between about 0.01% and 0.10% La, and less than or equal to about 3% Fe (e.g., Hastelloy S). Such alloy (e.g., Hastelloy S) may have a CTE of about 12 ppm/K, 13 ppm/K, 14 ppm/K, 15 ppm/K, 16 ppm/K or 17 ppm/K. The metal collar or sleeve may have the aforementioned CTE values for a temperature range of, for example, between about 25 °C and 400 °C, 20 °C and 500 °C, 25 °C and 500 °C, 25 °C and 600 °C, 25 °C and 900 °C, or 25 °C and 1000 °C.

The seal may comprise one or more braze materials (e.g., same or different braze materials at different joints when using a metal collar or sleeve, or one braze material when the joining the ceramic material directly to the cell lid or body). The CTE of a braze material may be at least about 3 microns per meter per degree Celsius (μm/m/° °C), 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The CTE of the braze material may be less than or equal to about 3 microns per meter per degree Celsius (μm/m/°C), 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The braze material may have such CTE values for a temperature range of, for example, between about 25 °C and 400 °C, 20 °C and 500 °C, 25 °C and 500 °C, 25 °C and 600 °C, 25 °C and 900 °C, or 25 °C and 1000 °C.

The stress(es) at the ceramic-to-metal joint may be reduced by brazing the ceramic to a metal with a suitably (e.g., sufficiently) low yield strength. By creating a joint between a strong ceramic and a metal (e.g., metal collar or sleeve) with sufficiently low strength, stresses generated at the ceramic-to-metal braze joint may be released by plastically deforming the metal rather than the cracking the ceramic. In some cases, the ductile metal collar or sleeve comprises a Ni alloy comprising greater than or equal to about 95% or 99% (e.g., greater than or equal to about 95 wt %, or greater than or equal to about 99 wt %) Ni. The Ni alloy may also comprise less than or equal to about 0.25% Cu, 0.35% Mn and/or 0.40% Fe. The metal collar or sleeve may comprise any suitably ductile metal material described herein. In some cases, a yield strength of the metal collar or sleeve is less than or equal to about 50 MPa, 60 MPa, 70 MPa, 80 MPa, 90 MPa, 100 MPa, 150 MPa, 200 MPa, 250 MPa, 300 MPa, 350 MPa, 400 MPa, 450 MPa, 500 MPa, 600 MPa, 700 MPa, 800 MPa, 900 MPa or 1000 MPa. The metal collar or sleeve may have such yield strengths at a temperature of, for example, greater than or equal to about 25 °C, 400 °C, 500 °C, 600 °C, 700 °C, 800 °C, 900 °C, 1000 °C or 1100 °C. For example, a metal collar or sleeve can have a yield strength of less than or equal to about 350 MPa at a temperature of greater than or equal to about 500 °C.

The stress(es) at the ceramic-to-metal joint may be reduced by using a braze material that is suitably (e.g., sufficiently) ductile. A ductile braze material may comprise silver (Ag), copper (Cu) and/or nickel (Ni). The braze material may comprise, for example, at least about 95% or 99% Ag (e.g., by weight), at least about 95% or 99% Cu (e.g., by weight) or at least about 95% or 99% Ni (e.g., by weight). The braze material may comprise any suitably ductile braze material described herein. The ductile braze material may have a yield strength of less than or equal to about 10 MPa, 20 MPa, 30 MPa, 40 MPa, 50 MPa, 60 MPa, 70 MPa, 80 MPa, 90 MPa, 100 MPa, 150 MPa, 200 MPa, 250 MPa, 300 MPa, 350 MPa, 400 MPa, 450 MPa, 500 MPa, 600 MPa, 700 MPa, 800 MPa, 900 MPa or 1000 MPa. The braze material may have such yield strengths at a temperature of, for example, greater than or equal to about 25 °C, 400 °C, 500 °C, 600 °C, 700 °C, 800 °C, 900 °C, 1000 °C or 1100 °C. In some cases, braze materials may be coated (e.g., Ni coated).

The seal may comprise one or more metallization materials (e.g., metallization powders). The CTE of a metallization material (e.g., after the metallization layer is formed) may be at least about 3 μm/m/°C, 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/° °C, 19 μm/m/°C or 20 μm/m/°C. The CTE of the metallization material (e.g., after the metallization layer is formed) may be less than or equal to about 3 microns per meter per degree Celsius (μm/m/°C), 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The metallization material may have such CTE values for a temperature range of, for example, between about 25 °C and 400 °C, 20 °C and 500 °C, 25 °C and 500 °C, 25 °C and 600 °C, 25 °C and 900 °C, or 25 °C and 1000 °C. The Young's modulus of a metallization material may be less than about 50 giga-Pascals (GPa), 75 GPa, 100 GPa, 150 GPa or 500 GPa. The metallization material may have such Young's modulus values for a temperature of, for example, 25 °C, 300 °C, 400 °C, 500 °C, 600 °C, 900 °C, or 1000 °C. The metallization material may be chemically stable in air and/or when exposed to reactive materials in the device at a temperature of greater than or equal to about 200 °C, 300 °C, 400 °C, 500 °C, 600 °C, 900 °C, or 1000 °C.

In some cases, the maximum difference in CTE (e.g., between any two (or more) of the ceramic material, metallization material, braze material, metal collar or sleeve, and cell top or body) can be less than about 0.01 microns per meter per degree Celsius (μm/m/°C), 0.02 μm/m/°C, 0.05 μm/m/°C, 0.1 μm/m/°C, 0.2 μm/m/°C, 0.3 μm/m/°C, 0.5 μm/m/°C, 0.75 μm/m/°C, 1 μm/m/°C, 2 μm/m/°C, 3 μm/m/°C, 5 μm/m/° °C, 7 μm/m/°C, 10 μm/m/°C or 15 μm/m/°C. For example, a metal collar or sleeve (e.g., comprising a Ni—Fe alloy such as, for example, alloy 42, alloy 52, 18CrCb ferritic stainless steel, ATI alloy 600 or Hastelloy S) may have a CTE that suitably matches (e.g., within less than about 3 μm/m/°C, or within less than about 1 μm/m/°C) the CTE of the ceramic (e.g., comprising an Nd₂O₃ ceramic such as, for example, Nd₂O₃ with 5% Y₂O₃ and 5% SiC). In some cases, a difference in CTE (e.g., between any two (or more) of the ceramic material, braze material, metal collar or sleeve, and cell top or body) can be greater than or equal to about 0.01 microns per meter per degree Celsius (μm/m/°C), 0.02 μm/m/°C, 0.05 μm/m/°C, 0.1 μm/m/°C, 0.2 μm/m/°C, 0.3 μm/m/°C, 0.5 μm/m/°C, 0.75 μm/m/°C, 1 μm/m/°C, 2 μm/m/°C, 3 μm/m/C, 5 μm/m/°C, 7 μm/m/°C, 10 μm/m/°C or 15 μm/m/°C. For example, a braze material (e.g., ductile braze material) may have a CTE that is suitably (e.g., at least about 1 μm/m/°C) different than the CTE of the ceramic.

The seal may comprise a ceramic material and a braze material. In some cases, the ceramic material is stable (e.g., thermodynamically stable) when in contact with (e.g., does not chemically react with) one or more reactive materials (e.g., reactive liquid metals or reactive liquid metal vapors such as, for example, molten lithium or lithium vapor). In some cases, the ceramic material (e.g., Nd₂O₃) is stable when in contact with air (or any other type of external atmosphere). In some cases, the ceramic material is stable with, is not substantially attacked by (e.g., the material may have a slight surface reaction, but does not progress into degradation or attack of the bulk of the material) and does not substantially dissolve into the molten salt. Examples of ceramic materials include, but are not limited to, aluminum nitride (AlN), beryllium nitride (Be₃N₂), boron nitride (BN), calcium nitride (Ca₃N₂), silicon nitride (Si₃N₄), aluminum oxide (Al₂O₃), beryllium oxide (BeO), calcium oxide (CaO), cerium oxide (CeO₂ or Ce₂O₃), erbium oxide (Er₂O₃), lanthanum oxide (La₂O₃), magnesium oxide (MgO), neodymium oxide (Nd₂O₃), samarium oxide (Sm₂O₃), scandium oxide (Sc₂O₃), ytterbium oxide (Yb₂O₃), yttrium oxide (Y₂O₃), zirconium oxide (ZrO₂), yttria partially stabilized zirconia (YPSZ), boron carbide (B₄C), silicon carbide (SiC), titanium carbide (TiC), zirconium carbide (ZrC), titanium diboride (TiB₂), chalcogenides, quartz, glass, or any combination thereof. The ceramic material may be electrically insulating (e.g., the ceramic material may have a resistivity greater than about 10² Ohm-cm, 10⁴ Ohm-cm, 10⁶ Ohm-cm, 10⁸ Ohm-cm, 10¹⁰ Ohm-cm, 10¹² Ohm-cm, 10¹⁴ Ohm-cm or 10¹⁶ Ohm-cm). The ceramic material may have a CTE that is (e.g., substantially) similar to (e.g., less than or equal to about 0.1%, 0.5%, 1%, 2%, 3%, 4%, 5%, 6%, 7%, 8%, 9%, 10%, 15%, 20%, 25%, 30%, 35%, 40%, 45% or 50% different than) a CTE of stainless steel (e.g., grade 430 stainless steel, 441 stainless steel or 18CrCb ferritic stainless steel) or nickel alloy (e.g., an alloy comprising greater than or equal to about 50% Ni and greater than or equal to about 48% Fe, such as, for example, alloy 52). In an example, a ceramic material comprising Nd₂O₃ has a CTE (e.g., at least about 9 μm/m/°C, such as, for example, between about 9 μm/m/°C and about 10 μm/m/°C) that substantially matches (e.g., within less than about 5%, 10%, 20%, 40%, 60% or 80%) the CTE of a metal collar or sleeve that comprises Fe and/or Ni (e.g., a metal collar or sleeve that comprises one or more alloys described elsewhere herein, such as, for example, alloy 52, 18CrCb ferritic stainless steel, 441 stainless steel, Inconel 600, ATI alloy 600 or Hastelloy S). The ceramic material may be selected, for example, based on stability, corresponding material set, cost (e.g., Nd₂O₃ may in some cases be lower cost than AlN), electrical and mechanical properties, etc. The ceramic material may comprise a mixture of materials of different composition and/or morphology, as described in greater detail elsewhere herein (e.g., primary and secondary ceramic materials). The ceramic material may comprise one or more materials that have only one stable charged oxidation state. For example, the materials included in the ceramics (e.g., included in the overall ceramic material, or included in primary or secondary material(s) individually) may only exist in one stable charged oxidation state (e.g., Nd₂O₃).

In some cases, the braze material comprises one or more braze constituents such that at least one braze constituent has low solubility in the reactive material, the reactive material has low solubility in at least one braze constituent, at least one braze constituent does not react (e.g., form intermetallic alloys with) the reactive material at the operating temperature of the device, and/or the braze material melts above the operating temperature of the device. The reactive material can be, for example, a reactive metal. In some examples, the braze material comprises at least one braze constituent that has low solubility in the reactive metal. In some examples, the reactive metal has low solubility in the braze constituent. In some examples, the braze constituent does not form intermetallic alloys with the reactive metal at the operating temperature of the device. In some examples, the braze constituent and/or braze material melts above the operating temperature of the device. In some examples, the braze constituent(s) may include Ti, Ni, Y, Re, Cr, Zr, and/or Fe and the reactive metal may include lithium (Li).

Examples of braze constituent materials include, but are not limited to, aluminum (Al), beryllium (Be), copper (Cu), chromium (Cr), iron (Fe), manganese (Mn), molybdenum (Mo), nickel (Ni), niobium (Nb), rubidium (Rb), scandium (Sc), silver (Ag), tantalum (Ta), rhenium (Re), titanium (Ti), vanadium (V), yttrium (Y), zirconium (Zr), phosphorus (P), boron (B), carbon (C), silicon (Si), or any combination thereof. In some instances, the ceramic material comprises aluminum nitride (AlN) and the braze material comprises titanium (Ti). In some cases, the braze material comprises a mixture of two or more materials (e.g., 3 materials). The materials may be provided in any proportion. For example, the braze can comprise 3 materials at a ratio (e.g., in weight-%, atomic-%, mol-% or volume-%) of about 30:30:40 or 40:40:20. In some cases, the braze material comprises a mixture of Ti—Ni—Zr. In some instances, the braze comprises at least about 20, 30 or 40 weight-% titanium, at least about 20, 30% or 40 weight-% nickel, and at least about 20, 30, 40, 50 or 60 weight-% zirconium. In some instances, the braze comprises less than about 20, 30 or 40 weight-% titanium, less than about 20, 30% or 40 weight-% nickel, and less than about 20, 30, 40, 50 or 60 weight-% zirconium. In some instances, the braze comprises about 18% Ti, about 60% Zr, about 22% Ni (e.g., on a weight-%, atomic-%, mol-% or volume-% basis). In some instances, the braze comprises about 7% Ti, about 67% Zr, and about 26% Ni (e.g., on a weight-%, atomic-%, mol-% or volume-% basis). In some instances, the braze comprises at least about 5, 10, 15, 20, 25, 30, 35, 40, 45, 50, 55, 60, 65, 70, 75, 80, 85, 90, 95 or more weight-%, atomic-%, mol-% or volume-% of titanium, nickel or zirconium (or any other braze material herein). In some instances, the braze comprises less than or equal to about 5, 10, 15, 20, 25, 30, 35, 40, 45, 50, 55, 60, 65, 70, 75, 80, 85, 90, 95 or more weight-%, atomic-%, mol-% or volume-% of titanium, nickel or zirconium (or any other braze material herein). In some instances, the braze comprises greater than or equal to about 82% Ni, and less than or equal to about 7% Cr, 3% Fe, 4.5% Si, 3.2% B and/or 0.06% C (e.g., BNi-2 braze). In some instances, the braze comprises greater than or equal to about 82% Ni, and less than or equal to about 15% Cr, 4.0% B and/or 0.06% C (e.g., BNi-9 braze). In some instances, the braze comprises greater than or equal to about 82% Ni, and less than or equal to about 15% Cr, 7.3% Si, 0.06% C and/or 1.4% B (e.g., BNi-5b braze). In some instances, the braze comprises yttrium, chromium or rhenium, and nickel.

To facilitate the use of certain braze materials (e.g., non-active braze materials) to bond the ceramic material to a metal collar or sleeve, a layer comprising metal (also “metallization layer” and “pre-metallization layer” herein) may first be applied to the ceramic material via a pre-metallization step (e.g., the metallization layer may be applied to the ceramic material by a coating process). For example, a metallization layer with a controlled layer thickness may be applied onto the ceramic material by sputter-coating or by vacuum or controlled atmosphere (e.g., Ar or N₂ with H₂ gas) high temperature thermal treatment (e.g., sintering the metallization layer onto the ceramic) without bonding a metal collar or sleeve to the braze material. The pre-metallization step may enable, for example, a subsequent brazing step to bond the pre-metallized ceramic surface to a metal collar or sleeve by using a preferred braze material that may not bond to the ceramic material directly (e.g., the braze material may not bond to the ceramic material without a metallization layer).

A metallization layer may comprise metallization material (also “pre-metallization material” herein). As described in greater detail elsewhere herein, the metallization material may include one or more metal and/or non-metal materials (e.g., one or more metals, ceramics, silicon oxide glass, etc.). Application of a metallization material may result in formation of one or more layers of the pre-metallization layer. The sublayer(s) may be formed in one step (e.g., a processing step using a single metallization material may result in the formation of two sublayers) or may result from multiple processing steps (e.g., multiple processing steps using different metallization materials). A metallization material may include a braze material. For example, at least a portion (e.g., some portion) of the braze material (e.g., yttrium, titanium or aluminum) may be applied as metallization material via a pre-metallization step. In some instances, a pre-metallization material may be referred to as a pre-metallization braze material. The metallization material may be different from a braze material. In some instances, a material may be referred to as a metallization material instead of a braze material. For example, when applying a metal coating as a powder and bonding that powder to the ceramic, the powder may be referred to as a metallization powder rather than a braze powder. Such nomenclature may distinguish between a braze material that may melt during a thermal process onto the ceramic and/or metal, and a metallization material (e.g., powder) that may effectively sinter onto the ceramic during a thermal process and may not melt (e.g., may not fully melt) during the thermal process.

At least a portion of the metallization material (e.g., yttrium, titanium or aluminum) applied via the pre-metallization step may be applied onto the ceramic via sputtering and subsequently covered by a layer of a material that is stable in air (e.g., Cr, Re or Ni) up to and beyond a given (e.g., intended or certified) operating temperature of the seal and/or the cell comprising the seal (e.g., temperatures ranging from room temperature to within about 5%, 10%, 20%, 30%, 50% or more of the intended operating temperature). The pre-metallization material application process may occur in stages, resulting in a layered structure comprising a first layer (e.g., an active layer) adjacent to the ceramic and a second layer (e.g., a protective layer) that covers the first layer. The second layer may be applied to the first layer using the same coating process (e.g., a sputter-coated thin layer of Y may be covered with a protective layer of Cr or Re in the same sputtering process step) or via a separate coating process (e.g., a different coating process such as, for example, Ni-plating). The active layer may comprise a metal (e.g., yttrium or titanium) that is capable of thermodynamically reducing the metal constituent in the ceramic (e.g., Nd₂O₃+2Y→Y₂O₃+2Nd, or AlN+Ti→TiN+Al). The protective layer may comprise a metal (e.g., Ni, Re, Cr, Si or Al), a high temperature metal alloy, a non-metal (e.g., Al₂O₃, SiO₂, MgO, AlN or another stable ceramic material), or any combination thereof. The resulting pre-metallized ceramic may comprise an assembly comprising a bulk ceramic component and a metallization layer (e.g., a thin layer of metallization material). The resulting pre-metallized ceramic may comprise, for example, an assembly comprising a bulk ceramic component, a thin layer of an active braze material (also “active layer” herein), and/or a thin layer of a protective material (also “protective layer” herein) that covers the active layer. The resulting pre-metallized ceramic may then be brazed (e.g., vacuum-brazed or hydrogen atmosphere-brazed) to a metal collar or sleeve (e.g., collar or sleeve comprising stainless steel) using a pre-metallized-ceramic-to-metal braze (e.g., Ni-based, Al-based or Cu-based braze), forming a third layer (e.g., pre-metallized-ceramic-to-metal layer). If the protective layer is a metal, the metal may be selected such that it forms none or a small number (e.g., less than or equal to 1, 2 or 3) of intermetallic compounds (e.g., brittle intermetallic compounds) with the active layer and/or with the pre-metallized-ceramic-to-metal-collar/sleeve braze layer (also “pre-metallized-ceramic-to-metal layer” herein). The metal may be selected such that it does not form intermetallic compounds (e.g., brittle intermetallic compounds) with the active layer and/or with the pre-metallized-ceramic-to-metal-collar/sleeve braze layer. For example, using Re or Cr as the protective layer may result in metal-to-metal interfaces that include none or at most one (e.g., brittle) intermetallic compound (e.g., Cr may not form intermetallic compounds with Y or Ni, and Re may not form intermetallic compounds with Ni and may only form one intermetallic compound with Y). The protective layer may be selected based on its stability in air at the operating temperature of the seal and/or its stability when in the presence of (e.g., in contact with) the reactive material (e.g., reactive metal) contained within the housing. In an example, a braze joint comprises a layered structure with a bulk ceramic comprising Nd₂O₃ ceramic, a thin (e.g., sputter-coated or applied via yttrium hydride (YH₃)) layer comprising yttrium metal, a thin (e.g., sputter-coated) layer comprising chromium or rhenium, a layer comprising nickel and/or copper (e.g., applied via a brazing process that joins the chromium or rhenium layer to a metal collar or sleeve), and a metal collar or sleeve comprising stainless steel, nickel or nickel alloys. The layer adjacent to the metal collar or sleeve may comprise greater than or equal to about 10%, 20%, 30%, 40%, 50%, 60%, 70%, 72%, 74%, 76%, 78%, 80%, 82%, 84%, 86%, 88%, 90%, 92%, 94%, 96%, 98% or 99% Ni (e.g., by weight). The layer adjacent to the metal collar or sleeve may comprise such Ni compositions in combination with one or more other elements (e.g., Cr, Fe, Si, B and/or C) with individual concentrations or a total concentration of less than or equal to about 20%, 17.5%, 15%, 12.5%, 10%, 9%, 8%, 7%, 6%, 5%, 4.5%, 4%, 3.6%, 3.2%, 3%, 2%, 1%, 0.08%, 0.05% or 0.01% (e.g., by weight). The layer adjacent to the metal collar or sleeve may comprise greater than or equal to about 82% Ni (e.g., BNi-2 braze, BNi-5b braze or BNi-9 braze). The layer adjacent to the metal collar or sleeve may comprise a braze alloy with greater than about 30% Ti, 30% Cu, 90% Cu, 30% Al, 30% Ag or 80% Ag. A seal comprising copper may comprise a thin layer of Ni that is plated or applied to the exposed braze (e.g., copper) surfaces.

A pre-metallization layer (also “metallization layer” herein) may be applied by bonding (e.g., sintering, at least partially melting and/or otherwise joining) a metallization material (e.g., metallization powder) onto the surface of the ceramic material. The pre-metallization layer may comprise one or more layers (e.g., one or more sublayers, such as, for example, an active layer and a protective layer), and/or one or more constituents. In some cases, the pre-metallization layer can comprise separate active and protective layers. In some cases, the active layer can simultaneously be a protective layer (e.g., a separate protective layer may not be needed). A protective layer may or may not be considered part of the pre-metallization layer. The metallization material may comprise metal powder. The metal metallization powder may comprise one or more metals including, for example, manganese, molybdenum, tungsten, niobium, and/or tantalum. The metallization material (e.g., metallization powder) may comprise metal powder mixed with one or more other materials (e.g., polymers, organic dispersants, water-based solvents, ceramics, glass, or any combination thereof) to form a slurry or paint that can be applied to the ceramic (e.g., prior to melting). In an example, the ceramic material (e.g., AlN or Nd₂O₃) may be bonded to a layer of metallization powder comprising tungsten particles by heating to at least about 1000 °C, 1200 °C, 1400 °C, 1600 °C, 1800 °C or 2000 °C. The bonding may include sintering. The bonding may include at least partially melting one or more components of the metallization material (e.g., thereby aiding the sintering). For example, in some Mo—Mn metallization powders that comprise mostly Mo, the Mn may form some liquid phase during the metallization process and then constitutionally freeze and alloy with Mo, thus partially melting the metallization powder during the process. Partially melting the metallization powder in this way may aid in fully sintering the metallization layer onto the ceramic. Other examples of Mo—Mn metallization powders may include low melting point alloys; such alloys may or may not be suitable as metallization powders. After bonding the metallization powder to the ceramic, the metallization layer (e.g., tungsten (W)) may be plated with nickel. In another example, the metallization powder (e.g., manganese (Mn) and/or molybdenum (Mo)) may be bonded (e.g., sintered, at least partially melted), for example, near or above (e.g., at greater than or equal to) about 1330 °C, 1400 °C, 1500 °C, 1550 °C or 1600 °C. After the metallization powder is bonded to the ceramic material, it may be coated or plated with Ni to decrease or prevent corrosion or oxidation.

The metallization layer may comprise one or more primary metal constituents that may be chosen based on a CTE that closely matches a ceramic material (e.g., Nd₂O₃), a low Young's modulus, stability in air at elevated (e.g., operating) temperatures, or any combination thereof. In some examples, a difference between a CTE of the ceramic material and a CTE of the primary metallization metal constituent may be less than or equal to about 3 ppm/K, 2 ppm/K, 1.5 ppm/K, 1 ppm/K, 0.5 ppm/K, 0.25 ppm/K, 0.1 ppm/K or 0.025 ppm/K. In some examples, a CTE of a primary metallization metal constituent may be less than or equal to about 6.5 ppm/K, 7 ppm/K, 7.5 ppm/K, 8 ppm/K, 8.5 ppm/K, 9 ppm/K, 9.5 ppm/K, 10 ppm/K, 10.5 ppm/K, 11 ppm/K, 11.5 ppm/K or 12 ppm/K. The CTEs may be for a temperature range of, for example, between about 20 °C and 1000 °C, or 20 °C and 500 °C. A primary metallization metal constituent may have or be chosen based on a low Young's modulus value. A primary metallization metal constituent may have or be chosen based on a Young's modulus value of, for example, less than about 200 giga-Pascals (GPa), 150 GPa, 100 GPa, 75 GPa or 50 GPa. The primary metallization metal constituent may be, for example, niobium (Nb) or tantalum (Ta). The metallization material may also include one or more secondary metallization metals. The secondary metallization metals may improve physical, thermal, chemical and/or mechanical properties, such as, for example, stability in air at or above the target service temperature or operating temperature of the device (e.g., a temperature of at least about 500 °C, 550 °C, 600 °C, 650 °C, 700 °C, 800 °C or 900 °C). The secondary metallization metals may include, for example, Ti, Al, Cr, Mo, Ta, Nb and/or Ni. The resulting metallization metal alloy may comprise Nb with greater than or equal to about 20 atomic-% (at %) Ti, 5 at % Mo, 2 at % Mo, 5 at % Al, 5 at % Ni, 10 at % Si and/or 5 at % Cr. In some examples, the metallization metal alloy comprises greater than or equal to about 50 at % Nb, 60 at % Nb, 70 at % Nb, 80 at % Nb, 90 at % Nb, or 95 at % Nb. In some examples, the metallization metal alloy comprises about 95 at % Nb and 5 at % Mo, 20 at % Ti and 80% Nb, 40 at % Ti and 60 at % Nb, 90 at % Nb and 5 at % each of Mo and Ni, or 80 at % Nb and 20 at % Al. In an example, Nb may have a CTE that closely matches Nd₂O₃ and a low Young's modulus (high elasticity), and may be made air stable by alloying with, for example, Ti, Mo, Al or Cr.

The metallization powder may comprise one or more ceramic or glass constituents. A ceramic or glass constituent may react with the ceramic material of the seal (also “seal ceramic material” herein) to form one or more (e.g., new) ceramic or glass materials (e.g., compounds such as, for example, mutual reaction compounds of the ceramic material and the ceramic or glass constituent of the metallization powder) that may, for example, aid in creating a mechanical bond between the pre-metallization layer and the ceramic material. In an example, the seal ceramic material comprises AlN and the metallization powder comprises at least about 10% Mn, at least about 10%, 20%, 50%, or 70% Mo and at least about 2%, 5%, 10% 15% or 20% Nd₂O₃. After the pre-metallization, the seal may comprise a layered structure including the bulk AlN seal ceramic material, a layer comprising Nd₂AlO₃N ceramic (e.g., formed as AlN+Nd₂O₃→Nd₂AlO₃N during melting and/or bonding of the seal ceramic material and the metallization powder) and a layer comprising Mn and/or Mo. In another example, the seal ceramic material comprises Nd₂O₃ and the metallization powder comprises at least about 10% Mn, at least about 10% Mo and at least about 2% AlN. After the pre-metallization, the seal may comprise a layered structure including the bulk Nd₂O₃ seal ceramic material, a layer comprising Nd₂AlO₃N ceramic (e.g., formed as Nd₂O₃+AlN→Nd₂AlO₃N during melting and/or bonding of the seal ceramic material and the metallization powder) and a layer comprising Mn and/or Mo. The bulk seal ceramic material, the layer comprising Nd₂AlO₃N ceramic (e.g., an active layer) and the layer comprising Mn and/or Mo (e.g., a protective layer) may form a pre-metallized ceramic component. At least one of the metallization layers (e.g., the active layer) may comprise one or more reaction products of the seal ceramic material and the metallization powder. In some cases, the metallization powder may comprise Nb metal and/or a Nb metal alloy mixed with a ceramic powder (e.g., Nd₂O₃, AlN, Y₂O₃, SrO, MgO, Al₂O₃ or TiO₂). For example, the metallization layer may comprise a Nd alloy (e.g., about 95 at % Nb and about 5 at % Mo, about 90% Nb and about 5 at % each of Mo and Ni, or about 80 at % Nb and about 20 at % Ti) with at least about 5 mol %, 10 mol % or 15 mol % Nd₂O₃ ceramic powder. In some cases, a size of the metallization powder particles or a resulting metal or ceramic grain size may be less than about 1 micrometer (μm), 5 μm, 10 μm, 15 μm, 20 μm, 30 μm, 40 μm, 50 μm, 60 μm, 80 μm, 100 μm, 150 μm or 500 μm. In some cases, open porosity of the metallization layer may be less than about 50%, 30%, 20%, 10%, 5%, 2%, 1% or 0.5%.

The seal may further comprise one or more additional layers (e.g., coated or plated onto the pre-metallized ceramic component or on each other). For example, the seal may further comprise one or more plated and/or brazed layers of Ni, Ni alloy and/or Cu. The pre-metallized layer (e.g., a pre-metallized layer comprising Nd₂AlO₃N and Mn and/or Mo sublayers, or a pre-metallized layer comprising W) may be Ni-plated (e.g., plated with Ni to prevent one or more portions of the pre-metallized layer such as, for example, tungsten, from oxidizing). This Ni-plated layer may be relatively thin. For example, the seal ceramic material may be metallized with Mo/Mn and the metallization layer may then be Ni-plated, or the seal ceramic material may be metallized with W and the metallization layer may then be Ni-plated. The Ni-plated layer (the Ni-plated pre-metallized ceramic component) may then be brazed to a metal (e.g., Fe—Ni alloy, Ni or SS) collar or sleeve using a braze comprising Cu or Ni (e.g., Cu, Ni or Ni alloy braze, such as for example, a Cu braze foil, a Cu paste, a BNi-2, BNi-5b or BNi-9 braze foil or a BNi-based braze paste). This braze layer may be thicker than the Ni-plated layer. When using a Cu braze, the brazed assembly may be Ni-plated after the brazing process (e.g., to cover the exposed Cu and/or to prevent the Cu from oxidizing or electromigrating). For example, after brazing with a Cu braze foil or paste, the braze joint may have some Cu exposed (e.g., on the edge of the braze and metal collar/sleeve joint). Such exposed metal surfaces may be Ni-plated (e.g., to ensure that the Cu is adequately covered to prevent Cu-electromigration).

The ceramic-to-metal seal joint may comprise metallization material comprising Mn and/or Mo that is bonded to the seal ceramic material. The metallization material may also comprise one or more ceramic or glass constituents. The metallization material may be bonded to the seal ceramic material using, for example, a high temperature process. For example, the ceramic-to-metal seal joint may comprise Nd₂O₃ as the seal ceramic material, a first metallization layer (e.g., an active layer) comprising Nd₂AlO₃N, a second metallization layer (e.g., a protective layer) comprising Mn, Mo, Nb, Ta and/or W, a first layer comprising Ni (e.g., a thin layer of Ni that is plated), a second layer comprising Ni (e.g., Ni alloy) or Cu (e.g., a braze layer of Ni, Ni alloy or Cu that may be thicker than the first layer), and a metal collar or sleeve (e.g., comprising greater than or equal to about 95% or 99% Ni, a Ni—Fe alloy, 18CrCb ferritic stainless steel, 441 stainless steel, Inconel 600, ATI alloy 600, Hastelloy S, or another stainless steel grade). In some cases, when the second layer comprises Cu, at least a portion of the second layer (e.g., the portion that is not covered by the metal collar or sleeve or by the first layer) may be covered by a third layer comprising Ni (e.g., another thin layer of Ni that is plated). In some cases, the second layer may comprise greater than or equal to about 82% Ni (e.g., BNi-2, BNi-9 braze or BNi-5b braze).

The ceramic-to-metal seal joint may comprise metallization material comprising W that is bonded to the seal ceramic material. The metallization material may or may not also comprise one or more ceramic or glass constituents (e.g., the tungsten may in some cases be bonded without an oxide bonding layer, without a glass frit and/or without being mixed with a ceramic). The metallization material may be bonded to the seal ceramic material using, for example, a high temperature process. For example, the ceramic-to-metal seal joint may comprise AlN or Nd₂O₃ as the seal ceramic material, a metallization layer (e.g., an active/protective layer) comprising W, a first layer comprising Ni (e.g., a thin layer of Ni that is plated), a second layer comprising Ni (e.g., Ni alloy) or Cu (e.g., a braze layer of Ni, Ni alloy or Cu that may be thicker than the first layer), and a metal collar or sleeve (e.g., comprising greater than or equal to about 95% or 99% Ni, a Ni—Fe alloy, or a stainless steel). In some cases, when the second layer comprises Cu, at least a portion of the second layer (e.g., the portion that is not covered by the metal collar or sleeve or by the first layer) may be covered by a third layer comprising Ni (e.g., another thin layer of Ni that is plated). In some cases, the second layer may comprise greater than or equal to about 82% Ni (e.g., BNi-2, BNi9 or BNi-5b braze).

In some implementations, a ceramic-to-metal brazed joint may be formed by a metallization process followed by a brazing process. In some implementations, the metallization step may not be needed and the ceramic-to-metal brazed joint may be formed directly by an active braze step (e.g., using a Ti-containing braze).

The ceramic-to-metal seal joint may comprise a Nd₂O₃ ceramic material, a metallization layer, a braze layer, and a metal sleeve or collar. The ceramic material, metallization layer, braze layer, and metal sleeve or collar may be sequentially bonded to each other to form a gas-tight bonded barrier/interface. For example, the ceramic-to-metal joint may include a ceramic material comprising Nd₂O₃ which is bonded to a metallization layer comprising niobium (e.g., Nb—Ti, Nb—Mo, Nb—Ni or Nb—Mo—Ni) and which may also be interspersed with ceramic particles (e.g., Nd₂O₃, AlN, Y₂O₃, TiO₂ and/or CaO), a braze layer (e.g., a Ni-based braze alloy, such as, for example, BNi-2, BNi-9 or BNi-5b braze), and a metal sleeve or collar (e.g., Fe— or Ni-based metal alloy, 18CrCb ferritic stainless steel, 441 stainless steel, Inconel 600, ATI alloy 600, Hastelloy S or alloy 52). In an example, the ceramic-to-metal joint may include a ceramic comprising Nd₂O₃ (e.g., Nd₂O₃ with greater than or equal to about 5 wt % SiC, 5 wt % ZrO₂ and/or 3 wt % Y₂O₃, or AlN with greater than or equal to about 3% Nd₂O₃), a Nd—Mo—Ni metallization layer (e.g., comprising about 85% Nb, 10% Mo and 5% Ni) interspersed with about 10 wt % Nd₂O₃ ceramic powder (e.g., with grain size less than about 100 microns), a braze alloy layer of BNi-2, BNi-9 or BNi-5b braze alloy, and a metal sleeve or collar (e.g., 18CrCb ferritic stainless steel, 441 stainless steel, ATI alloy 600, Hastelloy S or Inconel 600). The ceramic material layer may have a thickness of greater than about 1 mm, the metallization layer may have a thickness of less than or equal to about 50 μm, the braze alloy layer may have a thickness of less than or equal to about 100 μm, and the metal sleeve or collar may have a thickness of greater than or equal to about 100 μm.

The ceramic-to-metal seal joint may comprise Nd₂O₃ ceramic material, a titanium-containing braze alloy (e.g., Ni alloys comprising Ti, Al and/or Si, such as, for example, Ni with about 27 wt % Ti and about 10 wt % Al), and a metal sleeve or collar material (e.g., alloy 52, 18CrCb ferritic stainless steel, 441 stainless steel, Inconel 600, ATI alloy 600 or Hastelloy S). In an example, the ceramic-to-metal joint may include an Nd₂O₃ ceramic material (e.g., Nd₂O₃ with greater than or equal to about 5 wt % SiC, 5 wt % ZrO₂ and/or 3 wt % Y₂O₃), a Ni—Ti—Al braze alloy layer, and a metal sleeve or collar of 18CrCb ferritic stainless steel. The ceramic material layer may have a thickness of greater than about 1 mm thickness, the metallization layer may may have a thickness of less than or equal to about 25 μm, the braze alloy layer may have a thickness of less than or equal to about 100 μm, and the metal sleeve or collar may have a thickness of greater than or equal to about 75 μm.

Other suitable brazing material(s) may be added to the braze to improve chemical stability, change the melting temperature, or change mechanical properties (e.g., change the CTE of the braze, change the ductility of the braze, etc.). One or more layers may be formed under modified conditions (e.g., in a surrounding atmosphere with a different composition or in the presence of a suitable reactive material). Such modifications may alter the composition of the aforementioned layered structure. The metal collar or sleeve may in some cases be substituted by a different metal component (e.g., cell lid or body comprising stainless steel) and/or combined with an additional metal component. Any aspects of the disclosure described in relation to ceramic-to-metal joints comprising a metal collar or sleeve may equally apply to ceramic-to-metal joints comprising a metal component other than the metal collar or sleeve (e.g., a cell lid or body) at least in some configurations.

The ceramic material may comprise a main (also “primary” herein) ceramic material (e.g., AlN, Nd₂O₃ or Y₂O₃) and a secondary ceramic material that is also thermodynamically stable, such as, for example, Y₂O₃, La₂O₃ and/or any other ceramic material described herein (e.g., AlN, Be₃N₂, BN, Ca₃N₂, Si₃N₄, Al₂O₃, BeO, CaO, Ce₂O₃, Er₂O₃, MgO, Nd₂O₃, Sm₂O₃, Sc₂O₃, Yb₂O₃, ZrO₂, YPSZ, B₄C, SiC, TiC, ZrC, TiB₂, chalcogenides, quartz, glass, or any combination thereof). The main ceramic material (e.g., AlN or Nd₂O₃) may comprise, for example, greater than or equal to about 0.1%, 0.5%, 1%, 2%, 3%, 4%, 5%, 6%, 7%, 8%, 9%, 10%, 15%, 20%, 25%, 30%, 35%, 40%, or 45% of the secondary ceramic material (or a combination of secondary materials) by weight (or, in some cases, by mole or by volume). In some instances, the secondary ceramic material serves to improve one or more characteristics of the ceramic (e.g., increase the strength of the ceramic) by, for example, lowering a sintering temperature of the ceramic (e.g., thereby reducing the grain size), by forming a glassy phase between the grains of the main ceramic material to promote tortuous crack growth path, and/or by one or more other strengthening mechanisms for ceramic toughening. One or more of such strengthening mechanisms may increase the energy required for a crack to propagate. In some cases, the primary and/or secondary ceramic materials may have different dimensions, geometries, aspect ratios and/or other characteristics (e.g., regardless of the particle sizes). For example, a secondary ceramic material may be in a form that increases the strength of the ceramic, such as cuboidal-like shapes, spherical particles, elongated needle-like structures, whiskers, rods and/or other suitable form(s). Elongated shapes, such as, for example, needle-like structures, whiskers and/or rods, may have an aspect ratio (e.g., the ratio between the smallest dimensional length and the longest dimensional length) of at least about 10, 20, 50, 100, 200, 500 or 1000. The secondary ceramic material (e.g., Y₂O₃ and/or SiC added to AlN) may increase the strength of the primary ceramic material by at least about 0.1%, 0.5%, 1%, 2%, 3%, 4%, 5%, 6%, 7%, 8%, 9%, 10%, 15%, 20%, 25%, 30%, 40%, 50%, 60%, 70%, 80%, 90%, 100%, 120%, 140%, 160%, 180%, 200%, 250%, 300%, 350%, 400%, 450%, 500%, 600%, 700%, 800%, 900%, 1000%, and the like. A ceramic material comprising two or more ceramic material components (e.g., a primary ceramic material and a secondary ceramic material) may substitute a ceramic material comprising a single ceramic material component at least in some configurations, and vice versa.

The ceramic material may be densified (e.g., a material comprising separable powder particles may be converted to a more mechanically robust material where the particles have fused together) through high temperature processes such as, for example, sintering. In some cases, densification (e.g., sintering) may be performed to reduce an amount of porosity (e.g., percentage of volume within the bulk of a ceramic material not occupied by the ceramic material) from greater than or equal to about 50% (in an un-sintered sample) to less than or equal to about 10%, 9%, 8%, 7%, 6%, 5%, 4%, 3%, 2%, 1.5%, 1%, 0.75%, 0.5%, 0.25% or 0.1%. In some cases, the densified ceramic material may have a density that is greater than or equal to about 85%-of-theoretical-density (% TD), 90% TD, 92% TD, 94% TD, 96% TD, 98% TD or 99% TD (e.g., greater than about 96% TD). In some instances (e.g., at levels greater than about 96% TD for some materials), pores may no longer be connected to one another, the material may be substantially gas-tight and/or rates of corrosion may be considerably reduced (e.g., the density may reach “close pore” density). The sintering temperature and/or sintering time may differ depending on sintering conditions (e.g., under different atmospheres). The sintering temperature may be related to the sintering time (e.g., a lower sintering temperature may require a longer sintering time). The sintering temperature of the ceramic may be at least about 1000 °C, 1200 °C, 1300 °C, 1400 °C, 1500 °C, 1600 °C, 1700 °C, 1800 °C, 1900 °C or 2000 °C under different atmospheres (e.g., air, nitrogen or argon). The sintering time of the ceramic (e.g., at such temperatures and/or under different atmospheres) may be at least about 10 minutes (min), 20 min, 30 min, 40 min, 50 min, 60 min, 70 min, 80 min, 90 min, 100 min, 110 min, 120 min, 180 min, 240 min or 300 min. For example, the ceramic may be sintered at a sintering temperature of at least about 1000 °C, 1200 °C, 1300° °C, 1400 °C, 1500 °C, 1600 °C, 1700 °C, 1800 °C, 1900 °C or 2000 °C under different atmospheres (e.g., air, nitrogen or argon) for a period of at least about 10 minutes (min), 20 min, 30 min, 40 min, 50 min, 60 min, 70 min, 80 min, 90 min, 100 min, 110 min, 120 min, 180 min, 240 min or 300 min. Sintering may be performed at a pressure of at less than or equal to about 0.1 atm, 0.5 atmospheres (atm), 0.95 atm, 1 atm, 2 atm, 5 atm, 10 atm, 25 atm, 50 atm, 75 atm, 100 atm, 200 atm, 500 atm, 1000 atm, 2000 atm, 5000 atm, 10,000 atm, 20,000 atm, 50,000 atm or 100,000 atm (e.g., at such temperatures and/or under different atmospheres).

Sintering may be combined (or in some cases replaced) with one or more other processing steps. Such processing steps may be applied before, during and/or after sintering. The processing may include, for example, one or more manufacturing processes used to reduce the porosity and/or increase the density of a material. Manufacturing processes applied to one type of material (e.g., metal) may in some cases be advantageously applied to another type of material (e.g., ceramic). In some cases, the sintering process may involve a “hot press” procedure where the ceramic powder is heated to an elevated temperature in a controlled atmosphere (e.g., deep vacuum, partial vacuum, or a gas comprising Ar, N₂ and/or H₂) while a uniaxial force is applied to the ceramic to, for example, increase the rate of sintering, decrease the time it takes to reach a given density (e.g., near or about 100% density), and/or decrease the sintering temperature. The uniaxial force may be, for example, at least about 0.01 MPa, 0.1 MPa, 1 MPa, 10 MPa, 20 MPa, 30 MPa, 50 MPa, 100 MPa, 500 MPa or 1000 MPa. In some cases, a hot isostatic press (also known as a “HIP” processing) may be applied to the ceramic (e.g., after sintering). The hot isostatic press may be applied to the ceramic directly after sintering. The hot isostatic press may be applied to the ceramic at a temperature of less than or equal to about 1000 °C, 1200 °C, 1300 °C, 1400 °C, 1500 °C, 1600 °C, 1700 °C, 1800 °C, 1900 °C or 2000 °C. The hot isostatic press may be applied to the ceramic (e.g., at such temperatures) at a pressure of at least about 10 atm, 50 atm, 100 atm, 200 atm, 500 atm, 1000 atm, 2000 atm, 5000 atm, 10,000 atm, 20,000 atm, 50,000 atm or 100,000 atm. The hot isostatic press may be applied to the ceramic (e.g., at such temperatures and/or pressures) for a period of at least about 10 min, 20 min, 30 min, 40 min, 50 min, 60 min, 70 min, 80 min, 90 min, 100 min, 110 min, 120 min, 180 min, 240 min or 300 min. For example, the hot isostatic press may be applied to the ceramic by changing the temperature to less than or equal to about 1000 °C, 1200 °C, 1300 °C, 1400 °C, 1500 °C, 1600 °C, 1700 °C, 1800 °C, 1900 °C or 2000 °C and increasing the pressure to at least about 10 atm, 50 atm, 100 atm, 200 atm, 500 atm, 1000 atm, 2000 atm, 5000 atm, 10,000 atm, 20,000 atm, 50,000 atm or 100,000 atm for a period of at least about 10 min, 20 min, 30 min, 40 min, 50 min, 60 min, 70 min, 80 min, 90 min, 100 min, 110 min, 120 min, 180 min, 240 min or 300 min.

The ceramic material may have a porosity (e.g., after densification by sintering) of less than or equal to about 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.009%, 0.008%, 0.007%, 0.006% or 0.005% (e.g., less than about 1% or 0.5%).

In some instances, the ceramic comprises a main ceramic material (e.g., greater than about 50, 60, 70, 80, 90, 95 or more weight-%) that is thermodynamically stable with the contents of the cell (e.g., the reactive metal and molten salt), and a secondary ceramic material (e.g., MgO) that is not stable (e.g., not stable with the contents of the cell, and/or not stable with the atmosphere outside the cell) at sufficiently low quantities (e.g., less than about 40%, 35%, 30%, 25%, 20%, 15%, 10% or 5% on a weight, atomic, molar or volumetric basis). The secondary ceramic material may be present (e.g., exist) as particles dispersed throughout the bulk of the main ceramic material (e.g., in such a way that most of the secondary ceramic particles are not in direct contact with other secondary ceramic particles). In some cases, the secondary ceramic material particles may strengthen the overall ceramic material by establishing local regions of stress concentration to promote crack tip deflection and/or crack tip pinning. In some cases, the secondary ceramic material may be added to the main ceramic material to tune the CTE of the overall ceramic material to more closely match the CTE of the metal collar or sleeve and/or cell lid or body. In some cases, the secondary ceramic material may be added to the main ceramic material to increase overall strength. For example, the secondary ceramic material may be added to the main ceramic material to increase overall strength by existing in a phase-transformation-able state that absorbs energy as cracks propagate through the ceramic (e.g., yttria-stabilized ZrO₂ with about 3 mol % Y₂O₃). When exposed to reactive metal(s) and/or molten salt(s) and/or air, the secondary ceramic particle on the surface may be attacked, but the secondary ceramic particles dispersed throughout the bulk of the main ceramic material may not be attacked, thus enabling the ceramic material to be chemically stable when exposed to the reactive metal(s) and/or molten salt(s).

The ceramic material (also “ceramic” herein) may comprise a primary (also “main” herein) ceramic material and one or more secondary ceramic materials. In some examples, the ceramic material comprises a primary ceramic material (e.g., yttrium oxide (Y₂O₃), neodymium oxide (Nd₂O₃) or aluminum nitride (AlN)) and greater than or equal to about 0.1%, 0.5%, 1%, 2%, 3%, 4%, 5%, 6%, 7%, 8%, 9%, 10%, 12%, 12.5%, 15%, 20%, 25%, 30%, 35%, 40% or 45% by weight (also “weight percent,” “wt %” or “weight-%” herein) of a secondary ceramic material (e.g., aluminum nitride (AlN), beryllium nitride (Be₃N₂), boron nitride (BN), calcium nitride (Ca₃N₂), silicon nitride (Si₃N₄), aluminum oxide (Al₂O₃, also “alumina” herein), beryllium oxide (BeO), calcium oxide (CaO), cerium oxide (Ce₂O₃), erbium oxide (Er₂O₃), lanthanum oxide (La₂O₃), magnesium oxide (MgO, also “magnesia” herein), yttrium oxide (Y₂O₃, also “yttria” herein), neodymium oxide (Nd₂O₃, also “neodymia” herein), samarium oxide (Sm₂O₃), scandium oxide (Sc₂O₃), yttrium oxide (Yb₂O₃, also “yttria” herein), zirconium oxide (ZrO₂, also “zirconia” herein), yttria partially stabilized zirconia (YPSZ), tetragonal zirconia polycrystal (TZP), e.g., tetragonal crystal structure ZrO₂ with about 3 mol % Y₂O₃), boron carbide (B₄C), silicon carbide (SiC), titanium carbide (TiC), zirconium carbide (ZrC), titanium diboride (TiB₂), chalcogenides, quartz, glass, or any combination thereof). In some examples, the ceramic material comprises a primary ceramic material and less than about 0.1%, 0.5%, 1%, 2%, 3%, 4%, 5%, 6%, 7%, 8%, 9%, 10%, 12%, 12.5%, 15%, 20%, 25%, 30%, 35%, 40% or 45% by weight of a secondary ceramic material. A given ceramic material (e.g., Y₂O₃, Nd₂O₃ or AlN) may be a primary ceramic material in some instances and a secondary ceramic material in other instances. In some examples, the ceramic comprises a primary ceramic material (e.g., Y₂O₃, Nd₂O₃ or AlN) with greater than or equal to about 0.1%, 0.5%, 1%, 2%, 3%, 4%, 5%, 6%, 7%, 8%, 9%, 10%, 12%, 12.5%, 15%, 20%, 25%, 30%, 35%, 40% or 45% by weight of a secondary ceramic material (or a combination of secondary ceramic materials). In some examples, the ceramic comprises a primary ceramic material (e.g., Y₂O₃, Nd₂O₃ or AlN) with less than about 0.1%, 0.5%, 1%, 2%, 3%, 4%, 5%, 6%, 7%, 8%, 9%, 10%, 12%, 12.5%, 15%, 20%, 25%, 30%, 35%, 40% or 45% by weight of a secondary ceramic material (or a combination of secondary ceramic materials). The ceramic material may be substantially or wholly formed of the primary ceramic material. The amount/level/concentration of the secondary ceramic material may apply to an individual secondary ceramic material (e.g., the amount of the secondary ceramic material may apply to each individual secondary ceramic material, the ceramic material may comprise individual secondary ceramic materials in the same or different amounts, etc.) in a mixture of secondary ceramic materials, or to the secondary ceramic material mixture as a whole. Such compositions may be provided, for example, using primary and/or secondary ceramic material(s) that comprise grains (e.g., grains of given grain size(s)).

Other additives may also be included in the ceramic material and/or the secondary ceramic material(s) at lower amounts/levels (e.g., as other smaller percentage additives). Such amount/levels may be, for example, less than or equal to about 3%, 2.5%, 2%, 1.8%, 1.6%, 1.4%, 1.2%, 1%, 0.9%, 0.8%, 0.7%, 0.6%, 0.5%, 0.4%, 0.3%, 0.2%, 0.1%, 0.05%, 0.025%, 0.01% or 0.005% (e.g., wt % or mol %) of the ceramic material, or of one or more secondary ceramic materials. In an example, SiC secondary ceramic material may contain less than or equal to about 2% carbon and less than or equal to about 0.5% boron. In another example, TZP may comprise less than or equal to about 3 mol % Y₂O₃ and/or less than or equal to about 0.1-0.4 wt % Al₂O₃.

The ceramic material may comprise Nd₂O₃. The ceramic material may comprise a primary ceramic material (e.g., Nd₂O₃), and one or more secondary ceramic materials (e.g., Y₂O₃, SiC, AlN, TiC, ZrO₂, TZP, or any combination thereof). The ceramic material may be substantially or wholly formed of the primary ceramic material. The ceramic material may comprise various levels of secondary ceramic material(s). For example, the ceramic material may comprise a first secondary ceramic material and a second secondary ceramic material. The ceramic material may comprise the first secondary ceramic material (e.g., Y₂O₃) at a concentration greater than or equal to about 3 wt %, 5 wt % or 10 wt %. As an alternative, the ceramic material may comprise the first secondary ceramic material (e.g., Y₂O₃) at a concentration less than about 10 wt %, 5 wt % or 3 wt %. The ceramic material may comprise the first secondary ceramic material in combination with at least the second secondary ceramic material (e.g., SiC, AlN, TiC, ZrO₂ or TZP), the second secondary ceramic material being at a concentration greater than or equal to about 3 wt % or 5 wt %. As an alternative, the ceramic material may comprise the first secondary ceramic material in combination with at least the second secondary ceramic material (e.g., SiC, AlN, TiC, ZrO₂ or TZP), the second secondary ceramic material being at a concentration less than about 5 wt % or 3 wt %. The ceramic material may comprise the second secondary ceramic material without the first secondary ceramic material. The first secondary material may be selected, for example, among the aforementioned one or more secondary materials (e.g., SiC, AlN, TiC, ZrO₂ or TZP may be selected instead of Y₂O₃). The second secondary material may then be suitably selected from the remainder of the one or more secondary ceramic materials. The ceramic material may comprise additional secondary ceramic materials (e.g., at similar or different concentrations). Such additional secondary ceramic materials may be selected, for example, among the aforementioned one or more secondary ceramic materials not selected as the first secondary ceramic material and the second secondary ceramic material. The ceramic material and/or the secondary ceramic material(s) may comprise one or more additives as described elsewhere herein.

The ceramic material may have a tensile yield strength greater than or equal to about 50 MPa, 100 MPa, 150 MPa, 200 MPa, 250 MPa, 300 MPa, 350 MPa, 400 MPa, 450 MPa, 500 MPa, 550 MPa, 600 MPa, 700 MPa, 800 MPa, 900 MPa or 1000 MPa.

There are various examples of such ceramic material compositions. The ceramic material may comprise Nd₂O₃ (e.g., greater than about 30 wt % Nd₂O₃), and greater than or equal to about 3 wt % SiC. The ceramic material may comprise Nd₂O₃ (e.g., greater than 30 wt % Nd₂O₃), and greater than or equal to about 3 wt % Y₂O₃ and/or greater than or equal to about 3 wt % SiC. The ceramic material may comprise Nd₂O₃ (e.g., greater than about 30 wt % Nd₂O₃), and greater than or equal to about 3 wt % Y₂O₃ and/or greater than or equal to about 5% SiC. The ceramic material may comprise Nd₂O₃ (e.g., greater than about 30 wt % Nd₂O₃), and less than or equal to about 3 wt % Y₂O₃ and/or greater than or equal to about 5% SiC. The ceramic material may comprise Nd₂O₃ (e.g., greater than about 30 wt % Nd₂O₃), and less than or equal to about 5 wt % SiC. The ceramic material may comprise Nd₂O₃, and less than or equal to about 5 wt % Y₂O₃ and/or less than or equal to about 5 wt % SiC. The ceramic material may comprise Nd₂O₃, and less than or equal to about 5 wt % Y₂O₃ and/or greater than or equal to about 5 wt % SiC. The ceramic material may comprise Nd₂O₃, and less than or equal to about 10 wt % Y₂O₃ and/or greater than or equal to about 5 wt % SiC. The ceramic material may comprise Nd₂O₃, and less than or equal to about 10 wt % Y₂O₃ and/or less than about 5 wt % SiC. In an example, the ceramic material comprises Nd₂O₃, and less than about 5 wt % Y₂O₃ and greater than about 5 wt % SiC. The ceramic material may comprise Nd₂O₃ (e.g., greater than about 30 wt % Nd₂O₃), and greater than or equal to about equal to 5 wt % TiC. The ceramic material may comprise Nd₂O₃ (e.g., greater than about 30 wt % Nd₂O₃), and greater than or equal to about 5 wt % TiC and greater than or equal to about 3 wt % ZrO₂.

The composition of a material (e.g., ceramic material) may be described, defined and/or specified in various ways. The composition of a ceramic material may be specified in terms of the composition of the raw materials (e.g., powders) used to create the ceramic material. For example, if a ceramic material is fabricated from and/or comprises about 90 wt % Nd₂O₃ powder, 5 wt % TZP powder and 5 wt % SiC powder, the ceramic material composition may be specified in terms of its constituents as about 90 wt % Nd₂O₃, 5 wt % TZP and 5 wt % SiC. During the sintering process (e.g., hot pressing or HIP), the constituents may change phase and/or interact with each other. For example, TZP may interact with Nd₂O₃ in one or more ways, including, for example, forming Nd₂Zr₂O₇ as a separate phase from both TZP and Nd₂O₃, and/or diffusing into the Nd₂O₃ crystal structure. During diffusion into the Nd₂O₃ crystal structure, the Zr atoms may substitutionally replace Nd atoms in the crystal structure to create a mixed composition with a crystal structure similar to the Nd₂O₃ crystal structure (e.g., (Nd,Zr)₂O₃). In some cases, more than two metal elements may exist in the same crystal structure (e.g., Y₂O₃ and ZrO₂ may both diffuse into the Nd₂O₃ crystal structure to make (Nd,Zr,Y)₂O₃). In an example, the ceramic material may comprise greater than about 30 wt % Nd₂O₃, and less than or equal to about 5 wt % Y₂O₃, at greater than or equal to about 15 wt % Nd₂Zr₂O₇, and greater than or equal to about 5 wt % SiC. Such a composition of crystal structures/phases (or at least a subset thereof) may result from sintering and/or may be used in as a raw material.

As evidenced, for example, by the presence and amounts of the remaining old phase (e.g., TZP), new phase (e.g., Nd₂Zr₂O₇) and changed neighboring phase(s) (e.g., (Nd,Zr)₂O₃), the composition of a sintered ceramic material may be specified in multiple ways in addition to (or based on) the composition of the raw materials (e.g., powders) used to make a ceramic material.

In one approach, the composition of a ceramic material may be specified in terms of the atomic percent (also “atomic-%” and “at %” herein) of an element in the ceramic material (e.g., in the final (e.g., sintered) ceramic material). For example, the atomic percentage of Nd, Y, Zr, O, Si and/or C atoms in a ceramic material may be measured and used as a way to specify the composition of the ceramic material. Methods for measuring atomic percentages in a material may include, for example, mass spectroscopy (e.g., inductively coupled plasma mass spectroscopy (ICP-MS)) and/or other established analytical techniques. Some techniques, such as ICP-MS, may include dissolving a material in a solution (e.g., aqueous and/or acidic bath containing H₂O), thus making it difficult to determine the relative atomic percent of certain elements (e.g., H, O). The composition of the ceramic material may therefore be specified by measuring the “relative” atomic percentages of a group of elements (e.g., metals, or a list of elements excluding O, H, C, and/or N). In an example, a ceramic material is specified in terms of the atomic percentages of metallic elements or a subset of all the elements (e.g., elements excluding H, C, O, N). Other techniques (e.g., combustion and infrared detection, inert gas fusion, vacuum hot extraction, etc.) may be used to detect remaining atoms (e.g., H, C, O, N) present in the ceramic material. In some instances, multiple different analytical techniques can be used on different portions of the same material to determine atoms present and establish an accurate atomic percentage composition measurement of all elements present.

Another approach to specifying the composition of a ceramic material may include specifying the crystal structures present as measured through some analytical technique (e.g., X-ray diffraction (XRD)). Crystal structure analysis may provide estimates of the composition of the material, but may not reach desired levels of precision of each measured phase. For example, a ceramic material fabricated from 85 wt % Nd₂O₃, 5 wt % Y₂O₃, 5 wt % TZP and 5 wt % SiC may be analyzed using crystal structure analysis (e.g., XRD). The analysis may detect the presence of Nd₂O₃, Nd₂Zr₂O₇, (Nd,Zr)₂O₃, Y₂O₃, SiO₂, NdC₂ and/or SiC crystal structures; however, this process may not be able to provide sufficiently precise relative amounts (e.g., the analysis may be unable to resolve within less than about 2% or 10% of each crystal structure present in a sample). The composition of the ceramic material may therefore be specified by specifying which crystal structures are present in the ceramic material (e.g., in the final ceramic material) and the relative atomic percentages (either based on all types of elements in the sample, or based on a subset of elements, such as, for example, the relative percentages of metals in the sample). For example, the composition of a material comprising 85 wt % Nd₂O₃, 5 wt % Y₂O₃, 5 wt % TZP and 5 wt % SiC may be specified in terms of the relative wt %, vol % and/or mol % of raw materials, and/or may be specified as a material comprising Nd₂O₃, Y₂O₃, (Nd,Zr,Y)₂O₃, NdZr₂O₇ and/or SiC crystal structures with about 71 at % Nd, 6 at % Y, 17 at % Si and 6 at % Zr on a metals basis (excluding O and C atoms) or about 29 at % Nd, 3 at % Y, 7 at % Si, 7 at % C, 2 at % Zr and 52 at % O (accounting for all elements).

The relative atomic percentages of elements and/or metal may be calculated and/or determined based on the relative percentages of raw materials (compounds) in a given ceramic composition (e.g., in wt % or mol %). Compositions of ceramic materials specified herein in terms of the relative amounts of the raw materials (e.g., powders) used to fabricate the ceramic material may therefore also cover or include ceramic materials specified in terms of crystal structures present (e.g., in a final state) and/or atomic percentages (e.g., relative atomic percentages based on all elements present or on a subset of elements such as metals or elements excluding H, O and/or C). It will be appreciated that a ceramic composition specified herein in terms of a raw material composition may include or be equivalent to one or more ceramic compositions with (i) atomic percentages (e.g., atomic percentages as measured in the final ceramic material or in any intermediate states) corresponding to the raw material composition (e.g., specification of raw material(s) also covers the final material as specified in at %), (ii) one or more crystal structures (e.g., number and/or identity of crystal structures) resulting (e.g., after sintering) from the raw materials, or (iii) a combination thereof (e.g., if raw materials are specified then the final material can be specified). A given raw material composition may result in one or more final materials having the same atomic percentages, and the same or different crystal structure(s). For example, crystal structure(s) may depend on sintering conditions. Ceramic materials specified herein in terms of raw material compositions and/or atomic percentages may be understood to include final materials having any crystal structure(s). Such crystal structure(s) may be as described herein (e.g., in relation to TABLE 4). It will also be appreciated that a given final ceramic composition may be obtained using different raw materials. For example, different raw powders may be used to fabricate a ceramic material with the same final composition in atomic percent. The composition in atomic percentages (e.g., as specified, or as calculated based on raw material composition) may therefore be understood to define a ceramic material composition fabricated or manufactured from any raw material composition/mixture (e.g., from a raw material composition that includes Nd₂Zr₂O₇ as well as from (e.g., instead of) a raw material composition that includes Nd₂O₃ and ZrO₂). The ceramic material may have such atomic percentages at any point in time (e.g., during and after sintering, or throughout any other transformation). Further, it will be appreciated that a ceramic composition specified in terms of, for example, intermediate crystal structures (e.g., crystal structures present at any point during sintering and/or other transformation) may be the same ceramic composition as specified herein in terms of raw material composition, atomic percentages and/or final crystal structure(s). Any aspects of the disclosure described in relation to a ceramic composition specified in terms of raw material composition may equally apply to a ceramic composition specified in terms of atomic percent and/or in terms of crystal structure(s) or phase(s) present (e.g., in the final material, or in some cases, in one or more intermediate materials).

In some cases, individual ceramic compounds (e.g., Nd₂O₃, Y₂O₃, TZP or SiC) may exist as multiple different crystal structures (e.g., the same compound, say, Nd₂O₃, may exist as a hexagonal phase, cubic or a monoclinic crystal structure/phase). In some cases, one or more given (e.g., specific) crystal structures may be desired as they may provide improved chemical, electrical, mechanical or thermal properties (e.g., improved corrosion resistance, chemical stability, electrical resistance, bond strength with metallization or braze layer, strength, fracture toughness and/or CTE). Further details may be provided to further specify or define a ceramic material, including, for example, nominal grain size of constituent materials/compounds (which may be the same for each constituent material/compound, or different for different constituent material/compounds), typical shape or form of constituent materials/grains (e.g., spherical, whiskers or rods), porosity, and/or other physical properties as described elsewhere herein (e.g., CTE, yield strength, fracture toughness and/or chemical stability).

Some examples of ceramic material compositions comprising Nd₂O₃ are provided in TABLE 4. Examples of raw materials with amounts/levels, atomic percentages (including oxygen and carbon atoms), and crystal structures that may be present in the resulting (e.g., final) ceramic materials are provided. It will be appreciated that only a subset of the listed phases may be present (e.g., see examples provided in parentheses in the rightmost “Crystal structures” column in TABLE 4). The first ceramic material constituent in each row in the “Ceramic constituents” column may be considered the primary ceramic material (e.g., Nd₂O₃), and all other ceramic materials in the row may be considered secondary ceramic materials.

The ceramic material may comprise a given ceramic constituent at a level greater than or equal to one or more given values, at a level less than or equal to one or more given values, or a combination thereof. For example, composition #1 may comprise less than or equal to about 98 wt % of the ceramic constituent Nd₂O₃, greater than or equal to about 30 wt % or 50 wt % of the ceramic constituent Nd₂O₃, or a combination thereof. A combination of upper and lower bounds (limits) may define a range (e.g., range with or without endpoint(s) included). The primary ceramic material (e.g., Nd₂O₃) may form greater than or equal to about 30 wt %, 40 wt %, 50 wt %, 60 wt % or 70 wt % of the ceramic material for the compositions listed in TABLE 4 (e.g., the primary ceramic material may form greater than about 30 wt %, 40 wt %, 50 wt %, 60 wt % or 70 wt % of the final ceramic material). For example, composition #1 may comprise between about 30 wt %, 40 wt %, 50 wt %, 60 wt % or 70 wt % and 98 wt % Nd₂O₃, composition #17 may comprise between about 30 wt % or 40 wt % and 50 wt % Nd₂O₃, and composition #18 may comprise between about 30 wt % and 40 wt % Nd₂O₃. Examples of such ranges are provided in TABLE 4.

Also provided in TABLE 4 are examples of atomic percentages. For example, composition #1 may comprise less than or equal to about 38.8 at % Nd, greater than or equal to about 15 at % Nd, or a combination thereof (between about 15 at % and 38.8 at % Nd).

TABLE 4
EXAMPLES OF CERAMIC MATERIAL COMPOSITIONS

| | Ceramic constituents | Atomic percentages | Crystal structures that may be present |
|---|---|---|---|
| # | (wt %) | examples/ranges | and examples |
| 1 | Nd₂O₃ (e.g., ≤~98 | Nd: ≤~38.8%, ≥~15% | Monoclinic, cubic and/or hexagonal |
| | wt %, ≥~30 wt %, ≥~50 wt %) | Y: ≥~1.2% | Nd₂O₃, Y₂O₃ and/or (Nd, Y)₂O₃ |
| | Y₂O₃ (e.g., ≥~2 wt %) | O: ≤~60% | (e,g., monoclinic (Nd, Y)₂O₃) |
| 2 | Nd₂O₃ (e.g., ≤~98 | Nd: ≤~38.7%, ≥~15% | Monoclinic, cubic and/or hexagonal |
| | wt %, ≥~30 wt %, ≥~50 wt %) | Zr: ≥~1.1% | Nd₂O₃ and/or (Nd, Zr)₂O₃ |
| | ZrO₂ (e.g., ≥~2 wt %) | O: ≤~60.2% | Cubic or orthorhombic Nd₂Zr₂O₇ |
| | | | Tetragonal ZrO₂ |
| | | | (e,g., at least one of monoclinic |
| | | | Nd₂O₃ and cubic Nd₂Zr₂O₇; at least |
| | | | one of monoclinic Nd₂O₃, cubic |
| | | | Nd₂Zr₂O₇ and tetragonal ZrO₂) |
| 3 | Nd₂O₃ (e.g., ≤~98 | Nd: ≤~38.2%, ≥~15% | Monoclinic, cubic and/or hexagonal |
| | wt %, ≥~30 wt %, ≥~50 wt %) | Ti: ≥~2.2% | Nd₂O₃ |
| | TiC (e.g., ≥~2 wt %) | C: ≥~3.2% | Cubic or hexagonal TiO₂ |
| | | O: ≤~57.4% | (e,g., at least one of monoclinic |
| | | | Nd₂O₃ and cubic TiC) |
| 4 | Nd₂O₃ (e.g., ≤~98 | Nd: ≤~37.4%, ≥~15% | Monoclinic, cubic and/or hexagonal |
| | wt %, ≥~30 wt %, ≥~50 wt %) | Si: ≥~3.2% | Nd₂O₃ |
| | SiC (e.g., ≥~2 wt %) | C: ≥~3.2% | Cubic and/or hexagonal SiC |
| | | O: ≤~56.2% | (e,g., at least one of monoclinic |
| | | | Nd₂O₃ and hexagonal SiC) |
| 5 | Nd₂O₃ (e.g., ≤~96 | Nd: ≤~36.3%, ≥~15% | Monoclinic, cubic and/or hexagonal |
| | wt %, ≥~30 wt %, ≥~50 wt %) | Y: ≥~1.1% | Nd₂O₃, Y₂O₃ and/or (Nd, Y)₂O₃ |
| | Y₂O₃ (e.g., ≥~2 wt %) | Si: ≥~3.2% | Cubic and/or hexagonal SiC |
| | SiC (e.g., ≥~2 wt %) | C: ≥~3.2% | (e,g., at least one of monoclinic |
| | | O: ≤~56.2% | (Nd, Y)₂O₃ and hexagonal SiC) |
| 6 | Nd₂O₃ (e.g., ≤~90 | Nd: ≤~31.5%, ≥~15% | Monoclinic, cubic and/or hexagonal |
| | wt %, ≥~30 wt %, ≥~50 wt %) | Y: ≥~2.6% | Nd₂O₃, Y₂O₃ and/or (Nd, Y)₂O₃ |
| | Y₂O₃ (e.g., ≥~5 wt %) | Si: ≥~7.3% | Cubic and/or hexagonal SiC |
| | SiC (e.g., ≥~5 wt %) | C: ≥~7.3% | (e,g., at least one of monoclinic |
| | | O: ≤~51.2% | (Nd, Y)₂O₃ and hexagonal SiC) |
| 7 | Nd₂O₃ (e.g., ≤~94 | Nd: ≤~36.4%, ≥~15% | Monoclinic, cubic and/or hexagonal |
| | wt %, ≥~30 wt %, ≥~50 wt %) | Y: ≥~1.7% | Nd₂O₃, Y₂O₃, (Nd, Y)₂O₃, (Nd, Zr)₂O₃ |
| | Y₂O₃ (e.g., ≥~3 wt %) | Zr: ≥~1.6% | and/or (Nd, Y, Zr)₂O₃ |
| | ZrO₂ (e.g., ≥~3 wt %) | O: ≤~60.3% | Cubic or orthorhombic Nd₂Zr₂O₇ |
| | | | Monoclinic and/or tetragonal ZrO₂ |
| | | | (e,g., at least one of monoclinic |
| | | | (Nd, Y)₂O₃, and tetragonal ZrO₂; at |
| | | | least one of monoclinic (Nd, Y)₂O₃, |
| | | | cubic Nd₂Zr₂O₇ and tetragonal ZrO₂) |
| 8 | Nd₂O₃ (e.g., ≤~90 | Nd: ≤~34.1%, ≥~15% | Monoclinic, cubic and/or hexagonal |
| | wt %, ≥~30 wt %, ≥~50 wt %) | Y: ≥~2.8% | Nd₂O₃, Y₂O₃, (Nd, Y)₂O₃, (Nd, Zr)₂O₃ |
| | Y₂O₃ (e.g., ≥~5 wt %) | Zr: ≥~2.6% | and/or (Nd, Y, Zr)₂O₃ |
| | ZrO₂ (e.g., ≥~5 wt %) | O: ≤~60.5% | Cubic or orthorhombic Nd₂Zr₂O₇ |
| | | | Monoclinic and/or tetragonal ZrO₂ |
| | | | (e,g., at least one of monoclinic |
| | | | (Nd, Y)₂O₃ and tetragonal ZrO₂; at |
| | | | least one of monoclinic (Nd, Y)₂O₃, |
| | | | cubic Nd₂Zr₂O₇ and tetragonal ZrO₂) |
| 9 | Nd₂O₃ (e.g., ≤~85 | Nd: ≤~29%, ≥~15% | Monoclinic, cubic and/or hexagonal |
| | wt %, ≥~30 wt %, ≥~50 wt %) | Y: ≥~2.5% | Nd₂O₃, Y₂O₃, (Nd, Y)₂O₃, (Nd, Zr)₂O₃ |
| | Y₂O₃ (e.g., ≥~5 wt %) | Zr: ≥~2.3% | and/or (Nd, Y, Zr)₂O₃ |
| | ZrO₂ (e.g., ≥~5 wt %) | Si: ≥~7.1% | Cubic and/or orthorhombic Nd₂Zr₂O₇ |
| | SiC (e.g., ≥~5 wt %) | C: ≥~7.1% | and/or Nd₂(Zr, Si)₂O₇ |
| | | O: ≤~51.9% | Monoclinic and/or tetragonal ZrCO₂ |
| | | | Cubic and/or hexagonal SiC |
| | | | (e,g., at least one of monoclinic |
| | | | (Nd, Y)₂O₃, tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 10 | Nd₂O₃ (e.g., ≤~80 | Nd: ≤~26.5%, ≥~10% | Monoclinic, cubic and/or hexagonal |
| | wt %, ≥~30 wt %, ≥~50 wt %) | Y: ≥~2.5% | Nd₂O₃, Y₂O₃, (Nd, Y)₂O₃, (Nd, Zr)₂O₃ |
| | Y₂O₃ (e.g., ≥~5 wt %) | Zr: ≥~4.5% | and/or (Nd, Y, Zr)₂O₃ |
| | ZrO₂ (e.g., ≥~10 wt %) | Si: ≥~7% | Cubic and/or orthorhombic Nd₂Zr₂O₇ |
| | SiC (e.g., ≥~5 wt %) | C: ≥~7% | and/or Nd₂(Zr, Si)₂O₇ |
| | | O: ≤~52.6% | Monoclinic and/or tetragonal ZrO₂ |
| | | | Cubic and/or hexagonal SiC |
| | | | (e,g., at least one of monoclinic |
| | | | (Nd, Y)₂O₃, tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 11 | Nd₂O₃ (e.g., ≤~80 | Nd: ≤~24.8%, ≥~10% | Monoclinic, cubic and/or hexagonal |
| | wt %, ≥~30 wt %, ≥~50 wt %) | Y: ≥~2.3% | Nd₂O₃, Y₂O₃, (Nd, Y)₂O₃, (Nd, Zr)₂O₃ |
| | Y₂O₃ (e.g., ≥~5 wt %) | Zr: ≥~2.1% | and/or (Nd, Y, Zr)₂O₃ |
| | ZrO₂ (e.g., ≥~5 wt %) | Si: ≥~13% | Cubic and/or orthorhombic Nd₂Zr₂O₇ |
| | SiC (e.g., ≥~10 wt %) | C: ≥~13% | and/or Nd₂(Zr, Si)₂O₇ |
| | | O: ≤~44.8% | Monoclinic and/or tetragonal ZrO₂ |
| | | | Cubic and/or hexagonal SiC |
| | | | (e,g., at least one of monoclinic |
| | | | (Nd, Y, Zr)₂O₃, tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 12 | Nd₂O₃ (e.g., ≤~75 | Nd: ≤~22.7%, ≥~10% | Monoclinic, cubic and/or hexagonal |
| | wt %, ≥~30 wt %, ≥~50 wt %) | Y: ≥~2.3% | Nd₂O₃, Y₂O₃, (Nd, Y)₂O₃, (Nd, Zr)₂O₃ |
| | Y₂O₃ (e.g., ≥~5 wt %) | Zr: ≥~4.1% | and/or (Nd, Y, Zr)₂O₃ |
| | ZrO₂ (e.g., ≥~10 wt %) | Si: ≥~12.7% | Cubic and/or orthorhombic Nd₂Zr₂O₇ |
| | SiC (e.g., ≥~10 wt %) | C: ≥~12.7% | and/or Nd₂(Zr, Si)₂O₇ |
| | | O: ≤~45.6% | Monoclinic and/or tetragonal ZrO₂ |
| | | | Cubic and/or hexagonal SiC |
| | | | (e,g., at least one of monoclinic |
| | | | (Nd, Y)₂O₃ tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 13 | Nd₂O₃ (e.g., ≤~70 | Nd: ≤~20.7%, ≥~10% | Monoclinic, cubic and/or hexagonal |
| | wt %, ≥~30 wt %, ≥~50 wt %) | Y: ≥~2.2% | Nd₂O₃, Y₂O₃, (Nd, Y)₂O₃, (Nd, Zr)₂O₃ |
| | Y₂O₃ (e.g., ≥~5 wt %) | Zr: ≥~6.0% | and/or (Nd, Y, Zr)₂O₃ |
| | ZrO₂ (e.g., ≥~15 wt %) | Si: ≥~12.4% | Cubic and/or orthorhombic Nd₂Zr₂O₇ |
| | SiC (e.g., ≥~10 wt %) | C: ≥~12.4% | and/or Nd₂(Zr, Si)₂O₇ |
| | | O: ≤~46.4% | Monoclinic and/or tetragonal ZrO₂ |
| | | | Cubic and/or hexagonal SiC |
| | | | (e,g., at least one of monoclinic |
| | | | (Nd, Y)₂O₃ tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 14 | Nd₂O₃ (e.g., ≤~70 | Nd: ≤~19.4%, ≥~10% | Monoclinic, cubic and/or hexagonal |
| | wt %, ≥~30 wt %, ≥~50 wt %) | Y: ≥~2.1% | Nd₂O₃, Y₂O₃, (Nd, Y)₂O₃, (Nd, Zr)₂O₃ |
| | Y₂O₃ (e.g., ≥~5 wt %) | Zr: ≥~3.8% | and/or (Nd, Y, Zr)₂O₃ |
| | ZrO₂ (e.g., ≥~10 wt %) | Si: ≥~17.5% | Cubic and/or orthorhombic Nd₂Zr₂O₇ |
| | SiC (e.g., ≥~15 wt %) | C: ≥~17.5% | and/or Nd₂(Zr, Si)₂O₇ |
| | | O: ≤~39.8% | Monoclinic and/or tetragonal ZrO₂ |
| | | | Cubic and/or hexagonal SiC |
| | | | (e,g., at least one of monoclinic |
| | | | (Nd, Y)₂O₃ tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 15 | Nd₂O₃ (e.g., ≤~65 | Nd: ≤~17.6%, ≥~8% | Monoclinic, cubic and/or hexagonal |
| | wt % ≥~30 wt %, ≥~50 wt %) | Y: ≥~2.0% | Nd₂O₃, Y₂O₃, (Nd, Y)₂O₃, (Nd, Zr)₂O₃ |
| | Y₂O₃ (e.g., ≥~5 wt %) | Zr: ≥~5.6% | and/or (Nd, Y, Zr)₂O₃ |
| | ZrO₂ (e.g., ≥~15 wt %) | Si: ≥~17.1% | Cubic and/or orthorhombic Nd₂Zr₂O₇ |
| | SiC (e.g., ≥~15 wt %) | C: ≥~17.1% | and/or Nd₂(Zr, Si)₂O₇ |
| | | O: ≤~40.6% | Monoclinic and/or tetragonal ZrO₂ |
| | | | Cubic and/or hexagonal SiC |
| | | | (e,g., at least one of monoclinic |
| | | | (Nd, Y)₂O₃ tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 16 | Nd₂O₃ (e.g., ≤~65 | Nd: ≤~18.7%, ≥~8% | Monoclinic, cubic and/or hexagonal |
| | wt %, ≥~30 wt %, ≥~50 wt %) | Y: ≥~2.1% | Nd₂O₃, Y₂O₃, (Nd, Y)₂O₃, (Nd, Zr)₂O₃ |
| | Y₂O₃ (e.g., ≥~5 wt %) | Zr: ≥~7.9% | and/or (Nd, Y, Zr)₂O₃ |
| | ZrO₂ (e.g., ≥~20 wt %) | Si: ≥~12.1% | Cubic and/or orthorhombic Nd₂Zr₂O₇ |
| | SiC (e.g., ≥~10 wt %) | C: ≥~12.1% | and/or Nd₂(Zr, Si)₂O₇ |
| | | O: ≤~47.1% | Monoclinic and/or tetragonal ZrO₂ |
| | | | Cubic and/or hexagonal SiC |
| | | | (e,g., at least one of monoclinic |
| | | | (Nd, Y)₂O₃ tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 17 | Nd₂O₃ (e.g., ≤~50 | Nd: ≤~12.1%, ≥~6% | Monoclinic, cubic and/or hexagonal |
| | wt %, ≥~30 wt %) | Y: ≥~3.6% | Nd₂O₃, Y₂O₃, (Nd, Y)₂O₃, (Nd, Zr)₂O₃ |
| | Y₂O₃ (e.g., ≥~10 wt %) | Zr: ≥~6.6% | and/or (Nd, Y, Zr)₂O₃ |
| | ZrO₂ (e.g., ≥~20 wt %) | Si: ≥~20.4% | Cubic and/or orthorhombic Nd₂Zr₂O₇ |
| | SiC (e.g., ≥~20 wt %) | C: ≥~20.4% | and/or Nd₂(Zr, Si)₂O₇ |
| | | O: ≤~36.9% | Monoclinic and/or tetragonal ZrO₂ |
| | | | Cubic and/or hexagonal SiC |
| | | | (e,g., at least one of monoclinic |
| | | | (Nd, Y)₂O₃ tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 18 | Nd₂O₃ (e.g., ≤~40 | Nd: ≤~8.9%, ≥~8% | Monoclinic, cubic and/or hexagonal |
| | wt %, ≥~30 wt %) | Y: ≥~3.3% | Nd₂O₃, Y₂O₃, (Nd, Y)₂O₃, (Nd, Zr)₂O₃ |
| | Y₂O₃ (e.g., ≥~10 wt %) | Zr: ≥~7.6% | and/or (Nd, Y, Zr)₂O₃ |
| | ZrO₂ (e.g., ≥~25 wt %) | Si: ≥~23.3% | Cubic and/or orthorhombic Nd₂Zr₂O₇ |
| | SiC (e.g., ≥~25 wt %) | C: ≥~23.3% | and/or Nd₂(Zr, Si)₂O₇ |
| | | O: ≤~33.5% | Monoclinic and/or tetragonal ZrO₂ |
| | | | Cubic and/or hexagonal SiC |
| | | | (e,g., at least one of monoclinic |
| | | | (Nd, Y)₂O₃ tetragonal ZrO₂ and |
| | | | hexagonal SiC; at least one of |
| | | | monoclinic (Nd, Y, Zr)₂O₃, cubic |
| | | | Nd₂(Zr, Si)₂O₇, tetragonal ZrO₂ and |
| | | | hexagonal SiC) |
| 19 | Nd₂O₃ (e.g., ≤~94 | Nd: ≤~36.2%, ≥~15% | Monoclinic, cubic and/or hexagonal |
| | wt %, ≥~30 wt %, ≥~50 wt %) | Zr: ≥~1.0% | Nd₂O₃ and/or (Nd, Zr)₂O₃ |
| | ZrO₂ (e.g., ≥~2 wt %) | Si: ≥~3.2% | Cubic and/or orthorhombic Nd₂Zr₂O₇ |
| | SiC (e.g., ≥~2 wt %) | C: ≥~3.2% | and/or Nd₂(Zr, Si)₂O₇ |
| | | O: ≤~56.4% | Monoclinic and/or tetragonal ZrO₂ |
| | | | Cubic and/or hexagonal SiC |
| | | | (e,g., at least one of monoclinic |
| | | | Nd₂O₃, tetragonal ZrO₂ and |
| | | | hexagonal SiC; at least one of |
| | | | monoclinic (Nd, Zr)₂O₃, cubic |
| | | | Nd₂(Zr, Si)₂O₇, tetragonal ZrO₂ and |
| | | | hexagonal SiC) |
| 20 | Nd₂O₃ (e.g., ≤~90 | Nd: ≤~31.3%, ≥~15% | Monoclinic, cubic and/or hexagonal |
| | wt %, ≥~30 wt %, ≥~50 wt %) | Zr: ≥~2.4% | Nd₂O₃ and/or (Nd, Zr)₂O₃ |
| | ZrO₂ (e.g., ≥~5 wt %) | Si: ≥~7.3% | Cubic and/or orthorhombic Nd₂Zr₂O₇ |
| | SiC (e.g., ≥~5 wt %) | C: ≥~7.3% | and/or Nd₂(Zr, Si)₂O₇ |
| | | O: ≤~51.7% | Monoclinic and/or tetragonal ZrO₂ |
| | | | Cubic and/or hexagonal SiC |
| | | | (e,g., at least one of monoclinic |
| | | | Nd₂O₃, tetragonal ZrO₂ and |
| | | | hexagonal SiC; at least one of |
| | | | monoclinic (Nd, Zr)₂O₃, cubic |
| | | | Nd₂(Zr, Si)₂O₇, tetragonal ZrO₂ and |
| | | | hexagonal SiC) |
| 21 | Nd₂O₃ (e.g., ≤~80 | Nd: ≤~24.6%, ≥~10% | Monoclinic, cubic and/or hexagonal |
| | wt %, ≥~30 wt %, ≥~50 wt %) | Zr: ≥~4.2% | Nd₂O₃ and/or (Nd, Zr)₂O₃ |
| | ZrO₂ (e.g., ≥~10 wt %) | Si: ≥~12.9% | Cubic and/or orthorhombic Nd₂Zr₂O₇ |
| | SiC (e.g., ≥~10 wt %) | C: ≥~12.9% | and/or Nd₂(Zr, Si)₂O₇ |
| | | O: ≤~45.3% | Monoclinic and/or tetragonal ZrO₂ |
| | | | Cubic and/or hexagonal SiC |
| | | | (e,g., at least one of monoclinic |
| | | | Nd₂O₃, tetragonal ZrO₂ and |
| | | | hexagonal SiC; at least one of |
| | | | monoclinic (Nd, Zr)₂O₃, cubic |
| | | | Nd₂(Zr, Si)₂O₇, tetragonal ZrO₂ and |
| | | | hexagonal SiC) |
| 22 | Nd₂O₃ (e.g., ≤~75 | Nd: ≤~23.1%, ≥~10% | Monoclinic, cubic and/or hexagonal |
| | wt %, ≥~30 wt %, ≥~50 wt %) | Zr: ≥~2.0% | Nd₂O₃ and/or (Nd, Zr)₂O₃ |
| | ZrO₂ (e.g., ≥~5 wt %) | Si: ≥~18.2% | Cubic and/or orthorhombic Nd₂Zr₂O₇ |
| | SiC (e.g., ≥~15 wt %) | C: ≥~18.2% | and/or Nd₂(Zr, Si)₂O₇ |
| | | O: ≤~38.6% | Monoclinic and/or tetragonal ZrO₂ |
| | | | Cubic and/or hexagonal SiC |
| | | | (e,g., at least one of monoclinic |
| | | | Nd₂O₃, tetragonal ZrO₂ and |
| | | | hexagonal SiC; at least one of |
| | | | monoclinic (Nd, Zr)₂O₃, cubic |
| | | | Nd₂(Zr, Si)₂O₇, tetragonal ZrO₂ and |
| | | | hexagonal SiC) |
| 23 | Nd₂O₃ (e.g., ≤~75 | Nd: ≤~26.4%, ≥~10% | Monoclinic, cubic and/or hexagonal |
| | wt %, ≥~30 wt %, ≥~50 wt %) | Zr: ≥~6.8% | Nd₂O₃ and/or (Nd, Zr)₂O₃ |
| | ZrO₂ (e.g., ≥~15 wt %) | Si: ≥~6.9% | Cubic and/or orthorhombic Nd₂Zr₂O₇ |
| | SiC (e.g., ≥~5 wt %) | C: ≥~6.9% | and/or Nd₂(Zr, Si)₂O₇ |
| | | O: ≤~53.1% | Monoclinic and/or tetragonal ZrO₂ |
| | | | Cubic and/or hexagonal SiC |
| | | | (e,g., at least one of monoclinic |
| | | | Nd₂O₃, tetragonal ZrO₂ and |
| | | | hexagonal SiC; at least one of |
| | | | monoclinic (Nd, Zr)₂O₃, cubic |
| | | | Nd₂(Zr, Si)₂O₇, tetragonal ZrO₂ and |
| | | | hexagonal SiC) |
| 24 | Nd₂O₃ (e.g., ≤~70 | Nd: ≤~19.3%, ≥~10% | Monoclinic, cubic and/or hexagonal |
| | wt %, ≥~30 wt %, ≥~50 wt %) | Zr: ≥~5.7% | Nd₂O₃ and/or (Nd, Zr)₂O₃ |
| | ZrO₂ (e.g., ≥~15 wt %) | Si: ≥~17.4% | Cubic and/or orthorhombic Nd₂Zr₂O₇ |
| | SiC (e.g., ≥~15 wt %) | C: ≥~17.4% | and/or Nd₂(Zr, Si)₂O₇ |
| | | O: ≤~40.3% | Monoclinic and/or tetragonal ZrO₂ |
| | | | Cubic and/or hexagonal SiC |
| | | | (e,g., at least one of monoclinic |
| | | | Nd₂O₃, tetragonal ZrO₂ and |
| | | | hexagonal SiC; at least one of |
| | | | monoclinic (Nd, Zr)₂O₃, cubic |
| | | | Nd₂(Zr, Si)₂O₇, tetragonal ZrO₂ and |
| | | | hexagonal SiC) |
| 25 | Nd₂O₃ (e.g., ≤~94 | Nd: ≤~34.0%, ≥~15% | Monoclinic, cubic and/or hexagonal |
| | wt %, ≥~30 wt %, ≥~50 wt %) | Zr: ≥~1.5% | Nd₂O₃ and/or (Nd, Zr)₂O₃ |
| | ZrO₂ (e.g., ≥~3 wt %) | Ti: ≥~5.2% | Cubic and/or orthorhombic Nd₂Zr₂O₇ |
| | TiC (e.g., ≥~5 wt %) | C: ≥~5.2% | and/or Nd₂(Zr, Ti)₂O₇ |
| | | O: ≤~54.1% | Monoclinic and/or tetragonal ZrO₂ |
| | | | Cubic and/or hexagonal TiC |
| | | | (e,g., at least one of monoclinic |
| | | | Nd₂O₃, tetragonal ZrO₂ and cubic |
| | | | TiC; at least one of monoclinic |
| | | | (Nd, Zr)₂O₃, cubic Nd₂Zr₂O₇, |
| | | | tetragonal ZrO₂ and cubic TiC) |
| 26 | Nd₂O₃ (e.g., ≤~85 | Nd: ≤~29.4%, ≥~15% | Monoclinic, cubic and/or hexagonal |
| | wt %, ≥~30 wt %, ≥~50 wt %) | Zr: ≥~2.4% | Nd₂O₃ and/or (Nd, Zr)₂O₃ |
| | ZrO₂ (e.g., ≥~5 wt %) | Ti: ≥~9.7% | Cubic and/or orthorhombic Nd₂Zr₂O₇ |
| | TiC (e.g., ≥~10 wt %) | C: ≥~9.7% | and/or Nd₂(Zr, Ti)₂O₇ |
| | | O: ≤~48.8% | Monoclinic and/or tetragonal ZrO₂ |
| | | | Cubic and/or hexagonal TiC |
| | | | (e,g., at least one of monoclinic |
| | | | Nd₂O₃, tetragonal ZrO₂ and cubic |
| | | | TiC; at least one of monoclinic |
| | | | (Nd, Zr)₂O₃, cubic Nd₂Zr₂O₇, |
| | | | tetragonal ZrO₂ and cubic TiC) |
| 27 | Nd₂O₃ (e.g., ≤~89 | Nd: ≤~32.5%, ≥~15% | Monoclinic, cubic and/or hexagonal |
| | wt %, ≥~30 wt %, ≥~50 wt %) | Y: ≥~1.6% | Nd₂O₃, Y₂O₃, (Nd, Y)₂O₃, (Nd, Zr)₂O₃ |
| | Y₂O₃ (e.g., ≥~3 wt %) | Zr: ≥~1.5% | and/or (Nd, Zr, Y)₂O₃ |
| | ZrO₂ (e.g., ≥~ 3 wt %) | Ti: ≥~5.1% | Cubic and/or orthorhombic Nd₂Zr₂O₇ |
| | TiC (e.g., ≥~5 wt %) | C: ≥~5.1% | and/or Nd₂(Zr, Ti)₂O₇ |
| | | O: ≤~54.1% | Monoclinic and/or tetragonal ZrO₂ |
| | | | Cubic and/or hexagonal TiC |
| | | | (e,g., at least one of monoclinic |
| | | | (Nd, Y)₂O₃ tetragonal ZrO₂ and cubic |
| | | | TiC; at least one of monoclinic |
| | | | (Nd, Zr, Y)₂O₃, cubic Nd₂Zr₂O₇, |
| | | | tetragonal ZrO₂ and cubic TiC) |
| 28 | Nd₂O₃ (e.g., ≤~85 | Nd: ≤~30.4%, ≥~15% | Monoclinic, cubic and/or hexagonal |
| | wt %, ≥~30 wt %, ≥~50 wt %) | Y: ≥~2.7% | Nd₂O₃, Y₂O₃, (Nd, Y)₂O₃, (Nd, Zr)₂O₃ |
| | Y₂O₃ (e.g., ≥~5 wt %) | Zr: ≥~2.4% | and/or (Nd, Zr, Y)₂O₃ |
| | ZrO₂ (e.g., ≥~ 5 wt %) | Ti: ≥~5.0% | Cubic and/or orthorhombic Nd₂Zr₂O₇ |
| | TiC (e.g., ≥~5 wt %) | C: ≥~5.0% | and/or Nd₂(Zr, Ti)₂O₇ |
| | | O: ≤~54.5% | Monoclinic and/or tetragonal ZrO₂ |
| | | | Cubic and/or hexagonal TiC |
| | | | (e,g., at least one of monoclinic |
| | | | (Nd, Y)₂O₃ tetragonal ZrO₂ and cubic |
| | | | TiC; at least one of monoclinic |
| | | | (Nd, Zr, Y)₂O₃, cubic Nd₂Zr₂O₇, |
| | | | tetragonal ZrO₂ and cubic TiC) |
| 29 | Nd₂O₃ (e.g., ≤~88 | Nd: ≤~30.8%, ≥~15% | Monoclinic, cubic and/or hexagonal |
| | wt %, ≥~30 wt %, ≥~50 wt %) | Y: ≥~1.6% | Nd₂O₃, Y₂O_{3,} (Nd, Y)₂O₃, (Nd, Zr)₂O₃ |
| | Y₂O₃ (e.g., ≥~3 wt %) | Zr: ≥~1.4% | and/or (Nd, Zr, Y)₂O₃ |
| | ZrO₂ (e.g., ≥~ 3 wt %) | Si: ≥~4.4% | Cubic and/or orthorhombic |
| | TiC (e.g., ≥~3 wt %) | Ti: ≥~3.0% | Nd₂Zr₂O₇, Nd₂(Zr, Si)₂O₇ and/or |
| | SiC (e.g., ≥~3 wt %) | C: ≥~7.4% | Nd₂(Zr, Ti, Si)₂O₇ |
| | | O: ≤~51.5% | Monoclinic and/or tetragonal ZrO₂ |
| | | | Cubic and/or hexagonal TiC |
| | | | Cubic and/or hexagonal SiC |
| | | | (e,g., at least one of monoclinic |
| | | | (Nd, Y)₂O₃, tetragonal ZrO₂ and cubic |
| | | | TiC; at least one of monoclinic |
| | | | (Nd, Zr, Y)₂O_{3,} cubic Nd₂(Zr, Si)₂O₇, |
| | | | tetragonal ZrO₂, cubic TiC and |
| | | | hexagonal SiC) |

TABLE 4 provides examples of ceramic material compositions. A ceramic material may have a composition as listed in TABLE 4.A ceramic material may have a composition as listed in TABLE 4 and may also comprise constituents that are greater than or less than the amount specified in TABLE 4. For example, a constituent may be provided in a different amount than listed in TABLE 4, one or more constituents may be added or removed, and so on.

In an example, the ceramic material may comprise less than or equal to about 85 wt % and/or greater than about 30 wt % Nd₂O₃, with less than or equal to about 5 wt % Y₂O₃, less than or equal to about 5 wt % ZrO₂ (or TZP) and less than or equal to about 5 wt % SiC. In this example, the ceramic material may comprise Nd₂O₃, Y₂O₃, SiC, Nd₂Zr₂O₇ and/or ZrO₂ crystal structures. In some instances, it may be difficult to distinguish between two or more crystal structures (e.g., Nd₂O₃ and Y₂O₃) and/or other phases may not be detected (e.g., SiC and/or ZrO₂). The observed crystal structures may include, for example, monoclinic Nd₂O₃ (or Y₂O₃) and/or cubic Nd₂Zr₂O₇. The ceramic material may comprise less than or equal to about 29 at % Nd and/or greater than about 15 at % Nd, and greater than or equal to about 2.5 at % Y, 2.3 at % Zr, 7.1 at % Si, 7.1 at % C and 51.9 at % O.

In another example, the ceramic material may comprise less than or equal to about 85 wt % and/or greater than about 30 wt % Nd₂O₃, with less than or equal to about 5 wt % Y₂O₃, greater than or equal to about 5 wt % ZrO₂ (or TZP) and greater than or equal to about 5 wt % SiC. In this example, the ceramic material may comprise Nd₂O₃, Y₂O₃, SiC, Nd₂Zr₂O₇ and/or ZrO₂ crystal structures. The ceramic material may comprise less than or equal to about 29 at % Nd and/or greater than about 15 at % Nd, less than or equal to about 2.5 at % Y, and greater than or equal to about 2.3 at % Zr, 7.1 at % Si, 7.1 at % C and 51.9 at % O.

In another example, the ceramic material may comprise less than or equal to about 75 wt % and/or greater than about 30 wt % Nd₂O₃, with less than or equal to about 5 wt % Y₂O₃, greater than or equal to about 10 wt % ZrO₂ (or TZP) and greater than or equal to about 10 wt % SiC. In this example, the ceramic material may comprise Nd₂O₃, Y₂O₃, SiC, Nd₂Zr₂O₇ and/or ZrO₂ crystal structures. The ceramic material may comprise less than or equal to about 22.7 at % Nd and/or greater than about 10 at % Nd, less than or equal to about 2.3 at % Y, and greater than or equal to about 12.7 at % Si, 12.7 at % C, 4.1 at % Zr and 45.6 at % O.

In another example, the ceramic material may comprise less than or equal to about 90 wt % and/or greater than about 30 wt % Nd₂O₃, with greater than or equal to about 5 wt % ZrO₂ (or TZP) and greater than or equal to about 5 wt % TiC. In this example, the ceramic material may comprise Nd₂O₃, TiC, Nd₂Zr₂O₇ and/or ZrO₂ crystal structures. The ceramic material may comprise less than or equal to about 32.9 at % Nd and/or greater than about 15 at % Nd, and greater than or equal to about 5.1 at % Ti, 5.1 at % C, 2.5 at % Zr and 54.3 at % O.

In yet another example, the ceramic material may comprise less than or equal to about 85 wt % and/or greater than about 30 wt % Nd₂O₃, with less than or equal to about 5 wt % Y₂O₃, greater than or equal to about 5 wt % ZrO₂ (or TZP) and greater than or equal to about 5 wt % TiC. In this example, the ceramic material may comprise Nd₂O₃, Y₂O₃, TiC, Nd₂Zr₂O₇ and/or ZrO₂ crystal structures. The ceramic material may comprise less than or equal to about 30.4 at % Nd and/or greater than about 15 at % Nd, less than or equal to about 2.7 at % Y, and greater than or equal to about 5.0 at % Ti, 5.0 at % C, 2.4 at % Zr and 54.5 at % 0.

The ceramic material may comprise Nd₂O₃. The ceramic material may comprise a primary ceramic material (e.g., Nd₂O₃), and one or more secondary ceramic materials (e.g., AlN). The ceramic material may be substantially or wholly formed of the primary ceramic material. The ceramic material may comprise various levels of secondary ceramic material(s). The ceramic material may comprise the secondary ceramic material (e.g., AlN) at a concentration greater than or equal to about 2 wt %, 5 wt % or 10 wt %. As an alternative, the ceramic material may comprise the secondary ceramic material (e.g., AlN) at a concentration less than about 10 wt %, 5 wt % or 2 wt %. The ceramic material may comprise additional secondary ceramic materials (e.g., at similar or different concentrations). Such additional secondary ceramic materials may include, for example, SiC, TiC, Y₂O₃ and/or ZrO₂.

The ceramic material may have a tensile strength or tensile yield strength greater than or equal to about 50 MPa, 100 MPa, 150 MPa, 200 MPa, 250 MPa, 300 MPa, 350 MPa, 400 MPa, 450 MPa, 500 MPa, 550 MPa, 600 MPa, 700 MPa, 800 MPa, 900 MPa or 1000 MPa.

There are various examples of such ceramic material compositions. The ceramic material may comprise Nd₂O₃, and less than or equal to about 5 wt % AlN (e.g., AlN particles). The ceramic material may comprise Nd₂O₃, and greater than or equal to about 2 wt %, 5 wt % or 10 wt % AlN. The ceramic material may comprise Nd₂O₃, and less than or equal to about 10 wt % AlN. A ceramic comprising Nd₂O₃, and, for example, less than or equal to about 5 wt % AlN may have a CTE that closely matches (e.g., within about 10% or less, or within less than or equal to about 0.1%, 0.5%, 1%, 5%, 10%, 20% or 50%) the CTE of steel or stainless steel alloys (e.g., 430 stainless steel, 441 stainless steel, 18CrCb ferritic stainless steel, Inconel 600, ATI alloy 600 or Hastelloy S) (or another suitable material used instead of stainless steel, such as, for example, Ni or Fe—Ni alloys) at the operating temperature of the cell and/or system.

The ceramic material may comprise Y₂O₃. The ceramic material may comprise a primary ceramic material (e.g., Y₂O₃), and one or more secondary ceramic materials (e.g., MgO). The ceramic material may be substantially or wholly formed of the primary ceramic material. The ceramic material may comprise various levels of secondary ceramic material(s).

The ceramic material may comprise the secondary ceramic material (e.g., MgO) at a concentration greater than or equal to about 12.5 wt %. As an alternative, the ceramic material may comprise the secondary ceramic material (e.g., MgO) at a concentration less than about 12.5 wt %. The ceramic material may comprise additional secondary ceramic materials in (e.g., at similar or different concentrations). The ceramic material and/or the secondary ceramic material(s) may comprise one or more additives as described elsewhere herein.

There are various examples of such ceramic material compositions. The ceramic material may comprise Y₂O₃, and greater than or equal to about 12.5 wt % MgO (e.g., MgO particles). A ceramic comprising Y₂O₃, and, for example, greater than or equal to about 12.5 wt % MgO may have a CTE that closely matches (e.g., within about 10% or less, or within less than or equal to about 0.1%, 0.5%, 1%, 5%, 10%, 20% or 50%) the CTE of steel or stainless steel alloys (e.g., 430 stainless steel or 439 stainless steel) (or another suitable material used instead of stainless steel, such as, for example, Ni or Fe—Ni alloys) at the operating temperature of the cell and/or system.

The ceramic material may comprise AlN. The ceramic material may comprise a primary ceramic material (e.g., AlN), and one or more secondary ceramic materials (e.g., Y₂O₃, SiC, or combinations thereof). The ceramic material may be substantially or wholly formed of the primary ceramic material. The ceramic material may comprise various levels of secondary ceramic material(s). For example, the ceramic material may comprise a first secondary ceramic material and a second secondary ceramic material. The ceramic material may comprise the first secondary ceramic material (e.g., Y₂O₃) at a concentration greater than or equal to about 3 wt %. As an alternative, the ceramic material may comprise the first secondary ceramic material (e.g., Y₂O₃) at a concentration less than about 3 wt %. The ceramic material may comprise the first secondary ceramic material in combination with at least the second secondary ceramic material (e.g., SiC), the second secondary ceramic material being at a concentration greater than or equal to about 25 wt % (or 25 volume-% (also “v %,” “vol %” and “volume percent” herein). As an alternative, the ceramic material may comprise the first secondary ceramic material in combination with at least the second secondary ceramic material (e.g., SiC), the second secondary ceramic material being at a concentration less than about 25 wt % (or v %). In some instances, a concentration (e.g., of a secondary ceramic material) expressed in v % may be substantially the same or similar as when expressed in wt % (e.g., for AlN and SiC, wt % and v % can be very similar). The ceramic material may comprise the second secondary ceramic material without the first secondary ceramic material. The ceramic material may comprise additional secondary ceramic materials (e.g., at similar or different concentrations). The ceramic material and/or the secondary ceramic material(s) may comprise one or more additives as described elsewhere herein. For example, the secondary ceramic material (e.g., SiC) may also comprise about 2% carbon and about 0.5% boron.

The tensile strength of the ceramic material comprising AlN and SiC (e.g., AlN+Y₂O₃+SiC) may be greater than about 400 MPa, 500 MPa, 600 MPa, 700 MPa, 800 MPa or 900 MPa.

At least a portion (or all) of the second secondary ceramic material (e.g., SiC) may be present in the ceramic material as particles (e.g., SiC particles) that are not whiskers (e.g., at least some of the SiC particles may not be whiskers). One or more of the secondary ceramic materials (e.g. Y₂O₃) may function as a sintering aid.

There are various examples of such ceramic material compositions. The ceramic material may comprise AlN, and greater than or equal to about 3 wt % Y₂O₃ and/or greater than or equal to about 25 wt % or volume-% SiC. The ceramic material may comprise AlN, and less than about 3 wt % Y₂O₃ and/or less than about 25 wt % (or v %) SiC. The ceramic material may comprise AlN, and greater than or equal to about 3 wt % Y₂O₃ and/or less than about 25 wt % (or v %) SiC. The ceramic material may comprise AlN, and less than about 3 wt % Y₂O₃ and/or greater than or equal to about 25 wt % (or v %) SiC. The grain size of SiC in the ceramic material may be less than about 10 μm, 5 μm, 2 μm, 1 μm, 0.75 μm, 0.5 μm or 0.2 μm.

The ceramic material may comprise AlN. The ceramic material may comprise a primary ceramic material (e.g., AlN), and one or more secondary ceramic materials (e.g., Y₂O₃, Nd₂O₃, SiC, TiC, or any combination thereof). The ceramic material may be substantially or wholly formed of the primary ceramic material. The ceramic material may comprise various levels of secondary ceramic material(s). For example, the ceramic material may comprise a first secondary ceramic material and a second secondary ceramic material. The ceramic material may comprise the first secondary ceramic material (e.g., Nd₂O₃) at a concentration greater than or equal to about 1 wt %, 3 wt %, 5 wt % or 10 wt %. As an alternative, the ceramic material may comprise the first secondary ceramic material (e.g., Nd₂O₃) at a concentration less than about 10 wt %, 3 wt %, 5 wt % or 1 wt %, of. The ceramic material may comprise the first secondary ceramic material in combination with at least the second secondary ceramic material (e.g., Y₂O₃, SiC or TiC), the second secondary ceramic material being at a concentration greater than or equal to about 5 wt % (or v %), 10 wt % (or v %), 15 wt % (or v %), 20 wt % (or v %), 25 wt % (or v %), 30 wt % (or v %) or 40 wt % (or v %). As an alternative, the ceramic material may comprise the first secondary ceramic material in combination with at least the second secondary ceramic material (e.g., Y₂O₃, SiC or TiC), the second secondary ceramic material being at a concentration less than about 40 wt % (or v %), 30 wt % (or v %), 25 wt % (or v %), 20 wt % (or v %), 15 wt % (or v %), 10 wt % (or v %) or 5 wt % (or v %). In some instances, a concentration (e.g., of a secondary ceramic material) expressed in v % may be substantially the same or similar as when expressed in wt % (e.g., for AlN and SiC, wt % and v % can be very similar). The ceramic material may comprise the second secondary ceramic material without the first secondary ceramic material. The first secondary material may be selected, for example, among the aforementioned one or more secondary materials (e.g., Y₂O₃, SiC or TiC may be selected instead of Nd₂O₃). The second secondary material may then be suitably selected from the remainder of the one or more secondary ceramic materials. The ceramic material may comprise additional secondary ceramic materials (e.g., at similar or different concentrations). The ceramic material and/or the secondary ceramic material(s) may comprise one or more additives as described elsewhere herein. During processing (e.g., sintering) the primary ceramic material and at least one of the secondary ceramic materials may react to form a new phase (e.g., Nd₂AlNO₃), and/or the primary ceramic material and at least one additive may react to form a new phase. Secondary ceramic materials may or may not react with each other.

The second secondary ceramic material may have a smaller grain size than either the first ceramic material and/or other secondary ceramic material(s). In an example, the second secondary ceramic material is SiC or TiC and the particle size of the SiC to TiC particles in the ceramic is less than or equal to about 10 μm, 5 μm, 2 μm, 1 μm, 0.7 μm, 0.5 μm, 0.45 μm, 0.1 μm or 0.01 μm. In another example, the ceramic material comprises AlN, about 5 wt % Nd₂O₃, and about 5 wt % SiC or TiC where the SiC or TiC particle size is about 0.7 μm or 0.45 μm, and Nd₂O₃ material has reacted with AlN material to form Nd₂AlNO₃.

At least a portion (or all) of the second secondary ceramic material (e.g., SiC) may be present in the ceramic material as particles (e.g., SiC particles) that are not whiskers (e.g., at least some of the SiC particles may not be whiskers). One or more of the secondary ceramic materials (e.g. Y₂O₃) may function as a sintering aid.

The ceramic material (e.g., AlN+Nd₂O₃+SiC or AlN+Nd₂O₃+TiC, e.g., AlN+5 wt % Nd₂O₃+5 wt % SiC) may have a tensile yield strength greater than or equal to about 300 MPa, 350 MPa, 400 MPa, 450 MPa, 500 MPa, 550 MPa, 600 MPa, 700 MPa, 800 MPa, 900 MPa, 1000 MPa, 1200 MPa, 1400 MPa, 1600 MPa, 1800 MPa or 2000 MPa. The KIC fracture toughness of the ceramic material (e.g., AlN+5 wt % Nd₂O₃+5 wt % SiC) may be greater than or equal to about 5 MPa-m^{1/2}, 6 MPa-m^{1/2}, 7 MPa-m^{1/2}, 8 MPa-m^{1/2}, 9 MPa-m^{1/2}, 10 MPa-m^{1/2}, 11 MPa-m^{1/2}, 12 MPa-m^{1/2}, 13 MPa-m^{1/2}, 14 MPa-m^{1/2} or 15 MPa-m^{1/2} (as measured through micro hardness indentation tests). The ceramic material may have such strength and/or fracture toughness, for example, when the particle size of the second secondary ceramic material is less than or equal to about 10 μm, 5 μm, 2 μm, 1 μm, 0.7 μm, 0.5 μm, 0.45 μm, 0.1 μm, 0.01 μm or less.

There are various examples of such ceramic material compositions. The ceramic material may comprise AlN, and greater than or equal to about 3 wt % Nd₂O₃ and/or greater than or equal to about 5 wt % (or v %) SiC or TiC. The ceramic material may comprise AlN, and less than or equal to about 10 wt % Nd₂O₃ and/or less than or equal to about 40 wt % (or v %) SiC or TiC. The ceramic material may comprise AlN, and greater than or equal to about 1 wt % Nd₂O₃ and/or less than or equal to about 40 wt % (or v %) SiC or TiC. The ceramic material may comprise AlN, and less than or equal to about 10 wt % Nd₂O₃ and/or greater than or equal to about 5 wt % (or v %) SiC. In an example, the ceramic material comprises AlN, and about 5 wt % Nd₂O₃ and/or about 25 wt % (or v %) SiC or TiC.

Some examples of ceramic material compositions comprising AlN are provided in TABLE 5. Examples of raw materials with amounts/levels, and atomic percentages (including oxygen and carbon atoms) are provided in the same format as in TABLE 4. The first ceramic material constituent in each row in the “Ceramic constituents” column may be considered the primary ceramic material (e.g., AlN), and all other ceramic materials in the row may be considered secondary ceramic materials. The primary ceramic material (e.g., AlN) may form greater than or equal to about 30 wt %, 40 wt %, 50 wt % or 60 wt % of the ceramic material for the compositions listed in TABLE 5 (e.g., the primary ceramic material may form greater than about 30 wt %, 40 wt %, 50 wt % or 60 wt % of the final ceramic material). Further details regarding the format of TABLE 5 are provided in relation to TABLE 4 and accompanying description. A discussion of crystal structures is provided below.

TABLE 5
EXAMPLES OF CERAMIC MATERIAL COMPOSITIONS

| | | Atomic percentages |
|---|---|---|
| # | Ceramic Constituents (wt %) | examples/ranges |
| 1 | AlN (e.g., ≤~97 wt %, ≥~30 | Al: ≤~49.3%, ≥~25% |
| | wt %, ≥~50 wt %) | N: ≤~49.3%, ≥~25% |
| | Y₂O₃ (e.g., ≥~3 wt %) | Y: ≥~0.6% |
| | | O: ≥~0.8% |
| 2 | AlN (e.g., ≤~97 wt %, ≥30 | Al: ≤~49.5%, ≥~25% |
| | wt %, ≥50 wt %) | N: ≤~49.5%, ≥~25% |
| | Nd₂O₃ (e.g., ≥~3 wt %) | Nd: ≥~0.4% |
| | | O: ≥~0.6% |
| 3 | AlN (e.g., ≤~95 wt %, ≥~30 | Al: ≤~47.4%, ≥~20% |
| | wt %, ≥~50 wt %) | N: ≤~47.4%, ≥~20% |
| | SiC (e.g., ≥~5 wt %) | Si: ≥~2.6% |
| | | C: ≥~2.6% |
| 4 | AlN (e.g., ≤~95 wt %, ≥~30 | Al: ≤~48.3%, ≥~20% |
| | wt %, ≥~50 wt %) | N: ≤~48.3%, ≥~20% |
| | TiC (e.g., ≥~5 wt %) | Ti: ≥~1.7% |
| | | C: ≥~1.7% |
| 5 | AlN (e.g., ≤~72 wt %, ≥~30 | Al: ≤~36.4%, ≥~20% |
| | wt %, ≥~50 wt %) | N: ≤~36.4%, ≥~20% |
| | Y₂O₃ (e.g., ≥~3 wt %) | Y: ≥~0.6% |
| | SiC (e.g., ≥~25 wt %) | O: ≥~0.8% |
| | | Si: ≥~12.9% |
| | | C: ≥~12.9% |
| 6 | AlN (e.g., ≤~87 wt %, ≥~30 | Al: ≤~44.1%, ≥~20% |
| | wt %, ≥~50 wt %) | N: ≤~44.1%, ≥~20% |
| | Y₂O₃ (e.g., ≥~3 wt %) | Y: ≥~0.6% |
| | SiC (e.g., ≥~10 wt %) | O: ≥~0.8% |
| | | Si: ≥~5.2% |
| | | C: ≥~5.2% |
| 7 | AlN (e.g., ≤~82 wt %, ≥~30 | Al: ≤~41.5%, ≥~20% |
| | wt %, ≥~50 wt %) | N: ≤~41.5%, ≥~20% |
| | Y₂O₃ (e.g., ≥~3 wt %) | Y: ≥~0.6% |
| | SiC (e.g., ≥~15 wt %) | O: ≥~0.8% |
| | | Si: ≥~7.8% |
| | | C: ≥~7.8% |
| 8 | AlN (e.g., ≤~77 wt %, ≥~30 | Al: ≤~39.0%, ≥~20% |
| | wt %, ≥~50 wt %) | N: ≤~39.0%, ≥~20% |
| | Y₂O₃ (e.g., ≥~3 wt %) | Y: ≥~0.6% |
| | SiC (e.g., ≥~20 wt %) | O: ≥~0.8% |
| | | Si: ≥~10.3% |
| | | C: ≥~10.3% |
| 9 | AlN (e.g., ≤~70 wt %, ≥~30 | Al: ≤~36.9%, ≥~20% |
| | wt %, ≥~50 wt %) | N: ≤~36.9%, ≥~20% |
| | Y₂O₃ (e.g., ≥~10 wt %) | Y: ≥~1.9% |
| | SiC (e.g., ≥~20 wt %) | O: ≥~2.9% |
| | | Si: ≥~10.8% |
| | | C: ≥~10.8% |
| 10 | AlN (e.g., ≤~91 wt %, ≥~30 | Al: ≤~46.6%, ≥~20% |
| | wt %, ≥~50 wt %) | N: ≤~46.2%, ≥~20% |
| | Al₂O₃ (e.g., ≤~1 wt %) | Y: ≥~0.6% |
| | Y₂O₃ (e.g., ≥~3 wt %) | O: ≥~1.4% |
| | SiC (e.g., ≥~5 wt %) | Si: ≥~2.6% |
| | | C: ≥~2.6% |
| 11 | AlN (e.g., ≤~89 wt %, ≥~30 | Al: ≤~45.6%, ≥~20% |
| | wt %, ≥~50 wt %) | N: ≤~45.2%, ≥~20% |
| | Al₂O₃ (e.g., ≤~1 wt %) | Y: ≥~0.6% |
| | Y₂O₃ (e.g., ≥~3 wt %) | O: ≥~1.4% |
| | SiC (e.g., ≥~7 wt %) | Si: ≥~3.6% |
| | | C: ≥~3.6% |
| 12 | AlN (e.g., ≤~86 wt %, ≥~30 | Al: ≤~44.0%, ≥~20% |
| | wt %, ≥~50 wt %) | N: ≤~43.6%, ≥~20% |
| | Al₂O₃ (e.g., ≤~1 wt %) | Y: ≥~0.6% |
| | Y₂O₃ (e.g., ≥~3 wt %) | O: ≥~1.4% |
| | SiC (e.g., ≥~10 wt %) | Si: ≥~5.2% |
| | | C: ≥~5.2% |
| 13 | AlN (e.g., ≤~76 wt %, ≥~30 | Al: ≤~38.9%, ≥~20% |
| | wt %, ≥~50 wt %) | N: ≤~38.5%, ≥~20% |
| | Al₂O₃ (e.g., ≤~1 wt %) | Y: ≥~0.6% |
| | Y₂O₃ (e.g., ≥~3 wt %) | O: ≥~1.4% |
| | SiC (e.g., ≥~20 wt %) | Si: ≥~10.3% |
| | | C: ≥~10.3% |
| 14 | AlN (e.g., ≤~94 wt %, ≥~30 | Al: ≤~48.8%, ≥~25% |
| | wt %, ≥~50 wt %) | N: ≤~48.8%, ≥~25% |
| | Y₂O₃ (e.g., ≥~3 wt %) | Y: ≥~0.6% |
| | Nd₂O₃ (e.g., ≥~3 wt %) | Nd: ≥~0.4% |
| | | O: ≥~1.4% |
| 15 | AlN (e.g., ≤~85 wt %, ≥~30 | Al: ≤~47.6%, ≥~25% |
| | wt %, ≥~50 wt %) | N: ≤~47.6%, ≥~25% |
| | Y₂O₃ (e.g., ≥~3 wt %) | Y: ≥~0.6% |
| | Nd₂O₃ (e.g., ≥~10 wt %) | Nd: ≥~1.3% |
| | | O: ≥~2.9% |
| 16 | AlN (e.g., ≤~92 wt %, ≥~30 | Al: ≤~46.9%, ≥~20% |
| | wt %, ≥~50 wt %) | N: ≤~46.9%, ≥~20% |
| | Nd₂O₃ (e.g., ≥~3 wt %) | Nd: ≥~0.4% |
| | SiC (e.g., ≥~5 wt %) | O: ≥~0.6% |
| | | Si: ≥~2.6% |
| | | C: ≥~2.6% |
| 17 | AlN (e.g., ≤~87 wt %, ≥~30 | Al: ≤~44.3%, ≥~20% |
| | wt %, ≥~50 wt %) | N: ≤~44.3%, ≥~20% |
| | Nd₂O₃ (e.g., ≥~3 wt %) | Nd: ≥~0.4% |
| | SiC (e.g., ≥~10 wt %) | O: ≥~0.6% |
| | | Si: ≥~5.2% |
| | | C: ≥~5.2% |
| 18 | AlN (e.g., ≤~72 wt %, ≥~30 | Al: ≤~36.6%, ≥~20% |
| | wt %, ≥~50 wt %) | N: ≤~36.6%, ≥~20% |
| | Nd₂O₃ (e.g., ≥~3 wt %) | Nd: ≥~0.4% |
| | SiC (e.g., ≥~25 wt %) | O: ≥~0.6% |
| | | Si: ≥~13.0% |
| | | C: ≥~13.0% |
| 19 | AlN (e.g., ≤~80 wt %, ≥~30 | Al: ≤~42.9%, ≥~20% |
| | wt %, ≥~50 wt %) | N: ≤~42.9%, ≥~20% |
| | Nd₂O₃ (e.g., ≥~10 wt %) | Nd: ≥~1.3% |
| | SiC (e.g., ≥~10 wt %) | O: ≥~2.0% |
| | | Si: ≥~5.5% |
| | | C: ≥~5.5% |
| 20 | AlN (e.g., ≤~70 wt %, ≥~30 | Al: ≤~40.6%, ≥~20% |
| | wt %, ≥~50 wt %) | N: ≤~40.6%, ≥~20% |
| | Nd₂O₃ (e.g., ≥~20 wt %) | Nd: ≥~2.6% |
| | SiC (e.g., ≥~10 wt %) | O: ≥~4.2% |
| | | Si: ≥~5.9% |
| | | C: ≥~5.9% |
| 21 | AlN (e.g., ≤~87 wt %, ≥~30 | Al: ≤~45.8%, ≥~20% |
| | wt %, ≥~50 wt %) | N: ≤~45.8%, ≥~20% |
| | Y₂O₃ (e.g., ≥~3 wt %) | Y: ≥~0.6% |
| | Nd₂O₃ (e.g., ≥~5 wt %) | Nd: ≥~0.6% |
| | SiC (e.g., ≥~5 wt %) | O: ≥~1.8% |
| | | Si: ≥~2.7% |
| | | C: ≥~2.7% |
| 22 | AlN (e.g., ≤~77 wt %, ≥~30 | Al: ≤~42.0%, ≥~20% |
| | wt %, ≥~50 wt %) | N: ≤~42.0%, ≥~20% |
| | Y₂O₃ (e.g., ≥~3 wt %) | Y: ≥~0.6% |
| | Nd₂O₃ (e.g., ≥~10 wt %) | Nd: ≥~1.3% |
| | SiC (e.g., ≥~10 wt %) | O: ≥~2.9% |
| | | Si: ≥~5.4% |
| | | C: ≥~5.4% |
| 23 | AlN (e.g., ≤~92 wt %, ≥~30 | Al: ≤~47.5%, ≥~20% |
| | wt %, ≥~50 wt %) | N: ≤~47.5%, ≥~20% |
| | Y₂O₃ (e.g., ≥~3 wt %) | Y: ≥~0.6% |
| | TiC (e.g., ≥~5 wt %) | O: ≥~0.8% |
| | | Ti: ≥~1.8% |
| | | C: ≥~1.8% |
| 24 | AlN (e.g., ≤~92 wt %, ≥~30 | Al: ≤~47.7%, ≥~20% |
| | wt %, ≥~50 wt %) | N: ≤~47.7%, ≥~20% |
| | Nd₂O₃ (e.g., ≥~3 wt %) | Nd: ≥~0.4% |
| | TiC (e.g., ≥~5 wt %) | O: ≥~0.6% |
| | | Ti: ≥~1.8% |
| | | C: ≥~1.8% |
| 25 | AlN (e.g., ≤~87 wt %, ≥~30 | Al: ≤~46.6%, ≥~20% |
| | wt %, ≥~50 wt %) | N: ≤~46.6%, ≥~20% |
| | Y₂O₃ (e.g., ≥~3 wt %) | Y: ≥~0.6% |
| | Nd₂O₃ (e.g., ≥~5 wt %) | Nd: ≥~0.7% |
| | TiC (e.g., ≥~5 wt %) | O: ≥~1.9% |
| | | Ti: ≥~1.8% |
| | | C: ≥~1.8% |
| 26 | AlN (e.g., ≤~73 wt %, ≥~30 | Al: ≤~41.5%, ≥~20% |
| | wt %, ≥~50 wt %) | N: ≤~41.5%, ≥~20% |
| | Y₂O₃ (e.g., ≥~3 wt %) | Y: ≥~0.6% |
| | Nd₂O₃ (e.g., ≥~10 wt %) | Nd: ≥~1.4% |
| | TiC (e.g., ≥~15 wt %) | O: ≥~3.1% |
| | | Ti: ≥~5.9% |
| | | C: ≥~5.9% |
| 27 | AlN (e.g., ≤~92 wt %, ≥30 | Al: ≤~47.7%, ≥~20% |
| | wt %, ≥50 wt %) | N: ≤~47.7%, ≥~20% |
| | Nd₂O₃ (e.g., ≥~3 wt %) | Nd: ≥~0.4% |
| | TiC (e.g., ≥~5 wt %) | O: ≥~0.6% |
| | | Ti: ≥~1.8% |
| | | C: ≥~1.8% |
| 28 | AlN (e.g., ≤~87 wt %, ≥30 | Al: ≤~45.9%, ≥~20% |
| | wt %, ≥50 wt %) | N: ≤~45.9%, ≥~20% |
| | Nd₂O₃ (e.g., ≥~3 wt %) | Nd: ≥~0.4% |
| | TiC (e.g., ≥~10 wt %) | O: ≥~0.6% |
| | | Ti: ≥~3.6% |
| | | C: ≥~3.6% |

The crystal structure of ceramic materials with AlN as the primary ceramic component may include one or more crystal structures based on the compounds used to fabricate the ceramic material (e.g., ceramic constituents), as well as phases that may form based on interactions between the various ceramic constituents. Ceramic compositions comprising AlN and Y₂O₃ may comprise, for example, hexagonal (e.g., wurtzite) AlN and/or cubic or monoclinic Y₂O₃. In some cases, trace amounts of trigonal Al₂O₃ may be present due to residual amounts on the surface of AlN used to fabricate sintered ceramic materials, resulting in additional yttria-alumina phases such as, for example, orthorhombic YAP (YAlO₃), cubic YAG (Y₃Al₅O₁₂) and/or monoclinic YAM (Y₄Al₂O₉). Ceramic compositions comprising AlN and Nd₂O₃ may comprise, for example, hexagonal AlN, hexagonal or monoclinic Nd₂O₃ and/or tetragonal Nd₂AlNO₃. In some cases, AlN used to fabricate ceramics may also contain small amounts of Al₂O₃, which may cause ceramics fabricated from AlN and Nd₂O₃ to form an additional rhombohedral Nd(AlO₃) crystal structure. Ceramic compositions comprising SiC and/or TiC secondary ceramic components (e.g., other ceramic compositions comprising SiC and/or TiC secondary ceramic components) may (e.g., also) include, for example, hexagonal SiC and/or cubic TiC crystal structures. SiC or TiC may also react with Nd₂O₃ to form SiO₂, TiO₂ and/or NdC₂. In an example, the ceramic material may comprise AlN (e.g., greater than about 30 wt % AlN), at least about 5 vol % or 20 vol % SiC, and at least about 5 wt % Nd₂AlNO₃. The Nd₂AlNO₃ may be formed, for example, as a result of reaction of AlN with Nd₂O₃. Such a composition of crystal structures/phases (or at least a subset thereof) may result from sintering and/or may be used as a raw material.

In an example, the ceramic material may comprise less than or equal to about 72 wt % and greater than about 50 wt % AlN, greater than or equal to about 3 wt % Y₂O₃, and greater than or equal to about 25 wt % SiC. In this example, the ceramic material may comprise less than or equal to about 36.4 at % Al and/or greater than about 15 at % Al, less than or equal to about 36.4 at % N and/or greater than about 20 at % N, greater than or equal to about 0.6 at % Y, greater than or equal to about 0.8 at % O, greater than or equal to about 12.9 at % Si, and greater than or equal to about 12.9 at % C. The ceramic material may comprise hexagonal AlN, orthorhombic YAP, cubic YAG, monoclinic YAM, monoclinic Y₂O₃ and/or hexagonal SiC.

In another example, the ceramic material may comprise less than or equal to about 72 wt % and greater than about 50 wt % AlN, greater than or equal to about 3 wt % Nd₂O₃, and greater than or equal to about 25 wt % SiC. In this example, the ceramic material may comprise less than or equal to about 36.6 at % Al and/or greater than about 20 at % Al, less than or equal to about 36.6 at % N and/or greater than about 20 at % N, greater than or equal to about 0.4 at % Nd, greater than or equal to about 0.6 at % O, greater than or equal to about 13.0 at % Si, and greater than or equal to about 13.0 at % C. The ceramic material may comprise hexagonal AlN, hexagonal or monoclinic Nd₂O₃, Nd₂AlNO₃ and/or hexagonal SiC.

In yet another example, the ceramic material may comprise less than or equal to about 92 wt % and greater than about 50 wt % AlN, greater than or equal to about 3 wt % Nd₂—O₃, and greater than or equal to about 5 wt % TiC. In this example, the ceramic material may comprise less than or equal to about 47.7 at % Al and/or greater than about 20 at % Al, less than or equal to about 47.7 at % N and/or greater than about 20 at % N, greater than or equal to about 0.4 at % Nd, greater than or equal to about 0.6 at % O, greater than or equal to about 1.8 at % Ti, and greater than or equal to about 1.8 at % C. The ceramic material may comprise hexagonal AlN, hexagonal or monoclinic Nd₂O₃, Nd₂AlNO₃ and/or cubic TiC.

The primary and/or secondary ceramic material may comprise grains of ceramic material(s) (e.g., neodymium oxide, aluminum nitride, silicon carbide, silicon nitride, magnesium oxide, zirconium oxide or yttrium oxide) that are less than or equal to about 0.01 micrometers (μm), 0.05 μm, 0.1 μm, 0.2 μm, 0.5 μm, 1 μm, 2 μm, 3 μm, 4 μm, 5 μm, 6 μm, 7 μm, 8 μm, 9 μm, 10 μm, 15 μm, 20 μm, 30 μm, 40 μm, 50 μm, 60 μm, 70 μm, 80 μm, 90 μm, 100 μm, 150 μm, 200 μm, 400 μm, 500 μm or 1,000 μm in size. The primary and/or secondary ceramic material may comprise grains of ceramic material(s) that are greater than about 0.1 μm, 0.2 μm, 0.5 μm, 1 μm, 2 μm, 3 μm, 4 μm, 5 μm, 6 μm, 7 μm, 8 μm, 9 μm, 10 μm, 15 μm, 20 μm, 30 μm, 40 μm, 50 μm, 60 μm, 70 μm, 80 μm, 90 μm, 100 μm, 150 μm, 200 μm, 400 μm, 500 μm or 1,000 μm in size. The primary and/or secondary ceramic material may comprise grains of ceramic material(s) between about 0.1 μm and 5 μm, 1 μm and 5 μm, 2 μm and 4 μm, 2 μm and 10 μm, 10 μm and 40 μm, 20 μm and 100 μm, 100 μm and 500 μm, 0.1 μm and 1,000 μm, or 1 μm and 1000 μm in size. Grain size may refer to diameter, length, width or any other dimension of a grain (e.g., grains may be less than about 1 μm in size).

After densifying the ceramic though one or more processes (e.g., sinter, HIP process, hot press process, or sinter and HIP process), the ceramic may comprise grains of the primary and/or secondary ceramic material(s) that have an atomic configuration (e.g., crystal structure) consistent with a phase that is the most thermodynamically stable phase at room temperature. After densifying the ceramic though one or more processes (e.g., HIP, hot press process, or sinter and HIP process), the ceramic may comprise grains or portions of grains of the primary and/or secondary ceramic material(s) that have an atomic configuration (e.g., crystal structure) consistent with a phase that is different than the most thermodynamically stable phase at room temperature. For example, the combination of materials (composition) and densification process may result in a ceramic material that comprises grains or portions of grains of the primary or secondary ceramic material in a phase (e.g., crystal structure) that is different than the phase that is most thermodynamically stable at room temperature. The ceramic may comprise one or more phases of the primary and/or secondary ceramic material(s) (e.g., for each primary or secondary ceramic material, the ceramic material may comprise the most thermodynamically stable phase and/or one or more phases different from the most thermodynamically stable phase).

The phase that is different than the most thermodynamically stable phase at room temperature may in some cases correspond to a given phase (e.g., the most thermodynamically stable phase) at a temperature other than the room temperature (e.g., at a higher temperature). Such a phase may be stabilized using suitable composition and process. For example, a higher temperature Nd₂O₃ phase may be stabilized in a monoclinic Nd₂O₃ crystal structure. In some examples, stabilizing a crystal structure that is not the most thermodynamically stable crystal structure at room temperature may improve the stability of the ceramic material (e.g., improve its chemical stability against corrosion from water or moist air, improve its stability with reactive material, improve its stability in air at high temperature and in moist air at room temperature, etc.). For example, the crystal structure of Nd₂O₃ that is the most thermodynamically stable at room temperature may be the hexagonal crystal structure. At suitable composition and densification condition, a ceramic comprising Nd₂O₃ and other secondary ceramic materials (e.g., Y₂O₃ and/or SiC) may result in a ceramic material comprising Nd₂O₃ grains that are configured in a monoclinic crystal structure (e.g., yttria stabilized neodymia). In some examples, a ceramic material comprising Nd₂O₃ grains in the monoclinic crystal structure may be more stable in the presence of air, moist air and/or water (e.g., may not crumble in air at room temperature due to moisture).

Primary and/or secondary material(s) with such grain size(s) may be provided in one or more ceramic materials of the disclosure. For example, the ceramic material of the seal can comprise Nd₂O₃, and greater than about 5 wt % AlN, with grains that are about 2 μm to 4 μm in size. The primary ceramic material may have a different grain size than one or more of the secondary materials. The grain size (e.g., diameter, radius, thickness, width, length or another characteristic grain dimension) may refer to a grain size of the primary or secondary material(s) individually (e.g., the size of atomically aligned regions of the ceramic). Ceramic materials comprising grains may in some cases be compacted (e.g., pressed). Morphology and/or particle size distribution of the primary and/or secondary ceramic material may be modified using, for example, high energy milling and/or different mixing/milling methods (e.g., ball milling, high energy grinding/milling, attrition milling, planetary mixing or centrifugal mixing).

CTE-matching characteristics may depend on composition (e.g., identity and amount of primary and secondary material(s)), morphology (e.g., grain size and distribution of each of primary and secondary material(s)) and/or other factors (e.g., mechanical processing, casting or shaping/forming). In an example, a ceramic material comprising Nd₂O₃, and greater than or equal to about 5 wt % AlN, with about 2 micrometer to 4 micrometer grain size, may have a CTE that is substantially similar or nearly identical to 430 SS, 18CrCb ferritic stainless steel and/or 441 stainless steel. In another example, a ceramic material comprising Nd₂O₃, and greater than or equal to about 3 wt % Y₂O₃ and/or greater than or equal to about 5 wt % SiC or TiC, with about 0.01 micrometer to 20 micrometer grain size, may have a CTE that is substantially similar or nearly identical to a Ni alloy (e.g., alloy 42 or alloy 52) or a stainless steel (e.g., 430 stainless steel, 18CrCb ferritic stainless steel or 441 stainless steel).

Examples of primary ceramic materials and/or secondary ceramic materials may include any ceramic material described herein, such as, for example, aluminum nitride (AlN), beryllium nitride (Be₃N₂), boron nitride (BN), calcium nitride (Ca₃N₂), silicon nitride (Si₃N₄), aluminum oxide (Al₂O₃), beryllium oxide (BeO), calcium oxide (CaO), cerium oxide (Ce₂O₃), erbium oxide (Er₂O₃), lanthanum oxide (La₂O₃), magnesium oxide (MgO), neodymium oxide (Nd₂O₃), samarium oxide (Sm₂O₃), scandium oxide (Sc₂O₃), ytterbium oxide (Yb₂O₃), yttrium oxide (Y₂O₃), zirconium oxide (ZrO₂), yttria partially stabilized zirconia (YPSZ), boron carbide (B₄C), silicon carbide (SiC), titanium carbide (TIC), zirconium carbide (ZrC), titanium diboride (TiB₂), chalcogenides, quartz, glass, or any combination thereof.

The ceramic material (e.g., one or more ceramic materials comprising Nd₂O₃, such as, for example, listed in TABLE 4) may retain mechanical strength after exposure to air at a temperature of at least about 20 °C, 100 °C, 200 °C, 300 °C, 400 °C, 500 °C, 600 °C, 700 °C, 800 °C or 900 °C (e.g., at an operating temperature of a high temperature reactive material device) for at least about 1 hour (h), 5 h, 10 h, 1 day, 2 days, 3 days, 4 days, 100 h, 5 days, 7 days, 10 days, 2 weeks, 1 month, 2 months, 6 months, 9 months, 1 year, 2 years, 3 years, 4 years, 5 years, 10 years or more. The ceramic material (e.g., one or more ceramic materials comprising Nd₂O₃, such as, for example, listed in TABLE 4) may retain mechanical strength after being submerged in a reactive material (e.g., lithium metal-saturated molten LiCl—LiBr—LiF salts) at a temperature of at least about 20 °C, 100 °C, 200 °C, 300 °C, 400 °C, 500 °C, 600 °C, 700 °C, 800 °C or 900 °C. (e.g., at an operating temperature of a high temperature reactive material device) for at least about 1 minute, 5 minutes, 10 minutes, 20 minutes, 30 minutes, 1 h, 2 h, 3 h, 4 h, 5 h, 6 h, 7 h, 8 h, 9 h, 10 h, 1 day, 2 days, 3 days, 4 days, 5 days, 7 days, 10 days, 2 weeks, 1 month, 2 months, 6 months, 9 months, 1 year, 2 years, 3 years, 4 years, 5 years or more. The ceramic material (e.g., one or more ceramic materials comprising Nd₂O₃, such as, for example, listed in TABLE 4) may retain mechanical strength after being submerged in water at a temperature of at least about 25 °C, 40 °C, 50 °C, 60 °C, 70 °C, 80 °C, 90 °C or 100 °C for at least about 1 h, 5 h, 10 h, 1 day, 2 days, 3 days, 4 days, 100 h, 5 days, 7 days, 10 days, 2 weeks, 1 month, 2 months, 6 months, 9 months, 1 year, 2 years, 3 years, 4 years, 5 years, 10 years or more. Mechanical strength may be retained, for example, to within about 1%, 2%, 5%, 10%, 20%, 30%, 40% or 50% of initial value.

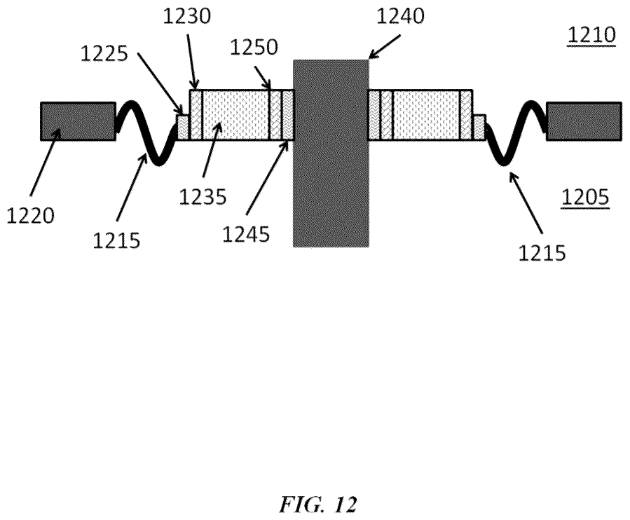

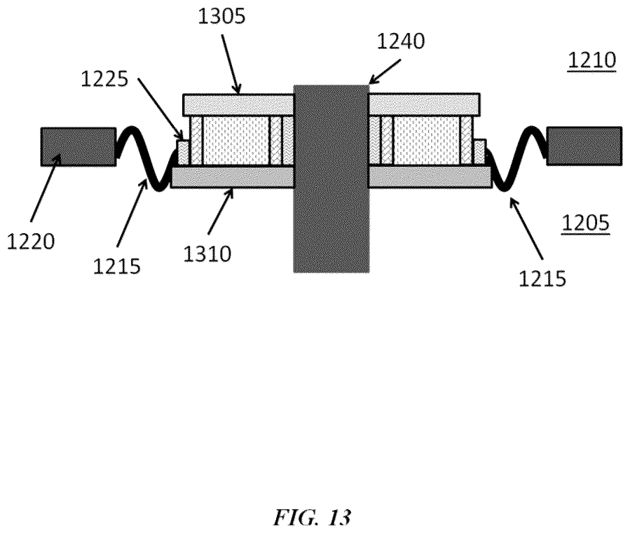

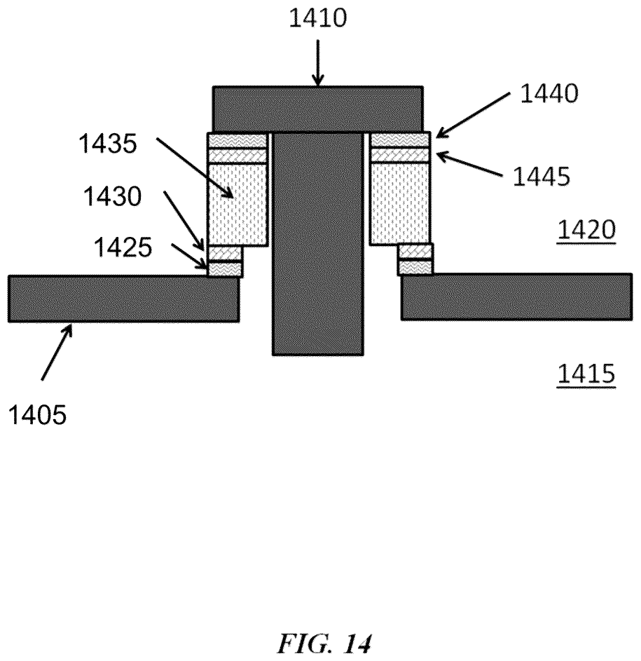

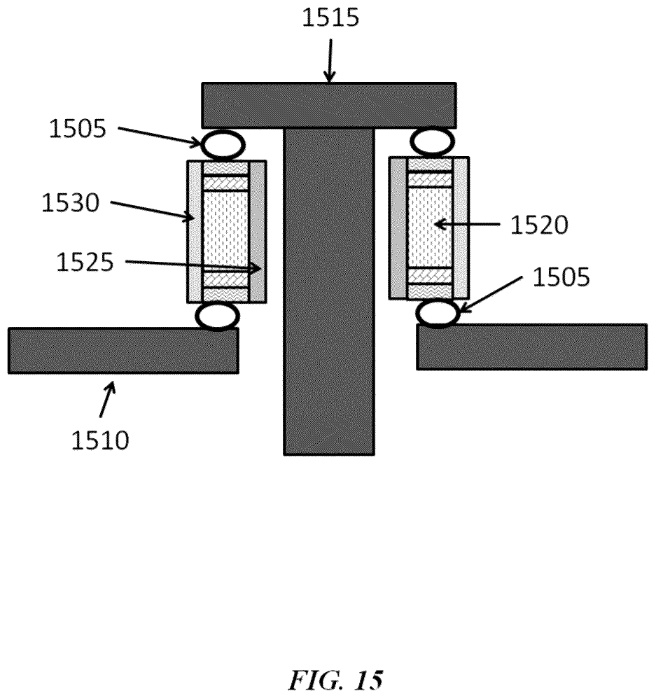

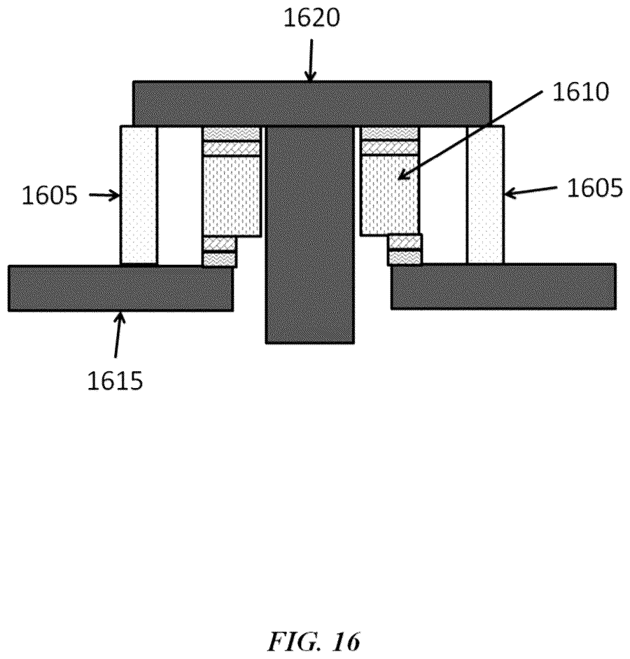

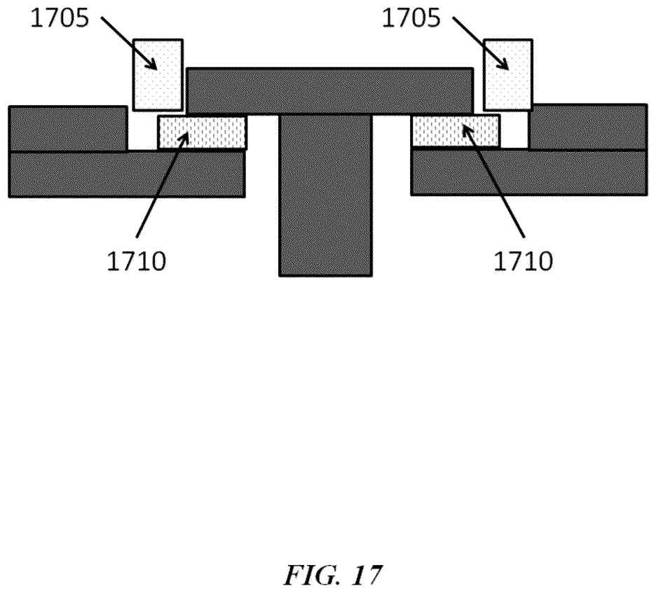

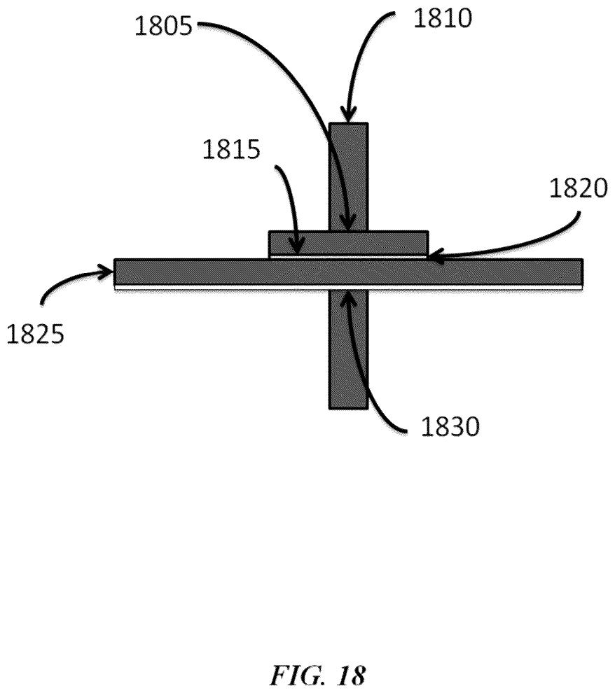

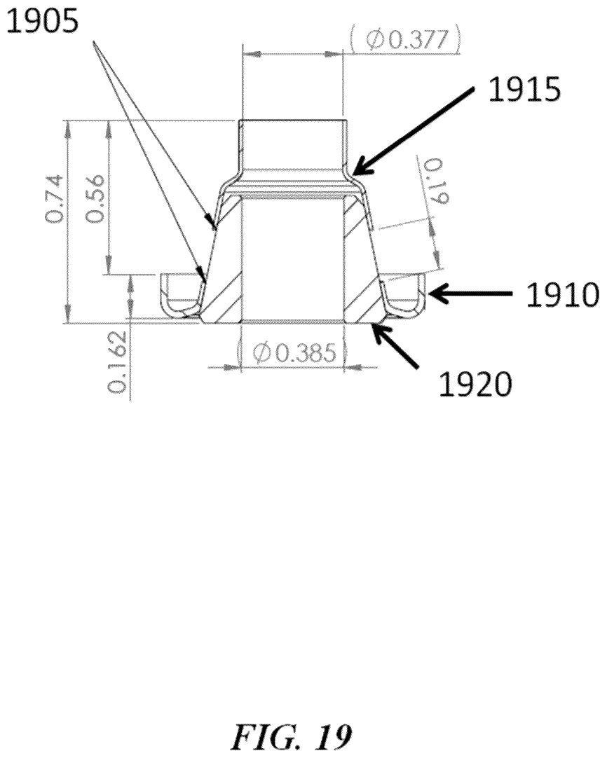

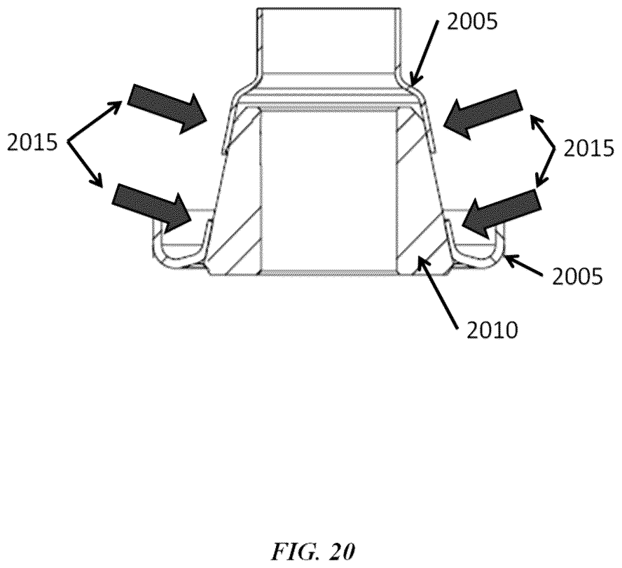

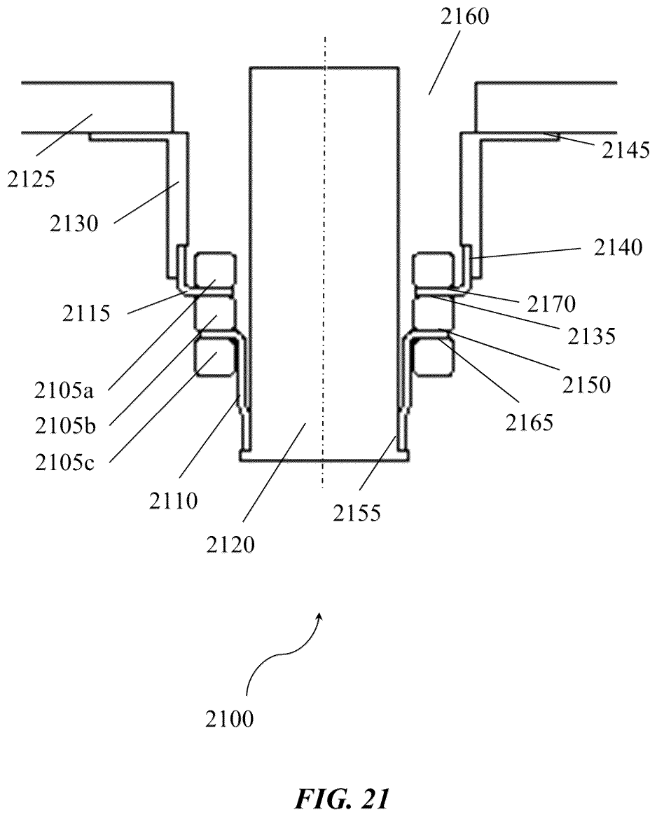

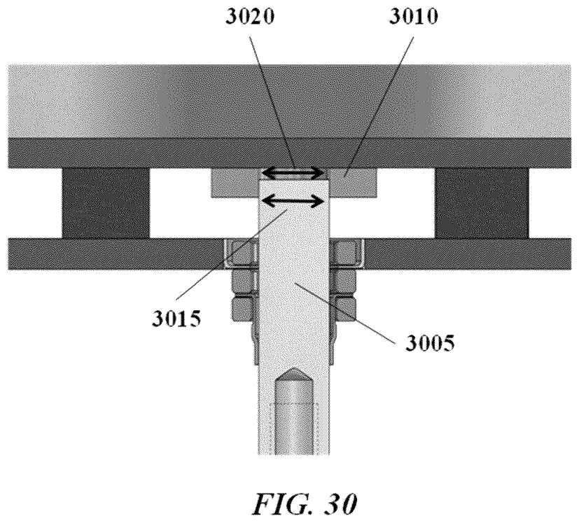

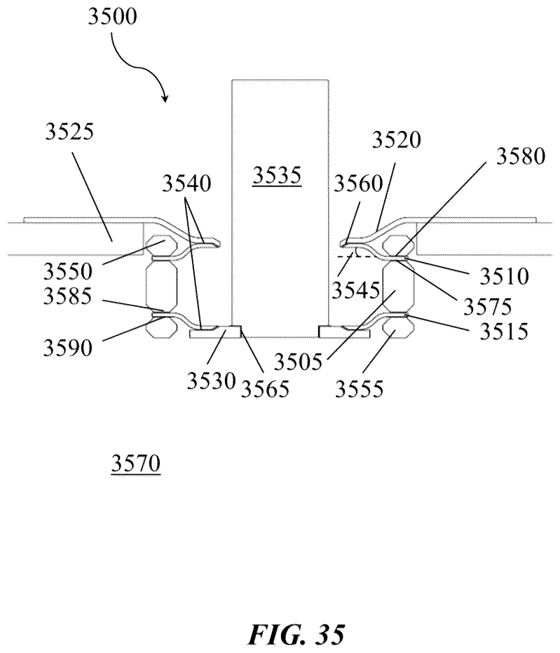

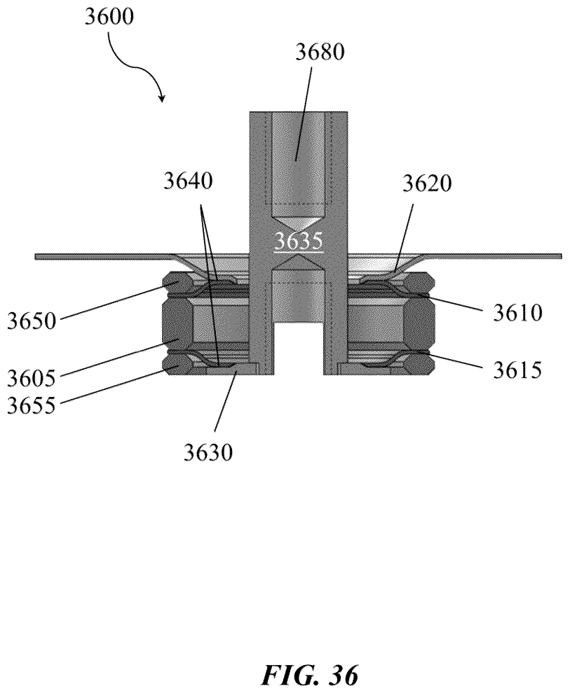

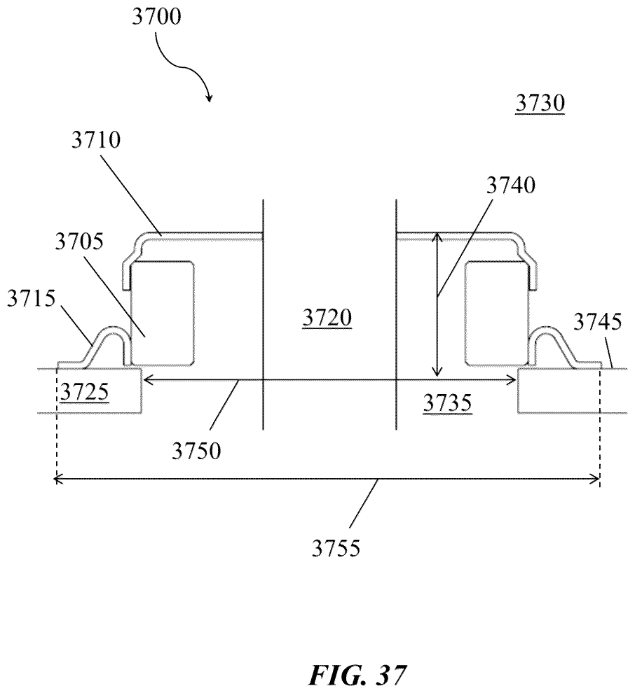

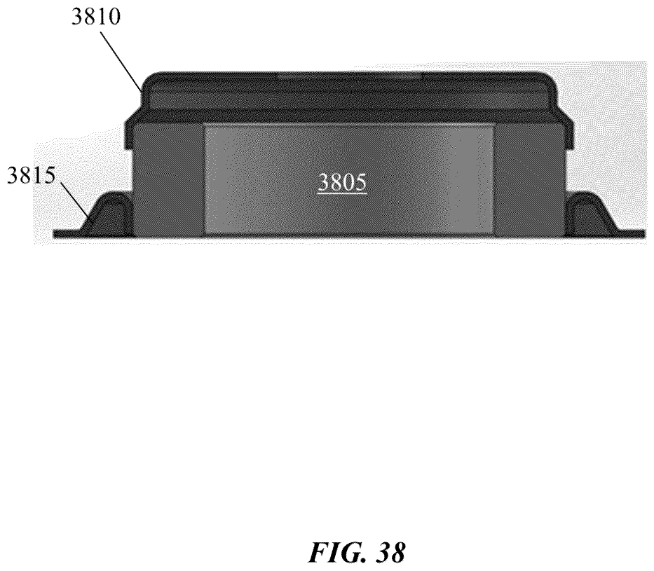

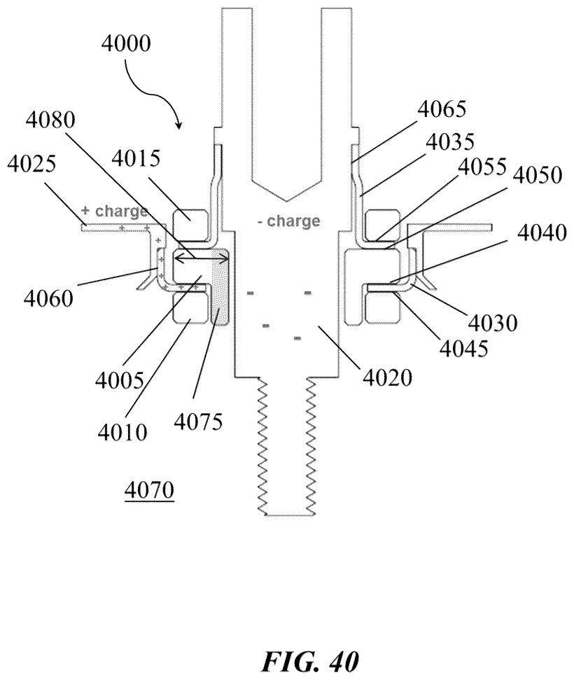

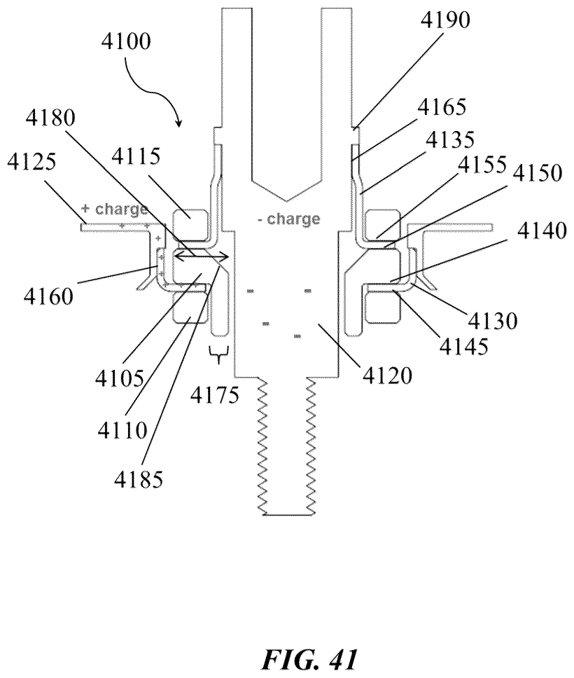

While such ceramic materials may be described herein primarily in the context of seals (e.g., the ceramic materials described in the context of TABLE 4 and TABLE 5 may be used, for example in seals of FIG. 12, FIG. 13, FIG. 14, FIG. 15, FIG. 16, FIG. 17, FIG. 18, FIG. 19, FIG. 20, FIG. 21, FIG. 30, FIG. 35, FIG. 36, FIG. 37, FIG. 38, FIG. 40 and/or FIG. 41), the ceramic materials can be used in other applications. Such applications may be as described elsewhere herein (e.g., in relation to reactor vessel linings). Examples of applications may include applications that utilize or depend on one or more characteristics or properties of such ceramic materials (e.g., strength, air stability, corrosion resistance and/or other characteristics/properties described herein). In an example, stronger ceramic materials (e.g., ceramic materials comprising AlN, such as, for example, AlN+Nd₂O₃+SiC or AlN+Nd₂O₃+TiC) may be used in bullet-proof vests. In another example, a ceramic material (e.g., AlN+3 wt % Y₂O₃ and at least about 25 vol % SiC, or AlN+ at least about 3 wt % Nd₂O₃+ at least about 5 vol % or 20 vol % SiC) may be used in a device that protects against ballistic penetration, such as, for example, ballistic armor.

The braze can be a passive braze or an active braze. Passive brazes can melt and wet a ceramic material or wet a ceramic material that has a metallization layer deposited onto it. Copper and silver are examples of passive brazes. Active brazes can react with the ceramic (e.g., chemically reduce the metal component of the ceramic (e.g., Al is reduced from AlN)). In some cases, active brazes can comprise a metal alloy having an active metal species such as titanium (Ti) or zirconium (Zr) that reacts with the ceramic material (e.g., AlN+Ti→Al+TiN or AlN+Zr→Al+ZrN). The active braze can further comprise one or more passive components (e.g., Ni). The passive component(s) can, for example, reduce the melting point of the braze and/or improve the chemical stability of the braze. In some cases, the active metal braze beads up on the ceramic and/or does not wet the ceramic.

The seal can hermetically seal the electrochemical cell. In some cases, the seal is inert to an atmosphere in contact with the electrochemical cell. The atmosphere in contact with the electrochemical cell can comprise oxygen (O₂), nitrogen (N₂), water (H₂O), or a combination thereof. In some cases, the ceramic material, metal sleeve or collar material, and/or the braze material are coated to provide resistance to the atmosphere (e.g., air stability) in contact with the electrochemical cell. For example, the coating can comprise silicon dioxide (SiO₂), yttrium oxide (Y₂O₃), aluminum oxide (Al₂O₃), phosphate glass (e.g., P₂O₅), aluminophosphate glass (e.g., AlPO₄, doped AlPO₄, AlPO₄ comprising small (e.g., nanoscale/nanometer scale) carbon particles (e.g., encapsulated within the aluminophosphate glass), aluminophosphate comprising Al—O—Al bonds, amorphous aluminophosphate glass that resists crystallization above at least 800 °C), or any combination thereof. In some cases, the coating may form a transparent thin film.

The seal can be at least partially inert to metal vapors and molten salts. In some cases, the metal vapors comprise lithium, sodium, potassium, magnesium, calcium, or any combination thereof. The ceramic material and/or the braze material can be coated to provide resistance to the metal vapors and metal salts. For example, the coating can be yttrium oxide (Y₂O₃), erbium oxide (Er₂O₃), boron nitride (BN), aluminum nitride (AlN), silicon nitride (Si₃N₄), silicon carbide (SiC), or any combination thereof.

In some cases, the coefficients of thermal expansion of the ceramic material and the braze material match the coefficients of thermal expansion of the electrically conductive housing and/or the conductor (e.g., to within about 1%, 5%, 10%, 15%, 20% or 30%). In some cases, a hermetic joint can be formed if the braze is not of a similar CTE compared with the CTE of the ceramic and/or other components or sub-assembly of the seal (e.g., a metal sleeve).

The seal can be welded or brazed to the electrically conductive housing, cell (housing) lid, and/or the conductor. In some cases, the electrically conductive housing and/or the conductor comprises 400-series stainless steel, 300-series stainless steel, nickel, or any combination thereof.

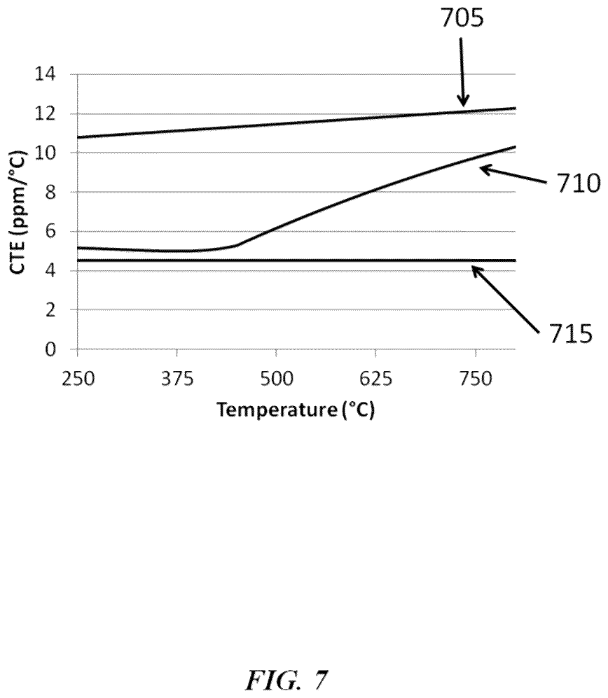

FIG. 7 shows the CTE in units of parts per million (ppm) per °C for various types of steel and an insulating ceramic. The CTE for 430 stainless steel 705 can range approximately linearly from about 10 ppm/° °C to about 12 ppm/° °C between about 250 °C and 800 °C. The CTE for nickel-cobalt ferrous alloy 710 can range non-linearly from about 5 ppm/° °C to about 10 ppm/°C between about 250 °C and 800 °C. The CTE for aluminum nitride ceramic 715 can be relatively constant at about 4.5 ppm/°C between about 250 °C and 800 °C.

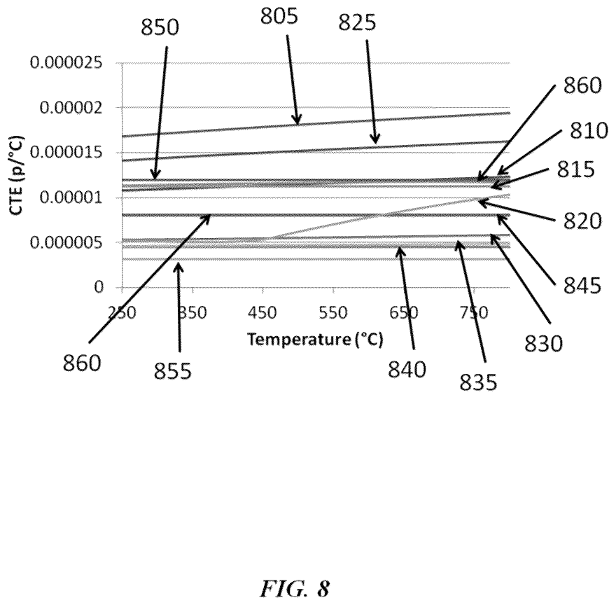

FIG. 8 shows the CTE in units of parts (p) per °C for various types of sleeve or collar materials (e.g., steel), braze materials and insulating ceramics. The sleeve or collar materials can include, for example, 304 stainless steel 805, 430 stainless steel 810, 410 stainless steel 815, and nickel-cobalt ferrous alloy 820. The braze materials can include, for example, nickel-100 825, molybdenum (Mo) 830 and tungsten (W) 835. The ceramic materials can include, for example, aluminum nitride (AlN) 840, aluminum oxide (Al₂O₃) 845, boron nitride (BN) in the direction parallel to the grain orientation 850, boron nitride (BN) in the direction perpendicular to the grain orientation 855, yttrium oxide (Y₂O₃) 860 and yttria partially stabilized zirconia (YPSZ) 865.

The CTE of the seal can match the CTE of the housing and/or conductor to any suitable tolerance. In some cases, the seal electrically isolates the conductor from the electrically conductive housing, where the CTE of the seal is at least about 1%, 5%, 10%, 15%, 20%, 30%, 50%, 60%, 70% or 80% different and/or less than the CTE of the electrically conductive housing and/or the conductor. In some instances, the seal electrically isolates the conductor from the electrically conductive housing, where the CTE of the seal is less than about 1%, 5%, 10%, 15%, 20%, 30%, 50%, 60%, 70% or 80% different and/or less than the CTE of the electrically conductive housing and/or the conductor.

The CTE of the seal can be matched to the conductive housing or the conductor at the operating temperature and/or during start-up of the cell (e.g., starting from non-molten metal electrodes). In some cases, the CTE of the seal is less than about 5%, 10%, 15% or 20% different than the CTE of the electrically conductive housing and/or the conductor at the temperature at which the electrochemical cell is operated. In some instances, the CTE of the seal is less than about 5%, 10%, 15% or 20% different than the CTE of the electrically conductive housing and/or the conductor at all temperatures between about −10 °C and the operating temperature.

The materials comprising the seal (e.g., ceramic insulator, braze alloy, and sleeve/collar) can be chosen to be chemically compatible with (e.g., stable in contact with) the interior and/or exterior environments of the cell.

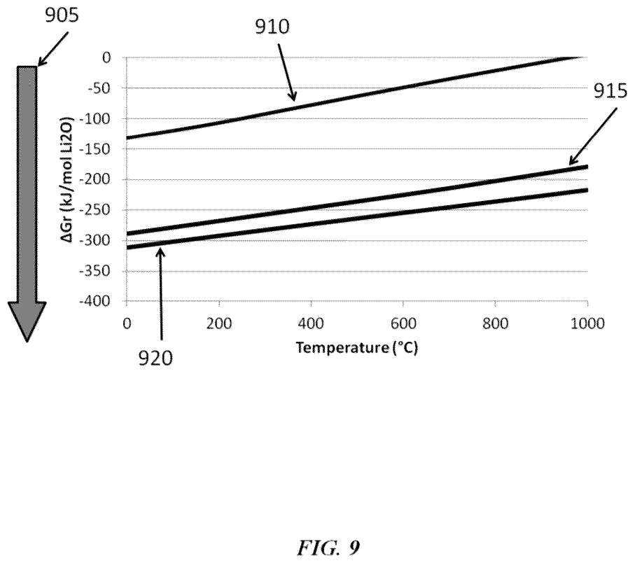

FIG. 9 shows the Gibbs free energy of formation (ΔGᵣ) for various materials at a range of temperatures with negative numbers being more thermodynamically stable 905. Examples include ΔGᵣ curves for lithium nitride (Li₃N) 910, aluminum nitride (AlN) 915 and titanium nitride (TiN) 920. A thermodynamic evaluation of different insulating ceramic materials can indicate that aluminum nitride (an electrically insulating ceramic) can be stable in the presence of lithium (e.g., since the ΔGᵣ per mole of N of AlN is more negative than Li₃N). Also, the ΔGᵣ per mole of N of TiN is more negative than Li₃N and also more negative than AlN. Thus, a titanium-alloy braze can chemically reduce AlN and form TiN (e.g., by the reaction AlN+Ti→TIN+Al), which, in turn, can bond well with the titanium-alloy braze. The reactive material (e.g., reactive metal), ceramic and braze materials can be selected such that the stability (e.g., normalized Gibbs free energy of formation (ΔGᵣ,n), such as, for example, Gibbs free energy of formation of the nitride compounds normalized by the number of nitride atoms in each compound formula) of the reactive metal-, ceramic- and braze-nitride compounds exist in rank order. In an example where nitride compounds are rank-ordered, ΔGᵣ,n of the reactive metal nitride (e.g., Li₃N) is less negative (i.e., more positive) than the ΔGᵣ,n of the ceramic nitride (e.g., AlN) which is less negative than the ΔGᵣ,n of the braze nitride (e.g., TiN). Rank-ordering the materials in this manner may reduce or eliminate a driving force for the rank-ordered compounds to degrade. In some cases, the braze material also comprises materials that show low mutual solubility in the reactive material (e.g., reactive metal or molten salt) and/or do not react with the reactive material (e.g., do not form intermetallic compounds with the reactive metal). Such a selection of materials can ensure thermodynamic stability of the reactive material (e.g., reactive metal), ceramic, and braze material. Additional materials can in some cases be added based on such rank-ordering. For example, a component (e.g., ceramic) can be replaced by two or more components with more suitable rank-ordering characteristics.

In an example, a ΔGᵣ,n (normalized by mole of oxygen) rank-ordered material set includes Y₂O₃ (most stable compound of material set), Nd₂O₃ (intermediate stability compound of material set), and Li₂O (least stable compound of material set). The seal comprises Nd₂O₃ insulating ceramic and an active braze material comprising yttrium, and seals a vessel containing lithium metal/metal vapors.

Nickel-cobalt ferrous alloy, titanium (Ti), nickel (Ni), zirconium (Zr) and 430 stainless steel (430 SS) can be stable in the presence of molten lithium (Li), as indicated, for example, by phase diagrams that show that lithium and the metal components of nickel-cobalt ferrous alloy and 430 SS (e.g., Fe, Ni, Cr, Co) do not form intermetallic compounds with Li and that their respective solubility into (or with) Li is relatively low (e.g., less than about 1 mol-%). Titanium-alloy braze can bond to ferrous alloys, such as, for example, nickel-cobalt ferrous alloy and/or 430 SS. In some cases, AlN, titanium-alloys, and nickel-cobalt ferrous alloy/430 SS are all stable in the presence of air at elevated temperatures. Thus, in an example, the method for choosing seal materials described herein shows that a seal comprising an insulating ceramic that comprises AlN, a braze that comprises Ti-alloy, and a sleeve or collar that comprises one or more of a nickel-cobalt ferrous alloy, 430 SS and zirconium forms a suitable seal material set. Another example of a suitable seal material set based on the process described herein includes an Nd₂O₃ ceramic, a braze and/or pre-metallization layer(s) comprising yttrium and nickel, and a sleeve or collar that comprises one or more of a nickel-cobalt ferrous alloy and 430 SS.

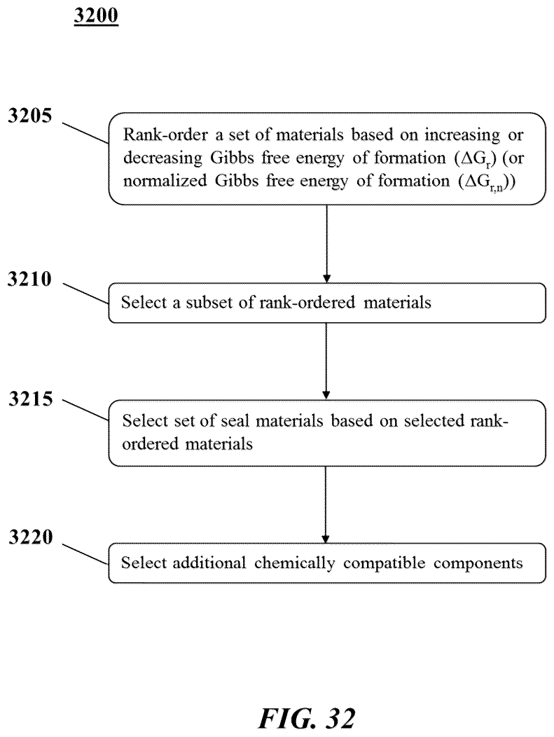

FIG. 32 is an example of a method 3200 for selecting materials to form a seal for a high-temperature device. The device can comprise a reactive material. The method can comprise a rank-ordered free energy of formation selection process. Such a selection process can provide a path toward a seal that has long-term stability. Such a seal can comprise thermodynamically stable materials (e.g., stable ceramic, stable (active) braze material, braze that can reduce the ceramic). The method can include rank-ordering a set of materials based on increasing or decreasing Gibbs free energy of formation (ΔGᵣ) of each of the materials (3205). In some cases, the materials that are compared in the Gibbs free energy comparison (i.e., the set of materials) comprise compounds associated with one or more seal materials (e.g., compounds associated with the set of seal materials, e.g., compounds associated with a ceramic material and a braze material, such as, for example, an active braze material) and/or compounds associated with the reactive material that is to be contained. The associated compounds may be ranked in accordance with their ΔGᵣ (e.g., Li₃N as the compound associated with the reactive material Li, TiN as the compound associated with the active braze material Ti; or Li₂O as the compound associated with the reactive material Li, Y₂O₃ as the compound associated with the active braze material). In some cases, the compounds comprise a common element (e.g., nitrogen in Li₃N, AlN and TiN, or oxygen in Li₂O, Nd₂O₃ and Y₂O₃). In such cases, the rank-ordering can be based on increasing or decreasing normalized Gibbs free energy of formation (ΔGᵣ,n, where ΔGᵣ,n is equal to ΔGᵣ divided by the stoichiometric number of atoms of the common elements in the formula of the compound, such as, for example, ΔGᵣ=ΔGᵣ,n/1 for Li₃N and ΔGᵣ=ΔGᵣ,n/3 for Nd₂O₃ where nitrogen and oxygen, respectively, is considered the common element) of each of the materials (e.g., the associated compounds). The common element can be capable of forming a compound with the reactive material (e.g., Li₃N or Li₂O). The common element can be, for example, nitrogen, oxygen or sulfur (e.g., the compounds are nitrides, oxides or sulfides). As previously described, reaction(s) involving the common element may aid in bonding between the selected rank-ordered materials (e.g., AlN+Ti→TIN+Al, or Nd₂O₃+2Y→Y₂O₃+2Nd).

The method can further include selecting a subset of the rank-ordered materials (3210) (e.g., such that the selected materials remain rank-ordered). Next, in a step 3215, the method can include selecting a set of seal materials (e.g., a ceramic material and an active braze material) based on the selected rank-ordered materials. This may eliminate a driving force for the selected rank-ordered materials to degrade when provided in the seal and/or exposed to the reactive material (e.g., Li). The selected set of seal materials can comprise a ceramic material and an active braze material. Selecting the set of seal materials can comprise selecting one or more seal materials (e.g., first a ceramic and then a braze) with associated compounds that have a ΔGᵣ,n that is more negative than a compound associated with the reactive material. The selection (e.g., a first step of the selection) may include selection of a ceramic material (e.g., AlN or Nd₂O₃, respectively) that is electrically insulating and that has a ΔGᵣ,n that is more negative than a compound associated with the reactive material (e.g., Li₃N or Li₂O, respectively). The selection (e.g., a second step of the selection) may include selection of an active braze material (e.g., Ti-alloy or Y-alloy, respectively) with an associated compound (e.g., TiN or Y₂O₃, respectively) that has a ΔGᵣ,n that is equal to or more negative than the ceramic material. In an example, the reactive material contained in the high-temperature device comprises lithium (Li). The selected rank-ordered materials in this example can be, in order, lithium nitride (Li₃N), aluminum nitride (AlN) and titanium nitride (TIN); the selected ceramic material can comprise aluminum nitride (AlN) and the selected active braze material can comprise titanium (Ti). Alternatively, the selected rank-ordered materials in this example can be, in order, lithium oxide (Li₂O), neodymium oxide (Nd₂O₃) and yttrium oxide (Y₂O₃); the selected ceramic material can comprise neodymium oxide (Nd₂O₃) and the selected active braze material can comprise yttrium (Y). In some cases, the active braze material is also selected based on its stability with the reactive metal (e.g., a stable active braze material may have low (e.g., <1%, <0.1%) mutual solubility with the reactive material and/or the active braze material and the reactive material may be stable in the presence of each other and/or not form intermetallic compounds). In some cases, the selected ceramic (AlN or Nd₂O₃, respectively) and active braze material (Ti or Y, respectively) are thermodynamically stable with Li. In some examples, the seal may comprise a ceramic material that is thermodynamically stable in the presence of the reactive material, an active braze material that is chemically stable with the reactive material, and where the active braze material chemically reacts with the ceramic material (e.g., Ti+AlN→TIN+Al or Nd₂O₃+2Y→Y₂O₃+2Nd, respectively) and the compound product of that reaction (e.g., TiN or Y₂O₃, respectively) is stable in the presence of the reactive material.

The method 3200 can further include selecting a sleeve or collar to join to the seal (3220) and/or selecting a container of the device to join to the sleeve or collar (3220). As described in greater detail elsewhere herein, the sleeve or collar can comprise a material that is chemically compatible with the seal and/or with one or more other materials of the device, and the container can comprise a material that is chemically compatible with the sleeve or collar and/or with one or more other materials of the device or seal. In some cases, one or more pairs of the selected rank-ordered materials can be CTE-matched. The steps of method 3200 may be performed in a different order, or one or more steps may be omitted. Further, the method 3200 may in some cases include additional or different step(s). One or more steps of method 3200 may be modified without altering its scope. For example, the method may be modified to account for presence of additional materials (e.g., a reactive atmosphere or a reactive compound or element) during bonding (e.g., allowing compounds with improved properties to be formed during bonding, such as, for example, by introducing an additional common element). Such additional materials may allow a modified set of rank-ordered materials to be formed (e.g., including one or more compounds comprising the additional material). A modified subset of rank-ordered materials (e.g., including one or more compounds comprising the additional material) and/or a modified set of seal materials may then be selected.

The coefficient of thermal expansion (CTE) may be considered when designing a seal. The seal may comprise structural features that can compensate for CTE mismatch. A CTE mismatch between various materials may not be a major concern during initial fabrication heat-up and brazing process of the high temperature seal (e.g., since the components may not be bonded, which allows for sliding interfaces). In some instances, during cool-down (e.g., after the braze has melted, bonded and solidified), the materials can contract at different rates (e.g., the insulator and metal sleeves can be exposed to large stresses). Therefore, one or more transition pieces may be added. The transition pieces may have CTE values intermediate to that of the insulator and the cell top and/or can have spring-like design features (e.g., a nickel-cobalt ferrous alloy, 430 SS or zirconium sleeve). In some cases, the transition pieces are thin relative to the insulator (e.g., the transition piece can have a thickness that is less than about 50% or 10% the thickness of the insulator). In some cases, the braze material is separated (e.g., kept away) from intended welding joints. In some cases, the seal includes a chemically stable material set (e.g., aluminum nitride ceramic, titanium-alloy braze, and nickel-cobalt ferrous alloy or 430 stainless steel sleeve), and can be CTE-matched or have a design that can accommodate differences in CTE.

In some cases, the seal does not comprise materials that are exactly matched in CTE and/or matched to the CTE of the housing and/or conductor. A mismatch in CTE can be compensated for by structural features and/or geometries such that the seal remains hermetically sealed and/or forms a suitable electrical insulation (e.g., at the operating temperature of the battery) and/or following one or more start-ups of the battery (e.g., melting of the liquid metal electrodes). For example, the seal can have a shape (i.e., suitable geometry) such that the electrochemical cell is hermetically sealed (e.g., the geometry of the seal can comprise a ceramic material bonded to a flexible metal component).

In some implementations, an electrochemical cell comprises an electrically conductive housing comprising a liquid metal that is liquid at an operating temperature of at least about 200 °C. In some cases, the operating temperature is at least about 350 °C. In some instances, the electrochemical cell is capable of storing at least about 50 Watt-hours of energy. The liquid metal can be configured to store/release charge during charge/discharge of the electrochemical cell. The electrochemical cell can comprise a conductor in electrical contact with the liquid metal, where the conductor protrudes through the electrically conductive housing through an aperture in the electrically conductive housing. The electrochemical cell can comprise a seal that seals the conductor to the electrically conductive housing. In some cases, the seal electrically isolates the conductor from the electrically conductive housing, where CTE of the material comprising the seal is not the same as the electrically conductive housing and/or the conductor. The seal can have a shape (i.e., suitable geometry) such that the electrochemical cell is hermetically sealed.

The CTE of the seal material may not be the same as the electrically conductive housing and/or the conductor. The materials of the seal, the conductive housing and/or the conductor can have any amount of CTE mismatch. In some cases, the CTE of the seal or seal material (or a portion thereof) is greater than or equal to about 1%, 5%, 10%, 15%, 20%, 25%, 30%, 40%, 50%, 60%, 70%, 80%, 90%, 100%, 125%, 150%, 300%, 400%, 500%, 600% or 700% different than the CTE of the electrically conductive housing and/or the conductor. In some cases, the CTE of a first seal material (e.g., metal collar) is less than about 1%, 5%, 10%, 15%, 20%, 25%, 30%, 40%, 50%, 60%, 70%, 80%, 90%, 100%, 125%, 150%, 300%, 400%, 500%, 600% or 700% different than the CTE of a second seal material (e.g., electrically isolating ceramic). In some cases, the CTE of a first seal material (e.g., metal collar) is at least about 1%, 5%, 10%, 15%, 20%, 25%, 30%, 40%, 50%, 60%, 70%, 80%, 90%, 100%, 125%, 150%, 300%, 400%, 500%, 600% or 700% different than the CTE of a second seal material (e.g., electrically isolating ceramic).

The CTE of the seal can be mismatched (e.g., intentionally or purposely mismatched) to the CTE of the conductive housing and/or the conductor at the operating temperature and/or during start-up of the cell (e.g., starting from non-molten metal electrodes). In some cases, the CTE of the seal is at least about 10% different than the CTE of the electrically conductive housing and/or the conductor at the temperature at which the electrochemical cell is operated. In some instances, the CTE of the seal is at least about 1%, 5%, 10%, 15%, 20%, 25%, 30%, 40%, 50%, 75%, 100%, 125%, 150% or 300% different than the CTE of the electrically conductive housing and/or the conductor at any or all temperatures between about −10 °C and the operating temperature (e.g., at least about 200 °C, 250 °C, 300 °C, 350 °C, 400 °C, 450 °C or 500 °C).

In some cases, the geometry of the seal comprises a ceramic material bonded to a flexible metal component. The flexible metal component can be joined (e.g., welded or brazed) to the electrically conductive housing and/or the conductor.

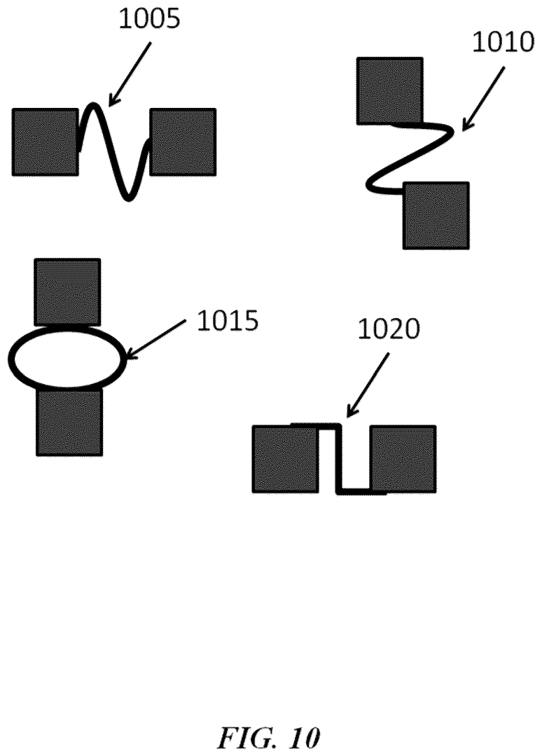

FIG. 10 shows examples of features that can compensate for a CTE mismatch. Examples include fins, cuts or bends in any configuration that can accommodate CTE mismatch (e.g., by spatial compliance). For example, a bend can be sinusoidal (either horizontally 1005 or vertically 1010), oval or tubular 1015, a sharp bend 1020, etc. The feature can be attached at a point above, below or in line with the top of the cell and/or current collector. The feature can be joined to, part of, or cut away from the cell housing and/or conductive feed-through. The feature can be coated (e.g., to improve chemical stability to the internal or external environments of the cell). The orientation, thickness and/or shape can be optimized to increase stability and resistance to failure from vibration and mechanical forces.

Low CTE mismatch may be achieved through suitable material selection. In some cases, one or more of the electrically conductive components of the seal comprise an electrically conductive ceramic (e.g., tungsten carbide) with a CTE that matches or is within less than or equal to about 1%, 2%, 5%, 10% or 20% of the CTE of the electrically insulating ceramic. The electrically conductive (CTE-matched) ceramic can be joined to both the insulating ceramic component and a metal collar. The joining process may involve brazing, diffusion bonding, and/or welding. The conductive ceramic may comprise, for example, tungsten carbide (WC), titanium carbide (TiC) and/or other carbides. The conductive ceramic may be sintered with some fraction (e.g., between about 2% and 10%, or at least about 2%, 3%, 4%, 5%, 6%, 7%, 8%, 9% or 10% in terms of weight, atomic, molar or volumetric composition) of metal (e.g., Co or Ni) which can allow for direct wetting of braze to the conductive ceramic.

In some cases, the electrically conductive components of the seal comprise a metal with low CTE (e.g., less than about 1 ppm/°C, 2 ppm/°C, 3 ppm/°C, 4 ppm/°C, 5 ppm/°C, 6 ppm/°C, 7 ppm/°C, 8 ppm/°C, 9 ppm/°C, 10 ppm/°C, 11 ppm/°C, 12 ppm/°C or 15 ppm/°C), low Young's modulus (e.g., less than about 0.1 GPa, 0.5 GPa, 1 GPa, 10 GPa, 50 GPa, 100 GPa, 150 GPa, 200 GPa or 500 GPa), high ductility (e.g., an ultimate strength greater than about 100%, 200%, 300%, 400% or 500% that of the yield strength), or any combination thereof. In some cases, the ultimate strength can be greater than about 50%, 100% or 200% that of the yield strength of the material for it to have sufficient ductility. In some cases, the electrically conductive components do not comprise an electrically conductive ceramic. Low CTE, low Young's modulus and/or high ductility component characteristics can lead to low stress concentrations in the ceramic. Low Young's modulus component characteristics can result in less stress generated between components with different CTE values (e.g., for a given CTE mismatch between two materials that are bonded together, if at least one material has a low Young's modulus, the strain generated by the CTE difference can cause the material with the low Young's modulus to “stretch,” resulting in a relatively small stress force between the two materials). Low CTE, low Young's modulus and/or high ductility component characteristics may reduce likelihood of failure (e.g., due to reduced stress concentrations and/or less stress generated). Metals that meet these specifications (in addition to corrosion resistance to the internal and external cell environment) can include, for example, zirconium (Zr), high-zirconium content alloys, tungsten (W), titanium (Ti), niobium (Nb), tantalum (Ta), nickel (Ni) and/or molybdenum (Mo).

In some implementations, the seal comprises a ceramic, one or more braze materials and one or more metal collars. For example, two metal collars may be joined to the ceramic, one to each side of the ceramic. Each such metal collar may be further joined to additional metal collar(s). Thus, a compound metal collar may be created that comprises two or more metal collars. In some examples, the compound metal collar comprises at least two metal collars, of which at least one metal collar comprises a material that is suitably joined (e.g., using one type of braze) to the ceramic and at least one metal collar comprises a material that is suitably joined to another component of the seal or of the cell (e.g., using another type of braze). The two metal collars may also be joined (e.g., using yet another type of braze). In some instances, at least a portion (e.g., all) of the brazes used to join the metal collars of the seal to each other and/or to other parts of the cell may be of the same type. In other instances, at least a portion or all of the brazes may be of different types. Further, one or more of the metal collars may be welded rather than brazed, or welded and brazed. The seal may comprise one or more compound metal collars. In some examples, the seal comprises at least about 1, 2, 3, 4, 5, 6, 7, 8, 9, 10, 12, 14, 16, 18, 20, 25, 30, 40 or more individual metal collars. In an example, the seal comprises 4 individual metal collars forming two compound metal collars. In some examples, at least a portion of the individual metal collars may comprise the same material. For example, metal collars comprising the same material may be used for joining metal collars to similar materials (e.g., similar cell housing or conductors materials).

In some cases, the seal comprises a ceramic, a braze material, a first (e.g., thin) metal collar, and/or a second metal collar. The first metal collar may be brazed to the ceramic, and the second metal collar may be brazed to the first metal collar. In some cases, the first metal collar is a low CTE material such as zirconium (Zr) or tungsten (W) and the second metal collar is a ferrous alloy, such as steel, stainless steel or 400 series stainless steel (e.g., 430 stainless steel). In some examples, the first metal collar is less than about 10 micro-meters (μm, or microns) thick, 20 μm, 50 μm, 100 μm, 150 μm, 250 μm, 500 μm, 1,000 μm, μm 1,500 or 2,000 μm thick.

In some cases, the seal comprises a ceramic, a braze, a first metal collar, a second metal collar and a third metal collar. The first metal collar may be joined to one part of the ceramic, and the second metal collar may be joined to the first metal collar. The third metal collar may be joined to a different part of the ceramic such that the first metal collar and the third metal collar are separated by an electronically insulating ceramic material. Joints between the first metal collar and the ceramic and between the third metal collar and the ceramic may both be hermetic. In some cases, the seal further comprises a fourth metal collar that is joined to the third metal collar (e.g., the first metal collar is joined to one part of the ceramic, the second metal collar is joined to the first metal collar, the third metal collar is joined to another part of the ceramic and the fourth metal collar is joined to the third metal collar). The braze material used to join the first metal collar to the second metal collar may comprise or be similar to any of the braze compositions described herein. The first metal collar or the second metal collar may be joined (e.g., using a braze composition similar to any of the braze compositions described herein, or welded) to the cell lid. The third metal collar may be joined to the fourth metal collar or directly to a negative current lead (e.g., brazed using any of the braze compositions of the disclosure).

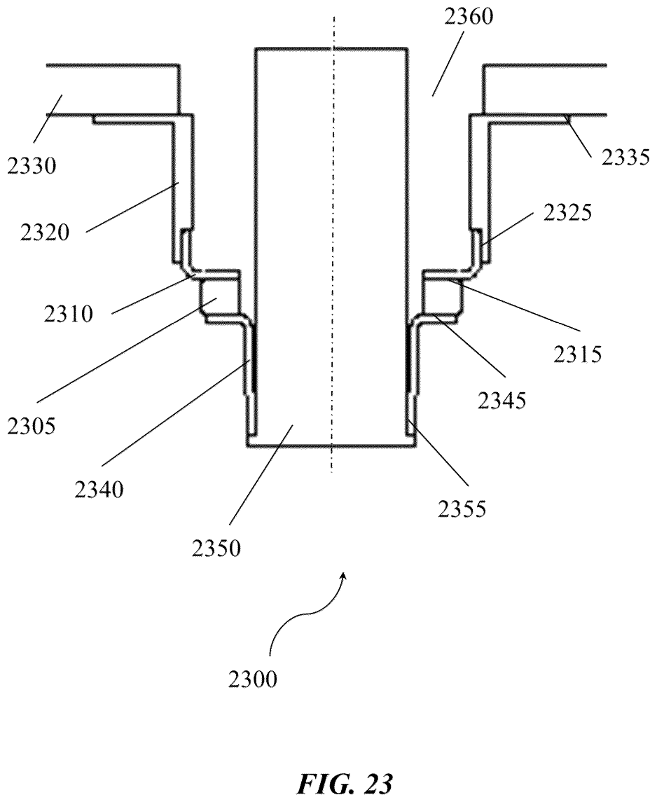

FIG. 23 is an example of a seal 2300 that comprises one ceramic component (e.g., AlN) 2305. The ceramic component may be a washer. The ceramic component may be electrically insulating. The ceramic component 2305 is joined with a first metal collar (e.g., Zr) 2310 via a first metal-to-ceramic joint (e.g., braze) 2315. The first metal collar 2310 is joined with a second metal collar (e.g., 430 SS) 2320 via a first metal-to-metal joint (e.g., weld, braze) 2325. The second metal collar 2320 is joined to a cell lid (e.g., 430 SS) 2330 via a second metal-to-metal joint (e.g., weld, braze) 2335. The seal further comprises a third metal collar (e.g., Zr) 2340 joined to the ceramic component 2305 via a second metal-to-ceramic joint (e.g., braze) 2345. The third metal collar 2340 is joined with a conductor (e.g., negative current lead) 2350 via a third metal-to-metal joint (e.g., weld, braze) 2355. The seal 2300 may comprise one or more gaps (e.g., air gaps) 2360.

In some cases, the first, second, third, and/or the fourth metal collar comprise structural features to relieve mismatches in the CTE of the joined materials, described in greater detail elsewhere herein. Such configurations may enable mechanically robust joining of the ceramic to one or more metal collars (e.g., the first metal collar, or the third metal collar), and the joining of one or more metal collars (e.g., the second metal collar, or the third or fourth metal collar) to the cell lid or a current conducting rod (also “conductor” herein) by simple welding (e.g., TIG welding, or laser welding) or brazing.

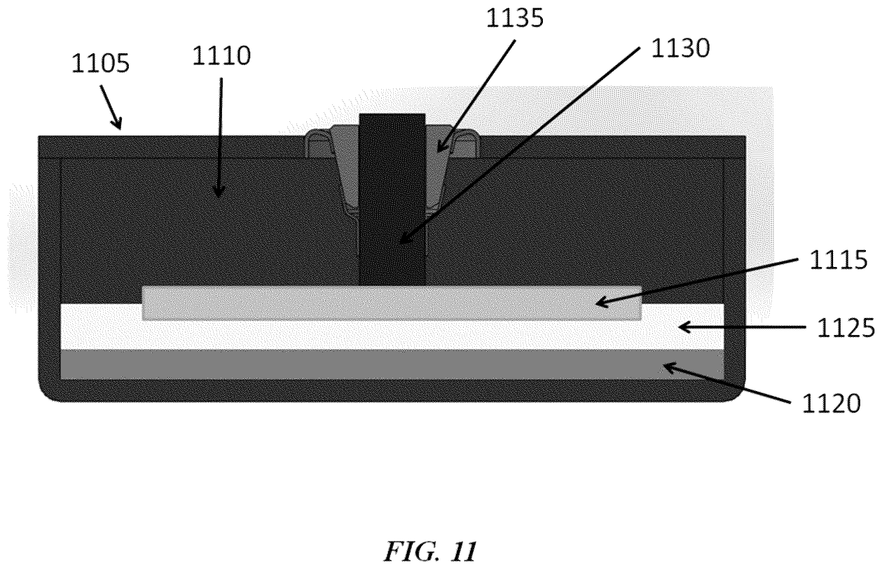

A brazed ceramic seal may be used to hermetically and/or electrically seal a system or vessel comprising a reactive material (e.g., an electrochemical cell having liquid metals). FIG. 11 shows an electrochemical cell having a brazed ceramic seal. A cell housing 1105 can have an empty head space 1110, a molten negative electrode (e.g., anode during discharge) 1115, a molten positive electrode (e.g., cathode during discharge) 1120 and a molten electrolyte 1125 disposed therebetween. The liquid metal anode can be in contact with a conductive feed-through 1130 that passes through the housing and serves as a negative terminal. The conductive feed-through can be electrically isolated from the housing by the seal 1135. The liquid metal cathode can be in contact with the housing, which can serve as a positive terminal.

In some cases, a brazed ceramic seal comprises a sub-assembly. The sub-assembly can comprise the insulating ceramic bonded to one or more (e.g., two) flexible, spring-like or accordion-like components, referred to herein as metal sleeves. After the sub-assembly is fabricated, the sleeves can be brazed or welded to other cell components such as the cell lid and/or the negative current lead. Alternatively, all of the joints can be created on the complete cap assembly by brazing (e.g., if tolerance limits are sufficiently tight). The chemical compatibility between the braze materials and the atmospheres the materials will be exposed to, and the thermal robustness during high temperature operation and thermal cycling can be evaluated during design of the sub-assembly. In some instances, the ceramic material is aluminum nitride (AlN) or silicon nitride (Si₃N₄), and the braze is a titanium alloy, titanium doped nickel alloy, a zirconium alloy or a zirconium doped nickel alloy.

FIG. 12 shows a schematic drawing of a brazed ceramic seal with materials that are thermodynamically stable with respect to internal 1205 and/or external 1210 environments of a cell. Such materials may not require a coating. The various materials can have mismatched CTEs that can be accommodated for with one or more geometric or structural features 1215 (e.g., a flexible metal bend, fin, or fold). The CTE-accommodating feature 1215 can be welded to a cell housing 1220 (e.g., 400-series stainless steel) on one end and brazed 1225 to a first metalized surface 1230 of a ceramic material 1235 on the other end. The ceramic material 1235 can be, for example, aluminum nitride (AlN), boron nitride (BN) or yttrium oxide (Y₂O₃) as described herein. The ceramic material can be brazed to a current collector (conductive feed-through) 1240 by a braze 1245. The braze 1245 can comprise, for example, iron (Fe), nickel (Ni), titanium (Ti) or zirconium (Zr). The braze 1245 can be in contact with a second metalized surface of the ceramic 1250 (e.g., titanium or titanium nitride). Several layers of materials placed adjacent to each other can result in a CTE gradient that can mitigate mismatch.

FIG. 13 shows a seal where the ceramic and/or braze materials are not thermodynamically stable with respect to the internal 1205 and external 1210 environments. In some instances, a coating can be applied to an outside 1305 and/or an inside 1310 of the seal or enclosure components.

FIG. 14, FIG. 15, FIG. 16 and FIG. 17 show more examples of brazed ceramic seals. In some cases, the seals extend above the housing by a greater distance. FIG. 14 shows an example of a seal on a cell which may advantageously not need a coating, not need a CTE mismatch accommodation feature, and/or provide increased structural stability against vibration and mechanical forces during operation, manufacturing or transportation. In this example, a housing 1405 can be sealed from a current collector 1410. This arrangement can hermetically seal an inside 1415 of the cell from an outside 1420 of the cell. The components of the seal can be arranged vertically and can include a first braze 1425, a ceramic 1435, a first metalized surface 1430 of the ceramic, a second braze 1440, and a second metalized surface 1445 of the ceramic.

FIG. 15 shows a seal 1520 that can provide structural stability against vibration and mechanical forces during operation, manufacturing and transportation. In this example, CTE accommodating features 1505 are disposed between a housing 1510 and a current collector 1515. The seal 1520 can comprise a ceramic and two brazes in contact with metalized surfaces of the ceramic. In some cases, the seal is coated on an inside 1525 and/or an outside 1530. In some cases, the coating(s) can comprise yttrium oxide (Y₂O₃).

FIG. 16 shows a seal 1610 with secondary mechanical load bearing components 1605. The load bearing components are electrically insulating in some cases. In some instances, the load bearing components do not form a hermetic seal. The seal 1610 (e.g., including a ceramic, two brazes in contact with metalized surfaces of the ceramic, etc.) can hermetically seal a cell housing 1615 from a current collector 1620.

FIG. 17 shows an example of a secondary back-up seal 1705 (e.g., in case of failure of a primary seal 1710). The secondary seal can fall onto and/or bond over the primary seal in the case of failure of the primary seal. In some cases, the secondary seal comprises glass that melts and becomes flowable in the case of the primary seal failing. The melted secondary seal can pour down onto the failed primary seal and block leaks. In some cases, the seal 1705 and/or the seal 1710 can be axisymmetric (e.g., doughnut-shaped around a vertical axis through the aperture in the cell lid).

FIG. 18 shows another example of a seal configuration or sub-assembly (e.g., an alumina or zirconia seal with yttrium oxide (Y₂O₃) coating and iron- or titanium-based braze). The seal can include a collar 1805. The collar can provide mechanical support. The collar can comprise ferritic stainless steel welded to a rod. The seal configuration can include a conductor 1810. The conductor can be made of ferritic stainless steel (e.g., having a CTE of about 12). The conductor can be tolerant of one or more reactive materials (e.g., tolerant of liquid lithium). The conductor can be unlikely to change mechanical properties or form due to a phase transition. The conductor can have greater than or equal to about 40% higher electrical conductivity than 304 stainless steel. The seal can include a braze 1815. The braze can be disposed above and below a ceramic washer 1820. The braze can be iron-based. The braze can have a CTE of about 12 and withstand high temperatures (e.g., 850 °C or greater). The ceramic washer 1820 can be made of alumina (e.g., with a CTE of about 7), or zirconia (e.g., tetragonal with CTE of about 11). The low CTE mismatch of a zirconia washer can allow higher brazing temperature without cracking. A cell housing 1825 can be made from ferritic steel and provide mechanical support through the ceramic (e.g., the ceramic washer) to the collar. The seal configuration can comprise a coating (e.g., spray coating) 1830 (e.g., comprising yttrium oxide (Y₂O₃)). The coating can be provided on the cell housing (e.g., lid). The coating can be capable of being resistant to reactive materials (e.g., lithium (Li) vapor), inexpensive and/or mitigate ceramic compatibility.

The length (e.g., horizontal extent) of the braze interface can be about three to six times the thickness of the thinnest component being brazed. If the ratio of thickness to braze interface length is too low (e.g., less than about three), the sealing area may be mechanically too weak to hold the brazed joint together. If the ratio is too high (e.g., greater than about six), the stresses on the sleeve due to CTE mismatch may cause the sleeve to fracture or pull away from the ceramic. In some cases, the braze interface absorbs the stresses induced by the mismatch of the CTEs of the sleeve, braze and ceramic induced by forming the joint at high temperature and cooling down to room temperature after fabrication.

FIG. 19 shows an example of a sub-assembly with braze length equal to between about 3 and 6 times the thickness of a metal sleeve. The metal sleeve (e.g., nickel-cobalt ferrous alloy, zirconium alloy) can have a thickness of about 0.01 inches, 0.0080 inches, 0.0060 inches, 0.0030 inches, 0.0015 inches or less. The sub-assembly can comprise a braze 1905, one or more (e.g., nickel-cobalt ferrous alloy or stainless steel) sleeves (e.g., 1910 and 1915) and an insulator 1920.

FIG. 20 shows an example of a shape of a sub-assembly that can accommodate CTE mismatch. The sub-assembly (i.e., seal) can comprise a sleeve (e.g., a nickel-cobalt ferrous alloy sleeve) 2005 and an insulator (e.g., a ceramic) 2010. Compressive forces can act in the direction of indicated arrows 2015. Ceramic materials may be capable of withstanding a high level of compression. In some cases, seal designs can utilize this characteristic of ceramics to provide a reliable seal. In order to produce a compressive seal, outer material of the seal can have a higher CTE value than inner material of the seal. During processing and fabrication, the sub-assembly can be heated, causing the materials to expand. After reaching the braze melting temperature, the braze joint can be formed, and upon cooling, the higher CTE material can contract at a higher rate than the inner material to create a compressive seal. Due to the high temperature brazing operation and subsequent cool-down, the sleeves (e.g., nickel-cobalt ferrous alloy or stainless steel sleeves) can apply a compressive force to the sealed bonding interface (e.g., nickel-cobalt ferrous alloy or stainless steel/insulator interface) due to the insulator in the center contracting less. The example in FIG. 20 utilizes a Ti-alloy braze to form the sealing joint, and the compressive forces 2015 formed during the cool-down to press the sleeve 2005 (e.g., nickel-cobalt ferrous alloy sleeve) onto the insulator (e.g., ceramic) 2010, thus providing a stable and robust seal. The seal in FIG. 20 is an example of a circumferential seal.

FIG. 21 is an example of a seal 2100 that comprises multiple ceramic components. The ceramic components may be washers. The ceramic components may be electrically insulating. The seal can electrically isolate a conductor (e.g., negative current lead) 2120 from a cell housing (e.g., cell lid) 2125 (e.g., by a hermetic seal). The seal in FIG. 21 is an example of a stacked seal design. In this seal design, three separate ceramic components (e.g., AlN) 2105a, 2105b and 2105c are positioned vertically on top one another. The ceramic components (e.g., insulators) are disposed between one or more metal sleeves or collars 2110, 2115 and 2130 (e.g., zirconium metal, zirconium alloy, or nickel-cobalt ferrous alloy forming a flexible joint). In some cases, the collar 2130 may not be used and the collar 2115 may be joined directly to the cell housing 2125. The ceramic 2105b may provide sealing. The ceramic components 2105a and 2105c may provide stress and/or support for the seal. The ceramic components 2105a and 2105c may or may not provide sealing. In some situations, the ceramic components 2105a and 2105c may break (e.g., break and fall off). In such situations, the sealing provided by the central (in this case middle) ceramic component may not be affected.

The ceramic component 2105b is joined with a first metal collar (e.g., Zr) 2115 via a first metal-to-ceramic joint (e.g., braze) 2135. The first metal collar 2115 may further be joined to the ceramic component 2105a via a fourth metal-to-ceramic joint 2170. In some cases, the first metal-to-ceramic joint 2135 and the fourth metal-to-ceramic joint 2170 are the same type of joint (e.g., comprise the same braze material). The first metal collar 2115 is joined with a second metal collar (e.g., 430 SS) 2130 via a first metal-to-metal joint (e.g., weld, braze) 2140. The second metal collar 2130 is joined to a cell lid (e.g., 430 SS) 2125 via a second metal-to-metal joint (e.g., weld, braze) 2145. The seal further comprises a third metal collar (e.g., Zr) 2110 joined to the ceramic component 2105b via a second metal-to-ceramic joint (e.g., braze) 2150. The third metal collar 2110 may further be joined to the ceramic component 2105c via a third metal-to-ceramic joint (e.g., braze) 2165. In some cases, the second metal-to-ceramic joint (e.g., braze) 2150 and the third metal-to-ceramic joint 2165 are the same type of joint (e.g., comprise the same braze material). The third metal collar 2110 is joined with a conductor (e.g., negative current lead) 2120 via a third metal-to-metal joint (e.g., weld, braze) 2155. The seal 2100 may comprise one or more gaps (e.g., air gaps) 2160.

In some cases, the sealing is provided by a central ceramic (e.g., the middle ceramic 2105b in FIG. 21) that is joined to metal collars (e.g., metal collar 2110 and 2115 in FIG. 21) on opposite sides of parallel faces of the ceramic (e.g., along interfaces/joints 2150 and 2135 in FIG. 21) in a stacked fashion. Two additional ceramic components (e.g., the top ceramic 2105a and the bottom ceramic 2105c in FIG. 21) are included in the design and joined on the face of each metal collar that is opposite to the face that is bonded to the central ceramic (e.g., along brazing interfaces/joints 2170 and 2165 in FIG. 21). A stacked configuration with three ceramic components may create symmetric braze lengths on either side of the metal collars. Braze joints comprising symmetric braze lengths on either side of a metal collar may create symmetric forces on the metal collar. This may enhance the overall strength of the braze joint (e.g., by minimizing stress concentrations and placing the metal under tension and the ceramic components under compression). In some cases, a joint comprising a flat ceramic surface that is bonded to a flat metal surface is considered to be a face seal.

Different applications may benefit from different seal designs. A circumferential (e.g., conical) seal design (e.g., see FIG. 20) may provide a robust seal design with a single ceramic component. The angled circumferential surface on the ceramic may enable easier assembly (e.g., the parts may fall into the proper configuration without the need for fixtures with tight tolerances or without the need for careful assembly prior to brazing). The circumferential design may in some cases be able to withstand greater CTE-mismatches between the metal collars and the ceramic since the primary force exerted by the metal onto the ceramic after cooling down from the brazing temperature may be a radially symmetric compressive force (e.g., due to ceramics generally being stronger in compression than in tension). A stacked seal design (e.g., see FIG. 21, or FIG. 23 which may be considered a special case of the stacked design with just one ceramic) may allow for lower cost components based on simpler machining of flat parallel surfaces on the top and bottom of the ceramic instead of machining the outer diameter and/or machining the side of the ceramic to a specific conical angle (e.g., a conical angle of at least about 5, 10, 15, 20, 25, 30, 35, 40, 50, or 75 degrees relative to a vertical orientation, or a conical angle of less than or equal to about 5, 10, 15, 20, 25, 30, 35, 40, 50, or 75 degrees relative to a vertical orientation) as may be required by a circumferential seal. The stacked design may also enable designs with lower seal height (e.g., since the sealing interfaces are perpendicular to the height of the design). The seals of the disclosure (e.g., the seals in FIG. 20, FIG. 21 and FIG. 23) may be axially symmetric to aid in balancing forces on the seal. In some configurations, the stacked configuration may include 1, 2, 3, 4, 5, 6, 7, 8, 9, 10, 12, 14, 16, 18, 20 or more ceramic components. The number of ceramic components may be configured to balance the forces in a given seal configuration. In some cases, the ceramic components may be symmetrically distributed on two sides of a central (e.g., middle) ceramic component. In some cases, the ceramic components may be non-symmetrically distributed on two sides of a central (e.g., middle) ceramic component. In some cases, the ceramic components may be distributed in any configuration around (e.g., on two sides of, such as, for example, above and below) one or more ceramic components that provide sealing. Further, thickness of the ceramic components and/or of the metal collars may be selected to balance the forces in a given seal configuration. For example, metal collars joined or bonded to the ceramic (e.g., the first metal collar or the third metal collar) may have a first thickness, metal collars joined or bonded only to other metal collars (e.g., in compound metal collars) may have a second thickness, and metal collars joined or bonded to a conductor, cell housing lid and/or other part of the housing may have a third thickness (e.g., the third thickness may be equal to the first thickness if the metal collar is also directly joined to the ceramic).

Brazing can be provided on either side of the sleeve or flexible joint (e.g., a balanced seal as shown in FIG. 21) or on just one side of the joint (e.g., an unbalanced seal as shown in FIG. 23). Brazing on either side of each metal sleeve can balance the forces experienced by the sealing interfaces. An advantage of the balanced seal design may be that there can be limited force applied to the ceramic and minimal torque present during the cooling of the system. Such configurations can place the sleeves (e.g., nickel-cobalt ferrous alloy sleeves) in tension and the ceramics in compression. In an example, balancing of the seal may enable stress (e.g., stress generated during a post-fabrication cooling process) to be less than the tensile strength of the ceramic. In another example, balancing of the seal may enable strain (e.g., strain generated during a post-fabrication cooling process) to be less than the strain strength (e.g., maximum strain that the ceramic can withstand prior to breaking) of the ceramic. The ceramic may have a given strength. In some examples, a strength value (e.g., tensile strength, ultimate strength, yield strength) of a ceramic material, such as, for example, AlN, BN, Al₂O₃, La₂O₃, Y₂O₃, MgO, SiC, TiC or Si₃N₄, can be greater than about 10 mega-Pascals (MPa), 50 MPa, 100 MPa, 150 MPa, 200 MPa, 250 MPa, 300 MPa, 350 MPa, 400 MPa, 450 MPa, 500 MPa, 550 MPa, 600 MPa, 650 MPa, 700 MPa, 750 MPa, 800 MPa, 900 MPa, 1,000 MPa, 1,500 MPa, 2,000 MPa, 3,000 MPa, or 5,000 MPa.

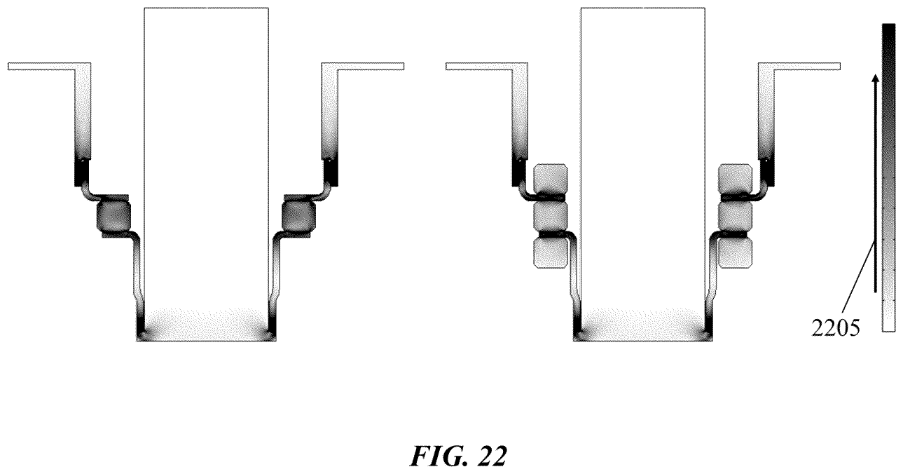

FIG. 22 shows examples of forces on seals by providing images of results from computational models that predict stress and strain generated during a post-fabrication cooling process for a seal due to CTE mismatch (without incorporating plastic deformation). The models show the von Mises stress distribution (e.g., a calculated stress distribution based on forces applied in three spatial dimensions that provides insight into the likelihood of a stress-induced mechanical failure, e.g., if the calculated von Mises stress exceeds the strength of the material, the material is predicted to fail) generated using a linear elastic model for a process involving joining ceramic and metal components together at contacting interfaces at 850 °C and cooling the system to 25 °C. In the example image on the left in FIG. 22, the seal comprises only one ceramic insulator (e.g., as shown in FIG. 23). In the example image on the right in FIG. 22, the seal comprises three ceramic insulators (e.g., as shown in FIG. 21). As shown in these examples, the single ceramic seal on the left in FIG. 22 can be subject to larger von Mises stresses and/or strain than the three ceramic seal on the right in FIG. 22. The shades in FIG. 22 represent different levels of the von Mises stress, with white being zero stress and black being the maximum stress on the scale, as indicated by an arrow in the direction of increasing stress 2205.

While the sub-assembly is cooled, stresses may build up, leading to immediate failure or failure when the seal is joined with the rest of the components of the cell top assembly. Since nickel-cobalt ferrous alloy can experience a phase transition at around 425 °C (e.g., as noted by the sudden change in CTE as a function of temperature in FIG. 7 and FIG. 8), it can maintain a higher stress level unless annealed below that temperature. In some cases, annealing of nickel-cobalt ferrous alloy is completed by a 30 minute soak at 850 °C, which can ultimately yield high stresses in the sub-assembly. Higher temperature braze materials may use 430 stainless steel sleeves, since they do not experience grain growth after a phase transition leading to a change in shape or properties that may occur at prolonged periods of time at the device's (e.g., liquid metal battery's) operating temperature.

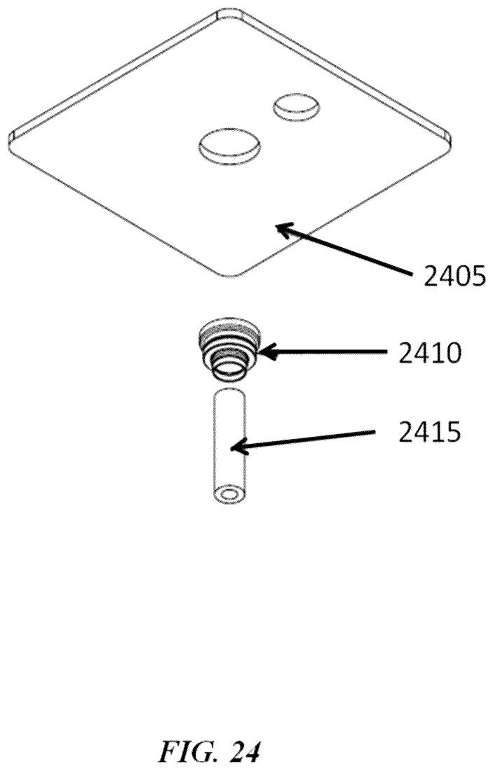

FIG. 24 shows an exploded view of a cell cap assembly having a cell top 2405, a sub-assembly 2410 and a conductor 2415. The cell top can have any suitable geometry (e.g., as long as it interfaces with the cell body and allows for features such as, for example, gas management (if necessary), and a hole for the sub-assembly to be welded to). For example, the cell top can comprise a first aperture for the conductor/sub-assembly and a second aperture for a gas management connection. Each aperture may be sealed with a seal of the disclosure. In some cases, the conductor has a low CTE (e.g., so that the part does not short or crack the ceramic or fail).

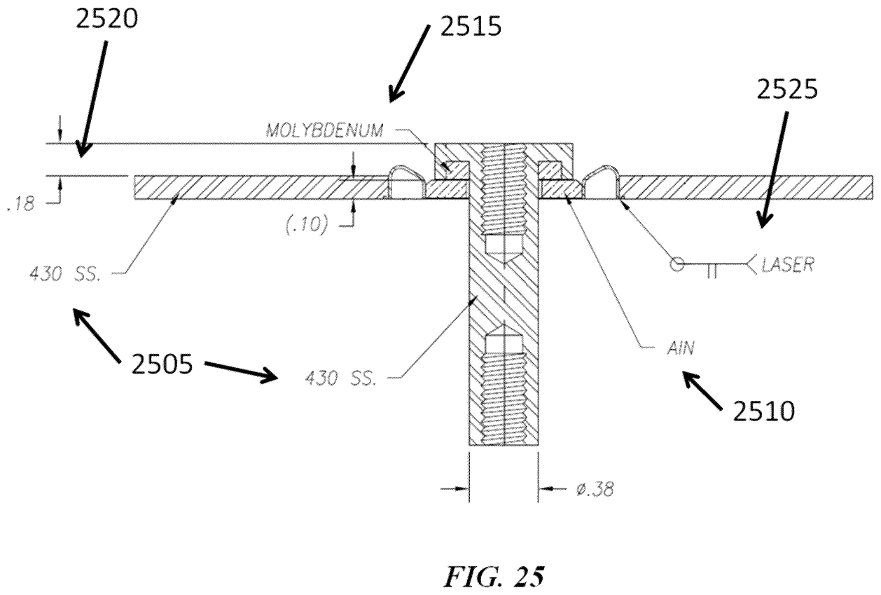

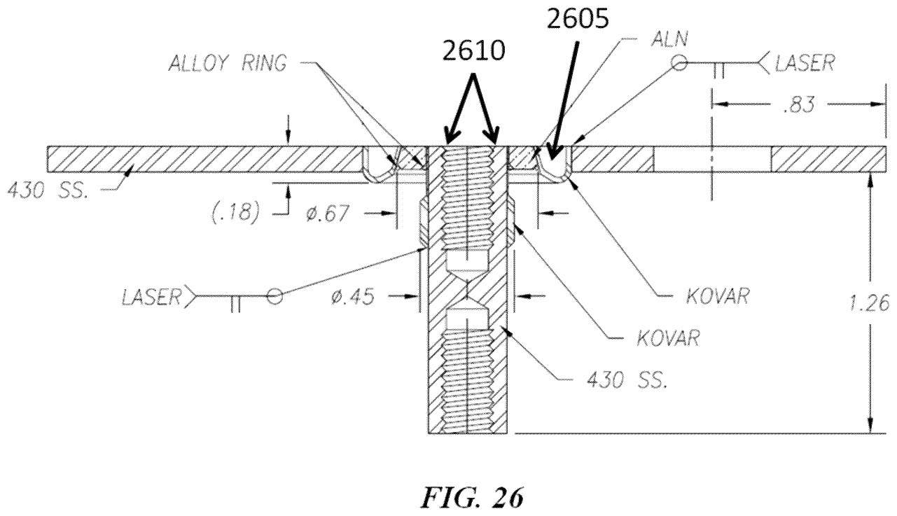

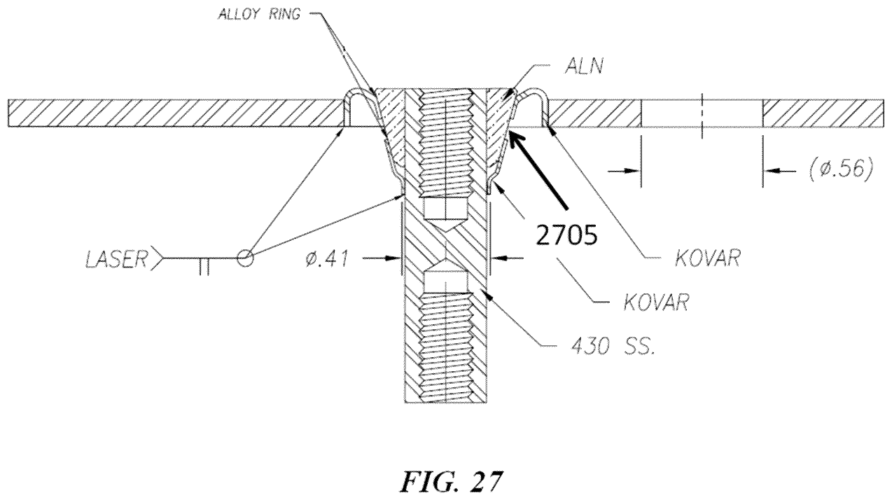

FIG. 25, FIG. 26 and FIG. 27 show examples of various features of seals. The seal in FIG. 25 utilizes corrosion resistant metals such as molybdenum, tungsten, 630 SS or 430 SS 2505 (e.g., having a low CTE of less than about 4 ppm/°C or 10 ppm/° °C) and ceramics 2510 (e.g., aluminum nitride (AlN)). The seal comprises a CTE-matching component 2515 (e.g., at about 5.5 ppm/°C) to allow for reduced or minimal stress build-up (e.g., between the metal 2505 and the ceramic 2510). The CTE-matching component 2515 can comprise, for example, molybdenum, or an alloy of tungsten and/or molybdenum. Examples of such materials are provided in Example 1. The seal has a robust design for mechanical loading and is resistant to electrical bridging shorts. The seal has a low profile design 2520 (e.g., about 0.25 inches), and can be welded or brazed in a commercially scalable way 2525 (e.g., by laser or during sub-assembly brazing).

In FIG. 26, parts of the seal are submerged into the cell such that the seal does not extend up beyond the surface of the cell lid. The seal can include a gas management port and nickel-cobalt ferrous alloy in place of molybdenum. A flipped metal collar 2605 can reduce or eliminate the catching of debris. In some cases, an inner diameter braze (e.g., between nickel-cobalt ferrous alloy and aluminum nitride (AlN)) 2610 can result in undesirable amounts of stress.

The cell shown in FIG. 27 can be sealed by a vacuum brazing process. The seal can enter about ⅜ inch below the cell top, with about 0.05 inch extension above the cell top. The cell can have increased structural capability when compared to the cell in FIG. 26. The design can allow for addition of a central pin after brazing, allowing for more control and flexibility during assembly. In some cases, the smaller gap between the metal pieces can lead to a short by wetting of the ceramic 2705.

Seal ceramic component(s) (e.g., seal ceramic washers or isolators/insulators) may have a complex or compound shape. Such shaped ceramic components may, for example, allow compressive forces on a sealing ceramic (e.g., the middle ceramic 2105b in FIG. 21 or the ceramic component 2305) in a stacked configuration to improve sealing and durability (e.g., thereby enabling a hermetic seal that does not crack during brazing or cell operation), facilitate easier assembly and/or fixturing, and/or increase or physically block an electrical shorting path. Such seals may be configured for sealing a container comprising a reactive material maintained at a temperature of at least about 200 °C. (e.g., at least about 600 °C in some cases).

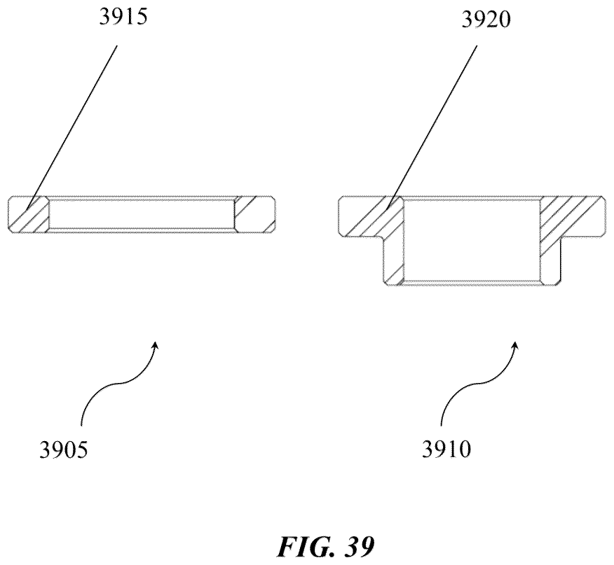

FIG. 39 shows cross-sectional views of a portion or component 3905 of a seal that comprises a simple ceramic component 3915 and a portion or component 3910 of a seal that comprises a shaped ceramic component (e.g., L-shaped) 3920. The seal portions or components 3905 and 3910 can be configured in stacked configurations (e.g., with one or more sealing interfaces that are perpendicular to a direction parallel to a conductor that passes through the seal). For example, the ceramic components 3915 and 3920 can be center ceramic components that form a seal around a conductor (not shown).

FIG. 40 shows a cross-sectional view of an example of a seal 4000 with a shaped ceramic component 4005. The ceramic component 4005 may be electrically isolating. The seal can electrically isolate a conductor (e.g., negative current lead) 4020 from a cell housing (e.g., cell lid). The ceramic component 4005 can be exposed to reactive material 4070 within the cell housing. The ceramic component (e.g., AlN) 4005 may or may not be surrounded by additional ceramic components (e.g., AlN). For example, the ceramic component 4005 can form a center ceramic component of the seal 4000 (e.g., the ceramic component can be positioned in the center of a vertical stack of ceramic components). The ceramic component 4005 can be surrounded by additional ceramic components (e.g., second and third ceramic components 4010 and 4015 adjacent to the ceramic component).

The ceramic component(s) (e.g., comprising aluminum nitride (AlN), silicon nitride (Si₃N₄) or magnesium oxide (MgO)) can be disposed between one or more metal sleeves or collars (e.g., zirconium metal, zirconium alloy, or nickel-cobalt ferrous alloy) forming a flexible joint. For example, a metal sleeve can be joined to the ceramic component 4005, and the metal sleeve can be directly or indirectly joined to the container (not shown). An additional metal sleeve can be joined to the conductor 4020. In some implementations, the metal sleeve can be joined to the container at a bottom surface of the ceramic component and the additional metal sleeve can be joined to the conductor at a top surface of the ceramic component.

The first (e.g., center) ceramic component 4005 can be joined with a first metal sleeve (e.g., Zr) 4030 via a first metal-to-ceramic joint (e.g., braze) 4040. The first metal sleeve 4030 may further be joined to the second ceramic component 4010 via a second metal-to-ceramic joint 4045. The first metal sleeve 4030 can be joined with a third metal sleeve (e.g., 430 SS) 4025 via a first metal-to-metal joint (e.g., weld, braze) 4060. In some cases, the third metal sleeve (e.g., cell top sleeve) 4025 may not be used and the sleeve 4030 may be joined directly to the cell housing (not shown). A second metal sleeve (e.g., Zr) 4035 can be joined to the first ceramic component 4005 via a third metal-to-ceramic joint (e.g., braze) 4050. The second metal sleeve 4035 may further be joined to the third ceramic component 4015 via a fourth metal-to-ceramic joint (e.g., braze) 4055. The second metal sleeve 4035 can be joined with the conductor 4020 via a second metal-to-metal joint (e.g., weld, braze) 4065. At least a subset of the metal-to-ceramic joints 4040, 4045, 4050 and 4055 may be the same type of joint (e.g., comprise the same braze material). At least a subset of the metal-to-metal joints 4060 and 4065 may be the same type of joint (e.g., comprise the same weld or braze material).

In some implementations, the metal sleeve (e.g., the first metal sleeve 4030) that is directly or indirectly joined with the container (e.g., cell lid) may be joined with the ceramic component 4005 at the vertically lower sealing interface 4040, while the metal sleeve that is directly or indirectly joined with the conductor may be joined with the ceramic component 4005 at the vertically higher sealing interface 4050.

The ceramic component 4005 can have a compound shape (e.g., L-shape). For example, the ceramic component 4005 can comprise a protruding portion 4075 (shaded region) that substantially protrudes beyond a sealing interface (e.g., beyond a sealing interface on the ceramic component or beyond any combination of the sealing interfaces 4040, 4045, 4050 and 4055). The protruding portion can have a thickness 4080 that substantially exceeds a thickness of the sealing interface (e.g., sealing interface 4040), thereby allowing the protruding portion to substantially protrude beyond the sealing interface (e.g., braze joint). The protruding portion can be adjacent to the conductor 4020. The ceramic component 4005 can increase or physically block an electrical shorting path between the conductor 4020 and the metal sleeve 4030. As indicated in FIG. 40, the third metal sleeve 4025 may be at a positive potential (“+charge” and “+” signs to indicate positive polarity) with respect to the conductor 4020 at a negative potential (“− charge” and “−” signs to indicate negative polarity). The second metal sleeve 4035 may also be at a positive potential when joined with the cell lid via the third metal sleeve 4025. The thickness 4080, which may be greater for a shaped ceramic component than for a simple ceramic component, may aid in isolating the components with a positive polarity from the components with a negative polarity. Additionally, the protruding portion 4075 may protrude vertically downward from the seal in a direction parallel to the conductor. This downwardly protruding portion may also aid in providing additional isolation or blockage between the components with positive polarity and the conductor. Further, it may allow fixturing (e.g., guided fixturing) of the seal and/or the conductor (e.g., when assembling the seal, or when fixturing the seal and/or the conductor in the container), as described in greater detail with reference to FIG. 41.

FIG. 41 is another example of the seal in FIG. 40. In this example, a seal 4100 comprises a shaped first (e.g., center) ceramic component 4105 joined with a first metal sleeve (e.g., Zr) 4130 via a first metal-to-ceramic joint (e.g., braze) 4140. The first metal sleeve 4130 can further be joined to a second ceramic component 4110 via a second metal-to-ceramic joint 4145. The first metal sleeve 4130 can be joined with a third metal sleeve (e.g., 430 SS) 4125 via a first metal-to-metal joint (e.g., weld, braze) 4160. The third metal sleeve (e.g., cell top sleeve) can be joined with the cell lid (e.g., 430 SS) (not shown). A second metal sleeve (e.g., Zr) 4135 can be joined to the first ceramic component 4105 via a third metal-to-ceramic joint (e.g., braze) 4150. The second metal sleeve 4135 may further be joined to a third ceramic component 4115 via a fourth metal-to-ceramic joint (e.g., braze) 4155. The second metal sleeve 4135 can be joined with a conductor 4120 via a second metal-to-metal joint (e.g., weld, braze) 4165. The metal-to-ceramic joints 4140, 4145, 4150 and 4155 may be face-sealing. The metal-to-metal joints 4160 and 4165 may be “diameter” braze joints in some implementations. The metal sleeve 4135 may have a diameter of, for example, about 0.625 inches.

The metal sleeves can be joined to the first (e.g., center) ceramic component and the second and third ceramic components via sealing interfaces (e.g., metal-to-ceramic joints such as braze joints) with substantially the same (symmetric) sealing interface lengths (e.g., braze lengths). The braze lengths may be, for example, less than or equal to about 0.040 inches, 0.050 inches, 0.060 inches, 0.070 inches, 0.080 inches, 0.090 inches, 0.10 inches, 0.11 inches or 0.12 inches wide (e.g., from inner radius to outer radius), and less than or equal to about 0.0005 inches, 0.001 inches, 0.015 inches, 0.020 inches, 0.025 inches, 0.030 inches or 0.035 inches thick. For example, two or more (e.g., each) of the braze joints 4140, 4145, 4150 and 4155 can be about 0.080 inches wide (e.g., from inner radius to outer radius) and about 0.002 inches thick. The symmetric sealing interface lengths (e.g., braze lengths) may advantageously reduce asymmetric forces on the seal (e.g., in a balanced configuration). For example, substantially the same (e.g., identical) braze lengths for all braze joints may ensure that adjacent materials have substantially matching CTEs (e.g., closest CTE match between adjacent materials), thus reducing potential for cracks forming within the ceramic upon brazing or cell operation.

The first ceramic component 4105 can comprise at least two portions that are neither parallel nor perpendicular to each other when viewed in an axially symmetric cross-section (e.g., a cross-section through the center of the conductor in a direction parallel to the conductor). For example, the first ceramic component can comprise an inner diameter chamfer 4185. Further, the compound shape can comprise a protruding portion 4175 that substantially protrudes beyond a sealing interface (e.g., beyond a sealing interface on the ceramic component or beyond any combination of the sealing interfaces 4140, 4145, 4150 and 4155). The protruding portion can have a thickness 4180 and can substantially protrude beyond the sealing interface (e.g., braze joint) toward the conductor 4120. The inner diameter chamfer can extend along greater than or equal to about 10%, 20%, 30%, 40%, 50%, 60%, 70%, 80% or 90% of the thickness 4180. The inner diameter chamfer may be determined by the symmetric sealing interface length. For example, the chamfer may extend along the entire thickness of the protruding portion 4175 in order to match the sealing interface lengths of sealing interfaces without protruding portions. The chamfer may have an angle of greater than or equal to about 5°, 10°, 25°, 45°, 60°, 75° or 80°. Thus, the inner diameter chamfer may allow symmetric sealing interface lengths to be achieved when combining simple and shaped ceramic components within the seal. The protruding portion 4175 may protrude vertically downward from the seal (e.g., from the bottom of the entire seal to allow outer diameter fixturing) in a direction parallel to the conductor (e.g., parallel with the length of the conductor in a vertical direction). In this example, this downwardly protruding portion is longer than in the example of FIG. 40, thereby providing additional aid in fixturing (e.g., guided fixturing) of the seal and/or the conductor. The length of the downwardly protruding portion (e.g., of the L-shape) may allow, for example, the outer diameter fixture of the seal to hold the first ceramic in place. In some cases, external fixturing may be used to align at least a portion of components (e.g., in order to align all components of the seal/container/conductor assembly). Further, the conductor 4120 may comprise one or more shoulders 4190 that protrude from the diameter of the conductor and allow the second metal sleeve 4135 to self-fixture.

FIG. 35 is a cross-section of a seal 3500 with a concentric accordion joint. The seal 3500 is another example of a stacked configuration (e.g., a balanced configuration), and may, for example, increase flexibility (e.g., the cell may be configured to flex like a spring to absorb at least a portion of internal stresses caused by materials expanding/contracting upon heating/cooling without losing hermeticity), improve ease of manufacturing/assembly (e.g., supply chain, fabrication techniques and assembly) and/or improve operational durability (e.g., chemical corrosion resistance, electrochemical corrosion resistance and thermal stress management). Further, the seal may comprise seal ceramic component(s) of a complex shape. The ceramic component(s) may be exposed to reactive material 3570 within the cell housing. The seal may be configured for sealing (e.g., hermetically) a container maintained at a temperature of at least about 200 °C. (e.g., at least about 600 °C in some cases).

The seal may comprise one or more (e.g., 1 or 3) ceramic components (e.g., aluminum nitride (AlN), silicon nitride (Si₃N₄) or magnesium oxide (MgO) washers). In configurations with multiple ceramic components, additional ceramic components may be distributed (e.g., in a vertically symmetric configuration) around a first (e.g., center) ceramic component. At least two metal sleeves (e.g., zirconium or stainless steel sleeves) may be joined to the ceramic component. The metal sleeves may be flexible (e.g., bendable) to, for example, allow the seal to absorb at least a portion of internal thermal stresses in the seal.

The seal may comprise one or more face-sealing interfaces (e.g., braze joints) that are substantially perpendicular to a direction parallel to a conductor that passes through the seal. In some implementations, all interfaces, including metal-to-ceramic joints as well as metal-to-metal joints, may be face-sealing. This may allow braze foils to be utilized to join the seal and/or a reduced set of manufacturing steps (e.g., a single furnace run) to be performed. The face-sealing interfaces (e.g., braze joints) may be, for example, less than or equal to about 0.040 inches, 0.050 inches, 0.060 inches, 0.070 inches, 0.080 inches, 0.090 inches, 0.10 inches, 0.11 inches or 0.12 inches wide (e.g., from inner radius to outer radius). The face-sealing interfaces may be configured to reduce or minimize stress.

With continued reference to the example in FIG. 35, the seal 3500 comprises a first (e.g., center) ceramic component (e.g., AlN) 3505 joined to a first metal sleeve (e.g., Zr) 3510 and a second metal sleeve (e.g., Zr) 3515. In some implementations, the metal sleeves 3510 and 3515 may be substantially similar (e.g., identical). This may allow fewer unique parts to be manufactured per seal (e.g., the number of different diameters of rod stock and fabrication steps may be reduced). The seal further comprises a first coupler (e.g., 430 SS cell top coupler) 3520 between a container (e.g., cell top) 3525 and the first metal sleeve 3510. The first coupler 3520 may be flexible, thereby allowing the seal to absorb at least a portion of internal thermal stresses. The metal sleeves 3510 and 3515 and the first coupler 3520 may be shaped to create a spring to absorb stresses (e.g., internal stresses) related to thermal expansion, thus decreasing the amount of stress transferred to the ceramic components (e.g., insulators) of the seal. The seal further comprises a second coupler (e.g., 430 SS negative current lead (NCL) coupler) 3530 between a conductor (e.g., 430 SS negative current lead) 3535 and the second metal sleeve 3515. The first coupler 3520 and the second coupler 3530 may be joined with the first metal sleeve 3510 and the second metal sleeve 3515, respectively, via sealing interfaces (e.g., face-sealing braze joints) 3540.

The first metal sleeve 3510, the second metal sleeve 3515, the first coupler 3520 and/or the second coupler may be configured with a bend (e.g., at least about 10°, 20°, 30°, 45°, 60°, 75° or 80° slope) 3545 to allow for self-fixturing of the seal during assembly at room temperature and/or when the (e.g., entire) seal is at its brazing temperature. In an example, a bend of at least about 30° is used. Thus, the couplers may self-fixture with their respective metal sleeves. Gaps between these components may be configured to take into account each material's CTE such that interference is limited or eliminated upon heating up. Further, the first metal sleeve 3510, the second metal sleeve 3515 and/or the first coupler 3520 may comprise angled self-fixturing features. For example, the first metal sleeve 3510 and the first coupler 3520 may comprise complementary kinks or hooks 3560. Such self-fixturing features may allow parts to, for example, slide into position (e.g., align) during assembly. Similarly, the conductor 3535 may self-fixture with the second coupler 3530 (e.g., via mating connection 3565). Providing the conductor and the second coupler separately may in some cases reduce waste upon fabrication. The conductor may nest with second coupler and/or one or more other components of the seal. The metal sleeves 3510 and 3520 and/or the first coupler 3520 may be configured to limit waste upon fabrication (e.g., inner diameter and outer diameter choice of parts may allow more appropriate standard dimensions of feedstock to be used), allow easier (e.g., less time-consuming) and/or allow greater flexibility during fabrication (e.g., capability to use multiple different machining alternatives, such as, for example, lathe, CNC or stamping). The metal sleeves 3510 and 3520 may have a diameter of, for example, about 0.990 inches and a thickness of, for example, about 0.015 inches. In some cases, a single fixture, along with self-fixturing may be used to align all components of the seal and/or of the seal/container/conductor assembly.

In some implementations, the seal may further comprise additional ceramic components (e.g., AlN balancing ceramics). In this example, the seal comprises two additional ceramic components 3550 and 3555 joined with the first metal sleeve 3510 and the second metal sleeve 3515, respectively. One or more of the ceramic components may be chamfered. For example, only the first ceramic component, at least a portion of the ceramic components or all of the ceramic components may be chamfered. Different ceramic components may comprise substantially similar chamfers. Alternatively, different ceramic components may comprise different chamfers. The chamfer(s) may have an angle of greater than or equal to about 5°, 10°, 25°, 45°, 60°, 75° or 80°. The chamfers may aid in fixturing of seal components. Each ceramic component may have a given height (or width or another characteristic dimension). For example, the first ceramic component (e.g., corresponding to a shorting length) may have a height of less than or equal to about 0.200 inches, while the second and third ceramic components may have a height of less than or equal to about 100%, 80%, 60%, 40% or 20% of the height of the first ceramic. Stress modeling optimization may be used in some cases to guide or determine suitable thickness of materials.

At least a portion (e.g., all) of the face-sealing interfaces (e.g., the sealing interfaces between the ceramic components 3505, 3550 and 3555 and the metal collars 3510 and 3515, and the sealing interfaces 3540) can comprise, for example, about 0.060 inches wide (e.g., from inner radius to outer radius) braze joints. At least one of the face-sealing interfaces may be configured as a concentric accordion joint (e.g., concentric accordion in, such as, for example, in an axisymmetric seal as shown FIG. 36). A concentric accordion joint may comprise the first coupler 3520, the first metal sleeve 3510 and a sealing interface 3575. The concentric accordion joint may further comprise the first ceramic component 3505 and, in some cases, the second ceramic component 3550 and/or the sealing interface 3580. Another concentric accordion joint may be at least partially formed by the second coupler 3530, the second metal sleeve 3515 and a sealing interface 3585. This (e.g., partial) accordion joint may further comprise the first ceramic component 3505 and, in some cases, the third ceramic component 3555 and/or the sealing interface 3590. In some implementations, the concentric accordion joint may be used in non-axisymmetric seals (e.g., seals that are square or oval rather than circular).

FIG. 36 is a cut-away view of another example of a seal 3600 with a concentric accordion joint. The seal 3600 comprises a first (e.g., center) ceramic component (e.g., AlN) 3605 joined to a first metal sleeve (e.g., Zr) 3610 and a second metal sleeve (e.g., Zr) 3615, a first coupler (e.g., 430 SS cell top coupler) 3620 between a container (e.g., cell top) (not shown) and the first metal sleeve 3610, a second coupler (e.g., 430 SS negative current lead (NCL) coupler) 3630 between a conductor (e.g., 430 SS negative current lead) 3635 and the second metal sleeve 3615. The first coupler 3620 and the second coupler 3630 may be joined with the first metal sleeve 3610 and the second metal sleeve 3615, respectively, via sealing interfaces (e.g., face-sealing braze joints) 3640. The seal further comprises two additional ceramic components 3650 and 3655 joined with the first metal sleeve 3610 and the second metal sleeve 3615, respectively. The seal 3600 may be axially symmetric (as shown) and may be exposed to reactive material 3670 within container. In some cases, the conductor 3635 may comprise a hole 3680 (e.g., a threaded hole used to connect to a busbar/interconnect or an adjacent cell).

### Compound Seals

Seals of the disclosure may include compound seals (e.g., double seal) and compound seal cell cap assemblies (e.g., double seal cell cap assembly). Compound seals may seal a high temperature container from an environment external to the container. Such seals may be configured for sealing a container comprising a reactive material maintained at a temperature of at least about 200 °C. (e.g., at least about 600 °C in some cases). The seals may be exposed to an internal atmosphere of the container as well as an external atmosphere outside the container. The exposure internal and external atmospheres may place different materials requirements on the compound seal. While single seals may be configured to contain (e.g., hermetically) the internal materials of a cell, battery or other high-temperature device while resisting corrosion from the surrounding environments (e.g., inside and outside environments), a compound seal may divide the environments and address the sealing in different environments individually. For example, a double seal may be capable of withstanding two different environments. The double seal may comprise two seals joined together in such a manner that results in the double seal effectively resisting corrosion from both environments.

A compound seal may be advantageously used, for example, in situations where a set of stability (e.g., due to exposure), durability, lifetime, flexibility, space (e.g., nested seals), strength and/or other requirements are difficult to meet by a single set of materials. For example, a double seal may comprise a first seal that is stable when in contact with the reactive material (also “active stable seal” herein) and a second seal that is stable when in contact with the external environment such as, for example, air or any other type of surrounding atmosphere (collectively referred to as “air stable seal” herein). The reactive material may comprise, for example, a reactive metal or a vapor of a reactive metal, a molten salt or a vapor of a molten salt, or a combination thereof. The reactive metal may be molten or liquid. For example, the first seal may resist or withstand corrosion (e.g., electrochemical and chemical corrosion) by molten lithium and/or a molten lithium salt (e.g., LiCl, LiF or LiBr), and the second seal may (e.g., substantially) resist or withstand oxidation by air. For example, the second seal may resist oxidation by air resulting in an increase in a leakage rate (e.g., gas leakage rate) of the second seal (e.g., after an initial oxidation process resulting in a passivating and stable oxide layer, the second seal may resist further oxidation by air). The first seal may comprise a solid material that is not stable when in contact with the external environment, the second seal may comprise a solid material that is not stable when in contact with the reactive material, or a combination thereof. Alternatively, at least one of the seals may be of multiple types. For example, an air stable seal may in some cases be an active stable seal, and vice versa.

A given seal configuration may be used as an active stable seal and/or an air stable seal. In some cases, a seal configuration may be adapted for use as a given type of seal. For example, materials selection or sizing may be adapted to enable use of a given seal configuration as an active stable seal or an air stable seal. Examples of active stable seals include, for example, the seals in FIG. 35, FIG. 36, FIG. 39, FIG. 40 and FIG. 41. For example, the shaped ceramic seals of FIG. 39, FIG. 40 and FIG. 41 may be stable when in contact with the reactive material. A cell cap assembly of a cell or container that comprises the shaped seal ceramic may further comprise an additional seal that is stable when in contact with the external environment and within which the shaped seal is nested. Another example includes the concentric accordion joint seal of FIG. 35 and FIG. 36. In some examples, this seal may be stable when in contact with the reactive material but not when in contact with the external environment.

The seals of a compound seal may be synergistically combined. For example, if the current lead 4020 (e.g., the top of the protruding current lead 4020) of the seal 4000 in

FIG. 40 is physically attached or secured to the metal sleeve 4025 or 4030 or a cell lid (e.g., by one or more additional components not shown in FIG. 40, such as, for example, via an additional (e.g., air stable) seal used in combination (e.g., in a double seal configuration) with the (e.g., active stable) seal 4000), the metal sleeves 4030 and 4035 configured in accordance with FIG. 40 may put the ceramic component (e.g., center ceramic component) 4005 in compression (e.g., rather than in tension which may lead to expanded spaces within the seal as the center ceramic component is squeezed) as the seal is heated or cooled such that the ceramic component is compressed upon thermal expansion of the conductor, the container, and/or the additional seal. Such thermal expansion may be of importance in some implementations where, as the seal components are cooled after forming the seal (e.g., by brazing), they may contract at different rates due to different CTEs (e.g., with ceramics contracting the least and stainless steel parts, such as, for example, the conductor and/or the container, contracting the most) and the thermal expansion may effectively pull at the braze joints and ceramics of the seal, thus leading to mechanical failure in some cases. The switched locations of the metal sleeves 4030 and 4035 (e.g., with respect to the configuration in FIG. 21) may in some cases (e.g., for an AlN ceramic in a balanced ceramic seal configuration) flip the internal stresses of the ceramic component 4005 from being in tension to in compression.

A compound seal may comprise, for example, greater than or equal to 2, 3, 4, 5, 6, 7, 8, 9, 10, 12, 14 or more seals. When the number of seals is equal to or exceeds 2, individual seals may in some cases be exposed to atmospheres intermediate (e.g., mixtures) or altogether different (e.g., inert) from at least one of the internal and external atmospheres previously described. At least a portion (e.g., greater than or equal to about 1/10, ⅕, ¼, ⅓, ½ or more) of the seals in a compound seal may be hermetic. For example, the first and second seals in a double seal may each be hermetic.

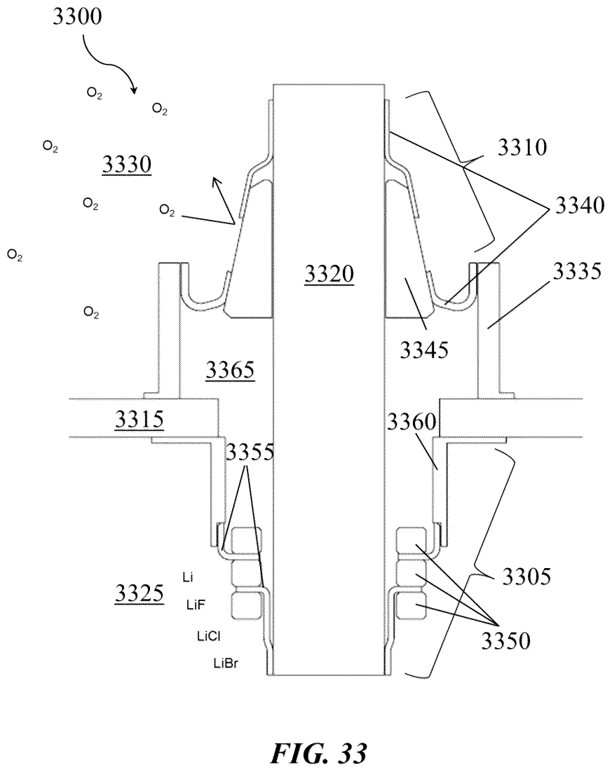

FIG. 33 is a cross-sectional view of an example of a double seal 3300. The double seal 3300 comprises a first seal (e.g., active stable seal) 3305 and a second seal (e.g., air stable seal) 3310. The first seal and the second seal may each provide a seal (e.g., electrically isolating seal) between a container (e.g., cell top) 3315 and a conductor (or a thermocouple or voltage sensor) 3320 that protrudes through the container through an aperture in the container. The first seal 3305 may be exposed to an atmosphere 3325 comprising, for example, active (e.g., reactive) cell materials (e.g., Li, LiF, LiCl or LiBr as shown). The first seal 3305 may be stable when in contact with the atmosphere 3325. The second seal 3310 may be exposed to an atmosphere 3330 comprising, for example air (e.g., O₂ as shown, with O₂ illustratively bouncing off of the seal). The second seal 3310 may be stable when in contact with the atmosphere 3330. The seal 3300 may comprise a pocket 3365 between the first and second seals.

Compound seals may comprise one or more seals arranged in a circumferential configuration, one or more seals arranged in a stacked configuration, or a combination thereof. In this example, the second seal is arranged in a circumferential configuration and the first seal is arranged in a stacked configuration. In a double seal, for example, the first and second seals may each be of any suitable configuration. In this example, the configuration of the first seal may be similar to the seal of FIG. 21 and the configuration of the second seal may be similar to the seal of FIG. 20. The first seal and the second seal may each comprise one or more insulators (e.g., ceramic components) and one or more collar or sleeves (e.g., metal collar or sleeves) adjacent to the insulator (e.g., ceramic component). For example, the first seal subassembly can comprise insulators (e.g., ceramics) 3350 and sleeves (e.g., metal) 3355, and the second seal sub-assembly can comprise an insulator (e.g., a ceramic) 3345 and sleeves (e.g., metal) 3340. The first seal may comprise an additional sleeve (e.g., metal) 3360 that joins the seal, via one of the sleeves 3355, with the cell top 3315. The second seal may be joined with the cell top 3315 via a bushing (e.g., an axisymmetric bushing) 3335 joined with one of the sleeves 3340. The first and second seals may each be joined with the conductor 3320 via one of the sleeves 3355 and 3340, respectively.

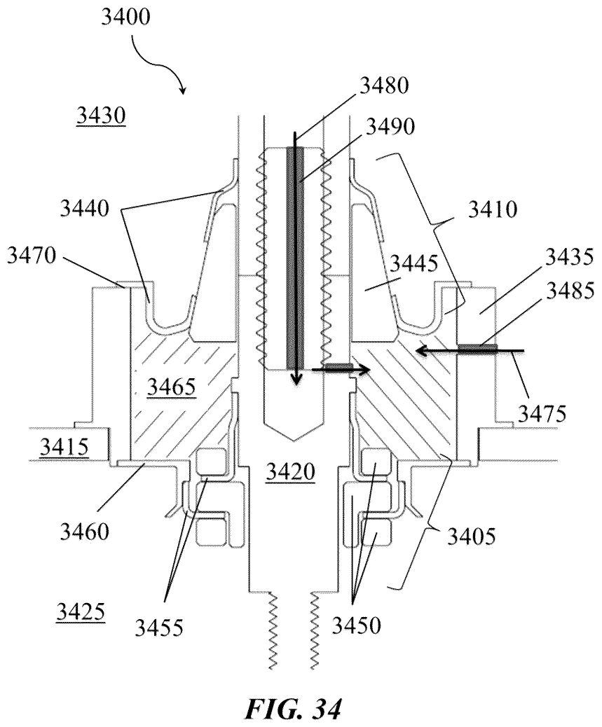

FIG. 34 is another example of a double seal 3400 comprising a first seal (e.g., active stable seal) 3405 and a second seal (e.g., air stable seal) 3410. In this example, the configuration of the first seal may be similar to the seal of FIG. 40 and the configuration of the second seal may be similar to or modified the seal of FIG. 20. The first seal subassembly can comprise insulators (e.g., 3 ceramic components including a shaped center ceramic component) 3450 and sleeves (e.g., metal) 3455, and the second seal sub-assembly can comprise an insulator (e.g., a ceramic) 3445 and sleeves (e.g., metal) 3440. The double seal may comprise a bushing 3435. In this example, the first and second seals are first joined with the bushing, and the bushing is joined with a container (e.g., cell top) 3415. The first seal may comprise an additional sleeve (e.g., metal) 3460 that joins the seal, via one of the sleeves 3455, with the bushing 3435. The second seal may be joined with the bushing 3435 via one of the sleeves 3340 (e.g., adapted to seal with the bushing at a horizontal sealing interface 3470 rather than a vertical sealing interface as is FIG. 33). The first and second seals may each be joined with a conductor 3420 via one of the sleeves 3455 and 3440, respectively.

The first seal 3405 may be exposed to an atmosphere 3425 comprising, for example, active (e.g., reactive) cell materials. Sealing of the first seal to the container 3415 may be performed in an environment comprising a first inert gas (e.g., He—Ar or He-inert gas mixture). Thus, the atmosphere 3425 may comprise the active cell materials mixed with inert gas and substantially no air or other external atmosphere 3430. The second seal 3310 may be exposed to an atmosphere 3430 comprising, for example, air. The seal 3400 may comprise a pocket 3465 between the first and second seals. The pocket may be filled, as indicated by arrows 3475 and 3480, with a second inert gas (e.g., He—Ar or He-inert gas mixture) via one or more ports 3485 and 3490, respectively, that allow the second inert gas to enter the pocket. The port 3475 may be provided, for example, in the bushing 3435 or in the conductor (also “negative current lead (NCL)” herein) 3420. The ports 3485 and 3490 may be used as alternatives or in concert. For example, the pocket may be filled either through the port 3490 comprising a hole through the conductor, or through the port 3485 comprising a hole through the bushing between the first seal and the second seal. In the example of FIG. 33, a port may be provided as a hole through the conductor 3320 or as a hole in the bushing 3335 between the second seal and the container 3315. The hole(s) in the conductor/bushing may provide process flexibility when joining the double seal (e.g., when manufacturing and assembling the first and second seals and joining them with the container).

Sealing a high temperature device, container or electrochemical cell comprising a container (e.g., container 3415) with a double seal (e.g., seal 3400) may include sealing a first seal (e.g., first seal 3405) in an environment comprising the first inert gas to capture the first inert gas inside the container. A second seal (e.g., second seal 3410) may then be sealed and may form a pocket (e.g., pocket 3465) between the first seal and the second seal. The first and/or second seals (e.g., each previously formed by laser-welding in an environment comprising a non-inert gas such as, for example, air) may be sealed to the container and a conductor (e.g., conductor 3320), by, for example, TIG-welding. As previously described, the first and second seals may in some cases be indirectly sealed to the container via, for example, a bushing (e.g., bushing 3335 or 3435). The first seal may be sealed to the container/conductor, followed by sealing the second seal to the container/conductor. Alternatively, the first and second seals may both be joined to the conductor and then sealed to the container (e.g., via the bushing), or the first and second seals may both be joined with the bushing/conductor and the bushing can then be sealed to the container. A cap assembly may comprise the container (e.g., cell lid) and the first seal, or the container, the first seal and the second seal.

The pocket may be filled with a second inert gas via a port (e.g., port 3485 and/or 3490) and then sealed (e.g., by closing the port via a weld), thus sealing the pocket and capturing the second inert gas in the pocket. The first and second inert gases may or may not be the same (e.g., may or may not have the same composition). For example, the first and/or second inert gas can comprise helium (He), argon (Ar), a mixture of He and Ar, a mixture of He and another inert gas (e.g., neon, krypton or xenon), a neat or mixed inert gas other than He and Ar, or any combination thereof. An inert gas may or may not be a noble gas and may in some cases include any gas that is stable in a given environment (e.g., stable with reactive material inside the container at cell operating temperature). The first and/or second inert gas may comprise, for example, between about 1% and 5%, 1% and 10%, 1% and 15%, 1% and 25% or 1% and 50% He with balance Ar. In an example, the first and second inert gases suitable for a liquid metal battery cell comprising lithium each comprise between about 1% and 15% He with remainder Ar.

FIG. 37 is a cross-sectional view of an example of an air stable seal 3700. The air stable seal 3700 comprises an insulator (e.g., a ceramic component) 3705 and at least two (e.g., metal) sleeves 3710 and 3715 joined to the ceramic component. In some cases, a CTE of at least one of the metal sleeves substantially matches a CTE of the ceramic component. For example, the ceramic component 3705 may comprise alumina and the metal sleeves 3710 may comprise an alloy comprising greater than or equal to about 42% Ni and greater than or equal to about 58% Fe, such as, for example, alloy 42. This may reduce internal stresses within the ceramic component (e.g., alloy 42 may be used for both sleeves, and its CTE may closely match the CTE of alumina, allowing low internal stresses within the alumina ceramic). The first metal sleeve (also “NCL sleeve” herein) 3710 may be joined with a conductor or NCL 3720. The second metal sleeve (also “cell top sleeve” herein) 3715 may be joined with a container (e.g., cell top) 3725. In some cases, the cell top sleeve may relieve stress (e.g., upon reheat). The seal 3700 may be stable when in contact with an external environment (e.g., air) 3730. The seal 3700 may also be exposed to and be stable when in contact with an environment (e.g., an inert gas, or a mixture of the environment 3730 and an inert gas) 3735. The seal 3700 may not be exposed to a reactive material or environment within the container (not shown). For example, the ceramic component 3705 may not be exposed to the reactive material. The seal 3700 may not be stable when in contact with the reactive material or environment within the container. In some cases, the seal 3700 may be stable when in contact with a mixture of the environment within the container and an inert gas. The seal 3700 may be hermetic (e.g., when maintained at a temperature of at least about 600 °C).

The seal 3700 may be suitable for use in a compound seal (e.g., in the double seals of FIG. 33 and FIG. 34 instead of the seals 3310 and 3410). For example, a high temperature device, container or electrochemical cell comprising the seal 3700 can also comprise an additional seal nested within the seal 3700 (see examples of nested seals in FIG. 33 and FIG. 34). The additional seal (e.g., active stable seal) may be stable when in contact with the reactive material within the container.

The seal 3700 may be configured to bear an increased amount of vertical load (e.g., to allow increased vertical weight). For example, the seal may be configured of bearing a vertical load of at least about 2 Newtons (N), 4 N, 6 N, 8 N, 10 N, 12 N, 14 N, 16 N, 18 N, 20 N, 25 N, 50 N, 75 N, 100 N, 500 N, 1,000 N, 2,000 N, 5,000 N or more. In an example, the seal is configured to bear a vertical load of at least about 10 Newtons. The vertical load-bearing capability may allow at least a portion of the load (e.g., vertical load from other cells) to be transferred to the container (e.g., as opposed to the additional seal).

The seal 3700 may be configured such that its height 3740 is small (e.g., smaller than in alternative seal configurations). A reduced height may allow cells (e.g., battery cells within a system) to be packed closer to one another (e.g., with a reduced spacing between vertically stacked electrochemical cells). In some cases, closer cell packing may enable or improve self-heating of group(s) of cells (e.g., facilitate implementation of a self-heating core). The height 3740 (e.g., above a top plate 3745 of the container) may be less than about 5 inches, 4 inches, 3 inches, 2 inches, 1 inch, 0.5 inch, 0.25 inch or 0.125 inch. The seal may be configured such that its diameter 3755 is large (e.g., smaller than in alternative seal configurations). The larger diameter may enable, for example, nesting of the additional (e.g., active stable) seal within this seal. The seal may have an outer diameter of, for example, at least about 0.5 inch, 1 inch, 1.5 inch, 2 inches, 2.5 inches, 3 inches or more. The conductor 3720 may protrude through the container through an aperture 3750 with a diameter of at least about 0.5 inch, 1 inch, 1.5 inch or 2 inches. In an example, the seal has an outer diameter of at least about 1 inch or the aperture is at least about 0.5 inches in diameter.

The metal sleeve 3710 and/or 3715 may have a thickness of less than or equal to about 0.040 inches, 0.030 inches, 0.020 inches or 0.010 inches. In an example, the metal sleeve(s) have a thickness of about 0.020 inches. The metal sleeve(s) may allow flexibility during fabrication (e.g., capability to use one or more fabrication methods such as lathe, CNC and stamping). The metal sleeve(s) may have an outer diameter of less than or equal to about 3 inches, 2 inches, 1.5 inches, 1 inch, 0.5 inch or less. In an example, the metal sleeve(s) have an outer diameter of 1.530 inches, which provides flexibility in manufacturing requirements. The NCL sleeve may be configured such that its diameter is, for example, larger than in alternative seal configurations; its shape may be configured to absorb stress as the seal heats up and grows due to thermal expansion. The ceramic component 3705 may have a characteristic dimension (e.g., height) of less than or equal to about 0.100, 0.150, 0.200, 0.250 or 0.300 inches and a width of less than or equal to about 100%, 80%, 60%, 40% or 20% of the characteristic dimension.

A first of the at least two metal sleeves may be joined to the ceramic component and the conductor via a braze joint with a braze length of less than or equal to about 0.040 inches, 0.060 inches, 0.070 inches, 0.080 inches or 0.100 inches (e.g., about 0.080 inches), thereby reducing thermal stresses at the braze joint. The cell top sleeve 3710 may be configured to decrease or minimize stress at the braze joint (e.g., through a reduced braze length between the ceramic and the metal).

FIG. 38 is a sectioned side view of the seal in FIG. 37, showing the structured shape of the seal. The seal may comprise a ceramic component 3805 joined with a first metal sleeve 3810 and a second metal sleeve 3815. The first metal sleeve may be joined with a conductor (not shown) and the second metal sleeve may be joined with a container or cell top (not shown).

In some implementations, seals, sub-assemblies, conductors and/or housings may comprise structural features (e.g., mating features) or be combined with structural members such as, for example, flanges, hooks, ledges, interlock features, weldable tabs, brazable tabs, snap fits, screw fits, screws, nuts, bolts and/or other structural members to facilitate a secure connection of the sealing arrangements herein. In some cases, such mating features may be used in concert with welding, brazing, coating, metalized surfaces, structural features for CTE mismatch, etc. Further, seals, sub-assemblies, conductors and/or housings may comprise structural features to facilitate interconnection between cells and groups of cells. In some cases, such features may be directed at reducing or minimizing stress and forces acting on seals as a result of interconnection. Further, the seals herein may be configured for use in concert with various interconnections features (e.g., current transfer plates). Configuration of the seals may in such cases include, for example, material considerations (e.g., material compatibility of seals and interconnections), desired system resistance (e.g., affecting choice of seal with a given resistance), space and operating condition considerations (e.g., affecting choice of a seal that is compatible with space constraints imposed by a given interconnection arrangement and/or operating conditions), and so on.

### Interconnections

Wired or wire-less (e.g., direct metal-to-metal) interconnections may be formed between individual electrochemical cells and/or between groups of electrochemical cells (e.g., modules, packs, cores, CEs, systems, or any other group comprising one or more electrochemical cells). In some cases, groups of cells may be joined via one or more cell-to-cell interconnections. In some cases, groups of cells may be joined via a group-level interconnection. The group-level interconnection may further comprise one or more interconnections with one or more individual cells of the group. The interconnections may be structural and/or electrical. Cells and/or groups of cells may be assembled (or stacked) horizontally or vertically. Such assembled cells and/or groups of cells may be arranged in series or parallel configurations. Further, groups of cells may be supported by various frames. The frames may provide structural support and/or participate or aid in forming the interconnections (e.g., frames on groups of cells may mate or be connected).

An interconnect may refer to any electrical connection other than a direct metal-to-metal joint. Interconnects can include wires or bent sheet metal components designed to pass current. Interconnects may be compliant (e.g., flexible). A wire may refer to any cord, strip, or elongated electrical conduit. Wires can be flexible. As used herein, a braided metal strip is a wire. In some cases, a busbar is a wire.

In some implementations, interconnections may be configured to decrease resistance (e.g., internal resistance) in a system (e.g., a battery). A battery with a low system resistance (e.g., such that the battery is capable of efficiently storing energy and delivering power) may be desirable in some cases. The system resistance can be determined by the combined effect of a plurality of resistances along the current flow path such as between electrochemical cells, within electrochemical cells, and between groups of electrochemical cells. In some cases, electrochemical cells or groups thereof are connected using interconnects. In some instances, an interconnect is a wire. However, the shortest possible electrical connection can generally lead to the lowest system resistance. Therefore, the present disclosure describes direct connection of cells to each other (e.g., by brazing), in some cases reducing or eliminating the use of wires to connect electrochemical cells.

In some implementations, a battery comprises a plurality of electrochemical cells connected in series, where the battery is capable of storing at least about 10 kWh of energy, the battery has an operating temperature of at least about 250 °C, and each of the electrochemical cells has at least one liquid metal electrode. The battery can be any suitable size. In some cases, the battery is capable of storing at least about 10 kilo-Watt-hours of energy. In some cases, the battery is capable of storing at least about 30 kilo-Watt-hours of energy. In some cases, the battery is capable of storing at least about 100 kilo-Watt-hours of energy.

The internal resistance of the battery can be any suitably low resistance. In some cases, the internal resistance of the battery (e.g., at the operating temperature) is less than or equal to about 2.5*n*R, where ‘n’ is the number of series connected modules of the battery and ‘R’ (also referred to herein as ‘R_{Module}’) is the resistance of each of the individual modules or parallel connected modules. In some examples, the inverse of R is the sum of the inverses of the resistance of each electrochemical cell in a given module, as given by, for example,

$$1 / {R}_{Module} = {\sum }_{i = 1}^{m} 1 / {R}_{i} ,$$

where ‘m’ is the number of cells in one module. Each module can include a plurality of electrochemical cells in a parallel configuration. Electrochemical cells in adjacent modules can be arranged in a series configuration (e.g., individual cells in a module can be connected in series with corresponding individual cells in an adjacent module, such as, for example, in a configuration where individual cells of a first module are connected in series with individual cells of a second module located above the first module). In some cases, the internal resistance of the battery (e.g., at the operating temperature) is less than or equal to about 2.5*n*R, 2*n*R, 1.5*n*R, 1.25*n*R or 1.05*n*R. In some cases, the total system resistance (e.g., at the operating temperature) is greater than about 1.0*n*R due to the resistance contribution of interconnects, busbars, surface contact resistance at connection interfaces, etc. The battery can comprise electrochemical cells connected in series and in parallel. The number of electrochemical cell modules (or parallel connected modules) that are connected in series (i.e., n) can be any suitable number. In some examples, n is at least 3, at least 5, at least 6, at least 10, at least 12, at least 15, at least 16, at least 20, at least 32, at least 48, at least 54, at least 64, at least 108, at least 128, at least 216, or at least 256. In an example, n is 3 (e.g., for a battery comprising a pack), 6 (e.g., for a battery comprising a pack), or 216 (e.g., for a battery comprising a core).

A wired or wire-less (e.g., direct metal-to-metal) interconnection between individual electrochemical cells and/or between groups of electrochemical cells can have a given internal resistance. In some cases, electrochemical cells are not connected with wires. In some examples, series connections (e.g., wire-less cell-to-cell connections, or current transfer plate connections) are created with a connection that has an internal resistance of less than or equal to about 0.05 milli-ohm (mOhm), 0.1 mOhm, 0.5 mOhm, 1 mOhm, 2 mOhm, 5 mOhm, 10 mOhm, 50 mOhm, 100 mOhm or 500 mOhm at an operating temperature greater than about 250 °C. In some instances, the resistance is measured by a direct electrical connection between the conductor of a first electrochemical cell and the electrically conducting housing of a second cell. In some cases, one or more busbars and/or interconnects can be used to create a connection between any two groups of cells. In some examples, such a connection has an internal resistance of less than or equal to about 0.01 mOhm, 0.05 mOhm, 0.1 mOhm, 0.2 mOhm, 0.5 mOhm, 1 mOhm, 5 mOhm, 10 mOhm, 50 mOhm or 100 mOhm.

In some instances, the resistance is measured by the voltage drop across a busbar (and/or interconnect) while current is flowing through the busbar (and/or interconnect) according to the following formula: R_{busbar}=V/I, where ‘R_{busbar}’ is the resistance of the busbar (and/or interconnect), ‘V’ is the measured voltage drop across the busbar (and/or interconnect) and ‘I’ is the current flowing through the busbar (and/or interconnect). Any aspects of the disclosure described in relation to internal resistance of cell-to-cell connections may equally apply to connections between groups of cells at least in some configurations, and vice versa. Further, any aspects of the disclosure described in relation to internal resistance of series connections may equally apply to parallel connections at least in some configurations, and vice versa.

In some implementations, an electrochemical energy storage system comprises at least a first electrochemical cell adjacent to a second electrochemical cell. Each of the first and second electrochemical cells can comprise a negative current collector, negative electrode, electrolyte, positive electrode and a positive currently collector. At least one of the negative electrode, electrolyte and positive electrode can be in a liquid state at an operating temperature of the first or second electrochemical cell. A positive current collector of the first electrochemical cell can be direct metal-to-metal joined (e.g., brazed or welded) to the negative current collector of the second electrochemical cell. In some examples, the negative current collector comprises a negative current lead.

In some cases, the first and second electrochemical cells are not connected by wires. In some cases, the electrochemical energy storage system comprises one or fewer interconnects for every 2, 3, 4, 5, 6, 7, 8, 9, 10, 11, 12, 13, 14, 15, 16, 17, 18, 19, 20, 21, 22, 23, 24, 25, 26, 27, 28, 29, 30 or more electrochemical cells. In some cases, the electrochemical energy storage system (e.g., battery) comprises one interconnect for at least every 1, 2, 3, 4, 5, 6, 7, 8, 9, 10, 15, 20, 25, 30, 40, 50, 75, 100, 150, 200, or more electrochemical cells.

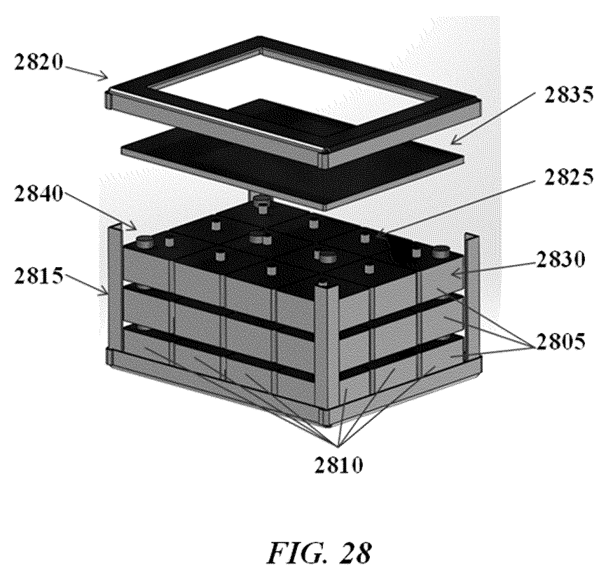

FIG. 28 shows an example of a cell pack 2800 comprising 3 modules 2805. Each of the modules comprises 12 cells 2830 that are connected in parallel 2810. The modules are held in place with cell pack framing (also “frame” herein) 2815 that includes a top component of the frame 2820. The cells are stacked directly on top of each other with the negative current terminal of one cell 2825 contacted directly with the housing of another cell (e.g., the cell above it). The negative current terminals of the top layer of cells will have no housing of another cell directly above, so can instead be contacted (e.g., brazed to) a negative busbar 2835.

In some configurations, the parallel connections 2810 made in the module can be created using a single piece (or component) with multiple pockets for cell materials. This piece can be a stamped component that allows for direct electrical connection between cells. In some examples, the stamped pocketed electrically conductive housing does not create a barrier between the cells. In some cases, the pocketed electrically conductive housing seals the pockets from each other. This electrically conductive housing can be easier to manufacture and assemble than individual electrically conductive cell housings. In some configurations, the parallel connections 2810 made in the module can be created by direct contact of the housings of the cells in the module. Cell packs can be attached in series and parallel in various configurations to produce cores, CEs, or systems. The number and arrangement of various groups of electrochemical cells can be chosen to create the desired system voltage and energy storage capacity. The packs, cores, CEs, or systems can then be enclosed together in high temperature insulation to create a system that can heat itself using the energy created from cells charging and discharging.

When stacked vertically, the electrochemical cells bear the weight of the cells stacked above. The cells can be constructed to support this weight. In some cases, cell-to-cell spacers 640 are placed between the layers of cells. These spacers can disperse the weight of the above cells and/or relieve some of the weight applied to the negative current terminals. In some cases, the negative current terminals are electrically isolated from the housing with a seal. This seal can be the weakest structural component of the electrochemical cell, so the spacers can reduce the amount of force applied to the seals.

In some implementations, a liquid metal battery comprises a plurality of electrochemical cells each comprising an electrically conductive housing and a conductor in electrical communication with a current collector. The electrically conductive housing can comprise a negative electrode, electrolyte and positive electrode that are in a liquid state at an operating temperature of the cell. The conductor can protrude through the electrically conductive housing through an aperture in the electrically conductive housing and can be electrically isolated from the electrically conductive housing with a seal. The plurality of electrochemical cells can be stacked in series with the conductor of a first cell in electrical contact with the electrically conductive housing of a second cell. The liquid metal battery can also comprise a plurality of non-gaseous spacers disposed between the electrochemical cells. In some cases, the electrochemical cells are stacked vertically. For example, at least 2, 3, 4, 5, 6, 7, 8, 9, 10, 15, 20, 25, 30, 36, 40, 48, 50, 60, 70, 80, 90, 100, 120, 140, 160, 180, 200, 216, 250, 256, 300, 350, 400, 450, 500, 750, 1000, 1500, 2000 or more electrochemical cells can be stacked in series. In some cases, the battery further comprises at least one additional electrochemical cell connected in parallel to each of the plurality of electrochemical cells that are stacked in series. For example, each vertically stacked cell can be connected in parallel with at least 1, 2, 3, 4, 5, 6, 7, 8, 9, 10, 15, 16, 20, 25, 30, 40, 50, 60, 70, 80, 90, 100, 120, 140, 160, 180, 200, 250, 300, 350, 400, 450, 500, 750, 1000, 1500, 2000 or more additional electrochemical cells. In some cases, the electrically conductive housings are part of a current conducting pathway.

The non-gaseous spacers (also “spacers” herein) can be a solid material. In some cases, the spacers comprise a ceramic material. Non-limiting examples of ceramic materials include aluminum nitride (AlN), boron nitride (BN), yttrium oxide (Y₂O₃), zirconium oxide (ZrO₂), yttria partially stabilized zirconia (YPSZ), aluminum oxide (Al₂O₃), chalcogenides, erbium oxide (Er₂O₃), silicon dioxide (SiO₂), quartz, glass, or any combination thereof. In some cases, the spacers are electrically insulating.

The spacers can have any suitable thickness. In some cases, the thickness of the spacer is approximately equal to the distance that the conductor protrudes out of the electrically conductive housing (e.g., the thickness of the spacer can be within less than or equal to about 0.005%, 0.01%, 0.05%, 0.1% or 0.5% of the distance that the conductor protrudes out of the electrically conductive housing).

The majority of the force (e.g., the weight of electrochemical cells stacked vertically above a cell) is generally born by the spacers and/or housing rather than the seals. The non-gaseous spacers and/or the electrically conductive housing can support any suitably high percentage of the applied force. In some cases, greater than or equal to about 70%, 80%, 90% or 95% of the force is applied to the non-gaseous spacers and/or the electrically conductive housing.

There can be any suitable amount of force applied to the electrically conductive housing and/or seal. In some instances, the force applied to the seal is no greater than the seal can support. In some cases, the force applied to the seal is less than or equal to about 10, 15, 20, 25, 30, 35, 40, 45, 50, 60, 70, 80, 100, 120, 150 or 200 Newtons (N). In some cases, the force applied to the housing is greater than or equal to about 100, 500, 1,000, 5,000 or 10,000 N.

There can be any suitable amount of pressure applied to the electrically conductive housing and/or seal. In some instances, the pressure applied to the seal is no greater than the seal can support. In some cases, the pressure applied to the seal is less than or equal to about 1, 10, 50, 100, 200, 300 or 500 pounds per square inch (psi). In some cases, the pressure applied to the housing is greater than or equal to about 500, 1,000, 2,000, 2,500, 3,000, 5,000 or 10,000 psi.

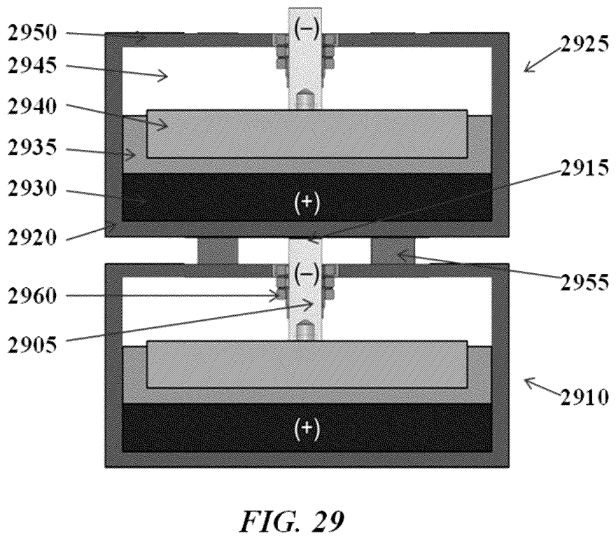

The cell to cell connections can be configured in a variety of ways based on tolerances and optimal conductive path. In one configuration, the top face of the negative current lead in one cell can be direct metal-to-metal joined (e.g., brazed, welded) to the bottom of the cell above it (see, for example, FIG. 29). Other configurations can include, for example, alternative direct metal-to-metal joined (e.g., alternative braze joined) configurations, such as an outer diameter braze enhanced by differences in the coefficient of thermal expansion (CTE) of the inner rod and the outer fixture (see, for example, FIG. 30). of thermal expansion (CTE) of the inner rod and the outer fixture (FIG. 30).

In some cases, as shown in FIG. 29, the conductor 2905 of a first cell 2910 is brazed 2915 to the electrically conductive housing 2920 of the second cell 2925. The braze material can be any suitable material. Some non-limiting examples of braze materials include materials that comprise iron (Fe), nickel (Ni), titanium (Ti), chromium (Cr), zirconium (Zr), phosphorus (P), boron (B), carbon (C), silicon (Si), or any combination thereof. The cell can comprise a cathode 2930, an electrolyte 2935 and an anode 2940 connected to the current collector and conductor 2905. The conductor can feed through the cell lid 2950. In some cases, the cell has some empty head space 2945.

In some implementations, the conductor 2905 can feed through a seal 2960 in the cell lid 2950. The conductor (e.g., negative current lead) 2905 may rigid. The seal 2960 may not be rigid. As additional cells are added during assembly, an increasing weight can be exerted on the conductor 2905 of the bottom cell 2910 by the housing 2920 of the top cell 2925 (e.g., at the position 2915). In some instances, the vertical spacing between the cells 2910 and 2925 may decrease if the seal 2960 (with the conductor 2905 and the anode 2940) move downward into the cell 2910 as a result of the compression force. To ensure that modules are electrically isolated from each other, spacers (e.g., ceramics) 2955 can be placed across the surface of the cells to support the cells above them. In this configuration, the cell housing can be used as the main structural support for the system. The ceramic spacer 2955 can relieve the seal 2960 from having to support the weight of the top cell 2925 (and any additional cells added during assembly). In some configurations, there may initially be a gap between the top of the spacers 2955 and the bottom of the housing 2920 of the top cell 2925 (e.g., the thickness of the spacer can be slightly less than the distance that the conductor initially protrudes through the electrically conductive housing), and the spacers (e.g., ceramics) can be placed in compression during assembly as additional cell(s) are added (e.g., as the spacing between the top of the housing of the bottom cell 2910 and the bottom of the housing of the top cell 2925 decreases). As a result, the displacement (also “anode-cathode displacement” herein) between anodes and cathodes (e.g., final displacement after assembly between the anode 2940 and the cathode 2930 in cell 2910) can in some cases be determined by the non-gaseous spacers. In some configurations, the spacers can be placed in compression right away (e.g., if the thickness of the spacer is slightly greater than the distance that the conductor initially protrudes through the electrically conductive housing).

In some cases, differences in the coefficient of thermal expansion (CTE) can be used to connect two cells. As shown in FIG. 30, the conductor of the first cell 3005 sits in a recessed portion of the electrically conductive housing of the second cell 3010, and the coefficient of thermal expansion (CTE) of the conductor 3015 is greater than the CTE of the electrically conductive housing 3020.

The CTE of the conductor can be any amount greater than the CTE of the electrically conductive housing. In some cases, the CTE of the conductor is greater than or equal to about 2%, 5%, 10%, 15%, 20%, 30%, 40%, 50%, 60%, 70%, 80%, 90% or 100% greater than the CTE of the electrically conductive housing.

Cells stacked vertically in series can be attached through a direct or hard electrical connection such that the height from 2950 to 2940 and/or anode-cathode displacement (ACD) can be determined by the dimensional tolerance of 2955. In some examples, the height from 2950 to 2940 can be at least about 3 millimeters (mm), 5 mm, 7 mm, 10 mm, 15 mm, and the like. In some examples, the ACD can be at least about 3 mm, 5 mm, 7 mm, 10 mm, 15 mm or greater. FIG. 29 is an example of how such connections may be configured.

Cells stacked vertically in series can be connected using a direct (e.g., metal-to-metal) electrical connection such that resistance per cell connection is reduced, for example, below about 100 mOhm (or another internal resistance value described elsewhere herein).

FIG. 29 is an example of how such connections may be configured. FIG. 29 also provides an example of a CTE mismatched seal connection.

In some implementations, cells can be joined vertically using a current transfer plate that can be connected (e.g., welded) to the negative current lead or conductor on the bottom cell, and the cell body (e.g., electrically conductive housing) on the top cell. The negative current lead can protrude through a housing of the bottom cell through a seal. For example, multiple cells can be connected in parallel into a cell module or a partial cell module, and then connected in series with other cell modules or partial cell modules via vertical stacking. The vertical stacking can be implemented by connecting the current transfer plate from one cell to the cell body or a feature on the cell body on the cell above it (e.g., to form the basis of a cell pack). The current transfer plate can be formed from a conductive material, such as any conductive material described herein. The current can comprise one or more surfaces (e.g., a flat surface) that can be welded or otherwise direct metal-to-metal joined with another surface (e.g., a cell body or a feature on the cell body of an adjacent cell). The current transfer plate can extend from the negative current lead toward the periphery of the cell surface comprising the negative current lead. Such configurations can enable electrical connections to be more conveniently made in tight spaces between cells or in cell assemblies (e.g., more convenient access during vertical stacking of cells).

In some examples, the welded connection can have an internal resistance of about 0.05 milliohm (mOhm), about 0.1 mOhm, about 0.5 mOhm, about 1 mOhm, about 2 mOhm, about 5 mOhm, about 10 mOhm, about 50 mOhm, about 100 mOhm, or about 500 mOhm at an operating temperature greater than 250 °C. In some examples, the series connections can be created with a connection that has an internal resistance of less than about 0.05 mOhm, less than about 0.1 mOhm, less than about 0.5 mOhm, less than about 1 mOhm, less than about 2 mOhm, less than about 5 mOhm, less than about 10 mOhm, less than about 50 mOhm, less than about 100 mOhm, or less than about 500 mOhm at an operating temperature greater than about 250 °C.

The current transfer plate may be combined with or comprise a strain relieving function to reduce stress on the seal (e.g., the seal around the negative current lead) that may be generated by the welding/joining process and/or thermal expansion differences during heat-up and/or cool-down, and/or stresses generated when cells and/or packs are vertically stacked on top one another. In some cases, the stresses on the seal may be reduced by including an electrically insulating non-gaseous (e.g., ceramic) spacer. The non-gaseous spacer can support the weight from the current transfer plate and/or cells stacked onto the current transfer plate and direct the weight onto the housing (e.g., the cell cap), thereby reducing the portion of the applied weight that is transmitted through the seal. In some cases, the strain relieving function may include a spiral pattern (e.g., a single spiral arm or multiple spiral arms) or other feature on the current transfer plate to give the current transfer plate compliance and may reduce stress experienced by the seal as the cells are stacked on top one another or during heat-up due to CTE mismatches. The spiral pattern may comprise one or more spiral arms. The spiral arms may be, for example, less than or equal to about 0.5 mm, 1 mm, 2 mm or 4 mm thick. The spiral arms may create a spiral that has a circular or oval external shape that is greater than or equal to about 1 cm, 2 cm, 3 cm or 4 cm or larger in diameter. In some cases, the current transfer plate may be sufficiently compliant such that the strain relieving feature is not needed.

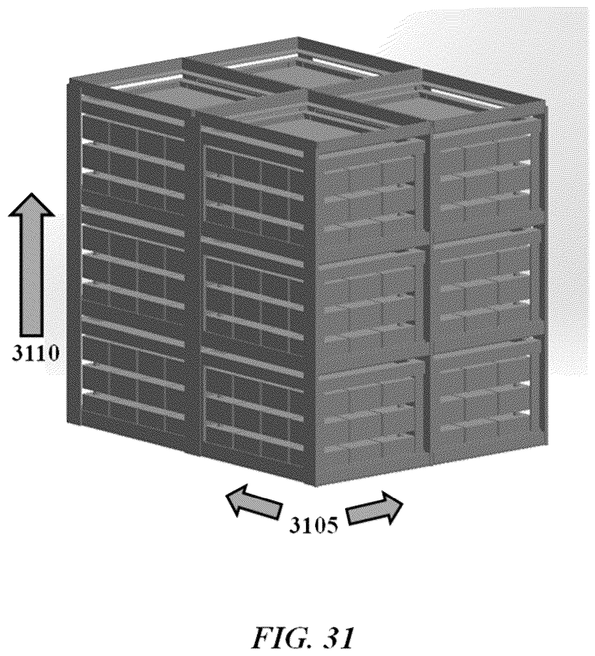

Cell packs can be attached in series and parallel in various configurations to produce cores, CEs, or systems. The number and arrangement of various groups of electrochemical cells can be chosen to create the desired system voltage and energy storage capacity. The packs, cores, CEs, or systems can then be enclosed together in high temperature insulation to create a system that can heat itself using the energy created from cells charging and discharging. For example, FIG. 31 is an example of how packs can be configured, indicating that the cell packs in a given plane are connected to one another in parallel 3105, while the packs connected directly atop one another are connected in series 3110.

The packs themselves can be connected vertically and horizontally to one another through busbars (e.g., unlike the cell-to-cell connections within a pack which can generally be direct connections such as brazes or welds). In some cases, the busbar is flexible or comprises a flexible section (e.g., to accommodate non-isothermal expansion of the system throughout heat up and operation). In some cases, the busbar comprises or is connected via a compliant interconnection component (e.g., braided metal or metal alloy, or bent sheet metal) that may or may not comprise the same material as the (rest of the) busbar. The busbar and/or the compliant interconnection component can comprise a conductive material (e.g., stainless steel, nickel, copper, aluminum-copper based alloy, or any combination thereof). The pack may further comprise or form other or additional interconnections (e.g., to allow the pack to be interconnected with additional packs). In some implementations, busbars may be used to provide pack-level electrical connections/interconnections (e.g., only busbars may be used for pack-level electrical connections/interconnections).

A busbar can be used to make an electrical connection with cells in a parallel string (e.g., a parallel string of cells, a parallel string of packs, etc.). In some examples, a busbar can be used to configure a set of cells or cell modules into a parallel string configuration by being electrically connected with the same terminal on all of the cells or cell modules (e.g., the negative terminals of all of the cells or cell modules, or the positive terminals of all of the cell or cell modules). For example, a positive busbar and/or a negative busbar may be used. The positive busbar can be connected to the housing and may or may not need to be flexible. In some cases, the positive busbar may not be used. The negative busbar can be joined to features in (or on) one or more of the cell bodies (e.g., the cell bodies of individual cells in a pack) to provide a strong electrical connection. In some cases, the negative busbar can be attached to conductive feed-throughs (e.g., negative current leads), which may require some compliance for thermal expansion. For example, a flexible connection between a relatively rigid busbar core and the feed-through may be achieved using a compliance feature between the feed-through and the busbar. The compliance feature may involve a spiral pattern (e.g., a single spiral arm or multiple spiral arms) that may be created by cutting away and/or removing material from a flat busbar in the desired pattern. The spiral pattern may comprise one or more spiral arms. The spiral arms may be, for example, less than or equal to about 0.5 mm, 1 mm, 2 mm or 4 mm thick. The spiral arms may create a spiral that has a circular or oval external shape that is greater than or equal to about 1 cm, 2 cm, 3 cm or 4 cm or larger in diameter. In some cases, the busbar may be sufficiently compliant such that the compliance feature is not needed. In configurations where cells are stacked vertically atop one another, the busbar at the top of the cell stack (e.g., cell pack stack) can comprise only the negative busbar (e.g., since the positive terminal of the stack can be on the bottom cell in the stack).

The core may be designed with multiple packs electrically connected in series and/or in parallel. The packs that are part of the core may be contained (e.g., all contained) within a single thermally managed chamber (also “thermal chamber” herein). For example, thermal insulation may surround a set of packs, thus maintaining (e.g., keeping) the packs (e.g., all packs) in good thermal contact with each other and thermally insulating the packs (e.g., all of the packs) from ambient conditions. In some cases, the core comprises electrically powered heaters installed near an inner surface of at least a portion of the insulation, electrically powered heaters distributed throughout the internal heated zone and/or connected to cell packs, or a combination thereof. The core may further comprise a frame (e.g., an internal metal frame). In some cases, the packs are arranged on trays that are arranged in a vertical and/or a horizontal stack. Each tray can provide mechanical support for the packs (e.g., the tray can comprise a frame). A plurality of trays (e.g., 2, 3, 4, 5, 10, 15, 20, 25, 30 or more trays) can be assembled into a core. The trays can be supported with the internal metal frame in the core.

Thermal insulation and/or frames may be provided with various groups of cells herein. The thermal insulation and/or the frame(s) may be configured to allow a group of cells to be cooled, the insulation to be removed, and individual or sets of subgroups of cells (or individual cells) to be disconnected, removed and/or replaced. For example, the thermal insulation and/or the frame may be designed to allow the core (and/or any system of the disclosure) to be cooled, the insulation to be removed, individual or sets of packs to be disconnected and removed from the core to allow for a single pack to be disconnected, removed and replaced, or any combination thereof. In some cases, a tray can be disconnected and removed from the core to allow for a single pack to be disconnected, removed and replaced, or any combination thereof. The core can then be reassembled and heated back up to operating temperature to allow for resumed operation. The thermal insulation and/or frames may further be configured to allow thermal management (e.g., modular thermal management) of individual cells or portion(s) thereof, groups of cells, or devices or systems comprising such cell(s).

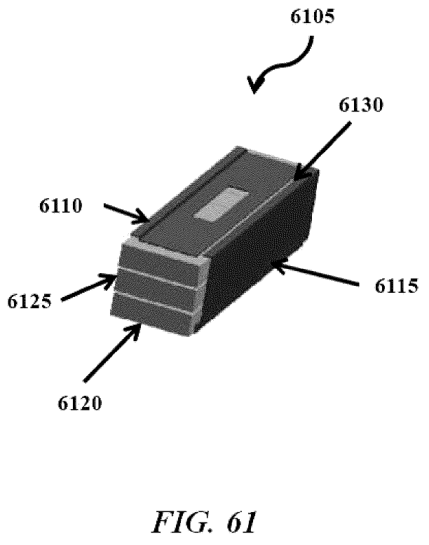

One or more interconnects can be used to connect the busbar of one pack to the busbar of another cell pack, thereby placing the cell packs in parallel or in series. In some cases, the negative busbar of one cell pack is connected to the positive busbar of another cell pack using a compliant interconnection component (also “interconnect” herein). In some cases, the interconnect may be braided metal or metal alloy. In some cases, the interconnect may be made from sheet metal and take the form of a bent sheet that is less than or equal to about 1/32 inch, 1/16 inch, ⅛ inch or ¼ inch thick. In some cases, the interconnect may comprise the same conductive material as the busbar. In some cases, the positive busbar and the interconnect are the same component (see, for example, FIG. 61).

The busbar and/or interconnect components can comprise a conductive material. For example, the busbar and/or interconnect components can comprise (e.g., be made of) stainless steel, nickel, copper, aluminum-copper based alloy, or any combination thereof.

The pack may further comprise or form other interconnections (e.g., to allow the pack to be interconnected with additional packs), including, but not limited to, additional interconnects, additional busbars and/or additional connection interfaces. In some implementations, busbars may be used to provide pack-level electrical connections/interconnections (e.g., only busbars may be used for pack-level electrical connections/interconnections).

In configurations where cells are stacked vertically atop one another, the busbar at the top of the cell stack (e.g., cell pack stack) can comprise only the negative busbar (e.g., since the positive terminal of the stack can be on the bottom cell in the stack).

The thermal insulation and/or the frame may be designed to allow the core (and/or any system of the disclosure) to be cooled, the insulation to be removed, individual or sets of packs to be disconnected and removed from the core to allow for a single pack to be disconnected, removed and replaced, or any combination thereof. The core can then be reassembled and heated back up to operating temperature to allow for resumed operation.

Various interconnection configurations described herein in relation to individual cells or a given group of cells may equally apply to other groups of cells (or portions thereof) at least in some configurations. In one example, interconnections such as, for example, brazed positive and negative current collectors of cells, braze enhanced by differences in coefficients of thermal expansion, connecting (e.g., welding) cell bodies or features in cell bodies, etc., may apply to (or be adapted to) groups of cells such as, for example, modules, packs, etc. In another example, interconnections such as, for example, stamped pocketed electrically conductive housing in cells and/or modules, etc., may apply to (or be adapted to) groups of cells such as, for example, modules, packs, etc. In yet another example, interconnections such as, for example, busbars/interconnects between packs, etc., may in some cases apply to (or be adapted to) groups of cells such as, for example, cores, etc. Further, stress-relieving configurations (e.g., current transfer plates between cells, spacers, spiral relief or compliance features/structures/patterns, etc.) and electrical/structural features (e.g., end-caps, etc.) may in some cases be applied to (or be adapted to) any group of cells herein. The various interconnection configurations may be applied at group level or to individual cells. Thus, in an example, a spacer used between cells may be configured for use as a spacer between packs, a current transfer plate between cells may be configured for use between modules, an interconnection interface comprising a feature on a cell body for connecting cell bodies within a module may be configured for connecting cell bodies of outer cells on adjacent packs, and so on. Further, interconnections described in relation to forming a series connection may be in some cases be adapted to forming a parallel connection, and vice versa.

### Electrochemical Energy Storage Cells, Devices and Systems

The disclosure provides electrochemical energy storage devices (batteries) and systems. An electrochemical energy storage device generally includes at least one electrochemical cell, also “cell” and “battery cell” herein, sealed (e.g., hermetically sealed) within a housing.

An electrochemical cell of the disclosure may include a negative electrode, an electrolyte adjacent to the negative electrode, and a positive electrode adjacent to the electrolyte. The negative electrode can be separated from the positive electrode by the electrolyte. The negative electrode can be an anode during discharging. The positive electrode can be a cathode during discharging. In some examples, an electrochemical cell is a liquid metal battery cell. In some examples, a liquid metal battery cell can include a liquid electrolyte arranged between a negative liquid (e.g., molten) metal electrode and a positive liquid (e.g., molten) metal, metalloid and/or non-metal electrode. In some cases, a liquid metal battery cell has a molten alkali metal (e.g., lithium, magnesium, sodium) negative electrode, an electrolyte, and a molten metal positive electrode. The molten metal positive electrode can include one or more of tin, lead, bismuth, antimony, tellurium and selenium. Any description of a metal or molten metal positive electrode, or a positive electrode, herein may refer to an electrode including one or more of a metal, a metalloid and a non-metal. The positive electrode may contain one or more of the listed examples of materials. In an example, the molten metal positive electrode can include lead and antimony. In some examples, the molten metal positive electrode may include an alkali metal alloyed in the positive electrode.

In some examples, an electrochemical energy storage device includes a liquid metal negative electrode, a liquid metal positive electrode, and a liquid metal electrolyte separating the liquid metal negative electrode and the liquid metal positive electrode. The negative electrode can include an alkali metal, such as lithium, sodium, potassium, rubidium, cesium, or combinations thereof. The positive electrode can include elements selected from Group IIIA, IVA, VA and VIA of the periodic table of the elements, such as aluminum, gallium, indium, silicon, germanium, tin, lead, pnicogens (e.g., arsenic, bismuth and antimony), chalcogens (e.g., tellurium and selenium), or combinations thereof. The electrolyte can include a salt (e.g., molten salt), such as an alkali metal salt. The alkali metal salt can be a halide, such as a fluoride, chloride, bromide, or iodide of the active alkali metal, or combinations thereof. In an example, the electrolyte includes lithium chloride. As an alternative, the salt of the active alkali metal can be, for example, a non-chloride halide, bistriflimide, fluorosulfano-amine, perchlorate, hexaflourophosphate, tetrafluoroborate, carbonate, hydroxide, or combinations thereof.

In some cases, the negative electrode and the positive electrode of an electrochemical energy storage device are in the liquid state at an operating temperature of the energy storage device. To maintain the electrodes in the liquid states, the battery cell may be heated to any suitable temperature. In some examples, the battery cell is heated to and/or maintained at a temperature of about 200 °C, about 250 °C, about 300 °C, about 350 °C, about 400 °C, about 450 °C, about 500 °C, about 550 °C, about 600 °C, about 650 °C, or about 700 °C. The battery cell may be heated to and/or maintained at a temperature of at least about 200 °C, at least about 250 °C, at least about 300 °C, at least about 350 °C, at least about 400 °C, at least about 450 °C, at least about 500 °C, at least about 550 °C, at least about 600 °C, at least about 650 °C, or at least about 700 °C. In some situations, the battery cell is heated to between 200 °C and about 500 °C, or between about 300 °C and 450 °C.

Electrochemical cells of the disclosure may be adapted to cycle between charged (or energy storage) modes and discharged modes. In some examples, an electrochemical cell can be fully charged, partially charged or partially discharged, or fully discharged.

In some implementations, during a charging mode of an electrochemical energy storage device, electrical current received from an external power source (e.g., a generator or an electrical grid) may cause metal atoms in the metal positive electrode to release one or more electrons, dissolving into the electrolyte as a positively charged ion (i.e., cation). Simultaneously, cations of the same species can migrate through the electrolyte, and may accept electrons at the negative electrode, causing the cations to transition to a neutral metal species, thereby adding to the mass of the negative electrode. The removal of the active metal species from the positive electrode and the addition of the active metal to the negative electrode stores electrochemical energy. During an energy discharge mode, an electrical load is coupled to the electrodes and the previously added metal species in the negative electrode can be released from the metal negative electrode, pass through the electrolyte as ions, and alloy with the positive electrode, with the flow of ions accompanied by the external and matching flow of electrons through the external circuit/load. This electrochemically facilitated metal alloying reaction discharges the previously stored electrochemical energy to the electrical load.

In a charged state, the negative electrode can include negative electrode material and the positive electrode can include positive electrode material. During discharging (e.g., when the battery is coupled to a load), the negative electrode material yields one or more electrons and cations of the negative electrode material. The cations migrate through the electrolyte to the positive electrode material and react with the positive electrode material to form an alloy. During charging, the alloy at the positive electrode disassociates to yield cations of the negative electrode material, which migrates through the electrolyte to the negative electrode.

In some examples, ions can migrate through an electrolyte from an anode to a cathode, or vice versa. In some cases, ions can migrate through an electrolyte in a push-pop fashion in which an entering ion of one type ejects an ion of the same type from the electrolyte. For example, during discharge, a lithium anode and a lithium chloride electrolyte can contribute a lithium cation to a cathode by a process in which a lithium cation formed at the anode interacts with the electrolyte to eject a lithium cation from the electrolyte into the cathode. The lithium cation formed at the anode in such a case may not necessarily migrate through the electrolyte to the cathode. The cation can be formed at an interface between the anode and the electrolyte, and accepted at an interface of the cathode and the electrolyte.

Electrochemical cells of the disclosure can include housings that may be suited for various uses and operations. A housing can include one cell or a plurality of cells. A housing can be configured to electrically couple the electrodes to a switch, which can be connected to the external power source and the electrical load. The cell housing may include, for example, an electrically conductive container that is electrically coupled to a first pole of the switch and/or another cell housing, and an electrically conductive container lid, a portion of which is electrically coupled to a second pole of the switch and/or another cell housing. The cell can be arranged within a cavity of the container. A first one of the electrodes of the cell can contact and be electrically coupled with an endwall of the container. An electrically insulating sheath (e.g., alumina sheath) may electrically insulate remaining portions of the cell from other portions of the container. A conductor can electrically couple a second one of the electrodes of the battery cell to the container lid, which can seal (e.g., hermetically seal) the battery cell within the cavity. The container and the container lid can be electrically isolated. As an alternative, a housing does not include an electrically insulating sheath. In some cases, a housing and/or container may be a battery housing and/or container. An electrically conductive sheath (e.g. graphite sheath) may prevent the cathode from wetting up the side walls of the container.

A battery, as used herein, can comprise a plurality of electrochemical cells. Individual cells of the plurality can be electrically coupled to one another in series and/or in parallel and/or a combination of series and parallel connections. In serial connectivity, the positive terminal of a first cell is connected to a negative terminal of a second cell. In parallel connectivity, the positive terminal of a first cell can be connected to a positive terminal of a second cell.

In order to subject the dielectric gasket to such high compressive forces, the fasteners may have relatively large diameters and may be closely spaced together. Such large diameter fasteners may be expensive and, thus, may significantly increase the cost to build a relatively large diameter container. In addition, as the diameter of the dielectric gasket is increased to accommodate a large diameter container, the gasket may become more and more fragile and difficult to maneuver.

In another aspect of the present disclosure, an energy storage device comprises at least one liquid metal electrode. The energy storage device can have a high energy storage capacity and a fast response time. The liquid metal electrode can be an anode or a cathode of the energy storage device. In some embodiments, the energy storage devices comprises a liquid metal anode (e.g., lithium, sodium, calcium, and/or potassium) and a liquid metal cathode (e.g., antinomy, bismuth, tellurium, tin, and/or lead). The energy storage device can also comprise a liquid electrolyte. In some embodiments, the reactions that occur at the electrode and liquid metal electrode interfaces are extremely facile, permitting high current density operation with minimal electrode overpotentials and extremely fast response times.

The energy storage capacity can be any suitably large value (e.g., suitable for grid-scale energy storage), including about 1 kWh, about 10 kWh, about 20 kWh, about 30 kWh, about 100 kWh, about 500 kWh, about 1 MWh, about 5 MWh, about 10 MWh, about 50 MWh, about 100 MWh, and the like. In some embodiments, the energy storage capacity is at least about 1 kWh, at least about 10 kWh, at least about 20 kWh, at least about 30 kWh, at least about 100 kWh, at least about 500 kWh, at least about 1 MWh, at least about 5 MWh, at least about 10 MWh, at least about 50 MWh, at least about 100 MWh and the like.

The response time can be any suitable value (e.g., suitable for responding to disturbances in the power grid). In some instances, the response time is about 100 milliseconds (ms), about 50 ms, about 10 ms, about 1 ms, and the like. In some cases, the response time is at most about 100 milliseconds (ms), at most about 50 ms, at most about 10 ms, at most about 1 ms, and the like.

In some embodiments, the liquid metal electrode comprises an alkali earth metal, a metalloid, or combinations thereof. In some embodiments, the liquid metal electrode comprises lithium, sodium, potassium, magnesium, calcium, or any combination thereof. In some cases, the liquid metal electrode comprises antimony, lead, tin, tellurium, bismuth or combinations thereof.

In some embodiments, the device is comprised in an array of energy storage devices as part of an energy storage system. The device can be an energy storage cell, and the energy storage system comprises a plurality of energy storage cells.

In another aspect of the present disclosure, an energy storage device comprises at least one liquid metal electrode stored in a container at a temperature greater than or equal to about 250 °C. The energy storage device can have a high energy storage capacity and the container can have a surface area-to-volume ratio that is less than or equal to about 10 m⁻¹.

The energy storage capacity can be any suitably large value (e.g., suitable for grid-scale energy storage), including about 1 kWh, about 10 kWh, about 20 kWh, about 30 kWh, about 100 kWh, about 500 kWh, about 1 MWh, about 5 MWh, about 10 MWh, about 50 MWh, about 100 MWh, and the like. In some embodiments, the energy storage capacity is at least about 1 kWh, at least about 10 kWh, at least about 20 kWh, at least about 30 kWh, at least about 100 kWh, at least about 500 kWh, at least about 1 MWh, at least about 5 MWh, at least about 10 MWh, at least about 50 MWh, at least about 100 MWh and the like.

In some embodiments, the surface area-to-volume ratio is about 100 m⁻¹, about 50 m⁻¹, about 10 m⁻¹, about 1 m⁻¹, about 0.5 m⁻¹, about 0.1 m⁻¹, about 0.01 m⁻¹, or about 0.001 m⁻¹. In some cases, the surface area-to-volume ratio is less than about 100 m⁻¹, less than about 50 m⁻¹, less than about 10 m⁻¹, less than about 1 m⁻¹, less than about 0.5 m⁻¹, less than about 0.1 m⁻¹, less than about 0.01 m⁻¹, or less than about 0.001 m⁻¹.

The temperature can be any suitable temperature (e.g., for maintaining the electrodes in a molten state). In some embodiments, the at least one liquid metal electrode is stored in the container at a temperature greater than or equal to about 250 °C, greater than or equal to about 400 °C, greater than or equal to about 450 °C greater than or equal to about 500 °C or greater than or equal to about 550 °C.

In another aspect of the present disclosure, an energy storage device comprises at least one liquid metal electrode and the energy storage device maintains at least 90% of its energy storage capacity after 100 charge/discharge cycles.

In some cases, the energy storage device has an energy storage capacity of at least about 1 kWh. In some embodiments, the energy storage device has an energy storage capacity of at least about 2 kWh, 3 kWh, 4 kWh, 5 kWh, 6 kWh, 7 kWh, 8 kWh, 9 kWh, 10 kWh, 20 kWh, 30 kWh, 100 kWh, 200 kWh, 300 kWh, 400 kWh, 500 kWh, 1 MWh, 5 MWh, or 10 MWh.

In some embodiments, the energy storage device maintains at least 90%, 95%, 96%, 97%, 98%, or 99% of its energy storage capacity after 100, 200, 300, 400, 500, or 1000, 3000, 5000, 10,000 charge/discharge cycles.

In some embodiments, an energy storage device comprises at least one liquid metal electrode, where the device is transportable on a vehicle and has an energy storage capacity of at least about 1 kWh. The energy storage device is transportable with at least any two of an anode, cathode and electrolyte of the energy storage device in solid state.

An energy storage device can be transported if it has less than a certain weight. In some embodiments, the energy storage device has a weight of about 10 kg, 100 kg, 500 kg, 1,000 kg, 2,000 kg, 3,000 kg, 4,000 kg, 5,000 kg, 10,000 kg, or 50,000 kg. In some embodiments, an individual cell of the energy storage device has a weight of about 0.1 kg, 0.5 kg, 1 kg, 2 kg, 3 kg, 4 kg, 5 kg, 10 kg, 100 kg, 1,000 kg, or 10,000 kg. In some embodiments, the energy storage device has a weight of at least about 10 kg, 100 kg, 500 kg, 1,000 kg, 2,000 kg, 3,000 kg, 4,000 kg, 5,000 kg, 10,000 kg, or 50,000 kg. In some embodiments, an individual cell of the energy storage device has a weight of at least about 0.1 kg, 0.5 kg, 1 kg, 2 kg, 3 kg, 4 kg, 5 kg, 10 kg, 100 kg, 1,000 kg, or 10,000 kg.

In some embodiments, an energy storage device comprises a container containing one or more cells, an individual cell of the one or more cells containing at least one liquid metal electrode, where a rate of heat generation in the cell during charge/discharge is about equal to a rate of heat loss from the cell.

The rate of heat generation can be any suitable value compared to the rate of heat loss from the cell (e.g., such that the battery is self-heating and/or maintains a constant temperature). In some cases, the ratio of the rate of heat generation to the rate of heat loss from the cell is about 50%, about 75%, about 80%, about 85%, about 90%, about 100%, about 110%, about 120%, or about 150%. In some instances, the ratio of the rate of heat generation to the rate of heat loss from the cell is at least about 50%, at least about 75%, at least about 80%, at least about 85%, at least about 90%, at least about 100%, at least about 110%, at least about 120%, or at least about 150%. In some instances, the ratio of the rate of heat generation to the rate of heat loss from the cell is at most about 50%, at most about 75%, at most about 80%, at most about 85%, at most about 90%, at most about 100%, at most about 110%, at most about 120%, or at most about 150%.

In another aspect of the present disclosure, a separator-less energy storage device comprises a container with at least one liquid metal electrode, where the container has a surface area-to-volume ratio that is less than or equal to about 100 m⁻¹, and the separator-less energy storage device has (i) a response time less than or equal to about 100 milliseconds (ms), and/or (ii) an energy storage capacity of at least about 1 kWh. In some embodiments, the separator-less energy storage devices comprises (i) and (ii). In some embodiments, the separator-less energy storage device does not include a separator.

The energy storage capacity can be any suitably large value (e.g., suitable for grid-scale energy storage), including about 1 kWh, about 10 kWh, about 20 kWh, about 30 kWh, about 100 kWh, about 500 kWh, about 1 MWh, about 5 MWh, about 10 MWh, about 50 MWh, about 100 MWh, and the like. In some embodiments, the energy storage capacity is at least about 1 kWh, at least about 10 kWh, at least about 20 kWh, at least about 30 kWh, at least about 100 kWh, at least about 500 kWh, at least about 1 MWh, at least about 5 MWh, at least about 10 MWh, at least about 50 MWh, at least about 100 MWh, and the like.

The response time can be any suitable value (e.g., suitable for responding to disturbances in the power grid). In some instances, the response time is about 100 milliseconds (ms), about 50 ms, about 10 ms, about 1 ms, and the like. In some cases, the response time is at most about 100 milliseconds (ms), at most about 50 ms, at most about 10 ms, at most about 1 ms, and the like.

In some embodiments, the surface area-to-volume ratio is about 100 m⁻¹, about 50 m 1, about 10 m⁻¹, about 1 m⁻¹, about 0.5 m⁻¹, about 0.1 m⁻¹, about 0.01 m⁻¹, or about 0.001 m⁻¹. In some cases, the surface area-to-volume ratio is less than about 100 m⁻¹, less than about 50 m⁻¹, less than about 10 m⁻¹, less than about 1 m⁻¹, less than about 0.5 m⁻¹, less than about 0.1 m⁻¹, less than about 0.01 m⁻¹, or less than about 0.001 m⁻¹.

In another aspect of the present disclosure, a method for forming an energy storage device comprises shipping a container comprising an energy storage material in solid state to a destination location, and at the destination location supplying energy to the energy storage material to form at least one of a liquid metal anode, liquid metal cathode, and liquid electrolyte, thereby forming the energy storage device.

In some instances, the energy storage material is not mixed during shipping. In some cases, the energy storage device does not include a separator. In some embodiments, during shipping, the energy storage material comprises at least one of a solid state anode, solid state cathode and solid state electrolyte.

In another aspect of the present disclosure, an energy storage system comprises: (a) a container comprising one or more energy storage cells, where an individual energy storage cell of the one or more energy storage cells comprises an energy storage material comprising at least one liquid metal electrode; and (b) a control system comprising a processor with machine-executable code for monitoring at least one temperature of the one or more energy storage cells and/or the container. The processor can regulate the flow of electrical energy into at least a subset of the one or more energy storage cells such that the energy storage material undergoes sustained self-heating during charge/discharge. In some embodiments, the container comprises a plurality of energy storage cells.

In some embodiments, the processor regulates one or more process parameters of the individual energy storage cell such that a rate of heat dissipation from the individual energy storage cell during charge/discharge is greater than a rate of heat loss from the individual energy storage cell. In some embodiments, at least one liquid metal electrode is stored in the container at a temperature greater than or equal to about 250 °C, greater than or equal to about 300 °C, greater than or equal to about 350 °C, greater than or equal to about 400 °C, greater than or equal to about 450 °C greater than or equal to about 500 °C or greater than or equal to about 550 °C.

### Pressure Relief Mechanism for Cathode (Riser Pipes)

An aspect of the disclosure relates to pressure relief mechanisms for electrochemical cells or batteries. The pressure relief mechanisms can be applied, for example, in liquid metal batteries described herein. Examples include application of the pressure relief mechanisms to positive battery electrodes in liquid metal batteries (e.g., for pressure relief during battery discharging, when the positive battery electrode functions as a cathode). The pressure relief mechanisms may be utilized to improve performance (e.g., charge cycling), longevity and/or to prevent battery failure. In other examples, pressure relief mechanisms and structures can be applied in alternative systems, such as, for example, in any energy storage device or energy transformation device with a liquid component which may expand and/or contract during operation. Operation may include charging, discharging, heating, cooling or any other change in state of the device.

In an illustrative example, pressure relief mechanisms and structures are provided for a positive electrode, such as the positive liquid metal electrode 405 in FIG. 4. The positive liquid metal electrode 405 may experience an expansive pressure force during discharging. During discharging, the positive liquid metal electrode can function as a cathode, and the negative liquid metal electrode 403 can function as an anode. If the liquid cathode cannot freely expand as material is transferred from the anode during discharge (e.g., due to the formation of the solid layer 410 atop the liquid cathode), internal pressure can build. This can result in undesirable morphologies (such as bowing described herein) and/or sudden, uncontrolled pressure-induced punctures or cracks that can inhibit cell operability.

Pressure relief mechanisms disclosed herein provide one or more unobstructed physical spaces (also “chambers” herein) where the liquid cathode can freely expand and contract during cycling, thus relieving pressure. Thus, the disclosure provides a mechanism for reversibly relieving internal fluid pressure.

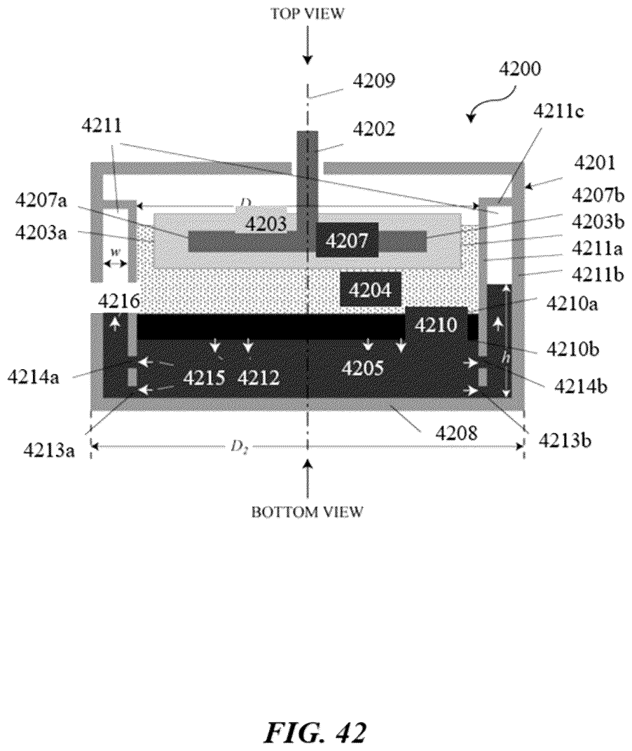

FIG. 42 is a cross-sectional side view of an electrochemical cell or battery 4200 with a pressure relief structure 4211. In an example, the battery cell 4200 can have an axially symmetric, circular cross-section when viewed from above (“top view” in FIG. 42). The housing 4201 can have concentric walls 4211a, 4211b. A first chamber or cavity can include a negative liquid metal electrode 4203, a negative current collector 4207, a liquid metal electrolyte 4204, a positive liquid metal electrode 4205 and a positive current collector 4208. During discharge, a solid intermetallic layer 4210 may form, as described elsewhere herein. The pressure relief structure 4211 forms a second chamber. The walls of the first and second chambers can form the concentric walls of the housing 4201 which may include a container, as described elsewhere herein. Thus, the pressure relief structure 4211 is provided in the annular chamber (also referred to as “riser pipe” herein) defined by the concentric walls. In some cases, the concentric walls of the housing may be integrally formed. Alternatively, the concentric walls may be formed separately and mechanically joined, e.g., by welding. The housing and/or the walls can be formed of any materials for housings/containers described herein.

During discharge, the negative liquid metal electrode 4203 can be an anode and the positive liquid metal electrode 4205 can be a cathode. The intermetallic layer 4210 includes an upper interface 4210a and a lower interface 4210b. As the lower interface 4210b of the intermetallic layer 4210 moves in a downward direction indicated by arrows 4212, the liquid material of the cathode 4205 is compressed. When pressure builds due to active electrochemistry in the first chamber space, the cathode material can rise between the walls 4211a, 4211b of the pressure relief structure 4211 via one or more openings 4213a, 4213b, 4214a, 4214b. The openings can be provided adjacent to the housing 4201 (e.g., openings 4213a, 4213b) such that the inner wall 4211a of the pressure relief structure is not in contact with the bottom wall of the housing 4201. In some examples, the bottom wall can be the positive current collector 4208. The openings can also be provided at some predetermined distance from the bottom wall of the housing 4201 (e.g., openings 4214a, 4214b). For example, the inner wall 4211a can be attached to the bottom wall of the housing and only have openings 4214a, 4214b.

The holes may be circular or of any other shape allowing the cathode material to flow through the holes. For example, circular holes may be preferred to minimize drag on the flowing cathode material. The cathode material may flow through the holes as indicated by arrows 42142, and upward in the pressure relief structure as indicated by arrows 4216.

Combinations and/or a plurality of openings 4213a, 4213b, 4214a, 4214b can be provided along the inner wall of the annular pressure relief chamber 4211. The holes may be provided at different axial distances from the bottom wall of the housing and may be of varying size. For example, the holes may be spaced to prevent the intermetallic layer 4210 from “bottoming out”, i.e., from reaching the uppermost level of the holes (which may be near the bottom of the first chamber), and blocking the riser pipe inlet (the area around arrows 42142).

The pressure relief structure can have a top wall 4211c. The top wall 4211c can close the pressure relief structure to prevent material inside the riser pipe from spilling over the top of the riser pipe. In some cases, the wall 4211b may be formed separately from the housing. For example, the walls 4211a, 4211b, and 4211c can be integrally formed as an annular tube with a closed top and an open bottom (e.g., openings 4213a, 4213b), or as an annular tube with closed top and bottom but with perforations or holes near the bottom (e.g., openings 4214a, 4214b). In some examples, one or more parts or all of the pressure relief structure may be formed of one or more materials different than the housing 4201. One or more parts or all of the pressure relief structure may be formed of an electrically insulating material, such as the electrically insulating materials described elsewhere herein.

With continued reference to FIG. 42, the cathode material in the riser pipe is not in contact with to the electrolyte 4204. Further, the cathode material is electrically isolated from the electrolyte and the anode. When the cathode material is electrically conductive (e.g., a liquid metal cathode material), the cathode material in the riser pipe (second chamber) can be electrically connected with the cathode material in the first chamber. In some cases, such as, for example, when an unsheathed housing is employed as described elsewhere herein, only the wall 4211b may be electrically insulating; the walls 4211b and 4211c may be electrically conductive. The wall 4211c may only be electrically conductive if it is to not contact the electrolyte at any point.

The cathode material may rise in the pressure relief structure 4211 to a height h. The height h may vary around the circumference of the pressure relief structure. The height h can be related to the volume change of the cathode (i.e., the liquid and solid cathode materials 4205 and intermetallic layer 4210). For example, the cathode materials 4205 and 4210 can have a volume V₁ when charged, and a volume V₂ when discharged. The height h can be related to the volume difference V₂-V₁ and the cross-sectional area of the pressure relief structure. The annular pressure relief structure in FIG. 42 can have a width w, and an area related to w and the circumference of the annular structure. The dimensions of the pressure relief structure, e.g., w, may be such that the cathode material can easily enter and rise in the structure. For example, the pressure relief structure can be dimensioned to minimize capillary wicking effects, and to ensure that the cathode material experiences minimal drag forces. The pressure relief structure can be dimensioned to accommodate a predetermined amount of cathode material. For example, the pressure relief structure may be dimensioned to accommodate less than 10%, less than 242%, less than 420%, or less than 742% of maximum volume or mass of the cathode material or of the liquid cathode material.

In some cases, the addition of the riser pipe decreases the gap between a first negative electrode end 4203a and an adjacent wall (e.g., the wall 4211a in FIG. 42), which may contribute to enhanced side wall creep of the liquid cathode material. To prevent the cathode material from climbing the pressure relief structure 4211 along the wall facing the first chamber and shorting to the anode from the sides (i.e., climbing upward in FIG. 42, parallel and on the opposite side of the wall 4211a from the arrows 4216), the pressure relief structure(s) may be isolated from the anode by a sheath (e.g., carbon or metal nitride or other sheath materials described herein) or coating of material (e.g., PVD or CVD coating of a high temperature material), which is not readily wet by the cathode material. In some cases, the material may provide a surface texture or chemistry that interacts with the intermetallic material, e.g., the intermetallic may easily slide along the surface.

Conversely, one or more parts of the pressure relief structure, e.g., the surfaces defining the chamber of the riser pipe, may be formed of and/or coated with a material that is readily wet by the cathode to ensure smooth flow of the cathode material in the riser pipe. The material can be inert. In some cases, the material may have desired reactivity with the cathode material. In some cases, the inlet and/or the openings 4213a, 4213b, 4214a, 4214b can be coated with a material that prevents the intermetallic from sliding into the riser pipe. The inlet and/or the openings 4213a, 4213b, 4214a, 4214b may be covered with a mesh. The inlet and/or the openings 4213a, 4213b, 4214a, 4214b may comprise one or more valves or valve-like features. For example, the inlet and/or the openings can be configured to allow flow into the riser pipe above a certain hydraulic pressure value (e.g., during discharging), and to allow flow from the riser pipe into the first chamber (e.g., during charging) at a relatively lower pressure.

Alternative configurations of the pressure relief mechanism may include external pressure relief structures, such as, for example, a riser pipe mounted externally to the housing 4201 and in fluid communication with the first chamber via one or more the openings 4213a, 4213b, 4214a, 4214b, ducts or connectors. Further examples of pressure relief structures include a shelf with an enlarged area for the intermetallic to grow (FIG. 6A), mechanical crumple zones which can contract and expand as an accordion (FIG. 6B), and a cell design including flexibility or “give” of the cell body or housing.

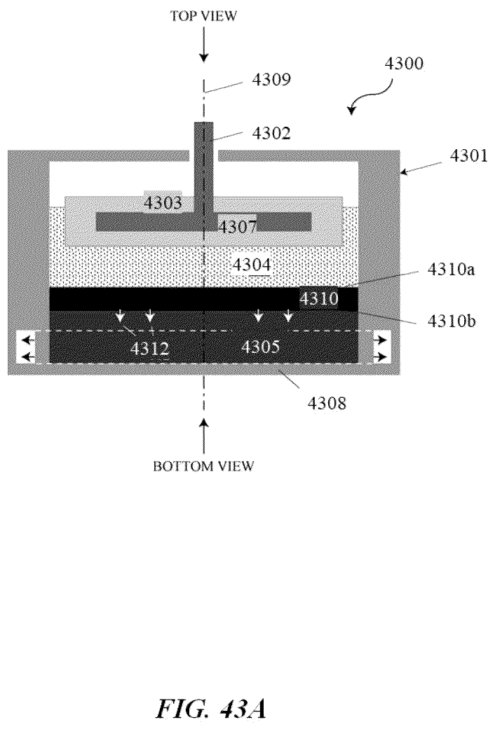

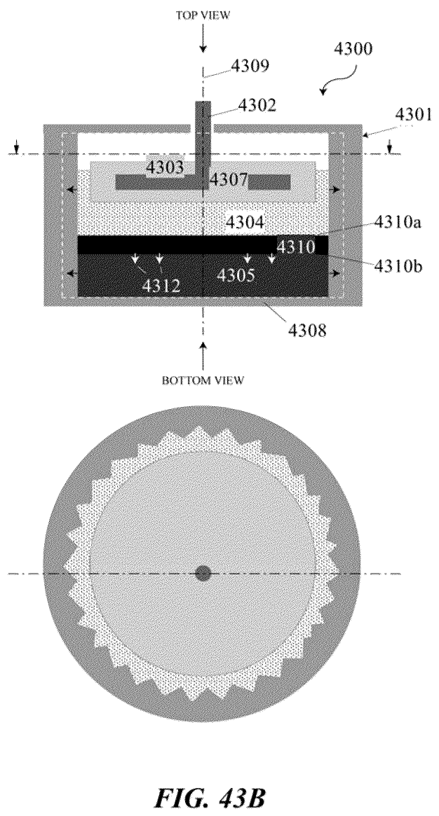

With reference to FIG. 43A, an electrochemical cell or battery 4300 comprises a housing 4301, a conductive feed-through (i.e., conductor, such as a conductor rod) 4302 that passes through an aperture in the housing 4301 and is in electrical communication with a liquid metal negative electrode 4303. The cell 4300 further comprises a liquid metal positive electrode 4305, and a liquid metal electrolyte 4304 between the electrodes 4303, 4305. The cell comprises a negative current collector 4307 and a positive current collector 4308 that are in electrical communication with the negative electrode 4303 and positive electrode 4305, respectively. During discharge of the cell 4300, a solid (or semi-solid) intermetallic layer 4310 forms adjacent to the positive electrode 4305. The intermetallic layer can develop by growing horizontally along an interface of the electrolyte 4304 and the positive electrode 4305. The expansion may be axially symmetrical or asymmetrical with respect to an axis of symmetry 4309. The electrolyte 4304 and intermetallic layer 4310 meet at a first interface 4310a, and the intermetallic layer 4310 and the positive electrode 4305 meet at a second interface 4310b. During discharge of the cell 4300, the intermetallic layer 4310 can bow, distort or move along a direction indicated by arrows 4312. The housing 4301 can include a shelf or cavity to house the intermetallic layer 4310 upon growth of the intermetallic layer 4310 during discharge of the cell 4300. The cavity can be aligned with a bottom portion of the housing 4301 (as shown). The cavity can include a wall portion that expands into a void space (white dashed lines) when there is a build-up of pressure in the positive electrode 4305. The wall portion can be spring loaded, for example, to (1) provide a resistive force to prevent the wall portion from expanding if the pressure in the positive electrode 4305 is below a given pressure, (2) enable the wall portion to expand the pressure in the positive electrode 4305 is at or above the given pressure, and (3) provide a restorative force to return the wall portion to its original position when the pressure in the positive electrode 4305 has decreased to below the given pressure. As an alternative, the cavity can be aligned with an interface between the electrolyte 4304 and the cathode 4305.

With reference to FIG. 43B, in an alternative configuration, the housing 4301 includes mechanical crumple zones (dashed lines) that can expand and contract upon growth and shrinkage of the intermetallic layer 4310 during discharge and charge, respectively, of the cell 4300. The crumple zones can include voids that enable the electrodes 4303, 4305 and electrolyte 4304 to flow into upon expansion of the electrodes 4303, 4305 and electrolyte 4304.

Pressure relief can be readily applied to cells or batteries of various size scales. In an example, the annular riser pipe in FIG. 42 is implemented in a nominal 4 inch, nominal 20 Ah cell (D1=2.75 inches, w=6 mm wide, D1+w=3.03 inches, D2=3.5 inches) with Li∥Sb, Pb chemistry with a negative liquid metal electrode (anode during discharge) comprising 9.5 grams of Li, a positive liquid metal electrode (cathode during discharge) comprising 361.5 grams of 40:60 mol % Sb:Pb, a liquid metal electrolyte comprising 219.5 grams of 22:31:47 mol % LiF:LiCl:LiBr, and a solid intermetallic layer comprising Li₃Sb formed at an interface of the liquid metal electrolyte and the positive liquid metal electrode during discharge. The liquid Pb alloy is allowed to “rise up” into the annular riser pipe as a result of expansion of the positive liquid metal electrode due to a pressure buildup. The concentric wall design is effective at relieving cathode pressure, and the amount of material between the walls is consistent with the volume expansion expected from Li alloying with Sb:Pb. Analogously, during charging, the material in the riser pipe can reversibly contract from the riser pipe. Other examples of cell sizes include, for example, a nominal 16 inch cell.

### Mechanical Modification of Intermetallic Shape and Morphology

In another aspect of the disclosure, mechanical modifications of electrochemical cells (or batteries) are provided. The mechanical modifications can be applied, for example, in liquid metal batteries described herein. Examples include application of the mechanical modifications to positive battery electrodes in liquid metal batteries, e.g., for controlling interfaces during battery discharging, when the positive battery electrode functions as a cathode. The mechanical modifications may be utilized to improve battery performance (e.g., charge cycling), battery longevity and/or to prevent certain battery failure modes. In other examples, mechanical modifications can be applied in alternative systems, such as, for example, in any energy storage device or energy transformation device with multiple phases (e.g., between a liquid and a solid) and phase interfaces which, wherein the phases and phase interfaces may be formed and/or transformed during operation. Operation may include charging, discharging, heating, cooling or any other change in state of the device.

In an example, mechanical modifications are provided for a positive electrode, such as the positive liquid metal electrode 405 in FIG. 4. During discharging, the positive liquid metal electrode can function as a cathode, and the negative liquid metal electrode 403 can function as an anode. As described elsewhere herein, the solid layer 410 may form atop the liquid cathode during discharge, and pressure forces from the liquid metal cathode and/or internal stresses in the layer itself may cause undesirable morphologies of the solid layer 410, e.g., bowing or bulging of the solid layer, and/or sudden, uncontrolled pressure-induced cracks that can inhibit cell operability.

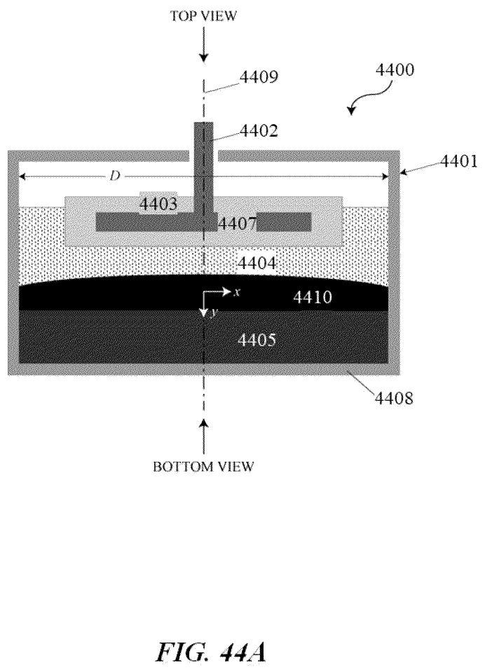

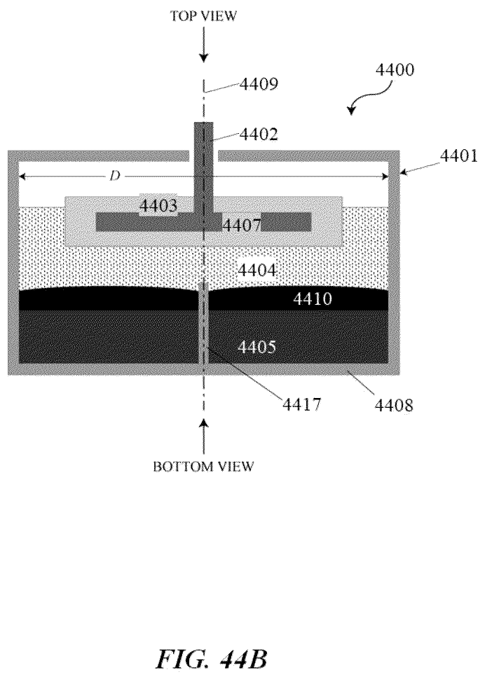

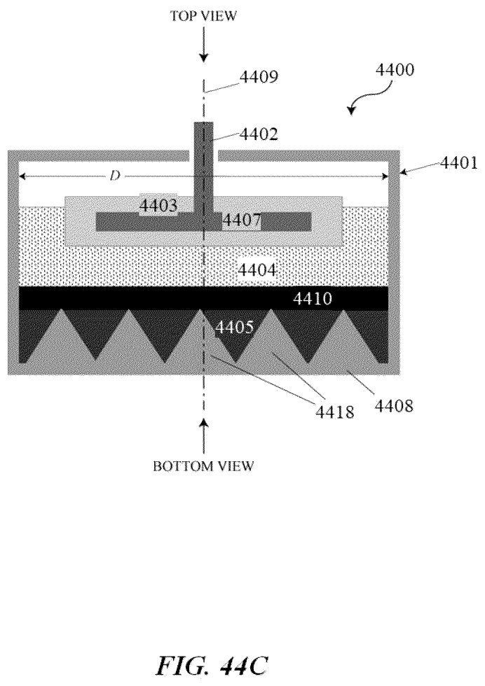

FIG. 44A a cross-sectional side view of an electrochemical cell 4400 with a bowing or bulging solid intermetallic layer 4410 formed adjacent to a positive liquid metal electrode 4405 during discharging, as described elsewhere herein. In an example, the battery cell 4400 can have an axially symmetric, circular cross-section when viewed from above (“top view” in FIG. 44A). The battery cell can comprise a negative liquid metal electrode 4403, a negative current collector 4407, a liquid metal electrolyte 4404, the positive liquid metal electrode 4405 and a positive current collector 4408. Uncontrolled and unintended formation of the intermetallic layer 4410 may cause failure of electrochemical cells or batteries (e.g., liquid metal battery cells with chemistries such as Li∥Sb,Pb), because the intermetallic solid can grow into structures that form a short between a negative liquid metal electrode 4403 and/or a negative current collector 4407 and the positive liquid metal electrode 4405. During discharge, the negative liquid metal electrode 4403 can be an anode and the positive liquid metal electrode 4405 can be a cathode.

The cathode morphology may depend on the size of the cell or battery 4400. In smaller cells (e.g., a nominal 4 inch liquid metal battery cell with Li∥Sb,Pb chemistry), the cathode morphology may include an bulged (bowed) intermetallic layer with a maximum height at or near the center of the cell, as shown in FIG. 44A. The liquid metal cathode 4405 can fill cell cavity below the arc (i.e., between the intermetallic layer 4410, and the bottom wall of the housing 4401 and/or the positive current collector 4408). In larger cells, the intermetallic layer may develop irregular undulations with several height maxima distributed over an active surface or interface (e.g., the interface between the electrolyte 4404 and the liquid metal cathode 4405) of the cell. In some cases, these undulating morphologies may be problematic during cell operation, because the crests of the undulating cathode (i.e., the undulating intermetallic layer of the cathode) can contact the anode 4403 and/or the negative current collector 4407, which can irreversibly short a cell. In some examples, the troughs of the undulating features appear to be pinned at the sidewalls of the cell (i.e., at the sidewalls of the housing 4401). In one example, the cathode morphology in a nominal 1 inch liquid metal battery cell with Li∥Sb,Pb chemistry can be relatively flat and controlled, while deviation from flatness can increase with increasing cell size.

FIG. 44B is a cross-sectional side view of the electrochemical cell or battery 4400 outfitted with a mechanical modification, such as a post 4417. The added mechanical modification (e.g., an appropriate physical protrusion) may interact with the cathode-intermetallic interface (including the intermetallic), thereby modifying the cathode-intermetallic morphology into a form more amenable to extended cell operation (e.g., encouraging a more flat, uniform intermetallic layer) by introducing additional pin or “attachment points” in addition to the sidewalls of the housing. Thus, the intermetallic can be allowed to form, but the shape or geometry can be disrupted such that the formed intermetallic layer is flatter (e.g., by forming smaller bulges or undulations). For example, the intermetallic can be forced to form smaller and lower bulging features (FIG. 44B) between attachment points instead of the single feature across an entire width, diameter or other characteristic dimension D of the cell (FIG. 44A). The presence of one or more disruptors or an array of disruptors may furthermore affect the thickness of the intermetallic layer and/or location of the height maxima. For example, a height maximum may not occur symmetrically between attachment points, and may depend on the type of attachment point (e.g., the location of a height maximum between a wall attachment point and a post attachment point may be skewed toward one of the two attachment points). In some cases, a complicated morphology of the intermetallic layer may result from the use of a set or an array of attachment points. In another example, the intermetallic layer may be thinner near an attachment point, or the thickness may depend on the type of attachment point.

One or more mechanical modifications (also “disruptors” or “intermetallic disruptors” herein) may be provided in the cell or battery 4400, including, but not limited to, one or more vertical posts, an array of vertical posts (e.g., two, three or more posts 4417, a bed of nails), one or more plates, a grid of interleaved plates configured to form compartments on the cathode (e.g., egg carton-like or grid-like structure), one or more structural pieces, an array of structural pieces (e.g., an array of angled iron pieces lying on their side on the cell bottom), stamped structures (e.g., stamped ridges) and/or other mechanical disruptor type or configuration capable of mechanically interfering with the growth of the intermetallic layer to enable managing the cathode morphology during cycling. In some cases, one or more features may be provided elsewhere within the cell 4400 that are complementary to a particular cathode disruptor configuration or to a cell morphology that results from a particular cathode disruptor configuration. For example, if a stamped ridge configuration or an array of posts is used on the cathode, giving rise to a particular wave-like pattern, the negative current collector 4407 may be formed with a similar wave-like pattern such that the distance between any point on an upper surface of the intermetallic layer 4410 and a vertically opposite (i.e., at the same position x) point on the negative current collector 4407 remains approximately constant across the cell.

FIG. 44C is a cross-sectional side view of the electrochemical cell or battery 4400 outfitted with ridges 4418, another example of a mechanical modification of the cathode. Although a flat layer is shown, the intermetallic layer may have a morphology determined by the ridge structure. The disruptors may be formed of any suitable material including, but not limited to, materials suitable for housings/containers, current collectors, sheaths, or any other features of the disclosure. Individual disruptors and/or disruptor types may or may not be formed of the same material(s). The disruptors may be provided together with one or more components of cell 4400. For example, the disruptors may be provided on bottom wall of the housing 4401 and/or on the positive current collector 4408. One or more disruptor features may be integrated with one or more cell components, while one or more other disruptor features may be integrated with another one or more cell components. The disruptor features or parts thereof may be formed separately and subsequently attached to one or more cell components. Alternatively, the disruptor features or parts thereof may be integrally formed with one or more cell components. For example, ridges may be stamped into the positive current collector 4408, and an additional disruptor grid may be attached to or contacted with the modified positive current collector, thus forming a composite disruptor configuration. In another example, a first portion of a single type of disruptor may be integrally formed with the housing 4401, while a second portion may be attached to the first portion during cell assembly. Any combination of disruptor material, formation or assembly can be used. Furthermore, mechanical modification can be advantageously incorporated into an existing cell manufacturing process. For example, ridges or posts can be introduced during stamping or hydroforming of a cell bottom. In another example, the attachment and welding of posts can be automated or achieved using a robot.

Individual disruptor features (e.g., individual posts) may be spaced apart in a predetermined pattern. For example, a spacing between individual disruptor features in array can be determined to achieve a predetermined maximum height and/or a predetermined pattern of the intermetallic layer. Once an appropriate spacing is determined, the array spacing may be scaled between different cell geometries. For example, the same spacing can be used, or the spacing can be scaled by cell diameter or width, cell area, etc. In some cases, array spacing can be scaled according to current density and/or other cell operating parameters. The disruptor features may be spaced apart uniformly, or stochastically. The disruptor features may be spaced apart to achieve a desired surface density of disruptor features (e.g., an average surface density of 1.5 posts per square centimeter of the bottom surface of the housing 4401).

In an example, the disruptor of FIG. 44B is implemented in a nominal 4 inch, nominal 20 Ah cell (D1=2.75 inches, w=6 mm wide, D1+w=3.03 inches, D2=3.5 inches) with Li∥Sb,Pb chemistry with a negative liquid metal electrode (anode during discharge) comprising 15.8 grams of Li, a positive liquid metal electrode (cathode during discharge) comprising 480.3 grams of 40:60 mol % Sb:Pb, a liquid metal electrolyte comprising 300.2 grams of 22:31:47 mol % LiF:LiCl:LiBr, and a solid intermetallic layer comprising LisSb formed at an interface of the liquid metal electrolyte and the positive liquid metal electrode during discharge. In a discharged state, the Li∥Sb,Pb cell can have a intermetallic phase and a metallic Sb,Pb alloy. In experiments with a centered steel post design and an off-center steel post design, the peak of the intermetallic layer is translated from the center of the cell as a result of the presence of the post. In the case of the off-center post design, the maximum height of the bulging intermetallic layer can be shifted in the direction of the post, and the intermetallic layer can be thinnest near the post. An array of vertical posts extending from the cell bottom and a grid of interleaved metal plates, producing several compartments in the cell bottom similar to an egg carton have also been tested. Other examples of cell sizes include, for example, a nominal 16 inch cell.

Aspects of the disclosure may be synergistically combined. For example, a pressure relief mechanism can be used in concert with other intermetallic management strategies, such as the use of mechanical disruptors described herein. The pressure relief mechanism may enhance the performance of the disruptors by reducing the tendency of cathode material to be forced through induced defects in the intermetallic layer. For example, in Li∥Sb,Pb systems, the use of disruptors alone may cause defects in the solid intermetallic layer that do not result in a controlled pressure release, causing liquid cathode material to break through the defects with substantial force. The resulting upward motion of liquid cathode material can be a limiting factor to cell operability and lifespan. The use of pressure relief mechanisms of the disclosure may alleviate the pressure buildup and enable improved (or modified) disruptor performance. For example, smaller and/or otherwise distributed disrupters may be used during operation with lesser pressure buildup.

Any aspects of the disclosure described in relation to cathodes may equally apply to anodes at least in some configurations. Similarly, one or more battery electrodes and/or the electrolyte may not be liquid in alternative configurations. In an example, the electrolyte can be a polymer or a gel. In a further example, at least one battery electrode can be a solid or a gel. Furthermore, in some examples, the electrodes and/or electrolyte may not include metal. Aspects of the disclosure are applicable to a variety of energy storage/transformation devices without being limited to liquid metal batteries.

Electrochemical cells of the disclosure may be capable of storing (and/or taking in) a suitably large amount of energy. In some instances, a cell is capable of storing (and/or taking in) about 1 Wh, about 5 Wh, 25 Wh, about 50 Wh, about 100 Wh, about 500 Wh, about 1 kWh, about 1.5 kWh, about 2 kWh, about 3 kWh, or about 5 kWh. In some instances, the battery is capable of storing (and/or taking in) at least about 1 Wh, at least about 5 Wh, at least about 25 Wh, at least about 50 Wh, at least about 100 Wh, at least about 500 Wh, at least about 1 kWh, at least about 1.5 kWh, at least about 2 kWh, at least about 3 kWh, or at least about 5 kWh. It is recognized that the amount of energy stored in an electrochemical cell and/or battery may be less than the amount of energy taken into the electrochemical cell and/or battery (e.g., due to inefficiencies and losses).

The compilation of cells (i.e., battery) can include any suitable number of cells, such as at least about 2, at least about 5, at least about 10, at least about 50, at least about 100, at least about 500, at least about 1000, at least about 5000, at least about 10000, and the like. In some examples, a battery includes 1, 2, 3, 4, 5, 6, 7, 8, 9, 10, 15, 20, 30, 40, 50, 60, 70, 80, 90, 100, 200, 300, 400, 500, 600, 700, 800, 900, 1000, 2000, 5000, 10,000, 20,000, 50,000, 100,000, 500,000, or 1,000,000 cells.

Batteries of the disclosure may be capable of storing a suitably large amount of energy for use with a power grid (i.e., a grid-scale battery) or other loads or uses. In some instances, a battery is capable of storing (and/or taking in) about 5 kWh, 25 kWh, about 50 kWh, about 100 kWh, about 500 kWh, about 1 MWh, about 1.5 MWh, about 2 MWh, about 3 MWh, or about 5 MWh. In some instances, the battery is capable of storing (and/or taking in) at least about 5 kWh, at least about 25 kWh, at least about 50 kWh, at least about 100 kWh, at least about 500 kWh, at least about 1 MWh, at least about 1.5 MWh, at least about 2 MWh, at least about 3 MWh, or at least about 5 MWh.

In some instances, the cells and cell housings are stackable. Any suitable number of cells can be stacked. Cells can be stacked side-by-side, on top of each other, or both. In some instances, at least about 10, 50, 100, or 500 cells are stacked. In some cases, a stack of 100 cells is capable of storing at least 50 kWh of energy. A first stack of cells (e.g., 10 cells) can be electrically connected to a second stack of cells (e.g., another 10 cells) to increase the number of cells in electrical communication (e.g., 20 in this instance). In some instances, the energy storage device comprises a stack of 1 to 10, 11 to 50, 51 to 100, or more electrochemical cells.

The electrochemical cells can be arranged in series and/or parallel to form an electrochemical energy storage system (i.e., battery). The energy storage system can comprise modules, packs, cores, and/or pods of electrochemical cells surrounded by a frame.

### Methods for Transporting Energy Storage Systems

Another aspect of the present disclosure provides methods for transporting energy storage systems. In some cases, the energy storage devices are transported with molten metal electrodes (e.g., at a high temperature of at least 250 °C, at least 400 °C, at least 500 °C, or at least 600 °C). The energy storage devices can also be transported at ambient temperature (e.g., with the electrodes being solid and not molten) and heated at the site of operation to melt the metal electrodes.

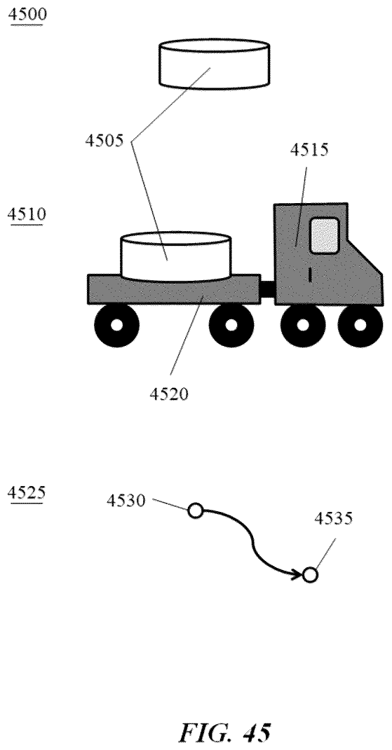

The energy storage devices can be transported in any suitable manner including fully assembled or in pieces to be assembled at the site of operation. The energy storage devices can be transported on any suitable vehicle, such as a truck (including on a trailer pulled by a truck), on a train, on a ship, on an airplane, on a helicopter, by a robot, and the like. FIG. 45 shows an energy storage device 4505 that is assembled 4500 and placed on a vehicle 4510. In this case the vehicle includes a truck 4515 and a trailer 4520 pulled by the truck. The vehicle can transport the energy storage device 4525 from an initial location 4530 to a site of installation and/or operation 4535 along any suitable path (e.g., along roads, railroad tracks, shipping routes and the like).

The energy storage devices can be transported any distance such as at least about 1 mile, at least about 10 miles, at least about 100 miles, at least about 1,000 miles or at least about 10,000 miles. The energy storage devices can be transported at any speed including at least about 5 miles per hour (mph), at least about 10 mph, at least about 20 mph, at least about 40 mph, at least about 60 mph, at least about 150 mph, or at least about 500 mph.

An energy storage device of the present disclosure, including an electrochemical cell (“cell”) of the energy storage device, can be configured for transport. In some cases, the cell does not have a voltage and cannot pass current while being transported (e.g., on a truck at room temperature). The cell may not have an appreciable or detectable voltage during transport, and the cell may not pass an appreciable or detectable current during transport. This can be advantageous since the cells are electrically inert and cannot short.

An electrochemical cell can comprise chemical components that generate a potential difference when a system comprising the cell is heated (e.g., to approximately 250 °C or 450 °C or 500 °C). While at room temperature, the electrolyte in the cell can be solid and/or incapable of conducting ions necessary to facilitate either the charge of discharge reactions. The system does not pass current (e.g., even if the electrode terminals are shorted), and does not have an inherent cell voltage. When the temperature is elevated, the non-aqueous (non water based) electrolyte melts and/or becomes an ionic conductor, thus enabling the cell to accept or provide current and charge or discharge. When at operating temperature and when the electrolyte is molten or ionically conductive and if the cell is above 0% state of charge, the battery can have a non-zero cell voltage of around 0.9 volts in some cases.

An advantage of a cell that does not exhibit a cell voltage and is unable to accept or supply current while at room temperature is that the safety risks associated with shipping batteries are reduced. Even in the event that the cells are jostled and are externally shorted, the cells do not discharge and cannot be charged.

In some cases, the system comprises a metallic crucible that acts as one electrode and a dielectrically separated region that forms the second electrode. At room temperature, the electrodes are physically separated by solid chemicals that are inert and do not inherently generate a potential between the two electrodes. As temperature is raised portions of the solid electrolyte can undergo a change in electrical characteristics (such as a phase transition) that results in a potential difference forming between the electrodes. When temperature is maintained at approximately this range, the system can be capable of sourcing (discharging) or sinking (recharging) current. When the temperature is brought back to room temperature, the chemical media can undergo another phase transition that brings potential difference to zero between the electrodes and also increases ionic resistance preventing flow of current.

Energy storage devices (or batteries) of the present disclosure can be reliably safe during transportation and handling from a pickup location to a delivery location. Physical short circuits or other externally induced abuse conditions (e.g., puncture, shock, vibration, etc.) have little to no effect on safety or operation of the system when these conditions are induced at room temperature.

An electrochemical energy storage device of the present disclosure (including a cell of the device) may not be capable of being charged, being discharged, or having an electrical potential during transport. This may be accomplished by transporting (or shipping) the energy storage device at a temperature that is reduced with respect to an operating temperature of the energy storage device.

For example, an electrochemical energy storage device can comprise an anode and a cathode, and an electrolyte between the anode and the cathode. The device may not be capable of conducting ions at a first temperature and capable of conducting ions at a second temperature. The first temperature may be maintained during transport of the electrochemical energy storage device.

The anode can comprise lithium, potassium, magnesium and/or calcium. The cathode can comprise antinomy, tin, tellurium, bismuth and/or lead.

In some embodiments, at least part of the device is a solid at the first temperature and a liquid at the second temperature. The at least part of the device can be an electrolyte.

In some cases, the first temperature is room temperature. In some cases, the first temperature is less than about 100 °C. In some cases, the second temperature is at least about 250 °C. In some cases, the second temperature is at least about 500 °C.

The device of the present disclosure may not be capable of being charged, being discharged, or having an electrical potential at the first temperature. In some instances, the device has a positive terminal and a negative terminal, and shorting the terminals does not discharge the device at the first temperature. In some cases, the device does not discharge when the device is punctured, vibrated, shorted, or shocked.

In another aspect of the present disclosure, an electrochemical energy storage device comprises a negative electrode and a positive electrode, and an electrolyte between the negative and positive electrodes. The device has a first potential difference between the electrodes at a first temperature of less than about 50 °C and a second potential difference between the electrodes at a second temperature of at least about 250 °C. The second potential difference is greater than the first potential difference.

In some cases, the first potential difference is less than or equal to about 2.5 volts, 2 volts, 1.5 volts, 1.2 volts, 1 volt, 0.9 volts, 0.8 volts, 0.7 volts, 0.6 volts, 0.5 volts, 0.4 volts, 0.3 volts, 0.2 volts, 0.1 volts, or less. The first potential difference can be about 0 volts.

The second voltage can be greater than 0 volts, or greater than or equal to about 0.1 volts, 0.2 volts, 0.3 volts, 0.4 volts, 0.5 volts, 0.6 volts, 0.7 volts, 0.8 volts, 0.9 volts, 1 volt, 1.2 volts, 1.5 volts, 2 volts, or 2.5 volts.

The negative electrode can comprise lithium, potassium, magnesium and/or calcium. The positive electrode can comprise antinomy, tin, tellurium, bismuth and/or lead.

The electrochemical energy storage device of the present disclosure can be comprised in an array of energy storage devices as part of an energy storage system. In some cases, the electrochemical energy storage device is an energy storage cell, and the energy storage system comprises a plurality of energy storage cells.

The present disclosure provides methods for transporting energy storage devices, and installing the energy storage devices for use in an energy storage system. The energy storage system can be electrically coupled to a power source and a load, such as, for example, a power grid. The energy storage system can store energy from the power source for use with the load.

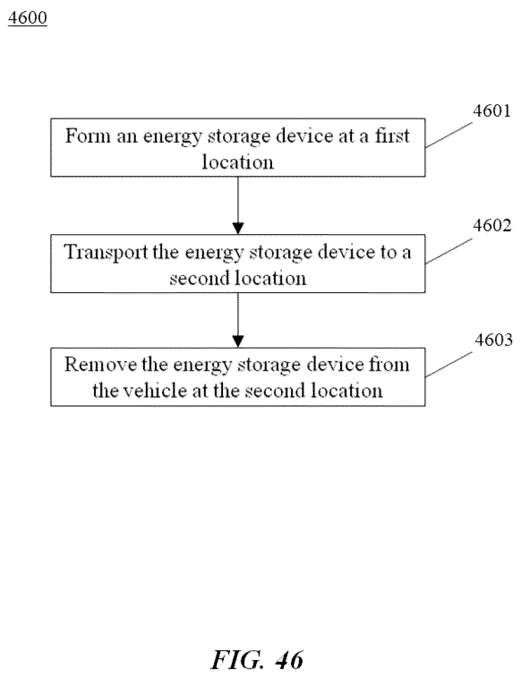

FIG. 46 illustrates a method 4600 for forming an energy storage system of the present disclosure. The method 4600 comprises, in a first operation 4601, forming, at a first location, an energy storage device comprising a negative electrode and a positive electrode, and an electrolyte between the negative electrode and the positive electrode, and placing the energy storage device on a vehicle (e.g., truck, train) that is configured to transport the energy storage device from the first location to a second location. The energy storage device can be as described elsewhere herein. For instance, the negative electrode, positive electrode and electrolyte can each be formed of a material that is in the liquid at an operating temperature of the energy storage device.

Next, in a second operation 4602, the method 4600 comprises using the vehicle to transport the energy storage device from the first location to the second location. Next, in a third operation 4603, at the second location the energy storage device can be removed from the vehicle. The energy storage device can be subsequently positioned at an installation location, and in some cases installed into the energy storage system at the installation location.

In some examples, the energy storage device can be electrically coupled to a power source. The power source can be selected from the group consisting of a power plant (e.g., nuclear power plant, coal-fired power plant, fuel-fired power plant), a wind turbine, a photovoltaic system, a geothermal system, and a wave energy system. The power source can be configured to generate power from a renewable energy source or non-renewable energy source.

The energy storage device of the present disclosure can be electrically coupled to a load, such as a power grid. The energy storage device can then be employed to deliver power to the load and/or store energy from the power source.

During transport, a potential difference between the positive electrode and the negative electrode can be less than about 1 volt, 0.9 volts, 0.8 volts, 0.7 volts, 0.6 volts, 0.5 volts, 0.4 volts, 0.3 volts, 0.2 volts, 0.1 volts, or less. In some examples, the potential difference can be about 0 volts. The potential difference can be less than 1 volt, 0.9 volts, 0.8 volts, 0.7 volts, 0.6 volts, 0.5 volts, 0.4 volts, 0.3 volts, 0.2 volts, 0.1 volts, or less (e.g., 0 volts) at a temperature (“transport temperature”) that is less than the operating temperature of the energy storage device. The energy storage device can be transported with the energy storage device at the transport temperature.

### Liquid Metal Electrochemical Energy Storage Devices

Electrochemical cells having molten electrodes having an alkali metal can provide receipt and delivery of power by transporting atoms of the alkali metal between electrode environments of disparate chemical potentials through an electrochemical pathway comprising a salt of the alkali metal. The chemical potential of the alkali metal is decreased when combined with one or more non-alkali metals, thus producing a voltage between an electrode comprising the molten alkali metal and the electrode comprising the combined alkali/non-alkali metals. Additional details of the batteries can be found in U.S. Patent Publication No. 2012/0104990, which is hereby incorporated by reference in its entirety.

In some cases, an electrochemical cell has three distinct phases. The first phase defines a positive electrode having at least one element other than an alkali metal. The second phase includes cations of the alkali metal, and defines two separate interfaces. The first phase is in contact with the second phase at one of the interfaces. The third phase defines a negative electrode and includes the alkali metal. It is separate from the first phase and in contact with the second phase at the other interface. The first and third phases have respective volumes which decrease or increase at the expense of one another during operation of the cell. As a result the second phase is displaced from a first position to a second position. The first, second, and third phases may be solid, liquid, or in a combination of solid or liquid states. In preferred embodiments, the alkali metal is present at respective disparate chemical potentials in the first and third phases, originating a voltage between the first and third phases.

An embodiment includes an electrochemical cell having two distinct phases. The first phase defines a positive electrode and includes an alkali metal, and two other elements other than the alkali metal. The second liquid phase includes cations of the alkali metal, and defines two separate interfaces. The first phase is in contact with the second phase at one of the interfaces. In some embodiments, the first and second phases are solid. In other embodiments, the first and second phases are liquid. In other embodiments, the phases are in a combination of solid or liquid states. The alkali metal preferably is selected to exhibit a change in chemical potential when combined with the first and second elements. During operation of the cell to deliver or draw electrical energy to drive transfer of the alkali metal to or from the second liquid phase to or from the first liquid phase, the first phase has a volume which increases or decreases thus transferring energy to or from the electrochemical cell to or from an external circuit. As a result the second phase is displaced from a first position to a second position.

In some cases, the two elements other than the alkali metal are independently selected from group IVA, VA and VIA elements of the chemical periodic table. In some embodiments, these elements are selected independently from one of tin, lead, bismuth, antimony, tellurium and selenium. In other embodiments, these elements are lead and antimony. The alkali metal may be sodium or lithium or potassium. The second phase may include refractory particles distributed throughout the second liquid phase. Moreover, the refractory particles may include a metal oxide or metal nitride, or combinations thereof.

The second phase can include a salt of the alkali metal. The salt of the alkali metal may be selected from one or more of halide, bistriflimide, fluorosulfano-amine, perchlorate, hexaflourophosphate, tetrafluoroborate, carbonate or hydroxide.

In some instances, a method stores electrical energy transferred from an external circuit. To that end, the method provides at least one electrochemical cell having three liquid phases. The first liquid phase defines a positive electrode and includes at least one element other than an alkali metal. The second liquid phase includes cations of the alkali metal, and defines two separate interfaces. The first phase is in contact with the second phase at one of the interfaces. The third liquid phase defines a negative electrode and includes the alkali metal. It is separate from the first phase and in contact with the second phase at the other interface. The electrochemical cell is configured to connect with the external circuit. The external circuit is electrically connected to a negative pole and a positive pole of electrochemical cell. The external circuit is operated which drives electrical energy that drives transfer of the alkali metal to or from the first liquid phase, through the second liquid phase, and to or from the third liquid phase. The first phase has a volume which decreases or increases while the third phase has a volume which decreases or increases respectively thus transferring energy to and from the external circuit to the electrochemical cell. As a result the second phase is displaced from a first position to a second position.

A method of the present disclosure can release electrical energy from the electrochemical cell to an external circuit. The method includes providing at least one electrochemical cell having three liquid phases. The first liquid phase defines a positive electrode and includes two elements other than an alkali metal. The second liquid phase includes cations of the alkali metal, and defines two separate interfaces. The first phase is in contact with the second phase at one of the interfaces. The third liquid phase defines a negative electrode and includes the alkali metal. It is separate from the first phase and in contact with the second phase at the other interface. The electrochemical cell is configured to connect sequentially with external circuits. The external circuits are electrically connected to a negative pole and a positive pole of electrochemical cell. The external circuits are sequentially operated to drive electrical energy to drive transfer of the alkali metal to or from the third liquid phase, through the second liquid phase, and to or from the first liquid phase, the first phase has a volume which increases or decreases while the third phase has a volume which decreases or increases respectively thus transferring energy to or from the electrochemical cell to or from the external circuits. As a result the second phase is displaced from a first position to a second position.

An electrochemical method and apparatus of the present disclosure for high-amperage electrical energy storage can feature a high-temperature, all-liquid chemistry. The reaction products created during charging can remain part of the electrodes during storage for discharge on demand. In a simultaneous ambipolar electrodeposition cell, a reaction compound can electrolyzed to effect transfer from an external power source The electrode elements are electrodissolved during discharge. Additional details of the liquid metal batteries can be found in U.S. Patent Publication No. 2008/0044725, which is herein incorporated by reference in its entirety.

Electrochemical cells of the present disclosure having molten electrodes comprising an alkaline earth metal can provide receipt and delivery of power by transporting atoms of the alkaline earth metal between electrode environments of disparate the alkaline earth metal chemical potentials. Additional details of the alkaline earth metal batteries can be found in U.S. Patent Publication No. 2011/0014503, which is herein incorporated by reference in its entirety.

In another aspect of the present disclosure, an energy storage device comprises at least one electrochemical cell having an operating temperature, the at least one electrochemical cell comprising: (a) a liquid negative electrode comprising a first metal; (b) a liquid electrolyte adjacent to the liquid negative electrode; and (c) a liquid positive electrode adjacent to the liquid electrolyte, the liquid positive electrode comprising a second elemental metal that is different than the first metal. The liquid electrolyte can comprise a charged species of the first metal and an oppositely charged species of the second metal, and the energy storage device is capable of being transported on a truck.

The first metal and/or the second metal can be an elemental metal (i.e., not an alloy or compound).

In another aspect of the present disclosure, an energy storage device comprises a first material and a second material, where the materials are liquid at the operating temperature of the device, the materials conduct electricity, the materials have different densities and the materials react with each other to form a mutual reaction compound, and the energy storage device is capable of being transported on a truck.

In some instances, the electrolyte has a free energy of formation more negative than that of the mutual reaction compound. In some embodiments, the electrolyte further comprises additives that lower the melting temperature of the electrolyte, reduces the viscosity of the electrolyte, enhance ionic conductivity through the electrolyte, inhibit electronic conductivity through the electrolyte or any combination thereof.

The first material or second material can further comprise additives that enable electrochemical monitoring of the extent of discharge of the device.

In another aspect of the present disclosure, an energy storage device comprises a molten salt, where a liquid electronic conductor is extracted from the molten salt by oxidation and metal is extracted from the molten salt by reduction and the energy storage device is capable of being transported on a truck.

In some cases, the liquid electronic conductor is antimony. In some embodiments, the liquid electronic metal is magnesium.

In another aspect of the present disclosure, an electrometallurgical cell comprises a positive electrode and a negative electrode, where the electrodes are liquid, the reactants of reactions that occur at the electrodes are liquid, and the products of reactions that occur at the electrodes are liquid, and where the electrometallurgical cell is capable of being transported on a truck.

In some cases, an electrode comprises a material and a reaction that occurs at the electrode produces the material, thereby enlarging the electrode. In some embodiments, an electrode comprises a material and a reaction that occurs at the electrode consumes the material, thereby consuming the electrode. In some embodiments, the electrodes do not comprise a solid.

The products of reactions that occur at the electrodes may not comprise a gas. In some embodiments, the cell has a current density of at least 100 mA/cm² and an efficiency of at least 60%, at least 70%, at least 80%, or at least 90%.

In another aspect of the present disclosure, an energy storage device capable of being transported on a truck and having a power capacity of greater than 1 MW comprises: (a) a physical footprint smaller than about 100 m²/MW; (b) a cycle life greater than 3000 deep discharge cycles; (c) a lifespan of at least 10 years; (d) a DC-to-DC efficiency of at least 65%; (e) a discharge capacity of at most 10 hours; and (f) a response time of less than 100 milliseconds.

The energy storage device of the present disclosure may comprise a liquid metal. In some cases, the device comprises a liquid metal anode, a liquid metal cathode, and a liquid metal electrolyte. The device can be transported with some or all of the anode, cathode and electrolyte being in the solid state.

In another aspect of the present disclosure, an energy storage device comprises a liquid electrode, the electrode comprising an additive, where the electrode is consumed and the additive is concentrated by operation of the device, and where a property of the device is determined by of the concentration of the additive, and where the energy storage device is capable of being transported on a truck.

In some cases, the property of the device is the extent of discharge of the device. In some embodiments, the additive comprises lead. In some embodiments, the open voltage of the cell drops when the additive is concentrated.

In another aspect of the present disclosure, an energy storage device comprises a liquid antimony electrode, a steel container and a layer of iron antimonide disposed therebetween, where the device is operated at less than 738 °C, and where the energy storage device is capable of being transported on a truck.

In some instances, the iron antimonide is electronically conductive and protects the steel from corrosion.

In another aspect of the present disclosure, an energy storage device comprises a liquid electrode and a current collector in contact with the electrode, where the liquid electrode is consumed in a reaction during operation of the device, and where the amount of liquid electrode is in stoichiometric excess relative to other reactants of the reaction such that the current collector is in contact with the liquid electrode when the reaction has proceeded to completion, and where the energy storage device is capable of being transported on a truck.

The current collector can be a negative current collector and the reaction comprises discharging the device.

In another aspect of the present disclosure, an energy storage device comprises an alkaline earth metal present in each of a positive electrode, a negative electrode and a liquid electrolyte, where the energy storage device is capable of being transported on a truck.

In some instances, the alkaline earth metal is at three disparate chemical potentials in the positive electrode, the negative electrode and the liquid electrolyte. In some cases, the alkaline earth metal is a halide in the electrolyte. In some instances, the alkaline earth metal is an alloy in the positive electrode. In some cases, the alkaline earth metal is elemental in the negative electrode.

In another aspect of the present disclosure, an energy storage device comprises an alkaline earth metal present in each of an elemental form, an alloy form and a halide form, where the energy storage device is capable of being transported on a truck.

In some cases, the elemental form (e.g., not alloyed or a salt) is found in a negative electrode of the device. In some embodiments, the alloy form is found in a positive electrode of the device. In some embodiments, the halide form (e.g., chloride salt) is found in an electrolyte of the device.

In another aspect of the present disclosure, an energy storage device comprises a liquid anode, a liquid cathode and a liquid electrolyte disposed therebetween, where the thickness of the electrolyte is substantially constant through a charge-discharge cycle of the device, and the energy storage device is capable of being transported on a truck. The thickness can vary by any suitable amount during the operation of the device including varying by less than 20%, less than 10%, less than 5%, or less than 2%.

In another aspect of the present disclosure, an energy storage device comprises a liquid anode, a liquid cathode and a liquid electrolyte disposed therebetween, where the thickness of the electrolyte is less than 50% of the thickness of the cathode or the anode, and the energy storage device is capable of being transported on a truck.

In another aspect of the present disclosure, an energy storage device comprises a liquid anode, a liquid cathode, a liquid electrolyte, and a circulation producer configured to generate circulation within at least one of the liquids, where the energy storage device is capable of being transported on a truck.

In some embodiments, the temperature inside the device is greater than the temperature outside the device and the circulation producer is a thermally conductive material extending from the inside of the device to the outside of the device.

In another aspect of the present disclosure, an energy storage device comprises a liquid electrode comprising an elemental alkaline earth metal and an electrolyte comprising a halide of the alkaline earth metal, where the electrolyte further comprises complexing ligands, and the energy storage device is capable of being transported on a truck.

The complexing ligands can reduce the solubility of the elemental alkaline earth metal in the halide of the alkaline earth metal.

In another aspect of the present disclosure, an energy storage device comprises a conductive housing comprising a conductive liquid anode, a conductive liquid cathode and an electrolyte disposed therebetween, where the interior surface of the container is not electrically insulated, and the energy storage device is capable of being transported on a truck.

In some cases, the device further comprises an electrically conductive structure that holds the conductive liquid anode or the conductive liquid cathode away from the interior surface of the container. In some cases, the conductive liquid anode or the conductive liquid cathode is associated with the structure at least in part by surface tension forces.

In another aspect of the present disclosure, an energy storage device comprises an anode comprising a first electronically conductive liquid and a cathode comprising a second electronically conductive liquid, where the device is configured to impede mixing of the electronically conductive liquids, and the energy storage device is capable of being transported on a truck.

In some instances, the electronically conductive liquids do not mix when the device is shaken or tipped. In some cases, the device further comprises an electrode separator disposed between the electronically conductive liquids. In some instances, the device further comprises a liquid electrolyte, the liquid electrolyte wets the electrode separator, and the electronically conductive liquids do not wet the separator. In some embodiments, the electrode separator floats in or on the electrolyte when the device is charged or discharged.

In another aspect of the present disclosure, an energy storage device comprises a negative electrode comprising an alkali metal, a positive electrode comprising the alkali metal and one or more additional elements and a liquid electrolyte disposed between the electrodes, where the electrolyte is not depleted upon charging or discharging of the device, and the energy storage device is capable of being transported on a truck.

At least one of the electrodes can be liquid at an operating temperature of the device. In some cases, the positive electrode comprises at least two additional elements such that the positive electrode comprises at least two elements when the positive electrode is fully depleted of the alkali metal. In some instances, the alkali metal is lithium, sodium, potassium, or any combination thereof.

In some cases, the one or more additional elements form an alloy with the alkali metal or exist in a compound with the alkali metal at an operating temperature of the device. In some embodiments, the one or more additional elements have a lower electronegativity than the alkali metal. In some instances, the electrolyte comprises a salt of the alkali metal. The operating temperature of the device is any suitable temperature such that the electrodes are molten (e.g., less than 600 °C).

In another aspect of the present disclosure, an energy storage device comprises a liquid metal electrode, a second metal electrode that can be a liquid and an electrolyte disposed between the electrodes, where the electrolyte is a paste, and the energy storage device is capable of being transported on a truck.

In another aspect of the present disclosure, an energy storage device comprises a liquid negative electrode comprising an alkali metal, a liquid positive electrode comprising an alloy of the alkali metal and an electrolyte disposed between the electrodes, where the electrolyte comprises a salt of the alkali metal and particles and the energy storage device is capable of being transported on a truck.

The particles can comprise alumina or magnesia. In some cases, the electrolyte is a paste.

In another aspect of the present disclosure, an energy storage device comprises a metal anode, a metal cathode and an electrolyte disposed between the electrodes, where the anode, cathode and electrolyte are liquids at an operating temperature of the device and the operating temperature of the device is less than 500 °C, and the energy storage device is capable of being transported on a truck.

In some cases, the operating temperature of the device is less than 250 °C.

In another aspect of the present disclosure, a method for charging an energy storage device comprises connecting an external charging circuit to terminals of the energy storage device that is capable of being transported on a truck such that an active alkali metal moves from a positive electrode, through an electrolyte, to a negative electrode comprising a metal having a higher chemical potential than the positive electrode.

In some instances, the active alkali metal is lithium, sodium, potassium, or any combination thereof.

In another aspect of the present disclosure, a method for discharging an energy storage device comprises connecting an external load to terminals of the energy storage device that is capable of being transported on a truck such that an active alkali metal moves from a negative electrode, through an electrolyte as cations, to a positive electrode where the active alkali metal forms a neutral metal having a lower chemical potential than the negative electrode.

In some cases, the active alkali metal is lithium, sodium, potassium, or any combination thereof.

In another aspect of the present disclosure, an energy storage device comprises a liquid metal electrode, an electrolyte and a current collector in contact with the electrode, where the current collector comprises a material that has a higher wetability with the liquid metal than with the electrolyte. In some embodiments, the material is a foam.

Energy storage devices of the present disclosure may be used in grid-scale settings or stand-alone settings. Energy storage device of the disclosure can, in some cases, be used to power vehicles, such as scooters, motorcycles, cars, trucks, trains, helicopters, airplanes, and other mechanical devices, such as robots.

A group of cells (e.g., a core, a CE, a system, etc.) with a given energy capacity and power capacity (e.g., a CE or a system capable of storing a given amount of energy) may be configured to deliver at least about 10%, at least about 20%, at least about 30%, at least about 40%, at least about 50%, at least about 60%, at least about 70%, at least about 80%, at least about 90%, at least about 95%, or about 100% of a given (e.g., rated) power level. For example, a 1000 kW system may be capable of also operating at 500 kW, but a 500 kW system may not be able to operate at 1000 kW. In some cases, a system with a given energy capacity and power capacity (e.g., a CE or a system capable of storing a given amount of energy) may be configured to deliver less than about 100%, less than about 110%, less than about 125%, less than about 150%, less than about 175%, or less than about 200% of a given (e.g., rated) power level, and the like. For example, the system may be configured to provide more than its rated power capacity for a period of time that is less than the time it may take to consume its energy capacity at the power level that is being provided (e.g., provide power that is greater than the rated power of the system for a period of time corresponding to less than about 1%, less than about 10% or less than about 50% of its rated energy capacity).

### Electrochemical Cells, Devices and Systems

The present disclosure provides electrochemical energy storage devices (e.g., batteries) and systems. In some examples, an electrochemical cell is a liquid metal battery cell. In some examples, a liquid metal battery cell can include a liquid electrolyte arranged between a negative liquid (e.g., molten) metal electrode and a positive liquid (e.g., molten) metal, metalloid and/or non-metal electrode. In some cases, a liquid metal battery cell has a molten alkaline earth metal (e.g., magnesium, calcium) or alkali metal (e.g., lithium, sodium, potassium) negative electrode, an electrolyte, and a molten metal positive electrode. The molten metal positive electrode can include, for example, one or more of tin, lead, bismuth, antimony, tellurium and selenium. For example, the positive electrode can include Pb or a Pb—Sb alloy. The positive electrode can also include one or more transition metals or d-block elements (e.g., Zn, Cd, Hg) alone or in combination with other metals, metalloids or non-metals, such as, for example, a Zn—Sn alloy or Cd—Sn alloy. In some examples, the positive electrode can comprise a metal or metalloid that has only one stable oxidation state (e.g., a metal with a single or singular oxidation state). Any description of a metal or molten metal positive electrode, or a positive electrode, herein may refer to an electrode including one or more of a metal, a metalloid and a non-metal. The positive electrode may contain one or more of the listed examples of materials. In an example, the molten metal positive electrode can include lead and antimony. In some examples, the molten metal positive electrode may include an alkali or alkaline earth metal alloyed in the positive electrode.

In some cases, an electrochemical cell is a high temperature battery that utilizes a liquid metal negative electrode (e.g., Na, Li), and a solid ion-conducting (e.g., β″-alumina ceramic) electrolyte. In some instances, the solid ion-conducting electrolyte operates above about 100 °C, above about 150 °C, above about 200 °C, above about 250 °C, above about 300 °C, or above about 350 °C. The electrolyte may comprise molten chalcogenide (e.g., S, Se, Te) and/or a molten salt comprising a transition metal halide (e.g., NiCl₃, FeCl₃). The electrolyte may include other supporting electrolyte compounds (e.g., NaCl, NaF, NaBr, Nal).

Any description of a metal or molten metal positive electrode, or a positive electrode, herein may refer to an electrode including one or more of a metal, a metalloid and a non-metal. The positive electrode can contain one or more of the listed examples of materials. In an example, the molten metal positive electrode can include lead and antimony. In some examples, the molten metal positive electrode can include an alkali or alkaline earth metal alloyed in the positive electrode.

An electrochemical energy storage device can include a liquid metal negative electrode, a liquid metal positive electrode, and a liquid salt electrolyte separating the liquid metal negative electrode and the liquid metal positive electrode. The negative electrode can include an alkali or alkaline earth metal, such as lithium, sodium, potassium, rubidium, cesium, magnesium, barium, calcium, or combinations thereof. The positive electrode can include elements selected from transition metals or d-block elements (e.g., Group 12), Group IIIA, IVA, VA and VIA of the periodic table of the elements, such as zinc, cadmium, mercury, aluminum, gallium, indium, silicon, germanium, tin, lead, pnicogens (e.g., arsenic, bismuth and antimony), chalcogens (e.g., sulfur, tellurium and selenium), or combinations thereof. In some examples, the positive electrode comprises a Group 12 element of the periodic table of the elements, such as one or more of zinc (Zn), cadmium (Cd) and mercury (Hg). In some examples, the positive electrode comprises one or more of Zn, Cd, Hg, or such material(s) in combination with other metals, metalloids or non-metals, such as, for example, a Zn—Sn alloy, Zn—Sn alloy, Cd—Sn alloy, Zn—Pb alloy, Zn—Sb alloy, or Bi.

The electrolyte can include a salt (e.g., molten salt), such as an alkali or alkaline earth metal salt. The alkali or alkaline earth metal salt can be a halide, such as a fluoride, chloride, bromide, or iodide of the active alkali or alkaline earth metal, or combinations thereof. In an example, the electrolyte (e.g., in Type 1 or Type 2 chemistries) includes lithium chloride. In some examples, the electrolyte can comprise sodium fluoride (NaF), sodium chloride (NaCl), sodium bromide (NaBr), sodium iodide (Nal), lithium fluoride (LiF), lithium chloride (LiCl), lithium bromide (LiBr), lithium iodide (LiI), potassium fluoride (KF), potassium chloride (KCl), potassium bromide (KBr), potassium iodide (KI), calcium fluoride (CaF₂), calcium chloride (CaCl₂)), calcium bromide (CaBr₂), calcium iodide (Cal₂), or any combination thereof. In another example, the electrolyte includes magnesium chloride (MgCl₂). As an alternative, the salt of the active alkali metal can be, for example, a non-chloride halide, a hydroxide, or a combination thereof. The electrolyte may exhibit low (e.g., minimal) electronic conductance (e.g., electronic shorting may occur through the electrolyte via valence reactions of PbCl₂↔PbCl₃ which increases electronic conductance). For example, the electrolyte can have an electronic transference number (i.e., percentage of electrical (electronic and ionic) charge that is due to the transfer of electrons) of less than or equal to about 0.03% or 0.3%.

In some cases, the negative electrode and the positive electrode of an electrochemical energy storage device are in the liquid state at an operating temperature of the energy storage device. To maintain the electrodes in the liquid states, the battery cell may be heated to any suitable temperature. In some examples, the battery cell is heated to and/or maintained at a temperature of about 100 °C, about 150 °C, about 200 °C, about 250 °C, about 300 °C, about 350 °C, about 400 °C, about 450 °C, about 500 °C, about 550 °C, about 600 °C, about 650 °C, or about 700 °C. The battery cell may be heated to and/or maintained at a temperature of at least about 100 °C, at least about 150 °C, at least about 200 °C, at least about 250 °C, at least about 300 °C, at least about 350 °C, at least about 400 °C, at least about 450 °C, at least about 500 °C, at least about 550 °C, at least about 600 °C, at least about 650 °C, at least about 700 °C, at least about 800 °C, or at least about 900 °C. In such a case, the negative electrode, electrolyte and/or positive electrode can be in a liquid (or molten) state. In some situations, the battery cell is heated to between about 200 °C and about 600 °C, between about 500 °C and about 550 °C, or between about 450 °C and about 575 °C.

The operating temperature can be selected such that it is sufficient to induce at least some of the electrode materials to liquefy. In some cases, the operating temperature is selected to liquefy the material of the negative electrode, electrolyte and the positive electrode. However, in some cases, at least one of the electrodes and the electrolyte may not be liquefied during operation of the cell. For instance, as an alternative, the operating temperature is selected to liquefy the material of the negative electrode and electrolyte, but not the positive electrode. As another alternative, the operating temperature is selected to liquefy the material of the positive electrode and electrolyte, but not the negative electrode.

In some implementations, the electrochemical cell or energy storage device may be at least partially or fully self-heated. For example, a battery may be sufficiently insulated, charged, discharged and/or conditioned at sufficient rates, and/or cycled a sufficient percentage of the time to allow the system to generate sufficient heat through inefficiencies of the cycling operation that cells are maintained at a given operating temperature (e.g., a cell operating temperature above the freezing point of at least one of the liquid components) without the need for additional energy to be supplied to the system to maintain the operating temperature.

Electrochemical cells of the disclosure may be adapted to cycle between charged (or energy storage) modes and discharged modes. In some examples, an electrochemical cell can be fully charged, partially charged or partially discharged, or fully discharged. The state of charge can be determined by the operating voltage of the electrochemical cell. In a discharged state, the operating voltage can be at a minimum, and in a charged state the operating voltage can be at a maximum. During charging, the operating voltage can increase and approach a maximum.

In some implementations, during a charging mode of an electrochemical energy storage device, electrical current received from an external power source (e.g., a generator or an electric power grid) may cause metal atoms in the metal positive electrode to release one or more electrons, dissolving into the electrolyte as a positively charged ion (i.e., cation). Simultaneously, cations of the same species can migrate through the electrolyte and may accept electrons at the negative electrode, causing the cations to transition to a neutral metal species, thereby adding to the mass of the negative electrode. The removal of the active metal species from the positive electrode and the addition of the active metal to the negative electrode stores electrochemical energy. In some cases, the removal of a metal from the positive electrode and the addition of its cation to the electrolyte can store electrochemical energy. In some cases, electrochemical energy can be stored through a combination of removal of the active metal species from the positive electrode and its addition to the negative electrode, and the removal of one or more metals (e.g., different metals) from the positive electrode and their addition to the electrolyte (e.g., as cations). During an energy discharge mode, an electrical load is coupled to the electrodes and the previously added metal species in the negative electrode can be released from the metal negative electrode, pass through the electrolyte as ions, and deposit as a neutral species in the positive electrode (and in some cases alloy with the positive electrode material), with the flow of ions accompanied by the external and matching flow of electrons through the external circuit/load. In some cases, one or more cations of positive electrode material previously released into the electrolyte can deposit as neutral species in the positive electrode (and in some cases alloy with the positive electrode material), with the flow of ions accompanied by the external and matching flow of electrons through the external circuit/load. This electrochemically facilitated metal alloying reaction discharges the previously stored chemical energy to the electrical load.

In a charged state, the negative electrode can include negative electrode material and the positive electrode can include positive electrode material. During discharging (e.g., when the battery is coupled to a load), the negative electrode material yields one or more electrons, and cations of the negative electrode material. In some implementations, the cations migrate through the electrolyte to the positive electrode material and react with the positive electrode material (e.g., to form an alloy). In some implementations, ions of the positive metal species (e.g., cations of the positive electrode material) accept electrons at the positive electrode and deposit as a metal on the positive electrode. During charging, in some implementations, the alloy at the positive electrode disassociates to yield cations of the negative electrode material, which migrate through the electrolyte to the negative electrode. In some implementations, one or more metal species at the positive electrode disassociates to yield cations of the negative electrode material in the electrolyte. In some examples, ions can migrate through an electrolyte from an anode to a cathode, or vice versa. In some cases, ions can migrate through an electrolyte in a push-pop fashion in which an entering ion of one type ejects an ion of the same type from the electrolyte. For example, during discharge, an alkali metal anode and an alkali metal chloride electrolyte can contribute an alkali metal cation to a cathode by a process in which an alkali metal cation formed at the anode interacts with the electrolyte to eject an alkali metal cation from the electrolyte into the cathode. The alkali metal cation formed at the anode in such a case may not necessarily migrate through the electrolyte to the cathode. The cation can be formed at an interface between the anode and the electrolyte, and accepted at an interface of the cathode and the electrolyte.

An electrochemical cell of the present disclosure can be a Type 1 or Type 2 cell, which can vary based on, and be characterized by, the composition of the active components (e.g., negative electrode, electrolyte and positive electrode), and based on the mode of operation of the cells (e.g., low voltage mode versus high voltage mode). Such modes of operation and related chemistries are described in, for example, U.S. patent application Ser. No. 14/286,369, which is entirely incorporated herein by reference.

In Type 1 mode (also “low voltage operation” mode herein), operation of a liquid metal battery cell can involve the utilization of symmetric or substantially symmetric electrode reactions in the form of an alloying/de-alloying electrochemical reaction. In some cases, in Type 1 mode a cell is operated at a voltage from about 0.4 V to 1.5 V. Here, there may be one active metal species which is present in the negative electrode, and/or the same active metal species may be present as an alloyed species in the positive electrode, and there is the only metal species that dissolves in or is extracted from the electrolyte during cell discharging and charging, respectively. The composition of the electrolyte therefore may not substantially change during the low voltage operation mode. Such mode of operation may provide a relatively low cell voltage, resulting in a relatively low energy density.

Although electrochemical cells of the present disclosure have been described, in some examples, as operating in a Type 1 mode or Type 2 mode, other modes of operation are possible. Type 1 mode and Type 2 mode are provided as examples and are not intended to limit the various modes of operation of electrochemical cells disclosed herein.

### Batteries and Housings

Electrochemical cells of the disclosure can include housings that may be suited for various uses and operations. A housing can include one cell or a plurality of cells. A housing can be configured to electrically couple the electrodes to a switch, which can be connected to the external power source and/or the electrical load. The cell housing may include, for example, an electrically conductive container that is electrically coupled to a first pole of the switch and/or another cell housing, and an electrically conductive container lid (e.g., cell cap) that is electrically coupled to a second pole of the switch and/or another cell housing. The cell can be arranged within a cavity of the container. A first one of the electrodes of the cell (e.g., positive electrode) can contact and be electrically coupled with an endwall of the container. A second one of the electrodes of the cell (e.g., negative electrode) can contact and be electrically coupled with a conductive feed-through or conductor (e.g., negative current lead) on the container lid (collectively referred to herein as “cell lid assembly,” “lid assembly” or “cap assembly” herein). An electrically insulating seal (e.g., bonded ceramic ring) may electrically isolate negative potential portions of the cell from positive portions of the container (e.g., electrically insulate the negative current lead from the positive current lead). In an example, the negative current lead and the container lid (e.g., cell cap) can be electrically isolated from each other, where a dielectric sealant material can be placed between the negative current lead and the cell cap. In some instances, the container lid is electrically isolated from the container. The cell lid may or may not be electrically isolated from the negative current lead in such instances. As an alternative, a housing includes an electrically insulating sheath (e.g., alumina sheath) or corrosion resistant and electrically conductive sheath or crucible (e.g., graphite sheath or crucible). In some cases, a housing and/or container may be a battery housing and/or container.

A cell can have any cell and seal configuration disclosed herein. For instance, the active cell materials can be held within a sealed steel/stainless steel container with a high temperature seal on the cell lid. A negative current lead can pass through the cell lid (and be sealed to the cell lid by the dielectric high temperature seal), and connect with a porous negative current collector (e.g., metal foam) suspended in an electrolyte. In some cases, the cell can use a graphite sheath, coating, crucible, surface treatment or lining (or any combination thereof) on the inner wall of the cell crucible. In other cases, the cell may not use a graphite sheath, coating, crucible, surface treatment or lining on an inner wall of the cell crucible. The container or container lining material may be electrically conductive.

A battery, as used herein, can comprise one or more (e.g., a plurality of) electrochemical cells. The cell(s) can include housings. Individual cells can be electrically coupled to one another in series and/or in parallel. In series connectivity, the positive terminal of a first cell is connected to a negative terminal of a second cell. In parallel connectivity, the positive terminal of a first cell can be connected to a positive terminal of a second, and/or additional, cell(s). Similarly, cell modules, packs, cores, CEs and systems can be connected in series and/or in parallel in the same manner as described for cells.

### Electrical Control of Energy Storage Devices

The present disclosure provides energy storage systems comprising electrochemical energy storage devices (e.g., batteries) and battery management systems. An electrochemical energy storage device can include at least one electrochemical cell, also “cell” and “battery cell” herein, sealed (e.g., hermetically sealed) within a housing. A cell can be configured to deliver electrical energy (e.g., electrons under potential) to a load, such as, for example, an electronic device, another energy storage device or a power grid. A cell can include a negative electrode, an electrolyte adjacent to the negative electrode, and a positive electrode adjacent to the electrolyte. The negative electrode can be separated from the positive electrode by the electrolyte. The negative electrode can be an anode during discharge. The positive electrode can be a cathode during discharge. One or more of the negative electrode, electrolyte and positive electrode can be in a liquid state (e.g., molten), as described elsewhere herein.

In some examples, an energy storage device comprises a plurality of cells. Individual cells of the plurality can be electrically coupled to one another in series and/or in parallel. In serial connectivity, the positive terminal of a first cell can be connected to a negative terminal of a second cell. In parallel connectivity, the positive terminal of a first cell can be connected to a positive terminal of a second, and/or additional, cell(s).

A battery management system can be programmed or otherwise configured to determine a state of charge or discharge of one or more energy storage cells of the electrochemical energy storage device. The battery management system can include a computer processor or other logic that executes code to determine the state of charge and other operational characteristics, such as voltage, current, temperature, etc., of the one or more energy storage cells. The battery management system can be operatively coupled to one or more electrochemical energy storage cells of the energy storage system. The battery management system can include a current control device, such as, for example, metal-oxide-semiconductor field-effect transistors (MOSFETs), insulated-gate bipolar transistors (IGBTs), circuit breakers or relays. The current control device can be configured to turn ON or OFF or be in partial ON/OFF state to control the amount of current that is bypassed around (or bled) from a cell for balancing purposes. The partial ON/OFF state can vary the amount of current that is passed from a cell from 0% to 100% of the maximum current that can be passed from the cell, such as, for example, at least about 1%, 2%, 3%, 4%, 5%, 6%, 7%, 8%, 9%, 10%, 20%, 30%, 40%, 50%, 60%, 70%, 80%, 90%, or 99% of the maximum.

The battery management system can aid in determining a state of charge of individual cells or a group of cells, as well as performing cell balancing, which enables states of charge on cells to be balanced to ensure that cells charge and discharge in tandem when connected together in series or parallel. For serial operation, the battery management system can require voltage sensing on cells and ballasting provisions that are connected to the battery management system. The ballasting provisions can include one or more electrical flow lines (e.g., wires) that are operatively coupled to the cells or a plurality of cells. The electrical flow lines can include sensing lines configured to enable the battery management system to sense an operating temperature of one or more cells of the energy storage device.

The battery management system can estimate the state of charge of a cell by calculating and/or measuring voltage, and amount and direction of current flow, through the relationship V (cell)=i*R+Vcell, where ‘V (cell)’ is the voltage that characterizes the state of charge of the cell, ‘i’ is the current measured through the ballasting line, ‘R’ is the impedance of the ballasting line, and Vcell is the inherent voltage of the cell. V(Cell) may be characterized as the overall voltage measured by the battery management system, taking into account the inherent voltage of the cell (Vcell) and the voltage drop measured as a function of current and voltage over the ballasting lines. Vcell may be a function of the amount of current passing through the cell, the state of charge of the cell and/or recent charge/discharge history (e.g., hysteresis effects). The current can be measured with the aid of an ammeter, which can be separate from or integrated in the battery management system. For high temperature energy storage devices, the impedance of the ballasting lines can vary as a function of temperature and in accordance with the material used in the ballasting lines. Thus, dependence on an assumed impedance of the ballasting lines at room temperature can yield an inaccurate estimate of the state of charge of a cell.

In order to account for erroneous estimates of the state of charge at temperatures that are elevated with respect to room temperature, the battery management system can calculate the state of charge by dynamically calculating and compensating for variations in impedance along ballasting lines. This can advantageously enable the battery management system to have a reliable metric of impedance on the ballasting lines, including the sensing lines, and thereby get a precise, substantially precise, or estimated measurement of cell voltage as well as the amount and direction of current flow, and, thereby state of charge. Such information can permit the battery management system to control balancing current appropriately. At the operating temperature of an electrochemical cell, and as the temperature fluctuates, the battery management system can calculate an impedance that is a function of the temperature. Using the current through a ballasting line, the calculated impedance (R) can then be used to estimate the state of charge (V) through the above relationship.

Impedance can be calculated using a correspondence between i) impedance and ii) temperature and, in some cases, physical property (e.g., material, diameter) of a line. For example, a 1-meter long 10AWG nickel wire can have a resistance of about 0.022 Ohms at 20 °C and about 0.110 Ohms at 550 °C. These values can be stored in a look-up table in memory or can be dynamically calculated by the battery management system logic. In some examples, the system can derive the impedance at a given temperature using the look-up table.

In some examples, an energy storage device comprises a stack of cells connected together in series. Sense wires are coupled to the cells for use as current drive paths. The sense wires can be heavy or high gauge wire, such as, for example, 12AWG nickel wire. With heavier wire, maintained at the operating temperature of the energy storage device (e.g., 500 °C), there can be increased resistance to electrical current that can manifest as a voltage drop across the sense line.

The battery management system can include a software algorithm in a memory location of the battery management system. The algorithm can aid in estimating the state of charge of an energy storage device. The algorithm can be pre-loaded in a memory location of the battery management system with a look-up matrix (or table) that has parameters, such as, for example, temperature, wiring distance, wiring material, wire index and/or any junction-related impedances (see, e.g., TABLE 6 below, showing how impedance, provided in units of Ohms (or an arbitrary unit) or provided as a multiplication factor, changes at various temperatures and wire lengths). The algorithm can take input from one or more temperature sensors of the energy storage system. Based on the temperature readings, the battery management system, as part of the algorithm, can refer to the look-up table to determine the impedance or impedance variation on a particular current path to a cell. From the measured temperature and measured current, the battery management system can estimate the impedance of ballasting provisions, including, for example, sensing (or sense) lines and/or balancing lines that pass current. From the measured impedance, the voltage of an individual cell or groups of cells can be estimated. From the voltage, the state of charge can be estimated (e.g., using the amount and direction of current). The battery management system can then regulate the flow of electrical current to or from one or more of the cells. As temperature of the system varies, by varying the look-up parameter and adjusting current control, the battery management system can enable an accurate mechanism of compensating for impedance mismatch.

TABLE 6
Example look-up table showing impedance as a function of
temperature and wire length. The impedance is shown for
temperatures T1, T2, T3 and T4 and wire lengths x and y.

| | T1 | T2 | T3 | T4 |
|---|---|---|---|---|
| Wire length x | 0.05 | 0.07 | 0.09 | 0.11 |
| Wire length y | 0.08 | 0.09 | 0.11 | 0.15 |

Battery management systems of the present disclosure can be capable of independently regulating flow of current to or from an electrochemical cell or group of electrochemical cells. In some examples, the battery management system can regulate the flow of current from a first cell independently from the flow of current from a second cell in series with the first cell. This can advantageously enable the battery management system to operate (e.g., charge or discharge) the first cell while independently operating the second cell.

In some cases, a known fixed value resistance can be introduced to the sense path in addition to impedance brought about by wiring. In some cases, the added resistance can be eliminated altogether and the inherent resistance of a wire can be used to estimate the impedance of a given wire.

Battery management systems of the present disclosure can be able to implement a substantially tight control on current path impedance and achieve higher accuracy in balancing without adding additional components. In some cases, a battery management system can achieve cell balancing within an accuracy of at most about 50%, 40%, 30%, 20%, 15%, 10%, 5%, 4%, 3%, 2%, 1%, 0.5%, or less. The battery management system can use, for example, cell-to-cell voltage(s) to quantify cell balancing (e.g., how balanced cells are in the system). For example, a maximum allowable spread in cell-to-cell voltage can be determined to be about, or less than about, 1 milli-Volt (mV), 10 mV, 50 mV, 100 mV or 200 mV, and the battery management system can balance the cells to maintain one or more (e.g., all) cell voltages within this limit. Cell balancing can lead to longer battery life and larger charge capacities. In addition, battery management systems of the present disclosure can facilitate the adjustment of physical distances to support installation or maintenance of cells without having to redesign hardware constituents of a battery management system.

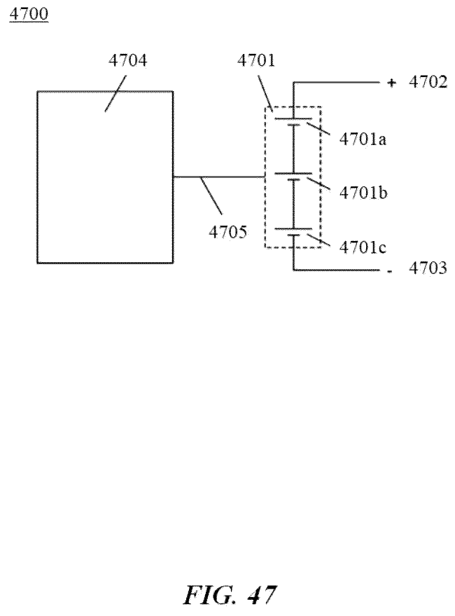

FIG. 47 shows an energy storage system 4700 comprising an electrochemical energy storage device 4701 with individual electrochemical energy storage cells (or groups of electrochemical cells) 4701a, 4701b and 4701c. In some cases, each of 4701a-4701c can comprise or represent a parallel string of cells. In some examples, each of 4701a-4701c can comprise one or more liquid metal battery cells, as described elsewhere herein. Any aspects of the disclosure described in relation to cells 4701a-4701c may equally apply to groups of cells 4701a-4701c at least in some configurations. The device 4701 has a positive terminal 4702 and a negative terminal 4703 that can be electrically coupled to a load, such as a power grid, in some cases through one or more intermediary elements. The cells 4701a-4701c in the illustrated example are in a serial configuration, but in other examples, cells can be in either a serial or parallel configuration. In some cases, some cells can be in a serial configuration, while other cells can be in a parallel configuration. For instance, cells can be in a parallel configuration to provide for redundancy or increase the overall charge capacity of the electrochemical energy storage device.

While the device 4701 comprises three cells 4701a-4701c, the device 4701 can include any number of cells. The device 4701 can include at least about 1, 2, 3, 4, 5, 6, 7, 8, 9, 10, 20, 30, 40, 50, 100, 200, 300, 400, 500, 1000, 10,000, 100,000 or 1,000,000 cells, or between about 1 and about 100,000 or between about 10 and about 1,000 cells.

The system 4700 further comprises a battery management system 4704 that is operatively coupled to the device 4701 through a ballasting member 4705. The ballasting member 4705 can include one or more ballasting lines, which can include sensing lines and current flow lines. The ballasting member 4705 can be used to divert at least some of the current through the cells 4701a-4701c through the ballasting member, which can aid in cell balancing.

Battery management systems can include various configurations of ballasting circuits. A ballasting circuit can be coupled to an energy storage device and used to estimate the state of charge of the energy storage device, and to aid in balancing individual cells of the energy storage device.

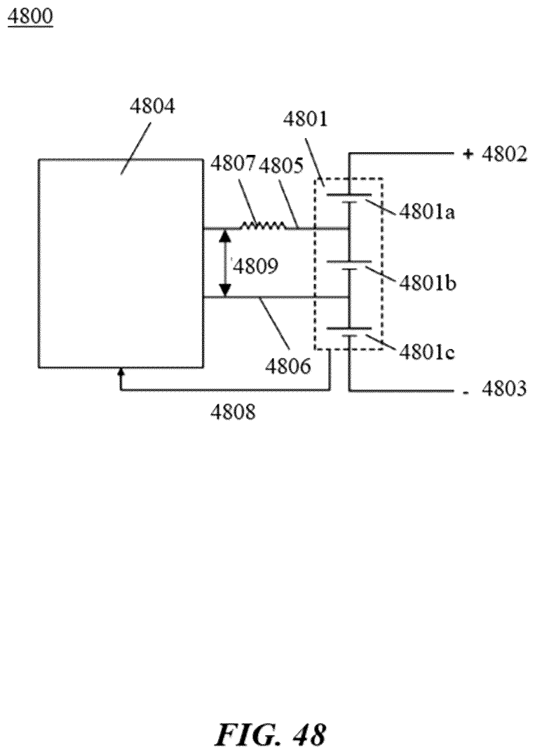

FIG. 48 shows an energy storage system 4800 comprising an energy storage device 4801 comprising a first cell (or group of cells) 4801a, a second cell (or group of cells) 4801b and a third cell (or group of cells) 4801c. In some cases, each of 4801a-4801c can comprise or represent a parallel string of cells. In some examples, each of 4801a-4801c can comprise one or more liquid metal battery cells, as described elsewhere herein. For example, in a configuration where 4801a-4801 represent individual cells, each of the cells 4801a-4801c can be a liquid metal battery. Any aspects of the disclosure described in relation to cells 4801a-4801c may equally apply to groups of cells 4801a-4801c at least in some configurations. The device 4801 has a positive terminal 4802 and a negative terminal 4803 that can be electrically coupled to a load, such as a power grid. Various components of the system 4800 are connected to one another by current flow paths (illustrated lines). In some cases, one or more current flow lines (not shown) can be used to divert current to or from any one of the cells 4801a, 4801b and 4801c (e.g., in addition to or instead of a first sense line 4805 and a sense line 4806).

The system 4800 further comprises a battery management system 4804 that is operatively coupled to the device 4801 through the first sense line 4805 and the second sense line 4806. The first sense line 4805 is coupled to a line connecting the first cell 4801a and the second cell 4801b, and the second sense line 4806 is coupled to a line connecting the second cell 4801b and the third cell 4801c. A temperature sensor 4808 provides a temperature of the device 4801 to the battery management system 4804. In some examples, the temperature sensor 4808 is a thermocouple. The system 4800 may also comprise one or more other measurement sensors or devices (e.g., an ampere-meter).

The first sense line 4805 includes a resistor 4807 with a known impedance that does not substantially vary with temperature, or varies with temperature in a determinable manner (e.g., with the aid of a look-up table). As an alternative, the resistor 4807 can be precluded, and the impedance of the first sense line 4805 can be determined using a look-up table or other matrix that provides a correspondence between the temperature measured by the temperature sensor 4808 and the impedance. The look-up table can include physical properties of the sense line (or wire), such as, for example, wire diameter and/or elemental make-up. The estimation of the impedance can be a function of the temperature as well as the physical properties.

The battery management system 4804 can use the temperature measured by the temperature sensor 4808 to estimate the impedance of various components of the system 4800, such as the first sense line 4805 (if the resistor 4807 is precluded), second sense line 4806, and current flow path leading from the negative terminal 4803 to the positive terminal 4802.

From the temperature measured by the temperature sensor 4808, the battery management system 4804 can estimate the impedance across a signal path, such as the first and second sense lines 4805 and 4806. From the measured impedance, the battery management system 4804 can then estimate the state of charge (voltage) of the cell 4801b in FIG. 48. Using the current measured along the current flow path leading from the negative terminal 4803 to the positive terminal 4802, and the impedance of the current flow path as determined using the temperature measured by the sensor 4808, the battery management system 4804 can estimate the overall voltage of the cells 4801a-4801c (V=current*impedance). For example, using the impedance along a current flow path leading from the negative terminal 4803, through the third cell 4801c and the second sense line 4806, and voltage measurement at 4803, the battery management system 4804 can measure the voltage across the third cell 4801c. The battery management system 4804 estimates the impedance using the temperatures measured by the temperature sensor 4808, and using, for example, a look-up table to determine the impedance as a function of temperature. As another example, a voltage drop 4809 across the second cell 4801b can be calculated by estimating the impedance of the first sense line 4805 and the second sense line 4806, and measuring the current from the first sense line 4805 through the second cell 4801b to the second sense line 4806, or vice versa. Next, the voltage drop 4809 is calculated by taking the product of the estimated impedance and the measured current.

Based on the temperature readings, the battery management system 4804 can determine the precise impedance variation on a given current path to cell 4801a, 4801b or 4801c. The system 4804 can then command current control devices of the system 4804 to turn ON or OFF, or be in partial ON/OFF stage (e.g., 10%, 20%, 30%, 40%, or 50% on), to control the amount of current that is bypassed around or bled from cell 4801a, 4801b or 4801c for balancing purposes. In a partial ON/OFF stage, the current flow can be a fraction of the maximum current flow. For example, in a 50% on stage, the current flow is 50% of the maximum current flow. As temperature of the system varies, by varying the look-up parameter and adjusting current control, the system 4804 can enable an accurate mechanism of compensating for impedance mismatch.

The voltage drop 4809 provides an estimation of the state of charge of the second cell 4801b. If the second cell 4801b is in a charged state (e.g., the voltage drop 4809 is about 1 V), then the second cell 4801b may be discontinued from charging by bypassing current around it through components in 4804. If the first cell 4801a and/or third cell 4801c is not charged, then these cells can be charged (e.g., continue to be charged), but current can be diverted from the second cell 4801b. In some cases, the sense line 4805 and 4806 can be used to divert current to or from any one of the cells 4801a, 4801b and 4801c.

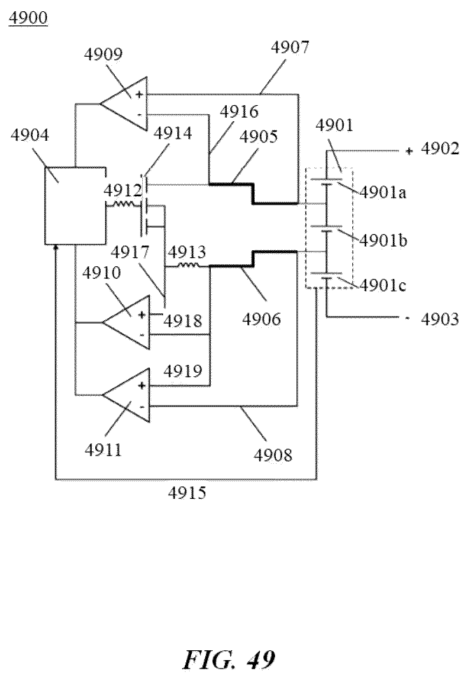

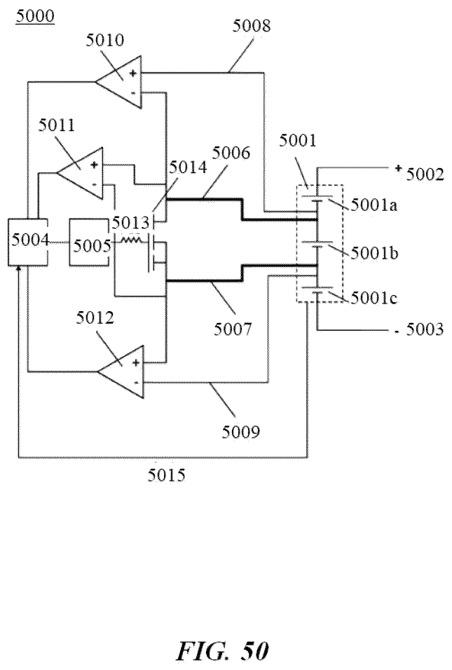

FIG. 49 and FIG. 50 are examples of energy storage systems with drive circuits that can provide dynamic impedance control.

FIG. 49 shows an energy storage system 4900 comprising an energy storage device 4901 comprising a first cell (or group of cells) 4901a, a second cell (or group of cells) 4901b and a third cell (or group of cells) 4901c. Each of 4901a-4901c can comprise or represent one cell or multiple cells in parallel (e.g., a parallel string of cells). In some examples, each of 4901a-4901c can comprise one or more liquid metal battery cells, as described elsewhere herein. For example, in a configuration where 4901a-4901 represent individual cells, each of the cells 4901a-4901c can be a liquid metal battery. Any aspects of the disclosure described in relation to cells 4901a-4901c may equally apply to groups of cells 4901a-4901c at least in some configurations. The device 4901 has a positive terminal 4902 and a negative terminal 4903 that can be electrically coupled to a load, such as a power grid, in some cases through one or more intermediary elements. During discharging of the device 4901, current can flow along the direction leading from the negative terminal 4903 to the positive terminal 4902 through at least some of the cells 4901a-4901c. During charging of the device 4901, current can flow in the opposite direction (i.e., from the positive terminal 4902 to the negative terminal 4903).

In this example, the system 4900 comprises a drive circuit 4904 as part of a battery management system of the system 4900, a first high current line 4905, a second high current line 4906, a first sense line 4907 and a second sense line 4908. The system 4900 further comprises a first operation amplifier (“op-amp”) 4909, a second op-amp 4910 and a third op-amp 4911. A first resistor 4912 (e.g., 10 kOhm resistor) couples the drive circuit 4904 to a metal-oxide-semiconductor field-effect transistor (MOSFET) 4914. A second resistor 4913 (e.g., 10 mOhm resistor) couples the second high current line to a line connecting the positive terminal of the second op-amp 4910 to the MOSFET 4914. Various components of the system 4900 are connected to one another by current flow paths (illustrated lines). A negative terminal of the first op-amp 4909 is electrically coupled to a first end of the first high current line 4905 through line 4916, and a positive terminal of the first op-amp 4909 is electrically coupled to a second end of the first high current line 4905 through the first sense line 4907, as shown. A positive terminal of the second op-amp 4910 electrically coupled to the MOSFET 4914 through line 4917, and a negative terminal of the second op-amp 4910 is electrically coupled to a first end of the second high current line 4906 through line 4918. A positive terminal of the third op-amp 4911 is electrically coupled to the first end of the second high current line 4906 through line 4919, and a negative terminal of the third op-amp 4911 is electrically coupled to a second end of the second high current line 4906 through the second sense line 4908.

In an example operation of the system 4900, the drive circuit 4904 turns on the MOSFET 4914. Current is then bypassed around cell 4901b through the high current lines 4905 and 4906 and the resistor 4913. In such a case, current does not flow through the second cell 4901b, but flows from the cell 4901a through the first high current line 4905, the MOSFET 4914, the second resistor 4913, the second high current line 4906 and the cell 4901c. In cases in which the high current lines 4905 and 4906 are heavy gauge wires of, for example, stainless steel or nickel, a measurable voltage drop may form across the lengths of the high current lines 4905 and 4906 (e.g., along the thicker portions of the lines/wires in FIG. 49). The op-amps 4909 and 4911 are used to sense the voltage drop across the high current lines 4905 and 4906, and the op-amp 4910 is used to sense the voltage drop across the resistor 4913. The resistor 4913 can be populated with a known impedance value and can be combined with the sensed voltage so that the current can be calculated via, for example, V=I*R. If the voltage drop across the high current lines 4905 and 4906 is combined with the current through the resistor 4913, a known wire cross-section and its resistivity (e.g., in circular mil Ohm per foot or in Ohm-meter) at the measured temperature, then the wire length can be estimated using the relationship: wire length (e.g., in feet)=[voltage (e.g., in volt (V))/current (e.g., in ampere (A))]*[area (e.g., in cmil)]/[resistivity (e.g., in (2*cmil/foot)]. This wire length can be ‘learned’ (e.g., calculated and stored for future retrieval, or calculated and statistically averaged together with previous and/or future determinations) by the battery management system (e.g., over time) and used with temperature, cross-section and resistivity (e.g., circular mil Ohm per foot) information to estimate wire impedance in the system. In some cases, battery management system electronics components can be positioned at a central location with respect to the physical location of cells. In these situations, high current balancing wire lengths may be different for different cells depending on their relative position with respect to the battery management electronics. The ability to measure impedance of the balancing wires for different balancing currents can therefore permit better control over the amount of current that is diverted, which can provide for improved voltage balancing between cells and improved state of charge matching between cells.

During operation, the first high current line 4905 and the second high current line 4906 can transmit current at a density from about 10 mA/cm² to about 10 A/cm². The first sense line 4907 and the second sense line 4908 can be non-current carrying lines. The first sense line 4907 and the second sense line 4908 can be configured to permit the estimation of voltage.

The first sense line 4907 and the first high current line 4905 may be electrically coupled to the device 4901 at a joint connection point between the cells 4901a and 4901b. Similarly, the second sense line 4908 and the second high current line 4906 may be electrically coupled to the device 4901 at a joint connection point between the cells 4901b and 4901c. In this configuration, the joint wire or line (e.g., from the point where each pair of sense and high current lines meet to the connection point at the device 4901) may be configured to exhibit a limited voltage drop. For example, the joint line may comprise a wire type with a similar thickness as the wire type(s) used for the sense lines.

The system 4900 further comprises a temperature sensor 4915 that is in thermal communication with the device 4901. The temperature sensor 4915 is configured to aid the drive circuit 4904 in measuring the temperature of the device 4901, such as the operating temperature of the device 4901 or one or more individual cells 4901a, 4901b and 4901c of the device 4901. Although one temperature sensor 4915 is shown, the system 4900 can include any number of temperature sensors. In some cases, each cell 4901a, 4901b and 4901c includes an individual temperature sensor. The individual temperature sensors can be in communication with the drive circuit 4904.

In an example operation of the system 4900, the drive circuit 4904 receives as input the temperature of the device 4901. From the temperature, the drive circuit 4904 estimates the impedance of each of the individual lines of the system 4904, such as the lines 4905-4908. The drive circuit 4904 can then estimate the state of charge (voltage) of the second cell 4901b. If the second cell 4901b is in a charged state, then the drive circuit can divert current from the current flow path leading from the negative terminal 4903 to the positive terminal 4902 along either the first high current line 4905 or the second high current line 4906.

FIG. 50 shows an energy storage system 5000 comprising an energy storage device 5001 comprising a first cell (or group of cells) 5001a, second cell (or group of cells) 5001b and a third cell (or group of cells) 5001c. Each of 5001a-5001c can comprise or represent one cell or multiple cells in parallel (e.g., each of 5001a-5001c can be individual cells or parallel strings of cells). In some examples, each of 5001a-5001c can comprise one or more liquid metal battery cells, as described elsewhere herein. For example, in a configuration where 5001a-5001 represent individual cells, each of the cells 5001a-5001c can be a liquid metal battery. Any aspects of the disclosure described in relation to cells 5001a-5001c may equally apply to groups of cells 5001a-5001c at least in some configurations. The device 5001 has a positive terminal 5002 and a negative terminal 5003 that can be electrically coupled to a load, such as a power grid, in some cases through one or more intermediary elements. During discharging of the device 5001, current can flow along the direction leading from the negative terminal 5003 to the positive terminal 5002 through at least some of the cells 5001a-5001c. During charging of the device 5001, current can flow in the opposite direction (i.e., from the positive terminal 5002 to the negative terminal 5003).

The system 5000 further includes a processor 5004 (e.g., a microprocessor) and a drive circuit 5005 as part of a battery management system of the system 5000. The system 5000 includes a first high current line 5006, a second high current line 5007, a first sense line 5008 and a second sense line 5009. The system 5000 further comprises a first operation amplifier (“op-amp”) 5010, a second op-amp 5011 and a third op-amp 5012. A resistor 5013 (e.g., 10 kOhm resistor) couples the drive circuit 5005 to a MOSFET 5014. In this configuration, additional resistor(s) are not used for coupling high current line(s) to line(s) connecting the op-amp(s) 5010, 5011 or 5012 to the MOSFET 5014. Various components of the system 5000 are connected to one another by current flow paths (illustrated lines). A negative terminal of the first op-amp 5010 is electrically coupled to a first end of the first high current line 5006, and a positive terminal of the first op-amp 5010 is electrically coupled directly to the device 5001 through the first sense line 5008, as shown. A positive terminal of the second op-amp 5011 is electrically coupled to the first end of the first high current line 5006, and a negative terminal of the second op-amp 5011 is electrically coupled to a first end of the second high current line 5007. A positive terminal of the third op-amp 5012 is electrically coupled to the first end of the second high current line 5007, and a negative terminal of the third op-amp 5012 is electrically coupled directly to the device 5001 through the second sense line 5009, as shown.

Because the first sense line 5008 and the first high current line 5006, and the second sense line 5009 and the second high current line 5007 are electrically coupled to the device 5001 at separate connection points, lines with different wire types may be used throughout (up to the respective connection points at the device 5001).

The system 5000 includes a temperature sensor 5015 that provides a temperature of the device 5001 or one or more of the cells 5001a-5001c to the processor 5004. The processor 5004 can determine the impedances of various components of the system 5000 using the temperature measured using the temperature sensor 5015 together with a correspondence between impedance and temperature, such as a look-up table or matrix. From the calculated impedance, the processor 5004 can instruct the drive circuit 5005 to direct or re-direct current flow through some or all of the cells 5001a-5001c using one or both of the first high current line 5006 and the second high current line 5007.

In some cases, the system in FIG. 50 can enable a more accurate implementation, where differential measurements are taken across the MOSFET 5014 by the second op-amp 5011, whereas in FIG. 49, a similar differential measurement across the MOSFET 4914 is not obtained.

Differential voltages may be measured at two or more locations. For example, in FIG. 49 and FIG. 50, differential readings can be taken across proximal and distal ends of the ballast lines 4905 and 4906, and 5006 and 5007, respectively. In some cases, as the lengths of ballast lines change, measurement values automatically update proportionate to the increase or decrease in length. In some examples, the battery management system can employ three differential voltage measurements to accomplish a temperature independent, automatically compensating ballasting circuit. A voltage drop measurement can be made across two power transmitting wire routes via secondary, un-loaded, voltage sense leads to measure the losses and automatically adjust the current controlling device to make up for the difference. This can allow for a variation in system temperature, wire length and gauge from battery to battery without a need to program different reference or look-up tables for each circumstance.

### Battery Management System

An energy storage system (also “system” herein), such as, for example, a battery, may be charged and discharged by flowing electric current across negative and positive terminals of the battery, which can comprise parallel and/or series-connected cells. The direction and intensity of the flow of current may be controlled by power electronics. As a cell is charged and approaches a full state of charge (SOC), the cell voltage may increase and may serve as an electrical signature that can be used to inform a control system that the cell can stop being charged. As a cell is discharged and approaches a zero SOC, the cell voltage may decrease and may serve as an electrical signature that can be used to inform a control system that the cell can stop being discharged. During operation, batteries exhibit a self-discharge current which may not be identical in every cell. The self-discharge current can reduce the state of charge (SOC) of the cell; the process can be reversible and the discharged capacity can be regained during charging.

The SOC of a cell can be directly related to the voltage of the cell. Cells connected in parallel can have the same terminal voltage. In some cases, parallel-connected cells can remain at a similar SOC as long as the difference in the self-discharge current is relatively small, for example, less than about 50 mA/cm², 40 mA/cm², 30 mA/cm², 20 mA/cm², 10 mA/cm², 5 mA/cm², 1 mA/cm², 0.5 mA/cm², 0.1 mA/cm², 0.05 mA/cm², or 0.01 mA/cm². However, cells connected in series (or parallel strings of cells connected in series) may result in series-connected cells (or series-connected parallel strings of cells) becoming electrically ‘unbalanced’, namely, that their SOC can become increasingly different over time due to the differences in the self-discharge current. During charging and discharging, the charge capacity may be limited by the cell with the highest state of charge (in some cases, the cell with the lowest self-discharge current) and the discharge capacity may be limited by the cell with the lowest state of charge (in some cases, the cell with the highest self-discharge current). In some cases, the SOC of a cell module is the average of the SOCs of all of the cells within the cell module and the self-discharge rate of the cell module is the sum of the self-discharge rates of all of the cells within the cell module, and the charge capacity of a series-connected string of cell modules may be limited by the cell module with the highest state of charge (in some cases, the cell module with the lowest self-discharge current) and the discharge capacity of a series-connected string of cell modules may be limited by the cell module with the lowest state of charge (in some cases, the cell module with the highest self-discharge current). Thus, during normal operation of series-connected cells (or series-connected cell modules) with different self-discharge currents, the apparent capacity of the system can reduce over time, limited by the cells (or cell modules) with the highest and lowest self-discharge rates. Furthermore, a cell (or a cell module) may be damaged if the voltage applied to the cell (or cell module) exceeds the charge cut-off limit or drops below the discharge cut-off limit. Accordingly, a control system may be included as part of a functioning battery system. The control system can monitor cell voltages to ensure that cells are operated within safe voltage limits and/or provide the capability to electrically balance the cells to ensure that the accessible charge and discharge capacity of the battery does not decrease over time due to, for example, the unbalancing mechanisms driven by differences in the self-discharge currents of cells.

A battery management system (BMS) may be provided to manage an energy storage system, such as, for example, one or multiple rechargeable batteries. A BMS can include a computer processor and other electrical components, as described elsewhere herein. In some examples, a BMS manages a battery by protecting it from operating outside its safe or permissible operating range(s), by monitoring its state of charge and state of health, calculating secondary data, reporting the secondary data, controlling its environment, authenticating it and/or balancing it. In some cases, the BMS manages (e.g., monitor and/or control) an energy storage device (e.g., a battery) by monitoring a first parameter (e.g., voltage, temperature) of the energy storage device (e.g., of an electrochemical cell in the energy storage device) and determining a second parameter based on the first parameter (e.g., state of charge, state of health, impedance value, etc.). The second parameter can be derived from the first parameter. The BMS may control the operating state of the energy storage device (e.g., an individual electrochemical cell or a group of electrochemical cells thereof) in response to the first parameter, the second parameter, or both. For example, the BMS can control the operating state of an electrochemical cell in response to the second parameter.

A BMS may comprise one or more electrical circuit boards (also “BMS circuit boards” or “BMS board” herein). The electrical circuit board(s) may be provided at the battery (e.g., connected to individual cells or groups of cells) and/or separately from the battery (e.g., electrically connected to individual cells or groups of cells from a remote location). In some examples, a core may comprise one BMS electrical circuit board that is connected to and manages all of the cells or cell modules within the core. In other examples, the BMS system may include multiple electrical circuit boards that are distributed throughout the core (e.g., one connected to each cell pack). Each separate electrical circuit board can be connected to and control its own set of cells, cell modules or one or more cell packs. Each separate electrical circuit board can communicate information to another electrical circuit board. For example, each separate electrical circuit board can communicate information to an electrical circuit board that coordinates information flow to and from all of the separate distributed electrical circuit boards.

A BMS may monitor the state of a battery as represented by one or more parameters, such as, for example: voltage (e.g., total voltage, voltages of individual cells, voltage of cell modules, voltage across interconnections such as, for example, across busbars and other cell-to-cell or pack-to-pack wiring, minimum and maximum cell voltage, voltage of periodic taps, differential voltage between two points a circuit, or sporadic fluctuations in cell voltage), temperature (e.g., average temperature, coolant intake temperature, coolant output temperature, temperatures of individual cells, temperature of battery management system components on circuit board(s) and/or mounted outside circuit boards, or temperature of surrounding environment), state of charge (SOC) (e.g., the charge level of the battery), leakage current (e.g., an estimate of the leakage current in a given cell or cell module), balancing current (e.g., the current applied by and/or controlled by the BMS to a cell module to keep cell the module electrically and charge balanced with other cell modules connected in series to the cell module), balancing charge capacity (e.g., charge capacity required to keep a cell or cell module balanced with other cells or cell modules), state of health (SOH) (e.g., a variously-defined measurement of the overall condition of the battery), coolant flow (e.g., fluid flow in batteries cooled by air or other fluid(s)), and/or current (e.g., current in or out of the battery).

The BMS (e.g., a controller thereof) may obtain power to operate circuit components (e.g., computer processor(s) and/or peripheral devices) from the cell(s) (e.g., the cell(s) monitored by the BMS) and/or from secondary power that may be delivered to the BMS through a local power distribution system. The local power distribution system may be a low voltage DC distribution (e.g., 12 VDC, 24 VDC, 48 VDC) or AC distribution (e.g., 110 VAC to 240 VAC). In some cases, the BMS does not draw power from cell(s) (e.g., the BMS derives power to operate solely from an external power distribution network). In some cases, the BMS may use a power distribution network to start and maintain operation (e.g., when cells have zero voltage). The power distribution system may comprise a secondary dedicated back-up battery system to prevent the BMS system from abruptly shutting down in the event of a power loss to the power distribution network. In some cases, the BMS (e.g., the controller) receives power from an auxiliary power source. The auxiliary power source may be, for example, an electric power grid and/or the back-up battery system. In some cases, the controller is predominantly powered from the auxiliary power source. For example, greater than or equal to about 50%, 60%, 70%, 80%, 90%, 95%, or 100% of the power of the controller is provided by the auxiliary power source.

A BMS may monitor and control the temperature of the battery to ensure that cells are operated within operating parameters, such as, for example, within given temperature limits. For example, the operating temperature may be at and/or maintained between about 250 °C and 750 °C. In some examples, the operating temperature may be at and/or maintained between about 300 °C and 750 °C, between about 350 °C and 750 °C, between about 400 °C and 750 °C, between about 450 °C and 750 °C, between about 500 °C and 750 °C, between about 550 °C and 750 °C, between about 600 °C and 750 °C, between about 440 °C and 500 °C, between about 440 °C and 480 °C, between about 440 °C and 460 °C, between about 460 °C and 480 °C, or between about 650 °C and 750 °C. In other examples, the operating temperature may be at and/or maintained between about 250 °C and 700 °C, between about 250 °C and 650 °C, between about 250 °C and 600 °C, between about 250 °C and 550 °C, between about 250 °C and 500 °C, between about 250 °C and 450 °C, between about 250 °C and 400 °C, between about 350 °C and 400 °C, or between about 250 °C and 350 °C.

A cell or a battery operating under (e.g., below) the minimum operating temperature limit may have low charging capacity. In some cases, the battery is not able to charge or discharge at a useful rate (e.g., the battery may charge or discharge at about 0% of its rated charge/discharge capacity) when it is operated below the minimum operating temperature limit. The BMS may be configured to keep the cell or battery operating over (e.g., above) a minimum temperature of at least about 250 °C, 300 °C, 350 °C, 400 °C, 450 °C, 500 °C, 550 °C, 600 °C or 650 °C. In some cases, a cell or a battery operating over the maximum operating temperature limit may cause damage to the battery. For example, the BMS may keep the cell or battery operating under (e.g., below) a maximum temperature of at most about 350 °C, 400 °C, 450 °C, 500 °C, 550 °C, 600 °C, 650 °C, 700 °C, or 750 °C. Temperature variations among individual cells and/or cell packs may cause a decrease in battery performance.

The temperature(s) of a cell or a battery may be measured by contact-based or non-contact thermal sensors suitable for the operating temperature of the liquid battery (e.g., between about 250 °C and 750 °C). The temperature may be measured by the battery management system. In some cases, the temperature of the cell is measured by contacting the probes of a thermocouple with the liquid metal negative electrode, liquid salt electrolyte, and/or liquid metal positive electrode in a cell. Two metal probes of the thermocouple can produce a voltage which is communicated to a local daughter board via a wire or a wireless connection. The voltage produced by the thermocouple can be compared with a reference voltage on the daughter board and converted into temperature information. In some cases, the temperature of the cell is measured by an infrared (IR) thermometer located on or connected to the daughter board and thermally insulated from a cell. A laser on the IR sensor can aim at one or more cell bodies. By measuring the amount of infrared energy emitted by the one or more cell bodies, the IR thermometer can measure the temperature of a cell or a group of cells (e.g., cell pack) from a distance.

A BMS may calculate one or more parameters based on the measurements from one or more cells or a group of cells (e.g., a cell module), such as, for example: average (e.g., nominal) charge voltage during a full or partial charge, average (e.g., nominal) discharge voltage during a full or partial discharge, maximum charge current as a charge current limit, maximum discharge current as a discharge current limit, energy (e.g., in kWh) delivered during the last full or partial discharge, energy (e.g., in kWh) accepted (also “taken in” herein) during the last full or partial charge, energy efficiency after the cells are brought back to a previously recorded SOC (e.g., full SOC) after one or more full or partial charges/discharges (e.g., the total energy (e.g., in kWh) provided to the battery during one or more (e.g., one or multiple, such as, for example, at least about 1, 2, 3, 4, 5, 10, 15, 20, 25, 50, 75, 100, 150, 200, 300 or more) charging steps divided by the total energy (e.g., in kWh) provided by the battery during one or more (e.g., one or multiple, such as, for example, at least about 1, 2, 3, 4, 5, 10, 15, 20, 25, 50, 75, 100, 150, 200, 300 or more) discharging steps), discharge capacity (e.g., in Ah) delivered during the last full or partial discharge cycle, charge capacity (e.g., in Ah) accepted (also “taken in” herein) during the last full or partial charge, Coulombic efficiency after the cells are brought back to a previously recorded SOC (e.g., full SOC) after one or more full or partial charges/discharges (e.g., the total capacity (e.g., in Ah) provided to the battery during one or more (e.g., one or multiple, such as, for example, at least about 1, 2, 3, 4, 5, 10, 15, 20, 25, 50, 75, 100, 150, 200, 300 or more) charging steps divided by the total capacity (e.g., in Ah) provided by the battery during one or more (e.g., one or multiple, such as, for example, at least about 1, 2, 3, 4, 5, 10, 15, 20, 25, 50, 75, 100, 150, 200, 300 or more) discharging steps), internal impedance of a cell (e.g., to determine open circuit voltage), change in discharge or charge capacity (e.g., in Ah) from a complete discharge over time, total energy delivered since first use, total operating time since first use, time at operating temperature since first use, time at various temperatures above standard operating temperature or at various temperature ranges above standard operating temperature, total number of thermal cycles (e.g., number of times the system is heated up to operating temperature and cooled to a temperature less than the operating temperature (e.g., room temperature)), and/or total number of charge/discharge cycles. In some examples, the BMS can estimate the SOC of a battery by counting Coulombs (i.e., by counting number of electrons) that flow through one or more cells. In other examples, the BMS can estimate the state of charge of a battery by receiving the number of Coulombs that have been provided to the battery by separate charging circuitry (e.g., power electronics such as a bi-directional inverter).

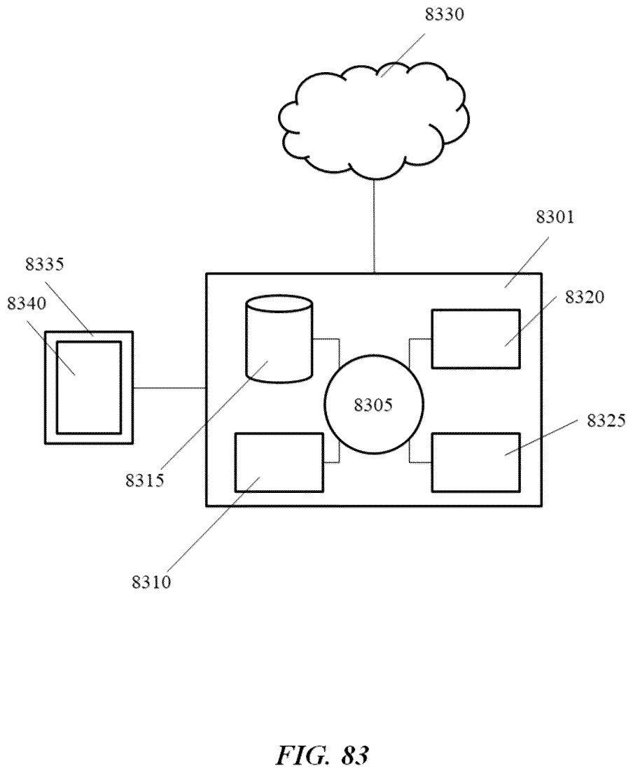

While charging, upon reaching the maximum charge current (e.g., highest allowable charge current) and/or maximum charge voltage (e.g., highest allowable voltage, such as, for example, a pre-defined maximum voltage cut-off limit), the BMS (e.g., the controller) may provide a signal to the power electronics system to slow or stop charging the battery (e.g., to slow or stop a charging rate). While discharging, upon reaching the maximum discharge current (e.g., highest allowable discharge current) and/or minimum discharge voltage (e.g., lowest allowable voltage, such as, for example, a pre-defined minimum voltage cut-off limit), the BMS (e.g., the controller) may provide a signal to the power electronics to stop discharging (e.g., to slow or stop a discharging rate). In some cases, while charging or discharging, the BMS (e.g., the controller) may provide a signal to the power electronics system to slow or stop charging or discharging the battery (e.g., to slow or stop a charging or discharging rate) when a pre-defined temperature limit is exceeded. The BMS may provide such signals directly to the power electronics, to one or more intermediate control electronic systems which in turn may provide such information to the power electronics, or a combination thereof. Further examples of management of operating conditions of the battery include, for example, a BMS controller configured to open relays or contactors in response to a measured current that exceeds a pre-determined value during charging, discharging or idling; or to start, stop or pause operation or alter operating parameters of the battery (or a system comprising the battery) in response to one or more signals received from one or more higher order controller (or other controllers) or from one or more remotely located control stations. A control station may be in communication with the BMS through a communication network such as, for example, a communication network in a computer system comprising the BMS (e.g., system 8300 in FIG. 83).

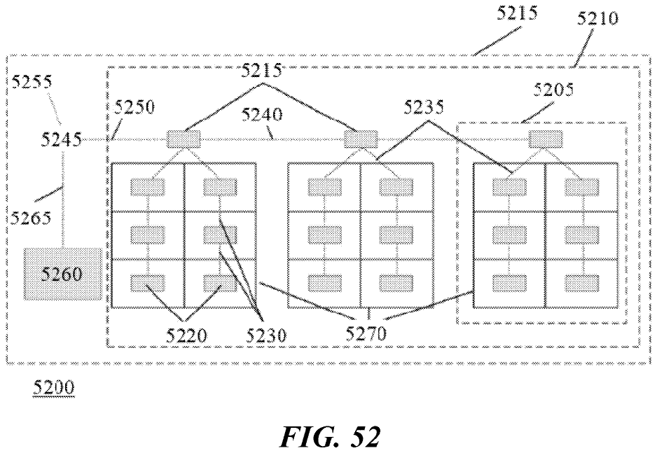

The BMS may report one or more (e.g., all) such measured or calculated data to an external device (e.g., a server or remote computer), using a communication links, such as, for example: serial communications (e.g., a CAN bus, SPI bus, isolated SPI bus or a MODBUS), direct wiring, DC-BUS (e.g., serial communication over power line), and/or wireless communications. In some examples, the (BMS) system reports measured or calculated data to higher order controller(s) through serial, direct wiring, power line and/or wireless communications. In some examples, the BMS comprises a plurality of controllers. The controllers can communicate with one another and/or with other controllers outside a system (e.g., BMS system) boundary (e.g., boundary 5205, 5210 or 5215 in FIG. 52) through CAN bus, MODBUS, SPI or isolated SPI bus using wired or wireless connections.

The BMS may communicate internally by use of a smart battery system. The smart battery system communication may take place via an Inter-Integrated Circuit (I2C) bus, System Management Bus (SMBus) or a Power Management Bus (PMBus). The SMBus can define a set of protocols for inter-device communications. PMBus can be a variant of an SMBus and can provide additional protocols for power management. In some examples, the BMS may communicate internally by use of a smart battery system via the SMBus. In other examples, the BMS may communicate internally by use of a smart battery system via the PMBus. The smart battery system can use a special integrated circuit in the battery to monitor the battery, report information and/or perform power management operations via a smart battery charger (e.g., based on estimated remaining charge on the battery). In some cases, the BMS may use one or more specific integrated circuits (ICs) that provide voltage sensing, current sensing, and/or fuel (e.g., active material) gauging functions. In other cases, the BMS may use one or more specific integrated circuits that provide voltage and/or current isolation across different areas of the circuit or provide isolated communication links (e.g., isolated voltage and/or current communication links) between different parts of the system.

The BMS may protect an energy storage system (e.g., battery) by preventing it from operating outside given operating conditions (e.g., its safe operating conditions), such as, for example: over-current (e.g., can be different in charging and discharging modes), over-voltage (e.g., during charging), under-voltage (e.g., during discharging), over-temperature, under-temperature, and/or over-pressure (e.g., for NiMH or lead-acid batteries). In some examples, the BMS can detect ground fault or leakage current conditions in cells. When a battery is found to be operating outside its safe operating conditions, the BMS can prevent such operation by implementing one or more actions or features. In some examples, the BMS may include an internal switch (e.g., relay or solid state device) that is activated (e.g., opened) if the battery is operated outside its safe operating conditions. In some examples, the BMS may request the devices (e.g., loads) to which the battery is connected to reduce or even terminate using the battery (e.g., power electronics are signaled to stop flow of current through the battery). In other examples, a BMS may actively control the environment, such as, for example, through heaters, fans, lift-gates, valves, air conditioning and/or fluid coolant(s).

The BMS may provide the capability to monitor cell temperatures to ensure that the accessible charge and discharge capacities of the battery do not decrease over time due to the unbalancing of temperatures among cells or batteries. In some examples, the BMS may monitor the temperatures of individual cells. In some examples, the BMS may monitor the temperature of groups of cells (e.g., individual cell modules, cell packs, or some cell packs within a core). In some cases, the BMS can monitor temperature of heat intake and/or heat output (e.g., temperature of dissipated heat) of individual cells, groups of cells or batteries. In some cases, the BMS can monitor temperature of coolant intake and/or coolant output of a group of cells (e.g., a pack, a core, a CE, or a system).

A BMS board may control the cell temperatures using a variety of approaches. When a cell temperature is below the minimum operating temperature, the control system or BMS may increase the charging or discharging rate for the individual cell, and/or turn on a heating source (e.g., resistive heating elements located within the thermal enclosure of a core) for a cell, a cell module, a cell pack, multiple cell packs, portions of a core or a complete core, until its temperature exceeds the minimum operating temperature (e.g., 450 °C). When a cell temperature is above the maximum operating temperature, the control system or BMS may decrease or stop the charging or discharging of the cell or group of cells (e.g., cell pack), turn on a cooling fan, open vents to allow for convective cooling, and/or turn on a liquid coolant for the individual cell, until its temperature drops below the (e.g., pre-set) maximum operating temperature (e.g., 550 °C).

The BMS may also measure and/or control cell voltage (e.g., potential difference between the positive and negative terminals, or components that are electrically connected to the positive and negative terminals, respectively) of parallel strings of cells. The BMS may provide feedback to the power electronics as a means to ensure that the cells do not exceed a given (e.g., pre-defined) cell charge cut-off voltage limit. In some examples, the pre-defined cell charge cut-off voltage limit is about 0.9 V, 1.0 V, 1.1 V, 1.2 V, 1.3 V, 1.4 V, 1.5 V, 1.6 V, 1.7 V, 1.8 V, 1.9 V, or 2.0 V. The BMS may ensure that the cells do not drop below a given (e.g., pre-defined) cell discharge cut-off voltage limit. In some examples, the pre-defined cell discharge cut-off voltage limit is about 0.6 V, 0.5 V, 0.4 V, 0.3 V, 0.2 V, 0.1 V, or 0 V.

The BMS may also provide voltage isolation to prevent cell voltages from interfering with sensitive analog and digital measurements. Voltage isolation may be achieved by using a combination of components that are rated for at least about 60V, 100V, 150V, 300V, 600V, 800V, 1000V, 1500V of DC isolation, by using isolated power sources and electrical grounds in BMS circuits, by isolating communications links through isolation transformers (galvanic and electromagnetic isolation) or opto-couplers (optical isolation), by using dedicated isolated communications transceivers and integrated circuits, by physically spacing high and low voltage components, by using special features and geometries for parts, interconnects and/or traces on circuit boards, or any combination thereof.

In some implementations, the BMS can comprise a pre-charge system. The pre-charge system can allow the battery to be connected to different loads in a safe way, and/or eliminate excessive inrush currents to load capacitors. The connection from battery to loads may normally be controlled through electromagnetic relays (e.g., contactors). In some examples, the pre-charge circuit can include power resistors that are connected in series with the loads until the capacitors are charged. In some examples, a switched mode power supply connected in parallel to loads can be used to charge the voltage of the load circuit up to a level close enough to battery voltage in order to allow closing of the contactors between the battery and the load circuit. The BMS may include a circuit that can check whether a relay is already closed before pre-charging (e.g., due to welding) to prevent inrush currents to occur.

The BMS may actively ensure (e.g., through electrochemical balancing) that at least a portion of the cells (or groups of cells, such as, for example, cell modules) in the battery are at and/or maintained at a similar voltage or state of charge (e.g., in order to maximize the battery's useful capacity, and/or to prevent localized under-charging or over-charging). In some cases, the BMS can balance the cells (or groups of cells, such as, for example, cell modules) by releasing energy and/or charge from the most charged cells by connecting them to a load (e.g., through passive regulators). For example, the system can balance the SOC of individual electrochemical cells or groups of electrochemical cells of a plurality by selectively depleting and dissipating charge from one or more electrochemical cells with excess SOC, thereby equalizing the SOC of the electrochemical cells with excess SOC with the remaining electrochemical cells of the plurality. In some cases, the BMS can balance the cells (or groups of cells, such as, for example, cell modules) by reducing or stopping the charging current to a sufficiently low level such that current may be bypassed around cells that have reached a pre-defined SOC level. For example, the system can balance (e.g., equalize) the SOC of individual electrochemical cells or groups of electrochemical cells of a plurality by bypassing charging current around one or more electrochemical cells that are at full SOC, thereby providing the bypassed charging current to one or more electrochemical cells that are SOC deficient (e.g., allowing them to reach full charge status). In some cases, the BMS can balance the cells (or groups of cells, such as, for example, cell modules) by shuffling energy and/or charge from the most charged cells to the least charged cells (e.g., via balancers). In some cases, the BMS can balance the cells (or groups of cells, such as, for example, cell modules) by selectively charging individual cells or groups of cells (e.g., cell modules) by selectively applying charge to cells that are not at a full SOC. In some cases, the BMS can balance the cells (or groups of cells, such as, for example, cell modules) by selectively charging the least charged cells by connecting the cells to an external power supply (e.g., an external power source that is tied to the electric power grid or an isolated external power source/supply). In some cases, the system can balance (e.g., equalize) the SOC of individual electrochemical cells or groups of electrochemical cells of a plurality by transferring and storing charge from one or more electrochemical cells with excess SOC in a charge reservoir and delivering the charge stored in the reservoir to one or more electrochemical cells that are SOC deficient.

In some cases, the BMS board is outside the thermally enclosed chamber of a group of cells (e.g., the core), and the wires used for balancing pass through the thermal insulation (e.g., of the core) to connect the positive and/or negative terminals of a cell module with the BMS board. In some cases, the BMS system is not designed to disconnect a cell or cell module from its series or parallel connection with other cells or cell modules. Rather, the BMS system may be capable of closing a circuit and providing a path for current to flow around the cell rather than through the cell, or independently discharging or charging one cell or group of cells (e.g., cell module) within an array of series-connected cells or groups of cells (e.g., cell modules).

Balancing by releasing energy from the most charged cells by connecting them to a load may be accomplished by closing a circuit on a BMS board that is connected by wires to the positive and negative terminals of the cell or a group of cells (e.g., cell module) that is highly charged, and allowing current to pass from the negative terminal of the cell or group of cells (e.g., cell module) through a resistor, then back to the positive terminal of the same cell or cell module, thereby reducing the SOC of that cell or group of cells (e.g., cell module or cell pack).

In some implementations, balancing may be achieved by reducing the charging current passed through a cell or a group of cells (e.g., cell module) that is about fully charged. For example, balancing by reducing the charging current passed through a cell or a cell module that is about fully charged may be accomplished by lowering the current applied by the main power supply (e.g., power electronics such as a bi-directional inverter) to the pack and/or system to an acceptably low level (e.g., about 0.1%, about 1%, or about 10% of maximum system current capability), and closing a circuit on a BMS board that allows electrons to flow from the negative terminal of the cell or cell module to the positive terminal of the same cell or cell module. The electron flow that is allowed to flow through this external circuit path can be about equal to the current being applied by the power supply to the series-connected cell packs and/or cell modules. When the electron flow is allowed to pass through this external circuit instead of passing through the cell or the cell module, the cell or the cell module may be considered to be ‘bypassed’ and may remain at about the same state of charge (e.g., about a fully charged state) during this bypass process. This method can allow electrons to continue to flow through and charge other cells or groups of cells (e.g., cell packs) that are not yet fully charged and are not being bypassed, thereby increasing their state of charge while the bypassed cells are held at about the same state of charge (e.g., at about a fully charged state). Once a cell or a group of cells (e.g., cell module) reaches a given (e.g., pre-defined) voltage cut-off limit to signify that it has reached a given SOC (e.g., it is about fully charged), the BMS can close a circuit to allow this cell or cell module to be bypassed. The battery management system may measure the current that is routed through the bypass to further refine SOC estimates for the cells. This process may continue until all cells are bypassed, at which point, they may have about the same SOC (e.g., all about fully charged) and the balancing process is complete. The circuits on the BMS boards that enabled the cell bypassing can be opened and the power supply can stop applying current, or go back into a normal operating mode. The normal operating mode may include first discharging and then charging and/or discharging.

In some examples, the BMS may actively charge cells that are at a lower state of charge until cell(s) (e.g., all cells) have a state of charge within about +0.1%, +1%, +5%, +10%, +20%, or +50% of each other (e.g., within about +0.1% or +1% of other cells in the system). In some examples, the BMS may actively charge a cell such that its state of charge is within a given (e.g., defined) range of cells discharge capacity (e.g., such that the cells demonstrate discharge capacity). In some implementations, the cells discharge capacity can be a parameter that can be used to benchmark cells for balancing or state of charge estimation purposes.

In some implementations, balancing can be accomplished by shuttling energy and/or charge from the most charged cells to the least charged cells. In some cases, the shuttled energy and/or charge may be temporarily stored using a balancing device such as a battery and/or capacitor. In some cases, the BMS system comprises wires that emanate from the positive and negative terminals of a set of series-connected cells or groups of cells (e.g., cell modules) and are collectively connected to a multiplexer (e.g., high current bi-directional multiplexer) circuit, which in turn is connected to the balancing device. The multiplexer circuit may be able to separately connect and disconnect pairs of wires that are connected to the positive and negative terminals of a cell or a group of cells (e.g., cell module) with wires that are connected to the positive and negative terminals of the balancing device. Initially, the multiplexer can connect the balancing device to one group of cells (e.g., cell module) which may discharge until the voltage of the balancing device and the group of cells (e.g., cell module) are about the same. The multiplexer may then connect a different group of cells (e.g., different cell module) with the balancing device. If the voltage of a group of cells (e.g., cell module voltage) is greater than the balancing device voltage, the group of cells (e.g., cell module, or one cell, such as, for example an individual cell in the group of cells) can discharge to the balancing device, decreasing its SOC. If the voltage of a group of cells (e.g., cell module voltage) is less than the balancing device voltage, the balancing device can discharge to the group of cells, thereby increasing the SOC of the group of cells (e.g., cell module, or one cell, such as, for example an individual cell in the group of cells). By sequentially connecting (e.g., all of) the groups of cells within a series-connected string, the BMS system may be able to increase the SOC of the groups of cells that are at a lower-than-average SOC, and the BMS may decrease the SOC of group of cells that are at a higher-than-average SOC, thereby balancing out the SOC of such groups of cells and effectively balancing the system. Similarly, if the system comprises multiple balancing devices and multiplexer systems that each balance a subset of the full series-connected string of groups of cells (e.g., full series-connected string of cell modules), a separate balancing device and multiplexer can be connected to the first set of balancing devices and effectively balance out the SOC of the balancing devices, thereby enabling all of the groups of cells that are series-connected in the battery to be balanced. In some cases, balancing a string of series-connected cells or groups of cells may be more efficient than other approaches to balancing since most of the energy extracted from cells (e.g., at least about 70%, at least about 80%, at least about 90%, at least about 95%, or at least about 99%) is used to charge up other cells and the energy is not intentionally spent/dissipated.

Balancing may be performed between groups of cells or between individual cells in a group of cells. For example, the balancing device can be electrically connected with a group of cells and/or with two or more individual cells. The multiplexer can connect the balancing device to an individual cell (e.g., in a group of cells) which may discharge until the voltage of the balancing device and the group of cells (or, in some cases, another individual cell) are about the same. The multiplexer may then connect a different individual cell (e.g., in the same group of cells) with the balancing device. If the voltage of a cell is greater than the balancing device voltage, the cell can discharge to the balancing device, decreasing its SOC. If the voltage of a cell is less than the balancing device voltage, the balancing device can discharge to the cell, thereby increasing its SOC. By sequentially connecting (e.g., all of) the cells within a group of cells, the BMS system may be able to increase the SOC of the cells that are at a lower-than-average SOC, and decrease the SOC of the cells that are at a higher-than-average SOC, thereby balancing out the SOC of such cells.

In some implementations, balancing cells or cell modules can be accomplished by selectively charging individual cells or groups of cells (e.g., cell modules) by selectively providing charge to cells that are not at a full SOC. In some examples, the system may be charged with the main power supply (e.g., power electronics such as a bi-directional inverter) until one cell or one group of cells (e.g., cell module) reaches a charge cut-off voltage limit. The main power supply may then stop the main flow of current to the cells or groups of cells and the BMS system may begin a balancing procedure. Here, a BMS board may close a circuit and provide current to individual groups of cells while monitoring the cell voltage(s). The current applied to the cell or group of cells may be less (e.g., less than about 50%, 10%, 5%, 1%, or 0.1%) than the maximum current flow provided by the main power supply (e.g., power electronics such as a bi-directional inverter). The BMS board may monitor the voltage of the cell or group of cells and adjust current to ensure that the cell or group of cells does not exceed a given (e.g., pre-defined) charge voltage cut-off limit. Once the cell or group of cells reaches the charge voltage cut-off limit, the BMS board may open a switch and decrease or stop current from flowing to that cell or group of cells. The BMS system may perform this activity on multiple cells or groups of cells simultaneously or sequentially, thereby charging up at least a portion or all of the cells or groups of cells to a full SOC, thus balancing out the system. This process may be considered to be efficient because energy used to balance the cells or groups of cells may later be returned to the grid during the discharging of the battery.

A BMS of the disclosure may be implemented in various topologies. In some examples, the BMS can be configured in a centralized topology: for example, a single controller can be connected to the battery cells through a plurality of wires (e.g., the controller can be connected to each battery cell via an individual wire). In some examples, the BMS can be configured in a distributed topology: for example, a BMS battery controller board can be installed at each cell, module or pack (or other group of cells), with communication cables connecting multiple battery controller boards to each other and/or to a higher order master controller. In some instances, the master controller may then be connected to other higher order controllers. In some instances, the master controller may be connected to other master controllers from different battery strings. In some examples, the BMS can be configured in a modular topology: for example, a few controllers can be provided, each controller handling a certain number of cells, with communication between the controllers. Among these topologies, centralized BMSs may in some cases be most economical, least expandable, and/or plagued by a multitude of wires. Distributed BMSs may in some cases be most expensive, simplest to install, and/or offer cleanest assembly. Modular BMSs may in some cases offer a compromise of the features and problems of the other two topologies.

A BMS system may comprise a subsystem (or be in communication with another system) dedicated for voltage measurement of cells. Such a (sub) system may be non-operational under given conditions (e.g., until cells are within less than about 1 °C, 5 °C, 10 °C, 25 °C, 50 °C, 100 °C or 200 °C of cell operating temperature). The voltage measurement (sub) system may be rendered non-operational by preventing specific controllers, portions of controllers or specific circuit components from being powered (e.g., until cells are not within about 50 °C of cell operating temperature). In some examples, the voltage measurement (sub) system may be powered up and energized, but may be commanded through software not to make any voltage measurements. In other examples, the voltage measurement (sub) system may be powered up and energized, and may proceed to make voltage measurements, but the measurements may be disregarded and not made available for system control functions. For example, the measurements are disregarded when the cell temperature is at least about 50 °C, 55 °C, 60 °C, 65 °C, 70 °C, 80 °C, 90 °C, or 100 °C less than the operating temperature of the battery (e.g., at least about 250 °C). In some situations, the BMS may be programmed to power down and de-energize when the operating temperature is at least about 50 °C, 55 °C, 60 °C, 65 °C, 70 °C, 80 °C, 90 °C, or 100 °C less than the operating temperature of the battery. In yet other examples, such as, for example, upon failure or breach of one or more cells, the voltage measurement sub (system) may remain operational (e.g., remain powered up and continue measuring voltage) as cell conditions change upon the failure/breach (e.g., rapidly decreasing temperature), or may become non-operational (e.g., be powered down as controlled by a system controller) at one or more given conditions (e.g., temperature at least about 50 °C, 55 °C, 60 °C, 65 °C, 70 °C, 80 °C, 90 °C, or 100 °C lower than expected or last recorded cell operating temperature; voltage at least about 5%, 10%, 15%, 25% or 50% below (i) a voltage as last recorded for the cell or (ii) one or more voltage(s) of other cells, such as, for example, other cells in the same group of cells or other cells in communication with the same controller or BMS board; or current at least about 5%, 10%, 15%, 25% or 50% below (i) a current as last recorded for the cell or (ii) one or more current(s) of other cells, such as, for example, other cells in the same group of cells or other cells in communication with the same controller or BMS board).

A BMS system may provide a human machine interface implemented either through visual indicators (e.g., LEDs or LED arrays, LCD displays, touch screens or similar). The interface can enable communication of information to and/or from, and/or interaction with, a user, operator (e.g., system operator), technician, a hardware/software developer, etc (collectively referred to as “users” herein). The interface may allow information to be output to the user. The interface may in some cases allow information to be input by the user. In some cases, the human machine interface comprises a user interface (e.g., a graphical user interface). Additionally, the BMS system may have a dedicated service access port as part of its communications interface to which an operator, user or service technician or a hardware/software developer can connect diagnostic or display devices (e.g., approved diagnostic or display devices). In some cases, access can be given to an operator, user, technician or developer to connect to the controller and monitor it for compliance to design requirements during development. In some cases, access can be given to an operator, user, technician or developer to connect to the controller and monitor the operation of the controller during deployed lifetime. The service access ports can also be used to implement software/firmware upgrades to correct bugs or update system performance (e.g., over time). In some instances, the BMS may comprise dedicated port(s) (e.g., one or more of the service access ports) that allow code updates for part of or all of the system. The BMS (e.g., in distributed topology) may be capable of distributing software updates for at least a portion or all connected systems through a service access port.

The BMS and/or the service access port(s) may restrict access to different levels of the system (e.g., to different layers of functionality) to maintain system security through use of access restrictions, passwords, token-based authentication or other encryption methods. Such authentication-based access can be implemented via the human machine interface (e.g., via input of an access code, personal information, fingerprint, etc.). In some cases, users can access the different layers of functionality based on job function and/or responsibility. For example, an operator may access multiple levels of functionality while a technician may access a limited set of functions.

The BMS or a related control system may track (or monitor) the discharge capacity of the battery and/or the time it takes to electrically balance the cells, and provide signals to operators or automated operating systems that may flag underperforming or failed cells for further monitoring and/or signal the need for replacement of one or more cells or groups of cells (e.g., cell/module/pack/core replacement).

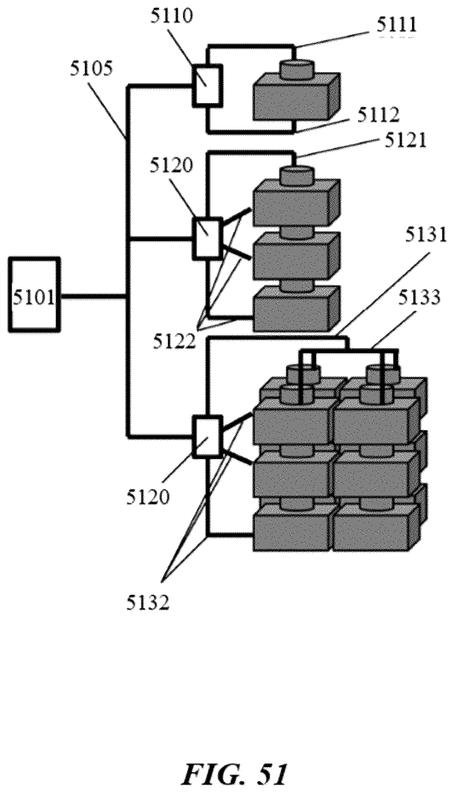

Provided herein are examples of implementations of a BMS. FIG. 51 shows an example of a BMS. The BMS comprises a board 5101 programmed or otherwise configured to control or regulate one or more distributed daughter boards. The BMS can receive (e.g., at the BMS board 5101) input from a server or from a remote computer system via a network. In some situations, the system includes a single BMS board. In other situations, the system includes multiple BMS boards that may or may not be interconnected with one another. The BMS board 5101 can control and receive input from one or more daughter boards, as illustrated in FIG. 51. The BMS can be connected (e.g., via one or more daughter boards) to each terminal point of a cell or cell module (e.g., to the top of every cell and to the bottom on every cell). In an example, 4 connections are provided for 3 cells in series. In another example, 4 connections are provided for 3 series-connected 4-parallel-cell modules. The number of connections may equal the number of cell modules plus 1.

In an example of a distributed topology, a daughter board 5110 (e.g., a cell or module controller) is installed at each cell or cell module (e.g., parallel connection of individual cells). The daughter board 5110 can be directly connected to each cell (or cell module), as indicated by connections 5111 and 5112 (e.g., of negative and positive polarity, respectively, where the connection 5111 can be a negative current lead). Cells within a module may be connected via their cell bodies, so cell modules may only need one connection on the cell body and one on the negative current lead. The daughter boards can compute and control their individual cell or cell module status(es) locally. The daughter board 5110 can monitor and control each cell or cell module individually. During charging or discharging modes, the current may be provided using additional electrical connections to connect to the positive and negative terminals of the individual cell, the series connected string of cells, or the series connected string of cell modules (not shown in FIG. 51).

In an example of a modular topology, one daughter board 5120 (e.g., pack controller) can control a number of cells or cell modules that are stacked together in a pack. The daughter board 5120 can be directly connected to each cell module in a pack, as indicated by connections 5121 and 5122 (e.g., of negative and positive polarity, respectively). The daughter board 5120 can monitor and control voltage, current and/or temperature of cells that are connected to it (e.g., through connections 5122).

In an example of a centralized topology (or a modular topology when part of a larger system), one daughter board 5120 (e.g., pack controller) can control multiple cells in parallel, in series or both in parallel and in series (e.g., a pack or a core). The daughter board 5120 can be directly connected to each cell module in a pack or a core, as indicated by a connection 5131 and individual connections 5132 (e.g., of negative and positive polarity, respectively). In some cases, negative current leads on the top module can be connected via a busbar 5133, and the busbar can be connected to the connection 5131. The daughter board 5120 can monitor and control voltage, current and temperature of cells that are connected to it (e.g., through connections 5132). The BMS board 5101 may be used for balancing packs (e.g., for balancing between a first module of a pack and a second module of a pack), estimating state of charge of a pack, controlling charge and discharge status of a pack and/or communicating status to higher controllers in the system.

In an example of a system configured in a distributed and/or modular architecture, the daughter board connects to series and parallel combinations of cells (e.g., packs). Multiple packs, each with similar configuration of series and parallel cells, may be suitably (e.g., optimally) arranged (e.g., spatially) and daughter boards for each pack may communicate to the BMS board 5101.

In some examples, the daughter boards can monitor one or more parameters (e.g., voltage, current, temperature, state of charge, state of health, etc.) from a cell, a cell module, a pack, a core, or a system, and communicate these parameters back to the BMS board 5101. For example, voltage, current and temperature measurements made by a daughter board can be aggregated and communicated to the BMS board 5101, where state of charge estimates can be computed and decisions made regarding continuation of charge or discharge. The BMS board 5101 (e.g., core controller) can communicate with both daughter boards and higher level controller(s) in the system through I2C bus, MODBUS, CAN bus, SPI bus, isolated SPI bus or similar communication line. The BMS board 5101 can send control commands to the daughter boards. Based on the commands, the daughter boards can perform actions that control one or more cells such as, for example, increasing or decreasing temperatures of cells, balancing the voltages and/or SOC of cells or groups of cells (e.g., cell modules), and so on.

In some implementations, the BMS board may be located some distance away from the cells, enabling the cells to operate at operating temperature (e.g., about 460 °C) and the BMS board to operate near ambient temperature (e.g., from about −50 °C to about +80 °C). The daughter boards, which can be thermally isolated from the cells, can be located closely to each cell or group of cells (e.g., cell pack) so that the daughter board is able to measure and/or track the voltage, current, temperature, state of charge (SOC) and/or state of health (SOH) of an individual cell, a group of cells or a battery. The BMS may have a transition zone or panel that provides thermal isolation between the cells, groups of cells or batteries, and the BMS, and allows wires (e.g., wire(s) that are used to monitor and manage cells) coming out of a hot zone in the immediate vicinity of the cells, groups of cells or battery (e.g., hot zone of the core) to cool and establish a thermal gradient along their length such that the end contacting the BMS is at an acceptably low temperature (e.g., less than about 80 °C).

FIG. 52 in an example of a system 5200 that comprises a BMS and a supervisory control and data acquisition (SCADA) system and associated communication wiring. In some cases, the BMS may have a first boundary (e.g., BMS system boundary) 5205. In some cases, the BMS may have a second boundary 5210. In some cases, the BMS may have a third boundary 5215. In some cases, the system boundary may extend between the system boundaries 5205 and 5210. The BMS may be located within an energy storage system (e.g., comprising one or more cores 5270) and/or separately from the energy storage system. For example, BMS controllers (or boards) may be provided within or attached to cells, modules, packs, cores, systems or batteries. Alternatively, or in addition, stand-alone components may be provided.

The system may comprise one or more pack controllers 5220. The pack controllers may communicate with each other via pack-to-pack communication wires 5230. The pack controllers may communicate with a core controller 5225 via pack-to-core controller communication wires 5235. The system may comprise one or more core controllers 5225. The core controllers may communicate with each other via core-controller-to-core-controller communication wires 5240. One or more of the core controllers (e.g., a master controller) may communicate with a SCADA controller 5245 via a core-controller-to-SCADA system communication wire 5250. The SCADA controller 5245 may be provided with user-controlled input and/or market signal (e.g., electrical power grid) input 5255. In some cases, the SCADA controller may determine or by instructed to determine (e.g., via control software) the operating mode (also “operation mode” herein) of the system 5200 (or any portion thereof) with or without external user-controlled input or market input/signals. The SCADA controller 5245 may communicate with power electronics 5260 via a power electronics-to-SCADA controller communication wire 5265. In some cases, a utility may connect to the power electronics (e.g., a bi-directional inverter). In some examples of DC distribution systems, a bi-directional inverter can not only link a DC-BUS to an AC grid, but can adjust its current commands and operation modes to balance power flow and regulate the DC-BUS voltage. The DC-BUS may provide current/voltage from the energy system to a load (e.g., a power grid or utility).

Current may be measured at one or more locations in the battery and/or the BMS system. In some cases, the BMS (e.g., the pack controller 1020) may not measure current. In some cases, charge/discharge current and/or balancing current may be measured by a device (e.g., ampere-meter) on one or more terminals of a cell or group of cells. Such a measurement may be communicated to one or more BMS boards. In some cases, power electronics can determine the current (e.g., the current in a string of cores).

In some implementations, a method for balancing the voltage of a string of cells using a charge reservoir and/or charge redistribution system is provided. In an example, an electric double-layer capacitor (EDLC) or other high capacity charge reservoir can be connected in parallel with each cell of a multi-cell string one at a time. If the voltage of the cell is higher than the voltage of the charge reservoir, the cell loses charge to the reservoir and the voltage of the cell decreases. On the other hand, if the voltage of the cell is lower than the voltage of the charge reservoir, the reservoir loses charge to the cell and the cell voltage increases. This process is repeated until all cells in the string are at the same voltage.

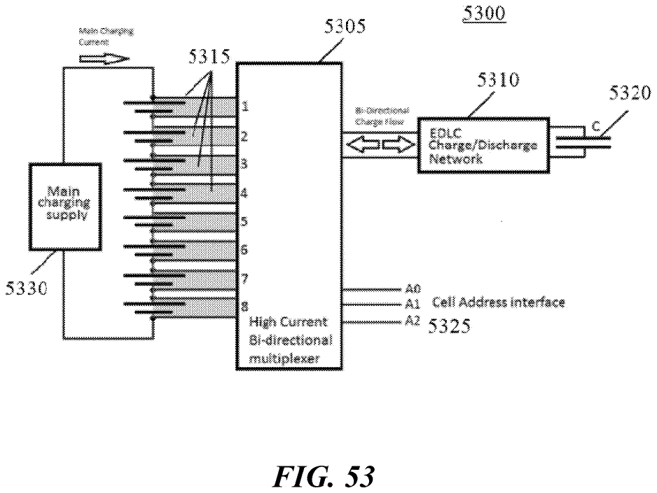

FIG. 53 is an example of a system 5300 for implementing a charge balancing scheme. Each cell 5315 in a series string can be connected by a switch to a charge reservoir 5320. Switching may be performed by a bi-directional multiplexer 5305. The bi-directional multiplexer may utilize a cell address interface 5325. The charge reservoir 5320 may comprise an EDLC. As each switch is closed (one at a time), charge flows from the cell 5315 into the charge reservoir 5320 if cell voltage is higher than reservoir voltage, and the voltage of the cell decreases. If cell voltage is lower than reservoir voltage, charge flows from the charge reservoir into the cell 5315, and the voltage of cell increases. As this process is repeated, voltage of all cells may eventually converge to the same value. No active control loop may be required.

The bi-directional multiplexer 5305 may be implemented using MOSFETs, FETs, transistors, IGBTs, relays, or any other switching technology with low resistance bi-directional path between an EDLC network (e.g., EDLC charge/discharge network) 5310 and the connected cells when ON and high isolation resistance between the EDLC network 5310 and the connected cells when OFF. In some examples, shunt regulators, op-amps and/or Zener diodes can be used to balance cells in a string. Such technologies may in some cases be dissipative and waste charge. The charge balancing configuration in FIG. 53 may redistribute the charge among the cells without intentionally wasting charge (e.g., providing a higher efficiency of energy storage systems). The series string of cells can be connected to a main charging supply 5330. In some situations, the main charging supply provides a main charging current to the cells. The main charging current may or may not be flowing during switching/balancing of the cells.

Capacitors of the disclosure may be used to aid in cell balancing (e.g., of series-connected cells) and may be combined with or modified by other devices, systems and/or methods. Such capacitors may be employed for use in floating capacitor balancing described in Chuang, Y.-C., “Floating Capacitor Active Charge Balancing for PHEV Applications,” Undergraduate Thesis, The Ohio State University (2010), and cell balancing in pack cooling systems described in U.S. Pat. No. 8,643,500 (“APPARATUS AND METHOD FOR DIAGNOSING ABNORMALITY IN CELL BALANCING CIRCUIT”) and U.S. Pat. No. 7,612,537 (“GALVANICALLY ISOLATED CHARGE BALANCE SYSTEM”), each of which is hereby incorporated herein by reference in its entirety.

### Failure Condition Detection

The present disclosure provides methods for detecting a failure condition in an electrochemical energy storage system or device (e.g., a liquid metal battery). A failure condition can be a breach in a seal of an electrochemical cell of the electrochemical energy storage device. In some cases, an electrochemical energy storage system comprises a seal that is the weakest point of an electrochemical cell. In the event of a breach of the seal, the environment near the cell can experience damage. A breach can render the system inoperable or reduce the performance of the system. The methods and devices described herein can permit reliable detection of a breach through electrical and/or chemical signatures, thereby increasing the speed and reliability of breach detection. The methods for reliable breach detection described herein can result in quicker system-wide responses, thereby increasing safety and reliability of deployed systems.

A breach at the top of the cell can occur in an area that is in contact with the portion of the cell that is the headspace above the liquid cell components; thus, the breach may occur in an area of the cell that comprises active materials in a gaseous form (e.g., only in a gaseous form). For example, the active chemistry materials can be primarily or only in gaseous form in the vicinity of the seal (e.g., the breach is not in contact with a molten metal or a molten salt). In some cases, the molten metal and/or the molten salt gases may condense and form a thin layer of liquid on the seal, thus exposing the seal to the liquid state of the cell active components.

Detection systems of the disclosure can include chemical sensor input/measurements, electrical measurements and/or input/measurements from non-chemical sensors (e.g., thermocouples). Such failure detection mechanisms can include analog and digital signals. In some implementations, failure detection may be implemented with the aid of a control system (e.g., system 8300 in FIG. 83). The control system can be a battery management system. The detection systems herein may include one or more inputs and/or measurements. In some cases, the inputs and/or measurements can be at least partially processed and/or implemented at the control system. For example, the detection systems herein can be distributed across the control system (e.g., distributed between a controller/server 8301 and the energy storage system 8335 in FIG. 83).

In some cases, cell chemistry provides an electrical signature in the event of a breach. Some cell chemistries can provide a signal that is indicative of an air leak (e.g., failure of a seal in an external environment) through an increase in a leakage current of the cell, reduction in charge/discharge Coulombic efficiency, shorting of the cell, eventual failure of the cell as an open circuit (i.e., current is unable to pass through the cell), noisy voltage signals (e.g., sporadic fluctuations in cell voltage during constant current charging, discharging or resting over a period of milliseconds, seconds, and/or minutes), a sudden drop in cell voltage, a sudden change in cell internal resistance, reduced discharge capacity (e.g., in Ah), or any combination thereof. The systems and methods described herein can detect such signals (e.g., the higher self-discharge rate) as represented by, for example, more charge required during cell balancing, reduced discharge capacity, increased charge capacity, or a suppressed cell voltage during charging or discharging. Systems and methods described herein can determine (e.g., based on these parameters) that a cell breach has occurred. In some cases, the breached electrochemical cell (and in some cases cells adjacent to the breached cell) are inactivated, discharged and/or cooled down. The breached cell (in some cases including adjacent cells) can be replaced (e.g., by a human operator or robot).

In some implementations, the electrical signature may comprise a charge/discharge Coulombic efficiency value that is decreasing over time and/or is below a baseline Coulombic efficiency value associated with an unbreached cell or an unbreached group of cells. The baseline Coulombic efficiency value may in some cases be associated with an unbreached cell or an unbreached group of cells operated at a similar temperature (e.g., to within less than about 0.1%, 0.5%, 1%, 2%, 5%, 10%, 15%, 20%, 25% or 30%) or at substantially the same temperature (e.g., operating temperature) as the cell monitored for cell breach or as a group of cells comprising the monitored cell (e.g., in configurations where the cell is part of a group of cells). For example, the baseline Coulombic efficiency value may be associated with an unbreached cell or group of cells operated at a similar or substantially the same temperature (e.g., operating temperature) as the cell or group of cells suspected of comprising a breached cell.

In some cases, breach of an electrochemical cell is detected by a chemical signature. For example, the system can include a detection system for hydrochloric acid (HCl), hydrobromic acid (HBr), hydrofluoric acid (HF), hydroiodic acid (HI), chlorine gas (Cl₂), bromine gas (Br₂), fluorine gas (F₂), iodine gas (I₂), and/or stibine gas (H₃Sb). The detection system can include one or more sensors, such as vapor sensors that are sensitive to such gases. In some cases, the detection system can include other sensor(s) capable of detecting the gases described herein and/or other substances associated with (e.g., intermediate products of) materials inside the cell and/or in a cell seal.

In some implementations, a chemical signature may give rise to an electrical signature. For example, a chemical sensor can produce an electronic signal upon detecting a given condition (e.g., normal condition, breach condition, etc.). In some cases, a baseline (e.g., normal or constant) signal is measured and/or monitored. For example, an analog signal from a chemical sensor may be converted to a digital signal that is monitored by a control system (e.g., system 8300 in FIG. 83). In such situations, a deviation from the baseline signal (e.g., rate of change, increase with respect to the baseline, etc.) may trigger a breach condition. In some cases, only a given signal level may trigger a breach condition. For example, a given absolute or relative value (or range of values) of a concentration of a chemical component (e.g., HCl, Cl₂) may trigger a breach condition. The breach condition may produce an electronic signal that is communicated to a control system (e.g., system 8300 in FIG. 83). Other sensor(s), such as, for example, temperature sensors, may be used. For example, a temperature sensor may comprise a thermocouple. An analog signal from the thermocouple may be converted to a digital signal that is monitored (e.g., by a control system, such as system 8300 in FIG. 83). In some instances, a given decrease in the measured temperature may indicate a breach condition.

Baseline signals, signal changes and/or given absolute or relative values of sensor signals may be used to produce an audible alarm, an automated response with or without the aid of a control system (e.g., a mechanical switch), and/or may be communicated to the control system. The control system may receive analog and/or digital signal(s) from the sensor(s). The control system may analyze the signal(s). The signal(s) and/or their processing/analysis may trigger a response from the control system. For example, the control system may disconnect a load. In some cases, analog signals can be converted to digital signals (e.g., at a digital acquisition (DAQ) board of the control system). The electronic signal may be recorded and/or processed at the control system. The control system may react in response to the electronic signal.

The disclosure provides methods for detecting a breach of an electrochemical cell. The method comprises providing an electrochemical cell having a negative electrode, an electrolyte and a positive electrode, where at least one, two or all of the negative electrode, the electrolyte and the positive electrode is/are in a liquid state at an operating temperature of the electrochemical cell. The electrochemical cell can have a seal that isolates the negative electrode, the electrolyte and the positive electrode from an environment external to the electrochemical cell (e.g., air). In some cases, the operating temperature of the electrochemical cell is at least about 250 °C. The method can include monitoring the electrochemical cell for an electrical signature that is indicative of a breach of the seal and exposure of at least one of the positive electrode, the electrolyte, and the negative electrode to the environment. In response to the electrical signature, the electrochemical cell can be inactivated, cooled and/or discharged.

In some implementations, the disclosure provides an energy storage system that comprises an electrochemical cell having a negative electrode, an electrolyte and a positive electrode, where at least one of the negative electrode, the electrolyte and the positive electrode is in a liquid state at an operating temperature of the electrochemical cell. A seal can isolate the negative electrode, the electrolyte and the positive electrode from an environment external to the electrochemical cell. The operating temperature of the electrochemical cell can be at least about 250 °C. The energy storage system can have a controller that monitors the electrochemical cell for an electrical signature that is indicative of a failure (e.g., breach) of the seal and/or exposure of at least one of the positive electrode, the electrolyte, and the negative electrode to the environment, and in response to the electrical signature, inactivates the electrochemical cell, flags/provides notice to system operator(s) that a cell needs to be replaced, cools the electrochemical cell, and/or discharges the electrochemical cell. In some cases, the electrochemical cell is first discharged, then cooled (e.g., to ambient temperature or to a temperature at which the molten electrodes solidify). In some instances, the electrochemical cell is simultaneously inactivated and cooled. Upon inactivating the electrochemical cell, the temperature of the electrochemical cell can decrease from the operating temperature.

In some cases, an electrical signature (e.g., the electrical signature that is indicative of a failure, such as, for example, a breach of the seal) indicates that a cell or a group of cells (e.g., pack, core) may need to be replaced. This information may be communicated to a user or system operator (e.g., notification can be provided to a user or system operator of a system comprising an energy storage system (e.g., an energy storage device such as a battery, or a plurality of electrochemical cells) and a battery management system, or a user or system operator of the battery management system). In some cases, the notification may include a prompt to schedule a procedure to cool the electrochemical cell, to cool at least a portion of the plurality of electrochemical cells (or the energy storage system), and/or to replace a group of electrochemical cells among the plurality of electrochemical cells (or in the energy storage system). In some cases, the notification may include information that a replacement may be needed but may not include a prompt; in such cases, the user or system operator may decide whether to schedule such a procedure. In some examples, a procedure can be scheduled at a future time point to cool the system (e.g., the energy storage system) or to cool at least a portion of the plurality of electrochemical cells. In some cases, the procedure includes replacing a group of cells.

In some cases, the electrochemical cell is one of a plurality of electrochemical cells connected in parallel and/or in series and the plurality of electrochemical cells are inactivated, cooled and/or discharged in response to an electrical signature (e.g., an electrical signature that is indicative of a breach). The electrochemical cell can be part of a battery and the electrochemical cell can be replaced in the battery by another electrochemical cell that is not breached. In some cases, a group of electrochemical cells are replaced in the battery by another group (e.g., replacement group) of electrochemical cells that are not breached. The group of electrochemical cells can be, for example, a module, pack, core, CE or system. In some cases, the plurality or group of electrochemical cells are connected in series and parallel.

In some cases, the electrical signature comprises a leakage current that is increased relative to a baseline leakage current associated with an unbreached cell. The increased leakage current can be determined, for example, based on an increased time required to charge and/or balance a group of cells (e.g., a cell module) with the breached cell. In some cases, a breached cell cannot be charged.

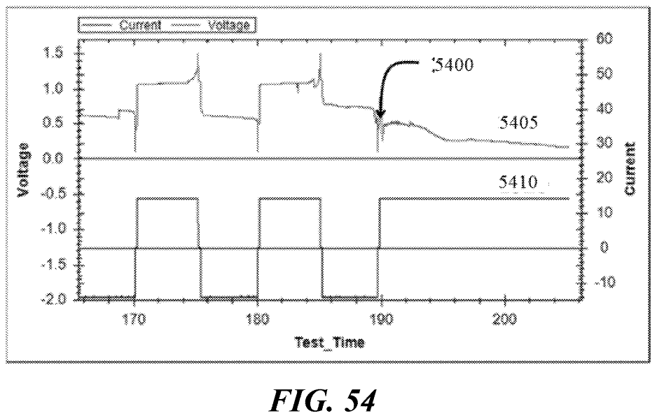

FIG. 54 shows an example of an electrochemical cell that is breached as indicated 5400. In this example, the cell fails to charge after the breach. The cell voltage decreases 5405 while the cell is being charged at a constant current 5410. This decrease in cell voltage under constant current can indicate increased leakage current and/or a short (e.g., increasing conductance or decreasing resistance).

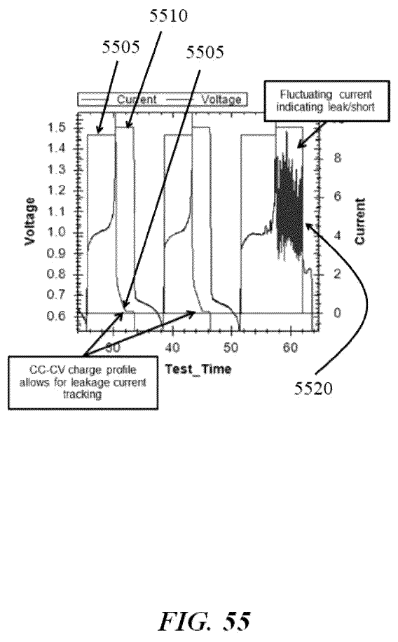

FIG. 55 shows an example of a cell that is operated with a constant current (CC) charge 5505 followed by a constant voltage (CV) float 5510. During a constant voltage float, the current normally decays down to very low levels 5515 (e.g., less than about 100 mA). Following a seal breach, the current can be much higher and fluctuate greatly 5520.

In some cases, the electrical signature comprises a self-discharge rate of the electrochemical cell that is increased relative to a baseline self-discharge rate associated with an unbreached cell. In some instances, the electrical signature comprises a voltage during charging or discharging of the electrochemical cell that is decreased relative to a baseline charge/discharge voltage associated with an unbreached cell. The electrical signature can be further indicative of shorting of the negative electrode with the positive electrode.

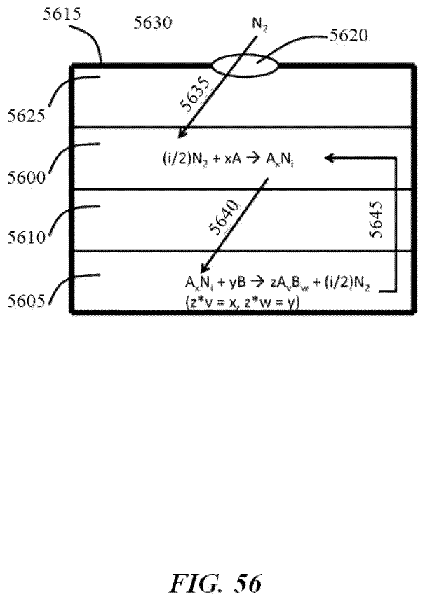

The electrical signature can be created upon breach by any suitable mechanism. An example of the mechanism is schematically illustrated for an electrochemical cell comprising a metal anode ‘A’ (e.g., Na, Li, K, Mg, Ca) and a metal cathode ‘B’ (e.g., Pb, Bi, Sn, Sb, Zn) active materials in FIG. 56. Here, an electrochemical cell has an anode 5600, a cathode 5605 and an electrolyte 5610 contained in a housing 5615 having a seal 5620. The anode 5600 can be a negative electrode during discharge and the cathode 5605 can be a positive electrode during discharge. The seal isolates the headspace 5625 in the cell from an atmosphere 5630. Upon breach of the seal, components of the atmosphere 5630 (e.g., oxygen, nitrogen, water vapor, etc.) can enter the cell. For example, upon breach of the seal, nitrogen (N₂) from the atmosphere enters the headspace of the electrochemical cell through a breach in the seal and contacts the anode (5635). The nitrogen can react with ‘A’ to produce a nitride compound ‘AₓNᵢ’ (e.g., Na₃N, Li₃N, K₃N, Mg₃N₂, Ca₃N₂), which can diffuse through the electrolyte to contact the cathode (5640). In an example, A can be lithium and the nitride compound Li₃N can be formed via the reaction ½ N₂+3Li→Li₃N. At the cathode, the nitride compound can react with the cathode metal to produce compounds having anode and cathode components (e.g., compounds having the formula AₓB_{y} where x and y are variables, or compounds having the formula AᵥB_{w}, where v and w are variables and where x/y=v/w, such as, for example, Na₃Pb, Li₃Sb₂, K₃Pb, Mg₃Sb₂, Ca₃Sb₂) and nitrogen gas (N₂). In the example where A is lithium, the anode and cathode materials can form LiSb via the reaction Li₃N+3Sb→3LiSb+½ N₂. In another example, lithium antimonide (Li₃Sb) may be formed. In some cases, ‘i’ can equal ‘y’. The nitrogen gas can bubble back up to and/or diffuse back to the anode (5645). The introduction of water vapor (e.g., steam, moist air) into the cell can result in the oxidation of the anode metal and the release of hydrogen gas (e.g., 2Li+H₂O→Li₂O+H₂). The presence of hydrogen gas can result in a chemical short process similar to the one that is generated by the presence of nitrogen gas as described herein.

### Interconnections

Wired or wire-less (e.g., direct metal-to-metal) interconnections may be formed between individual electrochemical cells and/or between groups of electrochemical cells (e.g., modules, packs, cores, CEs, systems, or any other group comprising one or more electrochemical cells). In some cases, groups of cells may be joined via one or more cell-to-cell interconnections. In some cases, groups of cells may be joined via a group-level interconnection. The group-level interconnection may further comprise one or more interconnections with one or more individual cells of the group. The interconnections may be structural and/or electrical. Cells and/or groups of cells may be assembled (or stacked) horizontally or vertically. Such assembled cells and/or groups of cells may be arranged in series or parallel configurations. Further, groups of cells may be supported by various frames. The frames may provide structural support and/or participate or aid in forming the interconnections (e.g., frames on groups of cells may mate or be connected). Groups of cells utilized for assembly purposes may or may not be the same as groups of cells utilized for regulation/control purposes.

In some implementations, electrochemical cells or groups thereof are connected using interconnects. In some instances, an interconnect is a wire. In some implementations, direct connection of cells to each other (e.g., by brazing) can be used to connect cells or groups of cells, in some cases reducing or eliminating the use of wires to connect electrochemical cells. For example, a positive current collector of a first electrochemical cell can be direct metal-to-metal joined (e.g., brazed or welded) to a negative current collector of a second electrochemical cell. In some instances, the negative current collector comprises a negative current lead or conductor. In some instances, the first and second electrochemical cells are not connected by wires. In another example, the conductor can protrude through an electrically conductive housing of the first cell through an aperture in the electrically conductive housing and can be electrically isolated from the electrically conductive housing with a seal. A plurality of electrochemical cells can be stacked in series with the conductor of the first cell in electrical contact with the electrically conductive housing of a second cell. A plurality of non-gaseous spacers can be disposed between the electrochemical cells. In some cases, the electrically conductive housings are part of a current conducting pathway (e.g., as in a parallel connection of cells). In some implementations, one or more busbars and/or interconnects can be used to create a connection between any two groups of cells.

A battery can comprise electrochemical cells connected in series and in parallel. The number of electrochemical cell modules (or parallel-connected modules) that are connected in series can be any suitable number, such as, for example, at least 3, at least 5, at least 6, at least 10, at least 12, at least 15, at least 16, at least 20, at least 32, at least 48, at least 54, at least 64, at least 108, at least 128, at least 216, or at least 256. In an example, the number of electrochemical cell modules (or parallel-connected modules) that are connected in series is 3 (e.g., for a battery comprising a pack), 6 (e.g., for a battery comprising a pack), or 216 (e.g., for a battery comprising a core).

The battery can include a common single point connector. The single point connector can be used to electrically connect to an electrochemical cell or to a group of electrochemical cells (e.g., modules, packs, cores, CEs, or systems). Multiple wires (e.g., ends of the wires) can be connected to the common single point connector (i.e., several wires can be connected to a common connector, which can connect to other portions of the battery at a single point). The battery can include a plurality of wires having a first end and a second end. The first end can be connected to at least one of the electrochemical cells (e.g., directly or indirectly). In some cases, the first end can be connected to a common single point connector, and the common single point connector can be connected to at least one of the electrochemical cells (e.g., to a busbar that is in electrical communication with at least one of the electrochemical cells, to a cell body, to a feature in a cell body such as a tab protruding from the cell body, etc.). The second end can be connected, for example, to control circuitry (e.g., directly or indirectly) or to another common single point connector. In some cases, the second end can be connected to a common single point connector, and the common single point connector can be connected to control circuitry. For example, the single point connector on the second end (or the second end itself) can be connected to control circuitry located outside the thermally insulated zone containing cell packs, such as, for example, to a battery management system (e.g., to a battery management system board). In some cases, the first ends of a set of wires can be connected to a single point connector, the second ends of a subset of the wires can be connected to another single point connector, and the remaining wire or wires (e.g., the remaining second ends of the wires) can be separately connected to another part of the battery (e.g., voltage sense line input port of a battery management system).

In some cases, the single point connector forms an electrical connection with another plurality (group) of electrochemical cells (e.g., to connect together modules, packs, cores, CEs, or systems). For example, the first end of the wire can be connected (e.g., via a single point connector such as an adapter plate) to a busbar (e.g., a negative busbar) that is in electrical communication with at least one of the electrochemical cells in a group of electrochemical cells (e.g., in a pack).

An adapter plate can create a single point connection for multiple wires to a busbar in a module, pack, core, or CE. The wires can be welded or brazed to the back of the adapter plate to facilitate single point separation of a large quantity of wires connecting to a busbar. In order to effectively balance and monitor cells within a cell module, multiple wire connections may need to be created. The connection point can be a potential point of failure and can add to the cost and complexity of assembly. In some implementations, a terminal that has the wires connected to it can be pre-fabricated. The plate can be bolted, welded or brazed wherever the connection is required. Wires connected in this manner can remain static through many uses and disconnections, thus reducing wire wear-tear and embrittlement effects. Thus, single point connectors can in some cases enable more facile module interchanges.

Any number of wires can be connected to a common single point connector. In some examples, 1, 2, 3, 4, 5, 6, 7, 8, 9, 10, 11, 12, 13, 14, 15, 16, 17, 18, 19, 20, 22, 24, 26, 28, 30, 35, or 40 wires are connected to the single point connector. In some cases, at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 22, at least 24, at least 26, at least 28, at least 30, at least 35, or at least 40 wires are connected to the single point connector.

The single point connector can be made of any conductive metal, such as, for example, nickel, stainless steel, copper-aluminum alloy, or of any other conductive material described herein. In some implementations, the single point connector can comprise a bent metal piece. The first ends of the wires can be passed through holes in the bent metal piece and/or welded to the bent metal piece. The wires can be any wire, including, but not limited to, American Wire Gauge (AWG) 18 wires or AWG 10 wires. In some cases, one or more wires may be used to sense voltage and therefore may be able to be thin (e.g., less than about 2 mm in diameter, or AWG 18). In some cases, one or more wires may be thicker (e.g., greater than about 2 mm in diameter, or AWG 18 gauge) and may be used to carry current to and from the cell or cell module (e.g., as required for cell balancing). The sensing line(s) (e.g., voltage sense line(s)) may be provided separately from the current flow line(s) (also “current carrying line(s)” or “high current line(s)” herein. In some cases, first ends of the current carrying wires and the voltage sense wire may be connected to a single point connector that is connected to the cells or a busbar, while the other (second) ends of the wires are separately connected to the battery management system (e.g., the voltage sense wire is connected to a voltage input port on the battery management system and the current wires are connected to a single point connector which is connected to a current input/output port on the battery management system). This arrangement may enable voltage drop across the current flow lines to be separated from the operational characteristics sensed by the sensing lines. As previously described, the sensing and current flow paths may be in electronic communication with the battery management system.

A group of cells (e.g., a core, a CE, a system, etc.) with a given energy capacity and power capacity (e.g., a CE or a system capable of storing a given amount of energy) may be configured to deliver at least about 10%, at least about 20%, at least about 30%, at least about 40%, at least about 50%, at least about 60%, at least about 70%, at least about 80%, at least about 90%, at least about 95%, or about 100% of a given (e.g., rated) power level. For example, a 1000 kW system may be capable of also operating at 500 kW, but a 500 kW system may not be able to operate at 1000 kW. In some cases, a system with a given energy capacity and power capacity (e.g., a CE or a system capable of storing a given amount of energy) may be configured to deliver less than about 100%, less than about 110%, less than about 125%, less than about 150%, less than about 175%, or less than about 200% of a given (e.g., rated) power level, and the like. For example, the system may be configured to provide more than its rated power capacity for a period of time that is less than the time it would take to consume its energy capacity at the power level that is being provided (e.g., provide power that is greater than the rated power of the system for a period of time corresponding to less than about 1%, less than about 10% or less than about 50% of its rated energy capacity).

### Electrochemical Cells, Devices and Systems

The present disclosure provides electrochemical energy storage devices (e.g., batteries) and systems. An electrochemical energy storage device generally includes at least one electrochemical cell, also “cell” and “battery cell” herein, sealed (e.g., hermetically sealed) within a housing. A cell can be configured to deliver electrical energy (e.g., electrons under potential) to a load, such as, for example, an electronic device, another energy storage device or a power grid.

An electrochemical cell of the disclosure can include a negative electrode, an electrolyte adjacent to the negative electrode, and a positive electrode adjacent to the electrolyte. The negative electrode can be separated from the positive electrode by the electrolyte. The negative electrode can be an anode during discharge. The positive electrode can be a cathode during discharge.

In some examples, an electrochemical cell is a liquid metal battery cell. In some examples, a liquid metal battery cell can include a liquid electrolyte arranged between a negative liquid (e.g., molten) metal electrode and a positive liquid (e.g., molten) metal, metalloid and/or non-metal electrode. In some cases, a liquid metal battery cell has a molten alkaline earth metal (e.g., magnesium, calcium) or alkali metal (e.g., lithium, sodium, potassium) negative electrode, an electrolyte, and a molten metal positive electrode. The molten metal positive electrode can include, for example, one or more of tin, lead, bismuth, antimony, tellurium and selenium. For example, the positive electrode can include Pb or a Pb—Sb alloy. The positive electrode can also include one or more transition metals or d-block elements (e.g., Zn, Cd, Hg) alone or in combination with other metals, metalloids or non-metals, such as, for example, a Zn—Sn alloy or Cd—Sn alloy. Any description of a metal or molten metal positive electrode, or a positive electrode, herein may refer to an electrode including one or more of a metal, a metalloid and a non-metal. The positive electrode may contain one or more of the listed examples of materials. In an example, the molten metal positive electrode can include lead and antimony. In some examples, the molten metal positive electrode may include an alkali or alkaline earth metal alloyed in the positive electrode.

In some examples, an electrochemical energy storage device includes a liquid metal negative electrode, a liquid metal positive electrode, and a liquid salt electrolyte separating the liquid metal negative electrode and the liquid metal positive electrode. The negative electrode can include an alkali or alkaline earth metal, such as lithium, sodium, potassium, rubidium, cesium, magnesium, barium, calcium, sodium, or combinations thereof. The positive electrode can include elements selected from transition metals or d-block elements (e.g., Group 12), Group IIIA, IVA, VA and VIA of the periodic table of the elements, such as zinc, cadmium, mercury, aluminum, gallium, indium, silicon, germanium, tin, lead, pnicogens (e.g., arsenic, bismuth and antimony), chalcogens (e.g., tellurium and selenium), or combinations thereof. In some examples, the positive electrode comprises a Group 12 element of the periodic table of the elements, such as one or more of zinc (Zn), cadmium (Cd) and mercury (Hg). In some cases, the positive electrode may form a eutectic or off-eutectic mixture (e.g., enabling lower operating temperature of the cell in some cases). In some examples, the positive electrode comprises a first positive electrode species and a second positive electrode species at a ratio (mol %) of about 20:80, 40:60 or 80:20 of the first positive electrode species to the second electrode species. In some examples, the positive electrode comprises Sb and Pb at a ratio (mol %) of about 20:80, 40:60 or 80:20 Sb to Pb. In some examples, the positive electrode comprises between about 20 mol % and 80 mol % of a first positive electrode species mixed with a second positive electrode species. In some cases, the positive electrode comprises between about 20 mol % and 80 mol % Sb (e.g., mixed with Pb). In some cases, the positive electrode comprises between about 20 mol % and 80 mol % Pb (e.g., mixed with Sb).

The electrolyte can include a salt (e.g., molten salt), such as an alkali or alkaline earth metal salt. The alkali or alkaline earth metal salt can be a halide, such as a fluoride, chloride, bromide, or iodide of the active alkali or alkaline earth metal, or combinations thereof. In an example, the electrolyte (e.g., in Type 1 or Type 2 chemistries) includes lithium chloride. In some examples, the electrolyte can comprise sodium fluoride (NaF), sodium chloride (NaCl), sodium bromide (NaBr), sodium iodide (Nal), lithium fluoride (LiF), lithium chloride (LiCl), lithium bromide LiBr, lithium iodide (LiI), potassium fluoride (KF), potassium chloride (KCl), potassium bromide (KBr), potassium iodide (KI), calcium fluoride (CaF₂), calcium chloride (CaCl₂)), calcium bromide (CaBr₂), calcium iodide (Cal₂), or any combination thereof. As an alternative, the salt of the active alkali metal can be, for example, a non-chloride halide, bistriflimide, fluorosulfano-amine, perchlorate, hexaflourophosphate, tetrafluoroborate, carbonate, hydroxide, nitrate, nitrite, sulfate, sulfite, or combinations thereof. In some cases, the electrolyte can comprise a mixture of salts. The electrolyte may exhibit low (e.g., minimal) electronic conductance (e.g., electronic shorting may occur through the electrolyte via valence reactions of PbCl₂↔PbCl₃ which increases electronic conductance). For example, the electrolyte can have an electronic transference number (i.e., percentage of electrical (electronic and ionic) charge that is due to the transfer of electrons) of less than or equal to about 0.03% or 0.3%.

In some cases, the negative electrode and the positive electrode of an electrochemical energy storage device are in the liquid state at an operating temperature of the energy storage device. To maintain the electrodes in the liquid states, the battery cell may be heated to any suitable temperature. In some examples, the battery cell is heated to and/or maintained at a temperature of about 100 °C, about 150 °C, about 200 °C, about 250 °C, about 300 °C, about 350 °C, about 400 °C, about 450 °C, about 500 °C, about 550 °C, about 600 °C, about 650 °C, or about 700 °C. The battery cell may be heated to and/or maintained at a temperature of at least about 100 °C, at least about 150 °C, at least about 200 °C, at least about 250 °C, at least about 300 °C, at least about 350 °C, at least about 400 °C, at least about 450 °C, at least about 500 °C, at least about 550 °C, at least about 600 °C, at least about 650 °C, or at least about 700 °C. In some situations, the battery cell is heated to between about 200 °C and about 600 °C, or between about 450 °C and about 575 °C. In some implementations, the electrochemical cell or energy storage device may be at least partially or fully self-heated. For example, a battery may be sufficiently insulated, charged, discharged and/or conditioned at sufficient rates, and/or cycled a sufficient percentage of the time to allow the system to generate sufficient heat through inefficiencies of the cycling operation that cells are maintained at a given operating temperature (e.g., a cell operating temperature above the freezing point of at least one of the liquid components) without the need for additional energy to be supplied to the system to maintain the operating temperature.

Electrochemical cells of the disclosure may be adapted to cycle between charged (or energy storage) modes and discharged modes. In some examples, an electrochemical cell can be fully charged, partially charged or partially discharged, or fully discharged.

In some implementations, during a charging mode of an electrochemical energy storage device, electrical current received from an external power source (e.g., a generator or an electrical grid) may cause metal atoms in the metal positive electrode to release one or more electrons, dissolving into the electrolyte as a positively charged ion (i.e., cation). Simultaneously, cations of the same species can migrate through the electrolyte and may accept electrons at the negative electrode, causing the cations to transition to a neutral metal species, thereby adding to the mass of the negative electrode. The removal of the active metal species from the positive electrode and the addition of the active metal to the negative electrode stores electrochemical energy. In some cases, the removal of a metal from the positive electrode and the addition of its cation to the electrolyte can store electrochemical energy. In some cases, electrochemical energy can be stored through a combination of removal of the active metal species from the positive electrode and its addition to the negative electrode, and the removal of one or more metals (e.g., different metals) from the positive electrode and their addition to the electrolyte (e.g., as cations). During an energy discharge mode, an electrical load is coupled to the electrodes and the previously added metal species in the negative electrode can be released from the metal negative electrode, pass through the electrolyte as ions, and deposit as a neutral species in the positive electrode (and in some cases alloy with the positive electrode material), with the flow of ions accompanied by the external and matching flow of electrons through the external circuit/load. In some cases, one or more cations of positive electrode material previously released into the electrolyte can deposit as neutral species in the positive electrode (and in some cases alloy with the positive electrode material), with the flow of ions accompanied by the external and matching flow of electrons through the external circuit/load. This electrochemically facilitated metal alloying reaction discharges the previously stored electrochemical energy to the electrical load.

In a charged state, the negative electrode can include negative electrode material and the positive electrode can include positive electrode material. During discharging (e.g., when the battery is coupled to a load), the negative electrode material yields one or more electrons, and cations of the negative electrode material. In some implementations, the cations migrate through the electrolyte to the positive electrode material and react with the positive electrode material (e.g., to form an alloy). In some implementations, ions of the positive metal species (e.g., cations of the positive electrode material) accept electrons at the positive electrode and deposit as a metal on the positive electrode. During charging, in some implementations, the alloy at the positive electrode disassociates to yield cations of the negative electrode material, which migrate through the electrolyte to the negative electrode. In some implementations, one or more metal species at the positive electrode disassociates to yield cations of the negative electrode material in the electrolyte. In some examples, ions can migrate through an electrolyte from an anode to a cathode, or vice versa. In some cases, ions can migrate through an electrolyte in a push-pop fashion in which an entering ion of one type ejects an ion of the same type from the electrolyte. For example, during discharge, an alkali metal anode and an alkali metal chloride electrolyte can contribute an alkali metal cation to a cathode by a process in which an alkali metal cation formed at the anode interacts with the electrolyte to eject an alkali metal cation from the electrolyte into the cathode. The alkali metal cation formed at the anode in such a case may not necessarily migrate through the electrolyte to the cathode. The cation can be formed at an interface between the anode and the electrolyte, and accepted at an interface of the cathode and the electrolyte.

Electrochemical cells of the disclosure can include housings that may be suited for various uses and operations. A housing can include one cell or a plurality of cells. A housing can be configured to electrically couple the electrodes to a switch, which can be connected to the external power source and the electrical load. The cell housing may include, for example, an electrically conductive container that is electrically coupled to a first pole of the switch and/or another cell housing, and an electrically conductive container lid that is electrically coupled to a second pole of the switch and/or another cell housing. The cell can be arranged within a cavity of the container. A first one of the electrodes of the cell can contact and be electrically coupled with an endwall of the container. An electrically insulating seal (e.g., bonded ceramic ring) may electrically isolate negative potential portions of the cell from positive portions of the container (e.g., electrically insulate the negative current lead from the positive current lead). In an example, the negative current lead and the container lid (e.g., cell cap) can be electrically isolated from each other, where a dielectric sealant material can be placed between the negative current lead and the cell cap. As an alternative, a housing includes an electrically insulating sheath (e.g., alumina sheath) or corrosion resistant and electrically conductive sheath or crucible (e.g., graphite sheath or crucible). In some cases, a housing and/or container may be a battery housing and/or container.

A battery, as used herein, can comprise a plurality of electrochemical cells. Individual cells can be electrically coupled to one another in series and/or in parallel. In series connectivity, the positive terminal of a first cell is connected to a negative terminal of a second cell. In parallel connectivity, the positive terminal of a first cell can be connected to a positive terminal of a second, and/or additional, cell(s). Similarly, cell modules, packs, cores, CEs and systems can be connected in series and/or in parallel in the same manner as described for cells.

Cells, cell modules, packs, cores, CEs and/or systems can be connected in series and/or in parallel. Described throughout the disclosure are various configurations in which cells or groups of cells can be interconnected. Given the modular nature of the assembly process, interconnection configurations described herein in relation to individual cells or a given group of cells may equally apply to other groups of cells at least in some configurations.

Electrochemical cells of the disclosure may be capable of storing and/or receiving input of (“taking in”) substantially large amounts of energy. In some instances, a cell is capable of storing and/or taking in and/or discharging about 1 watt-hour (Wh), about 5 Wh, 25 Wh, about 50 Wh, about 100 Wh, about 250 Wh, about 500 Wh, about 1 kilo-Watt-hour (kWh), about 1.5 kWh, or about 2 kWh. In some instances, the battery is capable of storing and/or taking in at least about 1 Wh, at least about 5 Wh, at least about 25 Wh, at least about 50 Wh, at least about 100 Wh, at least about 250 Wh, at least about 500 Wh, at least about 1 kWh, at least about 1.5 kWh, at least about 2 kWh, at least about 3 kWh, at least about 5 kWh, at least about 10 kWh, at least about 15 kWh, at least about 20 kWh, at least about 30 kWh, at least about 40 kWh, or at least about 50 kWh. It is recognized that the amount of energy stored in an electrochemical cell and/or battery may be less than the amount of energy taken into the electrochemical cell and/or battery (e.g., due to inefficiencies and losses).

A cell can be capable of providing a current at a current density of at least about 10 milliamperes per square centimeter (mA/cm²), 20 mA/cm², 30 mA/cm², 40 mA/cm², 50 mA/cm², 60 mA/cm², 70 mA/cm², 80 mA/cm², 90 mA/cm², 100 mA/cm², 200 mA/cm², 300 mA/cm², 400 mA/cm², 500 mA/cm², 600 mA/cm², 700 mA/cm², 800 mA/cm², 900 mA/cm², 1 A/cm², 2 A/cm², 3 A/cm², 4 A/cm², 5 A/cm², or 10 A/cm², where the current density is determined based on the effective cross-sectional area of the electrolyte and where the cross-sectional area is the area that is orthogonal to the net flow direction of ions through the electrolyte during charge or discharging processes. In some instances, a cell can be capable of operating at a direct current (DC) efficiency of at least about 10%, 20%, 30%, 35%, 40%, 45%, 50%, 55%, 60%, 65%, 70%, 75%, 80%, 90%, 95% and the like. In some instances, a cell can be capable of operating at a charge efficiency (e.g., Coulombic charge efficiency) of at least about 10%, 20%, 30%, 40%, 50%, 60%, 70%, 80%, 85%, 90%, 95%, 98%, 99%, 99.5%, 99.9%, 99.95%, and the like.

An electrochemical cell of the present disclosure can have a response time of any suitable value (e.g., suitable for responding to disturbances in the power grid). In some instances, the response time is about 100 milliseconds (ms), about 50 ms, about 10 ms, about 1 ms, and the like. In some cases, the response time is at most about 100 milliseconds (ms), at most about 50 ms, at most about 10 ms, at most about 1 ms, and the like.

A compilation or array of cells (e.g., battery) can include any suitable number of cells, such as at least about 2, at least about 5, at least about 10, at least about 50, at least about 100, at least about 500, at least about 1000, at least about 5000, at least about 10000, and the like. In some examples, a battery includes 1, 2, 3, 4, 5, 6, 7, 8, 9, 10, 15, 20, 30, 40, 50, 60, 70, 80, 90, 100, 200, 300, 400, 500, 600, 700, 800, 900, 1000, 2000, 5000, 10,000, 20,000, 50,000, 100,000, 500,000, or 1,000,000 cells.

Batteries of the disclosure may be capable of storing and/or taking in a substantially large amount of energy for use with a power grid (i.e., a grid-scale battery) or other loads or uses. In some instances, a battery is capable of storing and/or taking in and/or discharging about 5 kilo-Watt-hour (kWh), about 25 kWh, about 50 kWh, about 100 kWh, about 500 kWh, about 1 mega-Watt-hour (MWh), about 1.5 MWh, about 2 MWh, about 3 MWh, about 5 MWh, about 10 MWh, about 25 MWh, about 50 MWh, or about 100 MWh. In some instances, the battery is capable of storing and/or taking in at least about 1 kWh, at least about 5 kWh, at least about 25 kWh, at least about 50 kWh, at least about 100 kWh, at least about 500 kWh, at least about 1 MWh, at least about 1.5 MWh, at least about 2 MWh, at least about 3 MWh, at least about 4 MWh, at least about 5 MWh, at least about 10 MWh, at least about 25 MWh, at least about 50 MWh, or at least about 100 MWh.

In some instances, the cells and cell housings are stackable. Any suitable number of cells can be stacked. Cells can be stacked side-by-side, on top of each other, or both. In some instances, at least about 3, 6, 10, 50, 100, or 500 cells are stacked. In some cases, a stack of 10⁰ cells is capable of storing and/or taking in at least 50 kWh of energy. A first stack of cells (e.g., 10 cells) can be electrically connected to a second stack of cells (e.g., another 10 cells) to increase the number of cells in electrical communication (e.g., 20 in this instance). In some instances, the energy storage device comprises a stack of 1 to 10, 11 to 50, 51 to 100, or more electrochemical cells.

An electrochemical energy storage device can include one or more individual electrochemical cells. An electrochemical cell can be housed in a container, which can include a container lid (e.g., cell cap) and seal component. The device can include at least 1, 2, 3, 4, 5, 6, 7, 8, 9, 10, 20, 30, 40, 50, 100, 200, 300, 400, 500, 1000, 10,000, 100,000 or 1,000,000 cells. The container lid may utilize, for example, a seal (e.g., annular dielectric gasket) to electrically isolate the container from the container lid. Such a component may be constructed from an electrically insulating material, such as, for example, glass, oxide ceramics, nitride ceramics, chalcogenides, or a combination thereof (e.g., ceramic, silicon oxide, aluminum oxide, nitrides comprising boron nitride, aluminum nitride, zirconium nitride, titanium nitride, carbides comprising silicon carbide, titanium carbide, or other oxides comprising of lithium oxide, calcium oxide, barium oxide, yttrium oxide, silicon oxide, aluminum oxide, or lithium nitride, or any combinations thereof). The seal may be made hermetic by one or more methods. For example, the seal may be subject to relatively high compressive forces (e.g., greater than about 1,000 psi or greater than about 10,000 psi) between the container lid and the container in order to provide a seal in addition to electrical isolation. Alternatively, the seal may be bonded through a weld, a braze, or other chemically adhesive material that joins relevant cell components to the insulating sealant material.

A cell housing can comprise an electrically conductive container and a conductor in electrical communication with a current collector. The conductor protrudes through the container through an aperture in the container and is electrically isolated from the container. The ratio of the area of the aperture to the area of the container may be less than about 0.3, 0.2, 0.15, 0.1, 0.05, 0.01, 0.005, or 0.001. The housing can be capable of enclosing a cell that is capable of storing and/or taking in less than 100 Wh of energy, about 100 Wh of energy, or more than 100 Wh of energy. The cell can be capable of storing and/or taking in at least about 1 Wh, 5 Wh, 25 Wh, 50 Wh, 100 Wh, 500 Wh, 1 kWh, 1.5 kWh, 2 kWh, 3 kWh, 5 kWh, 10 kWh, 15 kWh, 20 kWh, 30 kWh, 40 kWh, or 50 kWh of energy.

### Type 1 and Type 2 Modes of Operation

Liquid metal batteries can provide a distinguished opportunity to achieve a long lifespan system that is relatively simple to assemble. A cell of a liquid metal battery of the present disclosure may be operated in a manner that utilizes symmetric or substantially symmetric electrode reactions in the form of an alloying/de-alloying electrochemical reaction (referred to herein as “low voltage operation” mode, or “Type 1” mode). In some cases, in Type 1 mode, a cell is operated at a voltage from about 0.4 Volt (V) to about 1.5 V. Here, one active metal species may be present in the negative electrode and as an alloyed species in the positive electrode, and may be the only metal species that dissolves in or is extracted from the electrolyte during cell discharging and charging, respectively. The composition of the electrolyte therefore may not substantially change during the low voltage operation mode. Such mode of operation may provide a relatively low cell voltage, resulting in a relatively low energy density.

A second mode in which liquid metal battery cells of the present disclosure can operate involves a non-symmetric or substantially non-symmetric reaction where one metal species is electrochemically active at one electrode and a second metal species is electrochemically active at the other electrode, resulting in a net change in the composition of the electrolyte at different states of charge. This mode of operation (referred to herein as “high voltage operation” mode, “Type 2” mode, or cells using “displacement salt electrode” operation or mechanism) can initiate new chemical reactions compared to the Type 1 mode of operation (e.g., in addition to or instead of alloying reaction at the positive electrode), in some cases resulting in, or otherwise utilizing, a relatively higher cell voltage (e.g., 1.5 V to 2.5 V, 1 V to 3 V, or 1 V to 4 V). Type 2 mode of operation can offer the possibility of using a wider variety of active materials, and combinations of such materials, as the electrochemistry of the cell.

In some examples, a Type 1 cell includes a negative electrode comprising an alkali or alkaline earth metal (e.g., lithium, sodium, potassium, magnesium, calcium), and a positive electrode comprising a poor metal, or alloys of such metals (e.g., one or more of tin, lead, bismuth, antimony, tellurium and selenium). The negative electrode and positive electrode can be in a liquid (or molten) state at an operating temperature of the cell. The negative and positive electrodes can be separated by a salt electrolyte (e.g., alkali or alkaline earth metal halide salts).

In a charged state, a Type 1 cell, when operated under Type 2 mode, can have a voltage of at least about 0.5 V, 1 V, 1.5 V, 2 V, 2.5 V, or 3 V in a charged state. In some cases, a Type 1 cell, when operated under Type 2 mode, can have an open circuit voltage (OCV) of at least about 0.5 V, 1 V, 1.5 V, 2 V, 2.5 V, or 3 V. In an example, a Type 1 cell, when operated under Type 2 mode, has an open circuit voltage greater than about 1 V, greater than about 2 V, or greater than about 3 V. In some cases, a charge cutoff voltage (CCV) of a Type 1 cell, when operated in Type 2 mode, is from about 1 V to 3 V, 1.5 V to 2.5 V, 1.5 V to 3 V, or 2 V to 3 V in a charged state. In some cases, a charge cutoff voltage (CCV) of a Type 1 cell, when operated in Type 2 mode, is at least about 1.0 V, 1.1 V, 1.2 V, 1.3 V, 1.4 V, 1.5 V, 1.6 V, 1.7V, 1.8 V, 1.9 V, 2.0 V, 2.1 V, 2.2V, 2.3 V, 2.4V, 2.5V, 2.6V, 2.7V, 2.8 V, 2.9 V or 3.0 V. In an example, a Type 1 cell, when operated under Type 2 mode, has a charge cutoff voltage of at least about 1.7 V after at least about 100 charge/discharge cycles. In some cases, a voltage of a Type 1 cell, when operated in Type 2 mode, is from about 1 V to 3 V, 1.5 V to 2.5 V, 1.5 V to 3 V, or 2 V to 3 V in a charged state. A Type 1 cell can provide such voltage(s) (e.g., voltage, OCV and/or CCV) upon operating at up to and exceeding about 10 cycles, 20 cycles, 30 cycles, 40 cycles, 50 cycles, 100 cycles, 200 cycles, 300 cycles, 400 cycles, 500 cycles, 600 cycles, 700 cycles, 800 cycles, 900 cycles, 1000 cycles, 2000 cycles, 3000 cycles, 4000 cycles, 5000 cycles, 10,000 cycles, or 20,000 cycles (also “charge/discharge cycles” herein). In some cases, the limiting factor on the number of cycles may be dependent on, for example, the housing and/or the seal as opposed to the chemistry of the negative electrode, electrolyte and/or the positive electrode. The limit in cycles may be dictated not by the electrochemistry, but by the degradation of non-active components of the cell, such as the container. During operation at an operating temperature of the Type 1 cell, the Type 1 cell can have a negative electrode, electrolyte and positive electrode in a liquid (or molten) state.

A Type 1 cell of the present disclosure, when operated in Type 2 mode, can have an energy storage capacity of at least about 1 Wh, 5 Wh, 25 Wh, 50 Wh, 100 Wh, 500 Wh, 1 kWh, 1.5 kWh, 2 kWh, 3 kWh, 5 kWh, 10 kWh, 15 kWh, 20 kWh, 30 kWh, 40 kWh, or 50 kWh, and a current density of at least about 10 mA/cm², 20 mA/cm², 30 mA/cm², 40 mA/cm², 50 mA/cm², 60 mA/cm², 70 mA/cm², 80 mA/cm², 90 mA/cm², 100 mA/cm², 200 mA/cm², 300 mA/cm², 400 mA/cm², 500 mA/cm², 600 mA/cm², 700 mA/cm², 800 mA/cm², 900 mA/cm², 1 A/cm², 2 A/cm², 3 A/cm², 4 A/cm², 5 A/cm², or 10 A/cm².

In a charged state, a Type 1 cell, when operated under Type 1 mode, can have a voltage of at least about 0.5 V, 0.6 V, 0.7 V, 0.8 V, 0.9 V, 1 V, 1.2 V, or 1.5 V in a charged state. In some cases, a Type 1 cell, when operated under Type 1 mode, can have an open circuit voltage (OCV) of at least about 0.5 V, 0.6 V, 0.7 V, 0.8 V, 0.9 V, 1 V, 1.2 V, or 1.5 V. In an example, a Type 1 cell, when operated under Type 1 mode, has an open circuit voltage greater than about 0.5 V. In some cases, a charge cutoff voltage (CCV) of a Type 1 cell, when operated in Type 1 mode, is from about 0.5 V to 1.5 V in a charged state. In some cases, a charge cutoff voltage (CCV) of a Type 1 cell, when operated in Type 1 mode, is at least about 0.5 V, 0.6 V, 0.7 V, 0.8 V, 0.9V, 1.0V, 1.1V, 1.2V, 1.3V, 1.4V, or 1.5 V. In an example, a Type 1 cell, when operated under Type 1 mode, has a charge cutoff voltage of at least about 1.0 V after at least about 300 charge/discharge cycles. In some cases, a voltage of a Type 1 cell, when operated in Type 1 mode, is from about 0.5 V to 1.5 V in a charged state. A Type 1 cell can provide such voltage(s) (e.g., voltage, OCV and/or CCV) upon operating at up to and exceeding about 10 cycles, 20 cycles, 30 cycles, 40 cycles, 50 cycles, 100 cycles, 200 cycles, 300 cycles, 400 cycles, 500 cycles, 600 cycles, 700 cycles, 800 cycles, 900 cycles, 1000 cycles, 2000 cycles, 3000 cycles, 4000 cycles, 5000 cycles, 10,000 cycles, or 20,000 cycles. In some cases, the limiting factor on the number of cycles may be dependent on, for example, the housing and/or the seal as opposed to the chemistry of the negative electrode, electrolyte and/or the positive electrode. The limit in cycles may be dictated not by the electrochemistry, but by the degradation of non-active components of the cell, such as the container. During operation at an operating temperature of the Type 1 cell, the Type 1 cell can have a negative electrode, electrolyte and positive electrode in a liquid (or molten) state.

A Type 1 cell of the present disclosure, when operated in Type 1 mode, can have an energy storage capacity of at least about 1 Wh, 5 Wh, 25 Wh, 50 Wh, 100 Wh, 500 Wh, 1 kWh, 1.5 kWh, 2 kWh, 3 kWh, 5 kWh, 10 kWh, 15 kWh, 20 kWh, 30 kWh, 40 kWh, or 50 kWh, and a current density of at least about 10 mA/cm², 20 mA/cm², 30 mA/cm², 40 mA/cm², 50 mA/cm², 60 mA/cm², 70 mA/cm², 80 mA/cm², 90 mA/cm², 100 mA/cm², 200 mA/cm², 300 mA/cm², 400 mA/cm², 500 mA/cm², 600 mA/cm², 700 mA/cm², 800 mA/cm², 900 mA/cm², 1 A/cm², 2 A/cm², 3 A/cm², 4 A/cm², 5 A/cm², or 10 A/cm².

The present disclosure provides cell design criteria that may address failure mechanisms, enabling the cells to achieve a long lifespan and optimum performance. Type 2 cell operation can advantageously provide opportunities for new cell chemistries that are lower cost, less hazardous and/or nontoxic, and that use more earth abundant materials.

The present disclosure provides various non-limiting approaches for operating cells under the Type 2 mode. In a first approach, a cell with positive and negative electrode materials that are ordinarily configured for use in a Type 1 mode is operated in a Type 2 mode of operation. In a second approach, a cell comprises materials that are configured for use in Type 2 mode of operation.

Under the first approach, a cell configured for use in a Type 1 mode is operated in Type 2 mode (e.g., voltage from 1.5 V to 2.5 V or higher), for example by charging the cell to a higher voltage and/or having less negative electrode material in the cell. Any operationally requisite negative electrode material can be supplied by the electrolyte during cell charging. In an example, the Type 1 cell may be Li∥Pb or Li|Sb—Pb or Li|Zn—Sn or Li|Bi with a lithium-ion containing electrolyte (e.g., LiF, LiCl, LiBr or a combination thereof). The cell is deficient in Li in the negative electrode, but during cell charging Li is supplied from the electrolyte to the negative electrode. In some examples, the Type 1 cell has an operating temperature of at least about 200 °C, at least about 250 °C, at least about 300 °C, at least about 400 °C, at least about 450 °C, at least about 500 °C, or at least about 550 °C, in some cases between about 500 °C and 550 °C. In a charged state, all or substantially all of the components of the Type 1 cell are in a liquid state.

Under Type 1 mode, the Type 1 cell can be charged to a voltage from about 0.5 V to 1.5 V to attain a charged or substantially charged state, and subsequently discharged to attain a discharged or substantially discharged state. However, under Type 2 mode, the Type 1 cell can be charged to a voltage from about 1.5 V to 2 V or higher (e.g., 1.5 V to 4 V). The quantity of lithium in the negative electrode in such a case can be in stoichiometric balance with the quantity of Sb and/or Pb in the positive electrode. As an alternative, the Type 1 cell can have a negative electrode with a stoichiometric deficiency of a negative electrode material (e.g., Li). Under Type 2 mode (e.g., at a CCV from about 1.5 V to 2.5 V or higher), during charging, one or more components of the positive electrode (e.g., Pb or Sb) can be removed from the positive electrode and dissolved into the electrolyte as a cation (e.g., Pb⁺² or Sb³⁺). Concurrently, one or more components of the negative electrode (e.g., Li) can be removed from the electrolyte, in its ionic form (e.g., Li⁺), and deposited into the negative electrode in metallic form. A cell thus formed can have a higher chemical potential relative to a cell operating under the Type 1 mode.

A Type 1 cell can have any cell and seal configuration disclosed herein. For instance, the active cell materials can be held within a sealed steel/stainless steel container with a high temperature seal on the cell lid. A negative current lead can pass through the cell lid (and be sealed to the cell lid by the dielectric high temperature seal), and connect with a porous negative current collector (e.g., metal foam) suspended in an electrolyte. In some cases, the cell can use a graphite sheath, coating, crucible, surface treatment or lining (or any combination thereof) on the inner wall of the cell crucible. In other cases, the cell may not use a graphite sheath, coating, crucible, surface treatment or lining on an inner wall of the cell crucible.

In an example, a Li∥Pb cell with a lithium halide (e.g., LiF, LiCl, LiBr or a combination thereof) electrolyte that is configured for use as a Type 1 cell can operate in Type 2 mode through the following example reactions: during charging, Lit ions from the electrolyte accept an electron from the top/negative current collector (e.g., foam current collector) and deposit as liquid Li metal, wetting into the foam/porous structure. Concurrently, Pb atoms shed electrons and subsequently dissolve into the electrolyte as Pb²⁺. The Pb²⁺ ions and respective halide salt (e.g., PbCl₂) can be more dense than the remainder of the lithium halide electrolyte. Hence, Pb²⁺ ion species may be driven by gravitation to remain concentrated towards the positive electrode. The Pb²⁺ ions may be concentrated at the bottom of the electrolyte layer. Since Li metal is deposited onto the foam from the electrolyte, the system may not require any Li metal during the time of assembly, but rather, can be assembled in a discharged state having only a Li salt electrolyte and a Pb or Pb alloy (e.g., Pb—Sb) positive electrode. In some examples, upon charge, the Li∥Pb is charged until a voltage of at least about 1.5 V, 2 V, 2.5 V, or 3 V or higher is obtained. The voltage in some cases can be from about 1 V to 2 V, 1 V to 2.5 V, 1 V to 3 V, 1.5 V to 2.5 V, 1.5 V to 3 V, 2 V to 3 V, 1.5 V to 2.0 V, or 1.5 V to 2.5 V in a charged state.

During operation of a cell under Type 1 mode or Type 2 mode, material of the positive electrode may dissolve in the electrolyte and in some cases migrate to the negative electrode, where it may deposit into the negative electrode or alloy with the material of the negative electrode. In some situations, this may degrade the operation of the cell through, for example, decreasing the operating voltage of the cell. In addition to, or as an alternative, a material of the negative electrode (e.g., Li) may react with a material of the positive electrode (e.g., Pb) in the electrolyte, which may form a particle cloud that may decrease cell performance and in some cases cause a shorting path between the negative and positive electrodes. The present disclosure provides various approaches for minimizing the possibility of (i) material of the positive electrode from depositing into the negative electrode or alloying with the material of the negative electrode, and (ii) material of the negative electrode from reacting with the material of the positive electrode in the electrolyte. These include, without limitation, selecting positive electrode components to have requisite free energies of formation (AGf) with a halide salt, selecting a thickness of the electrolyte as a function of relative density (compared to the electrolyte density) and diffusion kinetics of dissolved positive electrode species in the electrolyte, limiting a size or volume of the negative electrode, allowing the cell to periodically rest in a discharged state while held at a voltage below the Type 2 mode open circuit voltage (OCV), operating a cell at lower charge capacity, and operating the cell in both Type 1 and Type 2 modes of operation. Some or all of these approaches may aid in improving cell performance and minimizing the occurrence of cell failure of Type 1 cells during Type 2 mode of operation, or Type 2 cells during Type 2 mode of operation.

In some situations, the positive electrode can include a plurality of components or materials (e.g., Pb and Sb). One of the components (or materials) can have a less negative ΔGᵣ with halide salts in the electrolyte than the other component(s). For example, if the positive electrode comprises Pb and Sb, Sb has a more negative ΔGᵣ with halide salts in the electrolyte than Pb. The presence of an alloying metal can lower the activity of Pb in the positive electrode. In such circumstances, during charging, any droplets comprising a material of the positive electrode (e.g., Pb) that form in the electrolyte may have a higher activity than the material in the positive electrode, which, in some cases, may provide a driving force that, over time, dissolves the droplets in the electrolyte and deposits the droplets in the positive electrode. Such configuration may be practical for both Type 2 cells and Type 1 cells operated in Type 2 mode. Thus, alloying a positive electrode material (e.g., Sb) with a less electronegative positive electrode material (e.g., metal or metalloid such as Pb) can be used to decrease or prevent build-up of small particles of either positive electrode material (e.g., Sb or Pb) from accumulating in the electrolyte. Such accumulation of particles or phases may in some cases lead to electronic shorting between the electrodes through the electrolyte.

The thickness of the electrolyte may be selected to improve cell performance and operating lifetime. In some cases, the thickness of the electrolyte layer can be selected to minimize, if not substantially prevent, material of the positive electrode from diffusing into the negative electrode during cell operation, such as cell charging. The thickness of the electrolyte may be selected to decrease the rate at which material of the positive electrode diffuses into the negative electrode during cell operation, such as cell charging and/or discharging, and can be a function of diffusion kinetics and relative density of the positive electrode ion species dissolved into the electrolyte.

In some examples, the electrolyte can have a thickness (measured as the distance between negative electrode/electrolyte and positive electrode/electrolyte interfaces) of at least about 0.01 cm, 0.05 cm, 0.1 cm, 0.5 cm, 0.8 cm, 1.0 cm, 1.3 cm, 1.5 cm, 2 cm, 3 cm, 4 cm, 5 cm, 6 cm, 7 cm, 8 cm, 9 cm, 10 cm for a cell having a thickness of at least about 1 cm, 2 cm, 3 cm, 4 cm, 5 cm, 6 cm, 7 cm, 8 cm, 9 cm, 10 cm or more. In some examples, a cell has a thickness of at most about 3 cm or 4 cm, and an electrolyte with a thickness of at most about 1 cm or 2 cm.

As an alternative, or in addition to, the size (e.g., volume) of the negative electrode can be selected such that, upon cell charging, the negative current collector (e.g., metallic foam, or a tungsten current collector or lead) becomes nearly, substantially, or completely full of the negative electrode material (e.g., Li or Na) such that if there is any additional material from the electrolyte or positive electrode (e.g., Zn), it may overflow and not react with, or deposit into, the negative electrode. In an example, a cell comprises a negative electrode comprising Li or Na and a positive electrode comprising Zn. Since Zn is heavier (or more dense) than Li or Na, a Zn—Na or Zn—Li alloy may drip or flow off the bottom of the negative electrode (i.e., along the direction of the gravitational acceleration vector) and recombine with the positive electrode. This can aid in naturally cleansing the negative electrode of any Zn, such as, for example, in cases in which the Zn alloy is relatively anti-wetting/immiscible with the negative electrode material.

In an example, in a Type 2 cell chemistry, the negative electrode and the positive electrode materials may form an immiscible mixture (e.g., of Na-rich and Zn-rich composition). The immiscible mixture may promote the positive electrode material rich mixture to drip off the negative electrode and rejoin the positive electrode, thereby recovering cross-contaminated cathode material.

In some cases, a cell can be periodically permitted to rest in a discharged state under voltage that is below the open circuit voltage (OCV) in Type 2 mode. This approach can provide an opportunity for any droplets, comprising positive electrode material, that may have formed in the electrolyte or negative current collector to settle down to the positive electrode and recombine with the positive electrode material. In an example, a cell comprises a negative electrode comprising Li or Na and a positive electrode comprising Pb. During charging under Type 2 mode, Pb droplets form in the electrolyte. Subsequent to discharging, the cell is permitted to rest for a given time period at an applied voltage. In such a case, Pb droplets that have formed in the electrolyte settle down (i.e., along the gravitational acceleration vector) to the positive electrode, where they can recombine with the positive electrode.

In some cases, a cell can be operated at a lower charge capacity with respect to a maximum charge capacity of the cell, which can limit the quantity of positive electrode material that may dissolve in the electrolyte. In some examples, a cell can be operated at a charge capacity that is about 95%, 90%, 80%, 70%, 60%, 50%, 40%, 30%, 10%, 5% of the maximum charge capacity

In some cases, a cell can be operated in both a high voltage (Type 2) operating mode and the low voltage (Type 1) operating mode. This may provide a driving force for the material of the positive electrode (e.g., Pb²⁺) to redeposit onto the positive electrode during the Type 1 mode, which can help minimize, if not prevent, the material of the positive electrode form depositing in the electrolyte or the negative electrode.

A cell can be cycled between Type 1 and Type 2 modes of operation. A cell can be initially charged (or discharged) under Type 1 mode to a given voltage (e.g., 0.5 V to 1 V), and subsequently charged (then discharged) under Type 2 mode to a higher voltage (e.g., 1.5 V to 2.5 V, or 1.5 V to 3 V).

During cell operation, material (e.g., Fe) from a wall of the cell can react under the higher voltage potential (e.g., Type 2 mode), and ionize as a soluble species in the electrolyte. Hence, the wall material can dissolve into the electrolyte and subsequently interfere with the cell's electrochemistry. For example, the dissolved material can deposit on the negative electrode, which, in some cases, can grow as dendrites and stretch across the electrolyte to one or more walls of the cell, or toward the positive electrode, which can result in a short failure. The present disclosure provides various approaches for suppressing or otherwise helping minimize the dissolution of solid (passive) cell material such as Fe and its potentially negative effects on cell performance by, for example, formation of dendrites and cell shorting. In some cases, a cell can be designed such that increased spacing between the negative electrode and a wall of the cell suppresses or otherwise helps minimize the ability of dendrites from forming and shorting the wall to the inner wall. A cell can include an electrically insulating, and chemically stable sheath or coating between one or more walls of the cell and the negative electrode, electrolyte and/or positive electrode to minimize or prevent shorting to the one or more walls of the cell. In some cases, the cell can be formed of a non-ferrous container or container lining, such as a carbon-containing material (e.g., graphite), or a carbide (e.g., SiC, TiC), or a nitride (e.g., TiN, BN), or a chemically stable metal (e.g., Ti, Ni, B). The container or container lining material may be electrically conductive. Such non-limiting approaches can be used separately or in combination, for suppressing or otherwise helping minimize chemical interactions with Fe or other cell wall materials, and any subsequent negative effects on cell performance.

Although electrochemical cells of the present disclosure have been described, in some examples, as operating in a Type 1 mode or Type 2 mode, other modes of operation are possible. Type 1 mode and Type 2 mode are provided as examples and are not intended to limit the various modes of operation of electrochemical cells disclosed herein.

### Type 2 Chemistries

Another aspect of the present disclosure provides Type 2 cell chemistries. In some cases, cells operated under Type 2 mode can operate at a voltage between electrodes that can exceed those of cells operated under Type 1 mode. In some cases, Type 2 cell chemistries can operate at a voltage between electrodes that can exceed those of Type 1 cell chemistries operated under Type 1 mode. Type 2 cells can be operated in Type 2 mode. During operation at an operating temperature of the Type 2 cell, the Type 2 cell can have a negative electrode, electrolyte and positive electrode in a liquid (or molten) state. A cell can include components that are solid or semi-solid, such as a solid intermetallic layer between the electrolyte and the positive electrode. Products of the electrochemical cycle may include the formation of alloyed species that may be liquid, semi-liquid, or solid, and may be soluble and/or immiscible with the electrode materials and/or the electrolyte salt. In some cases, the intermetallic layer is observed under Type 1 mode of operation but not Type 2 mode of operation. For example, the intermetallic layer (e.g., the intermetallic layer in FIG. 4) may not form during operation of a Type 2 cell.

A Type 2 cell operating in Type 2 mode can have components (e.g., negative electrode, electrolyte, positive electrode) that are fully liquid. A Type 2 cell operating in Type 2 mode can have solid or semi-solid components, such as an intermetallic.

A cell with a Type 2 chemistry can include a molten alkali or alkaline earth metal (e.g., lithium, magnesium, sodium) negative electrode and an electrolyte adjacent to the negative electrode. The electrolyte can include a halide salt (e.g., LiF, LiCl, LiBr, MgCl₂, Nal). The electrolyte can comprise a mixture of salts (e.g., 25:55:20 mol % LiF:LiCl:LiBr, 50:37:14 mol % LiCl:LiF:LiBr, etc.). The cell with a Type 2 chemistry can include a molten metal positive electrode comprising one or more transition metals. In some cases, the positive electrode comprises zinc (Zn), cadmium (Cd) and mercury (Hg) or combination thereof, or such material(s) in combination with other metals, metalloids or non-metals, such as, for example, a Zn—Sn alloy, Zn—Sn alloy, Cd—Sn alloy, Zn—Pb alloy, Zn—Sb alloy, or Bi. In an example, the positive electrode can comprise 15:85, 50:50, 75:25 or 85:15 mol % Zn:Sn.

In some examples, the electrolyte may comprise two or more phases. In some cases, formation of an additional phase (e.g., a solid phase or a second liquid phase) may suppress species cross-over (e.g., Zn²⁺ containing salt crossing over from near the positive electrode to the negative electrode). Phase separation may result in formation of inter-salt compounds (e.g. compounds formed from of ZnCl₂ and LiCl, etc.). In one example, operating temperature can be reduced to suppress Zn²⁺ solubility in a Li-halide salt phase in contact with the negative electrode (e.g., phase formed due to stratification of two electrolyte phases). Solubility of Zn metal in Li-halide salts may be negligible in some cases. In another example, a solid Zn-halide salt can be formed adjacent to (e.g., in the vicinity of or in contact with) the positive electrode. In yet another example, viscosity of the electrolyte salt can be increased to suppress thermally driven convection of given species (e.g., salt comprising Zn-halide) toward the negative electrode (e.g., vertically upward to the negative electrode). The electrolyte may comprise salts of the positive electrode species. Such salts may be formed as the positive electrode species dissolves into the electrolyte (e.g., during charging). In some cases, such salts (e.g., ZnCl₂) may suppress a melting point of the electrolyte.

In some cases, a Type 2 cell can operate at a voltage of at least about 0.5 V, 1 V, 1.5 V, 2 V, 2.5 V, or 3 V in a charged state. In some cases, a Type 2 cell can have an open circuit voltage (OCV) of at least about 0.5 V, 1 V, 1.5 V, 2 V, 2.5 V, or 3 V. In an example, a Type 2 cell has an open circuit voltage greater than about 1 V, greater than about 2 V, or greater than about 3 V. In some cases, a charge cutoff voltage of a Type 2 cell is from about 1 V to 3 V, 1.5 V to 2.5 V, 1.5 V to 3 V, or 2 V to 3 V in a charged state. In some cases, a charge cutoff voltage (CCV) of a Type 2 cell is at least about 1.0 V, 1.1 V, 1.2 V, 1.3 V, 1.4 V, 1.5 V, 1.6 V, 1.7 V, 1.8 V, 1.9 V, 2.0 V, 2.1 V, 2.2 V, 2.3 V, 2.4 V, 2.5 V, 2.6 V, 2.7 V, 2.8 V, 2.9 V or 3.0 V. In an example, a Type 2 cell has a charge cutoff voltage of at least about 1.7 V after at least about 100 charge/discharge cycles. The operating voltage of a Type 2 cell can be from about 1 V to 2 V, 1 V to 3 V, 1.5 V to 2.5 V, 1.5 V to 3 V, or 2 V to 3 V in a charged state. A Type 2 cell can provide such voltage(s) (e.g., voltage, OCV and/or CCV) upon operating at up to and exceeding about 10 cycles, 20 cycles, 30 cycles, 40 cycles, 50 cycles, 100 cycles, 200 cycles, 300 cycles, 400 cycles, 500 cycles, 600 cycles, 700 cycles, 800 cycles, 900 cycles, 1000 cycles, 2000 cycles, 3000 cycles, 4000 cycles, 5000 cycles, 10,000 cycles, 20,000 cycles, 50,000 cycles, 100,000 cycles, 1000,000 or more cycles. In some cases, the limiting factor on the number of cycles may be dependent on, for example, the housing and/or the seal as opposed to the chemistry of the negative electrode, electrolyte and/or the positive electrode. The limit in cycles may be dictated not by the electrochemistry, but by the degradation of non-active components of the cell, such as the container or seal. A cell can be operated without a substantial decrease in capacity. The operating lifetime of a cell can be limited, in some cases, by the life of the container, seal and/or cap of the cell.

A Type 2 cell may have various advantages. For instance, a Type 2 cell may include one or more elements that are more abundant and readily accessible. A Type 2 cell may be less hazardous and toxic than other chemistries. In addition, some Type 2 chemistries can have valence states that help avoid, or minimize, oxidization and/or reduction (“redox”) shuttling reactions which can reduce Coulombic efficiency. In some examples, the positive electrode can comprise a metal or metalloid that has only one stable oxidation state (e.g., a metal with a single or singular oxidation state). For example, the positive electrode (e.g., the active material in the positive electrode) may comprise a Group 12 element, such as zinc and/or cadmium, which may only exhibit a single valence state compared to transition metals (e.g., iron, cobalt, nickel) or metalloids (e.g., lead, antinomy). In some examples, the positive electrode may comprise a Group 12 element with a singular stable oxidation state (e.g., Zn or Cd). In some examples, the positive electrode may comprise a transition metal with a singular stable oxidation state. A Type 2 cell of the present disclosure can have an energy storage capacity of at least about 1 Wh, 5 Wh, 25 Wh, 50 Wh, 100 Wh, 500 Wh, 1 kWh, 1.5 kWh, 2 kWh, 3 kWh, 5 kWh, 10 kWh, 15 kWh, 20 kWh, 30 kWh, 40 kWh, or 50 kWh, and a current density of at least about 10 mA/cm², 20 mA/cm², 30 mA/cm², 40 mA/cm², 50 mA/cm², 60 mA/cm², 70 mA/cm², 80 mA/cm², 90 mA/cm², 100 mA/cm², 200 mA/cm², 300 mA/cm², 400 mA/cm², 500 mA/cm², 600 mA/cm², 700 mA/cm², 800 mA/cm², 900 mA/cm², 1 A/cm², 2 A/cm², 3 A/cm², 4 A/cm², 5 A/cm², or 10 A/cm².

Type 2 cells can have cell configurations and be included in energy storage systems of the present disclosure. A Type 2 cell can be provided in an energy storage device comprising at least 1, 2, 3, 4, 5, 6, 7, 8, 9, 10, 20, 30, 40, 50, 60, 70, 80, 90, 100, 200, 300, 400, 500, 1000, 10,000, 20,000, 50,000, 100,000, 500,000, or 1,000,000 cells, which may be Type 2 cells or a combination of Type 1 cells and Type 2 cells (e.g., 50% Type 1 cells and 50% Type 2 cells). Such cells can be operated under Type 2 mode. In some cases, a first portion of the cells may be operated in Type 1 mode, and a second portion of the cells may be operated in Type 2 mode.

In an example, a Type 2 cell comprises Li|Zn. In a charged state, the Li∥Zn cell can have a cell voltage of at least about 1.0 V, 1.1 V, 1.2 V, 1.3 V, 1.4 V, 1.5 V, 1.6 V, 1.7 V, 1.8 V, 1.9 V, 2.0 V, 2.1 V, 2.2 V, 2.3 V, 2.4 V, 2.5 V, 2.6 V, 2.7 V, 2.8 V, 2.9 V, or 3.0 V. In an example, the Li|Zn cell has an OCV of about 1.86 V. A Li|Zn cell can be operated at a temperature of at least about 200 °C, 250 °C, 300 °C, 350 °C, 400 °C, 450 °C, 500 °C, 600 °C, 700 °C, 800 °C, or 900 °C. In such a case, the negative electrode, electrolyte and positive electrode are in a liquid (or molten) state.

In an example, a Type 2 cell comprises Na∥Zn. In a charged state, the Na∥Zn cell can have a cell voltage of at least about 1.0 V, 1.1 V, 1.2 V, 1.3 V, 1.4 V, 1.5 V, 1.6 V, 1.7 V, 1.8 V, 1.9 V, 2.0 V, 2.1 V, 2.2 V, 2.3 V, 2.4 V, 2.5 V, 2.6 V, 2.7 V, 2.8 V, 2.9 V, or 3.0 V. In an example, the Na∥Zn cell has an OCV of about 1.6 V. A Na∥Zn cell can be operated at a temperature of at least about 100 °C, 150 °C, 200 °C, 250 °C, 300 °C, 350 °C, 400 °C, 450 °C, 500 °C, 600 °C, 700 °C, 800 °C, or 900 °C. In such a case, the negative electrode, electrolyte and positive electrode are in a liquid (or molten) state.

In another example, a Type 2 cell comprises Li|Zn—Sn. Here, Sn can be added to reduce the melting point of the positive electrode and reduce the activity of Zn in the positive electrode, which can provide a driving force for removing Zn droplets that may form in the electrolyte. In a charged state, the Li∥Zn—Sn cell can have a cell voltage of at least about 1.2 V, 1.3 V, 1.4 V, 1.5 V, 1.6 V, 1.7 V, 1.8 V, 1.9 V, 2.0 V, 2.1 V, 2.2 V, 2.3 V, 2.4 V, 2.5 V, 2.6 V, 2.7 V, 2.8 V, 2.9 V, or 3.0 V. A Li|Zn—Sn cell can be operated at a temperature of at least about 200 °C, 250 °C, 300 °C, 350 °C, 400 °C, 450 °C, 500 °C, 600 °C, 700 °C, 800 °C, or 900 °C. In such a case, the negative electrode, electrolyte and positive electrode are in a liquid (or molten) state.

In another example, a Type 2 cell comprises Na∥Zn—Sn. In a charged state, the Na∥Zn—Sn cell can have a cell voltage of at least about 1.2 V, 1.3 V, 1.4 V, 1.5 V, 1.6 V, 1.7 V, 1.8 V, 1.9 V, 2.0 V, 2.1 V, 2.2 V, 2.3 V, 2.4 V, 2.5 V, 2.6V, 2.7V, 2.8 V, 2.9V, or 3.0 V. A Na∥Zn—Sn cell can be operated at a temperature of at least about 100 °C, 150 °C, 200 °C, 250 °C, 300 °C, 350 °C, 400 °C, 450 °C, 500 °C, 600 °C, 700 °C, 800 °C, or 900 °C. In such a case, the negative electrode, electrolyte and positive electrode are in a liquid (or molten) state.

### Energy Storage Systems

Also provided herein are control systems including computers programmed to control an energy storage system of the disclosure. An energy storage system can include an electrochemical energy storage device with one or more electrochemical energy storage cells. The device can be coupled to a computer system that regulates the charging and discharging of the device. The computer system can include one or more computer processors and a memory location coupled to the computer processor. The memory location comprises machine-executable code that, upon execution by the computer processor, implements any of the methods above or elsewhere herein.

In some implementations, an electrochemical energy storage system comprises at least a first electrochemical cell adjacent to a second electrochemical cell. Each of the first and second electrochemical cells can comprise a negative current collector, negative electrode, electrolyte, positive electrode and a positive currently collector, where at least one of the negative electrode, electrolyte and positive electrode are in a liquid state at an operating temperature of the first or second electrochemical cell. A positive current lead of the first electrochemical cell can be directly metal-to-metal joined (e.g., brazed or welded) to the negative current lead of the second electrochemical second cell. In some cases, the first and second electrochemical cells are not connected by wires.

### Interconnections

Wired or wire-less (e.g., direct metal-to-metal) interconnections may be formed between individual electrochemical cells and/or between groups of electrochemical cells (e.g., modules, towers, packs, trays, cores, CEs, systems, or any other group comprising one or more electrochemical cells). In some cases, groups of cells may be joined via one or more cell-to-cell interconnections. In some cases, groups of cells may be joined via a group-level interconnection. The group-level interconnection may further comprise one or more interconnections with one or more individual cells of the group. The interconnections may be structural and/or electrical. Cells and/or groups of cells may be assembled (or stacked) horizontally or vertically. Such assembled cells and/or groups of cells may be arranged in series or parallel configurations. Further, groups of cells may be supported by various frames. The frames may provide structural support and/or participate or aid in forming the interconnections (e.g., frames on groups of cells may mate or be connected).

In some implementations, interconnections may be configured to decrease resistance (e.g., internal resistance) in a system (e.g., a battery). A battery with a low system resistance (e.g., such that the battery is capable of efficiently storing energy and delivering power) may be desirable in some cases. The system resistance can be determined by the combined effect of a plurality of resistances along the current flow path such as between electrochemical cells, within electrochemical cells, and between groups of electrochemical cells. In some cases, electrochemical cells or groups thereof are connected using interconnects. In some instances, an interconnect is a wire. However, the shortest possible electrical connection can generally lead to the lowest system resistance. Therefore, the present disclosure describes direct connection of cells to each other (e.g., by brazing), in some cases reducing or eliminating the use of wires to connect electrochemical cells.

In some implementations, a battery comprises a plurality of electrochemical cells connected in series, where the battery is capable of storing at least about 10 kWh of energy, the battery has an operating temperature of at least about 250 °C, and each of the electrochemical cells has at least one liquid metal electrode. The battery can be any suitable size. In some cases, the battery is capable of storing at least about 10 kilo-Watt-hours of energy. In some cases, the battery is capable of storing at least about 30 kilo-Watt-hours of energy. In some cases, the battery is capable of storing at least about 100 kilo-Watt-hours of energy.

The internal resistance of the battery can be any suitably low resistance. In some cases, the internal resistance of the battery (e.g., at the operating temperature) is about 2.5*n*R, where ‘n’ is the number of series connected modules of the battery and ‘R’ (also referred to herein as ‘R_{Module}’) is the resistance of each of the individual modules or parallel connected modules. In some examples, R is the inverse of the sum of the inverses of the resistance of each electrochemical cell in a given module, as given by, for example,

$$1 / {R}_{M o d u l e} = {\sum }_{i = 1}^{m} 1 / {R}_{i} ,$$

where ‘m’ is the number of cells in one module. Each module can include a plurality of electrochemical cells in a parallel configuration. Electrochemical cells in adjacent modules can be arranged in a series configuration (e.g., individual cells in a module can be connected in series with corresponding individual cells in an adjacent module, such as, for example, in a configuration where individual cells of a first module are connected in series with individual cells of a second module located above the first module). In some cases, the internal resistance of the battery (e.g., at the operating temperature) is about 2*n*R, about 1.5*n*R, about 1.25*n*R, or about 1.05*n*R. In some cases, the internal resistance of the battery (e.g., at the operating temperature) is less than about 2.5*n*R, less than about 2*n*R, less than about 1.5*n*R, less than about 1.25*n*R, or less than about 1.05*n*R. In some cases, the total system resistance (e.g., at the operating temperature) is greater than about 1.0*n*R due to the resistance contribution of interconnects, busbars, surface contact resistance at connection interfaces, etc. The battery can comprise electrochemical cells connected in series and in parallel. The number of electrochemical cell modules (or parallel connected modules) that are connected in series (i.e., n) can be any suitable number. In some examples, n is at least 3, at least 5, at least 6, at least 10, at least 12, at least 15, at least 16, at least 20, at least 32, at least 48, at least 54, at least 64, at least 108, at least 128, at least 216, or at least 256. In an example, n is 3 (e.g., for a battery comprising a pack), 6 (e.g., for a battery comprising a pack), or 216 (e.g., for a battery comprising a core).

In some cases, the electrochemical cells are not connected with wires. In some examples, series connections (e.g., wire-less cell-to-cell connections) are created with a connection that has an internal resistance of about 0.5 milliohm (mOhm), about 1 mOhm, about 2 mOhm, about 5 mOhm, about 10 mOhm, about 50 mOhm, about 100 mOhm, or about 500 mOhm at an operating temperature greater than 250 °C. In some examples, series connections are created with a connection that has an internal resistance of less than about 0.5 mOhm, less than about 1 mOhm, less than about 2 mOhm, less than about 5 mOhm, less than about 10 mOhm, less than about 50 mOhm, less than about 100 mOhm, or less than about 500 mOhm at an operating temperature greater than about 250 °C. In some instances, the resistance is measured by a direct electrical connection between the conductor of a first electrochemical cell and the electrically conducting housing of a second cell. Any aspects of the disclosure described in relation to internal resistance of cell-to-cell series connections may equally apply to series connections between groups of cells at least in some configurations.

In some implementations, an electrochemical energy storage system comprises at least a first electrochemical cell adjacent to a second electrochemical cell, each of the first and second electrochemical cells comprising a negative current collector, negative electrode, electrolyte, positive electrode and a positive currently collector. The negative electrode, electrolyte and positive electrode can be in a liquid state at an operating temperature of the first or second electrochemical cell. A positive current collector of the first electrochemical cell can be direct metal-to-metal joined (e.g., brazed) to the negative current collector of the second electrochemical second cell. In some examples, the negative current collector comprises a negative current lead.

In some cases, the first and second electrochemical cells are not connected by wires. In some cases, the electrochemical energy storage system comprises one or fewer interconnects for every 2, 3, 4, 5, 6, 7, 8, 9, 10, 11, 12, 13, 14, 15, 16, 17, 18, 19, 20, 21, 22, 23, 24, 25, 26, 27, 28, 29, 30, or more electrochemical cells. In some cases, the electrochemical energy storage system (e.g., battery) comprises one interconnect for at least every 1, 2, 3, 4, 5, 6, 7, 8, 9, 10, 15, 20, 25, 30, 40, 50, 75, 100, 150, 200, or more electrochemical cells.

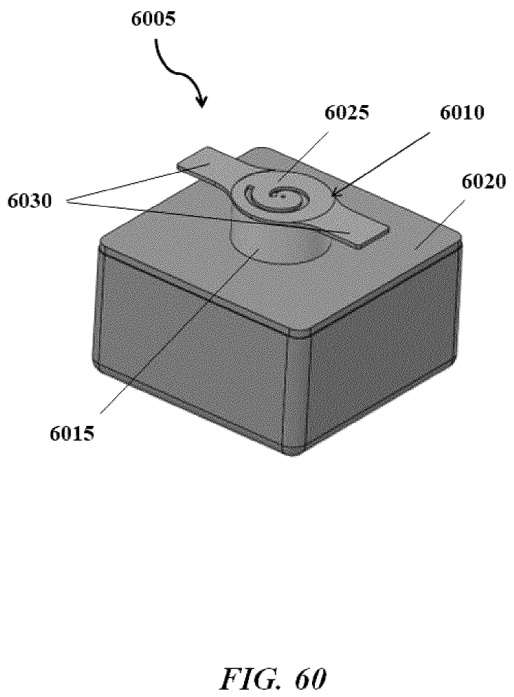

FIG. 60 is a perspective view of an electrochemical cell 6005 with a current transfer plate 6010 connected (e.g., welded) to a negative current lead 6015. The negative current lead can protrude through a housing 6020 of the cell 6005 through a seal (not shown). The current transfer plate can in some instances comprise a main portion 6025 in contact with the negative current lead, and one or more other portions 6030. The other portion(s) can be integrally formed with the main portion. The other portion(s) can be symmetrically (e.g., coaxially) or asymmetrically placed with respect to the main portion. For example, the current transfer plate can comprise a central portion 6025 and one or more flat elongated portions (e.g., flaps, tongues or tabs) 6030. The current transfer plate can be formed from a conductive material, such as any conductive material described herein. The other portion(s) can comprise a flat surface that can be welded or otherwise direct metal-to-metal joined with another surface (e.g., a cell body or a feature on the cell body of an adjacent cell). The current transfer plate (e.g., the other portion(s), such as the elongated portions 6030) can extend from the negative current lead toward the periphery of the cell surface comprising the negative current lead. Such configurations can enable electrical connections to be more conveniently made in tight spaces between cells or in cell assemblies. For example, the elongated portions 6030 can be more conveniently connected (e.g., welded to an adjacent cell body) during vertical stacking of cells because they can be more conveniently accessed (e.g., when accessing the cell from a direction parallel to the surface comprising the negative current lead, the connection can be made at the periphery of the surface comprising the negative current lead rather than near the center).

The current transfer plate may be combined with or comprise a strain relieving function to reduce stress on the seal (e.g., the seal around the negative current lead) that may be generated by the welding/joining process and/or thermal expansion differences during heat-up and/or cool-down. In some cases, the stresses on the seal may be reduced by including an electrically insulating non-gaseous (e.g., ceramic) spacer. The non-gaseous spacer can support the weight from the current transfer plate and/or cells stacked onto the current transfer plate and direct the weight onto the housing (e.g., the cell cap), thereby reducing the portion of the applied weight that is transmitted through the seal. In some cases, the strain relieving function may include a spiral pattern (e.g., a single spiral arm or multiple spiral arms) or other feature on the current transfer plate. The spiral pattern may be created by cutting away and/or removing material from the current transfer plate in the desired pattern. For example, the spiral feature on the main portion 6025 can give the current transfer plate compliance and may reduce stress experienced by the seal as the cells are stacked on top one another or during heat-up due to CTE mismatches. The spiral pattern may comprise one or more spiral arms. The spiral arms may be, for example, about 0.5 mm thick, about 1 mm thick, about 2 mm thick or about 4 mm thick. The spiral arms may create a spiral that has a circular or oval external shape that is about 1 cm, about 2 cm, about 3 cm or about 4 cm or larger in diameter. In some cases, the current transfer plate may be sufficiently compliant such that the strain relieving feature is not needed.

The busbar and/or interconnect components can comprise a conductive material. In some cases, the busbar and/or interconnect components can comprise (e.g., be made of) stainless steel or nickel. In some cases, copper can be used as busbar material (e.g., due to its high electrical conductivity of, for example, about 60×10⁶ S/m at 20 °C and about 20×10⁶ S/m at 500 °C). For example, copper may be used for high temperature battery systems that operate at less than about 450 °C; however, above about 450 °C, copper may be oxidized and/or lose structural integrity and may not be suitable for long-term use in high temperature battery systems. In some cases, the busbar and/or interconnect can comprise (e.g., be made from) a material that has a conductivity greater than stainless steel (e.g., greater than about 2×10⁶ S/m at 20 °C or greater than about 1×10⁶ S/m at 500 °C). For example, nickel may be used as a busbar and/or interconnect (e.g., in high temperature batteries) based on its electrical conductivity, which can be greater than the electrical conductivity of stainless steel but less conductive than copper.

In some cases, the busbar and/or interconnect may be made from an aluminum-copper based alloy that may have a conductivity similar to nickel but may be less expensive. Examples of such aluminum-copper based alloy can include, but are not limited to, aluminum-copper, aluminum-bronze or aluminum-brass, where the material comprises about 1 weight-percent aluminum (wt %), about 2 wt % aluminum, about 5 wt % aluminum, about 10 wt % aluminum or about 15 wt % aluminum, with most of the remainder of the material being copper, bronze or brass. Bronze may comprise, for example, about 88 wt % copper and about 12% tin, or primarily copper with other additives and smaller amounts of tin. Brass is a copper-zinc alloy that may comprise, for example, from about 60 wt % to about 90 wt % copper, from about 20 wt % to about 40 wt % zinc, and from about 1 wt % to about 20 wt % other materials such as tin, nickel, iron or lead. In some examples, the material of choice may be a copper-aluminum alloy comprising about 91 wt % copper, about 7 wt % aluminum and about 2 wt % iron. In some examples, the material of choice may be a copper-aluminum alloy comprising about 82 wt % copper, about 5 wt % nickel, about 2 wt % iron and about 10 wt % aluminum. The electrical conductivity of such aluminum-copper alloys at cell operating temperature (e.g., 500 °C) may be about 2×10⁶ S/m, about 3×10⁶ S/m, about 4×10⁶ S/m, about 5×10⁶ S/m, about 6×10⁶ S/m, about 7×10⁶ S/m, about 8×10⁶ S/m, about 9×10⁶ S/m, or about 10×10⁶ S/m.

In some cases, the busbar and/or interconnect component material may comprise (e.g., be made from) copper or a copper alloy that is coated with an oxidation-resistant material such as, for example, aluminum, aluminum-bronze, aluminum-brass, chromium, nickel, stainless steel, or any combination thereof. In some cases, the busbar and/or interconnect may comprise a copper core with a jacket or cladding that is oxidation-resistant, such as, for example, a jacket or cladding comprising aluminum, aluminum-bronze, aluminum-brass, chromium, nickel, stainless steel, or any combination thereof. The electrical conductivity of such coated/jacketed/clad materials may be similar to that of the substrate. For example, copper or a copper alloy jacketed with stainless steel can have a conductivity of about 90-100% that of copper.

A busbar and/or interconnect made from a non-ferrous alloy may be joined (e.g., brazed, press-fit or welded) to one or more end-caps (e.g., stainless steel end-caps) which may then enable the end-caps of the busbar or interconnect to be more easily joined (e.g., welded) to the appropriate busbar/interconnect/cells. For example, an end-cap may be more easily joined to a busbar/interconnect (e.g., at a first connection point of the end-cap) and/or to a cell (e.g., at a second connection point of the end-cap). In some instances, individual end-caps may be configured to join to both a busbar/interconnect and a cell. In some instances, separate end-caps may be provided for joining to a busbar/interconnect and for joining to a cell.

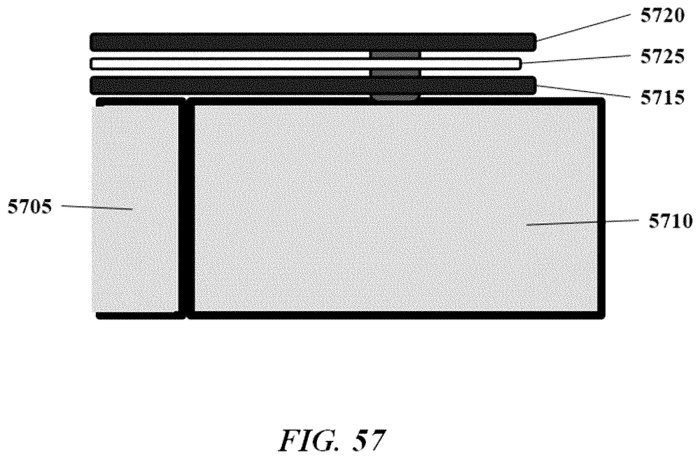

The busbars can be configured, for example, as shown in FIG. 57. A first cell 5705 is connected in parallel to a second cell 5710 (e.g., by direct contact of their housings). The connection can comprise a positive busbar 5715 and a negative busbar 5720 separated by a ceramic separator 5725. In some cases, the separator comprises a ceramic material. Non-limiting examples of ceramic materials include aluminum nitride (AlN), boron nitride (BN), yttrium oxide (Y₂O₃), zirconium oxide (ZrO₂), yttria partially substituted zirconia (YPSZ), aluminum oxide (Al₂O₃), silicon dioxide (SiO₂), magnesium oxide (MgO), quartz, glass, or any combination thereof. In some cases, the separator is electrically insulating.

In some examples, a connection between any two groups of cells using one or more busbars and/or interconnects has an internal resistance of about 0.01 mOhm, about 0.05 mOhm, about 0.1 mOhm, about 0.2 mOhm, about 0.5 mOhm, about 1 mOhm, about 5 mOhm, about 10 mOhm, about 50 mOhm, or about 100 mOhm. In some examples, a connection between any two groups of cells using one or more busbars and/or interconnects has an internal resistance of at least about 0.01 mOhm, at least about 0.05 mOhm, at least about 0.1 mOhm, at least about 0.2 mOhm, at least about 0.5 mOhm, at least about 1 mOhm, at least about 5 mOhm, at least about 10 mOhm, at least about 50 mOhm, or at least about 100 mOhm. In an example, an internal resistance between a first plurality of electrochemical cells and a second plurality of electrochemical cells connected to a busbar of the first plurality of electrochemical cells is less than about 10 mOhm or less than about 100 mOhm. In some instances, the resistance is measured by the voltage drop across the busbar (and/or interconnect) while current is flowing through the busbar (and/or interconnect) according to the following formula: R_{busbar}=V/I, where ‘R_{busbar}’ is the resistance of the busbar (and/or interconnect), ‘V’ is the measured voltage drop across the busbar (and/or interconnect) and ‘I’ is the current flowing through the busbar (and/or interconnect).

The positive and negative busbars may or may not be separated by a separator. For example, the positive and negative busbars may be provided on opposing ends of a module, pack, or any other group of one or more electrochemical cells. In some cases, the busbars may be physically separated such that a separator is not needed. In some cases, the busbars may be provided on adjacent surfaces of a unit (see, for example, FIG. 61) and a separator may or may not be provided.

FIG. 61 is an example of a pack 6105 with a first interpack busbar 6110 (e.g., a negative busbar) and a second interpack busbar 6115 (e.g., a positive busbar). The busbar 6110 may or may not be separated from the busbar 6115 by a separator (e.g., at interface 6130). The busbars 6110 and/or 6115 may in some instances be used to connect the pack 6105 to one or more other packs (e.g., in series or parallel configurations depending on the polarity of the busbar of the other pack).

A busbar connected to a first group of electrochemical cells (e.g., on a pack) may comprise a feature to allow the busbar (and therefore the first group of cells) to be electrically connected to a second group of cells (e.g., another pack). For example, the busbar 6115 or 6110 can comprise a flange, hook, ledge, interlock feature, weldable tab, brazable tab, snap fit or other member to allow the busbar to be interconnected with an adjacent group of cells (e.g., at a connection interface of the adjacent group of cells, to a busbar of the adjacent group of cells, to an interconnect on the adjacent group of cells, to an interconnect between the busbar on the first group of cells and a busbar on the second (adjacent) group of cells, etc.).

Busbar(s) may be configured to snap onto, be joined to (e.g., welded, brazed), or otherwise create a mating connection with a group of electrochemical cells. For example, the busbar 6115 can have a flange, hook, ledge, interlock feature, snap fit, weldable feature, brazable feature, bolted connection or other member that mates with the pack 6105 (e.g., at or near the interface 6130). For example, the busbar may mate with the pack at a connection interface. The connection interface may include one or more walls or housing components of cell(s) in the group of cells. The group of cells (e.g., a pack) may comprise a corresponding mating feature. For example, the pack 6105 can comprise a frame that mates with the busbar (e.g., allowing it to be snapped onto the pack). The frame may be electrically insulated from the cells, cell modules, and/or series stack of cell modules. In an example, a welded or brazed joint can be used. The joint may in some cases be cut in order to free the pack/interconnect/busbar.

The pack 6105 may further comprise or form other interconnections (e.g., to allow the pack 6105 to be interconnected with additional packs), including, but not limited to, additional interconnects, additional busbars and/or additional connection interfaces. For example, the pack 6105 may be further comprise additional interconnections at surfaces 6120 and/or 6125 (e.g., a positive interconnect, busbar or interconnection interface for connecting to another pack positioned adjacent to the surface 6125, and/or a positive interconnect, busbar or interconnection interface for connecting to another pack positioned adjacent to the surface 6120). Alternatively, one or more of the interconnections 6110 and/or 6115 may wrap around the pack 6105. For example, the positive busbar 6115 may further extend to the surface 6120, or to both the surface 6120 and the surface 6125. In another example, the negative busbar 6110 may further extend to the surface 6125, or to both the surface 6125 and the surface 6120. In some implementations, busbars may be used to provide pack-level electrical connections/interconnections (e.g., only busbars may be used for pack-level electrical connections/interconnections).

In configurations where cells are stacked vertically atop one another, the busbar at the top of the cell stack (e.g., cell pack stack) can comprise only the negative busbar (e.g., since the positive terminal of the stack can be on the bottom cell in the stack).

The core may be designed with multiple packs electrically connected in series and/or in parallel. The packs that are part of the core may be contained (e.g., all contained) within a single thermally managed chamber. For example, thermal insulation may surround a set of packs, thus keeping the packs (e.g., all packs) in good thermal contact with each other and thermally insulating the packs (e.g., all of the packs) from ambient conditions. In some cases, the core comprises electrically powered heaters installed near an inner surface of at least a portion of the insulation, electrically powered heaters distributed throughout the internal heated zone and/or connected to cell packs, or a combination thereof.

In some cases, the packs are arranged on trays that are arranged in a vertical stack. In some cases, the packs may be arranged on trays that are arranged in a horizontal stack. A plurality of trays (e.g., 2, 3, 4, 5, 10, 15, 20, 25, 30 or more trays) can be assembled into a core. The trays can be supported with an internal metal frame in the core. The packs can be assembled on each tray. The tray can provide mechanical support for the packs. The tray can be electrically isolated from the cells in the cell packs that are arranged on the tray. The packs in each tray can be series and/or parallel connected. The packs in each tray may be connected horizontally and/or vertically. In one example, the packs are assembled on each tray in a configuration about 1 pack deep and about 6 packs across. In another example, the packs are assembled on each tray in a configuration about 2 packs deep and about 4 packs across. In some cases, the packs are only connected in series to increase the core voltage. In some cases, two or more packs are stacked directly on top each another on one tray, with one or more trays within the core. Some of the packs on adjacent trays may be connected to each other to provide series connections between trays. Further, in some cases, some of the packs on adjacent trays may be connected to each other to provide parallel connections between trays. In some examples, the packs comprise about 6 modules stacked vertically on top each another and are about 1 cell wide and about 6 cells deep. In some examples, the packs comprise about 3 modules stacked vertically on top one another and are about 2 cells wide and about 8 cells deep.

The thermal insulation and/or the frame may be designed to allow the core (and/or any system of the disclosure) to be cooled, the insulation to be removed, a tray to be disconnected and removed from the core to allow for a single pack to be disconnected, removed and replaced, or any combination thereof. The core can then be reassembled and heated back up to operating temperature to allow for resumed operation.

The battery can have interconnects (e.g., wires) in addition to direct metal-to-metal joints (e.g., welds and brazes). A balance can be struck between the number of interconnects and the number of direct metal-to-metal joints where there are enough direct metal-to-metal joints to achieve a suitably low system resistance, but not so many that an entire battery is rendered inoperable and cannot be repaired without destroying direct metal-to-metal joints should one or more electrochemical cells fail. For example, interconnects may be advantageously used to enable modular assembly of the battery (e.g., module interchanges). Flexible interconnects can be used to reduce stresses generated between groups of cells (e.g., between cell packs) due to thermal gradients and differences in the coefficient of thermal expansion of components in the groups of cells (e.g., cell packs) and busbars (and/or other interconnections).

In some cases, the battery comprises at least one electrochemical cell connected in parallel with a plurality of electrochemical cells that are then stacked in series. The parallel connections can be made by creating the electrically conductive housing for multiple cells from one manufactured part. The housings can be stamped from a continuous piece of metal for example. In some cases, the parallel connections are formed by interconnects that allow at least some of the electrochemical cells comprising the battery to be replaced without breaking a direct metal-to-metal joint. In some cases, the parallel connections are formed by welding together cell bodies of adjacent cells (e.g., welding together the corners of adjacent cell bodies by melting together material from the cell body of adjacent cells and/or adding and melting filler material to the weld joint). In some cases, welding cell bodies directly to one another may risk creation of a hole in the cell body that may compromise the performance of the cell(s). To avoid the risk of creating a hole in the cell body, features may be added to the cell body (e.g., integrally formed with a housing or cell body, welded to the cell body during manufacturing, etc.) of one or more of the cells to be joined to allow the parallel connections to be formed by welding together the features in cell bodies of adjacent cells (e.g., welding together one or more tabs that stick out from the cell body and are positioned to be adjacent one or more tabs in an adjacent cell). One or more features (e.g., tabs, flanges, hooks, ledges or other weldable or brazable features) in the cell body may be provided on at least one of the cells to be joined. In some cases, one or more features in the cell body may be provided on all of the cells to be joined. The features may be positioned (e.g., aligned) to facilitate the formation of the parallel connection (e.g., to allow the features to be welded).

The battery can include a common single point connector. Multiple wires (e.g., ends of the wires) can be connected to the common single point connector (i.e., several wires can be connected to a common connector, which can connect to other portions of the battery at a single point).

In some implementations, a liquid metal battery can comprise a plurality of electrochemical cells connected in series and parallel. Each of the electrochemical cells can comprise a negative electrode, an electrolyte and a positive electrode. At least one of the negative electrode, the electrolyte and the positive electrode can be in a liquid state at an operating temperature of the electrochemical cell(s). The liquid metal battery can include a plurality of wires having a first end and a second end. The first end can be connected to at least one of the electrochemical cells (e.g., directly or indirectly). In some cases, the first end can be connected to a common single point connector, and the common single point connector can be connected to at least one of the electrochemical cells (e.g., to a busbar, to a cell body, to a feature in a cell body such as a tab protruding from the cell body, etc.). The second end can be connected, for example, to control circuitry (e.g., directly or indirectly) or to another common single point connector. In some cases, the second end can be connected to a common single point connector, and the common single point connector can be connected to control circuitry. For example, the single point connector on the second end (or the second end itself) can be connected to control circuitry located outside the thermally insulated zone containing cell packs, such as, for example, to a battery management system (e.g., to a battery management system board). In some cases, the first ends of a set of wires can be connected to a single point connector, the second ends of a subset of the wires can be connected to another single point connector, and the remaining wire or wires (e.g., the remaining second ends of the wires) can be separately connected to another part of the battery (e.g., voltage sense line input port of a battery management system).

In some implementations, the single point connector forms an electrical connection with another plurality (group) of electrochemical cells (e.g., to connect together modules, packs, cores, CEs, or systems).

An adapter plate can create a single point connection for multiple wires to a busbar in a module, pack, core, or CE. The wires can be welded or brazed to the back of the adapter plate to facilitate single point separation of a large quantity of wires connecting to a busbar. In order to effectively balance and monitor cells within a cell module, multiple wire connections may need to be created. The connection point can be a potential point of failure and can add to the cost and complexity of assembly. In some implementations, a terminal that has the wires connected to it can be pre-fabricated. The plate can be bolted, welded or brazed wherever the connection is required. Wires connected in this manner can remain static through many uses and disconnections, thus reducing wire wear-tear and embrittlement effects. Thus, single point connectors can in some cases enable more facile module interchanges.

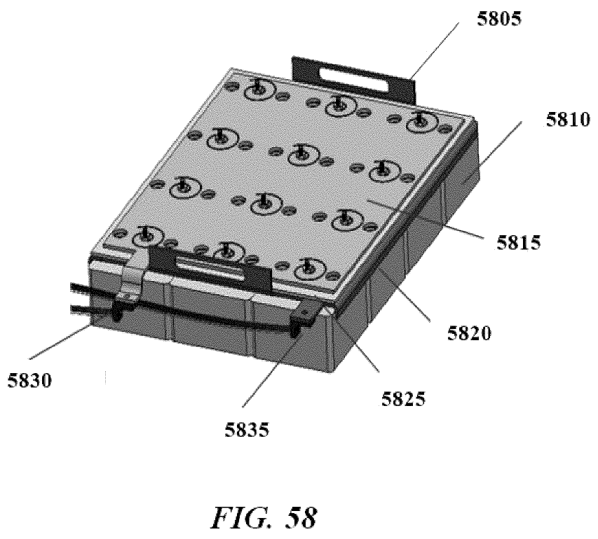

In some implementations, the first end of the wire is connected to a busbar that is in electrical communication with at least one of the electrochemical cells. FIG. 58 shows an example of a cell module (e.g., in a pack comprising a single module) with busbars and wires. The module includes handles 5805, in this case for lifting twelve electrochemical cells 5810 arranged in a 3 by 4 cell array. The electrochemical cells can be in electrical communication with a negative busbar 5815 and a positive busbar 5820. One or more ceramic spacers 5825 can be used to displace weight from the seals. The wires can be connected to common single point connectors (e.g., a negative single point connector 5830 and a positive single point connector 5835).

Any number of wires can be connected to a common single point connector. In some examples, 1, 2, 3, 4, 5, 6, 7, 8, 9, 10, 11, 12, 13, 14, 15, 16, 17, 18, 19, 20, 22, 24, 26, 28, 30, 35, or 40 wires are connected to the single point connector. In some cases, at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 22, at least 24, at least 26, at least 28, at least 30, at least 35, or at least 40 wires are connected to the single point connector.

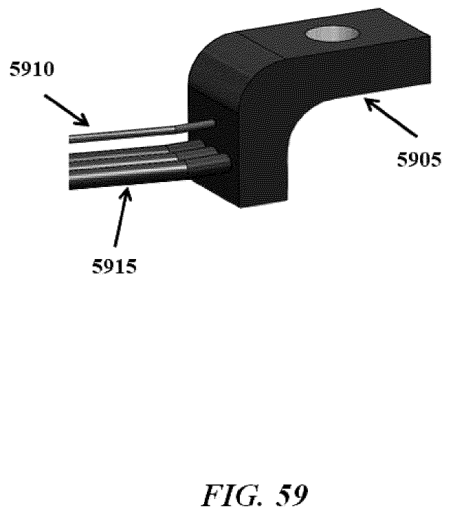

FIG. 59 shows an example of a single point connector. The single point connector can comprise a bent metal piece 5905. The single point connector (e.g., bent metal piece 5905) can be made of any conductive metal, such as, for example, nickel, stainless steel, copper-aluminum alloy, or of any other conductive material described herein. In some cases, the ends of wires 5910 and 5915 are passed through holes in the bent metal piece and/or welded to the bent metal piece. The wires can be any wire, including, but not limited to, American Wire Gauge (AWG) 18 wires 5910 or AWG 10 wires 5915. In some cases, one or more wires (e.g., 5910) may be used to sense voltage and therefore may be able to be thin (e.g., less than about 2 mm in diameter, or AWG 18). In some cases, one or more wires (e.g., 5915) may be thicker (e.g., greater than about 2 mm in diameter, or AWG 18 gauge) and may be used to carry current to and from the cell or cell module (e.g., as required for cell balancing). The sensing line(s) (e.g., 5910) may be provided separately from the current flow line(s) (e.g., 5915). In some cases, first ends of the current carrying wires and the voltage sense wire may be connected to a single point connector that is connected to the cells or a busbar, while the other (second) ends of the wires are separately connected to the battery management system (e.g., the voltage sense wire is connected to a voltage input port on the battery management system and the current wires are connected to a single point connector which is connected to a current input/output port on the battery management system). This arrangement may enable voltage drop across the current flow lines to be separated from the operational characteristics sensed by the sensing lines. As previously described, the sensing and current flow paths may be in electronic communication with the battery management system.

Various interconnection configurations described herein in relation to individual cells or a given group of cells may equally apply to other groups of cells (or portions thereof) at least in some configurations. In one example, interconnections such as, for example, brazed positive and negative current collectors of cells, braze enhanced by differences in coefficients of thermal expansion, connecting (e.g., welding) cell bodies or features in cell bodies, etc., may apply to (or be adapted to) groups of cells such as, for example, packs, trays, towers, etc. In another example, interconnections such as, for example, stamped pocketed electrically conductive housing in cells and/or modules, etc., may apply to (or be adapted to) groups of cells such as, for example, towers, packs, etc. In yet another example, interconnections such as, for example, busbars/interconnects between packs, etc., may in some cases apply to (or be adapted to) groups of cells such as, for example, cores, trays, etc. Further, stress-relieving configurations (e.g., current transfer plates between cells, spacers, spiral relief or compliance features/structures/patterns, etc.) and electrical/structural features (e.g., single point connectors, end-caps, etc.) may in some cases be applied to (or be adapted to) any group of cells herein. The various interconnection configurations may be applied at group level or to individual cells. Thus, in an example, a spacer used between cells may be configured for use as a spacer between packs or trays, a current transfer plate between cells may be configured for use between modules, a busbar on a pack may be configured for use as a busbar on a tray, an interconnection interface comprising a feature on a cell body for connecting cell bodies within a module may be configured for connecting cell bodies of outer cells on adjacent packs, and so on. Further, interconnections described in relation to forming a series connection may be in some cases be adapted to forming a parallel connection, and vice versa.

A group of cells (e.g., a core, a CE, a system, etc.) with a given energy capacity and power capacity (e.g., a CE or a system capable of storing a given amount of energy) may be configured to deliver at least about 10%, at least about 20%, at least about 30%, at least about 40%, at least about 50%, at least about 60%, at least about 70%, at least about 80%, at least about 90%, at least about 95%, or about 100% of a given (e.g., rated) power level. For example, a 1000 kW system may be capable of also operating at 500 kW, but a 500 kW system may not be able to operate at 1000 kW. In some cases, a system with a given energy capacity and power capacity (e.g., a CE or a system capable of storing a given amount of energy) may be configured to deliver less than about 100%, less than about 110%, less than about 125%, less than about 150%, less than about 175%, or less than about 200% of a given (e.g., rated) power level, and the like. For example, the system may be configured to provide more than its rated power capacity for a period of time that is less than the time it may take to consume its energy capacity at the power level that is being provided (e.g., provide power that is greater than the rated power of the system for a period of time corresponding to less than about 1%, less than about 10% or less than about 50% of its rated energy capacity).

### Electrochemical Cells, Devices and Systems

The present disclosure provides electrochemical energy storage devices (e.g., batteries) and systems. An electrochemical energy storage device generally includes at least one electrochemical cell, also “cell” and “battery cell” herein, sealed (e.g., hermetically sealed) within a housing. A cell can be configured to deliver electrical energy (e.g., electrons under potential) to a load, such as, for example, an electronic device, another energy storage device or a power grid.

An electrochemical cell of the disclosure can include a negative electrode, an electrolyte adjacent to the negative electrode, and a positive electrode adjacent to the electrolyte. The negative electrode can be separated from the positive electrode by the electrolyte. The negative electrode can be an anode during discharge. The positive electrode can be a cathode during discharge.

In some examples, an electrochemical cell is a liquid metal battery cell. In some examples, a liquid metal battery cell can include a liquid electrolyte arranged between a negative liquid (e.g., molten) metal electrode and a positive liquid (e.g., molten) metal, metalloid and/or non-metal electrode. In some cases, a liquid metal battery cell has a molten alkaline earth metal (e.g., magnesium, calcium) or alkali metal (e.g., lithium, sodium, potassium) negative electrode, an electrolyte, and a molten metal positive electrode. The molten metal positive electrode can include, for example, one or more of tin, lead, bismuth, antimony, tellurium and selenium. For example, the positive electrode can include Pb or a Pb—Sb alloy. The positive electrode can also include one or more transition metals or d-block elements (e.g., Zn, Cd, Hg) alone or in combination with other metals, metalloids or non-metals, such as, for example, a Zn—Sn alloy or Cd—Sn alloy. In some examples, the positive electrode can comprise a metal or metalloid that has only one stable oxidation state (e.g., a metal with a single or singular oxidation state). Any description of a metal or molten metal positive electrode, or a positive electrode, herein may refer to an electrode including one or more of a metal, a metalloid and a non-metal. The positive electrode may contain one or more of the listed examples of materials. In an example, the molten metal positive electrode can include lead and antimony. In some examples, the molten metal positive electrode may include an alkali or alkaline earth metal alloyed in the positive electrode.

In some examples, an electrochemical energy storage device includes a liquid metal negative electrode, a liquid metal positive electrode, and a liquid salt electrolyte separating the liquid metal negative electrode and the liquid metal positive electrode. The negative electrode can include an alkali or alkaline earth metal, such as lithium, sodium, potassium, rubidium, cesium, magnesium, barium, calcium, sodium, or combinations thereof. The positive electrode can include elements selected from transition metals or d-block elements (e.g., Group 12), Group IIIA, IVA, VA and VIA of the periodic table of the elements, such as zinc, cadmium, mercury, aluminum, gallium, indium, silicon, germanium, tin, lead, pnicogens (e.g., arsenic, bismuth and antimony), chalcogens (e.g., sulfur, tellurium and selenium), or combinations thereof. In some examples, the positive electrode comprises a Group 12 element of the periodic table of the elements, such as one or more of zinc (Zn), cadmium (Cd) and mercury (Hg). In some cases, the positive electrode may form a eutectic or off-eutectic mixture (e.g., enabling lower operating temperature of the cell in some cases). In some examples, the positive electrode comprises a first positive electrode species and a second positive electrode species at a ratio (mol-%) of about 20:80, 40:60, 50:50, or 80:20 of the first positive electrode species to the second electrode species. In some examples, the positive electrode comprises Sb and Pb at a ratio (mol-%) of about 20:80, 40:60, 50:50, or 80:20 Sb to Pb. In some examples, the positive electrode comprises between about 20 mol % and 80 mol-% of a first positive electrode species mixed with a second positive electrode species. In some cases, the positive electrode comprises between about 20 mol-% and 80 mol-% Sb (e.g., mixed with Pb). In some cases, the positive electrode comprises between about 20 mol-% and 80 mol-% Pb (e.g., mixed with Sb). In some examples, the positive electrode comprises one or more of Zn, Cd, Hg, or such material(s) in combination with other metals, metalloids or non-metals, such as, for example, a Zn—Sn alloy, Zn—Sn alloy, Cd—Sn alloy, Zn—Pb alloy, Zn—Sb alloy, or Bi. In an example, the positive electrode can comprise 15:85, 50:50, 75:25 or 85:15 mol-% Zn:Sn.

The electrolyte can include a salt (e.g., molten salt), such as an alkali or alkaline earth metal salt. The alkali or alkaline earth metal salt can be a halide, such as a fluoride, chloride, bromide, or iodide of the active alkali or alkaline earth metal, or combinations thereof. In an example, the electrolyte (e.g., in Type 1 or Type 2 chemistries) includes lithium chloride. In some examples, the electrolyte can comprise sodium fluoride (NaF), sodium chloride (NaCl), sodium bromide (NaBr), sodium iodide (Nal), lithium fluoride (LiF), lithium chloride (LiCl), lithium bromide (LiBr), lithium iodide (LiI), potassium fluoride (KF), potassium chloride (KCl), potassium bromide (KBr), potassium iodide (KI), calcium fluoride (CaF₂), calcium chloride (CaCl₂)), calcium bromide (CaBr₂), calcium iodide (Cal₂), or any combination thereof. In another example, the electrolyte includes magnesium chloride (MgCl₂). As an alternative, the salt of the active alkali metal can be, for example, a non-chloride halide, carbonate, hydroxide, nitrate, nitrite, sulfate, sulfite, or combinations thereof. In some cases, the electrolyte can comprise a mixture of salts (e.g., 25:55:20 mol-% LiF:LiCl:LiBr, 50:37:14 mol-% LiCl:LiF:LiBr, etc.). The electrolyte may exhibit low (e.g., minimal) electronic conductance (e.g., electronic shorting may occur through the electrolyte via valence reactions of PbCl₂↔PbCl₃ which increases electronic conductance). For example, the electrolyte can have an electronic transference number (i.e., percentage of electrical (electronic and ionic) charge that is due to the transfer of electrons) of less than or equal to about 0.03% or 0.3%.

In some cases, the negative electrode and the positive electrode of an electrochemical energy storage device are in the liquid state at an operating temperature of the energy storage device. To maintain the electrodes in the liquid states, the battery cell may be heated to any suitable temperature. In some examples, the battery cell is heated to and/or maintained at a temperature of about 100 °C, about 150 °C, about 200 °C, about 250 °C, about 300 °C, about 350 °C, about 400 °C, about 450 °C, about 500 °C, about 550 °C, about 600 °C, about 650 °C, or about 700 °C. The battery cell may be heated to and/or maintained at a temperature of at least about 100 °C, at least about 150 °C, at least about 200 °C, at least about 250 °C, at least about 300 °C, at least about 350 °C, at least about 400 °C, at least about 450 °C, at least about 500 °C, at least about 550 °C, at least about 600 °C, at least about 650 °C, at least about 700 °C, at least about 800 °C, or at least about 900 °C. In such a case, the negative electrode, electrolyte and positive electrode can be in a liquid (or molten) state. In some situations, the battery cell is heated to between about 200 °C and about 600 °C, between about 500 °C and about 550 °C, or between about 450 °C and about 575 °C.

In some implementations, the electrochemical cell or energy storage device may be at least partially or fully self-heated. For example, a battery may be sufficiently insulated, charged, discharged and/or conditioned at sufficient rates, and/or cycled a sufficient percentage of the time to allow the system to generate sufficient heat through inefficiencies of the cycling operation that cells are maintained at a given operating temperature (e.g., a cell operating temperature above the freezing point of at least one of the liquid components) without the need for additional energy to be supplied to the system to maintain the operating temperature.

Electrochemical cells of the disclosure may be adapted to cycle between charged (or energy storage) modes and discharged modes. In some examples, an electrochemical cell can be fully charged, partially charged or partially discharged, or fully discharged.

In some implementations, during a charging mode of an electrochemical energy storage device, electrical current received from an external power source (e.g., a generator or an electrical grid) may cause metal atoms in the metal positive electrode to release one or more electrons, dissolving into the electrolyte as a positively charged ion (i.e., cation). Simultaneously, cations of the same species can migrate through the electrolyte and may accept electrons at the negative electrode, causing the cations to transition to a neutral metal species, thereby adding to the mass of the negative electrode. The removal of the active metal species from the positive electrode and the addition of the active metal to the negative electrode stores electrochemical energy. In some cases, the removal of a metal from the positive electrode and the addition of its cation to the electrolyte can store electrochemical energy. In some cases, electrochemical energy can be stored through a combination of removal of the active metal species from the positive electrode and its addition to the negative electrode, and the removal of one or more metals (e.g., different metals) from the positive electrode and their addition to the electrolyte (e.g., as cations). During an energy discharge mode, an electrical load is coupled to the electrodes and the previously added metal species in the negative electrode can be released from the metal negative electrode, pass through the electrolyte as ions, and deposit as a neutral species in the positive electrode (and in some cases alloy with the positive electrode material), with the flow of ions accompanied by the external and matching flow of electrons through the external circuit/load. In some cases, one or more cations of positive electrode material previously released into the electrolyte can deposit as neutral species in the positive electrode (and in some cases alloy with the positive electrode material), with the flow of ions accompanied by the external and matching flow of electrons through the external circuit/load. This electrochemically facilitated metal alloying reaction discharges the previously stored electrochemical energy to the electrical load.

In a charged state, the negative electrode can include negative electrode material and the positive electrode can include positive electrode material. During discharging (e.g., when the battery is coupled to a load), the negative electrode material yields one or more electrons, and cations of the negative electrode material. In some implementations, the cations migrate through the electrolyte to the positive electrode material and react with the positive electrode material (e.g., to form an alloy). In some implementations, ions of the positive metal species (e.g., cations of the positive electrode material) accept electrons at the positive electrode and deposit as a metal on the positive electrode. During charging, in some implementations, the alloy at the positive electrode disassociates to yield cations of the negative electrode material, which migrate through the electrolyte to the negative electrode. In some implementations, one or more metal species at the positive electrode disassociates to yield cations of the negative electrode material in the electrolyte. In some examples, ions can migrate through an electrolyte from an anode to a cathode, or vice versa. In some cases, ions can migrate through an electrolyte in a push-pop fashion in which an entering ion of one type ejects an ion of the same type from the electrolyte. For example, during discharge, an alkali metal anode and an alkali metal chloride electrolyte can contribute an alkali metal cation to a cathode by a process in which an alkali metal cation formed at the anode interacts with the electrolyte to eject an alkali metal cation from the electrolyte into the cathode. The alkali metal cation formed at the anode in such a case may not necessarily migrate through the electrolyte to the cathode. The cation can be formed at an interface between the anode and the electrolyte, and accepted at an interface of the cathode and the electrolyte.

### Batteries and Housings

Electrochemical cells of the disclosure can include housings that may be suited for various uses and operations. A housing can include one cell or a plurality of cells. A housing can be configured to electrically couple the electrodes to a switch, which can be connected to the external power source and the electrical load. The cell housing may include, for example, an electrically conductive container that is electrically coupled to a first pole of the switch and/or another cell housing, and an electrically conductive container lid that is electrically coupled to a second pole of the switch and/or another cell housing. The cell can be arranged within a cavity of the container. A first one of the electrodes of the cell (e.g., positive electrode) can contact and be electrically coupled with an endwall of the container. A second one of the electrodes of the cell (e.g., negative electrode) can contact and be electrically coupled with a conductive feed-through or conductor (e.g., negative current lead) on the container lid. An electrically insulating seal (e.g., bonded ceramic ring) may electrically isolate negative potential portions of the cell from positive portions of the container (e.g., electrically insulate the negative current lead from the positive current lead). In an example, the negative current lead and the container lid (e.g., cell cap) can be electrically isolated from each other, where a dielectric sealant material can be placed between the negative current lead and the cell cap. As an alternative, a housing can include an electrically insulating sheath (e.g., alumina sheath) or a corrosion-resistant and electrically conductive sheath or crucible (e.g., graphite sheath or crucible). In some cases, a housing and/or container may be a battery housing and/or container.

A battery, as used herein, can comprise a plurality of electrochemical cells. The cell(s) can include housings. Individual cells can be electrically coupled to one another in series and/or in parallel. In series connectivity, the positive terminal of a first cell is connected to a negative terminal of a second cell. In parallel connectivity, the positive terminal of a first cell can be connected to a positive terminal of a second, and/or additional, cell(s). Similarly, cell modules, packs, cores, CEs and systems can be connected in series and/or in parallel in the same manner as described for cells.

As described in greater detail elsewhere herein, individual cells or portion(s) thereof, groups of cells, or devices or systems comprising such cell(s) (e.g., energy storage systems comprising energy storage devices such as batteries) can be thermally maintained and/or regulated, e.g., by a thermal management system. The thermal management system may be distributed across various portions of the energy storage device/system, and/or across a system for operating the energy storage device/system. In some implementations, one or more frames may be used for thermal management of the systems herein. Such thermal management frames may also provide structural support. At least a portion of the thermal management system may be assembled by connecting frames. The frames may be configured, for example, to form a system of fluid flow pathways and/or ducts comprising a thermal management fluid. In some cases, the frames may be configured to be in thermal contact with (e.g., via the thermal management fluid) one or more electrochemical cells.

### Thermal Management

Elevated or high temperatures systems/devices (e.g., energy storage devices such as, for example, batteries) of the disclosure can comprise thermal management systems. In some cases, elevated temperature devices may be high temperature devices, and vice versa. In some examples, the energy storage system/device can comprise a plurality of electrochemical cells. Each electrochemical cell can comprise a negative electrode, an electrolyte and a positive electrode. At least one of the negative electrode, the electrolyte and the positive electrode can be in a liquid state at an operating temperature of the electrochemical cell.

In some implementations, thermal management of the devices (e.g., batteries) herein may include over-insulating (providing excess insulation) and cooling during normal operation. Heating can be performed at start-up of the device. For example, heating can be performed at start-up of a battery system that comprises a battery comprising one or more cells that may be organized in one or more groups of cells (e.g., for at least one of the metal electrodes and/or the electrolyte in the one or more cells to melt and/or for the battery to function). Heating may be achieved using any form of heaters, such as, for example, electrical resistance heaters that convert electrical energy from a power source (e.g., power generators via the electric power grid, back-up battery system, an on-site power generator such as a diesel generator, renewable power generators such as a wind turbine or a solar power system). Heating can also be provided to the system after it has been heated up in order to manage the temperature of the system during charging, discharging, and/or rest operating modes, or during periods of extended resting or during periods where the battery is charged and/or discharged at power rates below its regular (or normal) or intended operating power rates. When the battery is at, near or above its operating temperature, the battery may be able to keep itself warm by providing power from energy stored within the battery (e.g., the battery may discharge its energy to its own heaters). Battery insulation can be designed such that, once heated, the battery retains heat (e.g., in a thermal chamber of the battery) during idle time (e.g., when the battery is not charging or discharging). However, when the battery is operating, the thermal chamber may in some cases overheat. To regulate the temperature of the device (e.g., the temperature in the device chamber or container) during the cycling period (e.g., when the battery is charging and/or discharging), a thermal management system can be used (e.g., to cool hot zones). As cell components may require heat for operation, the system may be configured such that the cells and/or groups of cells (e.g., packs) are thermally insulated in excess to trap and retain as much heat as possible, while providing mechanism(s) for natural or forced movement of one or more thermal management fluids to help maintain given (e.g., optimal) thermal boundaries. The mechanism(s) may be activated by the thermal management system. Such activated cooling mechanisms may enable improved system reliability, performance robustness, and high efficiency operation. In some cases, the cooling mechanism(s) may comprise activated passive cooling (e.g., opening vents/convection flow channels, opening a vent/valve to allow natural convection to cool the system). In some cases, the cooling mechanism(s) may comprise active cooling (e.g., starting or increasing a flow of a thermal management fluid). In some cases, the cooling mechanism may comprise a combination of activated passive cooling and active cooling.

In an example, the system comprises an amount of insulation that enables the system to increase an internal temperature of the system above an operating temperature of the system (e.g., above the standard operating temperature) during regular operation. The system may maintain the internal temperature at about, or within less than about 10 °C, 20 °C, 50 °C, 100 °C or 200 °C of a given (e.g., desired) operating temperature by activating an actuator, such as, for example, a valve or a lift-gate, to allow a fluid (e.g., thermal management fluid) to flow through one or more fluid flow paths driven by natural convection. The system may be self-heated under normal/regular operation, and may need to be cooled via activated passive cooling to maintain its operating temperature.

In some implementations, the thermal management system may provide a mechanism for emergency cool-down (e.g., in a condition where emergency shut-down of the battery system is required, such as, for example, due to a natural disaster in the deployed region). Emergency cool-down may be triggered by a thermal management computer system when it receives one or more specific signals. Such signal(s) may comprise signal(s) received from within the system (e.g., battery system or a larger system comprising the battery system) and/or outside signal(s) indicating that emergency cool-down procedures are to be initiated (e.g., earthquake alert). The emergency cool-down may include one or more mechanisms for rejecting/evacuating heat from the battery system to the thermal management fluid and/or to the environment (e.g., surrounding atmosphere). For example, the emergency cool-down may include increasing a flow rate of the thermal management fluid, partially or fully opening vent(s) or other thermal relief structure(s) in the system, and/or varying a temperature of the thermal management fluid supplied (in) to the system such that more thermal energy can be removed from the system.

A thermal management system (e.g., within a battery system) configured to implement such mechanism(s) can be integrated in a frame (e.g., a support frame) of the battery, allowing thermal management fluid(s) to flow through the system (e.g., battery system). In some cases, the thermal management fluids may flow through the system (e.g., battery system) without touching any cells or cell components. In some cases, such functionality/mechanisms may be integrally formed with (e.g., built into) one or more structural members of the battery or a portion thereof (e.g., a structural support member of a core, such as, for example, a frame). In some cases, such functionality/mechanisms may be attached to one or more structural support members (e.g., a structural support member of a core). In some cases, the structural support members can be designed as dual-purpose components (e.g., providing structural support and also providing a mechanism for heat evacuation as needed).

During operation of a high temperature system (e.g., core) comprising high temperature cells, cells may generate heat during charging and/or discharging processes. If a system is operated continuously, sufficiently often and/or with sufficient intensity (e.g., sufficiently high charging/discharging rate) within a given time period, and if the system is configured in such a way that the heat generated through the charging and/or discharging processes can be at least partially contained (e.g., through thermal insulation around one or more packs of cells), such a system may continuously maintain its cells at or above its operating temperature without the need to add additional heat (e.g., through the use of electric heaters). In some cases, the amount of heat generated through normal or regular (e.g., intended) operation (e.g., charge for 5 hours, then rest for 7 hours, then discharge for 5 hours, then rest for 7 hours, repeated daily) may equal the amount of heat lost to the environment.

Normal or regular operation may include or be defined in terms of one or more charge/discharge operating metrics, such as, for example, overall (e.g., average) charging/discharging rate (e.g., time to fully charge, time to fully discharge), amount of energy charged or discharged (e.g., change in energy storage capacity upon charging/discharging) and/or energy efficiency (e.g., energy efficiency over a given time period). Operating parameters (e.g., charge or discharge rate) may fluctuate over time. The operating metrics may then be provided on an average or overall basis (e.g., average discharge over a 24-hour period may be specified even though the discharge rate May fluctuate over time; regardless of charge/discharge profile, the system may have a given charge/discharge metric when it returns to the same state of charge). A system with such charge/discharge metric(s) may be self-heated (e.g., upon the charging/discharging under such conditions, a portion of the energy may dissipate due to inefficiencies to provide the necessary heating), or may use a given amount of additional energy (e.g., less than about 10% of energy discharged to the grid) to provide heating.

Normal or regular operation may include charging the system at a rate that can fully charge the system (e.g., from minimum to full or maximum charge) in at least about 1 hour, 2 hours, 3 hours, 4 hours, 5 hours, 6 hours, 7 hours, 8 hours, 10 hours, 12 hours, 14 hours, or 20 hours. Normal or regular operation may include discharging the system (e.g., from full or maximum charge to minimum charge) at a rate that can fully discharge the system in at least about 1 hour, 2 hours, 3 hours, 4 hours, 5 hours, 6 hours, 7 hours, 8 hours, 10 hours, 12 hours, 14 hours, or 20 hours. Normal or regular operation may include charging and/or discharging the system for a period of less than about 1 hour, less than about 2 hours, less than about 4 hours, less than about 6 hours, less than about 8 hours, less than about 12 hours, less than about 14 hours, less than about 18 hours, less than about 20 hours, less than about 24 hours, less than about 36 hours, or less than about 48 hours. Normal or regular operation may include cumulate charge or energy passed during charging and/or discharging (e.g., a single charge and/or discharge cycle, or cumulative energy from several charge/discharge cycles, such as, for example, by charging 1 Wh, discharging 1 Wh, charging 1.5 Wh and discharging 1.5 Wh, thereby discharging 2.5 Wh (i.e., 1 Wh+1.5 Wh) overall) the system to release (e.g., to the grid) an amount of energy that is at least about 10%, 20%, 30%, 40%, 50%, 60%, 70%, 80%, 90%, 95%, 100%, 110%, 125%, 150%, 175%, 200%, 250%, 300%, 400%, 500%, 750%, 1000%, 2000%, 5000%, or 10,000% of its rated energy storage capacity within a given time period (e.g., less than or equal to about 2 weeks, 1 week, 4 days, 48 hours, 24 hours, 12 hours, 8 hours, 4 hours, or 1 hour). The system may release more energy than its rated energy capacity within a given time period by undergoing multiple partial and/or full discharge and/or charge cycles within the given time period). Normal or regular operation may include resting for a given (e.g., some) period between charging and/or discharging. The resting period may be less than about 1 hour, 2 hours, 3 hours, 4 hours, 5 hours, 6 hours, 7 hours, 8 hours, 10 hours, 12 hours, 14 hours, 18 hours, 20 hours, 24 hours, 36 hours, or 48 hours. The system may be operated at such charge/discharge metrics with a given average efficiency. For example, an overall DC-to-DC energy efficiency may be at least about 30%, 40%, 50%, 60%, 70%, 80%, 90%, 95% or 99%. Normal or regular operation may include discharging some cumulative amount of energy (e.g., at least about 50% of its rated energy capacity, at least about 80% of its rated energy capacity), charging some cumulative amount of energy (e.g., at least about 50% of its rated energy capacity, or at least about 80% of its rated energy capacity), not resting for a period or resting for some cumulative period between charge/discharge and/or charge/charge and/or charge/discharge operational modes (e.g., less than about 20 hours, less than about 16 hours), achieving some DC-to-DC round-trip energy efficiency (e.g., less than about 90%, less than about 80%, or less than about 70%), and/or operating at such charge/discharge metrics within a given time period (e.g., less than about 48 hours, or less than about 24 hours).

Such a system may be capable of maintaining its cells at or above a given cell operating temperature (e.g., a target cell operating temperature) as long as the system is being operated in this manner. Thus, a battery system can be configured to balance the heat generated with the heat released to the environment by providing a suitable amount of insulation and by controlling heat loss through other heat loss paths (e.g., not through insulation but through vents, thermal management fluid, etc.). In some cases, the battery system can be configured to balance the heat generated with the heat released to the environment by providing a suitable amount of insulation, by controlling heat loss through other heat loss paths (e.g., not through insulation but through vents, thermal management fluid, etc.) and by operating the system regularly (e.g., continuously, often).

In some cases, there can be (e.g., extended) periods of inactivity within the cells (e.g., during which the cells are not charging or discharging). Thermal insulation can be used to prevent heat loss from the cells (e.g., to keep the metal electrodes molten when heat is not being generated from charging or discharging of the cell). The thermal insulation may be designed such that it maintains the cells at or above operating temperature for a given period of time (e.g., a finite period of time, such as, for example, at least about 30 minutes, 1 hour, 2 hours, 4 hours, 6 hours, 8 hours, 10 hours, 12 hours, 18 hours, 24 hours, 2 days, 5 days, 10 days, 20 days, 1 month, or more) when the cells are inactive and/or when no supplemental heating power is provided through heaters.

In some cases, a system (e.g., energy storage system such as, for example, a battery system) may be designed to operate without the need for heating even when the system is used less regularly and/or less intensely (e.g., than originally intended or quantified by a system specification, than normal or regular operation). A measure of the regularity of operation of the system may in some cases be based on percentage of use of the system during a given (e.g., specified) time period. For example, the system may be actively charging and/or discharging for less than or equal to about 99.5%, 99%, 95%, 90%, 85%, 80%, 75%, 70%, 65%, 60%, 55%, 50%, 45%, 40%, 35%, 30%, 25%, 20%, 15%, 10%, 5%, or less of the given time period (e.g., the battery may be in charging or discharging mode for less than about 20% of the time over a three day period). A measure of the intensity of operation of the system may in some cases be based on average charge or discharge power over a given (e.g., specified) time period as a percentage of its maximum rated power capacity. The given time period may include periods of rest (e.g., 0% of rated power). For example, the system may have an average charge or discharge power of less than or equal to about 99%, 95%, 90%, 80%, 70%, 60%, 50%, 40%, 30%, 20%, 10%, 5%, 1%, or less of its rated power over the given time period. In some examples, the given (e.g., specified) time period may be equal to or at least about 1 hour, 2 hours, 5 hours, 10 hours, 12 hours, 24 hours, 36 hours, 2 days, 3 days, 4 days, 5 days, 1 week, 2 weeks or 4 weeks.

The thermal insulation may allow the system to be (e.g., fully) self-heated when operated normally/regularly (e.g., when cycled at least once every 2 days, or with at least 50% of its energy capacity discharged at least every two days). For example, thermal insulation may enable the system to operate continuously in the self-heated configuration when charged and discharged (or cycled) at least once every 2 days. In some examples, the normal/regular operation may include cycling (an example of a charge/discharge metric associated with such operation) at least once every 1 day, 2 days, 3 days, 4 days, or the like.

In such cases (e.g., during periods of inactivity, or when used less regularly or less intensely), it may be desirable to configure the system with an excess amount of insulation (e.g., reduced rate of heat loss) as well as capability to perform activated passive cooling, such as, for example, opening a valve, lift-gate or other thermal relief mechanism(s) to increase rate of heat loss and thus prevent over-heating. In some cases, cooling channels in the system that can transport air from outside a thermally maintained zone of the system (e.g., zone comprising the thermal chamber) may be activated such that air moves through one or more (e.g., dedicated) channels of (e.g., within) the system. Air heated within the system is allowed to (e.g., safely) exit the system through one or more channels of the system with or without the use of forced air convection systems (e.g., fans, blowers, air handlers, etc.). In some cases, air transport channels may be configured to allow natural convection to set in when thermal relief features are activated.

During periods of inactivity, or when used less regularly or less intensely, the system may continue to operate (or exist in a ‘rest’ operational mode and be ready to be charged or discharged) above a given temperature (e.g., a pre-defined minimum operating temperature limit, such as, for example, at least about 300 °C, 350 °C, 400 °C, 450 °C, 475 °C, 500 °C, 550 °C, or 600 °C) without the need to add heat to the system. Thus, a robust system design of a high temperature battery may include over-insulating the system and performing activated passive cooling. Such a system configuration may enable more efficient operation during periods of inactivity and/or during less regular/intense use, and enable efficient operation when operated normally (e.g., as intended during periods of activity when cells are charging or discharging and/or during regular/intense use). Over-insulation and activated passive cooling may in some cases be more efficient (e.g., most advantageously employed) during periods when the system is used less regularly or less intensely.

The thermal management system may need to dissipate heat generated during charging and/or discharging (e.g., using active cooling or activated passive cooling) to prevent over-heating (e.g., especially since the system may be insulated). For example, the thermal management system can be configured to dissipate heat generated during normal/regular charging and/or during higher power discharging. In some cases, heat can be added to the system using heaters to keep the system above a minimum operating temperature during periods of resting and/or low intensity operation (e.g., operating at low rates of charging and/or discharging).

### Thermal Management Via Frames

The thermal management system may be implemented with the aid of one or more structural members of the device configured as conduits for cooling. In some cases, the thermal management system may be implemented with the aid of one or more frames on the device. Described herein are examples of frame structures that comprise conduit(s) for thermal management in elevated or high temperatures devices, such as, for example, high temperature batteries.

An energy storage system of the disclosure can include a frame supporting at least a portion of a plurality of electrochemical cells. The frame can have one or more fluid flow paths for bringing a thermal management fluid in thermal communication with at least a subset of the plurality of electrochemical cells. The thermal management fluid can be any suitable fluid, including but not limited to air, purified/cleaned air, a gas (e.g., helium, argon, supercritical CO₂), oil, water, molten salt, or steam. Examples of gases are argon or nitrogen. In some cases, ambient air may be used. In some cases, the thermal management fluid has a high heat capacity.

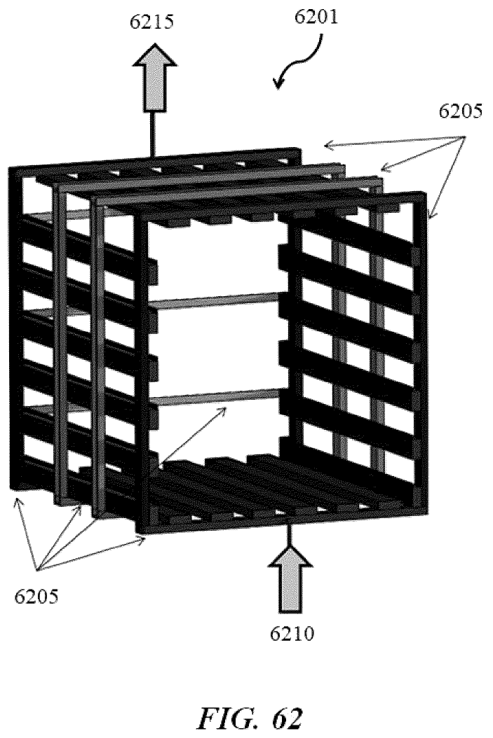

FIG. 62 shows an example of thermal management fluid being passed through a frame 6201 structure of an energy storage device such as, for example, a battery (e.g., a liquid metal battery). The frame may have one or more functions (e.g., multiple critical functions) (with) in the device or (with) in a system comprising the device. Examples of such function(s) include, but are not limited to: (i) providing mechanical support to the cells and/or groups of cells (e.g., modules, packs, and/or cores) within the device/system, (ii) ensuring cells or groups of cells do not directly short to one another or short to grounded connections, (iii) maintaining electrical isolation between cells and/or groups of cells (e.g., modules and/or packs) and other non-electrically active structural members, and/or (iv) providing a path for thermal management fluid to flow to aid in thermal management of the battery (or battery system). In some cases, the frame 6201 can comprise (e.g., be made of) frame elements 6205 (e.g., pieces of the frame that can be joined together to make the frame). The frame elements 6205 can comprise, for example, tubes, pipes, or enclosed trusses. The frame elements can be welded together. In some cases, the frame 6201 can be integrally formed. In some cases, the frame 6201 and/or portion(s) thereof can be joined with other frame(s) in the device/system. In some cases, thermal management fluid flow pathways may be welded or otherwise connected or joined to one or more portions of the frame structure. For example, external tubing may be joined to one or more fluid inlets or outlets on the frame 6201 or on individual frame element(s) 6205). The fluid inlet(s)/outlet(s) may be in fluid communication with fluid flow conduits in frame or frame element(s).

The frame can be of any suitable size or shape. In some cases, the frame is a rectangular box, e.g., comprising any number of vertical and horizontal frame elements 6205 as shown in FIG. 62. The frame can mechanically and/or structurally support the electrochemical cells in a series and/or parallel configuration. In some cases, the frame partitions the electrochemical cells into subsets having any number of cells (e.g., groups of cells as described elsewhere herein). The electrochemical cells within a subset can be connected in parallel and/or series. Further, as described in greater detail elsewhere herein, the frame can be joined and/or otherwise connected with other frame(s). For example, groups of cells can comprise (and/or be contained within or supported by) frames, and the frames can be used to assemble the groups of cells into larger units. The assembly may include joining of fluid conduits in adjacent frames.

The frame (or any portion thereof) may be configured to interface with thermal insulation. In some implementations, the frame can comprise one or more specific areas or portions that act as tethering or harnessing locations for thermal insulation mounting. In some instances, thermal insulation may be attached to the frame through rigid metallic connections that may be permanently connected (e.g., welded or bonded) to the frame (or any portion thereof). In other instances, thermal insulation may be connected to the frame such that the connection points are removable or replaceable (e.g., to facilitate service access or periodic replacement). Thermal insulation may be assembled to the frame such that the insulation region of the assembly (e.g., a region comprising the thermal insulation and/or conduits or connections passing through the thermal insulation) does not create a direct thermal pathway between thermally insulated regions (e.g., region comprising a thermal chamber of the device, or a thermally maintained zone of the system) of the assembly, and non-insulated regions of the assembly and/or the surrounding environment.

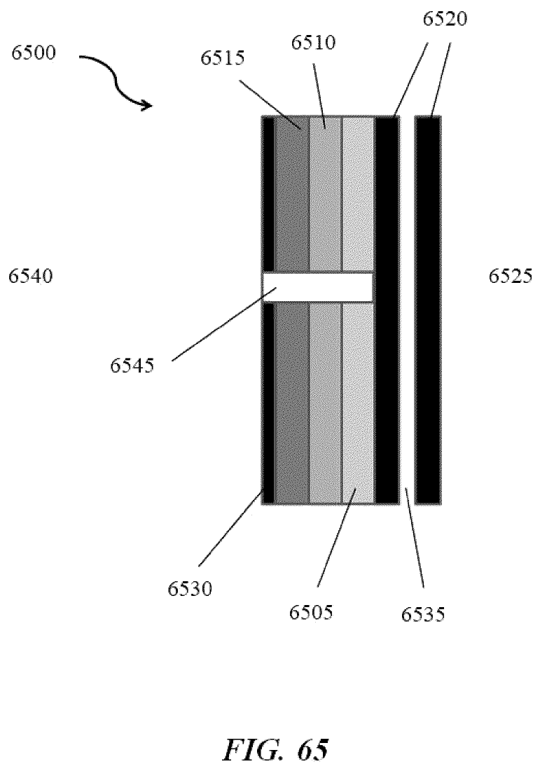

Implementations of the insulation may include configurations with multiple layers (see, for example, FIG. 65). For example, a thermal insulation structure (e.g., such as the portion of thermal insulation 6500 in FIG. 65) may comprise at least about 1, 2, 3, 4, 5, 6, 7, 8, 9, 10, 12, 14, 16, 18, 20, 25, 30, 35, or 40 layers. The layers (or any subset thereof) may be formed of same, similar (e.g., comprising chemically similar materials, or comprising blends comprising at least about 10% 40%, 50%, 60%, 70%, 80% or 90% of a common material) or different materials. In some cases, at least about, about, or less than about 5%, 10%, 15%, 20%, 25%, 30%, 35%, 40%, 45%, 50%, 55%, 60%, 65%, 70%, 75%, 80%, 85%, 90%, 95% or 100% of the layers in a given thermal insulation structure are same or similar. In some cases, the layering may aid the thermal insulation performance. For example, thin sheets of air or bonding material between layers may create additional insulating interfaces.

The frame can comprise a chamber that contains at least a subset of the plurality of electrochemical cells. The frame or chamber can contain any number of electrochemical cells (e.g., 1, 2, 3, 4, 5, 6, 7, 8, 9, 10, 11, 12, 13, 14, 15, 16, 17, 18, 19, 20, or more). In some cases, the frame or chamber contains at least about 5, at least about 10, at least about 20, at least about 30, at least about 40, at least about 50, at least about 60, at least about 80, at least about 100, at least about 200, at least about 300, at least about 400, at least about 500, at least about 600, or at least about 700 electrochemical cells. The chamber can be a thermal chamber. In some cases, the frame or chamber can comprise multiple thermal chambers.

With continued reference to FIG. 62, the frame can comprise one or a plurality of fluid flow paths. In some implementations, the fluid flow paths may be parallel. For example, a plurality of parallel fluid flow paths may be provided. At least a portion of the fluid flow paths may be separately controllable (e.g., by a control system of the disclosure). Such control may include opening/closing of one or more flow paths, control or maintenance of flow rate(s), control or maintenance of fluid temperature, etc. For example, a fluid flow rate (e.g., mass flow rate, volumetric flow rate) through at least two of the parallel fluid flow paths can be separately controllable. The thermal management fluid can enter fluid flow paths, e.g., at 6210, through one or more openings. The fluid can then flow through the frame through any number of (e.g., orthogonal, parallel) fluid flow paths 6205. An individual fluid flow path may have a cross-sectional geometry that is circular, square, rectangular, oval, or any other suitable shape. The fluid flow path may have a cross sectional area of less than about 0.1 cm², less than about 0.5 cm², less than about 1 cm², less than about 2 cm², less than about 5 cm², less than about 10 cm², less than about 20 cm², less than about 50 cm², or less than about 100 cm². The fluid can exit the fluid flow paths, e.g., at 6215, through one or more openings. In an alternative configuration, the fluid can enter the frame at 6215 and exit at 6210. Further, the fluid can alternatively or additionally enter and/or exit the frame on any face or boundary of the frame (e.g., on a face perpendicular or adjacent to the faces/boundaries comprising the inlet/outlet 6210 or 6215). In some cases, the thermal management fluid enters the frame through a first opening, is divided into a plurality of fluid flow paths, and exits through a second opening. In some cases, the thermal management fluid enters the frame through two or more distinct openings. The thermal management fluid may flow through distinct thermal flow paths (e.g., each in fluid communication with one or more distinct openings, such as, for example, a distinct inlet and/or a distinct outlet) that separate the fluid in each path, thus enabling the system to separately control fluid flow rate through each path (e.g., each controlled by their own fluid flow control actuator, such as, for example, a life-gate or valve). Such fluid control may be implemented with the aid of control systems (e.g., system 8300 in FIG. 83) configured to implement methods of the disclosure.

In some cases, the thermal management fluid does not contact the electrochemical cells (e.g., the thermal management fluid can be retained within the frame elements). The frame can be made from any suitable material including plastic, aluminum, steel or stainless steel. The frame can be resistant to corrosion. In some cases, the frame contacts the thermal management fluid and is chemically resistant to the thermal management fluid. The disclosure allows for multiple uses (“multi-use”) of the frame, including, for example, direct contact with the middle of a hot zone to absorb heat (e.g., pull heat away) from the hottest point in the device/system. In some cases, the thermal management fluid does not come in contact with cells (e.g., thereby increasing cell life and reducing system complexity). The frame can be chemically resistant to reactive materials (e.g., reactive metals), such as, for example, reactive metals used in the electrochemical cells (e.g., so that the frame can maintain its structure should one of the electrochemical cells leak).

The frame can have a feature or characteristic (e.g., geometric feature) that selectively accelerates heat transfer (e.g., the thickness or composition of the frame elements and/or the cross-sectional area or diameter of fluid flow path(s) can be different to allow more or less heat to pass between the electrochemical cells and the thermal management fluid). For example, a dimension of the frame (e.g., thickness, cross-sectional area or diameter of a fluid flow path in the frame, or thermal mass of the frame as a whole), or a portion thereof, can be configured to selectively accelerate heat transfer (e.g., in accordance with location of the frame or frame portion within the system). Various geometric features may enable various configurations of thermal management fluid routing. In some cases, the fluid flow path may be routed between cells or groups of cells (e.g., between packs) to permit selective removal of heat from the system. In some cases, the fluid may be routed directly onto one or more cell housings (or portions thereof) or onto frames, interconnections, or other structural or heat transfer members associated with individual cells or groups of cells. In some cases, the fluid may be routed via a duct, tubing, fins, or other heat transfer members in contact with one or more cell housings (or portions thereof) or in contact with frames, interconnections, or other structural or heat transfer members associated with individual cells or groups of cells.

The system can be insulated. In some cases, thermal insulation surrounds the frame (or frame elements) and/or is provided on the inside of fluid flow channel(s). Thermal insulation inside of a fluid flow channel can provide thermal insulation between the thermal transfer fluid (also “thermal management fluid” herein) and one or more structural portions of the fluid flow channel (e.g., stainless steel frame). The insulation can be distributed in a manner that facilitates thermal management of the system. An amount (e.g., volume, mass, thickness, total insulating capability, etc.) of thermal insulation at or in proximity to (e.g., facing) the center of the system/device and/or frame (e.g., at or in proximity to a heated zone) may be less than an amount of thermal insulation at or in proximity to the periphery of the system/device and/or frame (e.g., not at or not in proximity to a heated zone, or facing away from the center). For example, the system may comprise insulation along at least a portion of a fluid flow path to aid in removal of heat from a predetermined location within the system. The amount of insulation along any given portion may vary in accordance with location. For example, least amount of insulation may be provided in a location that is in proximity or adjacent to a heated zone (e.g., the insulation is thinner in a portion of the fluid flow path adjacent a heated zone of the system, and/or the insulation is thinner in a portion of the fluid flow path that is in the proximity of or adjacent to the center of the heated zone, and/or the insulation is thinner in a portion of the fluid flow path that is in the proximity of or adjacent to a specific group of cells).

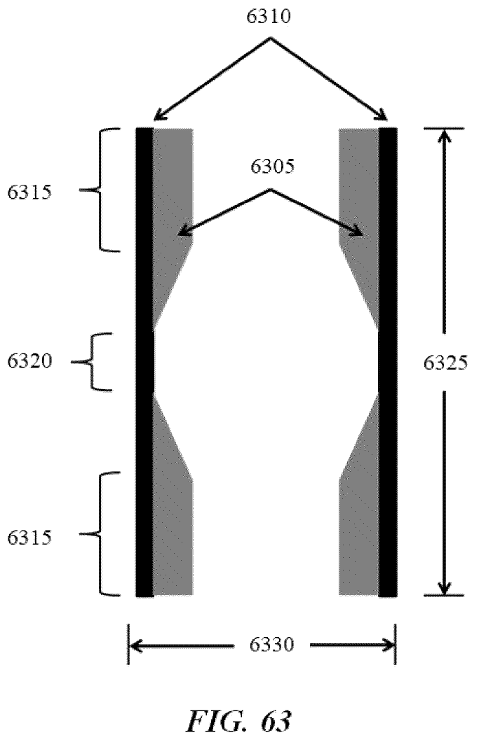

FIG. 63 is an example of a distribution of insulation configured to evacuate more heat from the hotter portions of the system than from less hot portions of the system. As shown, an insulation insert 6305 can be placed into box tubing 6310 (having a height (or length) 6325 and a width 6330) to allow more insulation along top and bottom regions 6315 of the inside of the tube and less insulation in a central region 6320 (e.g., in the event that there is a thermal gradient across the length (or height or width) of any thermal management fluid flow pathway). In some examples, flow paths or channels can be lined with insulation to selectively extract heat from specific locations in the device/system (e.g., the core) to decrease or minimize thermal gradients within the device/system, or across a portion of the device/system (e.g., a pack).

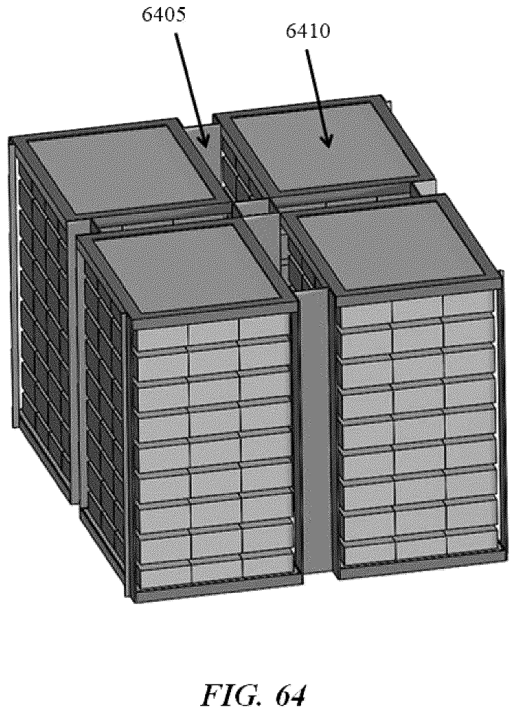

In some cases, the system includes ducting. With reference to FIG. 64, the ducting 6405 can be located between groups of electrochemical cells 6410 (e.g., enclosed by a frame). Thermal management fluid can be passed through the ducting (e.g., in addition to or instead of passing thermal management fluid through the frame). The thermal management fluid that is passed through the frame elements can be the same or different than the fluid that is passed through the ducting. Additional ducting can be added along the edges or the gaps or to pass through the insulation. In some examples, 1, 2, 3, 4, 5, 6, 7, 8, 9, 10, 12, 14, 15, 16, 18, 20 or more horizontal, vertical, spiral-shaped, winding and/or other ducts may be provided.

Fluid ducts, fluid flow paths (e.g., high capacity flow paths and low capacity capillaries) and direct fluid contact interfaces can form a hierarchy of heat transfer components/interfaces of various sizes and capacities (e.g., heat transfer capacities, as determined by fluid flow rate, fluid type, cell housing material, duct material, fluid flow path material, and so on. Different types of heat transfer components may be suited for different regions or situations (e.g., size of flow path and/or duct may be configured in accordance with a difference in temperature between the fluid and the cell(s), or a suitable configuration may be selected based on operating temperature).

The system can further include a fluid flow system that is configured and arranged to direct the thermal management fluid through the one or more fluid flow paths of the frame and/or ducting. The fluid flow system can include a pump, a fan, a blower, and/or any other suitable device for moving the thermal management fluid. The device used to direct fluid flow can be placed in a cool zone near the inlet of the fluid flow path, near the outlet of the fluid flow path, or inside the hot zone of the system and within or peripheral to the fluid flow path. In some cases, the fluid flow system can include multiple pumps, fans, blowers, and/or any other suitable device for moving the thermal management fluid through separate fluid flow channels or paths. For example, a pump or a fan can be provided for each separate fluid flow path. In another example, fluid may be moved through multiple (e.g., parallel) fluid flow paths that are in fluid communication with each other by a pump or a fan provided in or at one of the flow paths; fluid movement through the remaining flow paths may result from the Venturi effect. In some cases, the fluid may be pre-treated (e.g., pre-heated) to prevent thermal shock to the system prior to allowing the fluid to flow in (e.g., prior to admitting the fluid into) the fluid flow (e.g., cooling) pathways.

In some examples, the fluid flow system can provide separate thermal control over specific or different areas within the hot zone of the system (e.g., the system may comprise 1, 2, 3, 4, 5, 6, 7, 8, 9, 10, 12, 14, 16, 18, 20, 25, 30, 35, 40, 50 or more separate control zones). In some cases, the fluid flow channels can be configured for performing targeted thermal management (e.g., cooling) of one or more specific groups of cells (e.g., packs, or a set of packs). Providing thermal control over specific areas within the hot zone may enable the thermal management/control system to make the overall system (e.g., the battery and/or the system comprising the battery) more isothermal, thereby decreasing or minimizing stresses on the system that may occur due to the existence of and shifting of thermal gradients within the system.

In some implementations, the fluid flow system operates at all times. For example, if the flow is stopped completely, the fan (an example of a component of a fluid flow system) and/or other component(s) of the fluid flow system can overheat and/or melt (e.g., therefore requiring a fan rated for a 550 °C environment). The system may therefore maintain a low volume air flow during idle periods as a buffer (e.g., at the bottom of the device or system (e.g., the core)) to create a slight positive pressure (or over-pressure) inside the fluid flow (e.g., cooling) paths or tubes, thereby minimizing heat loss through the bottom (or a given surface) of the system and ensuring that the fan (and/or other component(s) of the fluid flow system) remains cool enough (e.g., stays within a specified low temperature zone, or below a given maximum or rated temperature). In some cases, the low volume air flow is provided by the fan.

In some implementations, the fluid flow system operates passively (e.g., without the need for fans, blowers, or pumps to actively force fluid through the fluid flow paths). The movement of thermal management fluid through the device or system can be driven primarily by natural convection. For example, the system may comprise a valve, damper or ‘lift-gate’ component at the inlet and/or outlet of a fluid flow path that can allow gas or air to flow into and/or out of the heated system cavity (e.g., thermal chamber). This convective flow process can drive hot air up and out a fluid flow path (e.g., like a chimney) by utilizing the phenomenon where hot air (or gas) rises and pulls cooler air (or gas) toward the fluid flow chamber. In some cases, natural convection is enabled and/or enhanced by positioning an inlet of the fluid flow path (e.g., the position where the fluid flow path transitions from ambient temperature, external environment into the hot zone of the system) near the bottom of the heated zone (also “hot zone” herein) and by positioning an exit of the fluid flow path near the top of the heated zone.

In some examples, the fluid flow system is configured or programmed to provide the thermal management fluid at an adjustable flow rate that is selected to maintain the temperature of the system or a portion of the system at the operating temperature (e.g., between about 150 °C and 750 °C, or between about 450 °C and 550 °C). The fluid flow system may be controlled by one or more computers or processors of (or in communication with) a management/control system (e.g., the fluid flow system may be controlled by a thermal management/control system). In some examples, the thermal management system and the fluid flow system are controlled by redundant computers or processors to increase overall system reliability.

The fluid flow system may be configured or programmed to provide thermal management fluid to rapidly cool the at least a portion of the system or the whole system (e.g., the energy storage device or system). Rapid cooling may be required and/or desired in case of an emergency or catastrophic event (e.g., a catastrophic leak of cell active components, a fire, an earthquake, a flood, etc.) or in case of a scheduled or unscheduled maintenance procedure (e.g., to replace a failing cell or cell pack, a management/control system board and/or other system component). For example, rapid cooling may be used upon failure or breach of one or more cells in the system/device (e.g., leading to lost hermeticity). Such a failure or breach may be detected by a control system configured to provide thermal management. In some cases, a cell breach may be small and may result in a gradual degradation of cell and/or battery performance over many days or weeks (e.g., 1, 2, 5, 10, 15 or 20 days or weeks). In other cases, a cell breach may result in an immediate (e.g., within less than about 1, 5, 10, 30, 40, 50 or 60 seconds, within less than about 1, 2, 5, 10, 20, 30, 40 or 50 minutes, within less than about 1, 2, 3, 4, 6, 8, 10, 12, 16 or 20 hours, or within less than about one day) degradation in cell and/or battery performance and the system may need to immediately stop charging and/or discharging. In the case of an immediate cell and/or battery performance degradation due to a cell breach, an emergency cooling procedure may be initiated, such as, for example, turning on one or more fans/blowers and/or opening valves/lift-gates to accelerate the cool-down process. The fans/blowers in a thermal management system may in some cases only be initiated during an emergency cool-down procedure. In some cases, the rapid cooling may only be initiated when the temperature of the system is above a given temperature (e.g., a critical (safety) temperature), such as, for example, the freezing point of the electrolyte (e.g., molten salts) and/or electrodes (e.g., liquid metals), or above the flammability temperature of a specific active cell material. In some examples, a critical temperature is greater than about, or about, 550 °C, 500 °C, 450 °C, 400 °C, 350 °C, 300 °C, 250 °C, 200 °C, 150 °C or 100 °C. Rapid cooling may include increasing a flow rate of thermal management fluid in one or more fluid flow paths of the system. The flow rate may be controlled selectively. At least a portion of such flow paths may be adjacent to a portion of the system for which a failure or emergency condition is detected (e.g., a failed cell).

An emergency cool-down process may comprise a rapid cool-down procedure. Such a procedure (or method) may be initiated and/or controlled by a control system. The method may be used to rapidly cool at least a portion of the energy storage system in response to a potentially hazardous event (e.g., earthquake and/or cell breach). The method may be performed when the system is at a given condition, such as, for example, when the system (or a portion thereof) is at or above (e.g., at least about 5 °C, 10 °C, 20 °C, 50 °C or 100 °C above) a given operating temperature (e.g., any operating temperature herein), or at or above (e.g., at least about 5 °C, 10 °C, 20 °C, 50 °C or 100 °C above) a given critical temperature (e.g., a critical freezing temperature). Upon rapidly cooling, a temperature of the system, device, or a portion thereof (e.g., at least one of the electrochemical cells in a battery) may decrease below a given threshold. In an example, the temperature of at least one of the electrochemical cells may decrease below a freezing point of one or more cell components (e.g., a hottest of a plurality of electrochemical cells can decrease from its operating temperature to a temperature below a freezing point of the electrolyte). The decrease in temperature may be achieved within a given time period (“time to cool down”). For example, the cooling may be achieved in less than about 5 seconds, 10 seconds, 30 seconds, 45 seconds, 1 minute, 2 minutes, 5 minutes, 10 minutes, 20 minutes, 30 minutes, 45 minutes, 60 minutes, 1 hour, 2 hours, 3 hours, 4 hours, 5 hours, 6 hours, 7 hours, 8 hours, 9 hours, 10 hours, 12 hours, 14 hours, 16 hours, 18 hours, 20 hours, 22 hours, 24 hours, 30 hours, 36 hours, 42 hours, or 48 hours. In an example, a hottest of the plurality of electrochemical cells can decrease from its operating temperature to a temperature below a freezing point of the electrolyte in less than about 4 hours.

At least a portion of the heat that is removed from the system can be rejected (e.g., lost) to the atmosphere or environment. In some cases, at least a portion of the heat that is removed from the system can be stored or used in another application (e.g., to heat homes or industrial processes through co-generation, or to prevent electronics from being chilled). In some implementations, a system comprising a circulatory fluid flow system that is configured to store thermal energy can be provided. One or more fluid flow paths (e.g., of the device) can be in fluid communication with a fluid flow path of the circulatory fluid flow system. The circulatory fluid flow system can comprise a thermal energy storage medium. The thermal energy storage medium can comprise any suitable material including, but not limited to, molten salt (e.g., any molten salt described herein), gravel, sand, steam or water. The thermal energy storage medium may be stored in a storage reservoir. In some cases, the thermal energy storage medium can be the thermal management fluid.

### Insulation and Thermal Barriers

At least a portion of components of an energy storage device or system (e.g., electrochemical cells, groups of cells such as packs, and frames) may be thermally isolated from other room-temperature components of the energy storage device or system through thermal insulation boundaries. Thermal insulation can aid in defining thermal barrier(s) that allow one side of a thermal boundary (e.g., thermal boundary comprising the thermal barrier(s)) to be maintained at or above a temperature suitable (e.g., required) for cell operation (e.g., hot zone), while the other side of the thermal boundary can be maintained closer to room temperature or ambient temperature conditions (e.g., cool zone).

Thermal insulation may comprise materials with known (e.g., high) impedance for heat transfer (also “thermal impedance” herein). Such materials may be packaged in sheets, tiles, wraps, tapes or other (e.g., similar) form factors such that they may be packaged around the high temperature zone (also “hot zone” herein). As previously described with reference to FIG. 12, in some cases, different layers of thermal insulation may be used in the same assembly (e.g., assembly comprising thermal insulation assembled to a frame). For example, one layer may utilize a thermal insulator with a first thermal impedance and subsequent layers may comprise materials with one or more different thermal impedances (e.g., a second thermal impedance, a third thermal impedance, and so on). The thermal insulation may comprise a set or package of components. The thermal insulation package can comprise one or more layers of thermal insulation (e.g., one or more layers of insulating material). In some examples, removable and/or replaceable components (e.g., tiles) may be incorporated into the thermal insulation layers. In some examples, layers that can be displaced by motor or servo drives may be included in or incorporated into the thermal insulation package and may be used to help manage the temperature of the system. For example, a control system may activate an actuator (e.g., motor or servo drive) to change the position or configuration of one or more portions of the thermal insulation package to change (e.g., decrease) the thermal insulating property of the thermal insulation package, thereby increasing, maintaining, or decreasing the rate of heat loss from the system. Such a process may be controlled by a control system and may be part of the thermal management control of the system.

Thermal insulation may have dedicated areas or portions (“pass-throughs”) through which wires, sensors and/or high current/voltage (e.g., cell current or voltage) connections, collectively referred to as “connections” herein, can pass in order to connect electrochemical cells (e.g., inside the thermal insulation) to other components in the energy storage system (e.g., outside the thermal insulation). For example, pass-throughs may carry wires and/or sensors that are in communication with a management/control system (e.g., system 8300 in FIG. 83). Such sensors may include, for example, one or more temperature sensors placed in or in thermal communication with the hot zone of the system. In some examples, pass-throughs carry only voltage (e.g., low voltage) sense wires. The voltage sense wires may be designed to handle (e.g., withstand) only small amounts of current (e.g., less than about 10 milli-amperes (mA) or less than about 1 mA). In some examples, pass-throughs carry voltage sense wires and/or wires for distributing current to/from cells. In some examples, pass-throughs carry high current and/or high voltage wires to busbars. Pass-throughs may have a cross-section that is, for example, circular, rectangular, square, oval, or polygonal. Such pass-throughs may have a cross-section area of greater than about 0.0001 square centimeters (cm²), greater than about 0.001 cm², greater than about 0.01 cm², greater than about 0.1 cm², greater than about 1 cm² or greater than about 10 cm²).

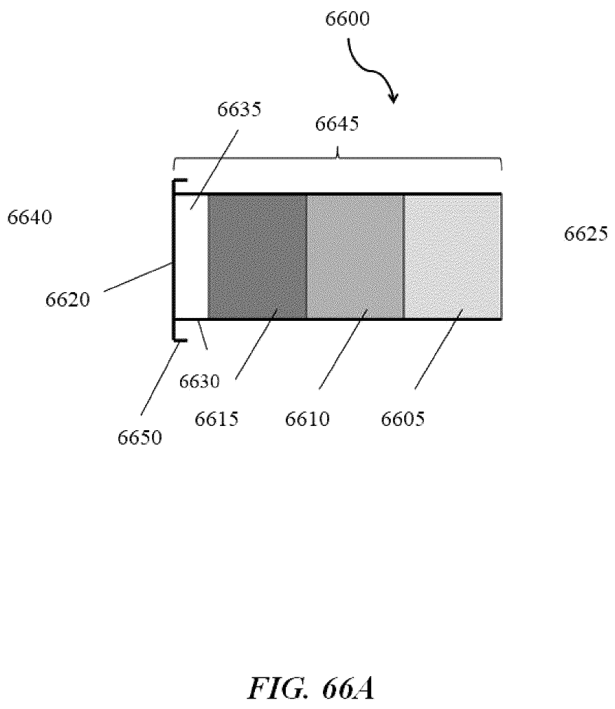

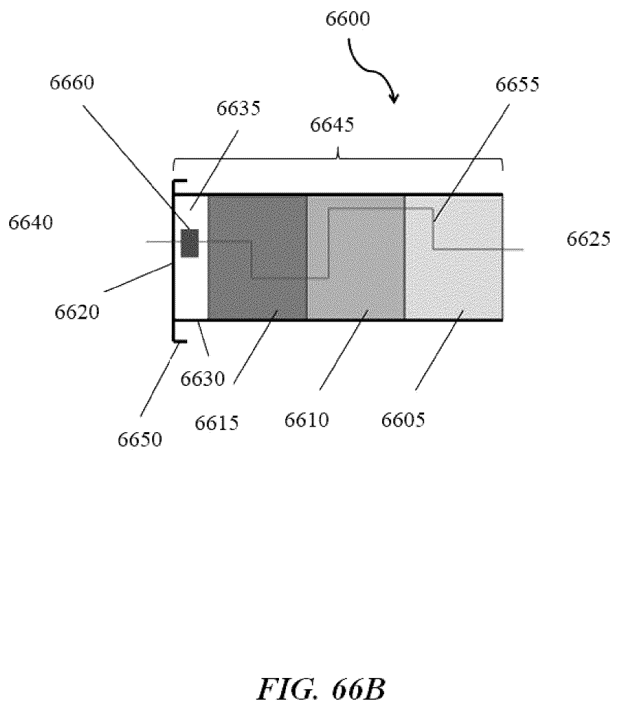

FIG. 66 is an example of a thermal insulation structure portion 6600 that comprises a first insulation layer 6605, a second insulation layer 6610 and a third insulation layer 6615. A first surface of the first insulation layer 6605 can contact or be positioned adjacent a frame (or frame element(s)) 6620 in (or adjacent to) a hot (e.g., inside) zone 6625. The frame 6620 can comprise a flow path (e.g., air flow path) 6635. A second surface of the first insulation layer 6605 can contact or be positioned adjacent a first surface of the second insulation layer 6610. A second surface of the second insulation layer 6610 can contact or be positioned adjacent to a first surface of the third insulation layer 6615. A second surface of the third insulation layer 6615 can contact or be positioned adjacent an outer skin 6630. The outer skin 6630 may face a cold or cool (e.g., outside) zone 6640. Thermal insulation of devices herein may in some cases comprise at least about 1, 2, 1, 2, 3, 4, 5, 6, 7, 8, 9, 10, 12, 14, 16, 18, 20, 22, 24, 26, 28, 30, 35, 40, 45, 50, 75 or 100 thermal insulation structure portions (e.g., such as the structure portion 6600).

A pass-through (e.g., high thermal efficiency pass-through) 6645 provides a conduit from the first surface of the layer 6605, through the layer 6605, through the layer 6610, through the layer 6615, through the outer skin 6630 to the cold/cool zone 6640. Wires, sensors and/or high current/voltage connections (not shown) may be passed from the hot zone/side 6625 to the cold/cool zone/side 6640.

A pass-through may be thermally efficient to limit or prevent excessive heat loss through it. In some cases, the pass-through can be filled with material(s) with high thermal impedance to limit or decrease heat transfer from the hot zone of the system to other lower temperature areas (e.g., to one or more cool zones). The filling material may be homogenous (e.g., one material fills the entire pass-through) or heterogeneous (e.g., two or more different materials are used as fillers in one pass-through). In some cases, the pass-through can comprise one or more plugs and/or one or more end-caps that may limit or decrease heat transfer through the pass-through. Plug(s) and/or end cap(s) may encapsulate material with high thermal impedance within the pass-through structure. In some examples, the entire pass-through structure can be mounted on a tile (or sheet, wrap, tape, etc.) of thermal insulation such that the tile (or sheet, wrap, tape, etc.) may be removed along with the pass-through as part of service or repair.

FIG. 66A is an example of a pass-through 6600 that comprises an end cap 6620. The pass-through 6600 can be surrounded by insulation layers 6605, 6610 and 6615. Alternatively, the pass-through 6600 can comprise (e.g., be filled with) filler materials 6605, 6610 and 6615. The pass-through may comprise an electrically conductive component (not shown), such as, for example, voltage sense wire(s), high current carrying wire(s), or wire(s) associated with thermal measurement (e.g., thermocouple wires). The insulation layers or filler materials 6605, 6610 and 6615 may be disposed between a hot zone 6625 and a cold (e.g., room temperature) zone 6640. The end cap 6620 may be attached to a wall or boundary 6630 of the pass-through. The wall 6630 may or may not extend along the entire length 6645 of the pass-through. In some cases, the wall 6630 may extend beyond the last filler material 6615. In such instances, an air gap 6635 may form between the filler material 6615 and the end cap 6620. In some cases, the pass-through may not comprise the wall 6630, and the end cap 6620 may be attached directly to the last filler material 6615; in such a case, the air gap 6635 may or may not form. The end cap 6620 can comprise one or more flanges 6650.

The wires that transit the pass-through may comprise special materials (e.g., materials that are stable at or above the operating temperature of the system, oxidation-resistant materials, materials that have suitable (e.g., sufficient and/or high) electrical conductivity at the operating temperature of the system), such as, for example, nickel, aluminum, bronze, brass, stainless steel, or any combination thereof. Such materials may limit or decrease heat-induced corrosion on the wires. The wires in the pass-through may transition (e.g., sequentially) from materials that are stable at higher temperatures, to more electrically conducting but less thermally stable materials (e.g., copper). In some examples, the wire in the pass-through comprises at least about 1, 2, 3, 4, 5, 6, 7, 8, 9, 10, 12, 14, 16, 18, 20, 25, 30 or more different sections. The sections may comprise different materials. The sections may be integrally formed, or joined (e.g., welded) together to form a composite wire. In some cases, the materials may be sequentially arranged in order from materials with highest thermal stability (and, in some cases, lower conductivity) in a region of the pass-through adjacent the hot side to materials with highest electrical conductivity (and, in some cases, lower thermal stability) in a region adjacent the cool side.

The pass-through may comprise wires that are built into (e.g., integrally formed with) the pass-through structure. In some cases, different pass-throughs in the system may be designed such that the wire lengths, location of the wires within the pass-through and/or spacing between the wires are the same for the different pass-throughs. In some cases, the pass-through may comprise wires that are floating within the pass-through. In some cases, wires may be cast or set in high thermal impedance material such that wires do not form a straight-line connection between high temperature (e.g., hot) and low temperature (e.g., cold/cool, room temperature) zones of the system. Wires routed in this manner may have excess length incorporated within the pass-through to allow thermal energy conducted by the wires to be released as the wires travel through heterogeneous layers of thermal impedance material within the pass-through. The (actual) length of the wire may be, for example, at least about 1.5 times, at least about 2 times, at least about 5 times, at least about 10 times, at least about 50 times, or at least about 100 times greater than a distance from the hot zone to the cold zone (e.g. length of the pass-through). This may aid with easily and/or safely interconnecting the wires with electronics components, and/or making areas of the system service access/touch safe.

FIG. 66B is another example of the pass-through 6600, further comprising a wire 6655. The wire 6655 (or multiple such wires) may have a circuitous (e.g., zigzag, spiral or helix) pattern or path (through the pass-through) that can prevent a direct thermal opening from the hot zone 6625 to the cold zone 6640. The rate of heat conducted through one or more wires in the pass-through may be related to or depend on one or more of: the temperature difference between the hot zone and the cold zone, the cross-sectional area of the wire(s), the thermal conductivity of the material(s) of the wire(s), and the inverse of the length of the wire(s). In some cases, further reducing the cross-sectional area may result in a mechanically fragile wire that is susceptible to breaking and/or oxidation. To reduce the amount of heat conducted through a wire, the wire may have a length that is significantly longer than the length of the pass-through. Extra wire loops 6660 may increase the length of the wire and reduce the amount of heat that is conducted through the wire. The wire may be configured in a helical coil, such as, for example, a wire that spirals in a circular geometric path from the hot zone to the cold zone. The axis of the helical structural can be about parallel (e.g., substantially parallel) to the direction of the heat flow path from the hot zone to the cold zone. The wire may be configured in other geometries, such as, for example, a helical-type geometry with an oval, square, rectangular, polygon, and/or other cross-sectional shape. The heat dissipation may decrease or prevent coupling of heat to electronics on the cold side (e.g., room temperature zone) 6640.

Pass-throughs may comprise infrared (IR) reflective coatings. The IR coatings may be applied to pass-throughs to limit or decrease heat transfer through IR losses. In some instances, pass-throughs carrying wires may comprise coatings that reduce abrasion on wire insulation (e.g., wire insulating material) in order to prevent loss of wire insulation through chaffing.

### Method for Operating an Energy Storage System

The disclosure provides methods for operating an energy storage system. In some cases, the method includes providing an energy storage system comprising a plurality of electrochemical cells supported by a frame structure. An individual cell of the plurality of electrochemical cells can comprise a negative electrode, an electrolyte and a positive electrode. At least one of the negative electrode, the electrolyte and the positive electrode can be in a liquid state at an operating temperature of the individual electrochemical cell. The frame structure can comprise one or more fluid flow paths for bringing a thermal management fluid in thermal communication with at least a subset of the plurality of electrochemical cells. In some cases, the method includes directing the thermal management fluid through the one or more fluid flow paths.

The method can be performed to achieve any number of objectives. In some cases, directing of the thermal management fluid is performed to maintain a temperature of the individual cell or one or more portions thereof (also “cell parts” herein), a group of cells, or a device or system comprising such cell(s) at the operating temperature (e.g., between about 150 °C and 750 °C). In some cases, directing of the thermal management fluid is performed to increase or maximize the efficiency and/or operating lifetime of the energy storage system.

The thermal management fluid can be directed at a rate that is varied over time. In some examples, the thermal management fluid is directed at a rate that depends on: (a) a temperature of the energy storage system or electrochemical cell thereof; (b) a rate of change of the temperature of the energy storage system or electrochemical cell thereof; (c) whether the energy storage system is charging, discharging or idle; (d) an anticipated future operation of the energy storage system; and/or (e) a current or anticipated market condition. The anticipated future operation of the energy storage system can include the time and extent of future charging, discharging and/or idle operation of the energy storage system. The current or anticipated market conditions can include the price of energy.

The thermal management fluid can be directed through the one or more fluid flow paths with the aid of a fluid flow system in fluid communication with the one or more fluid flow paths. In some examples, the fluid flow system comprises a vent, damper, lift-gate, valve, fan, pump or convection-assisted flow (e.g., forced and/or natural convection).

Heat can be added or removed from the system at any suitable rate. In some cases, directing the thermal management fluid through the one or more fluid flow paths dissipates or adds thermal energy from the plurality of electrochemical cells at a rate of about 1 Watt (W), about 10 W, about 50 W, about 100 W, about 500 W, about 1 kilo-Watt (KW), about 5 kW, about 10 KW, about 50 kW, about 100 KW, about 500 kW, or about 1000 kW. In some examples, directing the thermal management fluid through the one or more fluid flow paths dissipates or adds thermal energy from the plurality of electrochemical cells at a rate of at least about 1 watt (W), at least about 10 W, at least about 50 W, at least about 100 W, at least about 500 W, at least about 1 kilowatt (KW), at least about 5 kW, at least about 10 KW, at least about 50 kW, at least about 100 KW, at least about 500 kW, or at least about 1000 kW. In some examples, directing the thermal management fluid through the one or more fluid flow paths dissipates or adds thermal energy from the plurality of electrochemical cells at a rate of at most about 1 watt (W), at most about 10 W, at most about 50 W, at most about 100 W, at most about 500 W, at most about 1 kilowatt (kW), at most about 5 kW, at most about 10 KW, at most about 50 kW, at most about 100 kW, at most about 500 kW, or at most about 1000 kW.

The temperature of the system or any individual cell thereof can be maintained with any suitable tolerance. In some cases, upon directing the thermal management fluid through the one or more fluid flow paths, the temperature is maintained to within less than about 1 °C, 2 °C, 5 °C, 10 °C, 20 °C, 30 °C, 40 °C, 50 °C, 60 °C, 70 °C, 80 °C, 90 °C, 100 °C, 150 °C, 200 °C, or 250 °C of a target temperature setting. In some cases, the temperature of an individual cell fluctuates by at most about 1 °C, 2 °C, 5 °C, 10 °C, 20 °C, 30 °C, 40 °C, 50 °C, 60 °C, 70 °C, 80 °C, 90 °C, 100 °C, 150 °C, 200 °C, or 250 °C in a time period of 5 hours or less.

### Control Systems, Methods and Algorithms

Provided herein are computer control systems that are programmed to implement methods of the disclosure. Such a control system (also “system” or “management/control system” herein) can comprise a computer programmed to direct a thermal management fluid through one or more fluid flow paths and/or a computer readable medium comprising an algorithm to direct a thermal management fluid through one or more fluid flow paths. Thus, the control system can comprise a thermal management/control system.

In some implementations, the system comprises an energy storage system. The energy storage system can include an electrochemical energy storage device comprising one or more electrochemical energy storage cells. The system (e.g., the energy storage system, the electrochemical energy storage device) can comprise a thermal zone (e.g., hot zone). The thermal zone may contain the electrochemical energy storage cells. The system can further comprise a computer system coupled to the device. The computer system can regulate the charging and/or discharging of the device, thermally manage the device, or a combination thereof. The computer system (e.g., controller) can monitor one or more the electrochemical cells of the system/device a condition indicative of a failure (e.g., breach in a seal of an electrochemical cell of the electrochemical energy storage device). Such a failure or breach condition may be used by the computer system to trigger a thermal management response. The computer system can include one or more computer processors and a memory location coupled to the computer processor. The memory location comprises machine-executable code that, upon execution by the computer processor, implements any of the methods above or elsewhere herein. The computer system (e.g., computer processor, memory and/or other components of the computer system) are not in the thermal zone. The computer system May electronically communicate with the thermal zone (e.g., via wires, sensors and/or high current/voltage (e.g., cell current or voltage) connections). In some cases, the computer system may electronically communicate with one or more components in the thermal (e.g., hot) zone. For example, one or more temperature sensors (e.g., for monitoring one or more electrochemical cells, or for monitoring one or more groups of electrochemical cells) may be placed in in the hot zone of the system, and may provide measurement data to the computer system outside of the hot zone. The temperature sensor(s) can be in electronic communication with, for example, the computer processor.

In some implementations, the system comprises a plurality of electrochemical cells supported by a frame structure. An individual cell of the plurality of electrochemical cells can comprise a negative electrode, an electrolyte and a positive electrode. At least one, two, or all of the negative electrode, the electrolyte and the positive electrode can be in a liquid state at an operating temperature of the individual electrochemical cell. The frame structure can comprise the one or more fluid flow paths for bringing the thermal management fluid in thermal communication with at least a subset of the plurality of electrochemical cells.

The thermal management fluid can be directed at a rate that is varied over time for any suitable purpose. In some examples, the directing of the thermal management fluid is performed to maintain a temperature of the individual cell, or cell parts, at the operating temperature. In some examples, the directing of the thermal management fluid is performed to increase or maximize efficiency and/or operating lifetime of the energy storage system. As described in greater detail elsewhere herein, the rate can depend on, for example, a temperature of the energy storage system or electrochemical cell thereof, a rate of change of the temperature of the energy storage system or electrochemical cell thereof, whether the energy storage system is charging, discharging or idle, an anticipated future operation of the energy storage system, a current or anticipated market condition, or any combination thereof.

A group of cells (e.g., a core, a CE, a system, etc.) with a given energy capacity and power capacity (e.g., a CE or a system capable of storing a given amount of energy) may be configured to deliver at least about 10%, at least about 20%, at least about 30%, at least about 40%, at least about 50%, at least about 60%, at least about 70%, at least about 80%, at least about 90%, at least about 95%, or about 100% of a given (e.g., rated) power level. For example, a 1000 kW system may be capable of also operating at 500 kW, but a 500 kW system may not be able to operate at 1000 kW. In some cases, a system with a given energy capacity and power capacity (e.g., a CE or a system capable of storing a given amount of energy) may be configured to deliver less than about 100%, less than about 110%, less than about 125%, less than about 150%, less than about 175%, or less than about 200% of a given (e.g., rated) power level, and the like. For example, the system may be configured to provide more than its rated power capacity for a period of time that is less than the time it may take to consume its energy capacity at the power level that is being provided (e.g., provide power that is greater than the rated power of the system for a period of time corresponding to less than about 1%, less than about 10% or less than about 50% of its rated energy capacity).

### Seals for High-Temperature Devices

An aspect of the present disclosure provides a seal for a high-temperature device. The device can be a high temperature reactive material device that contains/comprises one or more reactive materials. For example, the high-temperature device can contain a reactive material. In some cases, the device can be a high-temperature reactive metal device. The device can be, without limitation, for the production and/or handling of a reactive material, such as, for example, a reactive metal (e.g., lithium or sodium) and/or a chemical with a strong chemical reducing capability (e.g., reactive chemical), for semiconductor manufacturing, for a nuclear reactor (e.g., nuclear fusion reactor, nuclear reactor that uses a molten salt or metal, such as, for example, molten sodium or lithium or molten sodium- or lithium-containing alloys, as a coolant), for a heterogeneous reactor, for a chemical processing device, for a chemical transportation device, for a chemical storage device, or for a battery (e.g., a liquid metal battery). For instance, some batteries operate at high temperatures (e.g., at least about 100 °C or 300 °C) and have reactive metal vapors (e.g., lithium, sodium, potassium, magnesium, or calcium) that may need to be sufficiently contained within the battery. In some examples, such high-temperature devices operate, are heated to and/or maintained at a temperature of at least about 100 °C, 150 °C, 200 °C, 250 °C, 300 °C, 350 °C, 400 °C, 450 °C, 500 °C, 550 °C, 600 °C, 650 °C, 700 °C, 750 °C, 800 °C, 850 °C, 900 °C, or more. At such temperatures, one or more components of the device can be in a liquid (or molten) or vaporized state.

The seal can comprise a ceramic material (e.g., aluminum nitride (AlN)) that is in contact with the reactive material (e.g., a reactive metal or molten salt) contained in the device. The ceramic material can be capable of being chemically resistant to a reactive material (e.g., a reactive material contained in the device, such as, for example, reactive metal or molten salt). The ceramic material can be capable of being chemically resistant to the reactive material when the device operates at a high temperature (e.g., at least about 100 °C, at least about 150 °C, at least about 200 °C, at least about 250 °C, at least about 300 °C, at least about 350 °C, at least about 400 °C, at least about 500 °C, at least about 600 °C, at least about 700 °C, at least about 800 °C, or at least about 900 °C).

The seal can comprise a metal collar or sleeve (e.g., made from stainless steel (SS) or zirconium). A sleeve and/or the collar design can be coefficient of thermal expansion (CTE)-accommodating (e.g., can accommodate differences in CTE (also “CTE mismatch” herein)). In some cases, a sleeve can be a collar. In some cases, a collar can be conical. For example, a collar can be a conical metal (e.g., zirconium) collar. Any aspects of the disclosure described in relation to collars may equally apply to sleeves at least in some configurations, and vice versa.

The seal can comprise an active metal braze disposed between the ceramic material and at least one of the metal collar/sleeve and the device. The active metal braze can comprise a metal species that chemically reduces the ceramic material (e.g., titanium (Ti) or zirconium (Zr)).

In some cases, the seal can surround an electrically conductive feed-through (and can electrically isolate the feed-through from the housing of the device), a thermocouple or a voltage sensor. For example, the ceramic material can be an insulator.

In some examples, the seal may be capable of being chemically resistant to reactive materials in the device at a temperature of at least about 100 °C, at least about 150 °C, at least about 200 °C, at least about 250 °C, at least about 300 °C, at least about 350 °C, at least about 400 °C, at least about 500 °C, at least about 600 °C, at least about 700 °C, at least about 800 °C, or at least about 900 °C. In some examples the seal may be capable of being chemically resistant to reactive materials at such temperatures for at least about 6 months, 1 year, 2 years, 5 years, 10 years, or more. In some examples, the device can be a high-temperature reactive metal device, and the seal can be capable of being chemically resistant to materials in the device that comprise the reactive metal. In an example, the seal is capable of being resistant to lithium vapor at a temperature of at least about 350 °C for at least about one year. The seal can retain the reactive material (e.g., vapors of the reactive material) in the device. For example, the seal can retain reactive metal vapors and/or molten salt vapors in the device.

### Electrochemical Cells, Devices and Systems

The present disclosure provides electrochemical energy storage devices (e.g., batteries) and systems. An electrochemical energy storage device generally includes at least one electrochemical cell, also “cell” and “battery cell” herein, sealed (e.g., hermetically sealed) within a housing. A cell can be configured to deliver electrical energy (e.g., electrons under potential) to a load, such as, for example, an electronic device, another energy storage device or a power grid.

An electrochemical cell of the disclosure can include a negative electrode, an electrolyte adjacent to the negative electrode, and a positive electrode adjacent to the electrolyte. The negative electrode can be separated from the positive electrode by the electrolyte. The negative electrode can be an anode during discharge. The positive electrode can be a cathode during discharge.

In some examples, an electrochemical cell is a liquid metal battery cell. In some examples, a liquid metal battery cell can include a liquid electrolyte arranged between a negative liquid (e.g., molten) metal electrode and a positive liquid (e.g., molten) metal, metalloid and/or non-metal electrode. In some cases, a liquid metal battery cell has a molten alkaline earth metal (e.g., magnesium, calcium) or alkali metal (e.g., lithium, sodium, potassium) negative electrode, an electrolyte, and a molten metal positive electrode. The molten metal positive electrode can include, for example, one or more of tin, lead, bismuth, antimony, tellurium and selenium. For example, the positive electrode can include Pb or a Pb—Sb alloy. The positive electrode can also include one or more transition metals or d-block elements (e.g., Zn, Cd, Hg) alone or in combination with other metals, metalloids or non-metals, such as, for example, a Zn—Sn alloy or Cd—Sn alloy. In some examples, the positive electrode can comprise a metal or metalloid that has only one stable oxidation state (e.g., a metal with a single or singular oxidation state). Any description of a metal or molten metal positive electrode, or a positive electrode, herein may refer to an electrode including one or more of a metal, a metalloid and a non-metal. The positive electrode may contain one or more of the listed examples of materials. In an example, the molten metal positive electrode can include lead and antimony. In some examples, the molten metal positive electrode may include an alkali or alkaline earth metal alloyed in the positive electrode.

In some examples, an electrochemical energy storage device includes a liquid metal negative electrode, a liquid metal positive electrode, and a liquid salt electrolyte separating the liquid metal negative electrode and the liquid metal positive electrode. The negative electrode can include an alkali or alkaline earth metal, such as lithium, sodium, potassium, rubidium, cesium, magnesium, barium, calcium, sodium, or combinations thereof. The positive electrode can include elements selected from transition metals or d-block elements (e.g., Group 12), Group IIIA, IVA, VA and VIA of the periodic table of the elements, such as zinc, cadmium, mercury, aluminum, gallium, indium, silicon, germanium, tin, lead, pnicogens (e.g., arsenic, bismuth and antimony), chalcogens (e.g., sulfur, tellurium and selenium), or combinations thereof. In some examples, the positive electrode comprises a Group 12 element of the periodic table of the elements, such as one or more of zinc (Zn), cadmium (Cd) and mercury (Hg). In some cases, the positive electrode may form a eutectic or off-eutectic mixture (e.g., enabling lower operating temperature of the cell in some cases). In some examples, the positive electrode comprises a first positive electrode species and a second positive electrode species at a ratio (mol-%) of about 20:80, 40:60, 50:50, or 80:20 of the first positive electrode species to the second electrode species. In some examples, the positive electrode comprises Sb and Pb at a ratio (mol-%) of about 20:80, 40:60, 50:50, or 80:20 Sb to Pb. In some examples, the positive electrode comprises between about 20 mol % and 80 mol-% of a first positive electrode species mixed with a second positive electrode species. In some cases, the positive electrode comprises between about 20 mol-% and 80 mol-% Sb (e.g., mixed with Pb). In some cases, the positive electrode comprises between about 20 mol-% and 80 mol-% Pb (e.g., mixed with Sb). In some examples, the positive electrode comprises one or more of Zn, Cd, Hg, or such material(s) in combination with other metals, metalloids or non-metals, such as, for example, a Zn—Sn alloy, Zn—Sn alloy, Cd—Sn alloy, Zn—Pb alloy, Zn—Sb alloy, or Bi. In an example, the positive electrode can comprise 15:85, 50:50, 75:25 or 85:15 mol-% Zn:Sn.

The electrolyte can include a salt (e.g., molten salt), such as an alkali or alkaline earth metal salt. The alkali or alkaline earth metal salt can be a halide, such as a fluoride, chloride, bromide, or iodide of the active alkali or alkaline earth metal, or combinations thereof. In an example, the electrolyte (e.g., in Type 1 or Type 2 chemistries) includes lithium chloride. In some examples, the electrolyte can comprise sodium fluoride (NaF), sodium chloride (NaCl), sodium bromide (NaBr), sodium iodide (Nal), lithium fluoride (LiF), lithium chloride (LiCl), lithium bromide (LiBr), lithium iodide (LiI), potassium fluoride (KF), potassium chloride (KCl), potassium bromide (KBr), potassium iodide (KI), calcium fluoride (CaF₂), calcium chloride (CaCl₂)), calcium bromide (CaBr₂), calcium iodide (Cal₂), or any combination thereof. In another example, the electrolyte includes magnesium chloride (MgCl₂). As an alternative, the salt of the active alkali metal can be, for example, a non-chloride halide, bistriflimide, fluorosulfano-amine, perchlorate, hexaflourophosphate, tetrafluoroborate, carbonate, hydroxide, nitrate, nitrite, sulfate, sulfite, or combinations thereof. In some cases, the electrolyte can comprise a mixture of salts (e.g., 25:55:20 mol-% LiF:LiCl:LiBr, 50:37:14 mol-% LiCl:LiF:LiBr, etc.). The electrolyte may exhibit low (e.g., minimal) electronic conductance (e.g., electronic shorting may occur through the electrolyte via valence reactions of PbCl₂>PbCl₃ which increases electronic conductance). For example, the electrolyte can have an electronic transference number (i.e., percentage of electrical (electronic and ionic) charge that is due to the transfer of electrons) of less than or equal to about 0.03% or 0.3%.

In some cases, the negative electrode and the positive electrode of an electrochemical energy storage device are in the liquid state at an operating temperature of the energy storage device. To maintain the electrodes in the liquid states, the battery cell may be heated to any suitable temperature. In some examples, the battery cell is heated to and/or maintained at a temperature of about 100 °C, about 150 °C, about 200 °C, about 250 °C, about 300 °C, about 350 °C, about 400 °C, about 450 °C, about 500 °C, about 550 °C, about 600 °C, about 650 °C, or about 700 °C. The battery cell may be heated to and/or maintained at a temperature of at least about 100 °C, at least about 150 °C, at least about 200 °C, at least about 250 °C, at least about 300 °C, at least about 350 °C, at least about 400 °C, at least about 450 °C, at least about 500 °C, at least about 550 °C, at least about 600 °C, at least about 650 °C, at least about 700 °C, at least about 800 °C, or at least about 900 °C. In such a case, the negative electrode, electrolyte and positive electrode can be in a liquid (or molten) state. In some situations, the battery cell is heated to between about 200 °C and about 600 °C, between about 500 °C and about 550 °C, or between about 450 °C and about 575 °C.

In some implementations, the electrochemical cell or energy storage device may be at least partially or fully self-heated. For example, a battery may be sufficiently insulated, charged, discharged and/or conditioned at sufficient rates, and/or cycled a sufficient percentage of the time to allow the system to generate sufficient heat through inefficiencies of the cycling operation that cells are maintained at a given operating temperature (e.g., a cell operating temperature above the freezing point of at least one of the liquid components) without the need for additional energy to be supplied to the system to maintain the operating temperature.

Electrochemical cells of the disclosure may be adapted to cycle between charged (or energy storage) modes and discharged modes. In some examples, an electrochemical cell can be fully charged, partially charged or partially discharged, or fully discharged.

In some implementations, during a charging mode of an electrochemical energy storage device, electrical current received from an external power source (e.g., a generator or an electrical grid) may cause metal atoms in the metal positive electrode to release one or more electrons, dissolving into the electrolyte as a positively charged ion (i.e., cation). Simultaneously, cations of the same species can migrate through the electrolyte and may accept electrons at the negative electrode, causing the cations to transition to a neutral metal species, thereby adding to the mass of the negative electrode. The removal of the active metal species from the positive electrode and the addition of the active metal to the negative electrode stores electrochemical energy. In some cases, the removal of a metal from the positive electrode and the addition of its cation to the electrolyte can store electrochemical energy. In some cases, electrochemical energy can be stored through a combination of removal of the active metal species from the positive electrode and its addition to the negative electrode, and the removal of one or more metals (e.g., different metals) from the positive electrode and their addition to the electrolyte (e.g., as cations). During an energy discharge mode, an electrical load is coupled to the electrodes and the previously added metal species in the negative electrode can be released from the metal negative electrode, pass through the electrolyte as ions, and deposit as a neutral species in the positive electrode (and in some cases alloy with the positive electrode material), with the flow of ions accompanied by the external and matching flow of electrons through the external circuit/load. In some cases, one or more cations of positive electrode material previously released into the electrolyte can deposit as neutral species in the positive electrode (and in some cases alloy with the positive electrode material), with the flow of ions accompanied by the external and matching flow of electrons through the external circuit/load. This electrochemically facilitated metal alloying reaction discharges the previously stored electrochemical energy to the electrical load.

In a charged state, the negative electrode can include negative electrode material and the positive electrode can include positive electrode material. During discharging (e.g., when the battery is coupled to a load), the negative electrode material yields one or more electrons, and cations of the negative electrode material. In some implementations, the cations migrate through the electrolyte to the positive electrode material and react with the positive electrode material (e.g., to form an alloy). In some implementations, ions of the positive metal species (e.g., cations of the positive electrode material) accept electrons at the positive electrode and deposit as a metal on the positive electrode. During charging, in some implementations, the alloy at the positive electrode disassociates to yield cations of the negative electrode material, which migrate through the electrolyte to the negative electrode. In some implementations, one or more metal species at the positive electrode disassociates to yield cations of the negative electrode material in the electrolyte. In some examples, ions can migrate through an electrolyte from an anode to a cathode, or vice versa. In some cases, ions can migrate through an electrolyte in a push-pop fashion in which an entering ion of one type ejects an ion of the same type from the electrolyte. For example, during discharge, an alkali metal anode and an alkali metal chloride electrolyte can contribute an alkali metal cation to a cathode by a process in which an alkali metal cation formed at the anode interacts with the electrolyte to eject an alkali metal cation from the electrolyte into the cathode. The alkali metal cation formed at the anode in such a case may not necessarily migrate through the electrolyte to the cathode. The cation can be formed at an interface between the anode and the electrolyte, and accepted at an interface of the cathode and the electrolyte.

In some cases, an electrochemical cell is a high temperature battery that utilizes a liquid metal negative electrode (e.g., Na, Li), and a solid ion-conducting (e.g., β″-alumina ceramic) electrolyte. In some instances, the solid ion-conducting electrolyte operates above about 100 °C, above about 150 °C, above about 200 °C, above about 250 °C, above about 300 °C, or above about 350 °C. The electrolyte may comprise molten chalcogenide (e.g., S, Se, Te) and/or a molten salt comprising a transition metal halide (e.g., NiCl₃, FeCl₃). The electrolyte may include other supporting electrolyte compounds (e.g., NaCl, NaF, NaBr, Nal).

### Batteries and Housings

Electrochemical cells of the disclosure can include housings that may be suited for various uses and operations. A housing can include one cell or a plurality of cells. A housing can be configured to electrically couple the electrodes to a switch, which can be connected to the external power source and the electrical load. The cell housing may include, for example, an electrically conductive container that is electrically coupled to a first pole of the switch and/or another cell housing, and an electrically conductive container lid that is electrically coupled to a second pole of the switch and/or another cell housing. The cell can be arranged within a cavity of the container. A first one of the electrodes of the cell (e.g., positive electrode) can contact and be electrically coupled with an endwall of the container. A second one of the electrodes of the cell (e.g., negative electrode) can contact and be electrically coupled with a conductive feed-through or conductor (e.g., negative current lead) on the container lid (collectively referred to herein as “cell lid assembly,” “lid assembly” or “cap assembly” herein). An electrically insulating seal (e.g., bonded ceramic ring) may electrically isolate negative potential portions of the cell from positive portions of the container (e.g., electrically insulate the negative current lead from the positive current lead). In an example, the negative current lead and the container lid (e.g., cell cap) can be electrically isolated from each other, where a dielectric sealant material can be placed between the negative current lead and the cell cap. As an alternative, a housing includes an electrically insulating sheath (e.g., alumina sheath) or corrosion resistant and electrically conductive sheath or crucible (e.g., graphite sheath or crucible). In some cases, a housing and/or container may be a battery housing and/or container.

A cell can have any cell and seal configuration disclosed herein. For instance, the active cell materials can be held within a sealed steel/stainless steel container with a high temperature seal on the cell lid. A negative current lead can pass through the cell lid (and be sealed to the cell lid by the dielectric high temperature seal), and connect with a porous negative current collector (e.g., metal foam) suspended in an electrolyte. In some cases, the cell can use a graphite sheath, coating, crucible, surface treatment or lining (or any combination thereof) on the inner wall of the cell crucible. In other cases, the cell may not use a graphite sheath, coating, crucible, surface treatment or lining on an inner wall of the cell crucible.

During cell operation, material (e.g., Fe) from a wall of the cell can react under the higher voltage potential (e.g., Type 2 mode), and ionize as a soluble species in the electrolyte. Hence, the wall material can dissolve into the electrolyte and subsequently interfere with the cell's electrochemistry. For example, the dissolved material can deposit on the negative electrode, which, in some cases, can grow as dendrites and stretch across the electrolyte to one or more walls of the cell, or toward the positive electrode, which can result in a short failure. The present disclosure provides various approaches for suppressing or otherwise helping minimize the dissolution of solid (passive) cell material such as Fe and its potentially negative effects on cell performance by, for example, formation of dendrites and cell shorting. In some cases, a cell can be designed such that increased spacing between the negative electrode and a wall of the cell suppresses or otherwise helps minimize the ability of dendrites from forming and shorting the wall to the inner wall. A cell can include an electrically insulating, and chemically stable sheath or coating between one or more walls of the cell and the negative electrode, electrolyte and/or positive electrode to minimize or prevent shorting to the one or more walls of the cell. In some cases, the cell can be formed of a non-ferrous container or container lining, such as a carbon-containing material (e.g., graphite), or a carbide (e.g., SiC, TiC), or a nitride (e.g., TiN, BN), or a chemically stable metal (e.g., Ti, Ni, B). The container or container lining material may be electrically conductive. Such non-limiting approaches can be used separately or in combination, for suppressing or otherwise helping minimize chemical interactions with Fe or other cell wall materials, and any subsequent negative effects on cell performance.

A battery, as used herein, can comprise a plurality of electrochemical cells. The cell(s) can include housings. Individual cells can be electrically coupled to one another in series and/or in parallel. In series connectivity, the positive terminal of a first cell is connected to a negative terminal of a second cell. In parallel connectivity, the positive terminal of a first cell can be connected to a positive terminal of a second, and/or additional, cell(s). Similarly, cell modules, packs, cores, CEs and systems can be connected in series and/or in parallel in the same manner as described for cells.

A hermetically sealed battery or battery housing may prevent an unsuitable amount of air, oxygen, nitrogen, and/or water into the battery (e.g., an amount such that the battery maintains at least about 80% of its energy storage capacity and/or maintains a round-trip Coulombic efficiency of at least about 90% per cycle when charged and discharged at at least about 100 mA/cm² for at least about one year, at least about 2 years, at least about 5 years, at least about 10 years or at least about 20 years). In some instances, the rate of oxygen, nitrogen, and/or water vapor transfer into the battery is less than about 0.25 milli-liter (mL) per hour, less than about 0.21 mL per hour, or less than about 0.02 mL per hour when the battery is contacted with air at a pressure that is at least about (or less than about) 0 atmospheres (atm), 0.1 atm, 0.2 atm, 0.3 atm, 0.4 atm, 0.5 atm, 0.6 atm, 0.7 atm, 0.8 atm, 0.9 atm or 0.99 atm higher than, or at least about (or less than about) 0.1 atm, 0.2 atm, 0.5 atm, 1 atm or lower than the pressure inside the battery and a temperature of about 400 °C to about 700 °C. In some instances, the rate of metal vapor, molten salt vapor, or inert gas transfer out of the battery is less than about 0.25 mL per hour, less than about 0.21 mL per hour, or less than about 0.02 mL per hour when the battery is contacted with air at a pressure of about 0.5 atm, 1 atm, 1.5 atm, 2 atm, 2.5 atm, 3 atm, 3.5 atm, or 4 atm less than the pressure inside the battery and a temperature of about 400 °C to about 700 °C. In some examples, the number of moles of oxygen, nitrogen, or water vapor that leaks into the cell over a given period (e.g., 1 month period, 6 month period, 1 year period, 2 year period, 5 year period, 10 year period, or more) is less than about 10%, less than about 5%, less than about 3%, less than about 1%, less than about 0.5%, less than about 0.1%, less than about 0.05%, or less than about 0.5% of the number of moles of active material (e.g., active metal material) in the cell.

A sealed high temperature device containing reactive materials may in some cases experience an increase in internal pressure (e.g., if the temperature of the device is increased above the boiling point of one or more of the materials within the device). The device may comprise a metal housing (e.g., stainless steel cell body) and a metal housing lid (e.g., stainless steel cell lid) that are joined (e.g., brazed or welded) together. The cell lid May comprise a high temperature seal. In the event of a pressure build-up inside the device, the device may rupture. In some cases, the device may rupture, eject material, and result in a hazardous event. It may be desirable for the device to comprise a component that relieves pressure before it reaches a hazardous level. It may also be desirable that the pressure relief component is in a gaseous head space of the device such that the pressure is released via the escape of gaseous components rather than liquid components.

In some implementations, the seal may be designed to serve as the pressure relief component (e.g., to be the weakest portion of the device that will allow the pressure that may build inside the device to be released through the seal) above a critical pressure and/or above a critical temperature. One or more seals may be provided on the device (e.g., a seal around a conductor, a dedicated pressure relief seal, a seal around a conductor that also provides pressure relief, etc.). In some cases, the seal releases pressure when the device and/or seal is heated above the melting point of the braze material that is used to create the metal-to-ceramic sealed interfaces. In some cases, the strength and/or geometry of the ceramic-to-metal joints in the seal are designed to fail (e.g., leak) before the metal-to-metal joints of the device housing and/or lid (and/or before the metal-to-metal joints of the seal). For example, one or more of the ceramic-to-metal brazes in the seal may be weaker than the metal-to-metal welds of the device housing and/or lid. In some examples, the critical pressure inside the device can be greater than about 1 atm, 2 atm, 3 atm, 4 atm, 5 atm, 10 atm, 20 atm, 50 atm, or 100 atm. In some examples, the critical temperature (e.g., of the device and/or of the seal) can be greater than about 300 °C, 400 °C, 500 °C, 600 °C, 700 °C, 800 °C, 900 °C, 1000 °C, 1100 °C, 1200 °C, 1300 °C, or 1400 °C.

### Seal Materials, Chemical Compatibility and Coefficients of Thermal Expansion

The seal can be made of any suitable material (e.g., such that the seal forms a hermetic seal and an electrical isolation). In some cases, the seal is made from a ceramic material and a braze material. The ceramic material and the braze material can have coefficients of thermal expansion (CTEs) that are matched to each other and/or to the housing material such that the electrochemical cell maintains a suitable seal during operation and/or start-up of the battery. The ceramic material can have a coefficient of thermal expansion that matches a coefficient of thermal expansion of the braze material and the cell top (e.g., lid or cap, or any component of a cell lid assembly) or body, or combination thereof.

In some cases, the coefficients of thermal expansion of the ceramic material, braze material and cell top or body are not identically matched, but are sufficiently close to minimize stresses during the braze operation and subsequent thermal cycles in operation. In some cases, the CTE of the ceramic is at least about 3 microns per meter per degree Celsius (μm/m/°C), at least about 4 μm/m/°C, at least about 5 μm/m/°C, at least about 6 μm/m/°C, at least about 7 μm/m/°C, at least about 8 μm/m/°C, at least about 9 μm/m/°C, at least about 10 μm/m/°C, at least about 11 μm/m/°C, at least about 12 μm/m/°C, at least about 13 μm/m/°C, or at least about 14 μm/m/°C. In some cases, the CTE of the ceramic is less than about 3 μm/m/°C, less than about 4 μm/m/°C, less than about 5 μm/m/°C, less than about 6 μm/m/C, less than about 7 μm/m/°C, less than about 8 μm/m/°C, less than about 9 μm/m/°C, less than about 10 μm/m/°C, less than about 11 μm/m/°C, less than about 12 μm/m/°C, less than about 13 μm/m/°C, or less than about 14 μm/m/°C. In some cases, the CTE of the metal collar or sleeve is at least about 5 μm/m/°C, at least about 6 μm/m/°C, at least about 7 μm/m/C, at least about 8 μm/m/°C, at least about 9 μm/m/°C, at least about 10 μm/m/°C, at least about 11 μm/m/°C, at least about 12 μm/m/°C, at least about 13 μm/m/°C, or at least about 14 μm/m/°C. In some cases, the CTE of the metal collar or sleeve is less than about 5 μm/m/°C, less than about 6 μm/m/°C, less than about 7 μm/m/°C, less than about 8 μm/m/°C, less than about 9 μm/m/°C, less than about 10 μm/m/°C, less than about 11 μm/m/°C, less than about 12 μm/m/°C, less than about 13 μm/m/°C, or less than about 14 μm/m/°C. In some cases, the ceramic material comprises at least about 50% AlN and has a CTE of less than about 5 μm/m/°C. In some cases, the metal collar or sleeve comprises Zr and has a CTE of about, or less than about, 7 μm/m/°C. In some cases, the maximum difference in coefficients of thermal expansion (e.g., between any two of the ceramic material, braze material and cell top or body) can be less than about 0.1 microns per meter per degree Celsius (μm/m/°C), less than about 0.5 μm/m/°C, less than about 1 μm/m/°C, less than about 2 μm/m/°C, less than about 3 μm/m/°C, less than about 5 μm/m/°C, less than about 7 μm/m/°C, less than about 10 μm/m/°C, or less than about 15 μm/m/°C.

In some cases, the seal comprises a metal collar (e.g., a thin metal collar) or sleeve. The collar or sleeve can be brazed to the ceramic (e.g., via a braze material) and joined to the cell lid and/or the negative current lead that protrudes through the cell lid and into the cell cavity. The seal can comprise features that alleviate CTE mismatches between the ceramic and the cell lid and/or the negative current lead.

In some implementations, an electrochemical cell comprises an electrically conductive housing comprising a liquid metal that is liquid at an operating temperature of at least about 200 °C. In some cases, the operating temperature is at least about 350 °C. In some instances, the electrochemical cell is capable of storing at least about 50 Watt-hours of energy. The liquid metal (including liquid metal alloys) can be configured to store/release charge during charge/discharge of the electrochemical cell. The electrochemical cell can comprise a conductor in electrical contact with the liquid metal, where the conductor protrudes through the electrically conductive housing through an aperture in the electrically conductive housing. The electrochemical cell can comprise a seal that seals the conductor to the electrically conductive housing.

In some cases, the seal comprises a ceramic material and a braze material. In some cases, the ceramic material is thermodynamically stable (e.g., does not chemically react) with reactive materials (e.g., reactive liquid metals or reactive liquid metal vapors). In some cases, the ceramic material is thermodynamically stable with, is not attacked by and does not dissolve into the molten salt. Examples of ceramic materials include, but are not limited to, aluminum nitride (AlN), beryllium nitride (Be₃N₂), boron nitride (BN), calcium nitride (Ca₃N₂), silicon nitride (Si₃N₄), aluminum oxide (Al₂O₃), beryllium oxide (BeO), calcium oxide (CaO), cerium oxide (Ce₂O₃), erbium oxide (Er₂O₃), lanthanum oxide (La₂O₃), magnesium oxide (MgO), neodymium oxide (Nd₂O₃), samarium oxide (Sm₂O₃), scandium oxide (Sc₂O₃), ytterbium oxide (Yb₂O₃), yttrium oxide (Y₂O₃), zirconium oxide (ZrO₂), yttria partially stabilized zirconia (YPSZ), boron carbide (B₄C), silicon carbide (SiC), titanium carbide (TiC), zirconium carbide (ZrC), titanium diboride (TiB₂), chalcogenides, quartz, glass, or any combination thereof.

In some cases, the braze material comprises at least one braze constituent that has low solubility in the reactive material, in which the reactive material has low solubility, that does not react (e.g., form intermetallic alloys with) the reactive material at the operating temperature of the device, and/or that melts above the operating temperature of the device. The reactive material can be a reactive metal. In some examples, the braze material comprises at least one braze constituent that has low solubility in the reactive metal. In some examples, the reactive metal has low solubility in the braze constituent. In some examples, the braze constituent does not form intermetallic alloys with the reactive metal at the operating temperature of the device. In some examples, the braze constituent melts above the operating temperature of the device. Examples of braze constituent materials include, but are not limited to, aluminum (Al), beryllium (Be), copper (Cu), chromium (Cr), iron (Fe), manganese (Mn), molybdenum (Mo), nickel (Ni), niobium (Nb), rubidium (Rb), scandium (Sc), silver (Ag), tantalum (Ta), titanium (Ti), vanadium (V), yttrium (Y), zirconium (Zr), phosphorus (P), boron (B), carbon (C), silicon (Si), or any combination thereof. In some instances, the ceramic material comprises aluminum nitride (AlN) and the braze material comprises titanium (Ti). In some cases, the braze material comprises a mixture of two or more materials (e.g., 3 materials). The materials may be provided in any proportion. For example, the braze can comprise 3 materials at a ratio (e.g., in weight-%, atomic-%, mol-% or volume-%) of about 30:30:40 or 40:40:20. In some cases, the braze material comprises a mixture of Ti—Ni—Zr. In some instances, the braze comprises at least about 20, 30 or 40 weight-% titanium, at least about 20, 30% or 40 weight-% nickel, and at least about 20, 30 or 40 weight-% zirconium. In some instances, the braze comprises less than about 20, 30 or 40 weight-% titanium, less than about 20, 30% or 40 weight-% nickel, and less than about 20, 30 or 40 weight-% zirconium. In some instances, the braze comprises about 18% Ti, about 60% Zr, about 22% Ni (e.g., on a weight-%, atomic-%, mol-% or volume-% basis). In some instances, the braze comprises about 7% Ti, about 67% Zr, and about 26% Ni (e.g., on a weight-%, atomic-%, mol-% or volume-% basis). In some instances, the braze can comprise at least about, or less than about, 5, 10, 15, 20, 25, 30, 35, 40, 45, 50, 55, 60, 65, 70, 75, 80, 85, 90, 95 or more weight-%, atomic-%, mol-% or volume-% of titanium, nickel or zirconium (or any other braze material herein). In some cases, other suitable brazing material(s) can be added to the braze to improve chemical stability, change the melting temperature, or change mechanical properties (e.g., change the CTE of the braze, change the ductility of the braze, etc.).

In some examples, such a ceramic comprises the main ceramic material (e.g., Y₂O₃) and at least about 2%, at least about 4%, at least about 6%, at least about 8%, at least about 10%, at least about 12%, or at least about 15% by weight of a secondary ceramic material (e.g., AlN, Be₃N₂, BN, Ca₃N₂, Si₃N₄, Al₂O₃, BeO, CaO, Ce₂O₃, Er₂O₃, La₂O₃, MgO, Nd₂O₃, Sm₂O₃, Sc₂O₃, Yb₂O₃, ZrO₂, YPSZ, B₄C, SiC, TiC, ZrC, TiB₂, chalcogenides, quartz, glass, or any combination thereof). In some examples, the ceramic comprises primarily the main ceramic material (e.g., Y₂O₃) with less than about 2%, less than about 4%, less than about 6%, less than about 8%, less than about 10%, less than about 12%, or less than about 15% by weight of a secondary ceramic material (or a combination of secondary ceramic materials). In some examples, the main ceramic material is Y₂O₃. In some examples, the secondary ceramic material is MgO. In an example, the ceramic comprises primarily Y₂O₃ with about 12.5 weight-% MgO particles. In some cases, a ceramic comprising Y₂O₃ and, for example, about 12.5 weight-% MgO may have a CTE that closely matches (e.g., within about 10% or less) the CTE of steel or stainless steel alloys (e.g., 430 stainless steel) at the operating temperature of the cell and/or system.

A wired or wire-less (e.g., direct metal-to-metal) interconnection between individual electrochemical cells and/or between groups of electrochemical cells can have a given internal resistance. In some cases, electrochemical cells are not connected with wires. In some examples, series connections (e.g., wire-less cell-to-cell connections, or current transfer plate connections) are created with a connection that has an internal resistance of about 0.05 milli-ohm (mOhm), about 0.1 mOhm, 0.5 mOhm, about 1 mOhm, about 2 mOhm, about 5 mOhm, about 10 mOhm, about 50 mOhm, about 100 mOhm, or about 500 mOhm at an operating temperature greater than 250 °C. In some examples, series connections are created with a connection that has an internal resistance of less than about 0.05 mOhm, less than about 0.1 mOhm, less than about 0.5 mOhm, less than about 1 mOhm, less than about 2 mOhm, less than about 5 mOhm, less than about 10 mOhm, less than about 50 mOhm, less than about 100 mOhm, or less than about 500 mOhm at an operating temperature greater than about 250 °C. In some instances, the resistance is measured by a direct electrical connection between the conductor of a first electrochemical cell and the electrically conducting housing of a second cell. In some cases, one or more busbars and/or interconnects can be used to create a connection between any two groups of cells. In some examples, such a connection has an internal resistance of about 0.01 mOhm, about 0.05 mOhm, about 0.1 mOhm, about 0.2 mOhm, about 0.5 mOhm, about 1 mOhm, about 5 mOhm, about 10 mOhm, about 50 mOhm, or about 100 mOhm. In some examples, such a connection has an internal resistance of less than about 0.01 mOhm, less than about 0.05 mOhm, less than about 0.1 mOhm, less than about 0.2 mOhm, less than about 0.5 mOhm, less than about 1 mOhm, less than about 5 mOhm, less than about 10 mOhm, less than about 50 mOhm, or less than about 100 mOhm. In some instances, the resistance is measured by the voltage drop across a busbar (and/or interconnect) while current is flowing through the busbar (and/or interconnect) according to the following formula: R_{busbar}=V/I, where ‘R_{busbar}’ is the resistance of the busbar (and/or interconnect), ‘V’ is the measured voltage drop across the busbar (and/or interconnect) and ‘I’ is the current flowing through the busbar (and/or interconnect). Any aspects of the disclosure described in relation to internal resistance of cell-to-cell connections may equally apply to connections between groups of cells at least in some configurations, and vice versa. Further, any aspects of the disclosure described in relation to internal resistance of series connections may equally apply to parallel connections at least in some configurations, and vice versa.

There can be any suitable amount of force applied to the electrically conductive housing and/or seal. In some instances, the force applied to the seal is no greater than the seal can support. In some cases, the force applied to the seal is about 10, about 15, about 20, about 25, about 30, about 35, about 40, about 45, about 50, about 60, about 70, about 80, about 100, about 120, about 150, or about 200 Newtons. In some cases, the force applied to the seal is less than about 10, less than about 15, less than about 20, less than about 25, less than about 30, less than about 35, less than about 40, less than about 45, less than about 50, less than about 60, less than about 70, less than about 80, less than about 100, less than about 120, less than about 150, or less than about 200 Newtons. In some cases, the force applied to the housing is about 100, about 500, about 1000, about 5000, or about 10000 Newtons. In some cases, the force applied to the housing is at least about 100, at least about 500, at least about 1000, at least about 5000, or at least about 10000 Newtons.

### Ceramic Materials and Seals for High-Temperature Devices

The present disclosure provides a seal or a corrosion resistant lining for a high-temperature device. The device can be a high temperature reactive material device that contains/comprises one or more reactive materials. For example, the high-temperature device can contain a reactive material. In some cases, the device can be a high-temperature reactive metal device. The device can be, without limitation, for the production and/or handling of a reactive material, such as, for example, a reactive metal (e.g., lithium, sodium, magnesium, aluminum, calcium, titanium and/or other reactive metals) and/or a chemical with a strong chemical reducing capability (e.g., reactive chemical), for semiconductor manufacturing, for a nuclear reactor (e.g., nuclear fusion/fission reactor, nuclear reactor that uses a molten salt or metal, such as, for example, molten sodium or lithium or molten sodium- or lithium-containing alloys, as a coolant), for a heterogeneous reactor, for a chemical processing device, for a chemical transportation device, for a chemical storage device, or for a battery (e.g., a liquid metal battery). For instance, some batteries operate at high temperatures (e.g., at least about 100 °C or 300 °C) and have reactive metal vapors (e.g., lithium, sodium, potassium, magnesium, or calcium) that may be sufficiently contained within the battery to reduce failure. In some examples, such high-temperature devices operate, are heated to and/or maintained at a temperature of at least about 100 °C, 150 °C, 200 °C, 250 °C, 300 °C, 350 °C, 400 °C, 450 °C, 500 °C, 550 °C, 600 °C, 650 °C, 700 °C, 750 °C, 800 °C, 850 °C, 900 °C or more. At such temperatures, one or more components of the device can be in a liquid (or molten) or vaporized state.

The device may comprise a ceramic material. The ceramic material may function as a dielectric insulator in a device that contains one or more reactive materials. The device may operate at a temperature of, for example, at least about 300 °C or 400 °C. The device may be associated with a nuclear fission or fusion reactor. The dielectric insulator may be part of a seal (e.g., a gas-tight seal). The ceramic material may be used in a seal of a device that contains reactive materials and operates at a temperature of greater than about 300 °C.

The seal can comprise a ceramic material (e.g., aluminum nitride (AlN)) that is in contact with the reactive material (e.g., a reactive metal or molten salt) contained in the device. The ceramic material can be capable of being chemically resistant to a reactive material (e.g., a reactive material contained in the device, such as, for example, reactive metal or molten salt). The ceramic material can be capable of being chemically resistant to the reactive material when the device operates at a high temperature (e.g., at least about 100 °C, 150 °C, 200 °C, 250 °C, 300 °C, 350 °C, 400 °C, 500 °C, 600 °C, 700 °C, 800 °C or 900 °C).

The seal can comprise an active metal braze disposed between the ceramic material and at least one of the metal collar/sleeve and the device. The active metal braze can comprise a metal species that chemically reduces the ceramic material (e.g., titanium (Ti) or zirconium (Zr)).

The seal can surround an electrically conductive feed-through (and can electrically isolate the feed-through from a housing of the device), a thermocouple or a voltage sensor. For example, the ceramic material can be an insulator.

In some examples, the seal may be capable of being chemically resistant to reactive materials in the device at a temperature of at least about 100 °C, 150 °C, 200 °C, 250 °C, 300 °C, 350 °C, 400 °C, 500 °C, 600 °C, 700 °C, 800 °C or 900 °C. In some examples the seal may be capable of being chemically resistant to reactive materials at such temperatures for at least about 6 months, 1 year, 2 years, 5 years, 10 years, 20 years or more. In some examples, the device can be a high-temperature reactive metal device, and the seal can be capable of being chemically resistant to materials in the device that comprise the reactive metal. In an example, the seal is capable of being resistant to lithium vapor at a temperature of at least about 300 °C for at least about one year. The seal can retain the reactive material (e.g., vapors of the reactive material) in the device. For example, the seal can retain reactive metal vapors and/or molten salt vapors in the device.

### Electrochemical Cells, Devices, and Systems

In some examples, an electrochemical cell is a liquid metal battery cell. In some examples, a liquid metal battery cell can include a liquid electrolyte arranged between a negative liquid (e.g., molten) metal electrode and a positive solid, semi-solid, or liquid (e.g., molten) metal, metalloid and/or non-metal electrode. In some cases, a liquid metal battery cell has a molten alkaline earth metal (e.g., magnesium (Mg), calcium (Ca)) and/or alkali metal (e.g., lithium, sodium, potassium) negative electrode, an electrolyte, and a metal positive electrode. The metal positive electrode can include, for example, one or more of tin (Sn), lead (Pb), bismuth (Bi), antimony (Sb), tellurium (Te), and selenium (Se). For example, the positive electrode can include liquid Pb, solid Sb, a liquid or semi-solid Pb—Sb alloy or liquid Bi. The positive electrode can also include one or more transition metals or d-block elements (e.g., zinc (Zn), cadmium (Cd), and mercury (Hg)) alone or in combination with other metals, metalloids or non-metals, such as, for example, a Zn—Sn alloy or Cd—Sn alloy. In some examples, the positive electrode can comprise a metal or metalloid that has one stable oxidation state (e.g., a metal with a single or singular oxidation state). Any description of a metal or molten metal positive electrode, or a positive electrode, herein may refer to an electrode including one or more of a metal, a metalloid and a non-metal. The positive electrode may contain one or more of the listed examples of materials. In an example, the metal positive electrode can include lead and/or antimony. In some examples, the metal positive electrode may include an alkali and/or alkaline earth metal alloyed in the positive electrode.

The electrolyte can include a salt (e.g., molten salt), such as an alkali or alkaline earth metal salt. The alkali or alkaline earth metal salt can be a halide, such as a fluoride (F), chloride (Cl), bromide (Br), or iodide (I) of the active alkali or alkaline earth metal, or combinations thereof. In an example, the electrolyte (e.g., in Type 1 or Type 2 chemistries) includes lithium chloride (LiCl). In some examples, the electrolyte can comprise sodium fluoride (NaF), sodium chloride (NaCl), sodium bromide (NaBr), sodium iodide (Nal), lithium fluoride (LiF), lithium chloride (LiCl), lithium bromide (LiBr), lithium iodide (LiI), potassium fluoride (KF), potassium chloride (KCl), potassium bromide (KBr), potassium iodide (KI), calcium fluoride (CaF₂), calcium chloride (CaCl₂)), calcium bromide (CaBr₂), calcium iodide (Cal₂), strontium fluoride (SrF₂), strontium chloride (SrCl₂), strontium bromide (SrBr₂), strontium iodide (Srl₂) or any combination thereof. In some examples, the electrolyte includes magnesium chloride (MgCl₂). As an alternative, the salt of the active alkali metal can be, for example, a non-chloride halide, bistriflimide, fluorosulfano-amine, perchlorate, hexaflourophosphate, tetrafluoroborate, carbonate, hydroxide, nitrate, nitrite, sulfate, sulfite, or combinations thereof. In some cases, the electrolyte can comprise a mixture of salts (e.g., 25:55:20 mol-% LiF:LiCl:LiBr, 50:37:14 mol-% LiCl:LiF:LiBr, 34:32.5:33.5 mol-% LiCl—LiBr—KBr, etc.). In some examples, the electrolyte comprises about 30:15:55 mol % of CaCl₂):KCl:LiCl. In some examples, the electrolyte comprises about 35:65 mol % CaCl₂):LiCl. In some examples, the electrolyte comprises about 24:38:39 wt % LiCl:CaCl₂):SrCl₂. In some examples, the electrolyte comprises at least about 20 wt % CaCl₂), 20 wt % SrCl₂, and 10 wt % KCl. In some examples, the electrolyte comprises at least about 10 wt % LiCl, 30 wt % CaCl₂, 30 wt % SrCl₂, and 10 wt % KCl. The electrolyte may exhibit low (e.g., minimal) electronic conductance. For example, the electrolyte can have an electronic transference number (i.e., percentage of electrical (electronic and ionic) charge that is due to the transfer of electrons) of less than or equal to about 0.03% or 0.3%.

In some cases, the negative electrode and/or the positive electrode of an electrochemical energy storage device is/are in the liquid state at an operating temperature of the energy storage device. To maintain the electrode(s) in the liquid state(s), the battery cell may be heated to any suitable temperature. In some examples, the battery cell is heated to and/or maintained at a temperature of about 100 °C, 150 °C, 200 °C, 250 °C, 300 °C, 350 °C, 400 °C, 450 °C, 475 °C, 500 °C, 550 °C, 600 °C, 650 °C or about 700 °C. The battery cell may be heated to and/or maintained at a temperature of at least about 100 °C, 150 °C, 200 °C, 250 °C, 300 °C, 350 °C, 400 °C, 450 °C, 475 °C, 500 °C, 550 °C, 600 °C, 650 °C, 700 °C, 800 °C or 900 °C. In such a case, the negative electrode, electrolyte and/or positive electrode can be in a liquid (or molten) state. In one example, the negative electrode and the electrolyte are in a liquid state and the positive electrode is in a solid or semi-solid state. In some situations, the battery cell is heated to between about 200 °C and 600 °C, 500 °C and 550 °C or 450 °C and 575 °C.

In some implementations, the electrochemical cell or energy storage device may be at least partially or fully self-heated. For example, a battery may be sufficiently insulated, charged, discharged and/or conditioned at sufficient rates, and/or cycled a sufficient percentage of the time to allow the system to generate sufficient heat through inefficiencies of the cycling operation so that cells are maintained at a given operating temperature (e.g., a cell operating temperature above the freezing point of at least one of the liquid components) without applying additional energy to the system.

Electrochemical cells of the disclosure may be adapted to cycle between charged (or energy storage) modes and discharged modes. In some examples, an electrochemical cell can be fully charged, partially charged or partially discharged, or fully discharged.

Cells may have voltages. Charge cutoff voltage (CCV) may refer to the voltage at which a cell is fully or substantially fully charged, such as a voltage cutoff limit used in a battery when cycled in a constant current mode. Open circuit voltage (OCV) may refer to the voltage of a cell (e.g., fully or partially charged) when it is disconnected from any circuit or external load (i.e., when no current is flowing through the cell). Voltage or cell voltage, as used herein, may refer to the voltage of a cell (e.g., at any state of charge or charging/discharging condition). In some cases, voltage or cell voltage may be the open circuit voltage. In some cases, the voltage or cell voltage can be the voltage during charging or during discharging. Voltages of the present disclosure may be taken or represented with respect to reference voltages, such as ground (0 volt (V)), or the voltage of the opposite electrode in an electrochemical cell.

In one example, the electrochemical cell in a charged state comprises a negative electrode comprising calcium, an electrolyte comprising CaCl₂), and a positive electrode comprising antimony. The cell may have an operating temperature of less than about 600 °C, 550 °C, 500 °C, 450 °C, 400 °C, 350 °C, 300 °C, 250 °C, or 200 °C. In some examples, the cell may have an operating temperature of at least about 200 °C, 250 °C, 300 °C, 350 °C, 400 °C, 450 °C, 500 °C, or greater. The positive electrode, or cathode in the charged state, may comprise solid antimony and/or solid antimony alloys and may not comprise any liquid metal. The negative electrode, or anode in the charged state, may comprise lithium and/or magnesium metal. The negative electrode may remain a liquid or semi-solid during normal operating (e.g., charging, discharging) conditions.

Any aspects of the disclosure described in relation to cathodes can equally apply to anodes at least in some configurations. Similarly, one or more battery electrodes and/or the electrolyte may not be liquid in alternative configurations. In an example, the electrolyte can be a polymer, a gel or a paste. In a further example, at least one battery electrode can be a solid, a gel or a paste. Furthermore, in some examples, the electrodes and/or electrolyte may not include metal. Aspects of the disclosure are applicable to a variety of energy storage/transformation devices without being limited to liquid metal batteries.

### Batteries and Housings

Electrochemical cells of the disclosure can include housings that may be suited for various uses and operations. A housing can include one cell or a plurality of cells. A housing can be configured to electrically couple the electrodes to a switch, which can be connected to the external power source and the electrical load. The cell housing may include, for example, an electrically conductive current feedthrough conductor (e.g., current lead rod) that is electrically coupled to a first pole of the switch and/or another cell housing, and an electrically conductive container lid that is electrically coupled to a second pole of the switch and/or another cell housing. The cell can be arranged within a cavity of the container. A first one of the electrodes of the cell (e.g., positive electrode) can contact and be electrically coupled with an endwall of the container. A second one of the electrodes of the cell (e.g., negative electrode) can contact and be electrically coupled with a conductive feed-through or conductor (e.g., negative current lead) on the container lid (collectively referred to herein as “cell lid assembly,” “lid assembly” or “cap assembly” herein). An electrically insulating seal (e.g., bonded ceramic ring) may electrically isolate negative potential portions of the cell from positive portions of the cell (e.g., electrically insulate the negative current lead from the positive current lead or electrically insulate a positively polarized current lead from a negatively polarized cell lid/cell housing). In an example, the negative current lead and the container lid (e.g., cell cap) can be electrically isolated from each other, where a dielectric sealant material can be placed between the negative current lead and the cell cap. As an alternative, a housing includes an electrically insulating sheath (e.g., alumina sheath) or corrosion resistant and electrically conductive sheath or crucible (e.g., graphite sheath or crucible). In some examples, a housing and/or container may be a battery housing and/or container.

A cell can have any cell and seal configuration disclosed herein. For instance, the active cell materials can be held within a sealed steel/stainless steel container with a high temperature seal on the cell lid. A current lead (e.g., negative current lead rod) can pass through the cell lid (and be sealed to the cell lid by the dielectric high temperature seal), and connect with a porous current collector (e.g., negative current collector, such as a metal foam) suspended in an electrolyte. In some examples, the cell can use a graphite sheath, coating, crucible, surface treatment or lining (or any combination thereof) on the inner wall of the cell crucible (e.g., container). In some examples, the cell may not use a graphite sheath, coating, crucible, surface treatment or lining on an inner wall of the cell crucible (e.g., container).

A cell may have a set of dimensions. In some examples, a cell can be greater than or equal to about 4 inches wide, 4 inches deep and 2.5 inches tall. In some examples, a cell can be greater than or equal to about 8 inches wide, 8 inches deep and 2.5 inches tall. In some examples, the height and width of the cell can be greater than the depth of the cell, with the seal positioned on the top horizontal surface of the cell, and can be referred to as a ‘prismatic’ cell geometry. A prismatic cell geometry may have a width that is at least about 4, 6, 8, 10, 12, 14, or more inches, a height that is at least about 4, 6, 8, 10, 12, 14, or more inches, and a depth that is less than about 8, 6, 4, 2, or less inches. In some examples, a prismatic cell geometry has a width of about 4 inches, a height of about 6 inches, and a depth of about 2 inches. In some examples, a prismatic cell geometry has a width of about 6 inches, a height of about 6 inches, and a depth of about 2 inches. In some examples, a prismatic cell geometry has a width of about 6 inches, a height of about 6 inches, and a depth of about 3 inches. In some examples, a prismatic cell geometry has a width of about 8 inches, a height of about 8 inches, and a depth of about 2 inches. In some examples, a prismatic cell geometry has a width of about 8 inches, a height of about 8 inches, and a depth of about 3 inches. In some examples, a prismatic cell geometry has a width of about 9 inches, a height of about 9 inches, and a depth of about 2 inches. In some examples, a prismatic cell geometry has a width of about 9 inches, a height of about 9 inches, and a depth of about 3 inches. In some examples, any given dimension (e.g., height, width or depth) of an electrochemical cell can be at least about 1, 2, 2.5, 3, 3.5, 4, 4.5, 5, 5.5, 6, 6.5, 7, 7.5, 8, 8.5, 9, 9.5, 10, 12, 14, 16, 18 or 20 inches. In an example, a cell (e.g., each cell) can have dimensions of greater than or equal to about 4 inches×4 inches×2 inches. In some examples, a cell (e.g., each cell) can have dimensions of greater than or equal to about 8 inches×8 inches×2.5 inches. In some examples, a cell may have greater than or equal to about 50 Watt-hours of energy storage capacity. In some examples, a cell may have at least about 200 Watt-hours of energy storage capacity.

The positive electrode may be in electrical communication with a positive current collector. In some embodiments, the positive electrode may be in electrical communication with the housing. In some embodiments, the positive electrode may comprise antimony. In some embodiments, the positive electrode may comprise an antimony alloy. In some embodiments, the positive electrode may be a solid metal electrode. In some embodiments, the solid metal positive electrode may be in a slab configuration. Alternatively, or in addition to, the solid metal positive electrode may comprise particles. The particles may comprise granules, flakes, needles, or any combination thereof of solid material. In some embodiments, the positive electrode may be solid antimony. The solid antimony may be in a slab configuration. Alternatively, or in addition to, the solid antimony may be particles comprising granules, flakes, needles, or any combination thereof of solid material. The solid metal positive electrode particles may comprise a dimension of at least about 0.001 mm, at least about 0.01 mm, at least about 0.1 mm, at least about 0.25 mm, at least about 0.5 mm, at least about 1 mm, at least about 2 mm, at least about 3 mm, at least about 5 mm, or larger. In some embodiments, the electrolyte sits on top of the positive electrode. Alternatively, or in addition to, the positive electrode may be submerged in or surrounded by the electrolyte.

The electrochemical cell may be arranged within the housing so that the average flow path of ions is substantially perpendicular to the plane of the container lid (e.g., ions flow vertically between the negative and positive electrode when the lid is facing in an upwards direction). This configuration may comprise a negative electrode contained within a negative current collector suspended within the cavity of the housing by a negative current lead. In this configuration, the width of the negative current collector may be greater than the height. The negative electrode may be partially or fully submerged in a molten salt electrolyte. A gaseous headspace may be present above the negative electrode (i.e., between the negative electrode and the container lid). The molten salt electrolyte may be between, and separate, the negative electrode and the positive electrode. The positive electrode may be positioned at or near the bottom (i.e., opposite the container lid) of the cavity. The positive electrode may comprise a solid slab geometry or may comprise particles of solid material. The positive electrode may be positioned below the electrolyte or may be submerged or surrounded by the electrolyte. During discharge, ions may flow from the negative electrode to the positive electrode with an average flow path that is perpendicular to and away from the container lid. During charging, ions may flow from the positive electrode to the negative electrode with an average flow path that is perpendicular to and towards the container lid.

The electrochemical cell may be arranged with the housing so that the average flow path of ions is substantially parallel to the plane of the container lid (e.g., ions flow horizontally between the negative and positive electrode when the lid is facing in an upward direction). In some examples, an electrochemical cell comprises a negative electrode contained within a negative current collector suspended within the cavity of the housing by a negative current lead. In this configuration, the height of the negative current collector may be greater than the width. The negative electrode may be partially or fully submerged in a molten salt electrolyte. A gaseous headspace may be present between the negative electrode and the container lid. In some embodiments, the negative electrode may be submerged and covered by a molten electrolyte and the gaseous headspace may be between the electrolyte and the container lid. The positive electrode may be positioned along the sidewalls of the housing between the bottom of the cavity and the container lid. The positive electrode may be positioned along a portion of the interior sidewall or cover one or more of the entire interior sidewall(s) of the cavity. The positive electrode may cover an area that is at least about 5%, at least about 10%, at least about 20%, at least about 30%, at least about 40%, at least about 50%, at least about 60%, at least about 70%, at least about 80%, at least about 90%, or more of the sidewall.

The cross-sectional geometry of the cell or battery can be circular, elliptical, square, rectangular, polygonal, curved, symmetric, asymmetric, or any other compound shape based on design requirements for the battery. In some examples, the cell or battery is axially symmetric with a circular or square cross-section. Components of cell or battery (e.g., negative current collector) may be arranged within the cell or battery in an axially symmetric fashion. In some cases, one or more components may be arranged asymmetrically, such as, for example, off the center of the axis.

One or more electrochemical cells (“cells”) may be arranged in groups. Examples of groups of electrochemical cells include modules, packs, cores, CEs and systems.

A module can comprise cells that are attached together in parallel by, for example, mechanically connecting the cell housing of one cell with the cell housing of an adjacent cell (e.g., cells that are connected together in an approximately horizontal packing plane). In some examples, a module can comprise cells that are attached together in series, by, for example, mechanically connecting the cell housing of one cell with the current lead rod that protrudes from the seal of an adjacent cell. In some examples, the cells are connected to each other by joining features that are part of and/or connected to the cell body (e.g., tabs protruding from the main portion of the cell body). A module can include a plurality of cells in parallel or in series. A module can comprise any number of cells, e.g., at least about 2, 3, 4, 5, 6, 7, 8, 9, 10, 11, 12, 13, 14, 15, 16, 17, 18, 19, 20 or more cells. In some examples, a module comprises at least about 4, 9, 12 or 16 cells. In some examples, a module is capable of storing greater than or equal to about 700 Watt-hours of energy and/or delivering at least about 175 Watts of power. In some examples, a module is capable of storing at least about 1080 Watt-hours of energy and/or delivering at least about 500 Watts of power. In some examples, a module is capable of storing at least about 1080 Watt-hours of energy and/or delivering at least about 200 Watts (e.g., greater than or equal to about 500 Watts) of power. In some examples, a module can include a single cell.

A pack can comprise modules that are attached through different electrical connections (e.g., vertically). A pack can comprise any number of modules, e.g., at least about 1, 2, 3, 4, 5, 6, 7, 8, 9, 10, 11, 12, 13, 14, 15, 16, 17, 18, 19, 20 or more modules. In some examples, a pack comprises at least about 3 modules. In some examples, a pack is capable of storing at least about 2 kilo-Watt-hours of energy and/or delivering at least about 0.4 kilo-Watts (e.g., at least about 0.5 kilo-Watts or 1.0 kilo-Watts) of power. In some examples, a pack is capable of storing at least about 3 kilo-Watt-hours of energy and/or delivering at least about 0.75 kilo-Watts (e.g., at least about 1.5 kilo-Watts) of power. In some examples, a pack comprises at least about 6 modules. In some examples, a pack is capable of storing greater than or equal to about 6 kilo-Watt-hours of energy and/or delivering at least about 1.5 kilo-Watts (e.g., greater than or equal to about 3 kilo-Watts) of power. In some examples, modules are connected together into a pack in a series connection.

A core can comprise a plurality of modules or packs that are attached through different electrical connections (e.g., in series and/or parallel). A core can comprise any number of modules or packs, e.g., at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50 or more packs. In some examples, the core also comprises mechanical, electrical, and thermal systems that allow the core to efficiently store and return electrical energy in a controlled manner. In some examples, a core comprises at least about 12 packs. In some examples, a core is capable of storing at least about 25 kilo-Watt-hours of energy and/or delivering at least about 6.25 kilo-Watts of power. In some examples, a core comprises at least about 36 packs. In some examples, a core is capable of storing at least about 200 kilo-Watt-hours of energy and/or delivering at least about 40, 50, 60, 70, 80, 90, 100, 200, 500, 1000, or more kilo-Watts or more of power.

A core enclosure (CE) can comprise a plurality of cores that are attached through different electrical connections (e.g., in series and/or parallel). A CE can comprise any number of cores, e.g., at least about 1, 2, 3, 4, 5, 6, 7, 8, 9, 10, 11, 12, 13, 14, 15, 16, 17, 18, 19, 20 or more cores. In some examples, the CE contains cores that are connected in parallel with appropriate by-pass electronic circuitry, thus enabling a core to be disconnected while continuing to allow the other cores to store and return energy. In some examples, a CE comprises at least 4 cores. In some examples, a CE is capable of storing at least about 100 kilo-Watt-hours of energy and/or delivering greater than or equal to about 25 kilo-Watts of power. In some examples, a CE comprises 4 cores. In some examples, a CE is capable of storing greater than or equal to about 100 kilo-Watt-hours of energy and/or delivering greater than or equal to about 25 kilo-Watts of power. In some examples, a CE is capable of storing greater than or equal to about 400 kilo-Watt-hours of energy and/or delivering at least about 80 kilo-Watts, e.g., greater than or equal to about 80, 100, 120, 140, 160, 180, 200, 250, 300, 500, 1000 or more kilo-Watts or more of power.

A system can comprise a plurality of cores or CEs that are attached through different electrical connections (e.g., in series and/or parallel). A system can comprise any number of cores or CEs, e.g., at least about 2, 3, 4, 5, 6, 7, 8, 9, 10, 11, 12, 13, 14, 15, 16, 17, 18, 19, 20 or more cores. In some examples, a system comprises 20 CEs. In some examples, a system is capable of storing greater than or equal to about 2 mega-Watt-hours of energy and/or delivering at least about 400 kilo-Watts (e.g., about or at least about 500 kilo-Watts or 1000 kilo-Watts) of power. In some examples, a system comprises 5 CEs. In some examples, a system is capable of storing greater than or equal to about 2 mega-Watt-hours of energy and/or delivering at least about 400 kilo-Watts, e.g., at least about 400, 500, 600, 700, 800, 900, 1,000, 1,200, 1,500, 2,000, 2,500, 3,000 or 5,000 kilo-Watts or more of power.

A group of cells (e.g., a core, a CE, a system, etc.) with a given energy capacity and power capacity (e.g., a CE or a system capable of storing a given amount of energy) may be configured to deliver at least about 10%, 20%, 30%, 40%, 50%, 60%, 70%, 80%, 90% or 95%, or about 100% of a given (e.g., rated) power level. For example, a 1000 kW system may be capable of also operating at 500 kW, but a 500 kW system may not be able to operate at 1000 kW. In some examples, a system with a given energy capacity and power capacity (e.g., a CE or a system capable of storing a given amount of energy) may be configured to deliver less than about 100%, 110%, 125%, 150%, 175% or 200% of a given (e.g., rated) power level, and the like. For example, the system may be configured to provide more than its rated power capacity for a period of time that is less than the time it may take to consume its energy capacity at the power level that is being provided (e.g., provide power that is greater than the rated power of the system for a period of time corresponding to less than about 1%, 10% or 50% of its rated energy capacity).

A battery can comprise one or more electrochemical cells connected in series and/or parallel. A battery can comprise any number of electrochemical cells, modules, packs, cores, CEs or systems. A battery may undergo at least one charge/discharge or discharge/charge cycle (“cycle”).

A battery can comprise one or more (e.g., a plurality of) electrochemical cells. The cell(s) can include housings. Individual cells can be electrically coupled to one another in series and/or in parallel. In series connectivity, the positive terminal of a first cell is connected to a negative terminal of a second cell. In parallel connectivity, the positive terminal of a first cell can be connected to a positive terminal of a second, and/or additional, cell(s). Similarly, cell modules, packs, cores, CEs and systems can be connected in series and/or in parallel in the same manner as described for cells.

### Features and Properties of Seals

The seal can be an important part of a high temperature system containing reactive metals (e.g., a liquid metal battery). Provided herein is a method for choosing materials suitable for forming a seal and methods for designing a suitable seal for a system containing reactive liquid metals or liquid metal vapors and/or reactive molten salt(s) or reactive molten salt vapors such as, for example, a liquid metal battery (e.g., based on the selection of these materials, and considerations of thermal, mechanical and electrical properties). The seal can also be used as part of an electrically isolated feed-through connected to a vessel comprising reactive liquid metals or reactive metal vapors for applications other than energy storage, such as fusion reactors comprising molten or high pressure Li vapor, or other applications that involve liquid sodium, potassium, magnesium, calcium, and/or lithium. The use of stable ceramic and electronically conductive materials can also be appropriate for applications with reactive gases such as those used in semiconductor material processing or device fabrication.

The seal can be electrically insulating and gas-tight (e.g., hermetic). The seals can be made of materials that are not attacked by the liquid and vapor phases of system/vessel components (e.g., cell components), such as, for example, molten sodium (Na), molten potassium (K), molten magnesium (Mg), molten calcium (Ca), molten lithium (Li), Na vapor, K vapor, Mg vapor, Ca vapor, Li vapor, or any combination thereof. The method identifies a seal comprising an aluminum nitride (AlN) or silicon nitride (Si₃N₄) ceramic and an active alloy braze (e.g., Ti, Fe, Ni, B, Si or Zr alloy-based) as being thermodynamically stable with most reactive metal vapors, thus allowing for the design of a seal that is not appreciably attacked by metal or metal vapors.

In some implementations, the seal can physically separate the current lead (e.g., a negative current collector, such as a metal rod that extends into the cell cavity) from the oppositely polarized (e.g., positive polarized) cell body (e.g., the cell (also “container” herein) and lid). The seal can act as an electrical insulator between these cell components, and hermetically isolate the active cell components (e.g., the liquid metal electrodes, the liquid electrolyte, and vapors of these liquids). In some examples, the seal prevents external elements from entering the cell (e.g., moisture, oxygen, nitrogen, and other contaminants that may negatively affect the performance of the cell). Some examples of general seal specifications are listed in TABLE 7. Such specifications (e.g., properties and/or metrics) can include, but are not limited to, hermeticity, electrical insulation, durability, Coulombic efficiency (e.g., charge efficiency or round-trip efficiency), DC-DC efficiency, discharge time, and capacity fade rate.

TABLE 7
EXAMPLES OF GENERAL SEAL SPECIFICATIONS

| | |
|---|---|
| Specification | Example Value |

The seal can have these properties under operating conditions:

| | |
|---|---|
| Hermetic | <1 × 10⁻⁸ atm cc/s He total |
| | leak rate |
| Electrically insulating | >1 kOhm impedance across seal |
| Durable | maintain integrity for >20 years |

Battery metrics:

| | |
|---|---|
| Coulombic efficiency | >98% (@ ~200 mA/cm²) |
| DC-DC efficiency | >70% (@ ~200 mA/cm²) |
| Discharge time | 4-6 hours (@ ~200 mA/cm²) |
| Capacity fade rate | <0.02%/cycle |

The seal can be hermetic, for example, to a degree quantified by a leak rate of helium (He) (e.g., leak rate from a device at operating conditions (e.g., at operating temperature, operating pressure, etc.) filled with He). In some examples, the leak rate of helium (He) can be less than about 1×10⁻⁶ atmospheric cubic centimeters per second (atm cc/s), 5×10⁻⁷ atm cc/s, 1×10⁻⁷ atm cc/s, 5×10⁻⁸ atm cc/s or 1×10⁻⁸ atm cc/s. In some examples, the leak rate of He is equivalent to the total leak rate of He leaving the system (e.g., cell, seal). In some examples, the leak rate of He is the equivalent total He leak rate if one atmosphere of He pressure was placed across the sealed interface, as determined from the actual pressure/concentration differential of He across the sealed interface and the measured He leak rate.

The seal can provide any suitably low helium leak rate. In some examples, the seal provides a helium leak rate of no more than or equal to about 1×10⁻¹⁰, 1×10⁻⁹, 1×10⁻⁸, 1×10⁻⁷, 5×10⁻⁷, 1×10⁻⁶, 5×10⁻⁶, 1×10⁻⁵ or 5×10⁻⁵ atmosphere-cubic centimeters per second (atm-cc/s) at a temperature (e.g., a storage temperature of the cell, an operating temperature of the cell, and/or a temperature of the seal) of greater than or equal to about −25 °C, 0 °C, 25 °C, 50 °C, 200 °C, 350 °C, 450 °C, 550 °C or 750 °C. The seal can provide such helium leak rates when the electrochemical cell has been operated (e.g., at rated capacity) for a period of, for example, at least about 1 hour, 12 hours, 1 day, 2 days, 3 days, 4 days, 5 days, 1 week, 2 weeks, 3 weeks, 1 month, 6 months, 1 year, 2 years, 5 years, 10 years, 20 years or more. In some examples, the seal provides such helium leak rates when the electrochemical cell has been operated for at least about 350 charge/discharge cycles (or cycles), 500 cycles, 1,000 cycles, 3,000 cycles, 10,000 cycles, 50,000 cycles, 75,000 cycles or 150,000 cycles.

In an example, the seal is substantially unreactive to air and prevents diffusion of air into the container when a reactive material is maintained at a temperature of at least about 200 °C, 250 °C, 300 °C, 350 °C, 400 °C, 450 °C, 500 °C, or greater. The seal may prevent diffusion of air into the container for at least about 1 hour, 12 hours, 1 day, 2 days, 3 days, 4 days, 5 days, 1 week, 2 weeks, 3 weeks, 1 month, 6 months, 1 year, 2 years, 5 years, 10 years, 20 years or more. The diffusion of air into the container may be at most about 1×10⁻⁴, 1×10⁻⁵, 1×10⁻⁶, 1×10⁻⁷, 1×10⁻⁸, 1×10⁻⁹, 1×10⁻¹⁰, or less atmosphere-cubic centimeters per second.

The seal can electrically isolate the conductor from the electrically conductive housing. The degree of electrical isolation can be quantified by measuring the impedance across the seal. In some examples, the impedance across the seal is greater than or equal to about 0.05 kilo-Ohms (kOhm), 0.1 kOhm, 0.5 kOhm, 1 kOhm, 1.5 kOhm, 2 kOhm, 3 kOhm, 5 kOhm, 10 kOhm, 50 kOhm, 100 kOhm, 500 kOhm, 1,000 kOhm, 5,000 kOhm, 10,000 kOhm, 50,000 kOhm, 100,000 kOhm or 1,000,000 kOhm at any operating, resting, or storing temperature. In some examples, the impedance across the seal is less than about 0.1 kOhm, 1 kOhm, 5 kOhm, 10 kOhm, 50 kOhm, 100 kOhm, 500 kOhm, 1,000 kOhm, 5,000 kOhm, 10,000 kOhm, 50,000 kOhm, 100,000 kOhm or 1,000,000 kOhm at any operating, resting, or storing temperature. The seal can provide electrical isolation when the electrochemical cell has been operated (e.g., at rated capacity) for a period of, for example, at least about 1 month, 6 months, 1 year or more. In some examples, the seal provides the electrical isolation when the electrochemical cell has been operated for at least about 350 charge/discharge cycles (or cycles), 500 cycles, 1,000 cycles, 3,000 cycles, 10,000 cycles, 50,000 cycles, 75,000 cycles or 150,000 cycles. The seal can provide electrical isolation when the electrochemical cell has been operated for a period of at least about 1 year, 5 years, 10 years, 20 years, 50 years or 100 years. In some examples, the seal provides the electrical isolation when the electrochemical cell has been operated for greater than or equal to about 350 charge/discharge cycles.

The seal can be durable. In some examples, the seal can maintain integrity for at least about 1 month, 2 months, 6 months, 1 year, 2 years, 5 years, 10 years, 15 years, 20 years or more. The seal can have such properties and/or metrics under operating conditions.

In some examples, a battery or device comprising the seal can have a Coulombic efficiency (e.g., measured at a current density of about 20 mA/cm², 200 mA/cm² or 2,000 mA/cm²) of at least about 50%, 55%, 60%, 65%, 70%, 75%, 80%, 85%, 90%, 95%, 96%, 97%, 98%, 99%, 99.5%, 99.8%, 99.9% or more. In some examples, a battery or device comprising the seal can have a DC-DC efficiency (e.g., measured at a current density of about 200 mA/cm² or 220 mA/cm²) of at least about 50%, 55%, 60%, 65%, 70%, 75%, 80%, 85%, 90%, 95% or more. In some examples, a battery or device comprising the seal can have a discharge time (e.g., measured at a current density of about 200 mA/cm² or 220 mA/cm²) of at least about 1 hour, 2 hours, 3 hours, 4 hours, 5 hours, 6 hours, 7 hours, 8 hours, 9 hours, 10 hours or more. In some examples, a battery or device comprising the seal can have a discharge time (e.g., measured at a current density of about 200 mA/cm² or 220 mA/cm²) between about 4 hours and 6 hours, 2 hours and 6 hours, 4 hours and 8 hours or 1 hour and 10 hours. In some examples, a battery or device comprising the seal can have a capacity fade rate (e.g., discharge capacity fade rate) of less than about 10%/cycle, 5%/cycle, 1%/cycle, 0.5%/cycle, 0.1%/cycle, 0.08%/cycle, 0.06%/cycle, 0.04%/cycle, 0.02%/cycle, 0.01%/cycle, 0.005%/cycle, 0.001%/cycle, 0.0005%/cycle, 0.0002%/cycle, 0.0001%/cycle, 0.00001%/cycle or less. The capacity fade rate can provide a measure of the change (decrease) in discharge capacity in ‘% per cycle’ (e.g., in % per charge/discharge cycle).

In some examples, the seal allows the electrochemical cell to achieve on one or more given operating conditions (e.g., operating temperature, temperature cycling, voltage, current, internal atmosphere, internal pressure, vibration, etc.). Some examples of operating conditions are described in TABLE 8. Such operating conditions can include, but are not limited to, metrics such as, for example, operating temperature, idle temperature, temperature cycling, voltage, current, internal atmosphere, external atmosphere, internal pressure, vibration, and lifetime.

TABLE 8
EXAMPLES OF OPERATING CONDITIONS FOR CELLS

| Item | Example description | Example metrics |
|---|---|---|
| Operating | The normal temperature | 440° C. to 550° C. |
| temperature | experienced by the seal | |
| | during operation. | |
| Idle | The temperature experienced | −25° C. to |
| temperature | by the seal while battery | 50° C. |
| | is idle (e.g., in | |
| | manufacturing, during transport, | |
| | battery in off-mode). | |
| Temperature | The seal can experience | −25° C. to |
| cycling | infrequent but large amplitude | 700° C. with at |
| | thermal cycles over the course | least about 10 |
| | of battery operating lifetime. | thermal cycles |
| Voltage | The voltage drop across the | 0 V to 3 V |
| | seal. | |
| Current | The electric current flowing | 0 A to 500 A |
| | through materials that | |
| | interface with the seal. | |
| Internal | The seal is exposed to vapors | 0.133 Pa or 0.001 |
| atmosphere | of reactive alkali metals or | torr vapor pressure |
| | reactive alkaline earth | of alkali metals or |
| | metals and halide salts from | alkaline earth |
| | within the battery. | metals and halide |
| | | salts |
| External | The atmosphere that the seal | Air at 0° C. to |
| atmosphere | is exposed to from the | 550° C. accompanied |
| | externals of the battery, | by 100% relative |
| | e.g., ambient air, high | humidity |
| | moisture. | |
| Internal | Vacuum gradient or positive | 0.5 atm to 4.0 atm |
| pressure | pressure across the seal. | |
| Vibration | The seal can be exposed to | Capable of handling |
| | vibrations caused during | vibrational loading |
| | manufacturing, transportation, | analogous to |
| | installation, operation, and | transportation when |
| | rare events (e.g., drops, | used in cell or |
| | shock impact). | system application. |
| Lifetime | The expected lifetime of a | 20 year life |
| | seal in full operation. | with <1% failure |

In some examples, an operating temperature (e.g., temperature experienced by the seal during operation) is at least about 100 °C, 200 °C, 300 °C, 400 °C, 500 °C, 600 °C, 700 °C, 800 °C, 900 °C or more. In some examples, the temperature experienced by the seal during operation is between about 440 °C and 550 °C, 475 °C and 550 °C, 350 °C and 600 °C or 250 °C and 650 °C. In an example, an operating temperature of about 400 °C to about 500 °C, about 450 °C to about 550 °C, about 450 °C to about 500 °C or about 500 °C to about 600 °C, or an operating temperature of at least about 200 °C. (e.g., suitable for cell chemistries that can operate as low as 200 °C) can be achieved. In some examples, the temperature experienced by the seal may be about equal to the operating temperature of the electrochemical cell or high temperature device (e.g., energy storage device). In some examples, the temperature experienced by the seal may differ from the operating temperature of the electrochemical cell or high temperature device (e.g., by at least, less than or equal to about 1 °C, 5 °C, 10 °C, 20 °C, 50 °C, 100 °C, 150 °C, 200 °C, and the like). In an example, an electrochemical cell comprises a reactive material maintained at a temperature (e.g., operating temperature of the cell) of at least about 200 °C, and the temperature of the seal is at least about 200 °C. (e.g., the same as the operating temperature of the cell, or different than the operating temperature of the cell). In some examples, the operating temperature of the seal can be lower or higher than the operating temperature of the electrochemical cell or high temperature device.

The chemical stability of the materials (e.g., cell lid assembly materials, adhesive seal material(s), etc.) can be considered (e.g., to ensure the durability of the seal during all possible temperatures that the system may reach). The seal may be exposed to one or more different atmospheres, including the cell internals (internal atmosphere) and open air (external atmosphere). For example, the seal can be exposed to typical air constituents including moisture, as well as to potentially corrosive active materials in the cell. In some implementations, a hermetic seal is provided. A hermetically sealed battery or battery housing can prevent an unsuitable amount of air, oxygen, nitrogen, and/or water from leaking or otherwise entering into the battery. A hermetically sealed battery or battery housing can prevent an unsuitable amount of one or more gases surrounding the battery (e.g., air or any component(s) thereof, or another type of surrounding atmosphere or any component(s) thereof) from leaking or otherwise entering into the battery. In some examples, a hermetically sealed cell or cell housing can prevent gas or metal/salt vapors (e.g., helium, argon, negative electrode vapors, electrolyte vapors) from leaking from the cell.

A hermetically sealed battery or battery housing may prevent an unsuitable amount of air, oxygen, nitrogen, and/or water into the battery (e.g., an amount such that the battery maintains at least about 80% of its energy storage capacity and/or maintains a round-trip Coulombic efficiency of at least about 90% per cycle when charged and discharged at least about 100 mA/cm² for at least about one year, 2 years, 5 years, 10 years or 20 years). In some instances, the rate of oxygen, nitrogen, and/or water vapor transfer into the battery is less than about 0.25 milli-liter (mL) per hour, 0.02 mL per hour, 0.002 mL per hour or 0.0002 mL per hour when the battery is contacted with air at a pressure that is at least about (or less than about) 0 atmospheres (atm), 0.1 atm, 0.2 atm, 0.3 atm, 0.4 atm, 0.5 atm, 0.6 atm, 0.7 atm, 0.8 atm, 0.9 atm or 0.99 atm higher than, or at least about (or less than about) 0.1 atm, 0.2 atm, 0.5 atm or 1 atm lower than the pressure inside the battery and a temperature of between about 400 °C and 700 °C. In some instances, the rate of metal vapor, molten salt vapor, or inert gas transfer out of the battery is less than about 0.25 mL per hour, 0.02 mL per hour, 0.002 mL per hour or 0.0002 mL per hour when the battery is contacted with air at a pressure of greater than or equal to about 0.5 atm, 1 atm, 1.5 atm, 2 atm, 2.5 atm, 3 atm, 3.5 atm or 4 atm less than the pressure inside the battery and a temperature between about 400 °C and 700 °C. In some examples, the number of moles of oxygen, nitrogen, or water vapor that leaks into the cell over a given period (e.g., at least about a 1 month period, 6 month period, 1 year period, 2 year period, 5 year period, 10 year period or more) is less than about 10%, 5%, 3%, 1%, 0.5%, 0.1%, 0.05% or 0.5% of the number of moles of active material (e.g., active metal material) in the cell.

The seal can meet one or more specifications, including, but not limited to: electrically insulating and hermetic, ability to function at operating temperature for duration of lifespan, thermal cycle-ability, sufficiently high electrical conductivity of the conductor (e.g., negative current lead), configuration that does not excessively protrude from cell body, inner surface chemically stable with liquids and vapors of active components, outer surface stable in air, ability to avoid arcing under high potentials, etc.

### Materials, Chemical Compatibility, and Coefficients of Thermal Expansion

Materials and features of seals herein may be configured to achieve suitable materials (e.g., chemical, mechanical, thermal) compatibility. Materials compatibility may include, for example, suitable matching of coefficients of thermal expansion (CTEs), suitable Young's modulus characteristics (e.g., low Young's modulus metal materials) and/or suitable ductility characteristics (e.g., one or more components with high ductility). Seals may incorporate structural features that can compensate for CTE mismatch.

Materials may be selected to achieve low CTE mismatch between various (e.g., pairs of) seal materials and/or housing (e.g., cell lid and/or body) materials. Materials may be selected to achieve low stress (e.g., stress due to CTE mismatch) at joint(s) between various (e.g., pairs of) seal materials and/or housing materials. A joint between various seal materials and/or housing materials may be of a given type (e.g., ceramic-to-metal or metal-to-metal). In an example, a ceramic material has a CTE that suitably (e.g., substantially) matches a CTE of a cell lid or body, thereby decreasing or minimizing stress(es) (e.g., stress(es) at one or more ceramic-to-metal joint(s) between the ceramic material and the cell lid or body). In some examples, a ceramic material has a CTE that is suitably (e.g., substantially) different than the CTE of the cell lid or body. In this instance, a metal collar or sleeve that is a better CTE match or has one or more other properties that reduce the ceramic-to-metal joint stress may be used. The metal collar or sleeve may move the CTE stress from the ceramic joint (e.g., from the ceramic-to-metal joint between the ceramic and the metal collar or sleeve) to the cell lid or body joint (e.g., to the metal-to-metal joint between the metal collar or sleeve and the cell lid or body). The ceramic material may have a CTE that suitably (e.g., substantially) matches a CTE of the metal collar or sleeve. The ceramic material may have a CTE that is suitably (e.g., substantially) different than the CTE of the metal collar or sleeve. The ceramic-to-metal seal joint stress(es) can be reduced, for example, by using a ductile metal collar or sleeve (e.g., comprising at least about 95% or 99% Ni) and/or by using a ductile braze material (e.g., comprising at least about 95% or 99% Ag, Cu or Ni). The ductile braze material may be used to reduce stress(es) at the ceramic-to-metal joint between the ceramic and the cell lid or body or to reduce stress(es) at the ceramic-to-metal joint between the ceramic and metal collar or sleeve.

The seal can be made of any suitable material (e.g., such that the seal forms a hermetic seal and an electrical isolation). In some examples, the seal comprises a ceramic material and a braze material. The ceramic material can have a CTE that is matched to the housing material such that the electrochemical cell maintains suitable gas-tight and/or electrically insulating properties during operation and/or start-up of the battery. The ceramic material may have a CTE that matches a CTE of the braze material and/or the cell top (e.g., lid or cap, or any component of a cell lid assembly) or body. In some examples, the CTEs of the ceramic material, braze material and cell top or body may not be identically matched, but may be sufficiently close to minimize stresses during the braze operation and subsequent thermal cycles in operation. In some examples, the CTE of the ceramic material may not be sufficiently close to the CTE of the cell top or body (e.g., in some cases resulting in an unstable and/or unreliable ceramic-to-metal joint which may lose its leak-tight property). The seal can comprise a collar (e.g., a thin metal collar) or sleeve (e.g., to overcome the CTE mismatch between a ceramic material and the cell lid or cell body). The collar or sleeve can be a metal collar or sleeve. The collar or sleeve can be brazed to the ceramic (e.g., via a braze material) and joined to the cell lid and/or the current lead that protrudes through the cell lid and into the cell cavity. A suitable collar or sleeve material and/or design may be selected in order to reduce the resulting stresses at the ceramic-to-metal joint (e.g., by reducing the CTE mismatch), increase the resulting stress at the collar or sleeve-to-cell lid or body joint (e.g., by increasing the CTE mismatch), or a combination thereof. The seal can comprise features that alleviate CTE mismatches between the ceramic and the cell lid and/or the current lead rod. Any aspects of the disclosure described in relation to the cell top or body (e.g., CTE, joint stress, configuration and/or formation, etc.) may equally apply to the cell top and body at least in some configurations. Any aspects of the disclosure described in relation to the cell top may equally apply to the cell body at least in some configurations, and vice versa.

The CTE of the metal collar or sleeve may be at least about 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The CTE of the metal collar or sleeve may be less than or equal to about 20 μm/m/°C, 19 μm/m/°C, 18 μm/m/°C, 17 μm/m/°C, 16 μm/m/°C, 15 μm/m/°C, 14 μm/m/°C, 13 μm/m/°C, 12 μm/m/°C, 11 μm/m/°C, 10 μm/m/°C, 9 μm/m/°C, 8 μm/m/°C, 7 μm/m/°C, 6 μm/m/°C or 5 μm/m/°C. In some examples, the metal collar or sleeve comprises Zr and has a CTE of less than or equal to about 7 μm/m/°C. In some examples, the metal collar or sleeve comprises Ni (e.g., at least about 95% or 99% Ni, or at least about 40% Ni and at least about 40% Fe by weight) and has a CTE of greater than or equal to about 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The metal collar or sleeve may comprise greater than or equal to about 5%, 10%, 15%, 20%, 25%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 65%, 70%, 75%, 80%, 85%, 90%, 95% or 99% Ni (e.g., by weight). The metal collar or sleeve may comprise such Ni compositions in combination with greater than or equal to about 5%, 10%, 15%, 20%, 25%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 65%, 70%, 75%, 80%, 85%, 90%, 95% or 99% Fe (e.g., by weight). Such Ni or Ni—Fe compositions (e.g., alloys) may comprise one or more other elements (e.g., C, Co, Mn, P, S, Si, Cr and/or Al) with individual concentrations or a total concentration of less than or equal to about 1%, 0.9%, 0.8%, 0.7%, 0.6%, 0.5%, 0.4%, 0.3%, 0.15%, 0.1%, 0.09%, 0.08%, 0.07%, 0.06%, 0.05%, 0.04%, 0.03%, 0.025%, 0.01% or 0.005%. In some examples, the metal collar or sleeve comprises greater than or equal to about 50.5% Ni, greater than or equal to about 48% Fe, and less than or equal to about 0.60% Mn, 0.30% Si, 0.005% C, 0.25% Cr, 0.10% Co, 0.025% P and/or 0.025% S (e.g., alloy 52). In some examples, the metal collar or sleeve comprises greater than or equal to about 41% Ni, greater than or equal to about 58% Fe, and less than or equal to about 0.05% C, 0.80% Mn, 0.40% P, 0.025% S, 0.30% Si, 0.250% Cr and/or 0.10% Al (e.g., alloy 42). In some examples, the metal collar or sleeve comprises an Fe alloy with between about 17.5% and 19.5% Cr, between about 0.10% and 0.50% Ti, between about 0.5% and 0.90% niobium, less than or equal to about 1% Ni, 1% Si, 1% Mn, 0.04% phosphorus, 0.03% nitrogen, 0.03% sulfur and/or 0.03% carbon, and a balance of Fe (e.g., 18CrCb ferritic stainless steel). Such Fe alloy (e.g., 18CrCb ferritic stainless steel) may have a CTE of about 8 ppm/K, 9 ppm/K, 10 ppm/K, 11 ppm/K or 12 ppm/K. In some examples, the metal collar or sleeve comprises an Fe alloy with between about 17.5% and 18.5% Cr, between about 0.10% and 0.60% Ti, between about 0.3% and 0.90% niobium, less than about 1% Si, 1% Mn, 0.04% phosphorus, 0.015% sulfur and/or 0.03% carbon, and a balance of Fe (e.g., grade 441 stainless steel). Such Fe alloy (e.g., 441 stainless steel) may have a CTE of about 9 ppm/K, 10 ppm/K, 11 ppm/K, 12 ppm/K, 13 ppm/K or 14 ppm/K. In some examples, the metal collar or sleeve comprises a Ni alloy with at least about 72% Ni, between about 14% and 17% Cr, between about 6% and 10% Fe, and less than about 0.15% C, 1% Mn, 0.015% S, 0.50% Si and/or 0.5% Cu (e.g., Inconel 600). Such Ni alloy (e.g., Inconel 600) may have a CTE of about 12 ppm/K, 13 ppm/K, 14 ppm/K, 15 ppm/K, 16 ppm/K or 17 ppm/K. In some examples, the metal collar or sleeve comprises a Ni alloy with less than about 0.05% C, 0.25% Mn and/or 0.002% S, less than or equal to about 0.20% Si, 15.5% Cr, 8% Fe and/or 0.1% Cu, and a balance of Ni and Co (e.g., ATI alloy 600). Such Ni alloy (e.g., ATI alloy 600) may have a CTE of about 12 ppm/K, 13 ppm/K, 14 ppm/K, 15 ppm/K, 16 ppm/K or 17 ppm/K. In some examples, the metal collar or sleeve comprises greater than or equal to about 67% Ni, less than about 2% Co, 0.02% C, 0.015% B, 0.35% Cu, 1.0% W, 0.020% P and/or 0.015% S, between about 14.5% and 17% Cr, between about 14% and 16.5% Mo, between about 0.2% and 0.75% Si, between about 0.30% and 1.0% Mn, between about 0.10% and 0.50% Al, between about 0.01% and 0.10% La, and less than or equal to about 3% Fe (e.g., Hastelloy S). Such alloy (e.g., Hastelloy S) may have a CTE of about 12 ppm/K, 13 ppm/K, 14 ppm/K, 15 ppm/K, 16 ppm/K or 17 ppm/K. The metal collar or sleeve may have the aforementioned CTE values for a temperature range of, for example, between about 25 °C and 400 °C, 20 °C and 500 °C, 25 °C and 500 °C, 25 °C and 600 °C, 25 °C and 900 °C, or 25 °C and 1000 °C.

The seal may comprise one or more braze materials (e.g., same or different braze materials at different joints when using a metal collar or sleeve, or one braze material when the joining the ceramic material directly to the cell lid or body). The CTE of a braze material may be at least about 3 microns per meter per degree Celsius (μm/m/° °C), 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The CTE of the braze material may be less than or equal to about 3 microns per meter per degree Celsius (μm/m/°C), 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The braze material may have such CTE values for a temperature range of, for example, between about 25 °C and 400 °C, 20 °C and 500 °C, 25 °C and 500 °C, 25 °C and 600 °C, 25 °C and 900 °C, or 25 °C and 1000 °C.

The stress(es) at the ceramic-to-metal joint may be reduced by using a braze material that is suitably (e.g., sufficiently) ductile. A ductile braze material may comprise silver (Ag), copper (Cu) and/or nickel (Ni). The braze material may comprise, for example, at least about 95% or 99% Ag (e.g., by weight), at least about 95% or 99% Cu (e.g., by weight) or at least about 95% or 99% Ni (e.g., by weight). The braze material may comprise any suitably ductile braze material described herein. The ductile braze material may have a yield strength of less than or equal to about 10 MPa, 20 MPa, 30 MPa, 40 MPa, 50 MPa, 60 MPa, 70 MPa, 80 MPa, 90 MPa, 100 MPa, 150 MPa, 200 MPa, 250 MPa, 300 MPa, 350 MPa, 400 MPa, 450 MPa, 500 MPa, 600 MPa, 700 MPa, 800 MPa, 900 MPa or 1000 MPa. The braze material may have such yield strengths at a temperature of, for example, greater than or equal to about 25 °C, 400 °C, 500 °C, 600 °C, 700 °C, 800 °C, 900 °C, 1000 °C or 1100 °C. In some examples, braze materials may be coated (e.g., Ni coated).

The seal may comprise one or more metallization materials (e.g., metallization powders). The CTE of a metallization material (e.g., after the metallization layer is formed) may be at least about 3 μm/m/°C, 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The CTE of the metallization material (e.g., after the metallization layer is formed) may be less than or equal to about 3 microns per meter per degree Celsius (μm/m/°C), 4 μm/m/°C, 5 μm/m/°C, 6 μm/m/°C, 7 μm/m/°C, 8 μm/m/°C, 9 μm/m/°C, 10 μm/m/°C, 11 μm/m/°C, 12 μm/m/°C, 13 μm/m/°C, 14 μm/m/°C, 15 μm/m/°C, 16 μm/m/°C, 17 μm/m/°C, 18 μm/m/°C, 19 μm/m/°C or 20 μm/m/°C. The metallization material may have such CTE values for a temperature range of, for example, between about 25 °C and 400 °C, 20 °C and 500 °C, 25 °C and 500 °C, 25 °C and 600 °C, 25 °C and 900 °C, or 25 °C and 1000 °C. The Young's modulus of a metallization material may be less than about 50 giga-Pascals (GPa), 75 GPa, 100 GPa, 150 GPa or 500 GPa. The metallization material may have such Young's modulus values for a temperature of, for example, 25 °C, 300 °C, 400 °C, 500 °C, 600 °C, 900 °C, or 1000 °C. The metallization material may be chemically stable in air and/or when exposed to reactive materials in the device at a temperature of greater than or equal to about 200 °C, 300 °C, 400 °C, 500 °C, 600 °C, 900 °C, or 1000 °C.

The seal may comprise a ceramic material and a braze material. In some examples, the ceramic material is stable (e.g., thermodynamically stable) when in contact with (e.g., does not chemically react with) one or more reactive materials (e.g., reactive liquid metals or reactive liquid metal vapors such as, for example, molten lithium, lithium vapor, or calcium metal). In some examples, the ceramic material (e.g., AlN, Nd₂O₃) is stable when in contact with air (or any other type of external atmosphere). In some examples, the ceramic material is stable with, is not substantially attacked by (e.g., the material may have a slight surface reaction, but does not progress into degradation or attack of the bulk of the material) and does not substantially dissolve into the molten salt. Examples of ceramic materials include, but are not limited to, aluminum nitride (AlN), beryllium nitride (Be₃N₂), boron nitride (BN), calcium nitride (Ca₃N₂), silicon nitride (Si₃N₄), aluminum oxide (Al₂O₃), beryllium oxide (BeO), calcium oxide (CaO), cerium oxide (CeO₂ or Ce₂O₃), erbium oxide (Er₂O₃), lanthanum oxide (La₂O₃), magnesium oxide (MgO), neodymium oxide (Nd₂O₃), samarium oxide (Sm₂O₃), scandium oxide (Sc₂O₃), ytterbium oxide (Yb₂O₃), yttrium oxide (Y₂O₃), zirconium oxide (ZrO₂), yttria partially stabilized zirconia (YPSZ), boron carbide (B⁻₄C), silicon carbide (SiC), titanium carbide (TiC), zirconium carbide (ZrC), titanium diboride (TiB₂), chalcogenides, quartz, glass, or any combination thereof. The ceramic material may be electrically insulating (e.g., the ceramic material may have a resistivity greater than about 10² Ohm-cm, 10⁴ Ohm-cm, 10⁶ Ohm-cm, 10⁸ Ohm-cm, 10¹⁰ Ohm-cm, 10¹² Ohm-cm, 10¹⁴ Ohm-cm or 10¹⁶ Ohm-cm). The ceramic material may have a CTE that is (e.g., substantially) similar to (e.g., less than or equal to about 0.1%, 0.5%, 1%, 2%, 3%, 4%, 5%, 6%, 7%, 8%, 9%, 10%, 15%, 20%, 25%, 30%, 35%, 40%, 45% or 50% different than) a CTE of stainless steel (e.g., grade 430 stainless steel, 441 stainless steel or 18CrCb ferritic stainless steel) or nickel alloy (e.g., an alloy comprising greater than or equal to about 50% Ni and greater than or equal to about 48% Fe, such as, for example, alloy 52).

In some examples, the braze material comprises one or more braze constituents such that at least one braze constituent has low solubility in the reactive material, the reactive material has low solubility in at least one braze constituent, at least one braze constituent does not react (e.g., form intermetallic alloys with) the reactive material at the operating temperature of the device, and/or the braze material melts above the operating temperature of the device. The reactive material can be, for example, a reactive metal. In some examples, the braze material comprises at least one braze constituent that has low solubility in the reactive metal. In some examples, the reactive metal has low solubility in the braze constituent. In some examples, the braze constituent does not form intermetallic alloys with the reactive metal at the operating temperature of the device. In some examples, the braze constituent and/or braze material melts above the operating temperature of the device. In some examples, the braze constituent(s) may include Ti, Ni, Y, Re, Cr, Zr, and/or Fe and the reactive metal may include lithium (Li) and/or calcium (Ca).

Examples of braze constituent materials include, but are not limited to, aluminum (Al), beryllium (Be), copper (Cu), chromium (Cr), iron (Fe), manganese (Mn), molybdenum (Mo), nickel (Ni), niobium (Nb), rubidium (Rb), scandium (Sc), silver (Ag), tantalum (Ta), rhenium (Re), titanium (Ti), vanadium (V), yttrium (Y), zirconium (Zr), phosphorus (P), boron (B), carbon (C), silicon (Si), or any combination thereof. In some instances, the ceramic material comprises aluminum nitride (AlN) and the braze material comprises titanium (Ti). In some examples, the braze material comprises a mixture of two or more materials (e.g., 3 materials). The materials may be provided in any proportion. For example, the braze can comprise 3 materials at a ratio (e.g., in weight-%, atomic-%, mol-% or volume-%) of about 30:30:40 or 40:40:20. In some examples, the braze material comprises a mixture of titanium, nickel, copper, and/or zirconium. In some instances, the braze comprises at least about 20, 30 or 40 weight-% titanium, at least about 20, 30% or 40 weight-% nickel, and at least about 20, 30, 40, 50 or 60 weight-% zirconium. In some instances, the braze comprises less than about 20, 30 or 40 weight-% titanium, less than about 20, 30% or 40 weight-% nickel, and less than about 20, 30, 40, 50 or 60 weight-% zirconium. In some instances, the braze comprises about 18% Ti, about 60% Zr, about 22% Ni (e.g., on a weight-%, atomic-%, mol-% or volume-% basis). In some instances, the braze comprises about 7% Ti, about 67% Zr, and about 26% Ni (e.g., on a weight-%, atomic-%, mol-% or volume-% basis). In some instances, the braze comprises at least about 5, 10, 15, 20, 25, 30, 35, 40, 45, 50, 55, 60, 65, 70, 75, 80, 85, 90, 95 or more weight-%, atomic-%, mol-% or volume-% of titanium, nickel or zirconium (or any other braze material herein). In some examples, the braze comprises about 19-21 weight percent (wt %) Zr, 19-21 wt % Ni, 19-21 wt % Cu, and the remainder comprises mostly of or all of Ti (i.e., ‘TiBraze 200’). In some examples, the braze comprises about 61-63 wt % Zr, 19-21 wt % Ni, and the remainder comprises mostly of or all of Ti (i.e., ‘TiZrNi’ braze). In some examples, the braze comprises about 29-31 wt % Ni and the remainder comprises mostly or all of Ti (i.e., ‘TiNi-70’ braze). In some examples, the braze comprises at least about 10 wt % or 15 wt % Ti (i.e., ‘Ti braze alloy’). In some instances, the braze comprises less than or equal to about 5, 10, 15, 20, 25, 30, 35, 40, 45, 50, 55, 60, 65, 70, 75, 80, 85, 90, 95 or more weight-%, atomic-%, mol-% or volume-% of titanium, nickel or zirconium (or any other braze material herein). In some examples, the braze comprises greater than about 70 wt %, greater than about 74 wt %, greater than about 78 wt %, greater than about 82 wt %, greater than about 86 wt %, greater than about 90 wt %, greater than about 94 wt %, or more nickel. In some examples, the braze comprises between about 70 wt % and 80 wt %, between about 70 wt % and 90 wt %, between about 70 wt % and 95 wt %, between about 80 wt % and 90 wt %, or between about 80 wt % and 95 wt % nickel. In some examples, the braze comprises between about 82 wt % and 94 wt % nickel. In some instances, the braze comprises greater than or equal to about 70 wt % Ni (“BNi braze” herein). In some instances, the braze comprises greater than or equal to about 82% Ni, and less than or equal to about 7% Cr, 3% Fe, 4.5% Si, 3.2% B and/or 0.06% C (e.g., BNi-2 braze). In some instances, the braze comprises greater than or equal to about 82% Ni, and less than or equal to about 15% Cr, 4.0% B and/or 0.06% C (e.g., BNi-9 braze). In some instances, the braze comprises greater than or equal to about 82% Ni, and less than or equal to about 15% Cr, 7.3% Si, 0.06% C and/or 1.4% B (e.g., BNi-5b braze). In some instances, the braze comprises yttrium, chromium or rhenium, and nickel. In some examples, the braze comprises silver (Ag) and aluminum (Al) and may also comprise titanium. The braze may comprise about 5:1, 6:1, 7:1, 8:1, 9:1, 10:1, 11:1, 12:1, 13:1, 14:1, 15:1, 16:1, 17:1, 18:1, 19:1, 20:1, 25:1, or greater ratio of silver to aluminum (Ag:Al). In some examples, the braze comprises a ratio of about 19:1 Ag:Al by weight or volume (e.g., about 95 wt % Ag to about 5 wt % Al) and may also comprise other additives, such as Ti.

To facilitate the use of certain braze materials (e.g., non-active braze materials) to bond the ceramic material to a metal collar or sleeve, a layer comprising metal (also “metallization layer” and “pre-metallization layer” herein) may first be applied to the ceramic material via a pre-metallization step (e.g., the metallization layer may be applied to the ceramic material by a coating process). For example, a metallization layer with a controlled layer thickness may be applied onto the ceramic material by sputter-coating or by vacuum or controlled atmosphere (e.g., Ar or N₂ with H₂ gas) high temperature thermal treatment (e.g., sintering the metallization layer onto the ceramic) without bonding a metal collar or sleeve to the braze material. The pre-metallization step may enable, for example, a subsequent brazing step to bond the pre-metallized ceramic surface to a metal collar or sleeve by using a braze material that may not bond to the ceramic material directly (e.g., the braze material may not bond to the ceramic material without a metallization layer).

A metallization layer may comprise metallization material (also “pre-metallization material” herein). As described in greater detail elsewhere herein, the metallization material may include one or more metal and/or non-metal materials (e.g., one or more metals, ceramics, silicon oxide glass, etc.). Application of a metallization material may result in formation of one or more layers of the pre-metallization layer. The sublayer(s) may be formed in one step (e.g., a processing step using a single metallization material may result in the formation of two sublayers) or may result from multiple processing steps (e.g., multiple processing steps using different metallization materials). A metallization material may include a braze material. For example, at least a portion (e.g., some portion) of the braze material (e.g., yttrium, titanium or aluminum) may be applied as metallization material via a pre-metallization step. In some instances, a pre-metallization material may be referred to as a pre-metallization braze material. The metallization material may be different from a braze material. In some instances, a material may be referred to as a metallization material instead of a braze material. For example, when applying a metal coating as a powder and bonding that powder to the ceramic, the powder may be referred to as a metallization powder rather than a braze powder. Such nomenclature may distinguish between a braze material that may melt during a thermal process onto the ceramic and/or metal, and a metallization material (e.g., powder) that may effectively sinter onto the ceramic during a thermal process and may not melt (e.g., may not fully melt) during the thermal process.

In some implementations, a ceramic-to-metal brazed joint may be formed by a metallization process followed by a brazing process. In some implementations, the metallization step may not be included and the ceramic-to-metal brazed joint may be formed directly by an active braze step (e.g., using a Ti-containing braze).

The ceramic material may comprise AlN. The ceramic material may comprise a primary ceramic material (e.g., AlN), and one or more secondary ceramic materials (e.g., Y₂O₃, SiC, or combinations thereof). The ceramic material may be substantially or wholly formed of the primary ceramic material. The ceramic material may comprise various levels of secondary ceramic material(s). For example, the ceramic material may comprise a first secondary ceramic material and a second secondary ceramic material. The ceramic material may comprise the first secondary ceramic material (e.g., Y₂O₃) at a concentration greater than or equal to about 3 wt %. As an alternative, the ceramic material may comprise the first secondary ceramic material (e.g., Y₂O₃) at a concentration less than about 3 wt %. The ceramic material may comprise the first secondary ceramic material in combination with at least the second secondary ceramic material (e.g., SiC), the second secondary ceramic material being at a concentration greater than or equal to about 25 wt % (or 25 volume-% (also “v %,” “vol %” and “volume percent” herein). In some examples, the ceramic material may comprise AlN as a primary ceramic material, and about 1 wt % to 5 wt % Y₂O₃ as a second ceramic material.

The braze can be a passive braze or an active braze. Passive brazes can melt and wet a ceramic material or wet a ceramic material that has a metallization layer deposited onto it. Copper and silver are examples of passive brazes. Active brazes can react with the ceramic (e.g., chemically reduce the metal component of the ceramic (e.g., Al is reduced from AlN)). In some examples, active brazes can comprise a metal alloy having an active metal species such as titanium (Ti) or zirconium (Zr) that reacts with the ceramic material (e.g., AlN+Ti→Al+TiN or AlN+Zr→Al+ZrN or 2Nd₂O₃+3Ti→4Nd+3TiO₂). The active braze can further comprise one or more passive components (e.g., Ni). The passive component(s) can, for example, reduce the melting point of the braze and/or improve the chemical stability of the braze. In some examples, the active metal braze beads up on the ceramic and/or does not wet the ceramic.

The seal can be welded or brazed to the electrically conductive housing, cell (housing) lid, and/or the conductor. In some examples, the electrically conductive housing and/or the conductor comprises 400-series stainless steel, 300-series stainless steel, nickel, steel, or any combination thereof. In some examples the electrically conductive housing and/or the conductor comprises a low-carbon stainless steel, such as 304L stainless steel (304L SS), for example. Low carbon stainless steel (e.g. 304L SS) can also be used in the metal collar and/or sleeves of the seal. In some examples, the sleeves comprise alloy 42 and the collar and conductor comprise low carbon stainless steel (e.g. 304L SS) and/or steel (e.g., mild steel). In some examples, the conductor comprises a Ni coating (e.g., Ni-plated mild steel). In some examples, a low carbon stainless steel may reduce unwanted chemical reactions with the reactive material inside a cell.

In some examples, the sleeve or collar materials can include, for example, 304 stainless steel, 304L stainless steel, 430 stainless steel (430 SS), 410 stainless steel, alloy 42, alloy 52, and nickel-cobalt ferrous alloy. In some examples, the sleeve or collar components may include a coating, such as a Ni coating (e.g., Ni-coated alloy 42). The braze materials can include, for example, nickel-100, molybdenum (Mo) and tungsten (W). The ceramic materials can include, for example, aluminum nitride (AlN), aluminum oxide (Al₂O₃), boron nitride (BN) in the direction parallel to the grain orientation, boron nitride (BN) in the direction perpendicular to the grain orientation, yttrium oxide (Y₂O₃) and yttria partially stabilized zirconia (YPSZ).

In some examples, the electrically conductive components of the seal comprise a metal with low CTE (e.g., less than about 1 ppm/°C, 2 ppm/°C, 3 ppm/°C, 4 ppm/°C, 5 ppm/°C, 6 ppm/°C, 7 ppm/°C, 8 ppm/°C, 9 ppm/°C, 10 ppm/°C, 11 ppm/°C, 12 ppm/°C or 15 ppm/°C), low Young's modulus (e.g., less than about 0.1 GPa, 0.5 GPa, 1 GPa, 10 GPa, 50 GPa, 100 GPa, 150 GPa, 200 GPa or 500 GPa), high ductility (e.g., an ultimate strength greater than about 100%, 200%, 300%, 400% or 500% that of the yield strength), or any combination thereof. In some examples, the ultimate strength can be greater than about 50%, 100% or 200% that of the yield strength of the material for it to have sufficient ductility. In some examples, the electrically conductive components do not comprise an electrically conductive ceramic. Low CTE, low Young's modulus and/or high ductility component characteristics can lead to low stress concentrations in the ceramic. Low Young's modulus component characteristics can result in less stress generated between components with different CTE values (e.g., for a given CTE mismatch between two materials that are bonded together, if at least one material has a low Young's modulus, the strain generated by the CTE difference can cause the material with the low Young's modulus to “stretch,” resulting in a relatively small stress force between the two materials). Low CTE, low Young's modulus and/or high ductility component characteristics may reduce likelihood of failure (e.g., due to reduced stress concentrations and/or less stress generated). Metals that meet these specifications (in addition to corrosion resistance to the internal and external cell environment) can include, for example, zirconium (Zr), high-zirconium content alloys, tungsten (W), titanium (Ti), niobium (Nb), tantalum (Ta), nickel (Ni) and/or molybdenum (Mo).

In some implementations, the seal comprises a ceramic, one or more braze materials and one or more metal collars. For example, two metal collars may be joined to the ceramic, one to each side of the ceramic. Each such metal collar may be further joined to additional metal collar(s). Thus, a compound metal collar may be created that comprises two or more metal collars. In some examples, the compound metal collar comprises at least two metal collars, of which at least one metal collar comprises a material that is suitably joined (e.g., using one type of braze) to the ceramic and at least one metal collar comprises a material that is suitably joined to another component of the seal or of the cell (e.g., using another type of braze). The two metal collars may also be joined (e.g., using yet another type of braze). In some instances, at least a portion (e.g., all) of the brazes used to join the metal collars of the seal to each other and/or to other parts of the cell may be of the same type. In some examples, at least a portion or all of the brazes may be of different types. Further, one or more of the metal collars may be welded rather than brazed, or welded and brazed. The seal may comprise one or more compound metal collars. In some examples, the seal comprises at least about 1, 2, 3, 4, 5, 6, 7, 8, 9, 10, 12, 14, 16, 18, 20 or more individual metal collars. In an example, the seal comprises 3 or 4 individual metal collars forming two compound metal collars. In some examples, at least a portion of the individual metal collars may comprise the same material. For example, metal collars comprising the same material may be used for joining metal collars to similar materials (e.g., similar cell housing or conductors materials).

In some examples, the seal comprises a ceramic, a braze material, a first (e.g., thin) metal collar, and/or a second metal collar. The first metal collar may be brazed to the ceramic, and the second metal collar may be brazed to the first metal collar. In some examples, the first metal collar is a low CTE material such as alloy 42, zirconium (Zr) or tungsten (W) and the second metal collar is a ferrous alloy, such as steel, stainless steel, a 300 series stainless steel (e.g., 304L stainless steel), or 400 series stainless steel (e.g., 430 stainless steel). In some examples, the first metal collar is less than about 2 micro-meters (μm, or microns) thick, 5 μm, 10 μm, 20 μm, 50 μm, 100 μm, 150 μm, 250 μm, 500 μm, 1,000 μm, μm, 1,500 or 2,000 μm thick.

In some examples, the seal comprises a ceramic, a braze, a first metal collar, a second metal collar and a third metal collar. The first metal collar may be joined to one part of the ceramic, and the second metal collar may be joined to the first metal collar. The third metal collar may be joined to a different part of the ceramic such that the first metal collar and the third metal collar are separated by an electronically insulating ceramic material. Joints between the first metal collar and the ceramic and between the third metal collar and the ceramic may both be hermetic. In some examples, the seal further comprises a fourth metal collar that is joined to the third metal collar (e.g., the first metal collar is joined to one part of the ceramic, the second metal collar is joined to the first metal collar, the third metal collar is joined to another part of the ceramic and the fourth metal collar is joined to the third metal collar). The braze material used to join the first metal collar to the second metal collar may comprise or be similar to any of the braze compositions described herein. The first metal collar or the second metal collar may be joined (e.g., using a braze composition similar to any of the braze compositions described herein, or welded) to the cell lid. The third metal collar may be joined to the fourth metal collar or directly to a negative current lead (e.g., brazed using any of the braze compositions of the disclosure).

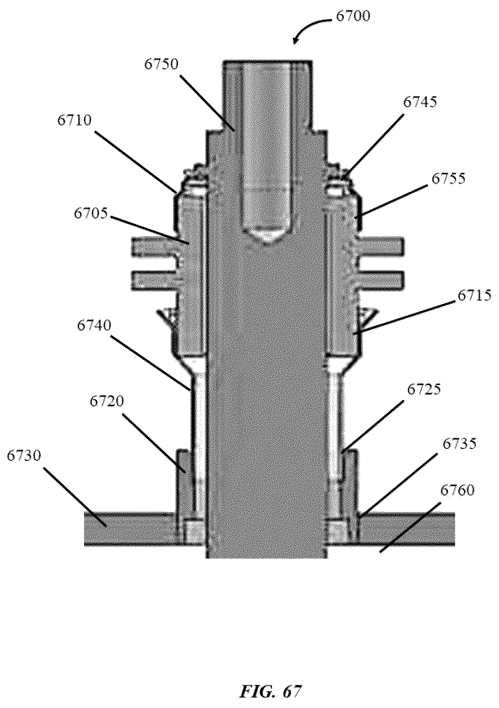

FIG. 67 is a cross-section of a radially symmetric example of a seal 6700 comprising a ceramic component 6705. The ceramic component can comprise aluminum nitride (AlN), for example. In some examples, the ceramic component can comprise yttrium oxide (Y₂O₃). In an example, the ceramic component comprises about 3 weight percent or more yttrium oxide. In some examples, the ceramic component comprises about 1 percent to about 4 percent yttrium oxide. The ceramic component 6705 is joined with a first metal sleeve (e.g., Ni-plated alloy 42) 6710 via a first metal-to-ceramic joint (e.g., braze) 6755. The seal further comprises a second metal sleeve (e.g., Ni-plated alloy 42) 6740 joined to the ceramic component 6705 via a second metal-to-ceramic joint (e.g., a first braze alloy) 6715. The first and second metal-to-ceramic joints 6755 and 6715 can comprise a first braze alloy of silver and aluminum (Ag—Al), for example. The first and second metal-to-ceramic joints 6755 and 6715 may comprise a first braze alloy and an internal braze alloy. The first braze alloy may be exposed to the environment external to the container (e.g., ambient air) and the internal braze alloy may be exposed to the internal environment of the container (e.g., high temperature reactive materials). The first braze alloy may comprise a ductile material. The first braze may be an alloy of at least two different metals. The first braze alloy can have a ratio of silver to aluminum of less than 19 to 1; for example, the first braze alloy can contain about 95% silver or less. The first braze alloy can further comprise a wetting agent. For example, the wetting agent can comprise titanium or titanium hydride. In some examples, the wetting agent can be provided as a metallization layer for the first braze alloy. The metal sleeves 6710 and 6740 can be brazed to the outer surface of the ceramic component, for example.

The first and/or second metal-to-ceramic joint(s) 6755 and 6715 may also comprise an internal braze alloy. The internal braze alloy may be at or adjacent to an internal surface of the first and/or second metal-to-ceramic joint(s) 6755 and 6715. The internal braze alloy may be more chemically stable than the first braze alloy. The internal braze may be an alloy of at least two different metals. The internal braze alloy may comprise a brittle material. The internal braze alloy may be an active metal braze. The internal braze alloy may be stable when exposed to the reactive metal materials internal to the sealed container (e.g., high temperature battery cell). The internal braze alloy may form a protective barrier between the reactive materials and the first braze alloy. The first braze alloy may be exposed to air external to the sealed container and may provide a barrier between the ambient air and the internal braze alloy. The internal braze alloy may comprise a Ni-based braze alloy (e.g., BNi-2, BNi-7, BNi-9) or a Ti braze alloy (e.g., TiBraze 200, TiZrNi, TiNi-70). The bottom metal-to-ceramic joint 6715 may comprise the first braze alloy of silver and aluminum and the top metal-to-ceramic joint 6755 may comprise both a first braze alloy of silver and aluminum (e.g., about 95% Ag and 5% Al), and an internal braze alloy of a Ti braze alloy (e.g., TiBraze200). The internal braze alloy may be exposed to the reactive materials (e.g., reactive metal vapors and/or salt vapors and/or liquid) in the sealed container and may not be exposed to air outside the sealed container. The first braze alloy in the top metal-to-ceramic joint 6755 may be exposed to air outside the sealed container and not exposed to the reactive materials in the sealed container. In some examples, the bottom metal-to-ceramic joint 6715 may also comprise a first and an internal braze alloy (as described above for joint 6755).

The first metal sleeve 6710 is joined with a conductor (e.g., a current lead, such as a negative current lead) 6750 via a first metal-to-metal joint (e.g., weld, braze) 6745. The conductor can comprise a low-carbon stainless steel, such as 304L stainless steel, for example, or mild steel or Ni alloy (e.g., Ni 201). The second metal sleeve 6740 is joined with a metal collar (e.g., 304L SS) 6720 via a second metal-to-metal joint (e.g., weld, braze) 6725. The metal collar 6720 is joined to the container (e.g. at the cell lid, comprising, e.g., 304L SS) 6730 via a third metal-to-metal joint (e.g., weld, braze) 6735. The seal encloses a chamber 6760 of the container, which can contain a reactive material, such as reactive liquids and gasses of an electrochemical cell, for example.

The metal-to-metal joints can comprise a BNi braze comprising 70 wt % or more of Ni; for example, a BNi-2, BNi-5b, or BNi-9 braze, a titanium-based braze alloy (e.g., TiBraze 200, TiZrNi, TiNi-70, a silver-aluminum braze alloy (e.g., an alloy with a 19:1 ratio of Ag:Al), a silver alloy, an aluminum alloy, an alloy that contains at least silver, and/or an alloy that contains at least aluminum. In some embodiments, the second metal-to-metal joint comprises a BNi braze or a titanium-based braze alloy (e.g., TiBraze 200). In some embodiments, the first and second metal-to-metal joints comprise a BNi braze or a Ti braze alloy. In some embodiments, each metal-to-metal joint comprises a BNi braze, a Ti braze alloy, and/or a Ag—Al braze alloy. In some examples, the metal collar 6720 is welded to the container, or is formed integrally as part of the container.

Although described as metal sleeves, in some embodiments one or both of metal sleeves 6710 and 6740 can be provided as a metal collar. In various embodiments, the seal illustrated in FIG. 67 can comprise a variety of materials. In one example, the ceramic component 6705 comprises an Al₂O₃ ceramic, joints 6715 and 6755 comprise a Cu—Ag braze, and metal sleeves 6710 and 6740 comprise a Fe—Ni alloy (e.g., a Fe—Ni sleeve or collar). In one example, the ceramic component 6705 comprises an AlN ceramic, joints 6715 and 6755 comprise a copper braze with a metallization layer comprising Ni-plating, and metal sleeves 6710 and 6740 comprise nickel metal (e.g., a Ni metal sleeve or collar). In one example, the ceramic component 6705 comprises an AlN ceramic, joints 6715 and 6755 comprise a Cr—Ni braze with a metallization layer, and metal sleeves 6710 and 6740 comprise nickel metal (e.g., a Ni metal sleeve or collar).

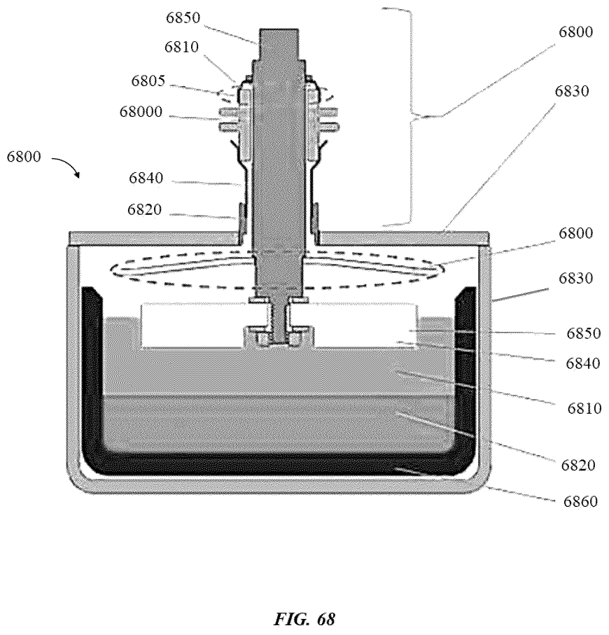

Seal 6700 can be incorporated into an electrochemical cell 6800, optionally in combination with additional features as illustrated in FIG. 68. Electrochemical cell 6800 comprises a container including a lid 6730 and can 6830. The container contains a reactive material held at high temperature (e.g., greater than 200 °C) when operating. The reactive material comprises an electrolyte 6810 (e.g. a salt) in contact with a positive electrode 6820 (e.g., Pb—Sb, Bi, Sb, or FeS₂) and a negative electrode 6840 (e.g., Li, Na, Mg, Ca). A negative current collector 6850 (e.g., a foam) connects the negative electrode to a negative current lead 6750, which extends through a seal 6700 to the outside environment. A liner 6860 (e.g., a graphite crucible) can be provided between the can 6830 and active cell components (e.g., electrolyte 6810 and positive electrode 6820).

A seal 6700 may comprise multiple features as illustrated in FIG. 68. In one example, the ceramic component 6705 comprises AlN ceramic, joints 6715 and 6755 comprise Al—Ag braze activated with Ti, TiH₂, and/or a Ti braze alloy, and metal sleeves 6710 and 6740 comprise alloy 42 metal alloy with a layer of nickel on its surface (e.g., Ni plated alloy 42 metal sleeve(s)). The thickness of the metal sleeve components 6710 and 6740 may be less than about 0.030 inches. In some examples, the thickness of the metal sleeve is less than or equal to about 0.025 inches, 0.02 inches, 0.015 inches, 0.01 inches or less. In some examples, the thickness of the metal sleeve is between about 0.01 inches and 0.015 inches, between about 0.01 inches and 0.02 inches, or between about 0.01 inches and 0.025 inches. In one example, the ceramic component comprises physical ion blocking features 1000 (as further described below) that may prevent or inhibit the formation of metal dendrites along the surface of the ceramic. In one example, the current lead 6750 (e.g., negative current lead) comprises a Ni alloy, steel (e.g., mild steel), or stainless steel (e.g., 304L SS alloy), and a stainless steel (e.g., 304L SS) metal collar 6720. The current lead 6750 may comprise a feature, such as a shoulder, that is an integral part of the current lead and serves as the surface for brazing the top metal sleeve 6710. The top metal-to-metal joint 6745 between the current lead 6750 and the top metal sleeve 6710 may comprise Ag—Al braze (e.g., ~95% Ag and ~5% Al), may comprise a Ni-based braze alloy (e.g., BNi-9 braze), or may comprise a Ti-based braze alloy (e.g., TiBraze 200), for example. The bottom metal-to-metal joint 6725 between the bottom metal sleeve 6740 and the metal coupler 6720 may comprise Ag—Al braze (e.g., ~95% Ag and ~5% Al) or may comprise a Ni-based braze alloy (e.g., BNi-9 braze) or a Ti braze alloy (e.g., TiBraze 200), for example.

The container of the cell can comprise a gas portion within between the liquid portion and the seal. In some examples, reactive material from the liquid portion can evaporate into the gas portion, eventually coming into contact with the seal. Additionally, liquid and/or ions can flow from the negative electrode along the surface of the negative current lead toward the seal. These processes can cause undesirable corrosion when particles of reactive material contact the seal. Accordingly, a shield 500 can be provided to inhibit the flow of vapor, liquid, and/or ions from the liquid portion to the seal.

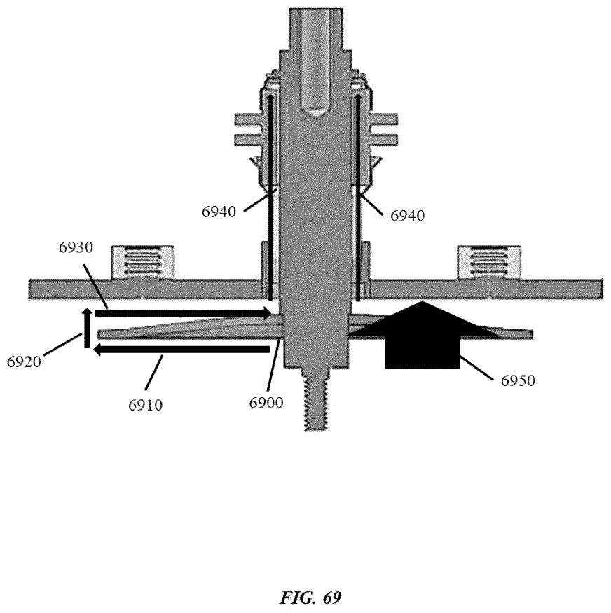

FIG. 69 illustrates an electrochemical cell comprising a shield 6900 shaped to inhibit or obscure the flow of vapor from the liquid portion to the seal. The shield 6900 extends into a gas portion between the liquid portion and the seal. For a vapor to flow from the liquid portion (e.g., at a point near the center) at the bottom of the image to the seal at the top, the vapor may follow a path outwards, around the shield, then back inwards toward the center, and up to the top of the seal. This path is illustrated by paths 6910, 6920, 6930, and 6940 respectively. The shield may either partially or fully obscure and/or block the seal and the liquid portion from each other. B_{y} contrast, if the shield is absent, the gas flows directly upwards along path 6950, then shares path 6940 to the seal. The latter path may provide less impedance to the flow of the gas, as discussed in greater detail below.

The shield can force the gas to flow along a narrow path for each segment by allowing a small gap between the shield and surrounding walls; in general, the width of this path can be assigned to a parameter, w, which can have a variable value (for example, in some cases w is less than or equal to about 1 cm, or less than or equal to about 2 mm, or less than or equal to about 1 mm). The amount of gas flowing along an infinitesimal distance dL of one of the paths can be proportional to the cross sectional area through which the path flows. The smaller the area, the more restricted the gas flow may be; additionally, the longer the length over which the gas flows, the more its flow may be slowed. The shield may extend from the conductor. The shield may extend a distance from the conductor that is greater than or equal to about 1 time, 1.5 times, 2 times, 3 times, 4 times, 5 times, or move the width of the conductor. In some examples, the shield extends from the conductor to within an infinitesimal distance of the container wall.

The degree to which gas flow is subjected to a longer path as a result of a shield can be estimated by a parameter called the “effective gas diffusion path” or EGDP. The EGDP can be defined as an integral along a path between two points (e.g., from the liquid to the seal) of the inverse cross-sectional area through which a gas following the path can flow. For example, on path 6910 in a circularly symmetric cell, at a radius r from the center, and with a path width w, the area can be estimated as the width w times the circumference of a circle of radius r. Under this assumption of radially symmetric cell/shield geometry, the infinitesimal EGDP can then be approximated as

$$\frac{d r}{2 π r w} ,$$

and the full EGDP can be estimated by the integral

$$\int \frac{d r}{2 π r w}$$

over each path. The units of EGDP are 1/length, and larger values of EGDP may correspond to longer effective distances over which vapor may flow. For example, given a path from the inner radius r₁ of the current lead to an outer radius 12 of the can and back (approximating paths 6910, 6920, and 6930, with path 6920 along a length L at radius r₂), the EGDP for the portion of the path from the liquid to the seal can be estimated as

$$\frac{1}{2 π w}$$

ln

$$\frac{{r}_{2}}{{r}_{1}} + \frac{L}{2 π w {r}_{2}}$$

(neglecting second order terms, e.g., O(w²). A similar integral performed for path 6950, traveling up a distance L in an annular region between r₁ and r₂, gives an EGDP of

$$\frac{L}{π ( {r}_{2}^{2} - {r}_{1}^{2} )} ,$$

which may be a significantly smaller value than with a shield. Path 6940 within the seal is common to both configurations, and so can be neglected. For example, a shield can increase the EGDP from a liquid portion to a seal by greater than or equal to about 10 percent, about 15 percent, about 20 percent, about 30 percent, or about 50 percent relative to the same cell without a shield. For example, a simple shield such as the one depicted in FIG. 69 can increase EGDP of a cell from about 6.35 cm⁻¹ to about 7.30 cm⁻¹ or more. In some examples, the EGDP from the liquid portion to the seal is at least about 1 cm⁻¹, 2 cm⁻¹, 3 cm⁻¹, 4 cm⁻¹, 5 cm⁻¹, 6 cm⁻¹, 7 cm⁻¹, or more. In an example, the EGDP from the liquid portion to the seal is 7 cm⁻¹ or more.

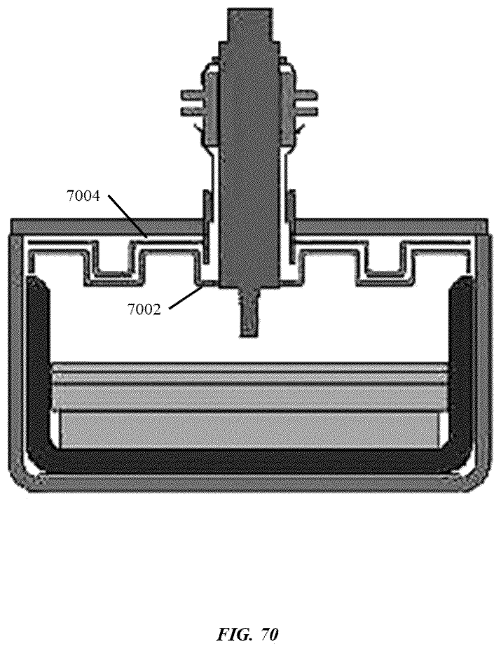

Further increases in EGDP can be achieved using more complex shield designs. For example, FIG. 70 illustrates a cell comprising a more complex shield system comprising a plurality of shields. A first shield 6902 is attached to the negative current lead in the center, and a second shield 6904 is attached to the walls of the cell container, joined to the lid. The two shields comprise a plurality of alternating convex and concave portions to provide a long and winding path from the liquid portion to the seal. The path can be S-shaped, for example. Such a path can have a length greater than or equal to about 1.2 times, 1.5 times, 1.7 times, 2 times, 3 times, or 5 times as long as a width of the container, for example.

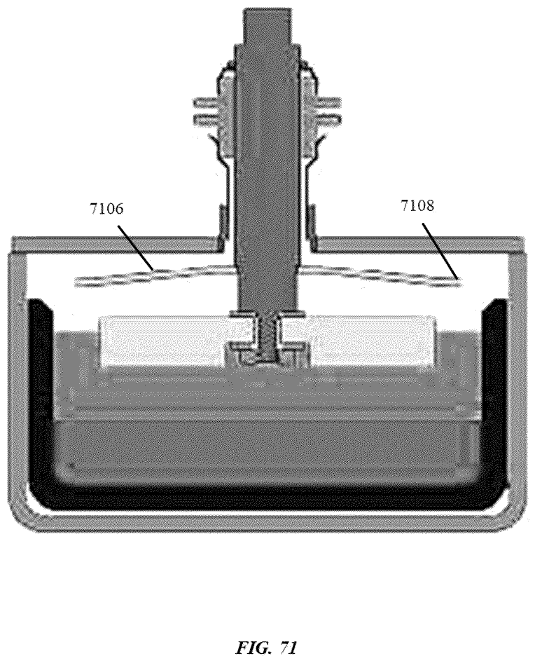

The shields provided herein can be shaped to provide additional benefits. For example, FIG. 71 illustrates a shield 6906 comprising a lip 6908 at its end. The lip is shaped to inhibit flow of liquid (e.g., splashing or creeping of liquid along solid surfaces, such as by capillary forces) from the liquid portion to the seal. For example, liquids with modest surface wetting angle may be prevented or resisted from flowing around the edge of the shield.

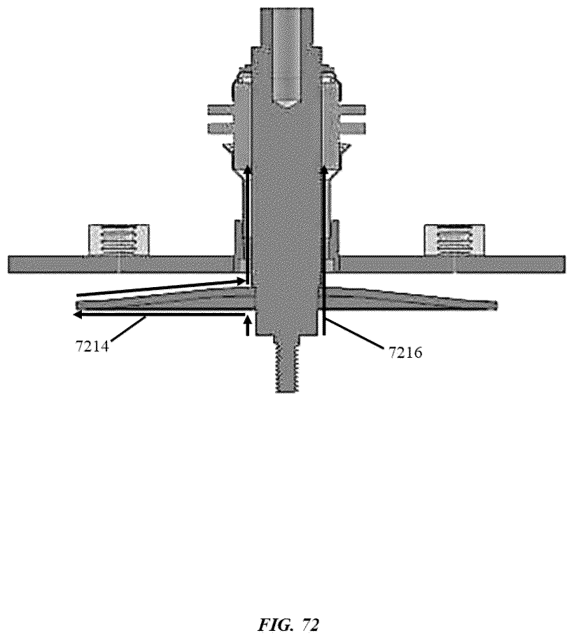

The shield may also provide protection against flow of ions along the surface of the negative current conductor to the seal. For example, FIG. 72 illustrates a shield 6912 configured to increase an effective ion diffusion path (EIDP) of ions traveling from the liquid portion at the bottom of the image to the seal at the top. A first path 6914 along the surface of shield 6912 and the negative current lead to the seal is compared to a second path 6916 traveling along the surface of the negative current lead. The EIDP can be defined as a dimensionless parameter given by an integral along a path between two points (e.g., from the liquid to the seal) of the inverse perimeter through which particles following the path along a surface can flow. For example, when flowing along a radial path from the center of a circle to its perimeter, the infinitesimal EIDP can be approximated as

$$\frac{d r}{2 π r} ,$$

where r is the radius of the circle. The full integral will then be

$$\int \frac{d r}{2 π r}$$

over the path. If the distance from the liquid portion to the seal in FIG. 72 is L, the radius of the current lead is r₁, the radius of the shield is 12, and circular symmetry is assumed, Then the EIDP of path 6916 can be approximated as

$$\frac{L}{2 π {r}_{1}} ,$$

and the EIDP of path 6914 is the same value, plus about

$$\frac{1}{2 π}$$

ln

$$\frac{{r}_{2}}{{r}_{1}} ,$$

representing the added EIDP from the shield. Additional shields can further increase EIDP by causing ions to repeatedly flow back and forth. For example, a shield or shields in such a system can provide an increase of greater than or equal to about 30 percent, about 40 percent, about 50 percent, about 70 percent, about 75 percent, about 80 percent, about 90 percent, or about 100 percent EIDP compared to the same system with no shield. In some examples, the effective ion diffusion path length is increased by about 75 percent or more. For example, the EIDP with a shield can be greater than or equal to about 1, about 1.5, about 2, about 3, about 4, or about 5. In one example, a cell with no shield has an EIDP of 1.17 and the same cell with a shield as illustrated has an EIDP of 1.60. In a second example, a plurality of shields are provided, producing an EIDP of 2.24. More complicated structures, such as the S-shaped structures of FIG. 6, can provide further increases in EIDP.

An additional feature that can be provided by the shields disclosed herein is cathodic protection. For example, referring to FIG. 68, shield 6900 blocks vapor from liquid portion 6810 from traveling in a straight-line path to seal 6700. Instead, vapor is directed to the outer edge of the container, coming in close proximity to the walls of can 6830. The walls of can 6830 can be in electrical communication with a positive electrode. Accordingly, atomic metal vapors from the liquid portion can be oxidized by coming into contact with the positive current source of the wall. The wall can include an ionically conductive film (e.g., comprising salt from the electrolyte and/or prior vapor-wall interactions), such that liquid metal atoms can be oxidized to a salt upon contact with the wall. For example, the ionically conductive film can conduct ions between the wall and the liquid portion. These interactions can inhibit flow of reactive metal atoms from the liquid portion to the seal. Shields configured to direct vapor along conductive container walls, especially in close proximity (e.g., about 5 mm or less), and for extended distances (e.g., about 1 cm or more) can enhance this effect.

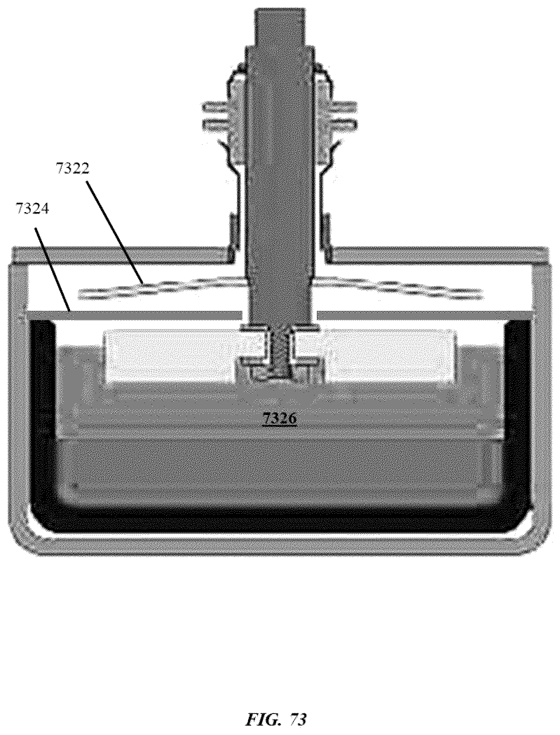

FIG. 73 illustrates a configuration comprising a plurality of shields, wherein a first shield 6922 is attached to a negative current lead and a second shield 6924 is disposed between the first shield 6922 and a liquid portion 6926, the second shield 6924 in contact with a positive current lead. To reach the seal at the top of the image, vapor may pass by the second shield 6924, which acts to oxidize reactive metal vapors to less-reactive salt ions, thereby reducing seal corrosion.

The ceramic portion of a seal can include measures to reduce flow of metal species, including electromigration of metal ions from braze material, along the surface of the ceramic component. A seal may include a ceramic component with a tubular structure. The tubular structure may have any cross-sectional geometry including, but not limited to, circular, elliptical, triangular, square, rectangular, or polygonal. In some embodiments, the ceramic component is annular or ‘ring-shaped’. An inner dimension of the tubular structure may be greater than or equal to an outer dimension of the current lead such that the ceramic component may circumscribe the current lead (e.g., the ceramic component may be a ring that fits over the exterior surface of the current lead). The ceramic component may be in contact with, may be in partial contact with, or may not be in contact with portions of the exterior surface of the current lead. The seal may be formed by brazing metal sleeves to the top and bottom of the external surface of the ceramic component (e.g., the surface of the ceramic component not exposed to the reactive materials that are inside the sealed container), forming a first and a second braze joint. Alternatively, or in addition to, the first and second braze joints may be formed by brazing the metal sleeves to the top and bottom of the internal surface of the ceramic component, by brazing to the inner and outer top edges of the ceramic component, by brazing to the inner and outer bottom edges of the ceramic component, or by brazing the metal sleeves to the top and bottom edges of the ceramic component. The first and the second braze joint may circumscribe the ceramic component and form a hermetic and gas-tight seal along the external surface of the ceramic component. The braze joints may conceal or cover a portion of the external surface of the ceramic component. A portion of the ceramic component between the first and the second braze joints may not be covered by the first and second braze joints and may be exposed to an ambient environment. The ambient environment may be any environment external to the cell. For example, the exposed surface of the ceramic component between the first and second braze may be external to the cell and not in contact with the reactive vapors or reactive material inside the cell. The ceramic component that is exposed to the ambient environment may have a surface that extends from the first braze joint to the second braze joint and circumscribes the current lead. The ceramic component may or may not come into contact with the current lead. In some examples, the surface of the ceramic component extending between the first and second braze joints is smooth (e.g., the surface may include a linear intercept between the first braze joint and the second braze joint) and may result in the lowest surface area when compared to other possible surfaces that intercept both the first and second braze joints. In some examples, the surface of the ceramic component extending between the first and the second braze joints has protrusions that increase the area of the exposed surface of the ceramic component. The protrusions may be defined as one or more features that extend away from (e.g., are at least partially orthogonal to) a theoretical or imaginary smooth surface (e.g., reference surface) extending between the first and second braze joints of the seal. In some embodiments, the protrusions may also be defined as one or more features that simultaneously extend at least partially away from both the first and second braze joints of the seal.

Some braze materials may, under some operating conditions, permit the flow of metal ions across the surface of the ceramic component which may lead to undesirable shorting, for example, due to the formation of metal dendrites as ions reach the far electrode and reduce to neutral metal. As the process repeats, dendrites can grow across the surface of the ceramic component, eventually forming a metallic link between oppositely polarized conductors, causing a short. To inhibit this, a physical ion blocker can be provided on the exposed surface of the ceramic component and/or integrated into the design of the ceramic component. For example seal 6700 of FIG. 68 illustrates a physical ion blocker 1000 comprising a plurality of protrusions on the surface extending substantially orthogonal to a reference surface extending between the first and second braze joints. The protrusions may be formed by one or more exposed surfaces of the ceramic component that are substantially parallel to, substantially orthogonal to, and/or that are at an acute angle to a reference surface extending from the first braze joint to the second braze joint. The plurality of protrusions may each comprise first, second, and/or third surface portions. The first surface portion may extend away from the exposed surface of the ceramic component perpendicular to, substantially perpendicular to, or at an angle to a reference surface of the ceramic component extending from the first braze joint to the second braze joint. For example, the protrusions can be angled less than or equal to about 20 degrees from a right angle, less than or equal to about 5 degrees from a right angle, or less than or equal to about 1 degree from a right angle. The second surface portion may be parallel to, substantially parallel to, or at a defined slope relative to the reference surface of the ceramic component extending from the first braze joint to the second braze joint. The third surface portion may extend towards the reference surface of the ceramic component. An electric field vector may be parallel with the reference surface and oriented from a first ceramic-to-metal braze joint to a second ceramic-to-metal braze joint. One of the ceramic-to-metal braze joints may be in electrical communication with a positive electrode. In the absence of protrusions, ions can be pulled by electric fields between the braze of positively polarized sleeve (e.g., 6740) and the braze of negatively polarized sleeve (e.g., 6710). The protrusions may cause ions traveling along the exposed surface of the ceramic component to move orthogonal to or at least partially against the electric field and, thereby, slow or stop the progress of the ions. Although two protrusions are illustrated, more or fewer protrusions can also be used, such as a single protrusion (e.g., encircling the outer perimeter of the ceramic component), or three or more such protrusions. The ceramic component and protrusions may be a single component (i.e., the ceramic component and protrusions may be one continuous material). Alternatively, or in addition to, the protrusions may be multiple components that are adhered together and/or to the ceramic component through a weld, braze, ceramic glue or cement, or other adhesion method. In some examples, the protrusions can differ from each other in length or angle. The protrusions may extend a distance of greater than or equal to about 0.5 millimeters (mm), 1 mm, 2 mm, 3 mm, 4 mm, 6 mm, 8 mm, 10 mm, or more from a reference surface of the ceramic component extending from the first braze joint to the second braze joint.

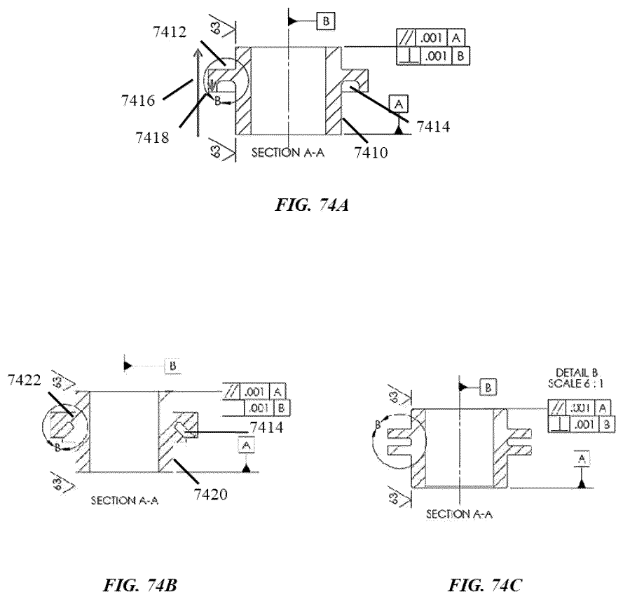

FIGS. 74A, 74B, and 74C illustrate various ceramic components comprising physical ion blockers. FIGS. 74A, 74B, and 74C illustrate radially symmetric two-dimensional cross-sections of ceramic components comprising physical ion blockers, with the line of radial symmetry running vertically through the center of each image. FIG. 74A illustrates a ceramic component 7410 comprising a physical ion blocker 7412. Physical ion blocker 7412 comprises a protrusion angled to form a void or groove 7414 oriented downward, in a direction towards the positive side of electric field 7416. When ions traveling along the surface in the direction of electric field 7416 reach the physical ion blocker, they are redirected in a direction with a vector component that is opposite the electric field vector, as illustrated by reverse arrow 7418. Thus, the path from the bottom end to the top first approaches the top, then reverses course, before resuming motion toward the top. Because this movement is in a direction opposite the electric field, positive ions will be effectively resisted by the field, inhibiting electromigration. FIG. 74B illustrates a further embodiment in which ceramic component 7420 comprises a physical ion blocker 7422 with protrusions defining a slope at an acute angle to the surface of the ceramic component, and forming an angled groove 7424 facing generally toward the source of positive electric field (downward). This angled groove (or void) provides a similar effect to the parallel groove 7414, as ions moving along the surface over the groove may travel at least partly against the vertical electric field along the surface of the ceramic component. FIG. 74C illustrates a third example, wherein ceramic component 7430 comprises a physical ion blocker 7432 including protrusions defining a groove 7434, the groove defining a slope substantially orthogonal to the surface of the ceramic component. As illustrated here, the physical ion blocker can be formed as an integral part of, or be integrated with, the ceramic component. Alternatively, the physical ion blocker can be attached to the ceramic component.

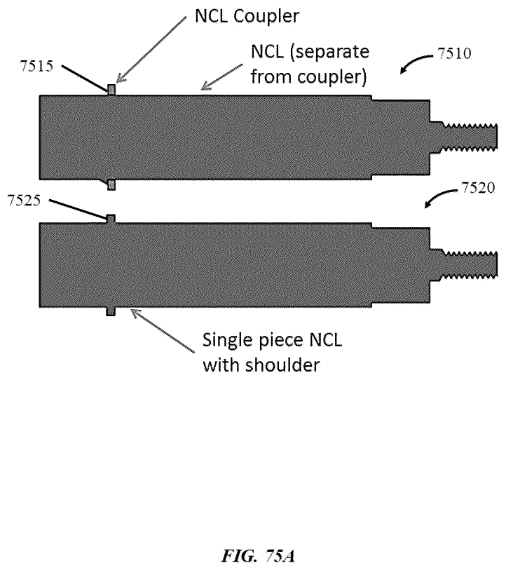

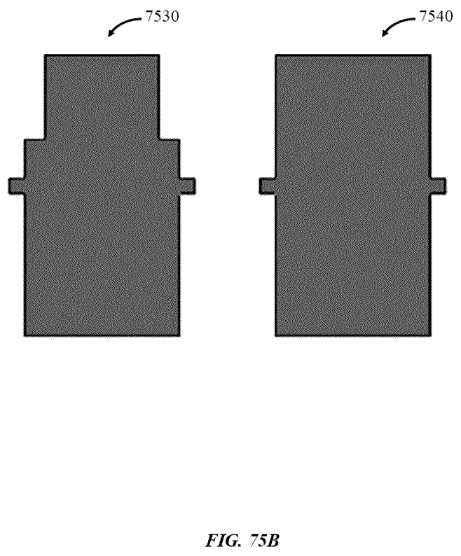

Refinements to current leads (e.g., negative current leads) are illustrated in FIG. 75A. FIG. 75A illustrates two embodiments of a negative current lead (NCL) comprising a coupler for joining to a metal sleeve. In the first embodiment 7510, a coupler 7515 is provided as a separate piece attached (e.g., welded) to the NCL. In the second embodiment 7520, a coupler 1825 is provided as an integral part of the NCL, forming a shoulder to which a sleeve can be joined (e.g. brazed or welded).

FIG. 75B illustrates an additional feature that may be included in a current lead such as an NCL. In some embodiments, NCL may be provided comprising a uniform cylindrical top. Such a top can be difficult to constrain, for example, when attaching a negative current collector (e.g. to a threaded connector) on the opposite side of the NCL, or when making other attachments to the NCL. To more efficiently constrain the NCL, a pair of substantially flat, parallel surfaces can be provided on the end of the NCL. FIG. 75B shows such a feature, as illustrated by front view 7530 and side view 7540. By breaking cylindrical symmetry, these surfaces provide an effective grip point, such as by a wrench, for example. This allows torque to be applied to rotate or stabilize the NCL when adjusting the cell or NCL, or when attaching other parts (e.g., a negative current collector).

In some examples, a brazed ceramic seal comprises a sub-assembly. The sub-assembly can comprise the insulating ceramic bonded to one or more (e.g., two) flexible, spring-like or accordion-like components, referred to herein as metal sleeves. After the sub-assembly is fabricated, the sleeves can be brazed or welded to other cell components such as the negative current lead, the cell lid and/or a collar joined (e.g., welded) to the cell lid. Alternatively, all of the joints can be created on the complete cap assembly by brazing (e.g., if tolerance limits are sufficiently tight). The chemical compatibility between the braze materials and the atmospheres the materials will be exposed to, and the thermal robustness during high temperature operation and thermal cycling can be evaluated during design of the sub-assembly. In some instances, the ceramic material is aluminum nitride (AlN) or silicon nitride (Si₃N₄), and the braze is a titanium alloy, titanium doped nickel alloy, a zirconium alloy or a zirconium doped nickel alloy. In some instances, the ceramic material is aluminum nitride (AlN) and the braze is a silver aluminum alloy.

This disclosure provides electrochemical energy storage devices (or batteries) and electrochemical battery housings. An electrochemical battery generally includes an electrochemical battery cell sealed (e.g., hermetically sealed) within an electrochemical battery housing.

### Electrochemical Energy Storage Materials

The present disclosure provides electrochemical energy storage devices (e.g., batteries) and systems. An electrochemical energy storage device generally includes at least one electrochemical cell, also “cell” and “battery cell” herein, sealed (e.g., hermetically sealed) within a housing. A cell can be configured to deliver electrical energy (e.g., electrons under potential) to a load, such as, for example, an electronic device, another energy storage device or a power grid.

In an aspect, the present disclosure provides an electrochemical energy storage device comprising a first electrode in electrical communication with a negative current collector, a second electrode in electrical communication with a positive current collector, and a liquid electrode between the first and second electrodes. In some embodiments, the first electrode is a negative electrode. The negative electrode may be an anode during discharge. In some embodiments, the second electrode is a positive electrode. The positive electrode may be a cathode during discharge.

In some examples, an electrochemical energy storage device includes a liquid metal negative electrode, a solid metal positive electrode, and a liquid salt electrolyte separating the liquid metal negative electrode and the solid metal positive electrode. In some examples, an electrochemical energy storage device includes a solid metal negative electrode, a solid metal positive electrode, and a liquid salt electrolyte separating the solid metal negative electrode and the solid metal positive electrode. In some examples, an electrochemical energy storage device includes a semi-solid metal negative electrode, a solid metal positive electrode, and a liquid electrolyte separating the semi-solid metal negative electrode and the solid metal positive electrode.

Any description of a metal or molten metal negative electrode, or a negative electrode, herein may refer to an electrode including one or more of a metal, a metalloid and a non-metal. The negative electrode may comprise calcium (Ca). In some examples, the negative electrode may comprise a calcium alloy. The calcium alloy may include an alkali or alkaline earth metal, such as lithium (Li), sodium (Na), potassium (K), rubidium (Rb), cesium (Cs), magnesium (Mg), barium (Ba), strontium (Sr), or combinations thereof. The calcium alloy may include one or more transition metals, such as copper (Cu), iron (Fe), nickel (Ni), zinc (Zn), cobalt (Co), or gold (Au). In some examples, the negative electrode may form a eutectic mixture (e.g., enabling a lower operating temperature of the cell in some cases). The calcium alloy may comprise a calcium-lithium (Ca—Li), a calcium-magnesium (Ca—Mg), a calcium-lithium-magnesium (Ca—Li—Mg) alloy, a calcium-copper (Ca—Cu), a calcium-zinc (Ca—Zn) alloy, a calcium-lithium-magnesium-copper alloy (Ca—Li—Mg—Cu), a calcium-lithium-magnesium-zinc alloy (Ca—Li—Mg—Zn), a calcium-magnesium-copper alloy (Ca—Mg—Cu), a calcium-magnesium-zinc alloy (Ca—Mg—Zn), a calcium-magnesium-copper-zinc alloy (Ca—Mg—Cu—Zn), or a calcium-lithium-magnesium-copper-zinc alloy (Ca—Li—Mg—Cu—Zn). The calcium alloy may maintain the negative electrode (e.g., first electrode) as a liquid at the operating temperature of the electrochemical cell. An anode that includes calcium may form an alloy with one or more components of the liquid electrolyte. The alloy formed from the calcium first electrode and the liquid electrolyte may be formed spontaneously upon heating of the cell or over time as the cell cycles through charge and discharge states. For example, the liquid electrolyte may comprise lithium, sodium, or potassium and the calcium first electrode may form an alloy with the lithium, sodium, or potassium. The alloy component(s) (e.g., magnesium, zinc, copper, etc.) may be added to the cell (e.g., into the negative current collector) during assembly of the cell.

A first electrode comprising a material (e.g., calcium or calcium alloy) that are in a liquid state at an operating temperature may charge and discharge more efficiently due to a reduced formation of dendrites and/or reduced cell shorting. Formation of dendrites may not be possible in a cell comprising a liquid first electrode (e.g., anode or negative electrode). Additionally, a liquid first electrode may wet the negative current collector and may be held in a shape and location to increase cell performance. A variety of electrode additives may be added to the first material to reduce the melting point of the first material such that the first electrode is in a liquid state at the operating temperature of the cell. Electrode additives may include lithium, sodium, magnesium, copper, and zinc. A first electrode may comprise greater than or equal to about 5 mole percent (mol %), 10 mol %, 20 mol %, 30 mol %, 40 mol %, 50 mol %, 60 mol %, 70 mol %, 80 mol %, 90 mol %, or more calcium. As an alternative, the first electrode may comprise greater than or equal to about 5 mol %, 10 mol %, 20 mol %, 30 mol %, 40 mol %, 50 mol %, 60 mol %, 70 mol %, 80 mol %, 90 mol %, or more lithium. As another alternative, the first electrode may comprise greater than or equal to about 5 mol %, 10 mol %, 20 mol %, 30 mol %, 40 mol %, 50 mol %, 60 mol %, 70 mol %, 80 mol %, 90 mol %, or more sodium. As another alternative, the first electrode may comprise greater than or equal to about 5 mol %, 10 mol %, 20 mol %, 30 mol %, 40 mol %, 50 mol %, 60 mol %, 70 mol %, 80 mol %, 90 mol %, or more mol % magnesium. As another alternative, the first electrode may comprise greater than or equal to about 5 mol %, 10 mol %, 20 mol %, 30 mol %, 40 mol %, 50 mol %, 60 mol %, 70 mol %, 80 mol %, 90 mol %, or more copper. As another alternative, the first electrode may comprise greater than or equal to about 5 mol %, 10 mol %, 20 mol %, 30 mol %, 40 mol %, 50 mol %, 60 mol %, 70 mol %, 80 mol %, 90 mol %, or more zinc. An another alternative, the first electrode may comprise an alloy comprising at least 2, 3, 4, 5, or all of calcium, lithium, sodium, magnesium, zinc, and copper at various stoichiometries. A first electrode may comprise any of the compositions shown in Table 1. The compositions shown in Table 1 are approximate and may vary.

TABLE 1
Example compositions of the first electrode in mole percent.

| ID | Ca | Li | Na | Mg | Zn | Cu |
|---|---|---|---|---|---|---|
| 1 | 100 | | | | | |
| 2 | 74 | | | 26 | | |
| 3 | 10 | | | 90 | | |
| 4 | 75 | | | 14 | 11 | |
| 5 | 67 | | | 20 | | 13 |
| 6 | 71 | | | 25 | | 4 |
| 7 | 70 | 30 | | | | |
| 8 | 63 | | 37 | | | |
| 9 | 57 | 10 | 33 | | | |
| 10 | 50 | 20 | 30 | | | |
| 11 | 47 | 10 | 28 | 5 | 5 | 5 |

A cell comprising a Ca—Li alloy in the negative electrode may comprise an electrolyte that contains some amount (e.g., at least about 2 mole percent) of at least one lithium halide salt (e.g., lithium chloride). In an example, the negative electrode comprises calcium and the electrolyte comprises a lithium salt (e.g., lithium chloride) and the calcium of the electrode reacts with the lithium of the salt to form a Ca—Li alloy. The electrolyte may comprise at least about 0.5 mole percent (mol %), at least about 1 mol %, at least about 2 mol %, at least about 3 mol %, at least about 4 mol %, at least about 5 mol %, at least about 6 mol %, at least about 8 mol %, at least about 10 mol %, at least about 15 mol %, at least about 20 mol %, at least about 30 mol %, at least about 40 mol %, at least about 50 mol %, at least about 60 mol %, at least about 70 mol %, at least about 80 mol %, or more lithium halide salt. The ratio of calcium to lithium metal in the negative electrode may be at least about 1-to-1, 1.5-to-1, 2-to-1, 2.5-to-1, 3-to-1, 3.5-to-1, 4-to-1, 5-to-1, 6-to-1, 7-to-1, 8-to-1, 9-to-1, or 10-to-1. During charging of a cell containing a Ca—Li alloy negative electrode, the Ca—Li alloy may form on the negative electrode and/or the amount of Ca—Li alloy may be increased by co-deposition of calcium and lithium metal onto the negative electrode. During discharging of a cell containing a Ca—Li alloy negative electrode, both calcium and lithium may dissolve from the negative electrode into the electrolyte as ions (e.g., Ca²⁺, Li⁺).

A cell with a Ca—Mg alloy negative electrode may comprise a magnesium salt (e.g., magnesium chloride) electrolyte. The electrolyte may comprise less than about 10 mol %, less than about 8 mol %, less than about 6 mol %, less than about 5 mol %, less than about 4 mol %, less than about 3 mol %, less than about 2 mol %, less than about 1 mol %, less than about 0.5 mol %, or less magnesium halide salt. In some examples, the electrolyte may comprise less than about 5 mol % magnesium halide salt. The ratio of calcium to magnesium metal in the negative electrode may be at least about 1-to-10, 1-to-9, 1-to-8, 1-to-7, 1-to-6, 1-to-5, 1-to-4, 1-to-3, 1-to-2, 1-to-1, 1.5-to-1, 2-to-1, 2.5-to-1, 3-to-1, 3.5-to-1, 4-to-1, 5-to-1, 6-to-1, 7-to-1, 8-to-1, 9-to-1, or 10-to-1. In a cell comprising a Ca—Mg alloy in the negative electrode, the Ca—Mg alloy may form on the negative electrode by depositing calcium from the electrolyte onto a magnesium metal or magnesium alloy during charging. During discharging, the Ca—Mg alloy may convert to magnesium or a magnesium alloy by preferentially dissolving calcium metal ions (e.g., Ca²⁺) from the Ca—Mg alloy into the electrolyte, thus leaving behind magnesium metal or magnesium alloy with a low amount of calcium metal (e.g., as compared to a cell in a charged state).

In some examples, the negative electrode may contain barium (Ba) metal and at least one barium halide salt. The ratio of barium to other metals in the negative electrode may be at least about 1-to-10, 1-to-9, 1-to-8, 1-to-7, 1-to-6, 1-to-5, 1-to-4, 1-to-3, 1-to-2, 1-to-1, 1.5-to-1, 2-to-1, 2.5-to-1, 3-to-1, 3.5-to-1, 4-to-1, 5-to-1, 6-to-1, 7-to-1, 8-to-1, 9-to-1, or 10-to-1. In one example, the negative electrode contains at least about a 1-to-1 ratio of barium to other metals. The electrolyte may comprise greater than or equal to about 0.5 mol %, 1 mol %, 2 mol %, 3 mol %, 4 mol %, 5 mol %, 6 mol %, 8 mol %, 10 mol 15 mol %, 20 mol %, 30 mol %, 40 mol %, 50 mol %, or more barium halide salt.

In some examples, the positive electrode (e.g., second electrode) may comprise antimony (Sb). In an example, the positive electrode may include one or more of antimony, tin, lead, bismuth, tellurium, selenium, or any combination thereof. In another example, the positive electrode may include an alkali or alkaline earth metal alloyed in, or reacted with, the positive electrode (e.g., second electrode). The positive electrode may be solid, semi-solid, or liquid at an operating temperature of the cell. In one example, the positive electrode comprises particles of solid antimony when the cell is in a charged state. The particles may be solid or semi-solid. In a discharged state, the cell may comprise solid antimony-containing intermetallic compounds (e.g., reaction products), such as CaₓSb_{y} intermetallic compounds (e.g., CaSb₂, Ca₁₁Sb₁₀, Ca₅Sb₃, Ca₂Sb), LiₓSb_{y} intermetallic compounds (e.g., Li₃Sb, Li₂Sb, Li₃Sb₂, LiSb₂), LiₓCa_{y}Sb_{z} (e.g., Li₁Ca₁Sb₁) intermetallic compounds, or any combination thereof. In some embodiments, barium, sodium, potassium, or strontium may deposit into the solid positive electrode material (e.g., Sb), forming intermetallic compounds of Ba—Sb, Sr—Sb, Na—Sb, K—Sb, or any combination thereof. The intermetallic compounds may form during discharging through the electrochemical deposition of calcium, lithium, barium, and/or strontium from the electrolyte comprising the metal positive electrode (e.g., antimony metal or various intermetallic compounds).

The electrolyte may participate in one or more reactions with the second electrode during cycling of the cell and one or more additional metal antimonides may be generated during discharge. For example, the second electrode may react with components of the electrolyte to form sodium or lithium antimonides (e.g., NaSb₃ and LiSb₃, respectively). Non-stoichiometric materials may also be formed, such as lithium-doped antimony or sodium-doped antimony. Heterometallic antimonides may be formed by one or more reactions between the second electrode, one or more components of the first electrode, and/or the electrolyte during discharge. Heterometallic antimonides may include, but are not limited to, LiCaSb, Li_{1.38}Ca_{10.62}Sb₉, and Sr_{2.37}Ca_{8.63}Sb₁₀.

The second electrode (e.g., cathode or negative electrode) may include one or more non-electrochemically active additives or one or more electrochemically active additives. Non-electrochemically active additives may include steel, graphite, tungsten carbide, aluminum nitride, or any combination thereof. Aluminum nitride may be added to the second electrode as a particle. The particles may comprise various sized and/or morphologies. Aluminum nitride particles may be added as shot, fibers, powder, flakes, needles, particles, or any combination thereof. Non-electrochemically active additives may modify the electronic conductivity or active particle density of the second electrode.

The first and second electrodes may be added to the electrochemical cell in a given molar ratio. The molar ratio of the first electrode material (e.g., calcium) to second electrode material (e.g., antimony) may be selected to increase the efficiency of the electrochemical cell (e.g., charge and/or discharge). The molar ratio of the first electrode material to the second electrode material may be greater than or equal to about 1-to-1, 1-to-2, 1-to-3, 1-to-4, 1-to-5, 1-to-6, 1-to-7, 1-to-8, 1-to-9, 1-to-10, 2-to-1, 2-to-3, 2-to-5, 2-to-7, 2-to-9, 3-to-1, 3-to-2, 3-to-4, 3-to-5, 3-to-6, 3-to-7, 3-to-8, 3-to-9, 3-to-10, 4-to-1, 4-to-3, 4-to-5, 4-to-7, 4-to-9, 5-to-1, 5-to-2, 5-to-3, 5-to-4, 5-to-6, 5-to-7, 5-to-8, 5-to-9, 5-to-10, 6-to-1, 6-to-5, 6-to-7, 7-to-1, 7-to-2, 7-to-3, 7-to-4, 7-to-5, 7-to-6, 7-to-8, 7-to-9, 7-to-10, 8-to-1, 8-to-3, 8-to-5, 8-to-7, 8-to-9, 9-to-1, 9-to-2, 9-to-4, 9-to-5, 9-to-7, 9-to-8, or 9-to-10. In an example, the molar ratio of the first electrode material to the second electrode material is 3-to-2. In an example, the first electrode material is calcium, the second electrode material is antimony, and the molar ratio of calcium to antimony is 3-to-2.

The electrolyte may include a salt (e.g., molten salt), such as an alkali metal halide salt, alkaline earth metal salt, and/or a calcium salt. The electrolyte may be in a liquid or molten state at an operating temperature of the cell. The electrolyte may comprise a single substance (e.g., a single salt) or may be a mixture of substances. The electrolyte may comprise greater than or equal to 1, 2, 3, 4, 5, 6, 8, 10, 12, or more substances. The electrolyte may support ionic conduction of metal ions. For example, the electrolyte may permit conduction of cations, anions, or both cations and anions from the first and second electrodes. The solubility of the metallic components (e.g., first and/or second electrode materials and intermetallic compounds) in the electrolyte may be low. The electrolyte may have low electronic conductivity and permit high reaction kinetics.

The electrolyte may comprise a molten calcium salt. The calcium salt may permit rapid conduction of calcium ions through the electrolyte. Examples of calcium salts include, but are not limited to, calcium chloride (CaCl₂)), calcium fluoride (CaF₂), calcium bromide (CaBr₂), calcium iodide (Cal₂), or combinations thereof. In an example, the calcium salt is calcium chloride or calcium bromide. The electrolyte may comprise greater than or equal to about 1 mol %, 5 mol %, 10 mol %, 15 mol %, 20 mol %, 25 mol %, 30 mol %, 40 mol %, 50 mol %, 60 mol %, 70 mol %, 80 mol %, 90 mol %, or more calcium salt. The electrolyte may include a salt additive. Examples of salt additives include, but are not limited to, salt compounds that include fluorides (F), chlorides (CI), bromides (Br), sodium (Na), potassium (K), rubidium (Rb), cesium (Cs), magnesium (Mg), strontium (Sr), or barium (Ba), such as lithium fluoride (LiF), lithium chloride (LiCl), lithium bromide (LiBr), lithium iodide (LiI), potassium chloride (KCl), barium fluoride (BaF₂), barium chloride (BaCl₂), barium bromide (BaBr₂), barium iodide (BaI₂), strontium fluoride (SrF₂), strontium chloride (SrCl₂), strontium bromide (SrBr₂), sodium fluoride (NaF), sodium chloride (NaCl), sodium bromide (NaBr), sodium iodide (Nal), or combinations thereof. The electrolyte may comprise greater than or equal to about 0.5 mol %, 1 mol %, 2 mol %, 3 mol %, 4 mol %, 5 mol %, 6 mol %, 8 mol %, 10 mol %, 15 mol %, 20 mol %, 30 mol %, 40 mol %, 50 mol %, or more salt additive. In one example, the electrolyte comprises about 30 mol % calcium chloride, about 15 mol % potassium chloride, and about 55 mol % lithium chloride. In one example, the electrolyte comprises about 35 mol % calcium chloride and about 65 mol % lithium chloride. In one example, the electrolyte comprises about 24 mol % lithium chloride, about 38 mol % calcium chloride, and about 38 mol % strontium chloride. In one example, the electrolyte comprises at least about 20 weight percent (wt %) calcium chloride, at least about 20 wt % strontium chloride, and at least about 10 wt % potassium chloride. In one example, the electrolyte comprises at least about 10 wt % lithium chloride, at least about 30 wt % calcium chloride, at least about 30 wt % strontium chloride, and at least about 10 wt % potassium chloride. Other example salt compositions are shown in Table 2. The values shown in Table 2 are approximate values and may vary.

TABLE 2
Example electrolyte compositions in mole percent by cation

| ID | CaCl₂ | LiCl | NaCl | KCl | SrCl2 | BaCl2 | CaBr₂ | LiBr | NaBr |
|---|---|---|---|---|---|---|---|---|---|
| 1 | 35 | 65 | | | | | | | |
| 2 | 48 | | 52 | | | | | | |
| 3 | 40.0 | | 41.9 | | 18.1 | | | | |
| 4 | 51.5 | | | | | | | 7.6 | 40.9 |
| 5 | 7.2 | 17.3 | | 48.2 | 27.3 | | | | |
| 6 | 40.0 | | | | 18.1 | | | | 41.9 |
| 7 | | | | 13 | | 29 | 58 | | |
| 8 | 11.7 | 45 | | 27.5 | 15.8 | | | | |
| 9 | 12.8 | 39.5 | | 30.3 | 17.4 | | | | |
| 10 | 14 | 34 | | 33 | 19 | | | | |
| 11 | 26.4 | 34.0 | 27.6 | | 11.9 | | | | |
| 12 | 20.4 | 49.1 | 21.3 | | 9.2 | | | | |
| 13 | 24.0 | 40.0 | 25.1 | | 10.9 | | | | |
| 14 | 28.4 | 29.0 | 29.7 | | 20.4 | | | | |
| 15 | 21 | | 23 | 56 | | | | | |
| 16 | 19 | | 21 | 50 | 10 | | | | |
| 17 | 55 | | 40 | 5 | | | | | |
| 18 | 50 | | 36 | 4 | 10 | | | | |
| 19 | 40 | | | 42 | 18 | | | | |
| 20 | 36 | 5 | 5 | 38 | 16 | | | | |
| 21 | 52 | | 48 | | | | | | |
| 22 | 47 | 10 | 43 | | | | | | |
| 23 | 47 | 5 | 43 | 5 | | | | | |
| 24 | 47 | | 43 | 10 | | | | | |

Alternatively, or in addition to, the salt of the alkali metal may be for example, a non-chloride halide, bistriflimide, fluorosulfano-amine, perchlorate, hexaflourophosphate, tetrafluoroborate, carbonate, hydroxide, nitrates, nitrites, sulfates, sulfites, or combinations thereof.

In an example, the negative electrode and the positive electrode of an electrochemical energy storage device are in a liquid state at an operating temperature of the energy storage device. In another example, the negative electrode and the positive electrode of an electrochemical energy storage device are in a solid state at an operating temperature of the energy storage device. In another example, the negative electrode and the positive electrode of an electrochemical energy storage device are in a semi-solid state at an operating temperature of the energy storage device. In another example, the negative electrode is in a liquid state and the positive electrode is in a solid state at an operating temperature of the energy storage device. In another example, the negative electrode is in a semi-solid state and the positive electrode is in a solid state at an operating temperature of the energy storage device. In another example, the negative electrode is in a liquid state and the positive electrode is in a semi-solid state at an operating temperature of the energy storage device. In another example, the negative electrode is in a solid state and the positive electrode is in a semi-solid state at an operating temperature of the energy storage device. In another example, the negative electrode is in a solid state and the positive electrode is in a liquid state at an operating temperature of the energy storage device.

To maintain the electrolyte and/or at least one of the electrodes in the liquid or semi-solid states, the battery cell may be heated to any suitable temperature. In some examples, the battery cell is heated to and/or maintained at a temperature of about 100 °C, 150 °C, 200 °C, 250 °C, 300 °C, 350 °C, 400 °C, 450 °C, 500 °C, 550 °C, 600 °C, 650 °C, or 700 °C. The battery cell may be heated to and/or maintained at a temperature of greater than or equal to about 100 °C, 150 °C, 200 °C, 250 °C, 300 °C, 350 °C, 400 °C, 450 °C, 500 °C, 550 °C, 600 °C, 650 °C, 700 °C, or more. In some situations, the battery cell is heated from about 150 °C to about 600 °C, about 400 °C to about 500 °C, or about 450 °C to about 575 °C. In an example, an electrochemical cell is operated at a temperature between about 300 °C and 650 °C.

The electrochemical cell or energy storage device may be at least partially or fully self-heated. For example, a battery may be sufficiently insulated, charged, discharged, and/or conditioned at sufficient rates, and/or cycle a sufficient percentage of the time to allow the system to generate sufficient heat through inefficiencies of the cycling operation that cells are maintained at a given operating temperature (e.g., a cell operating temperature above the freezing point of the electrolyte and/or at least one of the electrodes) without the need for additional energy to be supplied to the system to maintain the operating temperature.

Electrochemical cells of the disclosure may be adapted to cycle between charged (or energy storage) modes and discharged (or energy release) modes. In some examples, an electrochemical cell can be fully charged, partially charged or partially discharged, or fully discharged.

During a charging mode of an electrochemical energy storage device, electrical current received from an external power source (e.g., a generator or an electrical grid) may cause metal atoms in the metal positive electrode to release one or more electrons, dissolving into the electrolyte as a positively charged ion (i.e., cation). Simultaneously, cations of the same species of cations of a different species can migrate through the electrolyte and may accept electrons at the negative electrode, causing the cations to transition to a neutral metal species, thereby adding to the mass of the negative electrode. The removal of one or more metal species from the positive electrode and the addition of metal to the negative electrode stores electrochemical energy. During an energy discharge mode, an electrical load is coupled to the electrodes and the previously added metal species in the negative electrode can be released from the metal negative electrode, pass through the electrolyte as ions, and the added metal species or another metal species deposits as a neutral species with the positive electrode (and in some cases alloy with the positive electrode material), with the flow of ions accompanied by the external and matching flow of electrons through the external circuit/load. This electrochemically facilitated metal alloying reaction discharges the previously stored electrochemical energy to the electrical load. During charging, the alloy at the positive electrode disassociates to yield metal cations, which migrates through the electrolyte to the negative electrode where metal cations may be reduced to neutral metal and may be added to the negative electrode.

In some examples, ions can migrate through an electrolyte from an anode to a cathode, or vice versa. In some cases, ions can migrate through an electrolyte in a push-pop fashion in which an entering ion of one type ejects an ion of the same type from the electrolyte. For example, during discharge, a calcium anode and a calcium chloride electrolyte can contribute a calcium cation to a cathode by a process in which a calcium cation formed at the anode interacts with the electrolyte to eject a calcium cation from the electrolyte into the cathode. The calcium cation formed at the anode in such a case may not necessarily migrate through the electrolyte to the cathode. The cation can be formed at an interface between the anode and the electrolyte, and accepted at an interface of the cathode and the electrolyte.

In an example cell, upon discharging, cations formed at the negative electrode can migrate into the electrolyte. During operation, cells with different electrolytes and electrode compositions may not behave the same during cycling. Some cell chemistries may involve the movement of one species (e.g., Ca) from the negative electrode to the positive electrode and vice versa. Other cell chemistries may involve multiple species depositing on and being extracted from either electrode. The multiple species may be the same on both electrodes (e.g., Ca and Li depositing onto the negative electrode during charging, and Ca and Li depositing into the positive electrode during discharging) of the multiple species may not be the same on both electrodes (e.g., Ca deposits onto negative electrode while charging, and Ca and Li deposit onto positive electrode during discharging). Concurrently, the electrolyte may provide a cation of the same or a different species (e.g., the cation of the negative electrode material or cations from the electrolyte) to the positive electrode, which may reduce from a cation to a neutrally charged species, and alloy or form an intermetallic compound with the positive electrode. In a discharged state, the negative electrode may comprise a relatively small amount of electrode material (compared to a charged state) and/or be depleted of the negative electrode material (e.g., Ca, Li, Na, Mg). During charging, the cathode alloy or intermetallic compound at the positive electrode may disassociate to yield cations (e.g. Ca²⁺, Li⁺, Na⁺, Mg²⁺, Ba²⁺), which migrate into the electrolyte, and intermetallic compound converts to a positive electrode metal (e.g., Sb) or metal alloy with negligible amounts of the negative electrode metal(s) or metal species associated with the cations in the electrolyte. The electrolyte may then provide cations (e.g., the cation of the negative electrode material) to the negative electrode, which may replenish the negative electrode to provide a cell in a charged state. A cell may operate in a push-pop fashion, in which the entry of a cation into the electrolyte results in the discharge of the same cation from the electrolyte.

Electrochemical cells of the disclosure can include housings that may be suited for various uses and operations. A housing can include one cell or a plurality of cells. A housing can be configured to electrically couple the electrodes to a switch, which can be connected to the external power source and the electrical load. The cell housing may include, for example, an electrically conductive container that is electrically coupled to a first pole of the switch and/or another cell, and an electrically conductive terminal (e.g., a terminal on the seal) that are electrically isolated from the electrically conductive container is electrically coupled to a second pole of the switch and/or another cell. The cell can be arranged within a cavity of the container. A first one of the electrodes of the cell can contact and be electrically coupled with an end wall of the container. An electrically insulating seal (e.g., bonded ceramic ring) may electrically isolate negative potential portions of the cell from positive portions of the cell (e.g., electrically insulate the negative current lead from the positive current lead). In an example, the negative current lead and the container lid (e.g., cell cap) can be electrically isolated from each other, where a dielectric sealant material can be placed between the negative current lead and the cell cap. As an alternative, a housing includes an electrically insulating sheath (e.g., alumina sheath) or corrosion resistant and electrically conductive sheath or crucible (e.g. graphite sheath or crucible). In some cases, a housing and/or container may be a battery housing and/or container.

### Electrochemical Cells

A battery, as used herein, can comprise a plurality of electrochemical cells. Individual cells of the plurality can be electrically coupled to one another in series and/or in parallel. In serial connectivity, the positive terminal of a first cell is connected to a negative terminal of a second cell. In parallel connectivity, the positive terminal of a first cell can be connected to a positive terminal of a second, and/or additional, cell(s).

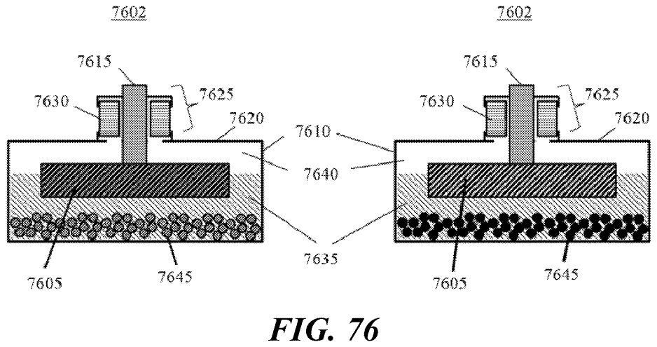

FIG. 76 is a cross-sectional side view of an electrochemical cell or battery comprising a housing 7610, an electrically conductive feed-through 7615 (i.e., conductor, such as a negative current lead) that passes through an aperture in the housing and is in electrical communication with a metal negative electrode 7605, a metal positive electrode 7645, and a liquid salt electrolyte 7635 between the metal electrodes. The negative current lead 7615 may be electrically isolated from the housing (e.g., using electrically insulating seals). The negative current collector may comprise and/or be fabricated from porous stainless steel, such as, but not limited to stainless steel foam, woven mesh, expanded mesh, felt, perforated sheets, or any combination thereof. The negative current collector may contain the negative electrode. The negative electrode may be in a liquid, semi-solid, or solid state. The negative electrode may be in contact with the molten salt electrolyte. The salt electrolyte may be in contact with the positive metal electrode. The positive metal electrode may be in electrical communication with the housing along the side walls and/or along the bottom end wall of the housing.

The housing can be constructed from an electrically conductive material such as, for example, steel, iron, stainless steel, graphite, nickel, nickel based alloys, titanium, aluminum, molybdenum, tungsten, conductive compounds such as nitrides (e.g., silicon carbide or titanium carbide), or a combination thereof (e.g., alloy).

The housing may include a container and a container lid (e.g., cell cap). The container and container lid may be connected mechanically. The cross-sectional geometry of the housing (e.g., the geometry parallel to the container lid) can be circular, elliptical, square, rectangular, polygonal, curved, symmetric, asymmetric or any other compound shape based on design requirements for the battery. The negative current lead may be electrically isolated from the container and/or container lid (e.g., cell cap), via, for example, the use of an electrically insulating hermetic seal. In some examples, an electrically insulating barrier (e.g., seal) may be provided between the negative current lead and the container lid. As an alternative, the seal can be in the form of a gasket, for example, and placed between the container lid, and the container. In some examples, the electrochemical cell or battery may comprise two or more conductors passing through one or more apertures and in electrical communication with the metal negative electrode. In some instances, a separator structure (not shown) may be arranged within the electrolyte between the negative electrode and the positive electrode.

The housing may comprise a housing interior. The housing interior may include, but is not limited to, a sheath (e.g., a graphite sheath), a coating, a crucible (e.g., a graphite crucible), a surface treatment, a lining, or any combination thereof. In one example, the housing interior is a sheath. In another example, the housing interior is a crucible. In further examples, the housing interior is a coating or surface treatment. The housing interior may be thermally conductive, thermally insulating, electrically conductive, electrically insulating, or any combination thereof. In some cases, the housing interior may be provided for the protection of the housing (e.g., for protecting the stainless steel material of the housing from corrosion). In some examples, the housing interior is corrosion resistant. In some cases, the housing interior may be anti-wetting to a liquid electrode. In other cases, the housing interior may be anti-wetting to the liquid electrolyte.

The housing may comprise a thinner lining component of a separate metal or compound, or a coating (e.g., an electrically insulating coating), such as, for example, a steel housing with a graphite lining, or a steel housing with a nitride coating or lining (e.g., boron nitride, aluminum nitride), a titanium coating or lining, or a carbide coating or lining (e.g., silicon carbide, titanium carbide). The coating can exhibit favorable properties and functions, including surfaces that are anti-wetting. In some cases, the lining (e.g., graphite lining) may be dried by heating above room temperature in air or dried in a vacuum oven before or after being placed inside the cell housing. Drying or heating the lining may remove moisture from the lining prior to adding the electrolyte, positive electrode, or negative electrode to the cell housing.

The housing may include a thermally and/or electrically insulating sheath or crucible. In this configuration, the negative electrode may extend laterally between the side walls of the housing defined by the sheath without being electrically connected (i.e., shorted) to the positive electrode. Alternatively, the negative electrode may extend laterally between a first negative electrode end and a second negative electrode end. When the sheath is not provided, the negative electrode may have a diameter (or other characteristic dimension) that is less than the diameter (or other characteristic dimension such as width for a cuboid container) of the cavity defined by the housing.

The housing interior (e.g., sheath, crucible, and/or coating) can be constructed from a thermally insulating, thermally conductive, and/or electrically insulating or electrically conductive materials such as, for example, graphite, carbide (e.g., silicon carbide, titanium carbide, diamond-like carbide, vanadium carbide), nitride (e.g., boron nitride, titanium nitride, aluminum titanium nitride), alumina, titania, silica, magnesia, steel, stainless steel, molybdenum, tungsten, or a mixed oxide, such as, for example calcium oxide, aluminum oxide, silicon oxide, elemental silicon, lithium oxide, magnesium oxide, or any combination thereof. The housing interior may be coated using vapor deposition or another coating or surface treatment process, such as using physical vapor deposition and chemical vapor deposition. The housing interior may be a paint and may be applied by dipping, spraying, or brushing. For example, the coating may be a zinc phosphate primer, high temperature ceramic paint, graphite paint, or silicon coating. The housing interior may be plated, such as with a nickel or chrome plating. The coating may include passivation or pickling of the surface. For example, the housing interior may have an annular cross-sectional geometry that can extend laterally between a first housing interior end and a second housing interior end. The housing interior may be dimensioned such the housing interior is in contact and pressed up against the side walls of the cavity defined by the housing cavity. As an alternative, the housing interior can be used to prevent corrosion of the container and/or to prevent wetting of the a material up the side wall, and may be constructed out of an electronically conductive material, such as steel, stainless steel, tungsten, molybdenum, nickel, nickel based alloys, graphite, titanium, or titanium nitride. For example, the housing interior may be a thin metal (e.g., steel or stainless steel) and may be a coating. For example, the housing interior may be a thin mild steel or stainless steel metal liner that has undergone a boronization surface treatment or has received a silicon coating. The coating can cover just the inside of the walls, and/or, can also cover the bottom of the inside of the container. In some cases, the housing interior may be dried by heating above room temperature in air or dried in a vacuum oven before or after being placed inside the cell housing. Drying or heating the lining may remove moisture from the lining prior to adding the electrolyte, positive electrode, or negative electrode to the cell housing.

In some examples, an interior of the housing can have a thickness from about 3 millimeter (mm) to about 30 mm. In some examples, the housing interior (e.g., graphite crucible) can have a thickness of at least or equal to about 3 mm, 6 mm, 9 mm, 12 mm, 15 mm, 20 mm, 30 mm and the like. In some examples, the housing interior (e.g., graphite crucible) can have a thickness of less than about 3 mm, 6 mm, 9 mm, 12 mm, 15 mm, 20 mm, 30 mm and the like. In some examples, the housing interior can be less than about 1 mm thick. In some examples, the housing interior can be at least about 1 micrometer thick. For example, the housing interior can be from about 1 micrometer to about 1 mm thick.

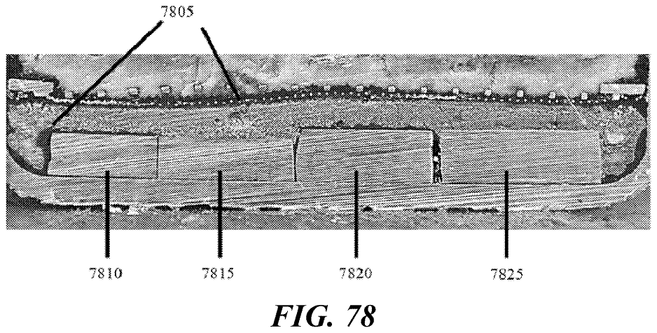

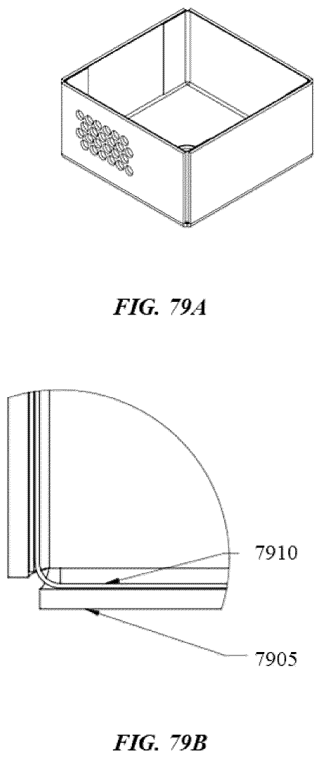

The housing may comprise a surface treatment. The surface treatment may harden the material of the housing (e.g., stainless steel) and may increase the resistance of the housing material (e.g., stainless steel) to corrosion. The second electrode material (e.g., antimony particles) may react with iron within the housing and increase corrosion of the housing. Unlike a coating, a surface treatment may chemically modify the top surface of a material and, therefore, increase corrosion resistance. Example surface treatments include, but are not limited to, boronizing, nitriding, nitrocarburizing, carburizing, or any combination thereof. The surface of a steel or stainless steel boronized component (e.g., cell housing, housing interior, porous electrode separate layers) may include FeₓB_{y} (e.g., Fe₂B or FeB) compounds, where ‘x’ and ‘y’ are numbers greater than zero. FIG. 78 shows an example of reactivity between electrode material (e.g., the second electrode) and various housing materials. Reaction components 7805 may be seen at the interface between various housing materials and the second electrode material. The second electrode material may be reactive with non-treated mild steel 7810 and non-treated 304 stainless steel 7820. The second electrode material may not be reactive with or may have limited reactivity with boronized mild steel 7815 and boronized 304 stainless steel 7825.

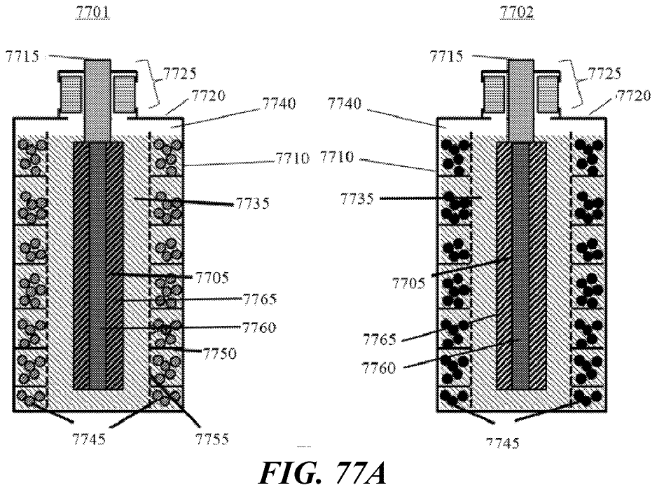

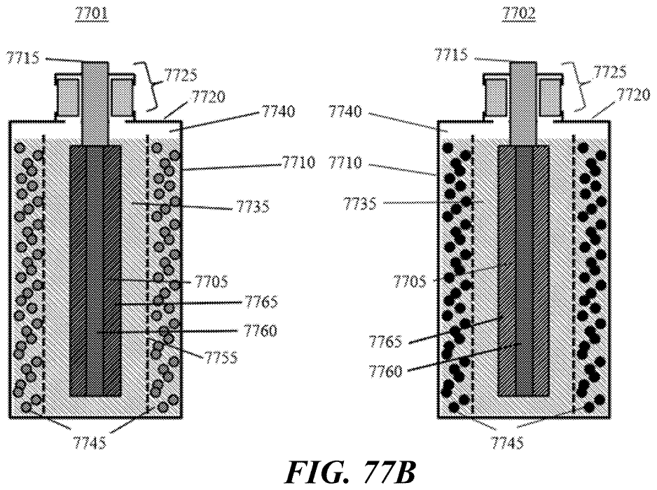

The cell can also include a first (e.g., negative) current collector and a second (e.g., positive) current collector. The negative current collector may be constructed from an electrically conductive material such as, for example, metal (e.g., stainless steel or steel) foam, perforated stainless steel or steel sheet, sheets of corrugated stainless steel or steel, sheets of woven mesh or expanded metal, or any combination thereof. The negative current collector may have a collector diameter that is less than or equal to approximately the diameter of the cavity defined by the housing. In some cases, the negative current collector may have a collector diameter (or other characteristic dimension) that is less than, equal to, or more than the diameter (or other characteristic dimension) of the negative electrode. The negative current collector may permit ions from the first electrode to migrate in and out of the current collector. The negative current collector may comprise a mechanical component that is rigid and provides geometric stability to the first electrode. The mechanical component may be an electrically conductive metal plate, perforated metal plate, an expanded metal sheet or plate, and/or a basket comprising one or more plates. The mechanical component may comprise a metal basket or a metal plate. The plate may be disposed in the electrochemical cell such that one of the two long dimensions (e.g., height) of the plate is substantially parallel to a gravitational acceleration vector (e.g., a long dimension is not parallel to the lid assembly). The metal may be 304 stainless steel, 304L stainless steel, 316 stainless steel, or mild steel. The plate may have a thickness of less than or equal to about 5 mm, 4 mm, 3 mm, 2 mm, 1.5 mm, 1.2 mm, 1 mm, 0.8 mm, 0.5 mm, or less. The plate may have a thickness of greater than or equal to 0.5 mm, 0.8 mm, 1 mm, 1.2 mm, 1.5 mm, 2 mm, 3 mm, 4 mm, 5 mm, or more. In an example, the plate is about 1.2 mm thick. The plate may be solid or may comprise holes (e.g., holes through the plate) such as perforations or holes formed from creating the expanded metal sheet. Holes (e.g., perforations) in the plate may be disposed across the entire plate or sections of the plate may comprise holes. The holes may be less than or equal to about 10 mm, 8 mm, 6 mm, 4 mm, 2 mm, 1 mm, 0.5 mm, or less in diameter. The holes may be greater than or equal to about 0.5 mm, 1 mm, 2 mm, 4 mm, 6 mm, 8 mm, 10 mm, or more in diameter. The diameter of the holes may be constant across the plate or may vary across the plate. The plate may have a metal material disposed around the plate or disposed along one or more surfaces of the plate. The metal material may be a metal mesh, metal cloth, metal knit, or any other metal material capable of wetting a liquid metal electrode. The metal material (e.g., metal cloth) may be wrapped around the plate. The metal material may be welded to the plate via spot welding, tungsten inert gas (TIG) welding, laser welding, or brazing. Alternatively, or in addition to, the metal material may be attached to the plate by one or more fasteners, such as with bolts or rivets. In an example, the negative current collector may comprise a basket formed of one or more metal plates. The basket may be lined with a wire cloth, mesh, metal knit, metal foam, or any combination thereof. FIG. 77A shows an example perforated metal basket that may be used as a negative current collector. The basket may comprise five sides, each comprising a perforated metal plate. As shown in FIG. 77B, the walls 7705 of the basket may be lined with a metal mesh or cloth 7710. The walls of the basket may be coupled via welding, such as by spot welding or tungsten inert gas (TIG) welding.

The negative current collector may comprise a porous metallic region in which the first electrode material (e.g., liquid metal) associates. The first electrode material may be internal to or surround the porous metal region. The porous metallic region may comprise metal foam, mesh, knit, mesh wire cloth, expanded metal, or other electrically conductive material. The metal foam, mesh, knit, mesh wire cloth, and expanded metal may comprise 304 stainless steel, 304L stainless steel, 316 stainless steel, mild steel, or other ferrous alloy. The electrically conductive material may be dispose internal to the metal basket. In an example, the porous metallic region is a wire cloth and multiple layers of the cloth are added to each surface of the metal current collector plate. The characteristic diameter or width of the pores within the porous metallic layer/component may be less than about 10 mm, 5 mm, 2 mm, 1 mm, 0.5 mm, 0.25 mm, 0.1 mm, 0.05 mm, 0.01 mm. For example, a perforated metal plate may have multiple layers of mesh wire cloth disposed adjacent to each surface of the plate. The plate may comprise greater than or equal to 1, 2, 3, 4, 5, 6, 8, 10, 12, or more layers of mesh wire cloth. In an example, the plate comprises five or more layers of mesh wire cloth. The cloth may be layered to create a structure that comprises pores between the intersecting wires of the cloth and between the layers of the cloth. Alternatively, or in addition to, the knitted mesh parts may be disposed adjacent to the plate. Formed knitted mesh parts may be disposed adjacent to the plate or around the negative current lead attached to the negative current collector. The plate may be formed into any geometry, such as cubic, prismatic, cylindrical, or any other shape.

The negative electrode may be contained within the negative current collector (e.g., foam or layers of metal mesh). In this configuration, the electrolyte layer comes up in contact with the bottom, sides, and/or the top of the negative current collector. The metal contained in the negative current collector (i.e., the negative electrode material) can be held away from the sidewalls of the housing, such as, for example, by the absorption and retention of a liquid metal negative electrode into the negative current collector, thus allowing the cell to run without an insulating sheath. In some embodiments, the negative electrode may be in a solid or semi-solid state. The solid or semi-solid metal negative electrode may be incorporated throughout the negative current collector. Alternatively, or in addition to, the solid or semi-solid metal negative electrode may be encompass and/or surround the negative current collector. In some embodiments, the negative electrode may comprise calcium. In some embodiments, the negative electrode may comprise a calcium alloy.

The positive current collector may be configured as part of the housing; for example, the bottom end wall and/or sidewalls of the housing may be configured as the positive current collector. The positive current collector may include a coating or a surface treatment as described elsewhere herein. Alternatively, the current collector may be discrete from the cell housing and may be electrically connected to the cell housing. In some cases, the positive current collector may not be electrically connected to the cell housing.

The second electrode (e.g., positive electrode) may be in electrical communication with a positive current collector. The positive electrode may be in electrical communication with the housing. The positive electrode may comprise antimony or an antimony alloy. In an example, the positive electrode may be a solid metal electrode. The solid metal positive electrode may be in a slab configuration. Alternatively, or in addition to, the solid metal positive electrode may comprise particles. The particles may comprise granules, flakes, needles, or any combination thereof of solid material. In an example, the positive electrode may be solid antimony. The solid antimony may be in a slab configuration. Alternatively, or in addition to, the solid antimony may be particles comprising granules, flakes, needles, or any combination thereof of solid material. The solid metal positive electrode particles may comprise a dimension of greater than or equal to about 0.00001 mm, 0.0001 mm, 0.001 mm, 0.01 mm, 0.1 mm, 0.25 mm, 0.5 mm, 1 mm, 2 mm, 3 mm, 5 mm, or larger. The solid particles may range in size from about 0.00001 mm to 0.0001 mm, 0.00001 mm to 0.001 mm, 0.00001 mm to 0.01 mm, 0.00001 mm to 0.1 mm, 0.00001 mm to 1 mm, 0.00001 mm to 10 mm. The size of the second electrode particles may remain constant as the cell cycles or change size as the cell cycles. The morphology of the second electrode may remain constant or may change as the cell cycles. In an example, small amounts of material spall off of a larger starting material to form particles. The larger starting material may be a particle or other geometry. In an example, the second electrode material may be added to the container as particles ranging in size from about 5 mm to 8 mm. The spalled off material may generate particles that range between about 0.1 micrometers (μm) and 100 μm. The second electrode material may be added to the electrochemical cell as particles, plates, or slabs of the second material. The plates or slabs of material may have at least one dimension that is greater than or equal to about 1 inch (in), 2 in, 3 in, 4 in, 5 in, 6 in, 7 in, 8 in, or more. In an example, the plates or slabs of material may have at least one dimension between about 4 in and 8 inch.

The solid particles of the second electrode (e.g., solid metal positive electrode) may be small to increase rate capability, electrode utilization, and cell capacity. Smaller particles may have a reduced diffusion distance, which may increase access and utilization of the second material (e.g., positive electrode material). The solid second electrode particles may comprise a dimension of less than or equal to about 10 mm, 8 mm, 6 mm, 5 mm, 4 mm, 3 mm, 2 mm, 1 mm, 0.5 mm, 0.25 mm, 0.1 mm, 0.01 mm, 0.001 mm, 0.0001 mm, 0.00001 mm, or smaller. In an example, the solid electrode particles of the second electrode may be less than or equal to about 10 mm. In an example, the solid electrode particles of the second electrode may be less than or equal to about 1 mm.

During operation the spalled off particles may be solid, semi-solid, or liquid. The second electrode may remain in the same state or may change states during operation. For example, the second electrode may transition from solid to semi-solid during charging and discharging cycles. The second electrode may comprise particles and the particles may agglomerate into larger structures and spall off into smaller structures during charging and discharging cycles. The particles or structures of the second electrode may be in electrical contact with each other during operation. The particles or structures of the second electrode may be in electrical contact with a positive current collector during operation. The positive current collector may be the housing or container of the electrochemical cell. The particles or structures of the second electrode may be in ionic contact with the electrolyte. The electrolyte may be disposed on top of the positive electrode. Alternatively, or in addition to, the second electrode may be submerged in or surrounded by the electrolyte. The second electrode and the electrolyte may behave as a Newtonian fluid, a non-Newtonian fluid, gel, or semi-solid material. The behavior of the second electrode and electrolyte may depend on the particle size distribution and particle density of the second electrode within the electrolyte.

The second electrode may comprise solid particles with a high electronic conductivity. The high electronic conductivity may permit the second electrode to conduct electrons without the use of other highly conductive materials or additives. For example, the second electrode may consist of particles of a single metal or metal alloy and may not comprise additional particles or materials to act as electrical conductors (e.g., graphite particles). The material of the solid particles of the second electrode may have an electronic conductivity of greater than or equal to about 2.5×10³ Siemens per meter (S/m), 5×10³ S/m, 7.5×10³ S/m, 1×10⁴ S/m, 2.5×10⁴ S/m, 5×10⁴ S/m, 7.5×10⁴ S/m, 1×10⁵ S/m, 2.5×10⁵ S/m, 5×10⁵ S/m, 7.5×10⁵ S/m, 1×10⁶ S/m, 2.5×10⁶ S/m, 5×10⁶ S/m, 7.5×10⁶ S/m, 1×10⁷ S/m, 2.5×10⁷ S/m, 5×10⁷ S/m, 7.5×10⁷ S/m, 1×10⁸ S/m, or more. In an example, the material of the solid particles of the second electrode has an electronic conductivity of greater than or equal to 1×10⁴ S/m. The material of the solid particles of the second electrode may have an electronic conductivity from about 2.5×10³ S/m to 5×10³ S/m, 2.5×10³ S/m to 7.5×10³ S/m, 2.5×10³ S/m to 1×10⁴ S/m, 2.5×10³ S/m to 2.5×10⁴ S/m, 2.5×10³ S/m to 5×10⁴ S/m, 2.5×10³ S/m to 7.5×10⁴ S/m, 2.5×10³ S/m to 1×10⁵ S/m, 2.5×10³ S/m to 2.5×10⁵ S/m, 2.5×10³ S/m to 5×10⁵ S/m, 2.5×10³ S/m to 7.5×10⁵ S/m, 2.5×10³ S/m to 1×10⁶ S/m, 2.5×10³ S/m to 2.5×10⁶ S/m, 2.5×10³ S/m to 5×10⁶ S/m, 2.5×10³ S/m to 7.5×10⁶ S/m, 2.5×10³ S/m to 1×10⁷ S/m, 2.5×10³ S/m to 2.5×10⁷ S/m, 2.5×10³ S/m to 5×10⁷ S/m, 2.5×10³ S/m to 7.5×10⁷ S/m, or 2.5×10³ S/m to 1×10⁸ S/m.

The second electrode may comprise solid particles that are dispersed within a liquid (e.g., molten) salt. The solid particles may comprise the second material (e.g., in a charged state) or an intermetallic material comprising the first material and the second material (e.g., in a discharged state). The particles may be larger particles (e.g. on the order of five to eight millimeters) or smaller particles (e.g., on the order of about 1 to 100 micrometers). The second electrode may be disposed in an electrode compartment (e.g., a cathode or positive electrode compartment). The second electrode compartment may be disposed between the housing of the container (e.g., positive current collector) and a separator. The compartment may comprise the solid particles of the second electrode and the liquid electrolyte. The solid particles may comprise greater than or equal to about 5 volume percent (vol %), 10 vol %, 15 vol %, 20 vol %, 25 vol %, 30 vol %, 35 vol %, 40 vol %, 45 vol %, 50 vol %, 55 vol %, 60 vol %, or more volume percent of the second electrode compartment. The solid particles may comprise from about 5 vol % to 10 vol %, 5 vol % to 15 vol %, 5 vol % to 20 vol %, 5 vol % to 25 vol %, 5 vol % to 30 vol %, 5 vol % to 35 vol %, 5 vol % to 40 vol %, 5 vol % to 45 vol %, 5 vol % to 50 vol %, 5 vol % to 55 vol %, or 5 vol % to 60 vol % of the electrode compartment. In an example, the solid particles comprise from about 10 vol % to 25 vol % of the electrode compartment. The remaining volume of the second electrode compartment may comprise the electrolyte.

Current may be distributed substantially evenly across a positive and/or negative metal electrode in contact with an electrolyte along a surface (i.e., the current flowing across the surface may be uniform such that the current flowing through any portion of the surface does not substantially deviate from an average current density). In some examples, the maximum density of current flowing across an area of the surface is less than or equal to about 105%, 115%, 125%, 150%, 175%, 200%, 250%, 300%, or less of the average density of current flowing across the surface. In some examples, the minimum density of current flowing across an area of the surface is greater than or equal to about 50%, 60%, 70%, 80%, 90%, 95%, or more of the average density of current flowing across the surface.

The electrochemical cell may be arranged within the housing so that the average flow path of ions is substantially perpendicular to the plane of the container lid (e.g., ions flow vertically between the negative and positive electrode when the lid is facing in an upwards direction). This configuration, shown in FIG. 76, may comprise a negative electrode contained within a negative current collector 7605 suspended within the cavity of the housing 7610 by a negative current lead 7615. The negative current lead 7615 may extend through an aperture in the container lid 7620 of the cell housing 7610. A seal 7625 may couple the negative current lead 7615 to the container lid 7620. The seal 7625 may electrically isolate the negative current lead 7615 from the container lid 7620 using an insulating ceramic 7630. In this configuration, the width of the negative current collector 7605 may be greater than the height of the negative current collector 7605. The negative electrode may be partially or fully submerged in a molten salt electrolyte 7635. A gaseous headspace 7640 may be present above the negative electrode (i.e., between the negative electrode and the container lid 7615). The molten salt electrolyte 7635 may be between, and separate, the negative electrode and the positive electrode 7645. The positive electrode 7635 may be position at or near the bottom (i.e., opposite the container lid 7625) of the cavity. The positive electrode 7645 may comprise a solid slab geometry or may comprise particles of solid material. The positive electrode may be positioned below the electrolyte 7635 or may be submerged or surrounded by the electrolyte 7635. During discharge, ions may flow from the negative electrode to the positive electrode 7645 with an average flow path that is perpendicular to and away from the container lid 7615. In a discharged state 7602, the negative current collector 7605 may contain a small amount of or substantially none of the negative electrode material and the positive electrode 7645 may comprise one or more intermetallic compounds (e.g., as a layer, a shell, or particles). During charging, ions may flow from the positive electrode to the negative electrode with an average flow path that is perpendicular to and towards the container lid 7620. In a charged state 7601, the negative current collector 7605 may comprise the negative electrode material (e.g., calcium or a calcium alloy) in a solid, semi-solid, or liquid state and the positive electrode 7645 may predominantly comprise positive electrode material (e.g., the positive electrode material may be substantially free of intermetallic components).

The electrochemical cell may be arranged within the housing such that the average flow path of ions is substantially parallel to the plane of the container lid (e.g., ions flow horizontally between the negative and positive electrode when the lid is facing in an upward direction). FIGS. 77A and 77B show example electrochemical cells in a charged state 7701 and a discharged state 7702. The electrochemical cell configuration may comprise a negative electrode contained within a negative current collector 7705 suspended within the cavity of the housing 7710 by a negative current lead 7715. The cell may have height, width, and depth dimensions. The height may be a dimension that is parallel to a gravitational acceleration vector (e.g., substantially perpendicular to the plane of the lid assembly or vertical). The depth and width dimensions may be substantially not parallel to a gravitational acceleration vector (e.g., parallel to the plane of the lid assembly or horizontal). In an example, the depth and width dimensions may be the same dimension. In an example, the width may be the smaller horizontal dimension (e.g., perpendicular to the gravitational acceleration vector) and the depth may be the larger horizontal dimension (e.g., perpendicular to the gravitation al acceleration vector). In this configuration, the height of the negative current collector 7705 may be greater than the width. The negative current collector 7705 may comprise a metal plate 7760 (e.g., steel or stainless steel) that is surrounded by or wrapped in a metal mesh, metal cloth, or expanded metal 7765. The metal mesh may be a knit or woven mesh. In an example, the negative current collector 7705 comprises one or more metal plates. The negative electrode may be partially or fully submerged in a molten salt electrolyte 7745. A gaseous headspace 7740 may be present between the negative electrode and the container lid 7720. In some embodiments, the negative electrode may be submerged and covered by a molten electrolyte 7735 and the gaseous headspace 7740 may be between the electrolyte 7735 and the container lid 7720. The positive electrode 7745 may be positioned along the sidewalls of the housing 7710 between the bottom of the cavity and the container lid 7720. The positive electrode 7745 may be positioned along a portion of the interior sidewall or cover the entire interior sidewall of the cavity. The positive electrode 7745 may cover an area that is greater than or equal to about 5%, 10%, 20%, 30%, 40%, 50%, 60%, 70%, 80%, 90%, or more of the sidewall. The sidewall of the housing 7710 may be coupled to one or more troughs or trays 7750. FIG. 77A shows an electrochemical cell with multiple troughs 7750. The troughs 7750 may be electrically coupled to the sidewall of the housing 7710 by a weld, braze, or other bonding or adhesive method. The troughs 7750 may hold or support the positive electrode 7745. An internal edge of the troughs 7750 (e.g., the edge closest to the negative current collector 7705) may be coupled to a separator 7755 (e.g., such as a retaining wall). Alternatively, as shown in FIG. 77B, an electrochemical cell may have one or no troughs and the positive electrode may be disposed in a cathode compartment between to a sidewall of the cell and one or more separators 7755. The separator 7755 may comprise a metal mesh, metal cloth, or sintered layers of metal mesh or cloth. The separator 7755 may reduce, limit, or prevent positive electrode material from diffusing through the electrolyte 7735 to contact the negative current collector 7705. The troughs, positive current collector (e.g., internal surface of the housing), and separator may be surface treated to reduce or prevent corrosion. The surface treatment may be as described elsewhere herein.

The positive electrode may comprise a shell adjacent to the side wall. The positive electrode may be configured to allow the positive electrode material (e.g., solid antimony metal particles) to be dispersed along a region near or adjacent to the sidewalls of the container. When the cell is in a charged state, a signification portion (e.g., greater than fifty volume percent) of the region of the cell that contains the positive electrode may be filled with the electrolyte. During discharge of the battery, the positive electrode materials may expand as cations from the electrolyte and/or negative electrode are deposited onto the positive electrode particles. During discharge, the first electrode (e.g., positive electrode) may expand by greater than or equal to about 5 volume percent (vol %), 10 vol %, 20 vol %, 30 vol %, 40 vol %, 50 vol %, 60 vol %, 70 vol %, 80 vol %, 90 vol %, 100 vol %, 125 vol %, 150 vol %, 175 vol %, 200 vol %, or more. The capacity density (based on the surface area of the cathode that is orthogonal to the average flow of ions through that surface area) of the second electrode may be greater than or equal to about 0.1 ampere hour per square centimeter (Ah/cm²), 0.2 Ah/cm², 0.3 Ah/cm², 0.4 Ah/cm², 0.5 Ah/cm², 0.6 Ah/cm², 0.7 Ah/cm², 0.8 Ah/cm², or more. The capacity density of the second electrode may be between about 0.1 Ah/cm² and 0.2 Ah/cm², 0.1 Ah/cm² and 0.3 Ah/cm², 0.1 Ah/cm² and 0.4 Ah/cm², 0.1 Ah/cm² and 0.5 Ah/cm², 0.1 Ah/cm² and 0.6 Ah/cm², 0.1 Ah/cm² and 0.7 Ah/cm², or 0.1 Ah/cm² and 0.8 Ah/cm². In an example, the capacity density of the second electrode is between about 0.16 Ah/cm² and 0.78 Ah/cm². The capacity volumetric density of the second electrode may be greater than or equal to about 0.1 ampere hour per milliliter (Ah/mL), 0.2 Ah/mL, 0.3 Ah/mL, 0.4 Ah/mL, 0.5 Ah/mL, 0.6 Ah/mL, 0.7 Ah/mL, 0.8 Ah/mL, 0.9 Ah/mL, 1 Ah/mL, 1.25 Ah/mL, or 1.5 Ah/mL.

There are multiple cell configurations that may provide expansion space for the positive electrode material, such as, but not limited to, using layers of troughs that line the cell walls (e.g., FIG. 77A) such that the positive electrode materials may be held on the bottom of each of these troughs and include room for a layer of molten salt above the positive electrode material. In a cell configuration that utilizes troughs, the troughs may be individual troughs connected to the sidewall or stacks of interconnected troughs. The positive electrode may comprise slabs of solid material positioned on or in the troughs. Alternatively, or in addition to, the positive electrode may comprise solid particles positioned on or in the troughs. The positive electrode may be positioned as a shell surrounding the molten electrolyte. Alternatively, the electrolyte may fill the cavity and the positive electrode may be surrounded by or submerged in the electrolyte. The positive electrode may be in electrical communication with the sidewalls. In housing configurations utilizing troughs, the positive electrode may be in electrical communication with the troughs and the troughs may be in electrical communication with the sidewall. During discharge, ions may flow from the negative electrode to the positive electrode with an average flow path that is parallel to the container lid and towards the sidewalls of the housing. During charging, ions may flow from the positive electrode to the negative electrode with an average flow path that is parallel to the container lid and away from the sidewalls of the housing.

The troughs may be mounted substantially perpendicular to the sidewall of the housing. The housing may comprise greater than or equal to about 1, 2, 5, 10, 15, 20, 50, 100, or more troughs layered within the interior of the housing. The positive electrode may be placed on or in all troughs or may be placed on or in selected troughs. The interior of the housing may further comprise a retaining wall positioned to maintain the positive electrode on or in the troughs. The retaining wall may be a porous material that allows ions from the negative electrode, electrolyte, or positive electrode to flow freely through the wall. In some embodiments, the porous material may allow for the molten electrolyte to flow freely through the wall. The retaining wall may be a single porous sheet of material positioned from the bottom of the cavity to the lid. The pores of the retaining wall may have an average diameter less than or equal to about 5 millimeters (mm), 3 mm, 2 mm, 1 mm, 0.5 mm, 0.25, 0.1 mm, 0.01 mm, 0.001 mm, or smaller. The retaining wall may be a self-supporting (e.g., a sheath-like) structure within the housing. Alternatively, the retaining wall may be connected to the interior edge of one or more of the troughs. The retaining wall may comprise a single sheet of porous material. Alternatively, or in addition to, the retaining wall may comprise segments of porous material. Each segment may be connected to one or more troughs. The retaining wall may be connected to the troughs by solder, braze, weld, or any other method of adhesion. The retaining wall may be in electrical communication with the housing. Alternatively, the retaining wall may not be in electrical communication with the housing.

The cross-sectional geometry of the cell or battery can be circular, elliptical, square, rectangular, polygonal, curved, symmetric, asymmetric or any other compound shape based on design requirements for the battery. In an example, the cell or battery is axially symmetric with a circular or square cross-section. Components of cell or battery (e.g., negative current collector) may be arranged within the cell or battery in an axially symmetric fashion. In some cases, one or more components may be arranged asymmetrically, such as, for example, off the center of the axis.

The combined volume of positive and negative electrode material may be at least about 5%, 10%, 20%, 30%, 40%, 50%, 60%, 70%, 80%, 90%, or 95% of the volume of the battery (e.g., as defined by the outer-most housing of the battery, such as a shipping container). In some cases, the combined volume of anode and cathode material is greater than or equal to about 5%, 10%, 20%, 40%, 60%, or 75% of the volume of the cell. In some cases, the volume of the cell not comprising the anode, cathode, and electrolyte may comprise a gaseous headspace. The gaseous headspace may comprise an inert, non-reactive gas. The inert gas may comprise argon, a noble gas, or any combination thereof. The combined volume of the positive and negative electrodes material may grow or shrink (e.g., in height) during operation due to the volume (size) growth or shrinkage of the positive or negative electrode. In an example, during discharge, the volume of the negative electrode (anode during discharge) may be reduced due to transfer of the negative electrode material to the positive electrode (cathode during discharge), wherein the volume of the positive electrode is increased (e.g., as a result of an alloying reaction). The volume reduction of the negative electrode may or may not equal the volume increase of the positive electrode. The positive and negative electrode materials may react with each other to form a solid or semi-solid intermetallic compound, which may have a density that is the same, lower, or higher than the densities of the positive and/or negative electrode materials. Although the mass of material in the electrochemical cell or battery may be constant, one, two or more phases (e.g., liquid or solid) may be present, and each such phase may comprise a certain material composition (e.g., an alkali metal may be present in the materials and phases of the cell at varying concentrations: a liquid metal negative electrode may contain a high concentration of an alkali metal, a liquid metal positive electrode may contain an alloy of the alkali metal and the concentration of the alkali metal may vary during operation, and a intermetallic compound product of the positive and negative liquid metal electrodes may contain the alkali metal at a fixed or variable stoichiometry). The phases and/or materials may have different densities. As material is transferred between the phases and/or materials of the electrodes, a change in combined electrode volume may result.

In some cases, a cell can include one or more alloyed products that are liquid, semi-liquid (or semi-solid), or solid. The alloyed products can be immiscible with the negative electrode, positive electrode and/or electrolyte. The alloyed products can form from electrochemical processes during charging or discharging of a cell.

An alloyed product can include an element constituent of a negative electrode, positive electrode and/or electrolyte. An alloyed product can have a different density than the negative electrode, positive electrode or electrolyte, or a density that is similar or substantially the same. The location of the alloyed product can be a function of the density of the alloyed product compared to the densities of the negative electrode, electrolyte and positive electrode. The alloyed product can be situated in the negative electrode, positive electrode, or electrolyte, or at a location (e.g., interface) between the negative electrode and the electrolyte or between the positive electrode and the electrolyte. In an example, an alloyed product is an intermetallic layer between the positive electrode and the electrolyte (see FIG. 76 and FIGS. 77A and 77B). In other examples, the alloyed product can be at other locations within the cell and be formed of a material of different stoichiometries/compositions, depending on the chemistry, temperature, and/or charged state of the cell.

The intermetallic layer can include an intermetallic compound of a material originating from the negative electrode and positive electrode material. The intermetallic compound may be formed during discharging at an interface between a positive liquid metal electrode (liquid metal cathode in this configuration) and a liquid metal electrolyte. The intermetallic compound (or product) can be solid or semi-solid. In an example, the intermetallic layer can form at the interface between the liquid metal cathode and the liquid metal electrolyte. One surface of the intermetallic layer may be in contact with the positive electrode and another surface of the intermetallic layer may be in contact with the electrolyte. In some cases, the intermetallic layer may exhibit liquid properties (e.g., the intermetallic may be semi-solid, or it may be of a higher viscosity or density than one or more adjacent phases/materials).

In some embodiments, the positive electrode may comprise a layer of solid particles and an intermetallic layer may form above the layer of solid particles. Alternatively, or in addition to, an intermetallic layer may form around and/or circumscribe the individual particles. In an alternative embodiment, an intermetallic layer may form around and/or circumscribe a group of particles. In an example, a negative electrode includes calcium (Ca) or a calcium alloy, the positive electrode includes antimony (Sb), and the intermetallic layer includes Ca and Sb (CaₓSb, where ‘x’ is a number greater than zero), such as, for example, CaSb₂. Cells with a Ca∥Sb chemistry may contain calcium ions within the electrolyte as well as other salts (e.g., CaCl₂), LiCl, KCl, NaCl, SrCl₂, or a combination thereof). In a discharged state, the cell is deficient in Ca in the negative electrode and the positive electrode comprises an alloy of Ca—Sb, and during charging, Ca is supplied from the positive electrode, passes through the electrolyte as a positive ion, and deposits onto the negative current collector as Ca. In some cases, the product of the discharge reaction may be an intermetallic compound (i.e. Ca₅Sb₃ for the Ca∥Sb cell chemistry), where the intermetallic layer may develop as a distinct solid phase by growing and expanding at the interface between the positive electrode and the electrolyte. For example, the intermetallic layer may grow and expand as a layer over the positive electrode or the intermetallic layer may grow as a shell around and into the positive electrode particles. The growth may be axially symmetrical or asymmetrical with respect to an axis of symmetry located at the center of the cell or battery. Alternatively, the solid intermetallic layer may develop and expand starting from one or more locations (also “nucleation sites” herein) along an interface between the metal cathode and liquid electrolyte. The nucleation sites may be located in a predetermined pattern along the surface; alternatively, the location of the nucleation sites may be stochastic (random), or determined by natural or induced defects at the interface between the metal cathode and the liquid electrolyte, or elsewhere within the cell or battery. In some examples, the solid or semi-solid intermetallic layer may not grow and expand horizontally. For example, the solid or semi-solid intermetallic layer may form evenly across the interface. In some examples, the intermetallic compounds may form on or adjacent to the surface of antimony particles and subsequently break-away from the surface of the antimony particles and become interspersed with electrolyte, while in some cases remaining in electronic communication with the positive current collector.

The solid intermetallic layer may begin developing at or near a location corresponding to the location of the external surface of the metal cathode particles at the commencement of discharging (i.e., the interface between the metal cathode and the electrolyte at the commencement of discharging), and may then grow in a radial direction of the metal cathode particles. Thus, the solid intermetallic layer may have an external interface or surface and an internal interface or surface. The external interface may remain in an approximately fixed location along the radius of the particle or granule, while the internal interface moves in a radial direction during discharge. In some cases, the solid intermetallic layer may grow and/or deform in the radial direction (i.e., intermetallic material is added to the layer from the radial direction).

During cycling, the formation of intermetallic compounds and the back-conversion of these intermetallic compounds to antimony may result in fragmentation of the antimony containing (e.g., antimony or antimony alloy) positive electrode particles, resulting in the formation of smaller positive electrode particles (e.g., at least about 0.0001 mm) than those initially assembled into the cell. The positive electrode particles may intersperse (e.g., be surrounded) with the molten salt electrolyte. Alternatively, or in addition to, the positive electrode may experience substantially no fragmentation and the small antimony or intermetallic compound particles may remain substantially similar in size to the initial assembled particles after cycling the cell multiple times. The positive electrode may therefore comprise small (e.g., at least about 0.0001 mm) particles of antimony, an antimony alloy, and/or intermetallic compounds (e.g., comprising Ca, Li, Ba, and/or Sr, and Sb) interspersed with molten salt electrolyte.

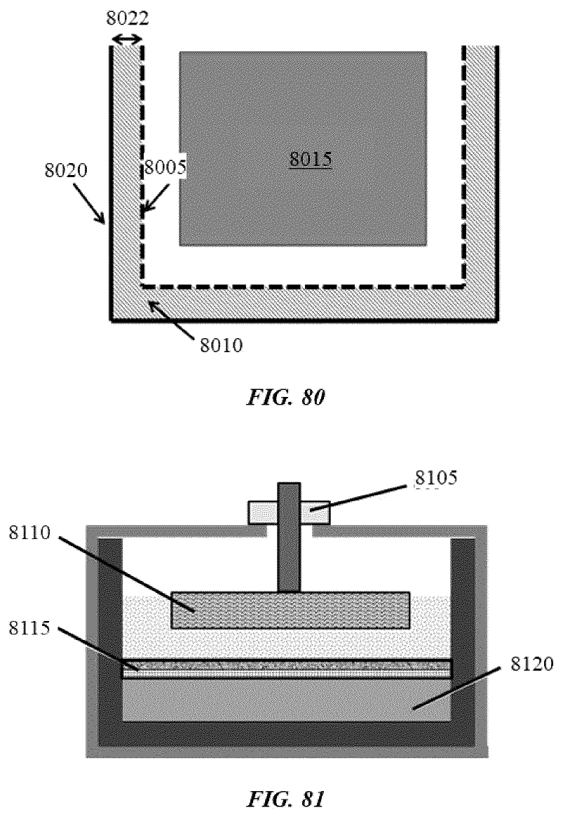

During operation, positive electrode particles (e.g., the second material) may drift to the negative electrode which may result in lost cell capacity, internal cell shorting, increased leakage current, or any combination thereof, which may reduce the efficiency of the battery. Positive electrode particle drift may be prevented by incorporating a separator, such as a metal (e.g., stainless steel or steel) screen, woven or expanded metal mesh, perforated sheet, felt, or any combination thereof, electrically connected to the second electrode (e.g., positive electrode). FIG. 80 shows an example electrochemical cell with a separator 8005 that forms a positive electrode 8010 compartment and reduces or prevents diffusion or migration of the positive electrode material through the electrolyte to the negative electrode 8015. The separator may be disposed internal to the housing such that the positive electrode 8010 is disposed as a shell around the internal surface of the cell container 8020. The separator may be positioned away from the internal walls of the container 8020 such that the thickness 8025 of the positive electrode 8010 is greater than or equal to about 0.05 inches (in), 0.1 in, 0.15 in, 0.2 in, 0.3 in, 0.4 in, 0.5 in, 0.6 in, 0.8 in, 1.0 in, or more inches. The thickness 510 of the positive electrode may be less than or equal to 1.0 in, 0.8 in, 0.6 in, 0.5 in, 0.4 in, 0.3 in, 0.2 in, 0.15 in, 0.1 in, 0.05 in, or fewer inches.

The separator may be positioned such that that the second electrode (e.g., positive electrode) is confined to a volume of the electrochemical cell. The volume that the second electrode is confined to may be greater than or equal to about 1, 2, 3, 4, 5, 6, 7, 8, 9, 10, 15, 20, or more times the volume of the non-expanded or non-dispersed second electrode material (e.g., the initial volume of the second electrode material before heating and cell cycling). In an example, the volume that the second electrode is confine to is about eight times the volume of the non-expanded second electrode material.

The separator may be disposed between the first electrode and the second electrode. FIG. 81 shows an example electrochemical cell configuration with a seal 8105, first electrode in a negative current collector 8110, second electrode 8120, and separator 8115 disposed between the negative current collector 8110 and the second electrode 8120. The separator may be positioned such that a long dimension of the separator is substantially orthogonal to vector of gravitational acceleration, as in FIG. 81, or such that a long dimension of the separator is substantially parallel to a vector of gravitational acceleration, as in FIGS. 77A and 77B. In an example, the separator is both substantially parallel and substantially orthogonal to a vector of gravitational acceleration, as shown in FIG. 7.

The separator may reduce or prevent the migration or diffusion of the second material (e.g., positive electrode material) and/or intermetallic material to the first electrode and negative current collector. In the absence of a separator, the intermetallic materials may migrate to the first electrode and contact the first electrode, thus shorting the electrochemical cell. The separator may act as a physical barrier to contain the material of the second electrode and/or the intermetallic material to a defined region of the cell. The separator may allow ionic species from the electrolyte (e.g., Ca²⁺, Li⁺, Na⁺, K⁺, Sr²⁺) and molten salt to pass through.

The separator may comprise multiple layers. In an example, the separator comprises two layers, a structural layer and a filtering layer. The structural layer may comprise a perforated plate or other porous rigid material. The structural layer may reduce or prevent physical distortion of the separator layer (e.g., bowing or bending). The plate may have a thickness of less than or equal to about 5 mm, 4 mm, 3 mm, 2 mm, 1.5 mm, 1.2 mm, 1 mm, 0.8 mm, 0.5 mm, 0.1 mm, or less. The plate may have a thickness of greater than or equal to 0.1 mm, 0.5 mm, 0.8 mm, 1 mm, 1.2 mm, 1.5 mm, 2 mm, 3 mm, 4 mm, 5 mm, or more. In an example, the plate is about 1.2 mm thick. The plate may be perforated (e.g., comprise holes through the plate) or may be an expanded metal. The perforations or holes in the expanded metal may be less than or equal to about 10 mm, 8 mm, 6 mm, 4 mm, 2 mm, 1 mm, 0.5 mm, or less in diameter. The perforations or holes in the expanded metal may be greater than or equal to about 0.5 mm, 1 mm, 2 mm, 4 mm, 6 mm, 8 mm, 10 mm, or more in diameter. In an example, the diameter of the perforations or the width of the holes in the expanded metal is about 2 mm. The diameter of the perforations may be constant across the plate or may vary across the plate. The plate may be any size suitable to separate materials of the second electrode from the negative current collector. The plate may be substituted with an expanded metal, ridged wire cloth, or any other material that has holes and is suitably mechanically robust.

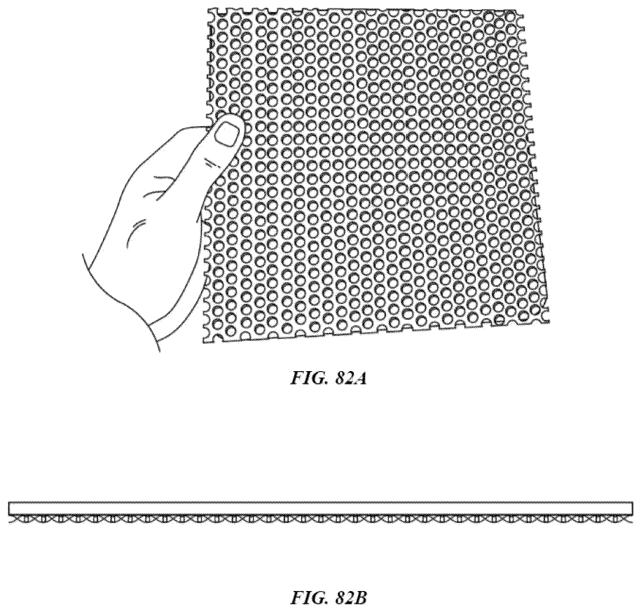

The filtering layer may comprise a wire cloth, mesh, felt, expanded metal, metal with holes formed within it, or sintered porous material. The filtering layer may be a single layer or may be multiple layers. In an example the filtering layer is a wire cloth with a weave pattern. Weave patterns may include a plain weave, twill weave, plain Dutch weave, and twilled Dutch weave, for wire cloths. In an example, the filtering layer comprises a plain Dutch weave. The filtering layer may be joined to the plate by a spot weld. The filtering layer may comprise greater than or equal to about 1, 2, 3, 4, 5, 6, 8, 10, 12, or more layers of wire cloth. The filtering layer may be disposed on the plate on the side adjacent to the second electrode (e.g., positive electrode). The filtering layer may have a nominal pore size of less than or equal to about 1 mm, 0.8 mm, 0.6 mm, 0.5 mm, 0.4 mm, 0.3 mm, 0.2 mm, 0.1 mm, 500 μm, 400 μm, 300 μm, 200 μm, 100 μm, 50 μm, 25 μm, or less. In an example, the filtering layer has a nominal pore size of less than about 0.8 mm. In an example, the filtering layer has a nominal pore size of about 25 μm. FIG. 82A shows a top view of a two layer separator comprising a perforated plate and mesh cloth and FIG. 82B shows a side view of the two layer separator. The top surface of the separator comprises a perforated plate and the bottom surface comprises a wire cloth. The filtering layer may comprise 304 stainless steel, 304L stainless steel, 316 stainless steel, graphite felt, or mild steel. In an example, the filtering layer comprises graphite felt. The structural layer and/or the filtering layer may be surface treated or coated. The surface treatment or coating may be any of the surface treatments or coating described elsewhere herein. In an example, both the structural layer and the filtering layer are boronized.

The porous metal separator may comprise pores that are small enough to slow or stop the migration of the positive electrode particles from the positive electrode to the negative electrode. A sufficiently small pore size in the metal separator may be smaller than most of the positive electrode particles, thereby physically blocking positive electrode particles from passing through the metal separator. Alternatively, or in addition to, the pores of the metal separator may be sufficiently small as to slow the convective flow of molten salt across the separator, which may thereby reduce or prevent the positive electrode particles from flowing to the negative electrode by convective flow of the electrolyte. Alternatively, or in addition to, the pores of the metal separator may be sufficiently small as to slow or reduce flux of the positive electrode particles through the separator through indirect-physical means, such as through electrostatic repulsion based on the polarity of the separator and the surface charge of cathode particles. In one embodiment, a cell arranged with a layer of solid positive electrode particles on the bottom of a cell housing (e.g., FIG. 76) may also comprise a layer of stainless steel mesh positioned above the positive electrode particles, thereby preventing the positive electrode particles from drifting up to the negative electrode. A similar approach may be used in a cell configuration where the ion flow path is parallel with the cell lid orientation (e.g., FIG. 77A or 77B), where a porous metal separator is positioned between the positive electrode and the negative electrode, whereby the metal separator is in electronic connection with the positive electrode and is electronically isolated from the negative electrode, thus preventing flow of the positive electrode particles to the negative electrode.

In one example, a cell may operate at about 500 °C and comprise a stainless steel (e.g., grade 304 stainless steel) cell body, a ceramic-to-metal braze seal comprising an aluminum nitride ceramic and a silver-based or titanium-based braze alloy, a calcium-lithium alloy negative electrode with a negative current collector comprising components fabricated from porous stainless steel sheets (e.g., perforated or expanded metal sheet), a positive electrode comprising solid antimony particles, an electrolyte comprising about 35 mol % lithium chloride and 65 mol % calcium chloride, and may comprise a porous metal (e.g., stainless steel) separator that is joined to the cell body and is electronically connected to the positive electrode. In one example, a cell may operate at about 500 °C and comprise a stainless steel (e.g., grade 304 stainless steel) cell body, a ceramic-to-metal braze seal comprising an aluminum nitride ceramic and a silver-based or titanium-based braze alloy, a calcium metal or calcium-magnesium metal alloy negative electrode with a negative current collector comprising components fabricated from porous stainless steel sheets (e.g., perforated or expanded metal sheet), a positive electrode comprising solid antimony particles, an electrolyte comprising at least about 30 mol % calcium chloride, at least about 30 mol % strontium chloride, and may comprise about 10 mol % potassium chloride, and may comprise a porous metal (e.g., stainless steel) separator that is joined to the cell body and is electronically connected to the positive electrode.

Any aspects of the disclosure described in relation to cathodes may equally apply to anodes at least in some configurations. Similarly, one or more battery electrodes and/or the electrolyte may not be liquid in alternative configurations. In an example, the electrolyte can be a polymer, a gel, or a paste. The electrolyte may be an ionic liquid electrolyte or an organic-based electrolyte. In a further example, at least one battery electrode can be a solid or a gel. Furthermore, in some examples, the electrodes and/or electrolyte may not include metal. Aspects of the disclosure are applicable to a variety of energy storage/transformation devices without being limited to liquid metal batteries.

The electrochemical cells can be arranged in series and/or parallel to form an electrochemical energy storage system (i.e., battery). The energy storage system can comprise packs and/or cores of electrochemical cells surrounded by a frame.

### Energy Storage Systems and Computer Systems

Electrochemical cells can be attached in series and parallel in various configurations to produce packs, trays, cores, or electrochemical systems. The number and arrangement of various groups of electrochemical cells can be chosen to create the desired system voltage and energy storage capacity. The packs, trays, cores, or systems can then be enclosed together in high temperature insulation to create a system that can heat itself using the energy created from cells charging and discharging.

The packs or trays themselves can be connected vertically and/or horizontally to one another through busbars (e.g., unlike the cell-to-cell connections within a pack or tray which are generally direct connections such as brazes). In some cases, the busbar is flexible or comprises a flexible section (e.g., due to the non-isothermal expansion of the system throughout heat up and operation).

Also provided herein are control systems including computers programmed to control an energy storage system of the disclosure. An energy storage system can include an electrochemical energy storage device with one or more electrochemical energy storage cells. The device can be coupled to a computer system that regulates the charging and discharging of the device. The computer system can include one or more computer processors and a memory location coupled to the computer processor. The memory location comprises machine-executable code that, upon execution by the computer processor, implements any of the methods above or elsewhere herein.

An energy storage system can include an electrochemical energy storage device with one or more electrochemical energy storage cells. The device can be coupled to a computer system that regulates the charging and discharging of the device. The computer system can include one or more computer processors and a memory location coupled to the computer processor. The memory location comprises machine-executable code that, upon execution by the computer processor, implements any of the methods above or elsewhere herein.

### Computer Systems

The present disclosure provides computer systems that are programmed to implement methods of the disclosure. FIG. 83 shows a computer system 8301 that is programmed or otherwise configured to operate the systems of the present disclosure and/or perform the methods of the present disclosure. The computer system 8301 can regulate various aspects of energy storage systems of the present disclosure, such as, for example, operations of an energy storage system, controlling charging and/or discharging of an energy storage system, etc. The computer system 8301 can be an electronic device of a user or a computer system that is remotely located with respect to the electronic device. The electronic device can be a mobile electronic device.

The computer system 8301 includes a central processing unit (CPU, also “processor” and “computer processor” herein) 8305, which can be a single core or multi core processor, or a plurality of processors for parallel processing. The computer system 8301 also includes memory or memory location 8310 (e.g., random-access memory, read-only memory, flash memory), electronic storage unit 8315 (e.g., hard disk), communication interface 8320 (e.g., network adapter) for communicating with one or more other systems, and peripheral devices 8325, such as cache, other memory, data storage and/or electronic display adapters. The memory 8310, storage unit 8315, interface 8320 and peripheral devices 8325 are in communication with the CPU 8305 through a communication bus (solid lines), such as a motherboard. The storage unit 8315 can be a data storage unit (or data repository) for storing data. The computer system 8301 can be operatively coupled to a computer network (“network”) 8330 with the aid of the communication interface 8320. The network 8330 can be the Internet, an internet and/or extranet, or an intranet and/or extranet that is in communication with the Internet. The network 8330 in some cases is a telecommunication and/or data network. The network 8330 can include one or more computer servers, which can enable distributed computing, such as cloud computing. The network 8330, in some cases with the aid of the computer system 8301, can implement a peer-to-peer network, which may enable devices coupled to the computer system 8301 to behave as a client or a server.

The CPU 8305 can execute a sequence of machine-readable instructions, which can be embodied in a program or software. The instructions may be stored in a memory location, such as the memory 8310. The instructions can be directed to the CPU 8305, which can subsequently program or otherwise configure the CPU 8305 to implement methods of the present disclosure. Examples of operations performed by the CPU 8305 can include fetch, decode, execute, and writeback.

The CPU 8305 can be part of a circuit, such as an integrated circuit. One or more other components of the system 8301 can be included in the circuit. In some cases, the circuit is an application specific integrated circuit (ASIC).

The storage unit 8315 can store files, such as drivers, libraries and saved programs. The storage unit 8315 can store user data, e.g., user preferences and user programs. The computer system 8301 in some cases can include one or more additional data storage units that are external to the computer system 8301, such as located on a remote server that is in communication with the computer system 8301 through an intranet or the Internet.

The computer system 8301 can communicate with one or more remote computer systems through the network 8330. For instance, the computer system 8301 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 8301 via the network 8330.

Methods as described herein can be implemented by way of machine (e.g., computer processor) executable code stored on an electronic storage location of the computer system 8301, such as, for example, on the memory 8310 or electronic storage unit 8315. The machine executable or machine readable code can be provided in the form of software. During use, the code can be executed by the processor 8305. In some cases, the code can be retrieved from the storage unit 8315 and stored on the memory 8310 for ready access by the processor 8305. In some situations, the electronic storage unit 8315 can be precluded, and machine-executable instructions are stored on memory 8310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 8301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 8301 can include or be in communication with an electronic display 8335 that comprises a user interface (UI) 8340 for providing, for example, displaying operating conditions of an energy storage system. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 8305. The algorithm can, for example, control and/or monitor an energy storage system.

Devices, systems and methods of the present disclosure may be combined with or modified by other devices, systems and/or methods, such as, for example, batteries and battery components described in U.S. Pat. No. 3,663,295 (“STORAGE BATTERY ELECTROLYTE”), U.S. Pat. No. 3,775,181 (“LITHIUM STORAGE CELLS WITH A FUSED ELECTROLYTE”), U.S. Pat. No. 8,268,471 (“HIGH-AMPERAGE ENERGY STORAGE DEVICE WITH LIQUID METAL NEGATIVE ELECTRODE AND METHODS”), U.S. Patent Publication No. 2011/0014503 (“ALKALINE EARTH METAL ION BATTERY”), U.S. Patent Publication No. 2011/0014505 (“LIQUID ELECTRODE BATTERY”), U.S. Patent Publication No. 2012/0104990 (“ALKALI METAL ION BATTERY WITH BIMETALLIC ELECTRODE”), and U.S. Patent Publication No. 2014/0099522 (“LOW-TEMPERATURE LIQUID METAL BATTERIES FOR GRID-SCALED STORAGE”), each of which is entirely incorporated herein by reference.

Energy storage devices of the disclosure may be used in grid-scale settings or stand-alone settings. Energy storage device of the disclosure can, in some cases, be used to power vehicles, such as scooters, motorcycles, cars, trucks, trains, helicopters, airplanes, and other mechanical devices, such as robots.

A person of skill in the art will recognize that the battery housing components may be constructed from materials other than the examples provided herein. One or more of the electrically conductive battery housing components, for example, may be constructed from metals other than steel and/or from one or more electrically conductive composites. In another example, one or more of the electrically insulating components may be constructed from dielectrics other than the aforementioned glass, mica and vermiculite. The present invention therefore is not limited to any particular battery housing materials.

Any aspects of the disclosure described in relation to cathodes can equally apply to anodes at least in some configurations. Similarly, one or more battery electrodes and/or the electrolyte may not be liquid in alternative configurations. In an example, the electrolyte can be a polymer or a gel. In a further example, at least one battery electrode can be a solid or a gel. Furthermore, in some examples, the electrodes and/or electrolyte may not include metal. Aspects of the disclosure are applicable to a variety of energy storage/transformation devices without being limited to liquid metal batteries.

### EXAMPLES

### Example 1: Materials of Construction

Alloys of tungsten (W) and molybdenum (Mo), such as, for example, those listed in TABLE 3, can be used in the seals of the disclosure. The alloys can be used as the component (e.g., W or Mo) that is brazed to the electrically insulating ceramic (e.g., aluminum nitride). In some cases, the tungsten and/or molybdenum alloy has a coefficient of thermal expansion (CTE) that is matched with the ceramic (e.g., within less than or equal to about 1%, 5% or 10% of the CTE of the ceramic), is substantially resistant to oxidation, and/or is substantially resistant to attack, alloying and/or corrosion from the metal vapor of the negative electrode (e.g., lithium, sodium, potassium, magnesium or calcium vapor) or the molten salt.

TABLE 3
EXAMPLES OF TUNGSTEN AND MOLYBDENUM ALLOYS

| Material | Brand | Description | Composition |
|---|---|---|---|
| Mo | Mo | Molybdenum | 99.97% Mo |
| TZM | TZM | Titanium-Zirconium-Molybdenum | 0.5% Ti/0.08% Zr/ |
| | | | 0.01-0.04% C |
| MHC | MHC | Molybdenum-Hafnium-Carbon | 1.2% Hf/0.05-0.12% C |
| Mo- | ML | Molybdenum-Lanthanum Oxide | 0.3% La₂O₃-0.7% La₂O₃ |
| Lanthanoxid | | | |
| (ML) | | | |
| Mo- | MLR (R = | Molybdenum-Lanthanum Oxide | 0.7% La₂O₃ |
| Lanthanoxid | Recrystallized) | | |
| (ML) | | | |
| Mo- | MLS (S = | Molybdenum-Lanthanum Oxide | 0.7% La₂O₃ |
| Lanthanoxid | Stress | | |
| (ML) | relieved) | | |
| MoILQ | MoILQ (ILQ = | Molybdenum-ILQ | 0.03% La₂O₃ |
| | Incandescent | | |
| | Lamp Quality) | | |
| Mo- | MY | Molybdenum-Yttrium-Cerium | 0.47% Y₂O₃/ |
| Yttriumoxid | | Oxide | 0.08% Ce₂O₃ |
| MoRe | MoRe5 | Molybdenum-Rhenium | 5.0% Re |
| MoRe | MoRe41 | Molybdenum-Rhenium | 41.0% Re |
| MoW | MW20 | Molybdenum-Tungsten | 20.0% W |
| MoW | MW30 | Molybdenum-Tungsten | 30.0% W |
| MoW | MW50 | Molybdenum-Tungsten | 50.0% W |
| MoCu | MoCu30 | Molybdenum-Copper | 30.0% Cu |
| MoCu | MoCu15 | Molybdenum-Copper | 15.0% Cu |
| MoZrO2 | MZ17 | Molybdenum-Zirconium Oxide | 1.7% ZrO₂ |
| MoTa | MT11 | Molybdenum-Tantalum | 11.0% Ta |
| MoNb | MoNb | Molybdenum-Niobium | |
| W (pure) | W (pure) | Tungsten | >99.97 |
| W-NS | W-NS | Tungsten-Non Sag | 60-65 ppm K |
| WVM | WVM | Tungsten Vacuum Metallizing | 30-70 ppm K |
| WVMW | WVMW | WVM-Tungsten | 15-40 ppm K |
| S-WVMW | S-WVMW | S-WVM-Tungsten | 15-40 ppm K |
| WC | WC20 | Tungsten Cerium Oxide | 2.0% CeO₂ |
| WL | WL10 | Tungten-Lanthanum Oxide | 1.0% La₂O₃ |
| WL | WL15 | Tungten-Lanthanum Oxide | 1.5% La₂O₃ |
| WL | WL20 | Tungten-Lanthanum Oxide | 2.0% La₂O₃ |
| WL-S | WL-S | Tungsten-Lanthanum Oxide-Stem | 1.0% La₂O₃ |
| WLZ | WLZ | Tungsten-Lanthanum Oxide- | 2.5% La₂O₃/ |
| | | Zirconium Oxide | 0.07% ZrO₂ |
| WT | WT20 | Tungsten-Thorium Oxide | 2.0% ThO₂ |
| WT | WVMT10 | Tungsten-Thorium Oxide | 30-70 ppm K/ |
| | | | 1.0% ThO₂ |
| WT | WVMWT | Tungsten-Thorium Oxide | 5-30 ppm K/ |
| | | | 2.0% ThO2 |
| WRe | WRe5 | Tungsten-Rhenium | 5.0% Re |
| WRe | WRe26 | Tungsten-Rhenium | 26.0% Re |
| WCu | WCu | Tungsten-Copper | 10-40% Cu |
| W-High- | DENSIMET ® | DENSIMET ® | 1.5%-10% Ni, Fe, |
| density | | | Mo |
| tungsten- | | | |
| heavy metal | | | |
| alloys | | | |
| W-High- | INERMET ® | INERMET ® | 5%-9.8% Ni, Cu |
| density | | | |
| tungsten- | | | |
| heavy metal | | | |
| alloys | | | |
| W-High- | DENAL ® | DENAL ® | 2.5%-10% Ni, Fe, |
| density | | | Co |
| tungsten- | | | |
| heavy metal | | | |
| alloys | | | |

It is to be understood that the terminology used herein is used for the purpose of describing specific embodiments, and is not intended to limit the scope of the present invention. It should be noted that as used herein, the singular forms of “a”, “an” and “the” include plural references unless the context clearly dictates otherwise. In addition, unless defined otherwise, all technical and scientific terms used herein have the same meaning as commonly understood by one of ordinary skill in the art to which this invention belongs.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. An electrochemical energy storage device comprising a negative electrode and a positive electrode and an electrolyte disposed between said negative and positive electrodes, wherein the electrochemical energy storage device has a first potential difference between the negative and positive electrodes at a first temperature that is less than about 50 °C and a second potential difference between the negative and positive electrodes at a second temperature of at least about 250 °C, wherein the second potential difference is greater than the first potential difference.

2-11. (canceled)

12. A method for forming an energy storage device, comprising:
shipping a container comprising an energy storage material in the solid state to a destination location; and
at the destination location, supplying energy to the energy storage material to form an energy storage device comprising an anode and a cathode that are spaced apart by an electrolyte, wherein at least one of said anode, cathode and electrolyte are in the liquid state at an operating temperature of said energy storage device.

13-21. (canceled)

22. An energy storage system, comprising:
a. a plurality of electrochemical cells each comprising a negative electrode, electrolyte and positive electrode, wherein at least two of the negative electrode, the electrolyte and the positive electrode is in a liquid state at an operating temperature of the electrochemical cell, wherein the plurality of electrochemical cells are connected in series and/or parallel; and
b. a frame supporting the plurality of electrochemical cells, wherein the frame comprises one or more fluid flow paths for bringing a thermal management fluid in thermal communication with at least a subset of the plurality of electrochemical cells.

23-62. (canceled)

63. An electrochemical cell, comprising:
a. an electrically conductive housing comprising a liquid metal that is liquid at an operating temperature of at least about 200 °C, wherein said liquid metal is configured to store or release charge during charge/discharge of the electrochemical cell;
b. a conductor in electrical contact with the liquid metal, wherein the conductor protrudes through the electrically conductive housing through an aperture in the electrically conductive housing; and
c. a seal that seals the conductor to the electrically conductive housing, wherein the seal provides a helium leak rate of no more than about 1×10⁻⁶ atmosphere-cubic centimeters per second (atm-cc/s) at a temperature of at least about 25 °C.

64. A method for operating an electrochemical energy storage device, comprising:
(a) activating said electrochemical energy storage device coupled to an electrical load, said electrochemical energy storage device comprising:
a. a first electrode comprising a first material, wherein said first electrode is in electrical communication with a negative current collector, wherein, at an operating temperature of said electrochemical energy storage device, said first material is liquid;
b. a second electrode comprising a plurality of solid particles comprising a second material, wherein said second electrode is in electrical communication with a positive current collector, wherein said second material is reactive with said first material, wherein said second material of said plurality of solid particles has an electronic conductivity of greater than or equal to 1×10⁴ Siemens per meter, and wherein at said operating temperature of said electrochemical energy storage device said second material is solid; and
c. a liquid electrolyte between said first electrode and said second electrode, wherein said liquid electrolyte is capable of conducting ions of said first material; and
(b) charging or discharging said electrochemical energy storage device through said electrical load, wherein (i) during charging, said liquid electrolyte conducts ions of said first material to said first electrode, and (ii) during discharging, said liquid electrolyte conducts ions of said first material away from said first electrode.
